(19) United States
(12) Patent Application Publication
(10) Pub. No.: US 2012/0190562 A1
(43) Pub. Date: Jul. 26, 2012

(54) METHODS AND COMPOSITIONS FOR DETERMINING SEVERITY OF HEART FAILURE IN A SUBJECT

(76) Inventors: Choong-Chin Liew, Toronto (CA); Jun Ma, Toronto (CA); Alan S. Go, Lafayette, CA (US)

(21) Appl. No.: 13/056,282

(22) PCT Filed: Jul. 28, 2009
(86) PCT No.: PCT/CA09/01055

§ 371 Date: Sep. 12, 2011

Related U.S. Application Data
(60) Provisional application No. 61/084,190, filed on Jul. 28, 2008.

(51) Int. Cl. C40B 30/04; C40B 40/06

(52) U.S. Cl. 506/9; 506/16

(57) ABSTRACT

The application provides a method of determining a severity of heart failure in a human test subject, by determining a level of RNA encoded by one or more heart failure marker genes in blood of the test subject compared to controls.

### FIELD OF THE DISCLOSURE

The disclosure relates to methods, kits and compositions for determining the likelihood and/or severity of a subject with heart failure. More particularly, the disclosure relates to methods, kits and compositions for determining the likelihood and/or severity of heart failure by measuring a level of one or more gene products in blood of the subject.

### BACKGROUND OF THE DISCLOSURE

Heart failure is increasing as a public health concern and rapidly growing as an economic burden. The enormous public health and economic burdens imposed by heart failure can be decreased only by introducing improved therapies and better patient management. The genomic approaches to disease that have revolutionized biologic and biomedical research over the past 10 years hold significant promise in tackling these issues.

Determining Heart Failure (HF) severity is challenging. New York Heart Association (NYHA) classification and BNP are often used but are limited. Blood gene expression patterns may provide further insights into disease severity, but patterns associated with NYHA class and BNP are unknown.

### SUMMARY OF THE DISCLOSURE

The present disclosure provides novel blood markers for determining the likelihood and/or severity of heart failure in a subject. This use can be effected in a variety of ways as further described and exemplified herein.

Accordingly, in one aspect there is provided a method of determining a severity of heart failure in a human test subject, the method comprising, for each gene of a set of one or more of the genes listed in Tables 3, 4, 5, 6, 7 and 8: a) determining a level of RNA encoded by the gene in blood of the test subject, thereby generating a test data; b) providing a first positive control data representing levels of RNA encoded by the gene in blood of human control subjects having a first categorized severity of heart failure; and c) comparing the data of steps a) and b) to thereby determine at least one value indicating whether the test data corresponds to the first positive control data; wherein an indication by the at least one value, for each gene of the set, that the test data corresponds to the first positive control data indicates that the test subject has the first categorized severity of heart failure.

In one embodiment, the one or more genes are selected from Tables 3 and 4. In another embodiment, the genes are selected from Tables 5 and 7. The first categorized severity may be compensated heart failure, optionally NYHA I-II heart failure, or decompensated heart failure, optionally NYHA III-IV heart failure.

In a further aspect, the method further comprises providing a second positive control data representing levels of RNA encoded by the gene in blood of human control subjects having a second categorized severity of heart failure, wherein correspondence between the test data and the second positive control data indicates that the test subject has the second categorized severity of heart failure. In one embodiment, the first categorized severity is compensated heart failure, optionally NYHA I-II heart failure and the second categorized severity is decompensated heart failure, optionally NYHA III-IV heart failure.

According to further features described below the determining of the level of RNA encoded by the gene in blood of the test subject is determined as a ratio to a level of RNA encoded by the gene in blood of a test subject not having heart failure.

In another aspect, the method further comprises determining levels of RNA encoded by the gene in blood of a population of human subjects having the first categorized severity of heart failure, thereby providing the positive control data representing the levels of RNA encoded by the gene in blood of human control subjects having the first categorized severity of heart failure. In yet another aspect, the method further comprises determining levels of RNA encoded by the gene in blood of a population of human subjects having the second categorized severity of heart failure, thereby providing the positive control data representing the levels of RNA encoded by the gene in blood of human control subjects having the second categorized severity of heart failure.

In a further aspect the method further comprises providing a third control data representing levels of RNA encoded by the gene in blood of human control subjects not having heart failure, and wherein step c) is effected by comparing the test data to the first positive control data, and optionally the second positive control data, and the third control data, wherein correspondence between the test data and the first or second positive control data and not the third control data indicates that the test subject has the first or second categorized severity of heart failure. In one embodiment, step c) is effected by causing a suitably programmed computer to compare the test data to the control data to thereby generate the at least one value indicating whether the test data corresponds to the control data.

According to another aspect, there is provided a computer-based method of determining a severity of heart failure in a human test subject, the method comprising, for each gene of a set of one or more of the genes listed in Tables 3, 4, 5, 6, 7 and 8: inputting, to a computer, test data representing a level of RNA encoded by the gene in blood of the test subject, wherein the computer is suitably programmed for comparing a data representing a level of RNA encoded by the gene in blood of a human subject to a control data representing levels of RNA encoded by the gene in blood of human subjects having a categorized severity of heart failure, to thereby output/generate at least one value indicating whether the test data corresponds to the first positive control data; and causing the computer to compare the test data to the first positive control data, wherein an indication by the at least one value that the test data corresponds to the first positive control data indicates that the test subject has the first categorized severity of heart failure.

In one embodiment, the one or more genes are selected from Tables 5 and 7.

In a further aspect, there is provided a method of monitoring the progression of heart failure in a human subject, the method comprising for each gene of a set of one or more of the genes listed in Table 5: a) determining a level of RNA encoded by the gene in blood of the subject at a first time point; b) determining a level of RNA encoded by the gene in blood of the subject at a second time point, wherein the second time point is later than the first time point; and c) comparing the levels of steps a) and b) to thereby determine at least one value indicating whether the level at the second time point is higher than the level at the first time point; wherein an indication by the at least one value, for each gene of the set, that the level at the second time point is higher than the level at the first time point indicates a progression of heart failure. In one embodiment step c) is effected by causing a suitably programmed computer to compare a level of RNA encoded by a gene at a first time point to a level of RNA encoded by the gene at a second time point to thereby determine the at least one value indicating whether the level at the second time point is higher than the level at the first time point.

In another aspect, there is provided a method of monitoring the progression of heart failure in a human subject, the method comprising, for each gene of a set of one or more of the genes listed in Table 7: a) determining a level of RNA encoded by the gene in blood of the subject at a first time point; b) determining a level of RNA encoded by the gene in blood of the subject at a second time point, wherein the second time point is later than the first time point; and c) comparing the levels of steps a) and b) to thereby determine at least one value indicating whether the level at the second time point is lower than the level at the first time point; wherein an indication by the at least one value, for each gene of the set, that the level at the second time point is lower than the level at the first time point indicates a progression of heart failure. In one embodiment, step c) is effected by causing a suitably programmed computer to compare a level of a RNA encoded by a gene at the first time point to a level of RNA encoded by the gene at the second time point to thereby determine the at least one value indicating whether the level at the second time point is lower than the level at the first time point.

According to yet another aspect, there is provided a computer-based method of monitoring the progression of heart failure in a human subject, the method comprising inputting, to a computer, test data representing a level of RNA encoded by one or more of the genes listed in Table 5 in blood of the subject at a first and at a second time point, wherein the second time point is later than the first time point; and causing the computer to compare the data of the first time point to the data of the second time point, and to determine whether the level at the second time is higher than the level at the first time point, wherein a determination that the level of RNA encoded by the gene in blood of the test subject at the second time point is higher than the level at the first time point indicates the progression of heart failure.

In an additional aspect, there is provided a computer-based method of monitoring the progression of heart failure in a human subject, the method comprising inputting, to a computer, test data representing a level of RNA encoded by one or more of the genes listed in Table 7 in blood of the subject at a first and second time point, wherein the second time point is later than the first time point; and causing the computer to compare the data of the first time point to the data of the second time point, and to determine whether the level at the second time point is lower than the level at the first time point, wherein a determination that the level at the second time point is lower than the level at the first time point indicates the progression of heart failure.

In another aspect, there is provided a method for classifying a human test subject as having heart failure, the method comprising, for each gene of a set of one or more of the genes listed in Tables 5 and 6: a) determining a level of RNA encoded by the gene, thereby generating a test data; b) providing a control data representing a level of RNA encoded by the gene in blood of human control subjects, wherein the control subjects do not have heart failure; and c) comparing the test data to the control data to thereby determine at least one value indicating whether the level of RNA encoded by the gene in blood of the test subject is higher than the level of RNA encoded by the gene in blood of the control subjects, wherein an indication by the at least one value that the level of RNA encoded by the gene in blood of the test subject is higher than the level of RNA encoded by the gene in blood of the control subjects classifies the test subject as having heart failure. In one embodiment, step c) is effected by causing a suitably programmed computer to compare the test data to the control data to thereby determine the at least one value indicating whether the level of RNA encoded by the gene in blood of the test subject is higher than the level of RNA encoded by the gene in blood of the control subject.

In another aspect, there is provided a method for classifying a human test subject as having heart failure, the method comprising, for each gene of a set of one or more of the genes listed in Tables 7 and 8: a) determining a level of RNA encoded by the gene, thereby generating a test data; b) providing a control data representing a level of RNA encoded by the gene in blood of human control subjects, wherein the control subjects do not have heart failure; and c) comparing the test data to the control data to thereby determine at least one value indicating whether the level of RNA encoded by the gene in blood of the test subject is lower than the level of RNA encoded by the gene in blood of the control subjects, wherein an indication by the at least one value that the level of RNA encoded by the gene in blood of the test subject is lower than the level of RNA encoded by the gene in blood of the control subjects classifies the test subject as having heart failure. In one embodiment, step c) is effected by causing a suitably programmed computer to compare the test data to the control data to thereby determine the at least one value indicating whether the level of RNA encoded by the gene in blood of the test subject is lower than the level of RNA encoded by the gene in blood of the control subject.

In another aspect, there is provided a method of classifying a human test subject as having decompensated heart failure, the method comprising, for each gene of a set of one or more of the genes listed in Tables 5 and 6: a) determining a level of RNA encoded by the gene in blood of the test subject, thereby generating a test data; b) providing a control data representing a level of RNA encoded by the gene in blood of human control subjects not having heart failure; and c) comparing the test data to the control data to thereby determine at least one value indicating whether the level of RNA encoded by the gene in blood of the test subject is higher than the level of RNA encoded by the gene in blood of human control subjects not having heart failure, wherein an indication by the at least one value that the level of RNA encoded by the gene in blood of the test subject is higher than the level of RNA encoded by the gene in blood of human control subjects not having heart failure classifies the test subject as having decompensated heart failure. In one embodiment, step c) is effected by causing a suitably programmed computer to compare the test data to the control data to thereby determine the at least one value indicating whether the level of RNA encoded by the gene in blood of the test subject is higher than the level of RNA encoded by the gene in blood of human control subjects not having heart failure.

In yet another aspect, there is provided a method of classifying a human test subject as having decompensated heart failure, the method comprising, for each gene of a set of one or more of the genes listed in Tables 7 and 8: a) determining a level of RNA encoded by the gene in blood of the test subject, thereby generating a test data; b) providing a control data representing a level of RNA encoded by the gene in blood of human control subjects not having heart failure; and c) comparing the test data to the control data to thereby determine at least one value indicating whether the level of RNA encoded by the gene in blood of the test subject is lower than the level of RNA encoded by the gene in blood of human control subjects not having heart failure, wherein an indication by the at least one value that the level of RNA encoded by the gene in blood of the test subject is lower than the level of RNA encoded by the gene in blood of human control subjects not having heart failure classifies the test subject as having decompensated heart failure. In one embodiment, step c) is effected by causing a suitably programmed computer to compare the test data to the control data to thereby determine the at least one value indicating whether the level of RNA encoded by the gene in blood of the test subject is lower than the level of RNA encoded by the gene in blood of human control subjects not having heart failure.

In a further aspect there is provided a computer-based method of classifying a human test subject as having decompensated heart failure, the method comprising, for each gene of a set of one or more of the genes listed in Tables 5 and 6: inputting, to a computer, test data representing a level of RNA encoded by the gene in blood of the test subject; causing the computer to compare the test data to control data representing a level of RNA encoded by the gene in blood of human control subjects not having heart failure, and to determine whether the level of RNA encoded by the gene in blood of the test subject is higher than the level of RNA encoded by the gene in blood of human control subjects not having heart failure, wherein a determination that the level of RNA encoded by the gene in blood of the test subject is higher than the level of RNA encoded by the gene in blood of human control subjects not having heart failure is used to classify the test subject as having decompensated heart failure.

In one aspect there is provided a method of classifying a human test subject as more likely to have NYHA class I-II heart failure than to not have heart failure, the method comprising, for each gene of a set of one or more of the genes listed in Table 3: a) determining a level of RNA encoded by the gene in blood of the test subject, thereby generating a test data; b) providing a first positive control data representing levels of RNA encoded by the gene in blood of human control subjects having NYHA class I-II heart failure; and c) comparing the test data to the control data to thereby determine at least one value indicating whether the test data corresponds to the first positive control data; wherein an indication by the at least one value, for each gene of the set, that the test data corresponds to the first positive control data indicates that the test subject is more likely to have NYHA class I-II heart failure than not to have heart failure. In one embodiment, step c) is effected by causing a suitably programmed computer to compare a test data to a first positive control data to thereby determine at least one value indicating whether the test data corresponds to the first positive control data.

In one embodiment the method further provides: (d) providing a negative control data representing levels of RNA encoded by the gene in blood of human control subjects not having heart failure; wherein a more likely correspondence between the test data and the positive control data than a correspondence between the test data and the negative control data indicates that the test subject is more likely to have NYHA class I-II heart failure than to not have heart failure.

In one embodiment, the level of RNA encoded by the gene in blood of the test subject is determined as a ratio to a level of RNA encoded by the gene in blood of one or more subjects not having heart failure. In another embodiment, each gene of the set of one or more genes has a ROC AUC of at least 0.68, 0.70, 0.72, 0.74, 0.76, 0.78 and/or 0.80. In a further embodiment the ratio of the level of RNA encoded by at least one gene of the set of one or more genes in blood in the test subject compared to the control is less than about 0.90, 0.88, 0.86, 0.84, 0.82, 0.80 and/or 0.78. In a further embodiment the ratio of the level of RNA encoded by at least one gene of the set of one or more genes in blood in the test subject compared to the control is greater than about 1.20, 1.22, 1.24, 1.26, 1.28, 1.30, 1.32, 1.34, 1.36, 1.38 and/or 1.40. In some embodiments the ratio of the level of RNA encoded by each gene of the set of one or more genes in blood in the test subject compared to the control is the ratio at a sensitivity of 0.6. In still a further embodiment, the ratio of the level of RNA encoded by at least one gene of the set of one or more genes in blood in the test subject compared to the control is selected from a range which includes an extreme NYHA I-II/average control ratio, for example as set forth in Table 3 or Table 4.

In another aspect, there is provided a method of classifying a human test subject as more likely not to have heart failure than to have NYHA class I-II heart failure, the method comprising, for each gene of a set of one or more of the genes listed in Table 3: a) determining a level of RNA encoded by the gene in blood of the test subject, thereby generating a test data; b) providing a first positive control data representing levels of RNA encoded by the gene in blood of human control subjects not having heart failure; and c) comparing the test data to the control data to thereby determine at least one value indicating whether the test data corresponds to the first positive control data; wherein an indication by the at least one value, for each gene of the set, that the test data corresponds to the first positive control data indicates that the test subject is more likely not to have heart failure than to have NYHA class I-II heart failure.

In one embodiment, step c) is effected by causing a suitably programmed computer to compare the data of steps a) and b) to thereby determine the at least one value indicating whether the test data corresponds to the first positive control data.

In one embodiment the method further comprises: (d) providing a first positive control data representing levels of RNA encoded by the gene in blood of human control subjects having NYHA class I-II heart failure; wherein a more likely correspondence between the test data and the negative control data than a correspondence between the test data and the first positive control data indicates that the test subject is more likely to not have heart failure than to have NYHA class I-II heart failure.

In one embodiment, the ratio of the level of RNA encoded by each gene of the set of one or more genes gene in blood in the test subject compared to the control is the ratio at a specificity of 0.6. In a further embodiment, the ratio of the level of RNA encoded by each gene of the set of one or more genes gene in blood in the test subject compared to the control is selected from a range which includes an extreme control/average control ratio, for example as set forth in Table 3 or Table 4.

In still a further aspect, there is provided a method of classifying a human test subject as more likely to have NYHA class III-IV heart failure than not to have heart failure, the method comprising, for each gene of a set of one or more of the genes listed in Table 4: a) determining a level of RNA encoded by the gene in blood of the test subject, thereby generating a test data; b) providing a first positive control data representing levels of RNA encoded by the gene in blood of human control subjects having NYHA class III-IV heart failure; and c) comparing the levels of (a) and (b) to thereby determine at least one value indicating whether the test data corresponds to the first positive control data; wherein an indication by the at least one value, for each gene of the set, that the test data corresponds to the first positive control data classifies the test subject as more likely to have NYHA class III-IV heart failure than not to have heart failure. In one embodiment, step c) is effected by causing a suitably programmed computer to compare the levels of (a) and (b) to thereby determine at least one value indicating whether the test data corresponds to the first positive control data.

In one embodiment, the method further provides: (d) providing a negative control data representing levels of RNA encoded by the gene in blood of human control subjects not having heart failure; wherein a more likely correspondence between the test data and the positive control data than a correspondence between the test data and the negative control data indicates that the test subject is more likely to have NYHA class III-IV heart failure than to not have heart failure.

In one embodiment each gene of the set of one or more genes has a ROC AUC of at least 0.60, 0.64, 0.68, 0.70, 0.72, 0.74, 0.76, 0.78 and/or 0.80. In another embodiment, the ratio of the level of RNA encoded by at least one gene of the set of one or more genes gene in blood in the test subject compared to the control is less than about 0.90, 0.80, 0.86, 0.84, 0.82, 0.80, 0.78, 0.76, 0.74, 0.72 and/or 0.7. In a further embodiment, the ratio of the level of RNA encoded by at least one gene of the set of one or more genes gene in blood in the test subject compared to the control is greater than about 1.20, 1.22, 1.24, 1.26, 1.28, 1.30, 1.32, 1.34, 1.36, 1.38, 1.40, 1.42, 1.44, 1.46, 1.48, 1.5 and/or 1.52. In some embodiments, the ratio of the level of RNA encoded by each gene of the set of one or more genes in blood in the test subject compared to the control is the ratio at a sensitivity of 0.6. In yet another embodiment, the ratio of the level of RNA encoded by each gene of the set of one or more genes in blood in the test subject compared to the control is selected from a range which includes an extreme NYHA III-IV/average control ratio, for example as set forth in Table 3 or Table 4.

In another aspect of the disclosure, there is provided a method of classifying a human test subject as more likely to not have heart failure than to have NYHA class III-IV heart failure, the method comprising, for each gene of a set of one or more of the genes listed in Table 4: a) determining a level of RNA encoded by the gene in blood of the test subject, thereby generating a test data; b) providing a first positive control data representing levels of RNA encoded by the gene in blood of human control subjects having NYHA class III-IV heart failure; and c) comparing the data of steps a) and b) to thereby determine at least one value indicating whether the test data corresponds to the first positive control data; wherein an indication by the at least one value, for each gene of the set, that the test data corresponds to the first positive control data classifies the test subject as more likely not to have heart failure than to have NYHA class III-IV heart failure. In one embodiment, step c) is effected by causing a suitably programmed computer to compare a test data to a control data to thereby determine at least one value indicating whether the test data corresponds to a first positive control data.

In one embodiment, the method further provides: (d) providing a positive control data representing levels of RNA encoded by the gene in blood of human control subjects having NYHA class III-IV heart failure; wherein a more likely correspondence between the test data and the negative control data than a correspondence between the test data and the first positive control data indicates that the test subject is more likely to not have heart failure than to have NYHA class III-IV heart failure.

In one embodiment, the ratio of the level of RNA encoded by each gene of the set of one or more genes in blood in the test subject compared to the control is the ratio at a specificity of 0.6. In another embodiment, the ratio of the level of RNA encoded by each gene of the set of one or more genes in blood in the test subject compared to the control is selected from a range which includes an extreme control/average control ratio, for example as set forth in Table 3 or Table 4.

In various aspects the disclosure provides computer-based methods for classifying human test subjects in relation to heart failure.

Accordingly, in one aspect of the disclosure there is provided a computer-based method for classifying a human test subject as more likely to have NYHA class I-II heart failure than to not have heart failure, the method comprising, for each gene of a set of one or more of the genes listed in Table 3: inputting, to a computer, test data representing a level of RNA encoded by the gene in blood of the test subject; and causing the computer to compare the test data to a first positive control data representing levels of RNA encoded by the gene in blood of human control subjects having heart failure, wherein correspondence between the test data and the first positive control data classifies the subject as more likely to have NYHA class I-II heart failure than to not have heart failure.

In another aspect of the disclosure there is provided a computer-based method for classifying a human test subject as more likely to not have heart failure than to have NYHA I-II heart failure, the method comprising, for each gene of a set of one or more of the genes listed in Table 3: inputting, to a computer, test data representing a level of RNA encoded by the gene in blood of the test subject; and causing the computer to compare the test data to a first negative control data representing levels of RNA encoded by the gene in blood of human control subjects having heart failure, wherein correspondence between the test data and the first negative control data classifies the subject as more likely not to have heart failure than to have NYHA class I-II heart failure.

In yet another aspect of the disclosure there is provided a computer-based method for classifying a human test subject as more likely to have NYHA class III-IV heart failure than to not have heart failure, the method comprising, for each gene of a set of one or more of the genes listed in Table 4: inputting, to a computer, test data representing a level of RNA encoded by the gene in blood of the test subject; and causing the computer to compare the test data to a first positive control data representing levels of RNA encoded by the gene in blood of human control subjects having heart failure, wherein correspondence between the test data and the first positive control data classifies the subject as more likely to have NYHA class III-IV heart failure than to not have heart failure.

In still another aspect of the disclosure, there is provided a computer-based method for classifying a human test subject as more likely to not have heart failure than to have NYHA class III-IV heart failure, the method comprising, for each gene of a set of one or more of the genes listed in Table 4: inputting, to a computer, test data representing a level of RNA encoded by the gene in blood of the test subject; and causing the computer to compare the test data to a first negative control data representing levels of RNA encoded by the gene in blood of human control subjects having heart failure, wherein correspondence between the test data and the first negative control data classifies the subject as more likely to not have failure than to have NYHA class III-IV heart failure.

In yet a further aspect, there is provided a computer-based method of classifying a human test subject as having decompensated heart failure, the method comprising, for each gene of a set of one or more of the genes listed in Tables 7 and 8: inputting, to a computer, test data representing a level of RNA encoded by the gene in blood of the test subject; and causing the computer to compare the test data to a control data representing a level of RNA encoded by the gene in blood of human control subjects not having heart failure, and to determine whether the level of RNA encoded by the gene in blood of the test subject is lower than the level of RNA encoded by the gene in blood of human control subjects not having heart failure, wherein a determination that the level of RNA encoded by the gene in blood of the test subject is lower than the level of RNA encoded by the gene in blood of human control subjects not having heart failure is used to classify the test subject as having decompensated heart failure.

According to still another aspect of the disclosure there is provided a kit comprising packaging and containing, for each gene of a set of one or more of the genes listed in Table 1 a primer set capable of generating an amplification product of DNA complementary to RNA encoded, in a human subject, only by the gene.

According to further features of the disclosure described below, the kit further comprises a computer-readable medium having instructions stored thereon that are operable when executed by a computer for comparing a test data representing a level of RNA encoded by the gene in blood of a human test subject to a first positive control data representing levels of RNA encoded by the gene in blood of human control subjects having a first categorized severity of heart failure, to thereby determine at least one value indicating whether the test data corresponds to the control data wherein an indication by the at least one value that the test data corresponds to the first positive control data classifies the test subject as having the first categorized severity of heart failure.

In another embodiment, the computer readable medium further has instructions stored thereon that are operable when executed by a computer for comparing a second positive control data representing levels of RNA encoded by the gene in blood of human control subjects having a second categorized severity of heart failure, wherein correspondence between the test data and the second positive control data indicates that the test subject has the second categorized severity of heart failure.

In yet another aspect, there is provided a kit comprising packaging and containing, for each gene of a set of one or more of the genes listed in Table 1, a primer set capable of generating an amplification product of DNA complementary to RNA encoded, in a human subject, only by the gene.

According to further features of the disclosure described below, the kit further comprises a thermostable polymerase, a reverse transcriptase, deoxynucleotide triphosphates, nucleotide triphosphates and/or enzyme buffer.

According to further features of the disclosure described below, the kit further comprises at least one labeled probe capable of selectively hybridizing to either a sense or an antisense strand of the amplification product.

According to further features of the disclosure described below, the level of RNA encoded by the gene in blood of the test subject is determined by quantitative reverse transcriptase-polymerase chain reaction analysis.

According to further features of the disclosure described below, the level of RNA encoded by the gene in blood of the test subject is determined by probing a microarray.

According to further features of the disclosure described below, the level of RNA encoded by the gene in blood of the test subject and the levels of RNA encoded by the gene in blood of the control subjects are determined by the same method.

In further aspects, there is provided isolated compositions, test systems and primer sets for use in the methods disclosed herein.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

An embodiment of the disclosure will now be described in relation to the drawings in which:

FIG. 1 shows an exemplary computer system.

### DETAILED DESCRIPTION OF THE DISCLOSURE

As will become apparent, preferred features and characteristics of one aspect are applicable to any other aspect. It should be noted that, as used herein, the singular form “a”, “an” and “the” include plural references unless the context clearly dictates otherwise.

The term “encode” as used herein means that a polynucleotide, including a gene, is said to “encode” a RNA and/or polypeptide if, in its native state or when manipulated by methods well known to those skilled in the art, it can be transcribed and/or translated to produce the mRNA for and/or the polypeptide or a fragment thereof. The anti-sense strand is the complement of such a nucleic acid, and the encoding sequence can be deduced there from.

The term “label” as used herein refers to a composition capable of producing a detectable signal indicative of the presence of the target polynucleotide in an assay sample. Suitable labels include radioisotopes, nucleotide chromophores, enzymes, substrates, fluorescent molecules, chemiluminescent moieties, magnetic particles, bioluminescent moieties, and the like. As such, a label is any composition detectable by spectroscopic, photochemical, biochemical, immunochemical, electrical, optical or chemical means.

As used herein, a “sample” refers to a sample of tissue or fluid isolated from an individual, including but not limited to, for example, blood, plasma, serum, tumor biopsy, urine, stool, sputum, spinal fluid, pleural fluid, nipple aspirates, lymph fluid, the external sections of the skin, respiratory, intestinal, and genitourinary tracts, tears, saliva, milk, cells (including but not limited to blood cells), organs, and also samples of in vitro cell culture constituent.

The term “gene” as used herein is a polynucleotide which may include coding sequences, intervening sequences and regulatory elements controlling transcription and/or translation. Genes of the disclosure include normal alleles of the gene encoding polymorphisms, including silent alleles having no effect on the amino acid sequence of the gene's encoded polypeptide as well as alleles leading to amino acid sequence variants of the encoded polypeptide that do not substantially affect its function. These terms also may optionally include alleles having one or more mutations which affect the function of the encoded polypeptide's function.

The polynucleotide compositions, such as primers, of this disclosure include RNA, cDNA, DNA complementary to target cDNA of this disclosure or portion thereof, genomic DNA, unspliced RNA, spliced RNA, alternately spliced RNA, synthetic forms, and mixed polymers, both sense and antisense strands, and may be chemically or biochemically modified or may contain non-natural or derivatized nucleotide bases, as will be readily appreciated by those skilled in the art.

Where nucleic acid according to the disclosure includes RNA, reference to the sequence shown should be construed as reference to the RNA equivalent, with U substituted for T.

The term “amount” or “level” of RNA encoded by a gene described herein encompasses the absolute amount of the RNA, the relative amount or concentration of the RNA, as well as any value or parameter which correlates thereto.

The methods of nucleic acid isolation, amplification and analysis are routine for one skilled in the art and examples of protocols can be found, for example, in the Molecular Cloning: A Laboratory Manual (3-Volume Set) Ed. Joseph Sambrook, David W. Russel, and Joe Sambrook, Cold Spring Harbor Laboratory; 3rd edition (Jan. 15, 2001), ISBN: 0879695773. Particularly useful protocol source for methods used in PCR amplification is PCR (Basics: From Background to Bench) by M. J. McPherson, S. G. Moller, R. Beynon, C. Howe, Springer Verlag; 1st edition (Oct. 15, 2000), ISBN: 0387916008.

“Heart failure” as used herein means a condition that impairs the ability of the heart to fill with blood or pump a sufficient amount of blood through the body resulting from a structural or functional cardiac disorder. Heart failure may be interchangeably referred to as congestive heart failure (CHF) or congestive cardiac failure (CCF). Stages of heart failure may be defined using any one of various classification systems known in the art. For example, heart failure may be classified using the New York Heart Association (NYHA) classification system. According to the NYHA classification system, there are 4 main classes of heart failure; NYHA stage I (NYHA I) heart failure, NYHA stage II (NYHA II) heart failure. NYHA stage III (NYHA III) heart failure and NYHA stage IV (NYHA IV) heart failure. These stages classify heart failure according to the following: NYHA I: No symptoms and no limitation in ordinary physical activity; NYHA II: Mild symptoms (mild shortness of breath and/or angina pain) and slight limitation during ordinary activity; NYHA III: Marked limitation in activity due to symptoms, even during less-than-ordinary activity (e.g. walking short distances, about 20 to 100 meters). Comfortable only at rest; NYHA IV: Severe limitations. Symptoms are experienced even while at rest, mostly bedbound patients.

As used herein, “Compensated heart failure” corresponds to NYHA I/NYHA II heart failure.

As used herein, “Decompensated heart failure” means corresponds to NYHA III/NYHA IV heart failure.

A “control population” refers to a defined group of individuals or a group of individuals with or without heart failure or with a particular heart failure classification, and may optionally be further identified by, but not limited to geographic, ethnic, race, gender, one or more other conditions or diseases, and/or cultural indices. In most cases a control population may encompass at least 10, 50, 100, 1000, or more individuals.

“Positive control data” encompasses data representing levels of RNA encoded by a target gene disclosed herein in each of one or more subjects having heart failure or a particular heart failure classification, and encompasses a single data point representing an average level of RNA encoded by a target gene in a plurality of subjects having heart failure or the particular heart failure classification.

“Negative control data” encompasses data representing levels of RNA encoded by a target gene described herein in each of one or more subjects not having heart failure, and encompasses a single data point representing an average level of RNA encoded by a target gene of the disclosure in a plurality of subjects not having heart failure.

According to one embodiment, subjects not having heart failure are healthy subjects.

The probability that test data “corresponds” to positive control data or negative control data refers to the probability, when comparing to positive control data, that the test data is more likely to be characteristic of data obtained in subjects having heart failure or the particular heart failure classification than in subjects not having any heart failure or the particular heart failure classification, or, when comparing to negative control data, that the test data is more likely to be characteristic of data obtained in subjects not having any heart failure or the particular heart failure classification than in subjects having heart failure or the particular heart failure classification, respectively.

A gene expression profile for heart failure or a particular heart failure classification found in blood at the RNA level of one or more of the genes listed in Tables 1, 3, 4, 5, 6, 7 and 8, can be identified or confirmed using many techniques, including but preferably not limited to PCR methods, as for example discussed further in the working examples herein, Northern analyses and the microarray technique. This gene expression profile can be measured in a bodily sample, such as blood, using microarray technology. In an embodiment of this method, fluorescently labeled cDNA probes may be generated through incorporation of fluorescent nucleotides by reverse transcription of RNA extracted from blood. Labeled cDNA probes applied to the chip hybridize with specificity to each spot of DNA on the array. Quantitation of hybridization of each arrayed element allows for assessment of corresponding mRNA abundance. For example, with dual color fluorescence, separately labeled cDNA probes generated from two sources of RNA are hybridized pair wise to the array. The relative abundance of the transcripts from the two sources corresponding to each specified gene is thus determined simultaneously. Such methods have been shown to have the sensitivity required to detect rare transcripts, which are expressed at a few copies per cell, and to reproducibly detect at least approximately two-fold differences in the expression levels (Schena et al., Proc. Natl. Acad. Sci. USA 93(2):106-149 (1996)). Microarray analysis can be performed by commercially available equipment, following manufacturer's protocols, such as by using the Affymetrix GenChip technology, or Incyte's microarray technology.

The phrase “receiver operating characteristic” or ROC curve, as used herein refers to a plot of true positive versus false positive results, usually in a trial of a diagnostic test. A ROC curve is a graphical means of assessing the ability of a screening test to discriminate between healthy/non-diseased and diseased persons.

The term “specificity” as used herein means the percentage of subjects who do not have a disorder (e.g. heart failure), or stage/class thereof, who are identified by an assay for the disorder, or stage/class thereof, as negative for the disorder, or stage/class thereof, respectively.

The term “sensitivity” as used herein means the percentage of subjects who have a disorder, or stage/class thereof, who are identified by an assay for the disorder, or stage/class thereof, as positive for the disorder, or stage/class thereof, respectively.

The phrase “threshold fold-change” as used herein refers to a fold change expression level threshold relative to average of subjects not having heart failure that is suitable for classifying a test subject, for example classifying a test subject as more likely to have NYHA class I-II heart failure than to not have heart failure at a particular sensitivity (e.g. 0.6) or specificity (e.g. 0.6).

The phrase “extreme NYHA/average control” is a ratio of the extreme directional NYHA subject expression level of a gene to the average control expression level of the gene. The ratio is useful to limit a range of fold-change expression which classifies a test subject, for example as more likely to have heart failure or a stage/class thereof, than to not have heart failure. For a gene which is overexpressed in subjects having heart failure or stage/class thereof relative to subjects not having heart failure (having a fold-change relative to average expression in subjects not having heart failure which is greater than 1), “extreme NYHA/average control” is a ratio of the highest level of gene expression observed in a subject having heart failure, or the stage/class thereof, relative to average expression in subjects not having heart failure (e.g. healthy controls), for example, as exemplified in Table 3 or Table 4, based on data provided in Table 1. For a gene which is underexpressed in subjects having heart failure, or a stage/class thereof relative to subjects not having heart failure, or the class/stage thereof, (having a fold-change relative to average expression in subjects not having heart failure which is less than 1), “extreme NYHA/average control” is a ratio of the lowest level of gene expression observed in a subject having heart failure, or the stage/class thereof, relative to average expression in subjects not having heart failure (e.g. healthy subjects), for example, as exemplified in Table 3 or Table 4, based on data provided in Table 1.

The phrase “extreme control/average control” as used herein is a ratio of the extreme directional control subject expression level of a gene to the average control expression level for the gene. The ratio is useful as a limit to the range of fold-change expression which classifies a test subject, for example as more likely to not have heart failure, or a stage/class thereof, than to have heart failure or a stage/class thereof. For a gene which is overexpressed in subjects having heart failure, or a stage/class thereof, relative to subjects not having heart failure (having a fold-change relative to average expression in subjects not having heart failure which is greater than 1), “extreme control/average control” is a ratio of the lowest level of gene expression observed in a control subject not having heart failure sample (e.g. healthy control) relative to average expression in control subjects not having heart failure (e.g. healthy controls), for example, as exemplified in Table 3 or Table 4, based on data provided in Table 1. For a gene which is underexpressed in subjects having heart failure, or a stage/class thereof, relative to subjects not having heart failure (having a fold-change relative to average expression in subjects not having heart failure which is less than 1), “extreme control/average control” is a ratio of the highest level of gene expression observed in a control subject not having heart failure (e.g. healthy control) relative to average expression in control subjects not having heart failure (e.g. healthy control subjects), for example, as exemplified in Table 3 or Table 4, based on data provided in Table 1.

### Methods

According to one aspect, there is provided a method of determining whether a human test subject has heart failure as opposed to not having heart failure, the method comprising for each gene of a set of one or more of the genes listed in Tables 1, 3, 4, 5, 6, 7, and 8: a) determining a level of RNA encoded by the gene in blood of the test subject, thereby generating a test data; b) providing a positive control data representing levels of RNA encoded by the gene in blood of human control subjects having heart failure and a negative control data representing levels of RNA encoded by the gene in blood of human control subjects not having heart failure; and c) comparing the data of steps a) and b) to thereby determine at least one value indicating whether the test data corresponds to the positive control data or the negative control data; wherein an indication by the at least one value, for each gene of the set, that the test data corresponds to the positive control data and not to the negative control data classifies the test subject as having heart failure. In one embodiment, step c) is effected by causing a suitably programmed computer to compare the data of steps a) and b) to thereby determine the at least one value indicating whether the test data corresponds to the positive control data or the negative control data.

According to another aspect, there is provided a method of determining a severity of heart failure in a human test subject, the method comprising for each gene of a set of one or more of the genes listed in Tables 5, 6, 7 and 8: a) determining a level of RNA encoded by the gene in blood of the test subject', thereby generating a test data; (b) providing a first positive control data representing levels of RNA encoded by the gene in blood of human control subjects having a first categorized severity of heart failure; and c) comparing the levels of steps a) and b) to thereby determine at least one value indicating whether the test data corresponds to the positive control data; wherein an indication by the at least one value, for each gene of the set, that the test data corresponds to the first positive control data classifies the test subject as having the first categorized severity of heart failure. In one embodiment, step c) is effected by causing a suitably programmed computer to compare the levels of steps a) and b) to thereby determine the at least one value indicating whether the test data corresponds to the positive control data.

In one embodiment, the first categorized severity is compensated heart failure or decompensated heart failure.

In another embodiment, the method further comprises providing a second positive control data representing levels of RNA encoded by the gene in blood of human control subjects having a second categorized severity of heart failure, wherein correspondence between the test data and the second positive control data indicates that the test subject has the second categorized severity of heart failure. In one embodiment, the first categorized severity is compensated heart failure and the second categorized severity is decompensated heart failure. In such an embodiment, the method allows determination of the likelihood that a particular heart failure patient falls within a compensated heart failure class or a decompensated heart failure class, which is relevant to types of treatment available to the subject.

In an embodiment, the method further comprises determining levels of RNA encoded by the gene in blood of a population of human subjects having the first categorized severity of heart failure, thereby providing the positive control data representing the levels of RNA encoded by the gene in blood of human control subjects having the first categorized severity of heart failure. In yet another embodiment, the method further comprises determining levels of RNA encoded by the gene in blood of a population of human subjects having the second categorized severity of heart failure, thereby providing the positive control data representing the levels of RNA encoded by the gene in blood of human control subjects having the second categorized severity of heart failure.

In a further embodiment, the method further comprises providing a third control data representing levels of RNA encoded by the gene in blood of human control subjects which not having heart failure, and wherein step c) is effected by comparing the test data to the first or second positive control data and the third control data, wherein correspondence with the first or second positive control data and not the third control data indicates that the test subject has the first or second categorized severity of heart failure.

In a further aspect, there is provided a method of monitoring the progression of heart failure in a human subject, the method comprising for each gene of a set of one or more of the genes listed in Table 5: a) determining a level of RNA encoded by the gene in blood of the subject at a first time point; b) determining a level of RNA encoded by the gene in blood of the subject at a second time point, wherein the second time point is later than the first time point; and c) comparing the levels of steps a) and b) to thereby determine at least one value indicating whether the level at the second time point is higher than the level at the first time point; wherein an indication by the at least one value, for each gene of the set, that the level at the second time point is higher than the level at the first time point indicates a progression of heart failure. In one embodiment, step c) is effected by causing a suitably programmed computer to compare a level of RNA encoded by a gene at a first time point to a level of RNA encoded by the gene at the second time point to thereby determine at least one value indicating whether the level at the second time point is higher than the level at the first time point.

In another aspect, there is provided a method of monitoring the progression of heart failure in a human subject, the method comprising, for each gene of a set of one or more of the genes listed in Table 7: a) determining a level of RNA encoded by the gene in blood of the subject at a first time point; b) determining a level of RNA encoded by the gene in blood of the subject at a second time point; and c) comparing the levels of steps a) and b) to thereby determine at least one value indicating whether the level at the second time point is lower than the level at the first time point; wherein an indication by the at least one value, for each gene of the set, that the level at the second time point is lower than the level at the first time point indicates a progression of heart failure. In one embodiment, step c) is effected by causing a suitably programmed computer to compare a level of RNA encoded by a gene at the first time point to a level of RNA encoded by the gene at the second time point to thereby determine the at least one value indicating whether the level at the second time point is lower than the level at the first time point.

In another aspect, there is provided a method for classifying a human test subject as having heart failure comprising, for each gene of a set of one or more of the genes listed in Tables 5 and 6: a) determining a level of RNA encoded by the gene, thereby generating a test data; b) providing a control data representing a level of RNA encoded by the gene in blood of human control subjects, wherein the control subjects do not have heart failure; and c) comparing the test data to the control data to thereby determine at least one value indicating whether the level of RNA encoded by the gene in blood of the test subject is higher than the levels of RNA encoded by the gene in blood of the control subjects, wherein an indication by the at least one value that the level of RNA encoded by the gene in blood of the test subject is higher than the level of RNA encoded by the gene in blood of the control subjects classifies the test subject as having heart failure. In one embodiment, step c) is effected by causing a suitably programmed computer to compare the test data to the control data to thereby determine the at least one value indicating whether the level of RNA encoded by the gene in blood of the test subject is higher than the levels of RNA encoded by the gene in blood of the control subjects.

In another aspect, there is provided a method for classifying a human test subject as having heart failure comprising, for each gene of a set of one or more of the genes listed in Tables 7 and 8: a) determining a level of RNA encoded by the gene, thereby generating a test data; b) providing control data representing levels of RNA encoded by the gene in blood of human control subjects wherein the control subjects do not have heart failure; and c) comparing the test data to the control data to thereby determine at least one value indicating whether the level of RNA encoded by the gene in blood of the test subject is lower than the level of RNA encoded by the gene in blood of the control subjects, wherein an indication by the at least one value that the level of RNA encoded by the gene in blood of the test subject is lower than the level of RNA encoded by the gene in blood of the control subjects classifies the test subject as having heart failure. In one embodiment, step c) is effected by causing a suitably programmed computer to compare the test data to the control data to thereby determine the at least one value indicating whether the level of RNA encoded by the gene in blood of the test subject is lower than the level of RNA encoded by the gene in blood of the control subjects.

In a further aspect, there is provided a method of classifying a human test subject as having decompensated heart failure, the method comprising a) determining a level of RNA encoded by each gene of a set of one or more of the genes listed in Table 5 in blood of the test subject, thereby generating a test data; b) providing a control data representing a level of RNA encoded by the gene in blood of human control subjects not having heart failure; and c) comparing the test data to the control data to thereby determine at least one value indicating whether the level of RNA encoded by the gene in blood of the test subject is higher than the level of RNA encoded by the gene in blood of human control subjects not having heart failure, wherein an indication by the at least one value that the level of RNA encoded by the gene in blood of the test subject is higher than the level of RNA encoded by the gene in blood of human control subjects not having heart failure classifies the test subject as having decompensated heart failure. In one embodiment, step c) is effected by causing a suitably programmed computer to compare the test data to the control data to thereby determine the at least one value indicating whether the level of RNA encoded by the gene in blood of the test subject is higher than the level of RNA encoded by the gene in blood of human control subjects not having heart failure.

In yet another aspect, there is provided a method of classifying a human test subject as having decompensated heart failure, the method comprising for each gene of a set of one or more of the genes listed in Table 7: a) determining a level of RNA encoded by the gene in blood of the test subject, thereby generating a test data; b) providing a control data representing a level of RNA encoded by the gene in blood of human control subjects not having heart failure; and c) comparing the test data to the control data to thereby determine at least one value indicating whether the level of RNA encoded by the gene in blood of the test subject is lower than the level of RNA encoded by the gene in blood of human control subjects not having heart failure, wherein an indication by the at least one value that the level of RNA encoded by the gene in blood of the test subject is lower than the level of RNA encoded by the gene in blood of human control subjects not having heart failure classifies the test subject as having decompensated heart failure. In one embodiment, step c) is effected by causing a suitably programmed computer to compare a test data to a control data to thereby determine the at least one value indicating whether the level of RNA encoded by the gene in blood of the test subject is lower than the level of RNA encoded by the gene in blood of human control subjects not having heart failure.

Determining whether the level of RNA of a gene in blood of the test subject is higher than the level of RNA encoded by the gene in blood of control subjects not having heart failure or in the same subject at a different time point may be effected by determining whether there is a fold-change in the level between the test subject and the control subjects or different time point which is higher than a minimum fold-change and/or which is within a range of fold-changes.

Determining whether the level of RNA of a gene in blood of the test subject is lower than the level of RNA encoded by the gene in blood of control subjects not having heart failure or in the same subject at a different time point may be effected by determining whether there is a fold-change in the level between the test subject and the control subjects or different time point which is lower than a maximum fold-change and/or which is within a range of fold-changes.

For a gene which is overexpressed in subjects having heart failure or stage/class thereof relative to subjects not having heart failure (having a fold-change relative to average expression in subjects not having heart failure which is greater than 1), a test subject having an expression level of the gene relative to average of subjects not having heart failure which equals or exceeds a threshold fold-change for sensitivity (e.g. average fold-change expression at sensitivity=0.6, as indicated in Table 3 and Table 4) is classified as being more likely to have heart failure or the stage/class thereof than to not have heart failure.

For a gene which is overexpressed in subjects having heart failure or stage/class thereof relative to subjects not having heart failure, a test subject having an expression level of the gene which is below the threshold fold-change for specificity (e.g. average fold-change expression at specificity=0.6, as indicated in Table 3 and Table 4) is classified as more likely to not have heart failure than to have heart failure or the stage/class thereof.

For a gene which is underexpressed in subjects having heart failure or stage/class thereof relative to subjects not having heart failure (having a fold-change relative to average expression in subjects not having heart failure which is less than 1), a test subject having an expression level of the gene relative to average of subjects not having heart failure which is less than or equal to the threshold fold-change for sensitivity (e.g. average fold-change expression at sensitivity=0.6, as indicated in Table 3 and Table 4) is classified as being more likely to have the heart failure or the stage/class thereof than to not have heart failure.

For a gene which is underexpressed in subjects having heart failure or stage/class thereof relative to subjects not having heart failure, a test subject having an expression level of the gene which is greater than the threshold fold-change for specificity (e.g. average fold-change expression at specificity=0.6, as indicated in Table 3 and Table 4) is classified as more likely to not have heart failure than to have heart failure or the stage/class thereof.

Optionally, the range of fold-changes classifying a test subject as more likely to have heart failure or the stage thereof than to not have heart failure may include, and be limited by, the extreme directional fold-change observed (Extreme NYHA/average Control), indicated in Table 3 and Table 4, as well as by the threshold fold-change at a given sensitivity. Further, optionally, the range of fold-changes classifying a test subject as more likely to not have heart failure than to have heart failure or the stage thereof may be limited by the extreme directional fold-change observed (Extreme Control/average Control), as indicated in Table 3 and Table 4, as well as by the threshold fold-change at a given specificity.

Examples of suitable fold-changes and ranges of fold-changes for classifying a test subject are provided in Tables 3, 4, 5, 6, 7 and 8, and include the following ones. The methods recited in the above and below paragraphs can be done with “about” the cited amounts.

A person skilled in the art will recognize that accuracy of classification power of the genes in terms of ROC AUC increases with increasing ROC AUC values.

Accordingly, in one embodiment, each gene of the set of one or more genes has a ROC AUC of at least 0.68, 0.70, 0.72, 0.74, 0.76, 0.78 and/or 0.80.

In certain embodiments, the genes in the gene set comprise genes having a particular fold change expression compared to control.

In one embodiment, wherein the level of gene expression in a class of heart failure is increased, the fold change to classify a test subject as NYHA I-U, a suitable minimum fold-change is about 1.20, 1.22, 1.24, 1.26, 1.28, 1.30, 1.32, 1.34, 1.36, 1.38, 1.40, 1.42, 1.44, 1.46, 1.48, 1.5 and/or 1.52 fold and/or greater than 1.52 fold, and a suitable range of fold-changes is about 1.20 to 1.7 fold, 1.25-1.65 fold, 1.30-1.60 fold, 1.35 to 1.55 fold, 1.40 to 1.50 fold, relative to an average level of RNA encoded by the gene in blood of subjects not having heart failure. To classify a test subject as NYHA-III-IV, a suitable minimum fold-change is greater than or equal about 1.20, 1.22, 1.24, 1.26, 1.28, 1.30, 1.32, 1.34, 1.36, 1.38, 1.40, 1.42, 1.44, 1.46, 1.48, 1.50, 1.52, 1.60, 1.70, 1.80, 1.90 and/or 2.00 fold and/or greater than 2.00 fold, and a suitable range of fold-changes is about 1.20 to 2.10 fold, 1.25 to 2.10 fold, 1.30 to 2.10 fold, 1.35 to 2.10 fold, 1.40 to 2.10 fold, relative to an average level of RNA encoded by the gene in blood of subjects not having heart failure.

In one embodiment wherein the level of gene expression in a class of heart failure is decreased, the fold change to classify a test subject as NYHA I-II, and/or NYHA III/IV a suitable minimum fold-change is about is less than about 0.90, 0.80, 0.86, 0.84, 0.82, 0.80 and/or 0.7 and a suitable range of fold-changes is about 0.90 to 0.60 fold, 0.88 to 0.60 fold, 0.84 to 0.60 fold, 0.80 to 0.6 fold, 0.76 to 0.60 fold, 0.72 to 0.60 fold, or 0.68 to 0.60 fold

In addition a cut-off value corresponding to a desired specificity and or specificity can be selected. In one embodiment, the sensitivity is 0.6. In another embodiment, the specificity is 0.6.

As used herein, the term “about” refers to a variability of plus or minus 10 percent.

Thus, a test subject is classified or determined as having or being more likely to have heart failure or a particular heart failure classification than to not have it if, for each marker gene of the particular set of marker genes used to practice the method of classifying or determining, the fold-change in level of RNA encoded by that gene in blood of the test subject relative to blood of the control subjects not having heart failure or the particular heart failure classification, classifies or determines that the test subject has or is more likely to have heart failure or the particular heart failure classification than to not have it.

Conversely, a test subject is classified or determined as having or being more likely to not have heart failure or the particular heart failure classification if for each marker gene of the particular set of marker genes used to practice the method of classifying or determining, the fold-change in level of RNA encoded by that gene in blood of the test subject relative to blood of the control subjects does not classify or determine the test subject as having or being more likely to have heart failure or the particular heart failure classification than to not have it.

In one aspect, the set of one or more heart failure marker genes may consist of any one of the possible combinations of one or more of the genes set out in Tables 1, 3, 4, 5, 6, 7, and 8.

In an aspect of the present disclosure, the level of RNA encoded by the gene in blood of the test subject is determined as a ratio to a level of RNA encoded by the gene in blood of a test subject not having heart failure.

It will be appreciated that data representing levels of RNA encoded by a set of genes of the disclosure may be combined with data representing levels of gene products of other genes which are differently expressed in blood in subjects having heart failure relative to subjects not having any heart failure so as to determine a probability that a test subject has heart failure versus not having heart failure, or for the purposes of classifying the stage of heart failure.

In another aspect, the method further comprises determining levels of RNA encoded by the gene in blood of a population of control human subjects having heart failure, and/or in blood of a population of human control subjects not having heart failure, to thereby provide the positive control data and/or the negative control data, respectively. Alternately, it is envisaged that the level of RNA encoded by a gene disclosed herein in control subjects of the disclosure could be provided by prior art data corresponding to a control data. In one embodiment, there is provided a first positive control data derived from subjects having a first categorized severity of heart disease, optionally, compensated or decompensated heart failure. In another embodiment, there is a first and second positive control data and the first positive control data is derived from subjects having compensated heart failure and the second positive control data is derived from subjects having decompensated heart failure.

The method may be practiced using any one of various types of control subjects.

In an aspect, the control subjects not having heart failure are subjects having been diagnosed as not having any heart failure as a result of routine examination. The methods disclosed herein may be practiced using subjects not having heart failure as the control subjects not having heart failure.

The methods described herein may furthermore be practiced using any one of various numbers of control subjects. One of ordinary skill in the art will possess the necessary expertise to select a sufficient number of control subjects so as to obtain control data having a desired statistical significance for practicing the method of the disclosure with a desired level of reliability.

For example, the method can be practiced using 1, 2, 3, 4, 5, 5 or more, 10 or more, 20 or more, 30 or more, 40 or more, 50 or more, 60 or more, 70 or more, 80 or more, 90 or more, 100 or more, 10 or more, 20 or more, 30 or more, 40 or more, 50 or more, 60 or more, 70 or more, 80 or more, 90 or more, 100 or more, 110 or more, 120 or more, 130 or more, 140 or more, 150 or more, 160 or more, 170 or more, 180 or more, 190 or more, or 200 or more of control subjects having heart failure and/ora particular classification of heart failure and/or of control subjects not having heart failure.

In one aspect of the disclosure, the level of RNA encoded by a gene in blood of the test subject and the levels of RNA encoded by the gene in blood of the control subjects are determined by the same method. As is described in the Examples section, below, the method can be practiced where the level of RNA encoded by a gene in blood of the test subject and the levels of RNA encoded by the gene in blood of the control subjects are determined by the same method. Alternately, it is envisaged that the level of a gene in blood of a test subject and in blood of control subjects could be determined using different methods. It will be appreciated that use of the same method to determine the levels of RNA encoded by a gene disclosed herein in a test subject and in control subjects can be used to avoid method-to-method calibration to minimize any variability which might arise from use of different methods.

In one aspect, determining of the level of RNA encoded by a gene disclosed herein in blood of a subject is effected by determining the level of RNA encoded by the gene in a blood sample isolated from the subject. Alternately, it is envisaged that determination of the level of RNA encoded by the gene in blood of a subject could be effected by determining the level of RNA encoded by the gene in an in-vivo sample using a suitable method for such a purpose.

In one aspect, the level of RNA encoded by a gene in blood of a subject is determined in a sample of RNA isolated from blood of the subject. Alternately, it is envisaged that the level of RNA of a gene in blood of a subject could be determined in a sample which includes RNA of blood of the subject but from which RNA has not been isolated therefrom, using a suitable method for such a purpose.

Any one of various methods routinely employed in the art for isolating RNA from blood may be used to isolate RNA from blood of a subject, so as to enable practicing of the methods described herein.

In one aspect, the level of RNA encoded by a gene in blood of a subject is determined in RNA of a sample of whole blood. Any one of various methods routinely employed in the art for isolating RNA from whole blood may be employed for practicing the method.

Alternately, it is envisaged that the level of RNA encoded by a gene in blood of a subject could be determined in RNA of a sample of fraction of blood which expresses the gene sufficiently specifically so as to enable the method. Examples of such blood fractions include preparations of isolated types of leukocytes, preparations of isolated peripheral blood mononuclear cells, preparations of isolated granulocytes, preparations of isolated whole leukocytes, preparations of isolated specific types of leukocytes, plasma-depleted blood, preparations of isolated lymphocytes, and the plasma fraction of blood.

In one aspect of the method, isolation of RNA from whole blood of a subject of the disclosure is effected using EDTA tubes, as described in the Examples section.

In another aspect of the method, isolation of RNA from whole blood of a subject of the disclosure may be effected by using a PAXgene Blood RNA Tube (obtainable from PreAnalytiX) in accordance with the instructions of the PAXgene Blood RNA Kit protocol.

Determination of a level of RNA encoded by a gene in a sample disclosed herein may be effected in any one of various ways routinely practiced in the art.

For example, the level of RNA encoded by a gene in a sample may be determined by any one of various methods based on quantitative polynucleotide amplification which are routinely employed in the art for determining a level of RNA encoded by a gene in a sample.

Alternatively, the level of RNA encoded by a gene may be determined by any one of various methods based on quantitative polynucleotide hybridization to an immobilized probe which are routinely employed in the art for determining a level of RNA encoded by a gene in a sample.

In one aspect of the methods described herein, quantitative polynucleotide amplification used to determine the level of RNA encoded by a gene is quantitative reverse transcriptase-polymerase chain reaction (PCR) analysis. Any one of various types of quantitative reverse transcriptase-PCR analyses routinely employed in the art to determine the level of RNA encoded by a gene in a sample may be used to practice the methods. For example, any one of various sets of primers may be used to perform quantitative reverse transcriptase-PCR analysis so as to practice the methods.

In one aspect, the quantitative reverse transcriptase-PCR analysis used to determine the level of RNA encoded by a gene is quantitative real-time PCR analysis of DNA complementary to RNA encoded by the gene using a labeled probe capable of specifically binding amplification product of DNA complementary to RNA encoded by the gene. For example, quantitative real-time PCR analysis may be performed using a labeled probe which comprises a polynucleotide capable of selectively hybridizing with a sense or antisense strand of amplification product of DNA complementary to RNA encoded by the gene. Labeled probes comprising a polynucleotide having any one of various nucleic acid sequences capable of specifically hybridizing with amplification product of DNA complementary to RNA encoded by the gene may be used to practice the methods described herein.

Quantitative real-time PCR analysis of a level of RNA encoded by a gene may be performed in any one of various ways routinely employed in the art.

In one aspect, quantitative real-time PCR analysis is performed by analyzing complementary DNA prepared from RNA of blood a subject of the disclosure, using the QuantiTect™ Probe RT-PCR system (Qiagen, Valencia, Calif.; Product Number 204345), a TaqMan dual labelled probe, and a Real-Time PCR System 7500 instrument (Applied Biosystems).

As specified above, the level of RNA encoded by a gene may be determined by a method based on quantitative polynucleotide hybridization to an immobilized probe.

In one aspect, determination of the level of RNA encoded by a gene by a method based on quantitative polynucleotide hybridization is effected using a microarray, such as an Affymetrix U133Plus 2.0 GeneChip oligonucleotide array (Affymetrix; Santa Clara, Calif.).

As specified above, the level of RNA encoded by a gene in a sample of the disclosure may be determined by quantitative reverse transcriptase-PCR analysis using any one of various sets of primers and labeled probes to amplify and quantitate DNA complementary to RNA encoded by a marker gene produced during such analysis. Examples of suitable primers for use in quantitative reverse transcriptase-PCR analysis of the level of RNA encoded by a target gene are within the knowledge of a person skilled in the art.

In one aspect, the primers may be selected so as to include a primer having a nucleotide sequence which is complementary to a region of a target cDNA template, where the region spans a splice junction joining a pair of exons. It will be appreciated that such a primer can be used to facilitate amplification of DNA complementary to messenger RNA, i.e. mature spliced RNA.

It will be appreciated that the probability that the test subject does not have any heart failure as opposed to having heart failure can be readily determined from the probability that the test subject has heart failure as opposed to not having heart failure. For example, when expressing the probability that the test subject has heart failure as a percentage probability, the probability that the test subject does not have any heart failure as opposed to having heart failure corresponds to 100 percent minus the probability that the test subject does not have any heart failure as opposed to having heart failure.

Determining the probability that the test data corresponds to positive control data and not to the negative control data may be effected in any one of various ways known to the ordinarily skilled artisan for determining the probability that a gene expression profile of a test subject corresponds to a gene expression profile of subjects having a pathology and not to a gene expression profile of subjects not having the pathology, where the gene expression profiles of the subjects having the pathology and the subjects not having the pathology are significantly different.

In one aspect of the method, determining the probability that the test data corresponds to the positive control data and not to the negative control data is effected by applying to the test data a mathematical model derived from the positive control data and from the negative control data.

In another aspect, determining whether the test data corresponds to positive control data may be effected in any one of various ways known to the ordinarily skilled artisan for determining whether a gene expression profile of a test subject corresponds to a gene expression profile of subjects having a pathology, where the gene expression profiles of the subjects having the pathology and the subjects not having the pathology are significantly different.

In one aspect, determining whether the test data corresponds to the positive control data is effected by applying to the test data a mathematical model derived from the positive control data.

Various suitable mathematical models which are well known in the art of medical diagnosis using disease markers may be employed to compare test data to a control data so as to classify, according to the present teachings, a test subject as more likely to have or having heart failure or a particular heart failure classification than to not have heart failure or the particular classification, to determine a probability that a test subject is likely to have heart failure or a particular heart failure classification as opposed to not having heart failure or the particular classification, or to diagnose a test subject as having colorectal cancer according to the teachings described herein. Generally these mathematical models can be unsupervised methods performing a clustering whilst supervised methods are more suited to classification of datasets. (refer, for example, to: Dreiseitl G. Ohno-Machado L. Logistic regression and artificial neural network classification models: a methodology review. J Biomed Inform. 2002 October-December; 35(5-6):352-9; Pepe M S. The Statistical Evaluation of Medical Tests for Classification and Prediction. Oxford, England: Oxford University Press; 2003; Dupont W D. Statistical Modeling for Biomedical Researchers. Cambridge, England: Cambridge University Press; 2002; Pampel F C. Logistic regression: A Primer. Publication #07-132, Sage Publications: Thousand Oaks, Calif. 2000; King E N, Ryan T P. A preliminary investigation of maximum likelihood logistic regression versus exact logistic regression. Am Statistician 2002; 56:163-170; Metz C E. Basic principles of ROC analysis. Semin Nucl Med 1978; 8:283-98; Swets J A. Measuring the accuracy of diagnostic systems. Science 1988; 240:1285-93; Zweig M H, Campbell G. Receiver-operating characteristic (ROC) plots: a fundamental evaluation tool in clinical medicine. Clin Chem 1993; 39:561-77; Witten I H, Frank Eibe. Data Mining: Practical Machine Learning Tools and Techniques (second edition). Morgan Kaufman 2005; Deutsch J M. Evolutionary algorithms for finding optimal gene sets in microarray prediction. Bioinformatics 200319:45-52; Niels Landwehr, Mark Hall and Eibe Frank (2003) Logistic Model Trees. pp 241-252 in Machine Learning: ECML 2003: 14th European Conference on Machine Learning, Cavtat-Dubrovnik, Croatia, Sep. 22-26, 2003, Proceedings Publisher: Springer-Verlag GmbH, ISSN: 0302-9743). Examples of such mathematical models, related to learning machine, include: Random Forests methods, logistic regression methods, neural network methods, k-means methods, principal component analysis methods, nearest neighbour classifier analysis methods, linear discriminant analysis, methods, quadratic discriminant analysis methods, support vector machine methods, decision tree methods, genetic algorithm methods, classifier optimization using bagging methods, classifier optimization using boosting methods, classifier optimization using the Random Subspace methods, projection pursuit methods, genetic programming and weighted voting methods.

### Computer-Based Methods

It will be appreciated that a computer may be used for determining the probability that the test subject has heart failure or a particular classification using a mathematical model, according to the methods described herein.

Thus, according to another aspect of the disclosure there is provided a computer-based method of determining a severity of heart failure in a human test subject. Accordingly, there is provided a computer-based method of determining a severity of heart failure in a human test subject, the method comprising, for each gene of a set of one or more of the genes listed in Tables 1, 3, 4, 5, 6, 7 and 8: inputting, to a computer, test data representing a level of RNA encoded by the gene in blood of the test subject; and causing the computer to compare the test data to a first positive control data representing levels of RNA encoded by the gene in blood of human control subjects having a first categorized severity of heart failure, wherein correspondence between the test data and the first positive control data indicates that the test subject has the first categorized severity of heart failure.

In another aspect, there is provided computer-based method of monitoring the progression of heart failure in a human subject. Accordingly, there is provided a computer-based method of monitoring the progression of heart failure in a human subject, the method comprising, for each gene of a set of one or more of the genes listed in Table 5: inputting, to a computer, test data representing a level of RNA encoded by the gene in blood of the subject at a first and second time point, wherein the second time point is later than the first time point; and causing the computer to compare the data of the first time point to the data of the second time point to thereby determine at least one value indicating whether the level at the second time point is higher than the level at the first time point, wherein a determination that the level of RNA encoded by the gene in blood of the test subject is increased at the second time point indicates the progression of heart failure.

In an additional aspect, there is provided a computer-based method of monitoring the progression of heart failure in a human subject, the method comprising, for each gene of a set of one or more of the genes listed in Table 7: inputting, to a computer, test data representing a level of RNA encoded by the gene in blood of the subject at a first time point and a level of RNA encoded by the gene at a second time point; and causing the computer to compare the level at the first time point to the level at the second time point to thereby determine whether the level of RNA encoded by the gene in blood of the subject is decreased at the second time point compared to the level of RNA encoded by the gene in blood of the subject at the first time point, wherein a determination that the level of RNA encoded by the gene in blood of the test subject is decreased at the second time point indicates the progression of heart failure.

A further aspect of the disclosure provides a computer-based method of classifying a human test subject as having heart failure the method comprising, for each gene of a set of one or more of the genes listed in Tables 5 and 6: inputting, to a computer, test data representing a level of RNA encoded by the gene in blood of the test subject; causing the computer to compare the test data to a control data representing a level of RNA encoded by the gene in blood of human control subjects, wherein the control subjects do not have heart failure, to determine whether the level of RNA encoded by the gene in blood of the test subject is higher than the level of RNA encoded by the gene in blood of human control subjects; wherein a determination that the level of RNA encoded by the gene in blood of the test subject is higher than the level of RNA encoded by the gene in blood of human control subjects is used to classify the test subject as having heart failure.

Yet a further aspect provides a computer-based method of Classifying a human test subject as having heart failure the method comprising for each gene of a set of one or more of the genes listed in Tables 7 and 8: inputting, to a computer, test data representing a level of RNA encoded by the gene in blood of the test subject; causing the computer to compare the test data to a control data representing a level of RNA encoded by the gene in blood of human control subjects, wherein the control subjects do not have heart failure, to determine whether the level of RNA encoded by the gene in blood of the test subject is higher than the level of RNA encoded by the gene in blood of human control subjects; and wherein a determination that the level of RNA encoded by the gene in blood of the test subject is lower than the level of RNA encoded by the gene in blood of human control subjects is used to classify the test subject as having heart failure

Another aspect provides a method for classifying a human test subject as having compensated heart failure comprising, for each gene of a set of one or more of the genes listed in Tables 5 and 6: a) determining a level of RNA encoded by the gene, thereby generating a test data; b) providing control data representing levels of RNA encoded by the gene in blood of human control subjects, wherein the control subjects do not have heart failure; and c) comparing the test data to the control data, wherein a determination in step (c) that the level of RNA encoded by the gene in blood of the test subject is higher than the level of RNA encoded by the gene in blood of the control subjects indicates the test subject has heart failure.

Another aspect provides a method for classifying a human test subject as having compensated heart failure, the method comprising, for each gene of a set of one or more of the genes listed in Tables 7 and 8: a) determining a level of RNA encoded by the gene, thereby generating a test data; b) providing a control data representing a level of RNA encoded by the gene in blood of human control subjects, wherein the control subjects do not have heart failure; and c) comparing the test data to the control data to thereby determine at least one value indicating whether the level of RNA encoded by the gene in blood of the test subject is higher than the level of RNA encoded by the gene in blood of the control subjects, wherein an indication by the at least one value that the level of RNA encoded by the gene in blood of the test subject is higher than the level of RNA encoded by the gene in blood of the control subjects classifies the test subject as having heart failure. In one embodiment, step c) is effected by causing a suitably programmed computer to compare the test data to the control data to thereby determine the at least one value indicating whether the level of RNA encoded by the gene in blood of the test subject is higher than the level of RNA encoded by the gene in blood of the control subjects.

According to another aspect of the disclosure there is provided a computer-based method of classifying a human test subject as having decompensated heart failure. Accordingly, there is provided a computer-based method of classifying a human test subject as having decompensated heart failure, the method comprising, for each gene of a set of one or more of the genes listed in Tables 5 and 6: inputting, to a computer, test data representing a level of RNA encoded by the gene in blood of the test subject; and causing the computer to compare the test data to a control data representing a level of RNA encoded by the gene in blood of human control subjects not having heart failure, and to determine whether the level of RNA encoded by the gene in blood of the test subject is higher than the level of RNA encoded by the gene in blood of human control subjects not having heart failure, wherein a determination that the level of RNA encoded by the gene in blood of the test subject is higher than the level of RNA encoded by the gene in blood of human control subjects not having heart failure is used to classify the test subject as having decompensated heart failure.

In yet a further aspect, there is provided a computer-based method of classifying a human test subject as having decompensated heart failure, the method comprising, for each gene of a set of one or more of the genes listed in Tables 7 and 8, inputting, to a computer, test data representing a level of RNA encoded by the gene in blood of the test subject; and causing the computer to compare the test data to a control data representing a level of RNA encoded by the gene in blood of human control subjects not having heart failure, and to determine whether the level of RNA encoded by the gene in blood of the test subject is lower than the level of RNA encoded by the gene in blood of human control subjects not having heart failure, wherein a determination that the level of RNA encoded by the gene in blood of the test subject is lower than the level of RNA encoded by the gene in blood of human control subjects not having heart failure is used to classify the test subject as having decompensated heart failure.

Application of computers for determining a probability that a test subject has a disease, or whether a test subject has a disease as opposed to not having the disease, so as to enable the method, is routinely practiced in the art using computer systems, and optionally computer-readable media, routinely used in the art.

Thus, according to a further aspect of the disclosure there is provided a computer system for providing the probability or determining that the test subject has heart failure or a particular classification as opposed to not having heart failure or the particular classification. The computer system comprises a processor; and a memory configured with instructions that cause the processor to provide a user with the probability or answer, where the instructions comprise applying a mathematical model to test data, to thereby determine the probability or whether the test subject has heart failure or the particular classification as opposed to not having heart failure or the particular classification.

The instructions may be provided to the computer in any one of various ways routinely employed in the art. In one aspect, the instructions are provided to the computer using a computer-readable medium.

Thus, according to yet another aspect of the disclosure there is provided a computer-readable medium having instructions stored thereon that are operable when executed by a computer for applying a mathematical model to test data, thereby determine the probability or whether a test subject has heart failure or the particular classification as opposed to not having heart failure or the particular classification.

As described above, following the step of obtaining the test data, the method of classifying of the disclosure comprises the step of comparing test data representing a level of RNA encoded by a marker gene to positive control data and/or negative control data, and determining the fold-change between the levels.

It will be appreciated that a computer may be used for comparing test data representing a level of RNA encoded by a marker gene to positive control data and/or negative control data, and determining the fold-change between the levels, according to methods of the disclosure.

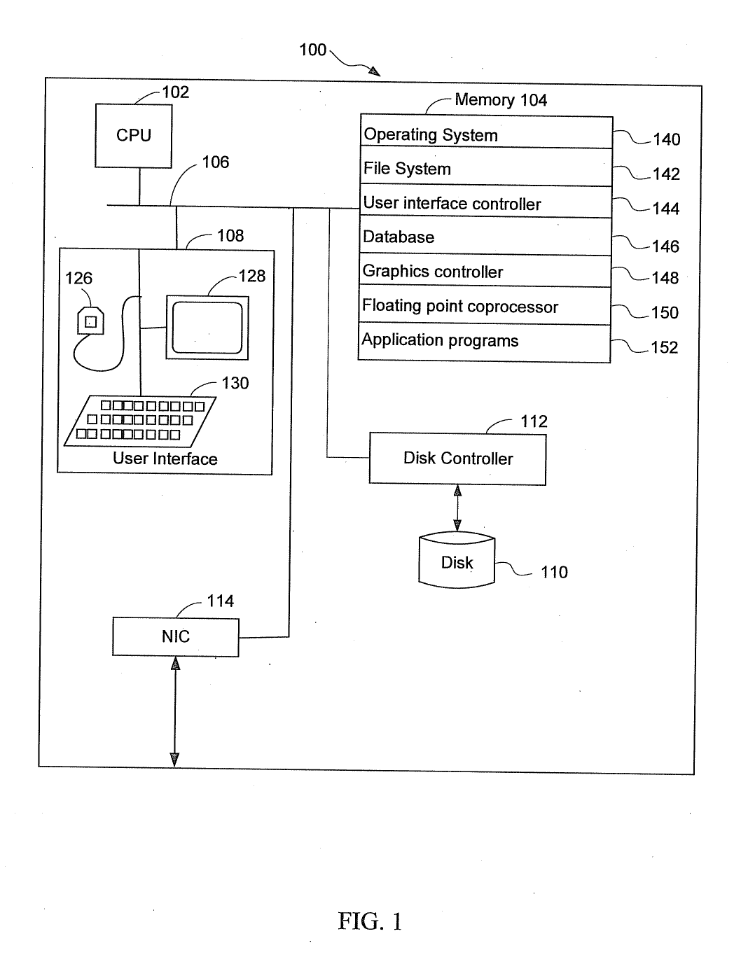

An exemplary computer system for practicing certain of the methods described herein is described in FIG. 1.

FIG. 1 shows a schematic of a general-purpose computer system 100 suitable for practicing the methods described herein. The computer system 100, shown as a self-contained unit but not necessarily so limited, comprises at least one data processing unit (CPU) 102, a memory 104, which will typically include both high speed random access memory as well as non-volatile memory (such as one or more magnetic disk drives) but may be simply flash memory, a user interface 108, optionally a disk 110 controlled by a disk controller 112, and at least one optional network or other communication interface card 114 for communicating with other computers as well as other devices. At least the CPU 102, memory 104, user interface 108, disk controller where present, and network interface card, communicate with one another by at least one communication bus 106.

Memory 104 stores procedures and data, typically including: an operating system 140 for providing basic system services; application programs 152 such as user level programs for viewing and manipulating data, evaluating formulae for the purpose of diagnosing a test subject; authoring tools for assisting with the writing of computer programs; a file system 142, a user interface controller 144 for handling communications with a user by user interface 108, and optionally one or more databases 146 for storing data of the disclosure and other information, optionally a graphics controller 148 for controlling display of data, and optionally a floating point coprocessor 150 dedicated to carrying out mathematical operations. The methods of the disclosure may also draw upon functions contained in one or more dynamically linked libraries, not shown in FIG. 1, but stored either in Memory 104, or on disk 110, or accessible by network interface connection 114.

User interface 108 may comprise a display 128, a mouse 126, and a keyboard 130. Although shown as separate components in FIG. 1, one or more of these user interface components can be integrated with one another in embodiments such as handheld computers. Display 128 may be a cathode ray tube (CRT), or flat-screen display such as an LCD based on active matrix or TFT embodiments, or may be an electroluminescent display, based on light emitting organic molecules such as conjugated small molecules or polymers. Other embodiments of a user interface not shown in FIG. 1 include, e.g., several buttons on a keypad, a card-reader, a touch-screen with or without a dedicated touching device, a trackpad, a trackball, or a microphone used in conjunction with voice-recognition software, or any combination thereof, or a security-device such as a fingerprint sensor or a retinal scanner that prohibits an unauthorized user from accessing data and programs stored in system 100.

System 100 may also be connected to an output device such as a printer (not shown), either directly through a dedicated printer cable connected to a serial or USB port, or wirelessly, or by a network connection.

The database 146 may instead, optionally, be stored on disk 110 in circumstances where the amount of data in the database is too great to be efficiently stored in memory 104. The database may also instead, or in part, be stored on one or more remote computers that communicate with computer system 100 through network interface connection 114.

The network interface 134 may be a connection to the internet or to a local area network by a cable and modem, or ethernet, firewire, or USB connectivity, or a digital subscriber line. Preferably the computer network connection is wireless, e.g., utilizing CDMA. GSM, or GPRS, or bluetooth, or standards such as 802.11a, 802.11b, or 802.11g.

It would be understood that various embodiments and configurations and distributions of the components of system 10 across different devices and locations are consistent with practice of the methods described herein. For example, a user may use a handheld embodiment that accepts data from a test subject, and transmits that data across a network connection to another device or location wherein the data is analyzed according to a formulae described herein. A result of such an analysis can be stored at the other location and/or additionally transmitted back to the handheld embodiment. In such a configuration, the act of accepting data from a test subject can include the act of a user inputting the information. The network connection can include a web-based interface to a remote site at, for example, a healthcare provider. Alternatively, system 10 can be a device such as a handheld device that accepts data from the test subject, analyzes the data, such as by inputting the data into a formula as further described herein, and generating a result that is displayed to the user. The result can then be, optionally, transmitted back to a remote location by a network interface such as a wireless interface. System 100 may further be configured to permit a user to transmit by e-mail results of an analysis directly to some other party, such as a healthcare provider, or a diagnostic facility, or a patient.

### Kits and Compositions

It will be appreciated that components for practicing the methods described herein may be assembled in a kit.

“Kit” refers to a combination of physical elements, e.g., probes, including without limitation specific primers, labeled nucleic acid probes, antibodies, protein-capture agent(s), reagent(s), instruction sheet(s) and other elements useful to practice the disclosure, in particular to identify the levels of particular RNA molecules in a sample. These physical elements can be arranged in any way suitable for carrying out the disclosure. For example, probes and/or primers can be provided in one or more containers or in an array or microarray device.

In the context of this disclosure, the term “probe” refers to a molecule which can detectably distinguish between target molecules differing in structure, such as allelic variants. Detection can be accomplished in a variety of different ways but preferably is based on detection of specific binding. Examples of such specific binding include antibody binding and nucleic acid probe hybridization.

The present disclosure encompasses the use of diagnostic kits based on a variety of methodologies, e.g., PCR, reverse transcriptase-PCR, quantitative PCR, microarray, chip, mass-spectroscopy, which are capable of detecting RNA levels in a sample. There is also provided an article of manufacturing comprising packaging material and an analytical agent contained within the packaging material, wherein the analytical agent can be used for determining and/or comparing the levels of RNA encoded by one or more target genes of the disclosure, and wherein the packaging material comprises a label or package insert which indicates that the analytical agent can be used to identify levels of RNA that correspond to a probability that a test subject has heart failure, or to the severity of heart failure or to survival outcome, for example, a probability that the test subject has heart failure as opposed to not having heart failure.

Therefore, there is provided kits comprising degenerate primers to amplify polymorphic alleles or variants of target genes of the disclosure, and instructions comprising an amplification protocol and analysis of the results.

The kit may alternatively also comprise buffers, enzymes, and containers for performing the amplification and analysis of the amplification products. The kit may also be a component of a screening or prognostic kit comprising other tools such as DNA microarrays. The kit may also provides one or more control templates, such as nucleic acids isolated from sample of patients without colorectal cancer, and/or nucleic acids isolated from samples of patients with colorectal cancer.

The kit may also include instructions for use of the kit to amplify specific targets on a solid support. Where the kit contains a prepared solid support having a set of primers already fixed on the solid support, e.g. for amplifying a particular set of target polynucleotides, the kit also includes reagents necessary for conducting a PCR on a solid support, for example using an in situ-type or solid phase type PCR procedure where the support is capable of PCR amplification using an in situ-type PCR machine. The PCR reagents, included in the kit, include the usual PCR buffers, a thermostable polymerase (e.g. Taq DNA polymerase), nucleotides (e.g. dNTPs), and other components and labeling molecules (e.g. for direct or indirect labeling). The kits can be assembled to support practice of the PCR amplification method using immobilized primers alone or, alternatively, together with solution phase primers.

In one embodiment, the kit provides one or more primer pairs, each pair capable of amplifying RNA encoded by a target gene of the disclosure, thereby providing a kit for analysis of RNA expression of several different target genes of the disclosure in a biological sample in one reaction or several parallel reactions. Primers in the kits may be labeled, for example fluorescently labeled, to facilitate detection of the amplification products and consequent analysis of the RNA levels.

Examples of amplification techniques include strand displacement amplification, as disclosed in U.S. Pat. No. 5,744,311; transcription-free isothermal amplification, as disclosed in U.S. Pat. No. 6,033,881; repair chain reaction amplification, as disclosed in WO 90/01069; ligase chain reaction amplification, as disclosed in European Patent Appl. 320 308; gap filling ligase chain reaction amplification, as disclosed in U.S. Pat. No. 5,427,930; and RNA transcription-free amplification, as disclosed in U.S. Pat. No. 6,025,134.

In one embodiment, levels of RNA encoded by more than one target gene can be determined in one analysis. A combination kit may therefore include primers capable of amplifying cDNA derived from RNA encoded by different target genes. The primers may be differentially labeled, for example using different fluorescent labels, so as to differentiate between RNA from different target genes.

Multiplex, such as duplex, real-time RT-PCR enables simultaneous quantification of 2 targets in the same reaction, which saves time, reduces costs, and conserves samples. These advantages of multiplex, real-time RT-PCR make the technique well-suited for high-throughput gene expression analysis. Multiplex qPCR assay in a real-time format facilitates quantitative measurements and minimizes the risk of false-negative results. It is essential that multiplex PCR is optimized so that amplicons of all samples are compared insub-plateau phase of PCR. Yun, Z., I. Lewensohn-Fuchs, P. Ljungman, L. Ringholm, J. Jonsson, and J. Albert. 2003. A real-time TaqMan PCR for routine quantitation of cytomegalovirus DNA in crude leukocyte lysates from stem cell transplant patients. J. Virol. Methods 110:73-79. [PubMed]. Yun, Z., I. Lewensohn-Fuchs, P. Ljungman, and A. Vahlne. 2000. Real-time monitoring of cytomegalovirus infections after stem cell transplantation using the TaqMan polymerase chain reaction assays.

Transplantation 69:1733-1736. [PubMed]. Simultaneous quantification of up to 2, 3, 4, 5, 6, 7, and 8 or more targets may be useful.

Accordingly, there is provided a kit comprising packaging and containing, for each gene of a set of one or more of the genes listed in Tables 1, 3, 4, 5, 6, 7 and 8, a primer set capable of generating an amplification product of DNA complementary to RNA encoded, in a human subject, only by the gene.

In another aspect, the kit further comprises a computer-readable medium having instructions stored thereon that are operable when executed by a computer for comparing the test data representing a level of RNA encoded by the gene in blood of a human test subject to a first positive control data representing levels of RNA encoded by the gene in blood of human control subjects having a first categorized severity of heart failure to thereby determine at least one value indicating whether the test data corresponds to the control data, wherein an indication by the at least one value that the test data corresponds to the first positive control data classifies the test subject as having the first categorized severity of heart failure.

In another embodiment, the computer readable medium further has instructions stored thereon that are operable when executed by a computer for comparing a second positive control data representing levels of RNA encoded by the gene in blood of human control subjects having a second categorized severity of heart failure, wherein correspondence between the test data and the second positive control data indicates that the test subject has the second categorized severity of heart failure.

In yet another aspect, there is provided a kit comprising packaging and containing, for each gene of a set of one or more of the genes listed in Tables 1, 3, 4, 5, 6, 7 and 8, a primer set capable of generating an amplification product of DNA complementary to RNA encoded, in a human subject, only by the gene.

In another aspect, the kit further comprises a thermostable polymerase, a reverse transcriptase, deoxynucleotide triphosphates, nucleotide triphosphates and/or enzyme buffer.

In yet another aspect, the kit further comprises at least one labeled probe capable of selectively hybridizing to either a sense or an antisense strand of the amplification product.

In yet another aspect of the disclosure, the kit further contains a computer-readable medium of the disclosure.

In one aspect, the kit is identified in print in or on the packaging as being for determining severity of heart failure in a test subject, for example, a probability that a test subject has a particular heart failure classification as opposed to not having the particular heart failure classification.

In another aspect, the kit is identified in print in or on the packaging as being for monitoring the progression of heart failure in a test subject.

In a further aspect, the kit is identified in print in or on the packaging as being for classifying whether a test subject has decompensated heart failure as opposed to not having heart failure.

In various aspects of the kits described herein, the set of genes may be any combination of two or more of the target genes, as described hereinabove and in the Examples section, below.

The disclosure also provides primer sets, isolated compositions and test systems.

Examples of a primer of the disclosure include an oligonucleotide which is capable of acting as a point of initiation of polynucleotide synthesis along a complementary strand when placed under conditions in which synthesis of a primer extension product which is complementary to a polynucleotide is catalyzed. Such conditions include the presence of four different nucleotide triphosphates or nucleoside analogs and one or more agents for polymerization such as DNA polymerase and/or reverse transcriptase, in an appropriate buffer (“buffer” includes substituents which are cofactors, or which affect pH, ionic strength, etc.), and at a suitable temperature. A primer must be sufficiently long to prime the synthesis of extension products in the presence of an agent for polymerase. A typical primer contains at least about 5 nucleotides in length of a sequence substantially complementary to the target sequence, but somewhat longer primers are preferred.

The terms “complementary” or “complement thereof”, as used herein, refer to sequences of polynucleotides which are capable of forming Watson & Crick base pairing with another specified polynucleotide throughout the entirety of the complementary region. This term is applied to pairs of polynucleotides based solely upon their sequences and does not refer to any specific conditions under which the two polynucleotides would actually bind.

A primer will always contain a sequence substantially complementary to the target sequence, that is the specific sequence to be amplified, to which it can anneal.

A primer which “selectively hybridizes” to a target polynucleotide is a primer which is capable of hybridizing only, or mostly, with a single target polynucleotide in a mixture of polynucleotides consisting of RNA of human blood, or consisting of DNA complementary to RNA of human blood.

Accordingly, there is provided an isolated composition comprising a blood sample from a test subject and, for each gene of one or more of the genes listed in Tables 1, 3, 4, 5, 6, 7 and 8, exogenous nucleic acid selected from the group consisting of: RNA encoded by the gene, cDNA complementary to RNA encoded by the gene, an oligonucleotide which specifically hybridizes to cDNA complementary to RNA encoded by the gene under stringent conditions, an oligonucleotide which specifically hybridizes to RNA encoded by the gene under stringent conditions, a primer set capable of generating an amplification product of cDNA complementary to RNA encoded by the gene, and an amplification product of cDNA complementary to RNA encoded by the gene.

In another embodiment, there is provided an isolated composition comprising, for each gene of a set of one or more of the genes listed in Tables 1, 3, 4, 5, 6, 7 and 8, exogenous nucleic acid which is isolated from a blood sample of a test subject, and which is selected from the group consisting of: RNA encoded by the gene, cDNA complementary to RNA encoded by the gene, an oligonucleotide which specifically hybridizes to cDNA complementary to RNA encoded by the gene under stringent conditions, an oligonucleotide which specifically hybridizes to RNA encoded by the gene under stringent conditions, a primer set capable of generating an amplification product of cDNA complementary to RNA encoded by the gene, and an amplification product of cDNA complementary to RNA encoded by the gene.

In a further aspect, there is provided a test system comprising, for each gene of a set of one or more of the genes listed in Tables 1, 3, 4, 5, 6, 7 and 8; and for each blood sample of a set of blood samples from different subjects: exogenous nucleic acid isolated from the sample selected from the group consisting of RNA encoded by the gene, cDNA complementary to RNA encoded by the gene, an oligonucleotide which specifically hybridizes to cDNA complementary to RNA encoded by the gene under stringent conditions, an oligonucleotide which specifically hybridizes to RNA encoded by the gene under stringent conditions, a primer set capable of generating an amplification product of cDNA complementary to RNA encoded by the gene, and an amplification product of cDNA complementary to RNA encoded by the gene.

The above disclosure generally describes the present disclosure. A more complete understanding can be obtained by reference to the following specific examples. These examples are described solely for the purpose of illustration and are not intended to limit the scope of the disclosure. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present disclosure:

### EXAMPLES

### Example 1

### Material and Methods:

Subject recruitment. Among 97 adults with and without HF, we measured BNP and extracted total RNA from peripheral leukocytes. Microarray hybridization was performed using GeneChip U133Plus2 (Affymetrix) to examine gene expression profiles. The severity of HF was characterized using New York Heart Association (NYHA) classification.

Blood collection, RNA extraction and microarray hybridization. Overnight fasting blood samples were collected using a Vacutainer™ tube and stored on ice till RNA extraction. Blood samples were processed for RNA extraction within six hours after blood collection. Red blood cells were ruptured with hypotonic haemolysis buffer, followed by collection of white blood cells by centrifugation. White blood cell total RNA was extracted with Trizol® Reagent. The quality of RNA samples was assessed on an Agilent Bioanalyzer 2100 using RNA 6000 Nano Chips; the quantity of RNA was measured by UV spectrophotometry. Five microgram of total RNA of each sample was used for hybridization on a GeneChip U133Plus2.

Data analysis. Probe-level expression data were processed by GC-Robust Multichip Analysis (GC-RMA) using GeneSpring v7.3 software. Genes showing unreliable measurements, assessed by cross-gene error model, were removed from any further analysis. Differentially regulated genes between NYHA I-II patients and healthy controls and between NYHA III-IV patients and healthy controls were identified by applying a t-test to the gene expression levels in these experimental groups, and a p value of 0.05 was chosen as the significance cut-off.

### Results:

We analyzed gene expression levels in 20 healthy control, 20 NYHA-I, 20 NYHA-II, 30 NYHA-III and 7 NYHA-IV subjects. Overall, 486 genes were found to be differentially expressed (p<0.05) between controls and combined NYHA I-II patients, and between controls and combined NYHA III-IV patients.

Expression levels per subject per gene are shown in Table 1.

Various descriptors for the genes are provided in Table 2.

The genes differentially expressed between controls and NYHA I-II patients are listed and characterized in Table 3. Table 3 provides the maximum overall accuracy of classification power of the genes in terms of receiver-operating characteristic (ROC) area under the curve (AUC), where increasing value indicates increasing accuracy. Table 3 also provides the average fold-change gene expression in NYHA I-II relative to control. The table indicates the threshold fold-change gene expression defining a probability of NYHA I-II as opposed to healthy (sensitivity=0.6). This represents a suitable threshold for classifying a test subject as more likely to have heart failure NYHA I-II than to be healthy. The table further indicates the extreme fold-change relative to average of controls observed in a NYHA I-II sample. This extreme can serve to limit a range of fold-change expression which classifies a test subject as probably having heart failure NYHA I-II rather than being healthy. The table further indicates the threshold fold-change gene expression defining a probability of healthy as opposed to NYHA I-II (specificity=0.6). This represents a suitable threshold for classifying a test subject as more likely to be healthy than to have heart failure NYHA I-II. The table further indicates the extreme fold-change relative to average of controls observed in a control sample. This extreme can serve to limit a range of fold-change expression which classifies a test subject as probably being healthy rather than having heart failure NYHA I-II.

The genes differentially expressed between controls and NYHA III-IV patients are listed and characterized in Table 4. Table 4 provides the maximum overall accuracy of classification power of the genes in terms of receiver-operating characteristic (ROC) area under the curve (AUC), where increasing value indicates increasing accuracy. Table 4 also provides the average fold-change gene expression in NYHA III-IV relative to control. The table indicates the threshold fold-change gene expression defining a probability of NYHA III-IV as opposed to healthy (sensitivity=0.6). This represents a suitable threshold for classifying a test subject as more likely to have heart failure NYHA III-IV than to be healthy. The table further indicates the extreme fold-change relative to average of controls observed in a NYHA III-IV sample. This extreme can serve to limit a range of fold-change expression which classifies a test subject as probably having heart failure NYHA III-IV rather than being healthy. The table further indicates the threshold fold-change gene expression defining a probability of healthy as opposed to NYHA III-IV (specificity=0.6). This represents a suitable threshold for classifying a test subject as more likely to be healthy than to have heart failure NYHA III-IV. The table further indicates the extreme fold-change relative to average of controls observed in a control sample. This extreme can serve to limit a range of fold-change expression which classifies a test subject as probably being healthy rather than having heart failure NYHA III-IV.

The genes displaying a trend of increased fold-change expression relative to controls as a function of severity are listed and described in Table 5, which displays average fold-change expression side-by-side for NYHA I-II and NYHA III-IV.

The genes displaying increased average fold-change expression in NYHA I-II and less increased average fold-change expression in NYHA III-IV, relative to controls, are listed and described in Table 6, which displays average fold-change expression side-by-side for NYHA I-II and NYHA III-IV.

The genes displaying a trend of decreased fold-change expression relative to controls as a function of severity are listed and described in Table 7, which displays average fold-change expression side-by-side for NYHA I-II and NYHA III-IV.

The genes displaying decreased average fold-change expression in NYHA I-II and less decreased average fold-change expression in NYHA III-IV, relative to controls, are listed and described in Table 8, which displays average fold-change expression side-by-side for NYHA I-II and NYHA III-IV.

### Example 2

### Classification of a Patient Suspected of Potentially Having Heart Failure in Relation to a Likelihood of Having NYHA I-II Stage Heart Failure, Having NYHA III-IV Stage Heart Failure or not Having Heart Failure

Overnight fasting blood samples are collected using Vacutainer™ tubes from a patient suspected of potentially having heart failure and from 20 healthy control subjects, and the samples are stored on ice until RNA extraction. The blood samples are processed for RNA extraction within six hours after blood collection. Red blood cells are ruptured with hypotonic haemolysis buffer, followed by collection of white blood cells by centrifugation. White blood cell total RNA samples are extracted with Trizol® Reagent. The quality of the RNA samples is confirmed on an Agilent Bioanalyzer 2100 using RNA 6000 Nano Chips; and the quantity of RNA in the samples is measured by UV spectrophotometry. Five micrograms of total RNA per sample is used to generate cDNA for hybridization on a GeneChip U133Plus2 according to the manufacturer's instructions to determine the level of RNA encoded by the genes SRP14 and GIMAP1 in the sample from the test subject and to determine the average level of RNA encoded by these genes in the samples from the control subjects.

The ratio of the level of RNA encoded by SRP14 in the sample from the patient to the average level of RNA encoded by SRP14 in the blood samples of the healthy subjects is determined, and the ratio of the level of RNA encoded by GIMAP1 in the sample from the patient to the average level of RNA encoded by GIMAP1 in the blood samples of the healthy subjects is determined.

The patient is classified as more likely to have NYHA I/II stage heart failure than to either be healthy or to have NYHA III/IV stage heart failure if the level of RNA encoded by SRP14 in the sample from the patient is 1.062 to 1.268 fold of the average level of RNA encoded by the gene in the blood samples of the healthy subjects.

Alternately, the patient is classified as more likely to have NYHA III/IV stage heart failure than to either be healthy or have NYHA I/II stage heart failure if the level of RNA encoded by GIMAP1 in the sample from the patient is between 0.945 and 0.543 fold of the average level of RNA encoded by the gene in the blood samples of the healthy subjects.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

TABLE 1

| | | Control | Control | Control | Control | Control | Control | Control | Control | Control | Control | Control |
|---|---|---|---|---|---|---|---|---|---|---|---|---|
| Affymetrix Probe | | Sample | Sample | Sample | Sample | Sample | Sample | Sample | Sample | Sample | Sample | Sample |
| set ID | Gene symbol | no. 0 | no. 1 | no. 2 | no. 3 | no. 4 | no. 5 | no. 6 | no. 7 | no. 8 | no. 9 | no. 10 |
| 1552318_at | GIMAP1 | 1884 | 1485 | 1803 | 1449 | 1283 | 1458 | 1227 | 1331 | 1418 | 1227 | 2513 |
| 1552630_a_at | SRCAP | 124.2 | 77.98 | 83.1 | 111.6 | 119.3 | 81.48 | 89.83 | 121.9 | 112.1 | 94.63 | 85.48 |
| 1554149_at | CLDND1 | 966.2 | 670.3 | 919.9 | 648.5 | 660.5 | 805.4 | 696.9 | 545.5 | 647 | 587.6 | 858.2 |
| 1554539_a_at | RHOF | 119.6 | 72.46 | 104.7 | 70.66 | 84.17 | 78.23 | 74.03 | 93.15 | 111.3 | 64.01 | 114 |
| 1554606_at | CCDC100 | 168.1 | 139.9 | 169.3 | 136.5 | 166.1 | 173.2 | 128.5 | 147.2 | 169.3 | 76.54 | 170.7 |
| 1555630_a_at | RAB34 | 198 | 120.9 | 71.23 | 147.2 | 172.7 | 117.2 | 69.16 | 90.66 | 84.27 | 128.9 | 97.02 |
| 1555963_x_at | B3GNT7 | 35.32 | 46.43 | 47.27 | 31.58 | 35.36 | 39.48 | 47.66 | 32.43 | 48.2 | 30.38 | 33.7 |
| 1555996_s_at | EIF4A2 | 1295 | 828.9 | 1099 | 889.6 | 1060 | 1383 | 701.3 | 893 | 1166 | 802.1 | 1461 |
| 1556113_at | DKFZp451A211 | 29.92 | 32.62 | 39.7 | 39.32 | 33.56 | 38.93 | 26.64 | 39.37 | 37.71 | 47.7 | 37.74 |
| 1556283_s_at | FGFR1OP2 | 165 | 131.2 | 76.38 | 88.58 | 109.6 | 91.5 | 78.85 | 65.81 | 92.95 | 102.7 | 102.4 |
| 1556864_at | TECT1 | 39.23 | 57.48 | 47.99 | 50.52 | 56.56 | 52.86 | 46.94 | 69.12 | 45.4 | 73.37 | 46.87 |
| 1557066_at | LUC7L | 245.7 | 204 | 185.9 | 187.3 | 200.9 | 175.5 | 172.4 | 136.3 | 187.1 | 107.9 | 247.5 |
| 1558277_at | ZNF740 | 28.41 | 29.88 | 40.89 | 38.67 | 48.19 | 21.6 | 28.24 | 29.86 | 40.84 | 28.75 | 28.62 |
| 1558755_x_at | ZNF763 | 205.3 | 220.2 | 180.7 | 179.7 | 89.79 | 150.6 | 150.4 | 211.1 | 123.7 | 201.4 | 221.1 |
| 1561146_at | VPS35 | 92.5 | 58.25 | 83.94 | 93.63 | 60.41 | 65.66 | 84.88 | 77.47 | 67.39 | 61.95 | 70.71 |
| 1564962_at | ZNF92 | 60.78 | 30.12 | 36.82 | 45.16 | 35.55 | 44.63 | 34.07 | 36.45 | 37.79 | 36.78 | 55.12 |
| 1567013_at | NFE2L2 | 92.13 | 116.1 | 99.01 | 96.95 | 90.98 | 100.3 | 148.1 | 102.5 | 95.55 | 98.68 | 97.62 |
| 1568815_a_at | DDX50 | 151 | 131.3 | 166.8 | 174.3 | 131.9 | 131.7 | 334.3 | 130.7 | 133.7 | 105.5 | 170 |
| 200007_at | SRP14 | 7803 | 7464 | 6882 | 7173 | 7378 | 7689 | 7067 | 6304 | 7925 | 6829 | 7844 |
| 200010_at | RPL11 | 13172 | 11186 | 13349 | 12281 | 12038 | 12587 | 12238 | 10770 | 11718 | 11894 | 15543 |
| 200059_s_at | RHOA | 9515 | 10294 | 9906 | 9957 | 9308 | 9998 | 10117 | 9804 | 8995 | 10155 | 9330 |
| 200091_s_at | RPS25 | 26796 | 19506 | 20137 | 21044 | 22753 | 21927 | 21649 | 18680 | 20566 | 18754 | 27490 |
| 200633_at | UBB | 8209 | 7467 | 10589 | 8228 | 7630 | 7988 | 7521 | 7384 | 8521 | 6871 | 9354 |
| 200650_s_at | LDHA | 5717 | 3812 | 6061 | 4920 | 4228 | 5319 | 4170 | 4601 | 5985 | 5270 | 4737 |
| 200672_x_at | SPTBN1 | 157.4 | 210 | 160.2 | 181.6 | 210.4 | 161.8 | 159.3 | 134.5 | 145.9 | 110.6 | 227.3 |
| 200677_at | PTTG1IP | 2484 | 2759 | 2222 | 2605 | 2859 | 3023 | 2457 | 2577 | 2249 | 2634 | 2290 |
| 200713_s_at | MAPRE1 | 1308 | 1366 | 1543 | 1430 | 1561 | 1322 | 1411 | 1259 | 1340 | 1313 | 1286 |
| 200822_x_at | TPI1 | 1372 | 1229 | 1263 | 1184 | 1134 | 1187 | 1204 | 1089 | 870.8 | 1123 | 1084 |
| 200829_x_at | ZNF207 | 571.7 | 461.4 | 573.6 | 552.4 | 506.3 | 567.8 | 482 | 437.8 | 539.9 | 448.2 | 546.1 |
| 200839_s_at | CTSB | 2846 | 2379 | 3032 | 2892 | 2294 | 2354 | 1816 | 2157 | 2522 | 2355 | 2562 |
| 200932_s_at | DCTN2 | 454 | 435.5 | 472.1 | 414 | 458.4 | 460.7 | 396 | 402.9 | 477.2 | 462.2 | 453.6 |
| 200950_at | ARPC1A | 472.4 | 452.8 | 476.3 | 501.2 | 495.3 | 505.8 | 493.2 | 468.7 | 478.5 | 483 | 528.9 |
| 201031_s_at | HNRPH1 | 9510 | 8383 | 9288 | 9897 | 8687 | 9842 | 6879 | 7563 | 8735 | 8125 | 11125 |
| 201075_s_at | SMARCC1 | 433 | 323.1 | 328.6 | 354.4 | 396.8 | 401.7 | 318.8 | 368 | 326.9 | 319 | 348.4 |
| 201098_at | COPB2 | 770.5 | 715.6 | 713.1 | 759.7 | 839 | 761.4 | 723.4 | 681.7 | 718.9 | 679.4 | 709.7 |
| 201105_at | LGALS1 | 4549 | 2137 | 2378 | 1646 | 3209 | 2769 | 1484 | 2191 | 3612 | 2985 | 2061 |
| 201172_x_at | ATP6V0E1 | 2863 | 3706 | 3694 | 3320 | 3105 | 3193 | 3483 | 3115 | 3287 | 3165 | 3017 |
| 201186_at | LRPAP1 | 466.4 | 436.1 | 398.8 | 543.2 | 485.1 | 436.2 | 622 | 459.7 | 422.8 | 551.5 | 365.9 |
| 201193_at | IDH1 | 550.4 | 448.8 | 557.1 | 578.6 | 482.4 | 510.1 | 435.7 | 453.8 | 445.4 | 560.4 | 385.5 |
| 201198_s_at | PSMD1 | 146.9 | 166.2 | 165.9 | 134.5 | 133.8 | 176.9 | 110 | 126.9 | 122.1 | 144.9 | 168.5 |
| 201220_x_at | CTBP2 | 1408 | 1473 | 1391 | 1441 | 1634 | 1719 | 1749 | 1634 | 1252 | 1542 | 1330 |
| 201234_at | ILK | 1080 | 1143 | 987 | 1398 | 1211 | 1090 | 1278 | 1191 | 1135 | 1033 | 1076 |
| 201357_s_at | SF3A1 | 398.2 | 392.7 | 427.4 | 395.6 | 384.7 | 422.7 | 510.4 | 499.4 | 383.6 | 384.1 | 358.3 |
| 201363_s_at | IVNS1ABP | 1579 | 1414 | 1439 | 1935 | 1780 | 1977 | 1530 | 2257 | 1550 | 1762 | 1658 |
| 201400_at | PSMB3 | 1346 | 1795 | 1744 | 1704 | 1581 | 1540 | 1603 | 1551 | 1618 | 1594 | 1622 |
| 201421_s_at | WDR77 | 197.9 | 167.8 | 160.4 | 171 | 185.1 | 189.7 | 121.3 | 127.1 | 144.7 | 132.9 | 209.5 |
| 201422_at | IFI30 | 8577 | 5701 | 5628 | 8420 | 6716 | 7306 | 6399 | 6907 | 7570 | 6983 | 5692 |
| 201426_s_at | VIM | 14865 | 12674 | 15376 | 14013 | 15626 | 15301 | 13339 | 14124 | 14113 | 15027 | 13339 |
| 201453_x_at | RHEB | 1240 | 1281 | 1396 | 1284 | 1124 | 1227 | 1199 | 1104 | 1202 | 1240 | 1207 |
| 201470_at | GSTO1 | 1302 | 1060 | 987.9 | 1182 | 1357 | 1082 | 927.3 | 883.4 | 999.3 | 985.2 | 1047 |
| 201478_s_at | DKC1 | 319.3 | 276.2 | 302.1 | 275.8 | 254.7 | 346.3 | 254.8 | 267.3 | 240.4 | 234.8 | 307.3 |
| 201527_at | ATP6V1F | 929.3 | 799.4 | 943.7 | 901.1 | 767.1 | 765.6 | 819 | 720.7 | 801.9 | 762.1 | 831 |
| 201536_at | DUSP3 | 389 | 259.2 | 262.1 | 388.2 | 240.7 | 424.4 | 377.4 | 312.1 | 355 | 279.2 | 285.9 |
| 201554_x_at | GYG1 | 726.8 | 485.7 | 694.8 | 607.8 | 650 | 871.6 | 921.5 | 761.7 | 702 | 750.5 | 642.5 |
| 201556_s_at | VAMP2 | 549.2 | 785.7 | 592.5 | 651.3 | 857.5 | 1020 | 819.9 | 1082 | 665.3 | 720.2 | 708.5 |
| 201576_s_at | GLB1 | 731.9 | 574.3 | 537 | 668.6 | 738.8 | 591 | 630.1 | 509.6 | 500.9 | 620.3 | 561.5 |
| 201590_x_at | ANXA2 | 3505 | 2218 | 2522 | 3501 | 2525 | 2955 | 1744 | 2093 | 3041 | 3073 | 2371 |
| 201628_s_at | RRAGA | 614.4 | 563.7 | 731 | 525.5 | 550.3 | 564.9 | 614.7 | 555.1 | 482.4 | 498 | 592.8 |
| 201788_at | DDX42 | 543.2 | 548.9 | 600.5 | 596.7 | 543.2 | 699.2 | 578.8 | 488.4 | 467.4 | 535.4 | 740.8 |
| 201900_s_at | AKR1A1 | 472 | 356.7 | 394.3 | 502.1 | 373.9 | 414.2 | 368.3 | 331.2 | 344.2 | 302.7 | 476.8 |
| 201945_at | FURIN | 447.7 | 569.8 | 369.2 | 511.9 | 526.5 | 508.8 | 784.3 | 734.7 | 415 | 586.2 | 384.2 |
| 202068_s_at | LDLR | 92.13 | 65.16 | 70.79 | 66.81 | 65.9 | 120.2 | 31.58 | 75.07 | 120.9 | 90 | 56.49 |
| 202104_s_at | SPG7 | 442.8 | 474.9 | 476.1 | 436 | 476.8 | 389.1 | 389 | 429.9 | 405.3 | 335.4 | 501.6 |
| 202138_x_at | JTV1 | 296.5 | 246.8 | 280.5 | 258.9 | 249.1 | 291 | 200.5 | 206.3 | 238.7 | 217.7 | 268.2 |
| 202185_at | PLOD3 | 221.7 | 179.2 | 213.7 | 199.9 | 194 | 199.6 | 183.5 | 185.9 | 186.4 | 185.2 | 191.7 |
| 202192_s_at | GAS7 | 576.8 | 526.7 | 509.3 | 506.2 | 905.7 | 761.2 | 650.3 | 615.2 | 498 | 580.8 | 427.1 |
| 202201_at | BLVRB | 740.8 | 493.2 | 380 | 541.5 | 494.6 | 493.7 | 391.4 | 388.5 | 476.7 | 673.1 | 385.8 |
| 202249_s_at | WDR42A | 243.1 | 258.7 | 231.2 | 227.1 | 295.3 | 254.5 | 245.7 | 265.7 | 210 | 217 | 237.9 |
| 202252_at | RAB13 | 97.44 | 91.77 | 83.75 | 67.72 | 88.48 | 100.5 | 99.67 | 81.18 | 60.81 | 68.19 | 62.37 |
| 202262_x_at | DDAH2 | 76 | 72.47 | 74.23 | 75.14 | 74.95 | 128.2 | 124.3 | 73.46 | 107.9 | 84.68 | 83.94 |
| 202380_s_at | NKTR | 654.8 | 681.6 | 773.4 | 676.8 | 653.4 | 775.9 | 618.4 | 556.1 | 561.7 | 537.2 | 809.7 |
| 202381_at | ADAM9 | 520 | 315.1 | 307.6 | 447.8 | 513.7 | 403.8 | 354.3 | 344.2 | 382.5 | 456.7 | 285.8 |
| 202428_x_at | DBI | 2216 | 1652 | 2182 | 1824 | 1911 | 2206 | 1723 | 1640 | 1958 | 1784 | 1845 |
| 202445_s_at | NOTCH2 | 198 | 151.4 | 131.7 | 156.5 | 160.8 | 199.1 | 192.9 | 148.2 | 140.6 | 174.5 | 180.5 |
| 202461_at | EIF2B2 | 183.7 | 156.4 | 190.1 | 175 | 142.9 | 146.6 | 166.5 | 107.2 | 174.5 | 115.7 | 181.2 |
| 202522_at | PITPNB | 628.5 | 643.8 | 744.3 | 586.9 | 542.4 | 602.8 | 662.8 | 593.1 | 659.3 | 608.1 | 652.9 |
| 202523_s_at | SPOCK2 | 332.9 | 173.9 | 308.5 | 233.3 | 230.4 | 128.7 | 338.5 | 289.7 | 228.9 | 147.8 | 363.2 |
| 202594_at | LEPROTL1 | 874.2 | 932.8 | 1043 | 981.2 | 1125 | 1079 | 853.2 | 973.3 | 1125 | 944.6 | 1178 |
| 202623_at | EAPP | 1279 | 1179 | 1458 | 1193 | 1321 | 1261 | 1106 | 1324 | 1130 | 1158 | 1358 |
| 202652_at | APBB1 | 41.64 | 44.49 | 52.08 | 40.68 | 35.16 | 38.92 | 53.9 | 34.51 | 30.56 | 35.42 | 59.96 |
| 202724_s_at | FOXO1 | 483.5 | 550.6 | 529.3 | 520.9 | 668 | 509.1 | 603.7 | 527.8 | 481.3 | 469 | 691.6 |
| 202750_s_at | TFIP11 | 182 | 206.2 | 163.7 | 216.8 | 144.8 | 143.9 | 212.3 | 178.5 | 194.2 | 158.1 | 141.7 |
| 202778_s_at | ZMYM2 | 604.5 | 591.3 | 560.5 | 603 | 704.5 | 664.6 | 624.1 | 630.5 | 518.6 | 636.8 | 588.5 |
| 202910_s_at | CD97 | 3345 | 3649 | 3145 | 2997 | 3996 | 2526 | 4236 | 3286 | 3749 | 3867 | 3215 |
| 202928_s_at | PHF1 | 139.9 | 145.8 | 182.7 | 152.5 | 161 | 157.8 | 224.7 | 198.1 | 160.6 | 134.1 | 197.5 |
| 202944_at | NAGA | 515 | 399.7 | 357.4 | 465.7 | 351.4 | 322.1 | 271.8 | 270.5 | 287.1 | 301.4 | 333.1 |
| 202979_s_at | CREBZF | 949.8 | 698.7 | 844.5 | 660.7 | 812.7 | 824.6 | 575.3 | 703.6 | 801.8 | 547.4 | 1067 |
| 203003_at | MEF2D | 113.2 | 135.8 | 105.5 | 100.3 | 127.4 | 124.7 | 147.9 | 162.1 | 99.28 | 99.52 | 98.68 |
| 203127_s_at | SPTLC2 | 307.8 | 319.7 | 226.1 | 306.8 | 343.6 | 307.8 | 301.8 | 267.3 | 295 | 325.7 | 218.6 |
| 203137_at | WTAP | 1897 | 1665 | 2024 | 2093 | 1891 | 1662 | 1646 | 1822 | 1959 | 2138 | 2200 |
| 203184_at | FBN2 | 151.9 | 49.68 | 84.2 | 106.8 | 147.1 | 32.88 | 55.32 | 85.65 | 74.35 | 69.59 | 56.49 |
| 203234_at | UPP1 | 388.9 | 326.2 | 279.8 | 440.3 | 466.9 | 608.6 | 476.5 | 355.6 | 399.9 | 622.8 | 338.8 |
| 203278_s_at | PHF21A | 702 | 941.7 | 832.3 | 865 | 1069 | 941.5 | 1318 | 1041 | 1065 | 1066 | 744.5 |
| 203305_at | F13A1 | 1003 | 1052 | 767.7 | 1494 | 896.7 | 773.6 | 898.1 | 713.8 | 853.8 | 1129 | 556 |
| 203371_s_at | NDUFB3 | 978.5 | 895.1 | 1118 | 933.4 | 1227 | 1244 | 1317 | 1050 | 1441 | 1258 | 962.6 |
| 203413_at | NELL2 | 514.7 | 462.8 | 574.3 | 523.8 | 502.5 | 542.4 | 619.7 | 302.9 | 285.1 | 331.6 | 1007 |
| 203416_at | CD53 | 9075 | 10473 | 11266 | 9781 | 9328 | 9796 | 10223 | 9767 | 10527 | 10381 | 9523 |
| 203492_x_at | CEP57 | 255.2 | 213.2 | 334.3 | 235.9 | 251.8 | 295.5 | 232.3 | 230.5 | 280.7 | 209.5 | 268.5 |
| 203534_at | LSM1 | 957.3 | 683.1 | 800.8 | 741.7 | 716.9 | 744.3 | 722.1 | 593.6 | 664.2 | 597 | 756.6 |
| 203535_at | S100A9 | 32414 | 38070 | 34471 | 39800 | 39980 | 40296 | 41494 | 41371 | 38393 | 42593 | 35664 |
| 203578_s_at | SLC7A6 | 161.3 | 100.3 | 102.6 | 112.6 | 149.9 | 149.4 | 104.2 | 74.93 | 114.6 | 115.4 | 169.9 |
| 203748_x_at | RBMS1 | 1231 | 1426 | 1752 | 1462 | 1464 | 1617 | 1787 | 1526 | 1398 | 1419 | 1510 |
| 203759_at | ST3GAL4 | 87.89 | 119.9 | 71.37 | 91.81 | 126.7 | 144 | 124.2 | 134.5 | 114.8 | 187.5 | 113.1 |
| 203844_at | VHL | 26.5 | 26.2 | 29.07 | 28.16 | 24.76 | 27.35 | 25.39 | 27.79 | 25.14 | 30.34 | 25.97 |
| 203880_at | COX17 | 283 | 216.7 | 227.8 | 254.5 | 274.6 | 336.9 | 206.9 | 175.3 | 245.1 | 211.4 | 245 |
| 203912_s_at | DNASE1L1 | 276.8 | 188.2 | 121.3 | 174 | 188.5 | 195.7 | 207.6 | 138.1 | 139.9 | 135.5 | 191.9 |
| 203939_at | NT5E | 83.05 | 95.94 | 84.68 | 58.85 | 159.3 | 80.49 | 87.63 | 58.04 | 84.08 | 58.25 | 111.1 |
| 203971_at | SLC31A1 | 139.6 | 115.6 | 124.6 | 88.98 | 138.7 | 106.9 | 80.79 | 85.82 | 116.9 | 98.68 | 65.59 |
| 204050_s_at | CLTA | 1522 | 1130 | 1257 | 1265 | 1150 | 1156 | 1058 | 1038 | 1023 | 1129 | 1141 |
| 204068_at | STK3 | 88.34 | 100.1 | 52.55 | 96.49 | 101.1 | 106.1 | 105 | 73.45 | 82.14 | 93.91 | 66.86 |
| 204099_at | SMARCD3 | 134.2 | 124.8 | 100.4 | 173.3 | 152.4 | 134.5 | 148 | 115.2 | 169.8 | 171.1 | 131.1 |
| 204143_s_at | ENOSF1 | 172.1 | 156.7 | 235.1 | 160.7 | 202.2 | 243.3 | 156 | 138.1 | 178.8 | 103.6 | 388.6 |
| 204204_at | SLC31A2 | 1991 | 2514 | 1765 | 1191 | 2508 | 2226 | 2037 | 1660 | 2072 | 2162 | 1118 |
| 204214_s_at | RAB32 | 560.9 | 457 | 465.9 | 638.8 | 589.7 | 492.6 | 454.6 | 503.2 | 460.7 | 668 | 448.3 |
| 204232_at | FCER1G | 4642 | 2846 | 2860 | 3236 | 4318 | 4339 | 4376 | 2374 | 3723 | 4488 | 3376 |
| 204243_at | RLF | 213.5 | 262.3 | 212.4 | 228.8 | 277.5 | 262.2 | 268.9 | 192.2 | 201.6 | 304.8 | 199.8 |
| 204249_s_at | LMO2 | 2407 | 2898 | 2281 | 3756 | 2770 | 2701 | 2172 | 2244 | 3530 | 2445 | 2131 |
| 204291_at | ZNF518 | 542.4 | 464.7 | 365 | 553.6 | 559.3 | 537.8 | 375.7 | 460.2 | 496.3 | 577 | 499.4 |
| 204342_at | SLC25A24 | 912.5 | 588.1 | 743.9 | 780.1 | 730.4 | 697.8 | 634.3 | 637 | 980 | 664.8 | 726 |
| 204352_at | TRAF5 | 448.8 | 420.9 | 757 | 373.3 | 482.9 | 437.1 | 474.9 | 294.3 | 387.7 | 260.6 | 970.6 |
| 204401_at | KCNN4 | 185.6 | 87.25 | 123.8 | 142.6 | 126.9 | 154.3 | 149.4 | 141.1 | 155.7 | 146 | 257.7 |
| 204504_s_at | HIRIP3 | 97.43 | 82.43 | 121.3 | 107.6 | 100.9 | 108.5 | 90.48 | 107.5 | 96.97 | 107.4 | 116.2 |
| 204617_s_at | ACD | 329.5 | 366 | 348.1 | 310.7 | 341.2 | 297.1 | 370 | 345.7 | 255.9 | 276.8 | 403.6 |
| 204645_at | CCNT2 | 1144 | 931.3 | 965.3 | 984.8 | 1072 | 970.4 | 832.8 | 992.2 | 1211 | 994.6 | 1001 |
| 204675_at | SRD5A1 | 108.7 | 59.78 | 72.44 | 120 | 105.5 | 99.38 | 72.63 | 49.66 | 92.48 | 82.93 | 92.22 |
| 204689_at | HHEX | 472.7 | 428.7 | 440 | 498.2 | 534.6 | 495.4 | 457.6 | 397.8 | 516.3 | 487.9 | 500.4 |
| 204801_s_at | DHRS12 | 49.68 | 30.65 | 29.64 | 44.71 | 45.49 | 49.3 | 35.44 | 52.97 | 36.63 | 73.82 | 34.85 |
| 205235_s_at | MPHOSPH1 | 97.85 | 80.02 | 99.73 | 99.65 | 80.41 | 110.5 | 98.97 | 95.75 | 85.52 | 87.1 | 113.4 |
| 205254_x_at | TCF7 | 372.8 | 311.1 | 358.6 | 364.6 | 353.2 | 256.9 | 432.6 | 301.6 | 198.3 | 230.3 | 576.8 |
| 205256_at | ZBTB39 | 65.34 | 64.65 | 97.14 | 68.87 | 62.88 | 67.57 | 64.98 | 74.04 | 72.97 | 66.53 | 85.45 |
| 205322_s_at | MTF1 | 422.7 | 475.2 | 505.2 | 534.4 | 494.4 | 528.8 | 654.3 | 498.5 | 488.4 | 570.4 | 390.2 |
| 205340_at | ZBTB24 | 140.6 | 116.2 | 140 | 155.5 | 139 | 152.8 | 110.1 | 114.6 | 140.4 | 134.1 | 184.9 |
| 205349_at | GNA15 | 212.1 | 170.6 | 118.4 | 170 | 160.1 | 169.3 | 125.1 | 116.3 | 159.5 | 177.8 | 117.3 |
| 205550_s_at | BRE | 252.4 | 260.9 | 270.3 | 232.6 | 225.3 | 269.8 | 266.7 | 212.5 | 254.3 | 270.3 | 254.3 |
| 205811_at | POLG2 | 167.8 | 184.9 | 182.4 | 163 | 163.1 | 193.2 | 133.3 | 132.7 | 163.1 | 158.7 | 200.9 |
| 205835_s_at | YTHDC2 | 138.9 | 96.7 | 113.2 | 142.3 | 144.8 | 113.2 | 82.04 | 112 | 121.3 | 80.94 | 138.9 |
| 205895_s_at | NOLC1 | 169.2 | 120.2 | 218.6 | 148.4 | 157.7 | 198.5 | 129.5 | 137.8 | 175.7 | 120.1 | 187.8 |
| 205965_at | BATF | 185.3 | 152.5 | 152.1 | 157.8 | 152.4 | 211.1 | 180.4 | 188.5 | 228.1 | 158.6 | 158.2 |
| 205976_at | FASTKD2 | 81.82 | 53.03 | 65.27 | 46.09 | 56.8 | 40.62 | 24.57 | 39.13 | 54.67 | 44.27 | 78.2 |
| 206015_s_at | FOXJ3 | 687.5 | 687.2 | 771.9 | 715.9 | 768.6 | 762.9 | 707.2 | 615.2 | 615.6 | 652.6 | 745.8 |
| 206037_at | CCBL1 | 31.53 | 35.72 | 35.23 | 39.58 | 48.94 | 35.84 | 44.4 | 38.17 | 27.4 | 43.83 | 40.81 |
| 206170_at | ADRB2 | 220.1 | 216 | 275.4 | 241.7 | 128.1 | 227.3 | 252.7 | 135.5 | 270.3 | 161.6 | 199.9 |
| 206182_at | ZNF134 | 132.1 | 101.6 | 142.7 | 117.7 | 86.07 | 101.8 | 119.9 | 98.54 | 109.2 | 116.2 | 149 |
| 206343_s_at | NRG1 | 19.31 | 16.48 | 26.29 | 26.52 | 16.33 | 15.73 | 8.638 | 12.58 | 6.16 | 34.29 | 35.78 |
| 206542_s_at | SMARCA2 | 1343 | 1311 | 1440 | 1414 | 1494 | 1727 | 1304 | 1351 | 1382 | 1333 | 1458 |
| 206580_s_at | EFEMP2 | 43.2 | 73.33 | 51.21 | 50.99 | 57.73 | 69.74 | 57.57 | 55.21 | 48.92 | 46.15 | 57.79 |
| 206715_at | TFEC | 294 | 205.5 | 257.8 | 395.5 | 266.3 | 218 | 157.6 | 214 | 299.3 | 264.6 | 208.9 |
| 206834_at | HBD | 87.7 | 68.45 | 142.6 | 25.14 | 27.87 | 55.14 | 44.46 | 54.27 | 59.38 | 47.65 | 76.77 |
| 206968_s_at | NFRKB | 122.4 | 105.6 | 106.3 | 117.7 | 109.6 | 113.7 | 112.3 | 121.9 | 99.67 | 83.69 | 140.5 |
| 207075_at | NLRP3 | 108.8 | 222.8 | 186.7 | 171.7 | 93.71 | 130.3 | 123.3 | 88.53 | 109.7 | 144 | 104.2 |
| 207078_at | MED6 | 202.3 | 197.3 | 162.5 | 200 | 193.2 | 165.6 | 176.5 | 201.5 | 198.3 | 175.2 | 231 |
| 207113_s_at | TNF | 106.6 | 97.96 | 106.3 | 142.2 | 124.1 | 138.8 | 122.5 | 68.63 | 73.1 | 130 | 73.92 |
| 207164_s_at | ZNF238 | 712.5 | 743.5 | 687 | 798 | 875.6 | 956.6 | 943.9 | 1033 | 794.9 | 683.6 | 772.5 |
| 207233_s_at | MITF | 99.13 | 75.94 | 90.11 | 115.9 | 100.8 | 147.1 | 93.15 | 73.52 | 76.8 | 84.03 | 72.91 |
| 207416_s_at | NFATC3 | 285.4 | 265.3 | 219.7 | 223.5 | 254.3 | 308.7 | 272.2 | 270 | 264.6 | 227.8 | 279 |
| 207513_s_at | ZNF189 | 259.5 | 231.2 | 230.4 | 345.5 | 296.6 | 276.2 | 223.3 | 257.5 | 268.7 | 300.4 | 244.8 |
| 207543_s_at | P4HA1 | 293.5 | 321.7 | 311.1 | 278.3 | 379.6 | 277.1 | 287.1 | 239.5 | 220.1 | 288.2 | 239.3 |
| 207564_x_at | OGT | 4664 | 3833 | 4140 | 3397 | 3937 | 4971 | 3338 | 3250 | 3386 | 2734 | 3672 |
| 207971_s_at | CEP68 | 81.87 | 60.57 | 77.85 | 75.24 | 77.25 | 85.17 | 76.71 | 59.46 | 62.71 | 85.75 | 160.5 |
| 208104_s_at | TSC22D4 | 488.4 | 563.3 | 534.8 | 584.3 | 556.5 | 455.6 | 615.6 | 578.5 | 503.8 | 460.3 | 441.7 |
| 208121_s_at | PTPRO | 66.19 | 48.45 | 69.74 | 122.1 | 102.5 | 99.4 | 45.93 | 49.13 | 102 | 84.75 | 120.8 |
| 208161_s_at | ABCC3 | 44.41 | 31.25 | 33.43 | 47.48 | 46.39 | 36.23 | 42.6 | 28.55 | 26.91 | 26.73 | 31.67 |
| 208269_s_at | ADAM28 | 126 | 123.3 | 109.8 | 132.1 | 137.1 | 102.8 | 99.91 | 146.1 | 101.4 | 105.3 | 127 |
| 208309_s_at | MALT1 | 411.7 | 238.3 | 478 | 329.5 | 359.5 | 344.7 | 266.2 | 214.5 | 276.3 | 175.1 | 410.6 |
| 208527_x_at | HIST1H2BE | 288.4 | 336 | 295.7 | 410.2 | 322.8 | 331.7 | 325.2 | 402.8 | 332 | 342.1 | 307.7 |
| 208579_x_at | H2BFS | 540.8 | 577.4 | 463.8 | 710.7 | 528.1 | 490.1 | 471.6 | 696.6 | 552.9 | 437.5 | 485.7 |
| 208635_x_at | NACA | 16908 | 13017 | 15899 | 15015 | 14149 | 15765 | 13172 | 12893 | 13397 | 12842 | 17082 |
| 208659_at | CLIC1 | 6182 | 6300 | 5867 | 6118 | 5982 | 6380 | 6825 | 6138 | 6354 | 7264 | 6422 |
| 208680_at | PRDX1 | 729.8 | 440.6 | 653.9 | 741.3 | 627.1 | 642 | 474.6 | 418.4 | 634.3 | 543.8 | 633.9 |
| 208749_x_at | FLOT1 | 1413 | 1857 | 1570 | 2312 | 2029 | 2258 | 2835 | 2615 | 1938 | 1972 | 1812 |
| 208771_s_at | LTA4H | 3764 | 4934 | 6635 | 4440 | 3590 | 5490 | 4104 | 3410 | 2630 | 5528 | 4454 |
| 208780_x_at | VAPA | 2057 | 3024 | 2172 | 1934 | 2071 | 1985 | 2581 | 2006 | 1681 | 2752 | 2043 |
| 208798_x_at | GOLGA8A | 1464 | 1409 | 1903 | 1140 | 1165 | 1355 | 1508 | 1566 | 867.7 | 945.9 | 2556 |
| 208805_at | PSMA6 | 1993 | 1656 | 1975 | 2009 | 1668 | 1823 | 1615 | 1646 | 2110 | 1700 | 1903 |
| 208868_s_at | GABARAPL1 | 913.4 | 1005 | 839.3 | 892.6 | 717.5 | 988.5 | 780.9 | 999.3 | 924.4 | 899.7 | 745.8 |
| 208903_at | RPS28 | 70.34 | 47.85 | 54.63 | 63.26 | 58.99 | 58.34 | 62.19 | 49.35 | 54.75 | 48.03 | 73.69 |
| 208921_s_at | SRI | 1093 | 874 | 1129 | 1037 | 985.2 | 1169 | 1003 | 893.1 | 990.9 | 983.7 | 1082 |
| 208923_at | CYFIP1 | 700.2 | 399.6 | 459 | 620.9 | 539.1 | 511 | 348.3 | 350 | 402.6 | 458.5 | 389.5 |
| 208946_s_at | BECN1 | 1704 | 1464 | 1551 | 1527 | 1431 | 1497 | 1501 | 1501 | 1629 | 1557 | 1581 |
| 208962_s_at | FADS1 | 109.6 | 64.28 | 54.07 | 99.03 | 44.5 | 111.6 | 48.3 | 43.67 | 45.12 | 68.83 | 48.87 |
| 209040_s_at | PSMB8 | 1457 | 1514 | 1566 | 1956 | 1477 | 1637 | 1635 | 1545 | 2117 | 1562 | 1750 |
| 209067_s_at | HNRPDL | 4005 | 2347 | 3383 | 2939 | 2872 | 3247 | 2614 | 2327 | 2692 | 2202 | 3765 |
| 209072_at | MBP | 37.16 | 51.18 | 77.16 | 31.27 | 50.34 | 61.52 | 84.23 | 64.13 | 32.45 | 46.78 | 38.94 |
| 209099_x_at | JAG1 | 95.89 | 73.92 | 63.36 | 95.47 | 136.8 | 84.27 | 88.18 | 94.24 | 85.67 | 100.1 | 82.95 |
| 209124_at | MYD88 | 4489 | 4799 | 4612 | 4879 | 4778 | 5024 | 4884 | 4477 | 5444 | 5588 | 4670 |
| 209180_at | RABGGTB | 406.4 | 245.9 | 314.4 | 329.7 | 345.1 | 369.1 | 244.9 | 253.1 | 332.9 | 270.2 | 435.9 |
| 209191_at | TUBB6 | 166.7 | 71.68 | 101.3 | 80.38 | 139.6 | 138.5 | 73.29 | 156.8 | 128 | 112.8 | 98.06 |
| 209212_s_at | KLF5 | 29.25 | 23.92 | 30.18 | 28.58 | 29.18 | 30 | 29.72 | 30.03 | 20.3 | 31.09 | 29.76 |
| 209218_at | SQLE | 176.4 | 80.67 | 121.8 | 124.5 | 86.02 | 135.6 | 63.61 | 66.58 | 152.7 | 115.5 | 115.2 |
| 209236_at | SLC23A2 | 231.3 | 214.6 | 250.7 | 244.8 | 222.4 | 232.1 | 192.3 | 210 | 166 | 234.2 | 244.5 |
| 209251_x_at | TUBA1C | 3893 | 4739 | 5131 | 4801 | 3980 | 5196 | 4839 | 4364 | 3776 | 4907 | 3867 |
| 209259_s_at | SMC3 | 668.6 | 619.8 | 508.1 | 607.8 | 666.9 | 648.8 | 560.8 | 550.9 | 500.1 | 490.6 | 687.4 |
| 209269_s_at | SYK | 750.8 | 708.5 | 504.7 | 728.6 | 729 | 727.8 | 681.7 | 1138 | 507.9 | 740.7 | 608.1 |
| 209330_s_at | HNRPD | 3827 | 2384 | 2654 | 2608 | 3115 | 2736 | 1983 | 2366 | 2640 | 2352 | 3250 |
| 209339_at | SIAH2 | 416.3 | 389 | 389.9 | 387.3 | 415.3 | 419 | 450.3 | 313.6 | 440.7 | 361.4 | 344 |
| 209430_at | BTAF1 | 996.1 | 816.4 | 1103 | 878.3 | 835.6 | 790.6 | 736 | 703.4 | 771.5 | 761.8 | 1049 |
| 209675_s_at | HNRPUL1 | 1615 | 1133 | 1149 | 1209 | 1353 | 1146 | 1495 | 1321 | 1047 | 988.9 | 1205 |
| 209684_at | RIN2 | 521.9 | 256.4 | 216.7 | 488.3 | 382.3 | 301.8 | 229.7 | 225.9 | 401.5 | 372.1 | 225.7 |
| 209806_at | HIST1H2BK | 1789 | 1497 | 1274 | 2351 | 1674 | 1314 | 1473 | 2321 | 1910 | 1385 | 1320 |
| 209840_s_at | LRRN3 | 49.34 | 126.4 | 56.07 | 32.72 | 42.74 | 100.7 | 216.8 | 6.376 | 13.1 | 187.9 | 173.1 |
| 209870_s_at | APBA2 | 130.4 | 230.7 | 226.5 | 178.2 | 173.4 | 204.3 | 165.5 | 163.6 | 230.5 | 182.9 | 286.4 |
| 209892_at | FUT4 | 75.81 | 69.48 | 93.03 | 109.5 | 88.04 | 78.17 | 68.41 | 54.59 | 58.72 | 69.84 | 63.03 |
| 209906_at | C3AR1 | 644.8 | 339.3 | 396.8 | 584.3 | 586.4 | 580.4 | 367.8 | 460.2 | 1007 | 487 | 311.3 |
| 210022_at | PCGF1 | 176.6 | 156.4 | 181.5 | 185.3 | 229 | 178.1 | 179 | 203.1 | 166.6 | 189.2 | 175.2 |
| 210061_at | ZNF589 | 171.7 | 111.6 | 110.4 | 154.9 | 96.49 | 91.36 | 142.2 | 115.1 | 111.7 | 108.9 | 146.3 |
| 210145_at | PLA2G4A | 73.82 | 43.97 | 41.29 | 89.09 | 59.06 | 68.56 | 64.85 | 38.8 | 42.24 | 51.64 | 53.14 |
| 210156_s_at | PCMT1 | 1108 | 894 | 979.2 | 1144 | 993.2 | 1102 | 851 | 908.9 | 1200 | 1084 | 949.5 |
| 210166_at | TLR5 | 336.3 | 391.3 | 355.8 | 422.1 | 532.7 | 569.1 | 628.8 | 423.7 | 389.9 | 436.6 | 400.3 |
| 210434_x_at | JTB | 1954 | 2209 | 2648 | 2296 | 1971 | 2157 | 2341 | 2142 | 2133 | 2178 | 2150 |
| 210644_s_at | LAIR1 | 589.2 | 468.5 | 394.8 | 463.6 | 378.8 | 379.8 | 360.9 | 284.8 | 290.2 | 427.5 | 431.8 |
| 210648_x_at | SNX3 | 3250 | 3348 | 3886 | 2986 | 3126 | 3173 | 3301 | 2834 | 2977 | 3319 | 3140 |
| 210875_s_at | ZEB1 | 246.4 | 205.4 | 217 | 260.5 | 306.9 | 307.7 | 312.8 | 392.4 | 245.5 | 235.4 | 268.4 |
| 211047_x_at | AP2S1 | 1194 | 1018 | 1183 | 1252 | 1032 | 1095 | 827.7 | 896.3 | 981.5 | 1029 | 971.2 |
| 211058_x_at | TUBA1B | 4583 | 4409 | 5040 | 4623 | 4038 | 5091 | 4623 | 4452 | 4300 | 4795 | 4480 |
| 211185_s_at | SF3B1 | 8756 | 8290 | 9641 | 8488 | 8730 | 7648 | 8383 | 8227 | 7461 | 8508 | 8558 |
| 211272_s_at | DGKA | 579.2 | 539.1 | 711.4 | 764.4 | 687.6 | 539.8 | 690.7 | 557.2 | 413.1 | 478 | 1109 |
| 211323_s_at | ITPR1 | 209.7 | 141.4 | 230.1 | 182.1 | 183.4 | 188.8 | 139.6 | 159.7 | 183.6 | 127.9 | 182.5 |
| 211383_s_at | WDR37 | 407.1 | 390.3 | 477.7 | 433.4 | 400.5 | 496 | 472.4 | 385.8 | 372.1 | 398.9 | 492.4 |
| 211429_s_at | SERPINA1 | 14493 | 15121 | 14694 | 15949 | 15340 | 17935 | 16250 | 15660 | 15688 | 17603 | 13784 |
| 211506_s_at | IL8 | 682.6 | 826.9 | 365.6 | 1706 | 1594 | 830.3 | 1226 | 827.1 | 212.5 | 891 | 697.7 |
| 211546_x_at | SNCA | 218.8 | 158.5 | 201 | 232 | 179.2 | 196.8 | 160.4 | 158.4 | 180.8 | 161.3 | 130.8 |
| 211684_s_at | DYNC1I2 | 741.4 | 467.2 | 610.4 | 533.6 | 532.7 | 496.3 | 457.2 | 341.5 | 445.2 | 448.8 | 552.4 |
| 211729_x_at | BLVRA | 469.8 | 292.5 | 337.3 | 582.4 | 392.2 | 396 | 320.5 | 227.3 | 495.3 | 364.7 | 279.7 |
| 211856_x_at | CD28 | 106.3 | 29.24 | 82.9 | 103.9 | 93.14 | 98.08 | 65.92 | 56.75 | 88.44 | 56.52 | 137.2 |
| 211946_s_at | BAT2D1 | 5110 | 5060 | 4852 | 5421 | 5347 | 5093 | 5199 | 4762 | 4581 | 4698 | 5303 |
| 211965_at | ZFP36L1 | 2246 | 2507 | 2246 | 2315 | 3602 | 4714 | 5169 | 3756 | 1860 | 1907 | 2137 |
| 212030_at | RBM25 | 1239 | 1076 | 1347 | 1253 | 1288 | 1438 | 1146 | 1188 | 1088 | 1145 | 1588 |
| 212042_x_at | hCG_31916///RPL7 | 24503 | 23259 | 23168 | 24307 | 25351 | 26482 | 22892 | 20974 | 23411 | 23782 | 27173 |
| 212132_at | LSM14A | 2999 | 2839 | 2691 | 3235 | 3421 | 3142 | 2881 | 3046 | 3115 | 2969 | 3688 |
| 212213_x_at | OPA1 | 202.2 | 162 | 187.7 | 189.7 | 206.9 | 209.4 | 188.5 | 169.3 | 174.7 | 181.8 | 223.5 |
| 212299_at | NEK9 | 330 | 328.8 | 434.2 | 320.7 | 331.4 | 314.5 | 322.7 | 234.2 | 291 | 253.7 | 403.6 |
| 212331_at | RBL2 | 3174 | 3533 | 3901 | 2963 | 3999 | 3111 | 3209 | 3637 | 3275 | 3414 | 4127 |
| 212334_at | GNS | 3124 | 1857 | 1973 | 2553 | 1968 | 2066 | 1816 | 1778 | 2122 | 2175 | 1727 |
| 212406_s_at | PCMTD2 | 1349 | 1254 | 1346 | 1412 | 1553 | 1399 | 1274 | 1265 | 1059 | 729.6 | 1565 |
| 212455_at | YTHDC1 | 3281 | 3126 | 3517 | 3372 | 3557 | 3517 | 3506 | 3379 | 3635 | 3389 | 3604 |
| 212543_at | AIM1 | 1030 | 1185 | 1357 | 1225 | 1144 | 1264 | 1057 | 1172 | 968.1 | 1020 | 1204 |
| 212658_at | LHFPL2 | 93.15 | 72.02 | 58.78 | 125.8 | 77.28 | 78.88 | 55.19 | 79.35 | 122.4 | 81.61 | 56.62 |
| 212663_at | FKBP15 | 1313 | 1124 | 1224 | 1324 | 1324 | 1205 | 1085 | 1191 | 1062 | 1267 | 1014 |
| 212769_at | TLE3 | 330.3 | 483.2 | 363.3 | 423 | 513.7 | 352.1 | 639.8 | 509.5 | 407.5 | 527.5 | 476.2 |
| 212820_at | DMXL2 | 1997 | 2047 | 1959 | 2279 | 2651 | 2033 | 2097 | 2315 | 2156 | 1986 | 1648 |
| 212932_at | RAB3GAP1 | 148.4 | 125.6 | 119.3 | 165.9 | 119.1 | 194.2 | 174.7 | 135.6 | 126 | 156.9 | 178.4 |
| 212989_at | SGMS1 | 369.8 | 418.3 | 326.1 | 457.3 | 358.5 | 314.2 | 500.1 | 330.8 | 443.3 | 357.3 | 367.5 |
| 212997_s_at | TLK2 | 583.5 | 693.7 | 628.4 | 651.8 | 724.4 | 670.8 | 693.9 | 688.6 | 666.7 | 697.2 | 702.1 |
| 213021_at | GOSR1 | 281.7 | 246.4 | 230.4 | 267.9 | 239.2 | 266.2 | 209.9 | 208.9 | 270.8 | 253.9 | 272.2 |
| 213152_s_at | SFRS2B | 751.1 | 426.9 | 655.3 | 479.1 | 478.3 | 525.4 | 447.6 | 402.4 | 497.8 | 383.5 | 790 |
| 213205_s_at | RAD54L2 | 126.8 | 102.4 | 163 | 155.2 | 163.4 | 179.2 | 138.8 | 151.9 | 140.2 | 146.4 | 168.5 |
| 213218_at | ZNF187 | 85.32 | 88.98 | 105.6 | 106.4 | 89.49 | 123.6 | 98.54 | 127.8 | 102.7 | 75.13 | 121.6 |
| 213266_at | 76P | 85.99 | 79.27 | 102.1 | 56.1 | 102.8 | 117.3 | 88.13 | 95.62 | 82.97 | 72.34 | 94.54 |
| 213302_at | PFAS | 39.96 | 40.25 | 36.15 | 55.37 | 43.59 | 33.97 | 32.35 | 19.03 | 40.8 | 24.97 | 67.23 |
| 213335_s_at | ST3GAL6 | 29.73 | 33.49 | 32.47 | 40.74 | 31.78 | 30.62 | 32.94 | 30.7 | 26.81 | 34.18 | 25.07 |
| 213397_x_at | RNASE4 | 93.21 | 116.3 | 93.89 | 90.71 | 54.61 | 59.9 | 66.33 | 37.77 | 55.72 | 67.15 | 57.34 |
| 213459_at | RPL37A | 138.6 | 141 | 104.9 | 88.49 | 89.02 | 86.48 | 97.81 | 78.25 | 109.9 | 75.72 | 115 |
| 213494_s_at | YY1 | 38.41 | 45.25 | 31.88 | 32.97 | 32.93 | 51.79 | 44.14 | 35.01 | 32.96 | 33.74 | 66.77 |
| 213540_at | HSD17B8 | 65.52 | 52.42 | 71.07 | 68.56 | 59.91 | 73.82 | 72.61 | 52.89 | 63.74 | 61.2 | 83.82 |
| 213693_s_at | MUC1 | 36.02 | 36.37 | 37.92 | 36.54 | 36.75 | 36.39 | 36.42 | 37.32 | 36.99 | 37.65 | 36.2 |
| 213827_at | SNX26 | 77.74 | 58.98 | 50.07 | 78.6 | 69.92 | 83.08 | 64.48 | 69.77 | 79.02 | 69.21 | 73.07 |
| 213877_x_at | TCEB2 | 108.6 | 93.89 | 103.5 | 105.8 | 95.58 | 89.67 | 89.05 | 112.9 | 104.2 | 104.6 | 104.6 |
| 214045_at | LIAS | 91.65 | 68.63 | 46.25 | 60.91 | 73.65 | 55.06 | 40.12 | 49.81 | 48.02 | 57.12 | 85.72 |
| 214057_at | MCL1 | 175.5 | 234.2 | 190.7 | 198.9 | 204.2 | 170.7 | 245.1 | 233.2 | 213.3 | 216.5 | 261 |
| 214330_at | ATPAF2 | 57.12 | 29.59 | 50.49 | 68.06 | 45.6 | 41.64 | 40.86 | 53.38 | 55.62 | 44.58 | 40.34 |
| 214364_at | MTERFD2 | 84.02 | 107.9 | 106 | 158.5 | 91.54 | 106.1 | 95.4 | 91.23 | 60.44 | 95.64 | 144.4 |
| 214430_at | GLA | 438.1 | 375.6 | 310.1 | 444.2 | 406.1 | 421.4 | 347.9 | 353.4 | 287.7 | 410.5 | 327.5 |
| 214511_x_at | FCGR1B | 790 | 610 | 504.4 | 1261 | 518.3 | 1320 | 773.4 | 399.2 | 1507 | 1134 | 655.9 |
| 214629_x_at | RTN4 | 6019 | 6030 | 5792 | 5907 | 5320 | 6860 | 6252 | 5531 | 5358 | 6719 | 5458 |
| 214683_s_at | CLK1 | 4049 | 3925 | 3908 | 3787 | 3874 | 4188 | 4046 | 3858 | 3686 | 3640 | 3441 |
| 214820_at | BRWD1 | 147 | 109 | 94.84 | 116.5 | 109.6 | 100.1 | 75.26 | 106.6 | 124.8 | 90.57 | 126.4 |
| 214853_s_at | SHC1 | 394.1 | 387.2 | 421.9 | 391.3 | 359.6 | 369.5 | 405 | 315.5 | 364.7 | 371.5 | 412 |
| 214931_s_at | SRPK2 | 423.3 | 383.6 | 399.1 | 422.4 | 459.7 | 578.8 | 370.5 | 490.7 | 427.8 | 382.8 | 369.4 |
| 214953_s_at | APP | 150.8 | 157.9 | 191.3 | 138.4 | 203.2 | 142.3 | 121.5 | 119.1 | 116.9 | 139.8 | 119.5 |
| 215009_s_at | SEC31A | 680.6 | 490.5 | 666.7 | 583.5 | 615.3 | 647.5 | 414.5 | 469.2 | 450 | 460.9 | 613.8 |
| 215049_x_at | CD163 | 538.4 | 492 | 581.8 | 418.7 | 368.9 | 223.6 | 284.5 | 260.4 | 372.1 | 370.6 | 236 |
| 215273_s_at | TADA3L | 511.8 | 425.9 | 478.1 | 573.4 | 489.9 | 616.9 | 466.9 | 502.7 | 534.3 | 544.7 | 572.4 |
| 215293_s_at | FRAG1 | 69.95 | 62.4 | 76.72 | 99.83 | 67.17 | 83.46 | 57.94 | 65.62 | 66.88 | 72.27 | 91.39 |
| 215567_at | FCF1 | 141.4 | 133.5 | 98.64 | 132.8 | 161.1 | 142.8 | 151 | 119.2 | 118.7 | 137.9 | 159.5 |
| 215997_s_at | CUL4B | 444.6 | 351.2 | 334 | 401.9 | 489.1 | 447.3 | 375.1 | 505 | 451.5 | 368.7 | 379.8 |
| 216484_x_at | HDGF | 394 | 397.9 | 419.1 | 408.6 | 389.8 | 356.8 | 399.7 | 383 | 373.8 | 350.1 | 343.9 |
| 216950_s_at | FCGR1A | 463.2 | 282.1 | 199 | 585.2 | 292.1 | 750.9 | 384.7 | 238.9 | 853 | 604.5 | 307.1 |
| 217383_at | PGK1 | 30.49 | 26.89 | 23.64 | 29.18 | 25.71 | 33.25 | 26.58 | 15.09 | 27.02 | 30.4 | 36.64 |
| 217403_s_at | ZNF227 | 104.8 | 97.18 | 101.1 | 108.1 | 87.27 | 116.2 | 94.07 | 84.75 | 115.1 | 79.58 | 144.4 |
| 217466_x_at | LOC400963///LOC440589 | 3422 | 2557 | 3342 | 2963 | 3378 | 2801 | 2691 | 2510 | 3224 | 2876 | 3727 |
| | ///LOC441013 | | | | | | | | | | | |
| | ///LOC645173///LOC646294 | | | | | | | | | | | |
| | ///LOC650901 | | | | | | | | | | | |
| | ///LOC729274/// | | | | | | | | | | | |
| | RPS2 | | | | | | | | | | | |
| 217769_s_at | POMP | 1380 | 1216 | 1231 | 1266 | 1130 | 1479 | 1352 | 1191 | 1378 | 1352 | 1221 |
| 217778_at | SLC39A1 | 225.7 | 225.2 | 169.1 | 192 | 224.2 | 234.8 | 281.5 | 205.9 | 200 | 251.8 | 196.5 |
| 217824_at | UBE2J1 | 296.9 | 248.8 | 265.8 | 267.3 | 304.6 | 341.7 | 297.8 | 210.3 | 264.3 | 313.9 | 299.4 |
| 217987_at | ASNSD1 | 634.6 | 746.5 | 652.2 | 600.8 | 590.2 | 893.7 | 791.4 | 689.7 | 745.1 | 743.7 | 459.6 |
| 217995_at | SQRDL | 972.1 | 1287 | 1463 | 1504 | 1499 | 1530 | 1523 | 1460 | 1651 | 1584 | 1196 |
| 218012_at | TSPYL2 | 203.7 | 205.9 | 253.5 | 243.2 | 273.2 | 211.3 | 252.7 | 255 | 212.2 | 266.2 | 293 |
| 218040_at | PRPF38B | 362.6 | 334.8 | 388.6 | 388.9 | 392.4 | 402.8 | 384.1 | 347.4 | 358.5 | 329.4 | 403.2 |
| 218065_s_at | TMEM9B | 1055 | 871 | 1016 | 1033 | 932.3 | 1047 | 834.4 | 793.9 | 964.5 | 859 | 1060 |
| 218091_at | HRB | 485.5 | 464.2 | 467.1 | 486 | 415 | 490.3 | 415.8 | 404.6 | 372.3 | 476.5 | 450.4 |
| 218125_s_at | CCDC25 | 61.3 | 52.67 | 63.51 | 60.03 | 58.7 | 63.04 | 56 | 57.09 | 58.27 | 57.9 | 76.26 |
| 218127_at | NFYB | 248.5 | 227.4 | 317 | 253.8 | 251 | 286.3 | 230.3 | 236.7 | 258.5 | 215.4 | 284.8 |
| 218143_s_at | SCAMP2 | 583.8 | 589.6 | 425.4 | 540.2 | 469 | 480.5 | 672.9 | 608.1 | 440.6 | 549.1 | 583.8 |
| 218206_x_at | SCAND1 | 364.4 | 333 | 344 | 391.6 | 357.1 | 354.6 | 346.1 | 324.3 | 365 | 382.4 | 373.1 |
| 218289_s_at | UBE1DC1 | 101.6 | 85.64 | 124 | 90.82 | 105.3 | 110.5 | 78.08 | 74.32 | 114.2 | 87.56 | 137.7 |
| 218325_s_at | DIDO1 | 331.7 | 351.2 | 500 | 377.7 | 339.1 | 327.9 | 358.1 | 297.8 | 349.7 | 331.6 | 422.2 |
| 218351_at | COMMD8 | 1127 | 909.3 | 900.2 | 1198 | 1013 | 1086 | 857.4 | 841.5 | 925 | 984.4 | 941.8 |
| 218499_at | RP6-213H19.1 | 2573 | 2350 | 2469 | 2538 | 2607 | 2482 | 2229 | 2576 | 2207 | 2236 | 2594 |
| 218627_at | DRAM | 317.5 | 326.8 | 236.3 | 237.9 | 349.2 | 306.5 | 304.1 | 372.3 | 272.4 | 351.2 | 244.3 |
| 218718_at | PDGFC | 162.9 | 108.7 | 81.93 | 165.6 | 77.12 | 163.9 | 67.68 | 47.73 | 63.04 | 118.5 | 83.46 |
| 218732_at | PTRH2 | 255.2 | 210.6 | 180.5 | 234.9 | 253.8 | 203.2 | 176.6 | 136.6 | 192 | 193.1 | 190.1 |
| 218845_at | DUSP22 | 911.1 | 884.8 | 878.7 | 837.4 | 921.2 | 937.4 | 760.9 | 691.4 | 794.9 | 763 | 811.9 |
| 218962_s_at | TMEM168 | 458.6 | 515.8 | 465 | 544.7 | 455.2 | 564.9 | 427.5 | 452.4 | 403.1 | 402.6 | 605.9 |
| 219130_at | CCDC76 | 325.7 | 275.9 | 335.4 | 298.3 | 320.3 | 264.4 | 229.3 | 227.3 | 278.6 | 223.8 | 391.6 |
| 219316_s_at | FLVCR2 | 85.94 | 69.55 | 67.89 | 113.6 | 93.45 | 102.5 | 61.74 | 66.2 | 69.57 | 100.7 | 57.74 |
| 219343_at | CDC37L1 | 191.8 | 154.2 | 223.8 | 188.8 | 211.3 | 216 | 175 | 173.9 | 146.2 | 157 | 221.3 |
| 219358_s_at | CENTA2 | 246 | 139.2 | 129.7 | 262.6 | 204 | 175.2 | 114 | 125.2 | 155.9 | 201 | 122.5 |
| 219418_at | NHEJ1 | 136.4 | 112.4 | 103.8 | 100 | 103.4 | 79.97 | 81.83 | 73.26 | 85.5 | 83.11 | 90.45 |
| 219507_at | RSRC1 | 96.34 | 73.13 | 88.03 | 74.42 | 53.82 | 100.9 | 61.91 | 55.97 | 56.88 | 57.62 | 93.19 |
| 219765_at | ZNF329 | 64.2 | 72.07 | 76.17 | 66.86 | 55.69 | 80.62 | 75.7 | 40.2 | 67.11 | 67.48 | 92.77 |
| 219787_s_at | ECT2 | 54.16 | 43.31 | 60.18 | 32.61 | 82.19 | 48.07 | 46.28 | 43.31 | 49.34 | 39.4 | 43.7 |
| 219822_at | MTRF1 | 171.6 | 198.5 | 157.5 | 164.1 | 147.1 | 156.9 | 130.3 | 149.6 | 162.7 | 142.4 | 205.5 |
| 219826_at | ZNF419 | 57.06 | 42.39 | 63.96 | 54.62 | 39.05 | 56.72 | 70.71 | 32.35 | 40.19 | 41.98 | 81.35 |
| 219952_s_at | MCOLN1 | 244.3 | 137.9 | 137.9 | 266.1 | 203 | 143.1 | 214.1 | 163.7 | 172.9 | 158.7 | 135.2 |
| 220044_x_at | CROP | 5172 | 4395 | 5111 | 4640 | 5239 | 5434 | 3691 | 3887 | 4419 | 4198 | 5548 |
| 220146_at | TLR7 | 136.4 | 84.15 | 67.17 | 164.8 | 107.1 | 103.9 | 55.87 | 60.3 | 175.4 | 93.48 | 133.8 |
| 220160_s_at | KPTN | 60.51 | 54.64 | 47.12 | 63.3 | 62.4 | 55.38 | 60.5 | 55.83 | 73.87 | 51.87 | 49.54 |
| 220386_s_at | EML4 | 617 | 405 | 654.3 | 652.9 | 560.6 | 692.9 | 499.3 | 581.7 | 544.4 | 552.5 | 592.5 |
| 220578_at | ADAMTSL4 | 66.54 | 103.4 | 59.72 | 102.1 | 65.22 | 74.23 | 77.09 | 65.03 | 58.51 | 69.57 | 67.33 |
| 220605_s_at | SIRT2 | 157.5 | 160.2 | 161.3 | 139.3 | 159.9 | 144.6 | 151.8 | 149.4 | 159.5 | 140.9 | 155.7 |
| 220610_s_at | LRRFIP2 | 122.7 | 105.9 | 105 | 100.9 | 113.3 | 100.2 | 115 | 101.7 | 122.8 | 104 | 97.27 |
| 220690_s_at | DHRS7B | 135.1 | 94.8 | 105.5 | 122.5 | 121.9 | 119.6 | 103.2 | 109.7 | 107.9 | 121.4 | 99.34 |
| 220750_s_at | LEPRE1 | 98.29 | 83.23 | 88.67 | 92.57 | 88.63 | 77.13 | 91.81 | 58.98 | 71.02 | 69.88 | 93.23 |
| 220865_s_at | PDSS1 | 62.44 | 85.1 | 79.22 | 91.05 | 111.8 | 83.33 | 49.16 | 54.02 | 52.8 | 76.41 | 81.66 |
| 220974_x_at | SFXN3 | 237.4 | 160.7 | 187 | 159.3 | 112.9 | 181.2 | 154 | 138.9 | 180.5 | 156.1 | 235.2 |
| 221011_s_at | LBH | 782.6 | 733.2 | 1236 | 724.8 | 721 | 926.1 | 893 | 730.7 | 983.3 | 588.6 | 1467 |
| 221206_at | PMS2 | 176.1 | 173 | 216.3 | 159.3 | 205.8 | 250.6 | 191.6 | 183.9 | 149.2 | 154.1 | 225.4 |
| 221264_s_at | TARDBP | 466.3 | 517.8 | 643.2 | 423.2 | 400.4 | 566.2 | 567 | 438.6 | 329.3 | 395 | 808.9 |
| 221428_s_at | TBL1XR1 | 1286 | 705.3 | 797 | 1133 | 1047 | 1111 | 795.3 | 1185 | 846.5 | 843.8 | 1093 |
| 221449_s_at | ITFG1 | 341.6 | 286.2 | 322.8 | 329.4 | 367 | 367.5 | 287.5 | 263.8 | 313 | 274.3 | 307.6 |
| 221580_s_at | JOSD3 | 1284 | 1053 | 1203 | 1194 | 1152 | 1227 | 1115 | 1082 | 1075 | 931.3 | 1451 |
| 221601_s_at | FAIM3 | 2051 | 2546 | 2840 | 1807 | 2379 | 2138 | 2252 | 1896 | 2007 | 1349 | 3919 |
| 221647_s_at | RIC8A | 405.7 | 420.8 | 504.6 | 432.9 | 465.6 | 438.3 | 523 | 445.1 | 394.7 | 388.3 | 431.6 |
| 221731_x_at | VCAN | 7619 | 5298 | 6657 | 7532 | 6051 | 5604 | 5286 | 5537 | 6076 | 7352 | 4400 |
| 221757_at | PIK3IP1 | 559.1 | 527.5 | 519.6 | 484.5 | 479.4 | 397.2 | 522.8 | 420.9 | 396.1 | 534.4 | 803.7 |
| 221841_s_at | KLF4 | 1649 | 720.6 | 857.9 | 1885 | 1151 | 1194 | 681 | 433 | 894.7 | 783.7 | 830.2 |
| 221868_at | PAIP2B | 39.09 | 30.5 | 56.1 | 31.81 | 41.04 | 53 | 32.47 | 45.34 | 34.53 | 32.52 | 69.28 |
| 221960_s_at | RAB2A | 61.14 | 59.15 | 47.9 | 53.23 | 36.75 | 59.55 | 57.1 | 34.68 | 33.08 | 40.13 | 78.62 |
| 222217_s_at | SLC27A3 | 290 | 310.1 | 228.1 | 357.6 | 247.7 | 198.6 | 259.9 | 238.1 | 340.7 | 303.2 | 212 |
| 222231_s_at | LRRC59 | 277 | 268.1 | 277.1 | 317.4 | 250.7 | 297.5 | 290.6 | 233.6 | 283.4 | 247.7 | 268.9 |
| 222574_s_at | DHX40 | 895.6 | 540.7 | 583.9 | 513 | 594.8 | 568.7 | 583.4 | 573.7 | 470.5 | 535 | 539.8 |
| 222605_at | RCOR3 | 572 | 672.9 | 858.4 | 739.5 | 843.8 | 823.5 | 750.4 | 786.9 | 762.1 | 746.8 | 836.2 |
| 222651_s_at | TRPS1 | 291.3 | 244.8 | 229.3 | 306.9 | 326 | 287.3 | 205.4 | 231.1 | 296.3 | 270.8 | 257.5 |
| 222670_s_at | MAFB | 1042 | 453.6 | 431.2 | 969.3 | 601.3 | 735.9 | 342.4 | 391.3 | 790 | 681.3 | 400 |
| 222688_at | PHCA | 356.5 | 257.4 | 171 | 364 | 272.9 | 275.7 | 257.4 | 163.7 | 215.7 | 252.9 | 212.2 |
| 222700_at | ARL6IP2 | 630.5 | 627.3 | 616.8 | 592.3 | 503.3 | 587.9 | 610.5 | 496.8 | 518.5 | 595.2 | 543.1 |
| 222753_s_at | SPCS3 | 259.9 | 195.3 | 180.8 | 153.6 | 180.8 | 185.5 | 214 | 151.1 | 155.3 | 166.9 | 182.2 |
| 222757_s_at | ZAK | 88.25 | 88.83 | 56.55 | 85.28 | 98.7 | 117.8 | 83.97 | 100.5 | 70.12 | 89.32 | 78.88 |
| 222774_s_at | NETO2 | 49.53 | 37.73 | 41.43 | 52.28 | 56.08 | 38.05 | 25.12 | 27.81 | 43.46 | 35.23 | 31.52 |
| 222884_at | ZNF346 | 96.89 | 125 | 112.7 | 109.6 | 116.2 | 113.6 | 113.9 | 119 | 119.4 | 88.18 | 121.2 |
| 222980_at | RAB10 | 2207 | 2120 | 2614 | 2333 | 2120 | 2327 | 2139 | 1916 | 2361 | 2530 | 2100 |
| 222982_x_at | SLC38A2 | 3456 | 4107 | 3801 | 3829 | 4128 | 3960 | 3881 | 3427 | 3667 | 4122 | 3419 |
| 223023_at | BET1L | 275.7 | 270.5 | 372.5 | 282.9 | 316.2 | 312.8 | 283.1 | 237.4 | 267.1 | 280.3 | 431.9 |
| 223064_at | RNF181 | 1324 | 1267 | 1180 | 1274 | 1387 | 1352 | 1252 | 1323 | 1309 | 1238 | 1252 |
| 223158_s_at | NEK6 | 129.7 | 129.8 | 88.91 | 120.2 | 110.7 | 90.5 | 94.32 | 104.7 | 83.9 | 84.28 | 100.4 |
| 223380_s_at | LATS2 | 319 | 454.2 | 246.2 | 265 | 304.1 | 300.6 | 371.7 | 298 | 225.9 | 228.8 | 282.5 |
| 223444_at | SENP7 | 965.7 | 866.3 | 769.5 | 980.4 | 813.5 | 785.5 | 805.1 | 855.8 | 918.4 | 909.8 | 932.8 |
| 223465_at | COL4A3BP | 374 | 434.1 | 305 | 328.6 | 497.4 | 475.3 | 428.7 | 383.3 | 351.3 | 480 | 407.3 |
| 223590_at | ZNF700 | 434.8 | 418.6 | 524.4 | 403.6 | 472.8 | 490.1 | 406.5 | 440.9 | 419.6 | 432.5 | 508.7 |
| 223686_at | TPK1 | 240.7 | 228.5 | 270.9 | 280.3 | 210.4 | 258.5 | 196.2 | 212.1 | 243.5 | 188 | 207.8 |
| 223801_s_at | APOL4 | 28.34 | 30.98 | 33.76 | 28.73 | 28.47 | 23 | 30.91 | 30.75 | 31.46 | 31.7 | 29.66 |
| 223922_x_at | MS4A6A | 2483 | 1898 | 2172 | 1795 | 1419 | 1529 | 1241 | 1296 | 1994 | 1723 | 1394 |
| 223982_s_at | PNPLA8 | 1275 | 1141 | 987.5 | 1088 | 1274 | 1209 | 1104 | 1088 | 1181 | 1270 | 1127 |
| 224046_s_at | PDE7A | 481.4 | 393.5 | 478.5 | 408.5 | 395.7 | 438.2 | 505 | 469.1 | 392.4 | 380.5 | 639.6 |
| 224374_s_at | EMILIN2 | 521.9 | 399.2 | 309.7 | 575.4 | 520.1 | 339.9 | 337.2 | 393.2 | 422.9 | 444.3 | 363.8 |
| 224387_at | COMMD5 | 68.06 | 63.51 | 52.34 | 58.93 | 70.7 | 79.41 | 36.65 | 56.08 | 70.16 | 63.91 | 57.25 |
| 224439_x_at | RNF7 | 458 | 397.9 | 425.7 | 447.6 | 400.7 | 403.3 | 323.2 | 360.7 | 384.2 | 325.5 | 435.6 |
| 224518_s_at | ZNF559 | 344.8 | 289.5 | 316.6 | 288.9 | 282.2 | 274.6 | 250.1 | 252 | 262.3 | 280.1 | 366 |
| 224582_s_at | NUCKS1 | 457.4 | 278.8 | 414.1 | 295.8 | 350 | 393.3 | 276.2 | 294.8 | 414 | 282.1 | 468.5 |
| 224591_at | HP1BP3 | 3243 | 2622 | 2970 | 2992 | 3023 | 3290 | 3037 | 2957 | 2745 | 2409 | 3575 |
| 224726_at | MIB1 | 165.5 | 187.2 | 141.2 | 139.3 | 167.1 | 179.6 | 167.4 | 120.4 | 132 | 143.4 | 164.3 |
| 224818_at | SORT1 | 674.8 | 668 | 600.6 | 777.4 | 664.4 | 761.2 | 514.6 | 467.9 | 557.3 | 579.7 | 409.8 |
| 224917_at | MIRN21 | 2803 | 2334 | 2017 | 2197 | 2412 | 2000 | 1992 | 2267 | 2363 | 2186 | 1589 |
| 224918_x_at | MGST1 | 433.6 | 287.7 | 332.5 | 438.7 | 436.8 | 395.6 | 354.3 | 340.2 | 354.1 | 528.5 | 255.7 |
| 224928_at | SETD7 | 342.8 | 214.3 | 273.6 | 272.4 | 267.8 | 247.8 | 234.1 | 158.7 | 206.1 | 219.9 | 222.6 |
| 225059_at | AGTRAP | 1123 | 1313 | 972.9 | 1394 | 1388 | 1338 | 1266 | 1476 | 1326 | 1303 | 1163 |
| 225064_at | RABEP1 | 620.9 | 424.7 | 384.8 | 377 | 411.9 | 486.7 | 344.2 | 422.4 | 535.1 | 331.5 | 579.9 |
| 225107_at | HNRNPA2B1 | 2886 | 2848 | 3034 | 3141 | 3219 | 2915 | 2498 | 2681 | 2486 | 2621 | 3496 |
| 225188_at | RAPH1 | 105.1 | 18.44 | 27.4 | 76.44 | 64.67 | 45.43 | 27.58 | 11.43 | 21.79 | 35.14 | 48.33 |
| 225341_at | MTERFD3 | 54.48 | 81.45 | 85.53 | 43.02 | 51.78 | 108.5 | 63.3 | 47.06 | 50.93 | 50.35 | 83.2 |
| 225358_at | DNAJC19 | 95.12 | 95.28 | 110.6 | 98.23 | 94.91 | 112.6 | 94.91 | 95.75 | 89.65 | 71.93 | 110.5 |
| 225365_at | ZDHHC20 | 2733 | 1965 | 2188 | 1992 | 2466 | 2068 | 1828 | 1899 | 2471 | 2170 | 2224 |
| 225388_at | TSPAN5 | 48.73 | 43.34 | 51.14 | 43.42 | 35.66 | 74.82 | 43.83 | 46.89 | 56.1 | 42.15 | 62.33 |
| 225456_at | MED1 | 376 | 360.9 | 346.7 | 400 | 384.3 | 466.7 | 336.6 | 312.1 | 349.5 | 300.9 | 323.3 |
| 225763_at | RCSD1 | 3352 | 3000 | 3113 | 3412 | 3983 | 2947 | 3035 | 3632 | 3066 | 2888 | 2706 |
| 225844_at | POLE4 | 257.4 | 150.4 | 179.3 | 247.7 | 206.1 | 183.4 | 162.1 | 175.6 | 205.3 | 193.4 | 194.1 |
| 225866_at | BXDC1 | 116.7 | 101.4 | 98.74 | 114.9 | 96.26 | 121.1 | 95.9 | 72.09 | 98.21 | 99.56 | 181 |
| 225870_s_at | TRAPPC5 | 732 | 544.9 | 517.9 | 768 | 712.3 | 561.4 | 660.2 | 563.9 | 556.1 | 670.3 | 497.1 |
| 226000_at | CTTNBP2NL | 26.87 | 32.79 | 26.33 | 27.09 | 25.79 | 29.88 | 18.51 | 28.97 | 25.28 | 25.82 | 27.05 |
| 226030_at | ACADSB | 122.1 | 84.28 | 142.3 | 117.7 | 124.1 | 136.6 | 102.8 | 81.34 | 103.6 | 101 | 167.3 |
| 226042_at | EDC3 | 98.95 | 86.31 | 111.7 | 92.28 | 103.6 | 88.9 | 106.5 | 104.2 | 82.24 | 94.11 | 115.5 |
| 226059_at | TOMM40L | 62.29 | 37.44 | 31.83 | 47.25 | 37.02 | 60.25 | 41.37 | 38.69 | 43.74 | 39.55 | 51.22 |
| 226115_at | AHCTF1 | 275.3 | 325.3 | 327.1 | 339 | 428 | 402.3 | 354.4 | 340.1 | 289.4 | 323 | 334.6 |
| 226127_at | ALKBH3 | 85.03 | 86.41 | 85.97 | 87.35 | 85.33 | 87.01 | 86.18 | 72.58 | 73.01 | 78.29 | 108.9 |
| 226218_at | IL7R | 5517 | 4898 | 6481 | 5330 | 5313 | 6331 | 5144 | 4197 | 3977 | 3268 | 8914 |
| 226220_at | METTL9 | 94.24 | 88.34 | 66.87 | 89.26 | 83.38 | 93.08 | 74.95 | 86.18 | 74.48 | 86.13 | 126.7 |
| 226323_at | CCDC16 | 557.7 | 539.1 | 746.7 | 607.4 | 607.8 | 705 | 526.7 | 538.5 | 558.9 | 582.6 | 636.6 |
| 226353_at | SPPL2A | 971.4 | 941.7 | 852.7 | 929.9 | 1083 | 1068 | 945.6 | 937.8 | 1030 | 1007 | 881.1 |
| 226428_at | TNPO2 | 186.4 | 211.5 | 227 | 198.4 | 161 | 175.1 | 194.3 | 184.6 | 198.3 | 203.4 | 213.8 |
| 226459_at | PIK3AP1 | 2001 | 2212 | 2000 | 2322 | 2080 | 2294 | 2174 | 1936 | 2643 | 1985 | 1591 |
| 226503_at | RIF1 | 301.5 | 276.5 | 229.1 | 278.3 | 238.6 | 232.5 | 215.6 | 221.4 | 286.6 | 220.3 | 318.6 |
| 226683_at | SNAG1 | 3137 | 2737 | 2187 | 3258 | 3523 | 3150 | 3199 | 3272 | 2815 | 3447 | 2880 |
| 226718_at | AMIGO1 | 85.99 | 87.32 | 102 | 94.15 | 74.93 | 77.97 | 81.11 | 59.8 | 66.54 | 71.42 | 97.33 |
| 226763_at | SESTD1 | 222.7 | 171 | 104.5 | 189.2 | 132.7 | 193.3 | 115.2 | 110.5 | 169.6 | 121 | 137.5 |
| 226836_at | SFT2D1 | 29.71 | 35.53 | 37.97 | 35.4 | 32.02 | 34.26 | 33.08 | 35.42 | 37.29 | 38.31 | 33.85 |
| 227020_at | YPEL2 | 895.4 | 817.4 | 794.1 | 749.3 | 807.8 | 835.1 | 677.4 | 488.4 | 664.9 | 697.3 | 661.2 |
| 227114_at | RNF214 | 107.2 | 93.54 | 136.8 | 120.9 | 121 | 100.9 | 104.8 | 82.64 | 83.67 | 75.33 | 122.2 |
| 227149_at | TNRC6C | 107.6 | 72.63 | 117.2 | 80.92 | 73.87 | 85.91 | 79.24 | 74.96 | 74.98 | 60.08 | 113.8 |
| 227173_s_at | BACH2 | 108.1 | 164.2 | 159.8 | 110.5 | 160.7 | 118.5 | 153.7 | 87.84 | 145.2 | 108.9 | 229.3 |
| 227213_at | ADAT2 | 89.18 | 66.52 | 77.56 | 78.34 | 71.4 | 122.7 | 65.72 | 54.35 | 70.36 | 61.75 | 116.8 |
| 227374_at | EARS2 | 57.91 | 59.08 | 56.32 | 46.97 | 52.93 | 56.03 | 40.39 | 46.67 | 63.07 | 51.61 | 58.18 |
| 227517_s_at | GAS5 | 634.8 | 507.9 | 703.6 | 478.6 | 478.3 | 491 | 437.4 | 380.9 | 494.8 | 368.4 | 851.8 |
| 227558_at | CBX4 | 1383 | 1294 | 1334 | 1227 | 1477 | 1499 | 1269 | 1527 | 1285 | 1295 | 1487 |
| 227560_at | SFXN2 | 116 | 76.77 | 103 | 100.3 | 92.3 | 103.9 | 92.1 | 78.79 | 110.7 | 101.1 | 112.9 |
| 227722_at | RPS23 | 360.2 | 216.9 | 185.8 | 153.9 | 43.85 | 160.7 | 250.3 | 154.8 | 103.4 | 176.4 | 499.5 |
| 227990_at | SLU7 | 1175 | 988.9 | 1142 | 1099 | 1152 | 1066 | 982.9 | 1077 | 973.1 | 1221 | 1059 |
| 228012_at | MATR3 | 28.96 | 23.94 | 36.07 | 27.77 | 27.74 | 33.4 | 23.94 | 24.63 | 33.37 | 27.71 | 46 |
| 228170_at | OLIG1 | 422.6 | 417 | 405.3 | 628.9 | 751.4 | 440.5 | 441.3 | 217.7 | 216.4 | 368.7 | 239.9 |
| 228176_at | EDG3 | 213.8 | 129 | 267.8 | 386.4 | 280.2 | 181.1 | 194.6 | 116.8 | 154 | 235.5 | 164.9 |
| 228234_at | TICAM2 | 378.8 | 334.8 | 304.7 | 453.9 | 323.3 | 273.8 | 301.7 | 263 | 331.2 | 300.3 | 280.1 |
| 228370_at | SNRPN | 172.7 | 164.6 | 178.2 | 136.2 | 145.6 | 209 | 175.6 | 147 | 132.9 | 136 | 363.6 |
| 228549_at | TMEM63A | 538.2 | 551.8 | 626.4 | 390.7 | 476.3 | 461.8 | 541.8 | 441.9 | 421.9 | 386.2 | 769.2 |
| 228630_at | ZNF84 | 88.84 | 83.66 | 131.1 | 94.63 | 104.7 | 108.9 | 82.32 | 118.7 | 88.18 | 90.52 | 154.2 |
| 228831_s_at | GNG7 | 156.4 | 187.9 | 270.6 | 141.9 | 224.4 | 172.2 | 206 | 210 | 165.1 | 190.9 | 343.2 |
| 229307_at | ANKRD28 | 41.67 | 46.67 | 50.85 | 16.49 | 37.52 | 43.65 | 18.25 | 37.9 | 23.43 | 57.59 | 33.36 |
| 229421_s_at | FLJ20273 | 33.77 | 35.13 | 36.56 | 38.62 | 39.14 | 35.99 | 39.08 | 38 | 35.65 | 45.92 | 31.44 |
| 229509_at | MFSD8 | 294.7 | 228.3 | 189.7 | 221.4 | 249.7 | 189.9 | 204.7 | 259.7 | 245.1 | 194.3 | 311.4 |
| 229854_at | OBSCN | 24.53 | 27.2 | 25.74 | 25.36 | 29.61 | 25.38 | 25.24 | 25.44 | 26.87 | 26.25 | 36.75 |
| 229982_at | QSER1 | 104.3 | 86.7 | 75.26 | 53.61 | 53.1 | 76.63 | 72.66 | 61.15 | 63.19 | 74.71 | 84.23 |
| 230265_at | SEL1L | 137.8 | 157.7 | 129.3 | 123.5 | 135.9 | 117.7 | 114 | 78.51 | 109.2 | 194 | 123.5 |
| 230320_at | TBRG1 | 139.3 | 128.1 | 153.1 | 175.8 | 169.4 | 156 | 120.8 | 138.8 | 169.6 | 113.6 | 170.6 |
| 230408_at | PCGF3 | 101.1 | 93.69 | 105.7 | 103.9 | 82.8 | 110.3 | 104.7 | 76.24 | 86.28 | 79.52 | 130 |
| 230480_at | PIWIL4 | 56.79 | 45.57 | 39.91 | 58.63 | 60.72 | 63.07 | 45.93 | 41.8 | 54.47 | 54.72 | 49.92 |
| 230837_at | LOC647500 | 87.73 | 74.83 | 70.88 | 85.38 | 81.38 | 82.84 | 75.87 | 111.8 | 99.75 | 86.91 | 81.53 |
| 230852_at | STAC3 | 53.88 | 38.09 | 40.34 | 49.17 | 45.89 | 35.34 | 35.12 | 42.72 | 42.98 | 45.13 | 33.93 |
| 230922_x_at | FUNDC2 | 45.32 | 43.74 | 47.19 | 52.73 | 45.43 | 52.67 | 43.7 | 60.61 | 53.53 | 49.78 | 53.56 |
| 231283_at | MGAT4A | 253.3 | 269.5 | 304.1 | 197.6 | 200.8 | 301.3 | 215.9 | 203.6 | 260.2 | 198.5 | 288 |
| 231697_s_at | TMEM49 | 106.6 | 77.76 | 54.63 | 55.53 | 50.45 | 52.01 | 54.71 | 58.2 | 57.59 | 56.2 | 70.56 |
| 231836_at | HKR1 | 68.13 | 76.92 | 135.6 | 64.18 | 51.8 | 50.94 | 82.85 | 71.85 | 75.48 | 66.03 | 103.4 |
| 231843_at | DDX55 | 246.2 | 214.1 | 203.1 | 217.8 | 190.5 | 179.6 | 216.4 | 210.4 | 184.3 | 158.5 | 217.6 |
| 231845_at | AARS2 | 140.4 | 114 | 98.37 | 142.6 | 102.1 | 122.2 | 105.6 | 97.6 | 92.53 | 105.3 | 169 |
| 231904_at | U2AF1 | 445.6 | 453.4 | 384.6 | 452.1 | 451.5 | 332.7 | 343.5 | 436.9 | 329.5 | 501.8 | 497.6 |
| 231914_at | NUDT14 | 46.57 | 47.88 | 49.78 | 48.73 | 46.99 | 42.49 | 47.74 | 48.43 | 49.35 | 44.66 | 44.78 |
| 232636_at | SLITRK4 | 68.55 | 57.31 | 32.95 | 66.84 | 76 | 55.93 | 41.77 | 20.75 | 42.23 | 67.88 | 44.46 |
| 232851_at | FBXO3 | 58.99 | 44.27 | 47.54 | 52.52 | 74.7 | 45.57 | 52.54 | 75.3 | 42.02 | 70.1 | 62.22 |
| 233019_at | CNOT7 | 404.1 | 306.5 | 270.5 | 352.2 | 357.3 | 276.5 | 316.5 | 322.8 | 275.7 | 309.1 | 446.5 |
| 233169_at | ZNF350 | 117.1 | 116.4 | 118.6 | 136.5 | 128.7 | 113.4 | 105.5 | 115.1 | 100 | 163.7 | 140 |
| 234013_at | TRA@ | 177 | 69.59 | 73.2 | 121.3 | 70.36 | 106.2 | 83.8 | 78.28 | 115.1 | 78.43 | 207.9 |
| 234311_s_at | GTPBP10 | 152.7 | 140.2 | 186.6 | 158.2 | 142.8 | 163.6 | 107 | 128.8 | 179.3 | 137.8 | 189.4 |
| 234339_s_at | GLTSCR2 | 1991 | 1592 | 2345 | 1935 | 1569 | 1855 | 1400 | 1226 | 1612 | 1808 | 2952 |
| 234464_s_at | EME1 | 26.74 | 32.8 | 23.03 | 25.23 | 34.62 | 36.05 | 23.49 | 28.07 | 26.82 | 33.2 | 47.56 |
| 234733_s_at | FANCM | 38.56 | 31.84 | 30.04 | 33.16 | 34.28 | 29.68 | 25.69 | 25.58 | 29.42 | 30.84 | 46.44 |
| 235024_at | PHF17 | 111 | 116.7 | 121.4 | 100.8 | 93.65 | 95.62 | 119.8 | 88.88 | 95.94 | 101.1 | 119.8 |
| 235067_at | MKLN1 | 942.6 | 1156 | 943 | 1187 | 1147 | 800.8 | 1137 | 1074 | 989.1 | 1002 | 877.7 |
| 235200_at | ZNF561 | 163 | 134.8 | 103.4 | 145.9 | 122.6 | 106.6 | 109.8 | 111.3 | 119 | 139.7 | 176 |
| 235359_at | LRRC33 | 349 | 274.1 | 205.3 | 354.2 | 270.6 | 276.3 | 259.6 | 141.7 | 196.1 | 202.2 | 277.7 |
| 235593_at | ZEB2 | 774.5 | 621.8 | 383.5 | 691 | 551.3 | 697.8 | 425.5 | 570.5 | 673.3 | 596.4 | 396.7 |
| 235610_at | ALKBH8 | 76.87 | 65.27 | 54.86 | 79.96 | 64.83 | 69.17 | 54.25 | 52.08 | 74.79 | 55.08 | 124.8 |
| 235623_at | ELP2 | 28.21 | 29.65 | 31.13 | 28.68 | 24.94 | 28.01 | 29.69 | 28.54 | 28.6 | 32 | 34.98 |
| 235690_at | ZNF594 | 37.8 | 23.62 | 25.94 | 26.28 | 29.1 | 23.87 | 30.93 | 23.36 | 25.26 | 31.5 | 47.45 |
| 237504_at | INTS10 | 91.75 | 86.89 | 65.38 | 77.54 | 71.72 | 74.29 | 62.18 | 84.13 | 86.26 | 85.47 | 88.46 |
| 238429_at | TMEM71 | 4027 | 4738 | 4531 | 3774 | 4731 | 4141 | 5656 | 6250 | 3875 | 5472 | 4497 |
| 238513_at | PRRG4 | 589.6 | 949.5 | 477 | 1593 | 1249 | 756 | 1482 | 751.4 | 1221 | 402.5 | 654.9 |
| 238736_at | REV3L | 327.9 | 339.4 | 291.1 | 269.8 | 259.7 | 266.8 | 425 | 307.4 | 234.2 | 272.7 | 301.6 |
| 238823_at | FMNL3 | 61.1 | 46.66 | 65.56 | 58.07 | 59.27 | 50.35 | 50.2 | 71.76 | 64.37 | 55.51 | 55.84 |
| 238909_at | S100A10 | 290.4 | 144.4 | 147.8 | 124 | 135.2 | 142.1 | 147.7 | 95.89 | 124.8 | 107 | 100.2 |
| 239108_at | MLSTD1 | 178.9 | 252.9 | 234.4 | 154.7 | 269 | 212.3 | 223.2 | 204.8 | 263.9 | 250.3 | 153.4 |
| 239897_at | BCLAF1 | 270.6 | 247.8 | 268.8 | 231.5 | 247.9 | 215 | 213.3 | 223.8 | 185.1 | 231.3 | 239 |
| 241368_at | LSDP5 | 208.9 | 352.2 | 299.6 | 367.3 | 403.6 | 307 | 307 | 386.1 | 278.3 | 500.8 | 310.7 |
| 241704_x_at | ZNF320 | 73.27 | 49.49 | 37.61 | 56.8 | 63.24 | 60.61 | 52.28 | 49.45 | 54.62 | 52.44 | 72.77 |
| 241706_at | CPNE8 | 168.5 | 118.6 | 98.83 | 121.4 | 94.15 | 119.2 | 91.99 | 78.89 | 91.27 | 92.01 | 100.2 |
| 241731_x_at | ZNF440 | 67.29 | 60.8 | 56.78 | 58.38 | 69.95 | 51.15 | 56.35 | 53.25 | 52.34 | 52.59 | 60.91 |
| 242197_x_at | CD36 | 47.53 | 15.07 | 20.04 | 55.01 | 40.17 | 56.45 | 35.62 | 32.33 | 17.05 | 50.8 | 48.93 |
| 242561_at | IPO9 | 41.02 | 33.29 | 27.38 | 35.98 | 24.53 | 31.99 | 21.94 | 24.1 | 30.9 | 26.28 | 25.3 |
| 242569_at | STAM2 | 326.4 | 310.2 | 241.7 | 342.1 | 330.3 | 300.2 | 268 | 335.8 | 289.4 | 360.2 | 313.5 |
| 242669_at | UFM1 | 297 | 278 | 262.7 | 302.8 | 265.1 | 305 | 209.4 | 221.3 | 324.4 | 220.8 | 225.1 |
| 243982_at | KLHL28 | 132.6 | 92.12 | 103.6 | 134.6 | 158.1 | 95.4 | 139.1 | 109 | 109 | 103.5 | 148.4 |
| 244038_at | WDR89 | 52.43 | 50 | 51.77 | 61.11 | 53.37 | 47.74 | 57.74 | 40.12 | 58.36 | 42.46 | 68.6 |
| 244654_at | MYO1G | 1789 | 1596 | 1853 | 1498 | 1338 | 1372 | 1402 | 1367 | 1335 | 1377 | 1486 |
| 244698_at | CDRT4 | 31.83 | 33.58 | 42.34 | 44.12 | 33.24 | 33.79 | 30.11 | 33.85 | 38.15 | 37.21 | 32.34 |
| 36566_at | CTNS | 114.3 | 100.2 | 112.3 | 119 | 101.5 | 95.52 | 83.74 | 86.35 | 77.96 | 99.66 | 108.5 |
| 37549_g_at | BBS9 | 47.53 | 37.19 | 46.39 | 43.79 | 42.47 | 42.57 | 37.35 | 43.14 | 43.51 | 38.7 | 43.04 |
| 48659_at | RP5-1077B9.4 | 199.5 | 185.6 | 172.4 | 192.4 | 201.1 | 169.6 | 215.8 | 171 | 192.1 | 197.7 | 219.6 |
| 56829_at | NIBP | 133 | 170.3 | 149.8 | 157.1 | 150.7 | 137.2 | 132.9 | 170.5 | 154.9 | 146.6 | 150.2 |
| 64486_at | CORO1B | 250.8 | 188.8 | 148.6 | 252.7 | 279.1 | 197.1 | 220 | 167 | 172 | 182.4 | 213.5 |
| 65493_at | HEATR6 | 56.59 | 35.06 | 42.69 | 39.23 | 34.23 | 40.4 | 41.43 | 33.94 | 41.52 | 23.55 | 37.68 |
| AFFX- | GAPDH | 8347 | 7922 | 8861 | 8956 | 8248 | 7472 | 8602 | 8829 | 7532 | 9750 | 8389 |
| HUMGAPDH/M33197_3_at | | | | | | | | | | | | |

| | | | | | | | | | | NYHA | NYHA | NYHA | NYHA |
|---|---|---|---|---|---|---|---|---|---|---|---|---|---|
| | Control | Control | Control | Control | Control | Control | Control | Control | Control | I-II | I-II | I-II | I-II |
| Affymetrix Probe | Sample | Sample | Sample | Sample | Sample | Sample | Sample | Sample | Sample | Sample | Sample | Sample | Sample |
| set ID | no. 11 | no. 12 | no. 13 | no. 14 | no. 15 | no. 16 | no. 19 | no. 21 | no. 29 | no. 31 | no. 33 | no. 34 | no. 35 |
| 1552318_at | 2180 | 1941 | 1659 | 1741 | 2171 | 1068 | 1800 | 1347 | 1780 | 1591 | 2961 | 1998 | 1270 |
| 1552630_a_at | 80.26 | 85.67 | 112.5 | 80.08 | 82.08 | 75.01 | 138.6 | 72.66 | 127.8 | 80.54 | 120.7 | 81.18 | 94.63 |
| 1554149_at | 783.8 | 745.1 | 840.5 | 715.5 | 833.1 | 608.4 | 787.4 | 768.6 | 884.9 | 682.5 | 759.4 | 723.7 | 863.8 |
| 1554539_a_at | 94.56 | 106.4 | 88.55 | 77.94 | 117.9 | 57.39 | 74.83 | 54.93 | 83.8 | 54.31 | 104.1 | 116.2 | 69.98 |
| 1554606_at | 155.9 | 128.1 | 117.4 | 167.2 | 172.1 | 136.6 | 126.6 | 156.4 | 141.7 | 62.39 | 173.8 | 113.9 | 120.4 |
| 1555630_a_at | 131.1 | 101.1 | 102.8 | 125.7 | 157.2 | 85.99 | 143.4 | 100.9 | 94.46 | 117.5 | 87.08 | 292 | 90.07 |
| 1555963_x_at | 29.58 | 41.06 | 49.48 | 40.71 | 51.69 | 46.88 | 46.88 | 46.88 | 41.91 | 53.58 | 44.09 | 65.59 | 60.24 |
| 1555996_s_at | 1162 | 1107 | 796.4 | 1138 | 1198 | 771.6 | 1194 | 639.8 | 980.2 | 247.1 | 1391 | 1217 | 850.3 |
| 1556113_at | 29.78 | 45.44 | 39.82 | 29.05 | 37.23 | 38.7 | 40.81 | 41.72 | 32.63 | 49.86 | 28.92 | 52.49 | 34.93 |
| 1556283_s_at | 130.7 | 114.9 | 96.99 | 117.5 | 89.51 | 144 | 88.41 | 80.86 | 107.2 | 107.2 | 79.99 | 124 | 115.5 |
| 1556864_at | 61.7 | 77.04 | 58.94 | 46.05 | 51.03 | 47.33 | 56.31 | 50.05 | 46.87 | 46.94 | 47.15 | 47.21 | 31.95 |
| 1557066_at | 199.7 | 160.4 | 153.3 | 210.7 | 219.2 | 123 | 157 | 156.1 | 238.5 | 112 | 297.5 | 198 | 156.4 |
| 1558277_at | 27.12 | 43.58 | 39.73 | 25.89 | 40.88 | 44.61 | 27.02 | 30.47 | 23.92 | 34.37 | 40.74 | 48.45 | 35.13 |
| 1558755_x_at | 196 | 153 | 207.2 | 132.6 | 159.3 | 186.8 | 154.3 | 228.6 | 132.2 | 134.5 | 146.2 | 121 | 80.78 |
| 1561146_at | 96.38 | 65.76 | 65.76 | 75.08 | 100.6 | 155.3 | 87.59 | 60.16 | 86.45 | 81.61 | 90.64 | 72.6 | 38.85 |
| 1564962_at | 29.45 | 50.32 | 34.43 | 46.31 | 30.9 | 51.92 | 40.27 | 30.69 | 31.47 | 28.56 | 36.96 | 47.11 | 22.78 |
| 1567013_at | 106.9 | 103.3 | 95.28 | 135.3 | 95.36 | 169 | 111.8 | 104.9 | 91.88 | 85.32 | 79.6 | 72.51 | 80.6 |
| 1568815_a_at | 152.6 | 103.4 | 159.2 | 139.7 | 180 | 217 | 153.6 | 163.8 | 175.6 | 198.7 | 201 | 224.1 | 135.5 |
| 200007_at | 7220 | 6459 | 7980 | 8188 | 7727 | 6601 | 7708 | 7508 | 7928 | 7913 | 8520 | 8572 | 8580 |
| 200010_at | 14275 | 12614 | 12659 | 14124 | 14740 | 9908 | 12741 | 13258 | 13676 | 13617 | 16256 | 14792 | 13757 |
| 200059_s_at | 8565 | 10365 | 9324 | 10340 | 9934 | 9979 | 11431 | 10357 | 9985 | 8754 | 9077 | 9222 | 9710 |
| 200091_s_at | 21979 | 19703 | 20867 | 24197 | 22838 | 18095 | 17295 | 21336 | 19407 | 22464 | 25069 | 23118 | 16091 |
| 200633_at | 7812 | 9041 | 7877 | 9864 | 8856 | 6456 | 8525 | 7210 | 9112 | 9452 | 10149 | 12007 | 9125 |
| 200650_s_at | 5589 | 5187 | 5280 | 5580 | 5079 | 5833 | 6568 | 4156 | 5527 | 5432 | 4919 | 6633 | 5470 |
| 200672_x_at | 261.1 | 133.9 | 185.9 | 180 | 183.8 | 133.6 | 157.8 | 171.2 | 143.1 | 89.18 | 304.4 | 156.4 | 131.3 |
| 200677_at | 2713 | 2326 | 2619 | 2726 | 1929 | 2750 | 3273 | 2640 | 2523 | 2992 | 2608 | 2665 | 2984 |
| 200713_s_at | 1408 | 1333 | 1283 | 1425 | 1570 | 1474 | 1557 | 1276 | 1337 | 1387 | 1524 | 1377 | 1611 |
| 200822_x_at | 1181 | 1196 | 1222 | 1357 | 1327 | 1350 | 1437 | 1095 | 1170 | 1206 | 1107 | 995 | 1327 |
| 200829_x_at | 541.9 | 497.1 | 506.5 | 631.4 | 607.2 | 438.2 | 638 | 427.9 | 558.2 | 579.3 | 642.9 | 750.9 | 632.4 |
| 200839_s_at | 2288 | 2548 | 2874 | 3021 | 3064 | 2520 | 3710 | 1382 | 1997 | 2524 | 1909 | 2542 | 2134 |
| 200932_s_at | 422.6 | 415.1 | 474.9 | 518.6 | 453.7 | 405.1 | 493.7 | 466.4 | 448.6 | 528.8 | 496.6 | 467.6 | 498.3 |
| 200950_at | 432.1 | 473.2 | 447.4 | 553.6 | 491.1 | 557.6 | 520.9 | 516.2 | 476.3 | 370.7 | 475.1 | 482.1 | 576 |
| 201031_s_at | 10377 | 8079 | 9773 | 7760 | 10535 | 6495 | 9850 | 8607 | 10650 | 10046 | 10812 | 11153 | 9596 |
| 201075_s_at | 340.9 | 283.4 | 376.8 | 292.2 | 350.2 | 295.4 | 384.2 | 347.9 | 361.8 | 264.2 | 382 | 298.9 | 338.5 |
| 201098_at | 726.6 | 713.9 | 821.1 | 828.5 | 783.1 | 788 | 868.6 | 755.1 | 788.6 | 734.6 | 791.9 | 773.7 | 828.5 |
| 201105_at | 2461 | 3190 | 2515 | 3836 | 3588 | 1856 | 6006 | 1566 | 3805 | 3895 | 3013 | 4701 | 3644 |
| 201172_x_at | 2860 | 3093 | 3348 | 3580 | 3239 | 3718 | 3675 | 3678 | 3017 | 3461 | 2989 | 3153 | 3509 |
| 201186_at | 527.7 | 381.9 | 483.4 | 384.1 | 369.2 | 489.3 | 542 | 531.3 | 446.7 | 612.2 | 448.3 | 367.4 | 588 |
| 201193_at | 436.6 | 505.8 | 523 | 573.3 | 468 | 551 | 570.9 | 409.5 | 392.2 | 491.8 | 433.6 | 468.7 | 587.5 |
| 201198_s_at | 145 | 162.5 | 145 | 185.6 | 156.5 | 133.4 | 176.4 | 139.8 | 147.3 | 168.8 | 164.9 | 226.7 | 167.2 |
| 201220_x_at | 1215 | 1767 | 1498 | 1414 | 1352 | 1792 | 1934 | 1515 | 1468 | 1665 | 1107 | 1825 | 1688 |
| 201234_at | 1030 | 1091 | 1178 | 1193 | 1147 | 989.3 | 1333 | 1098 | 1096 | 1193 | 1132 | 1254 | 1303 |
| 201357_s_at | 302.3 | 354.3 | 390.9 | 309.7 | 434.1 | 429.1 | 395.4 | 361.5 | 358.7 | 273.1 | 356.4 | 261.7 | 350 |
| 201363_s_at | 1729 | 1264 | 1757 | 1714 | 1700 | 2039 | 2128 | 1707 | 1799 | 1507 | 1746 | 1470 | 1415 |
| 201400_at | 1474 | 1344 | 1535 | 1888 | 1982 | 1798 | 1656 | 1898 | 1498 | 1841 | 1398 | 1532 | 1616 |
| 201421_s_at | 160.2 | 185.3 | 193.4 | 177.1 | 215.5 | 137.5 | 201.6 | 165.3 | 176.6 | 181.7 | 213.9 | 197.6 | 171.5 |
| 201422_at | 7083 | 6463 | 6479 | 7213 | 7880 | 6955 | 8967 | 4746 | 6676 | 6192 | 5881 | 6220 | 6458 |
| 201426_s_at | 14621 | 13865 | 13906 | 17697 | 14711 | 13516 | 21640 | 12540 | 15777 | 14544 | 14604 | 14926 | 13738 |
| 201453_x_at | 984.8 | 1226 | 1140 | 1303 | 1298 | 1124 | 1354 | 1266 | 1121 | 1288 | 1219 | 1388 | 1297 |
| 201470_at | 997.1 | 998.5 | 947.4 | 1348 | 1300 | 859.9 | 1675 | 1166 | 1236 | 1143 | 1358 | 1363 | 876.6 |
| 201478_s_at | 316.7 | 263.9 | 287.1 | 320.1 | 335.4 | 238.6 | 289.1 | 283.3 | 318.3 | 250.8 | 358.1 | 304.3 | 291.6 |
| 201527_at | 765.7 | 921 | 841.8 | 910.2 | 976.4 | 739.1 | 903.6 | 745.8 | 693.5 | 911.1 | 813.2 | 877.7 | 919.7 |
| 201536_at | 348.5 | 275.8 | 307 | 316 | 297.2 | 414.4 | 384.8 | 265.3 | 308.7 | 320.5 | 238.5 | 269.3 | 285.5 |
| 201554_x_at | 735.9 | 608.2 | 579.9 | 782.8 | 682.5 | 1187 | 796.6 | 685.2 | 537 | 707.7 | 563.7 | 665 | 570.4 |
| 201556_s_at | 494.6 | 651.2 | 753.2 | 621.4 | 642.4 | 678.9 | 626.8 | 592.9 | 697.4 | 581.6 | 752.4 | 587.6 | 482.5 |
| 201576_s_at | 559.7 | 449.8 | 635.6 | 643.5 | 611.2 | 540.4 | 814 | 612.4 | 571.7 | 618.6 | 474.5 | 542.7 | 644.4 |
| 201590_x_at | 2652 | 2876 | 2617 | 3020 | 3347 | 2146 | 4145 | 2079 | 2815 | 3006 | 2535 | 3672 | 2935 |
| 201628_s_at | 488.2 | 603.1 | 574.2 | 620.1 | 590.2 | 589.7 | 538.6 | 560.2 | 599 | 595 | 550.7 | 599.3 | 668.6 |
| 201788_at | 603 | 626.9 | 692.4 | 589.7 | 614.2 | 537 | 599.1 | 630.4 | 564.8 | 583.4 | 588.9 | 546.3 | 543.2 |
| 201900_s_at | 362.1 | 401.3 | 384.4 | 470.2 | 471.6 | 319.2 | 425.9 | 303.2 | 392.8 | 413.6 | 314.2 | 504.5 | 404.1 |
| 201945_at | 521.9 | 477.9 | 544.4 | 460.2 | 393.6 | 753.2 | 577.7 | 564.6 | 451.6 | 531 | 374 | 245.6 | 443.7 |
| 202068_s_at | 73.63 | 45.65 | 52.43 | 119.8 | 83.15 | 76.89 | 124 | 43.87 | 79.78 | 82.71 | 107 | 102.8 | 133.6 |
| 202104_s_at | 449 | 306.5 | 498.5 | 415 | 496.1 | 309.9 | 439.5 | 374.4 | 498.9 | 466.1 | 667.8 | 542.7 | 569.8 |
| 202138_x_at | 220.4 | 268.9 | 236.9 | 277.6 | 299 | 193.1 | 270 | 208.9 | 244.9 | 256 | 243.6 | 303.8 | 270 |
| 202185_at | 157.4 | 222.3 | 206.9 | 177.4 | 215.9 | 169.8 | 258.1 | 166.3 | 232.6 | 215 | 227.2 | 292 | 226.4 |
| 202192_s_at | 687.1 | 454.8 | 667.9 | 678.1 | 528.7 | 404.6 | 1198 | 588.6 | 867.5 | 1004 | 419.4 | 409.9 | 1165 |
| 202201_at | 429.1 | 540.1 | 586.1 | 534.5 | 481.3 | 526.8 | 1008 | 350 | 452 | 563.2 | 418.1 | 545.9 | 532.5 |
| 202249_s_at | 216.4 | 224.6 | 281.1 | 211.6 | 243.9 | 210.1 | 272.9 | 211.1 | 267.2 | 209.1 | 202.4 | 221.2 | 327.3 |
| 202252_at | 62.72 | 96.62 | 73.68 | 95.43 | 68.8 | 101.7 | 111.4 | 114.8 | 84.57 | 99.32 | 42.73 | 47.43 | 137 |
| 202262_x_at | 94.82 | 76.56 | 113 | 73.66 | 82.61 | 163.8 | 95.96 | 102.2 | 82.24 | 88.44 | 70.46 | 89.79 | 81.95 |
| 202380_s_at | 714.1 | 592.8 | 780.1 | 810.5 | 899.5 | 519.7 | 655.9 | 645.4 | 778.6 | 790.2 | 942.8 | 783.7 | 887.5 |
| 202381_at | 322 | 245.8 | 288.6 | 352.4 | 252.2 | 589.3 | 336.7 | 308.5 | 342.1 | 297.7 | 221.2 | 251.6 | 406.9 |
| 202428_x_at | 1841 | 2036 | 1832 | 2433 | 2179 | 1564 | 2063 | 1724 | 2145 | 1881 | 2214 | 2697 | 2227 |
| 202445_s_at | 163.2 | 92.32 | 186.6 | 159.1 | 143.2 | 159.4 | 189 | 195.1 | 133.8 | 157.3 | 91.05 | 120.9 | 115.6 |
| 202461_at | 150.9 | 155.3 | 131.9 | 237.8 | 201.6 | 135.4 | 185.3 | 171.2 | 176.3 | 209.1 | 227.1 | 254.2 | 195.2 |
| 202522_at | 660.5 | 793 | 534.8 | 709.9 | 688.4 | 661.4 | 722.3 | 694 | 619.9 | 711.3 | 704.6 | 759 | 721.3 |
| 202523_s_at | 343.7 | 309.3 | 251.2 | 197.3 | 236.1 | 173 | 184.3 | 209.4 | 241.4 | 178.2 | 458 | 287.5 | 173.4 |
| 202594_at | 1238 | 994.8 | 1048 | 1085 | 1133 | 844 | 1063 | 1112 | 1112 | 1083 | 1718 | 1142 | 976.7 |
| 202623_at | 1191 | 1124 | 1379 | 1341 | 1194 | 1162 | 1184 | 1313 | 1176 | 1176 | 1148 | 1109 | 1280 |
| 202652_at | 54.27 | 42.91 | 48.71 | 39.65 | 37.66 | 26.16 | 36.1 | 39.13 | 47.45 | 38.71 | 95.89 | 24.76 | 37.71 |
| 202724_s_at | 685.1 | 426.9 | 509.2 | 608.8 | 488.3 | 511.4 | 477 | 800.7 | 605.6 | 585.2 | 798.6 | 522 | 525.1 |
| 202750_s_at | 193.4 | 193.5 | 222.7 | 203.2 | 189.8 | 212.8 | 237.2 | 96.53 | 140.6 | 237 | 195.1 | 215.7 | 234.6 |
| 202778_s_at | 622.4 | 528 | 698.4 | 601 | 577.5 | 562.9 | 495.2 | 691 | 617.4 | 735.6 | 561.7 | 483 | 676.2 |
| 202910_s_at | 3466 | 3382 | 3627 | 2680 | 3494 | 2158 | 4296 | 4574 | 3991 | 4970 | 3025 | 2470 | 4916 |
| 202928_s_at | 166.9 | 157.2 | 191 | 181.7 | 157.8 | 188 | 141.3 | 151.9 | 213.9 | 140.8 | 225.3 | 128.9 | 178.6 |
| 202944_at | 339.3 | 376.5 | 323.7 | 348.5 | 469.3 | 276.3 | 466.4 | 236.6 | 284 | 365.5 | 251.6 | 415.2 | 351.5 |
| 202979_s_at | 767.7 | 653.7 | 750.9 | 925.9 | 875.8 | 460.3 | 693.7 | 624 | 857.7 | 592 | 1099 | 865.8 | 807.5 |
| 203003_at | 91.75 | 133.7 | 142.9 | 94.78 | 95.68 | 110.3 | 105.5 | 98.1 | 103.1 | 98.45 | 88.48 | 98.02 | 88.56 |
| 203127_s_at | 208.9 | 262 | 222.1 | 290.5 | 321.2 | 374.8 | 376.5 | 242 | 290.9 | 257.3 | 208 | 197.5 | 317.5 |
| 203137_at | 1730 | 1855 | 1704 | 1824 | 1974 | 1742 | 1945 | 1616 | 2003 | 1433 | 2025 | 2126 | 1783 |
| 203184_at | 73.37 | 35.37 | 36.05 | 81.62 | 29.66 | 81.14 | 116.4 | 37.18 | 60.09 | 59.88 | 38.33 | 52.72 | 105.7 |
| 203234_at | 561.6 | 241.8 | 450 | 398.4 | 378.2 | 423.4 | 641.9 | 331.8 | 393 | 612.8 | 474.4 | 479.2 | 376.7 |
| 203278_s_at | 1176 | 752 | 865 | 800.5 | 804.1 | 1161 | 1095 | 1184 | 799.6 | 1300 | 709.2 | 803 | 880.4 |
| 203305_at | 918.8 | 501.5 | 789.9 | 1395 | 511.3 | 1091 | 1423 | 1002 | 1014 | 1182 | 1308 | 632.6 | 1472 |
| 203371_s_at | 1422 | 1022 | 943.3 | 1178 | 911.1 | 1179 | 1085 | 1326 | 889.5 | 1340 | 895.3 | 1039 | 1042 |
| 203413_at | 975.6 | 529.1 | 657 | 474.2 | 648.6 | 515.5 | 224.5 | 923.3 | 805.6 | 492.6 | 1181 | 475.2 | 469.7 |
| 203416_at | 8837 | 11286 | 9761 | 10625 | 11158 | 10060 | 11136 | 10917 | 10038 | 10473 | 9524 | 10298 | 11366 |
| 203492_x_at | 249.7 | 236.8 | 208.9 | 304 | 331.9 | 190.6 | 262.4 | 237.2 | 251.5 | 195.3 | 310.5 | 301.2 | 260.3 |
| 203534_at | 733.2 | 602.9 | 730.8 | 822.4 | 864.6 | 624.4 | 757.5 | 679.8 | 768.7 | 871.1 | 797.4 | 888.8 | 902.5 |
| 203535_at | 37683 | 36308 | 39457 | 39511 | 34853 | 45270 | 42972 | 44450 | 35573 | 41945 | 33292 | 29396 | 36045 |
| 203578_s_at | 193.5 | 112.5 | 91.18 | 119.5 | 122 | 120 | 87.53 | 88.04 | 129.1 | 40.32 | 179.6 | 130.5 | 93.12 |
| 203748_x_at | 1563 | 1508 | 1443 | 1528 | 1400 | 1954 | 1402 | 1647 | 1467 | 1314 | 1415 | 1165 | 1458 |
| 203759_at | 133.4 | 58.73 | 146.6 | 88.74 | 78.85 | 252.5 | 138.5 | 171.3 | 82.92 | 84.5 | 91.54 | 92.68 | 86.43 |
| 203844_at | 24.82 | 29.75 | 28.12 | 23.59 | 27.3 | 27.82 | 27.28 | 28.96 | 21.25 | 26.74 | 25.05 | 28.09 | 31 |
| 203880_at | 250 | 248.8 | 240.2 | 294.7 | 305.5 | 203.5 | 285.8 | 232.2 | 308.7 | 291.6 | 266.2 | 318 | 274.8 |
| 203912_s_at | 166.8 | 153.3 | 168.9 | 203 | 240.7 | 161.1 | 236.1 | 233.4 | 227.8 | 238.7 | 156.7 | 220.8 | 213.1 |
| 203939_at | 88.55 | 114 | 104 | 91.88 | 91.38 | 71.17 | 54.18 | 154.6 | 60.44 | 68.01 | 71.07 | 81.11 | 58.89 |
| 203971_at | 89.49 | 86.94 | 88.48 | 105 | 106.9 | 95.64 | 114 | 75.3 | 114.1 | 113.2 | 95.25 | 79.5 | 109.2 |
| 204050_s_at | 1015 | 1187 | 1048 | 1295 | 1357 | 1204 | 1337 | 1013 | 1097 | 1139 | 1182 | 1308 | 1199 |
| 204068_at | 89.44 | 49.51 | 69.7 | 54.7 | 63.36 | 104.5 | 62.22 | 131.1 | 58.95 | 100 | 37.96 | 55.16 | 55.1 |
| 204099_at | 122.6 | 122.8 | 157.6 | 159.6 | 151.9 | 208.7 | 172.5 | 100.5 | 113.4 | 179.3 | 94.82 | 122.8 | 117.6 |
| 204143_s_at | 320.5 | 178.9 | 196.1 | 159.5 | 290.1 | 117.9 | 176.2 | 117.6 | 311.1 | 216.1 | 266 | 242.4 | 175.9 |
| 204204_at | 1726 | 1717 | 2027 | 2175 | 1952 | 977.3 | 2554 | 2420 | 2238 | 2729 | 1541 | 1401 | 2706 |
| 204214_s_at | 449.5 | 491.8 | 528.1 | 429.3 | 516.6 | 554.4 | 710.6 | 502.6 | 438.1 | 518.6 | 347.9 | 394.9 | 451.1 |
| 204232_at | 2568 | 3407 | 4203 | 3835 | 3297 | 4650 | 4744 | 2951 | 3697 | 3166 | 3688 | 3457 | 5537 |
| 204243_at | 277.8 | 195.3 | 245.3 | 274.3 | 320.8 | 318.7 | 310 | 299.6 | 248.9 | 259.6 | 269.5 | 238.9 | 310.7 |
| 204249_s_at | 2042 | 2600 | 2411 | 2150 | 2252 | 2719 | 2749 | 2191 | 2363 | 1718 | 1760 | 2654 | 2875 |
| 204291_at | 470.7 | 464.2 | 497.5 | 417.9 | 436.6 | 410.3 | 497.8 | 457 | 529.2 | 481.8 | 448.5 | 522 | 457.7 |
| 204342_at | 721 | 710.2 | 712.7 | 910.7 | 865.3 | 748.7 | 759 | 827.4 | 948.2 | 861.6 | 578.8 | 864.8 | 799.7 |
| 204352_at | 508.5 | 540.2 | 487 | 593.8 | 591.3 | 317 | 357.6 | 672.9 | 553.4 | 657.9 | 771.3 | 644.4 | 616.3 |
| 204401_at | 127.5 | 176.4 | 188.3 | 123.9 | 151.8 | 197.4 | 155.5 | 174.7 | 198.7 | 140.1 | 149.2 | 147.4 | 131.6 |
| 204504_s_at | 124.6 | 93.56 | 97.37 | 118.9 | 108.2 | 77.85 | 107.3 | 103.6 | 116 | 105 | 139.4 | 127.5 | 93.96 |
| 204617_s_at | 303.3 | 334.8 | 396.1 | 311.7 | 297.5 | 271.8 | 351.9 | 367.4 | 398.1 | 329.4 | 372.6 | 396.6 | 339.3 |
| 204645_at | 895.3 | 815.8 | 1001 | 925.5 | 918.3 | 869.2 | 864.6 | 969.1 | 1200 | 754.4 | 943.1 | 931.2 | 946.5 |
| 204675_at | 68.19 | 72.33 | 71.86 | 96.6 | 94.28 | 57.31 | 162.5 | 73.74 | 84.45 | 105.6 | 96.23 | 105.7 | 89.3 |
| 204689_at | 359.3 | 437.3 | 471.6 | 480.7 | 471.6 | 632.3 | 397.5 | 516.1 | 371.5 | 356 | 311.5 | 472.1 | 456.2 |
| 204801_s_at | 79.22 | 28.79 | 49.84 | 34.74 | 40.04 | 32.57 | 24.03 | 54.37 | 37.22 | 38.62 | 29.76 | 18.42 | 36.82 |
| 205235_s_at | 103.1 | 92.75 | 91.13 | 103.1 | 102.3 | 86.35 | 103.2 | 127.3 | 87.34 | 81.53 | 95.19 | 95.81 | 122.9 |
| 205254_x_at | 700.2 | 423.9 | 362.3 | 284.8 | 504.9 | 279.4 | 193.1 | 330.8 | 441.9 | 257.1 | 1063 | 298.2 | 280.7 |
| 205256_at | 74.39 | 84.52 | 65.81 | 87.65 | 68.62 | 74.98 | 67.25 | 77.83 | 79.39 | 86.87 | 90.89 | 65.29 | 75.15 |
| 205322_s_at | 420 | 507 | 480.1 | 476.5 | 420.5 | 620.9 | 464.3 | 432.8 | 439.8 | 594.9 | 392.9 | 401.1 | 491 |
| 205340_at | 176.6 | 174.6 | 169.1 | 131.4 | 145.8 | 99.61 | 123.1 | 161.4 | 149 | 157 | 181.1 | 164 | 164.8 |
| 205349_at | 165.5 | 149.3 | 188 | 166 | 150.4 | 148.8 | 222.8 | 135.9 | 149.2 | 154.7 | 106.4 | 142.1 | 124.3 |
| 205550_s_at | 227.3 | 232.3 | 237.9 | 277 | 249.5 | 311 | 260.2 | 275.5 | 249.4 | 301.5 | 244.3 | 262.5 | 265.5 |
| 205811_at | 213 | 207.2 | 151.4 | 182.2 | 214 | 135.8 | 176.6 | 173.2 | 148.9 | 170.8 | 199.8 | 197.8 | 179.3 |
| 205835_s_at | 118.1 | 97.06 | 60.61 | 111.4 | 124.9 | 78.26 | 153.5 | 57.87 | 114.8 | 73.58 | 135.8 | 113.8 | 100 |
| 205895_s_at | 168 | 205.3 | 139.4 | 159.5 | 220.1 | 95.19 | 190.9 | 120 | 153.6 | 86.99 | 182.5 | 240.4 | 153.8 |
| 205965_at | 179.3 | 170.4 | 194.7 | 252.8 | 206.2 | 312.5 | 211.9 | 151.2 | 196.3 | 295.2 | 210.4 | 288.9 | 217.9 |
| 205976_at | 65.18 | 52.49 | 51.75 | 65.68 | 68.68 | 24.68 | 61 | 45.02 | 68.97 | 48.6 | 73.65 | 57.5 | 48.08 |
| 206015_s_at | 720.4 | 675.3 | 829.2 | 806.3 | 754.5 | 662.3 | 657.9 | 819.8 | 704.9 | 660.3 | 894 | 794.1 | 744.2 |
| 206037_at | 43.46 | 36.24 | 38.13 | 40.41 | 31.69 | 35.84 | 47.18 | 39.5 | 35.46 | 35.48 | 37 | 45.67 | 40.87 |
| 206170_at | 76.53 | 254.6 | 176.5 | 359.3 | 318.1 | 136.8 | 230.8 | 120.4 | 237.3 | 305.8 | 175.8 | 370.1 | 389.2 |
| 206182_at | 130.6 | 121.8 | 104 | 119.9 | 108.7 | 104.1 | 109.6 | 114.4 | 96.47 | 93.98 | 138.5 | 104.1 | 100.9 |
| 206343_s_at | 9.973 | 9.604 | 16.27 | 14.24 | 11.29 | 23.76 | 53.43 | 19.79 | 15.32 | 17.21 | 8.482 | 6.955 | 9.874 |
| 206542_s_at | 1260 | 1085 | 1608 | 1339 | 1453 | 1240 | 1278 | 1725 | 1588 | 1344 | 1433 | 1233 | 1425 |
| 206580_s_at | 42.73 | 52.92 | 52.74 | 54.96 | 62.79 | 62.97 | 80.75 | 60.92 | 51.47 | 68.79 | 52.16 | 50.5 | 45.64 |
| 206715_at | 212.4 | 247.1 | 183.5 | 270.5 | 243.5 | 249.1 | 353.8 | 124.5 | 157.2 | 144.8 | 181.5 | 236.3 | 209.1 |
| 206834_at | 68.52 | 78 | 47.76 | 56.27 | 70.2 | 44.42 | 57.99 | 98.81 | 58.25 | 55.98 | 69.72 | 71.68 | 69.62 |
| 206968_s_at | 113.7 | 82.51 | 120 | 102.3 | 143.7 | 114.7 | 122.1 | 105.7 | 114.2 | 72.09 | 149.7 | 113.5 | 117.5 |
| 207075_at | 152.9 | 109.8 | 119.6 | 180.3 | 88.32 | 104.4 | 136.9 | 132.8 | 171.4 | 119.1 | 53.62 | 61.89 | 182.5 |
| 207078_at | 217.6 | 173.9 | 215.4 | 144.3 | 248.5 | 137.5 | 191.6 | 201.3 | 177.8 | 308.5 | 189.8 | 225.9 | 183.7 |
| 207113_s_at | 78.88 | 118.9 | 83 | 113.7 | 118.1 | 104 | 123.3 | 82.14 | 125.7 | 122.2 | 109.9 | 88.42 | 152.1 |
| 207164_s_at | 694.3 | 684.8 | 596.9 | 539.5 | 706.4 | 613.5 | 747.3 | 672.7 | 605.5 | 193.4 | 632 | 415.1 | 556.1 |
| 207233_s_at | 75.53 | 88.88 | 100.3 | 80.45 | 85.4 | 73.72 | 121.1 | 78.38 | 84.37 | 70.36 | 64.66 | 63.51 | 75.21 |
| 207416_s_at | 253.5 | 270.1 | 311.8 | 325.7 | 257.4 | 198.4 | 293.2 | 297.9 | 320 | 323.6 | 297.9 | 436.5 | 324 |
| 207513_s_at | 263.7 | 248.5 | 313.6 | 229.6 | 227.4 | 219.1 | 234.8 | 244.6 | 271.5 | 237.8 | 265.8 | 265.3 | 226.2 |
| 207543_s_at | 241.5 | 287.9 | 267.9 | 293.1 | 284.1 | 405 | 356.7 | 359.9 | 267.7 | 325.9 | 232.8 | 319.3 | 393.5 |
| 207564_x_at | 4293 | 3451 | 3203 | 3529 | 4408 | 2297 | 4279 | 2807 | 4326 | 1845 | 4552 | 3506 | 3611 |
| 207971_s_at | 104.3 | 87.18 | 82.87 | 69.29 | 79.97 | 68.14 | 95.7 | 70.79 | 104.7 | 78.94 | 83.31 | 79.49 | 69.88 |
| 208104_s_at | 442.6 | 481.6 | 617.9 | 468.4 | 443.5 | 653.5 | 478.5 | 513.6 | 519.5 | 516 | 464.5 | 342.3 | 424 |
| 208121_s_at | 57.74 | 104.2 | 53.78 | 52.35 | 100.2 | 43.8 | 78.02 | 87.16 | 69.88 | 55.59 | 99.16 | 107.4 | 114.1 |
| 208161_s_at | 29.36 | 34.67 | 18.83 | 61.98 | 40.08 | 47.47 | 77.79 | 39.89 | 49.77 | 45.78 | 71 | 53.98 | 53.34 |
| 208269_s_at | 106.2 | 136 | 126.7 | 109.2 | 159.1 | 103.4 | 90.82 | 172.6 | 130.7 | 107.4 | 115.9 | 130.7 | 99.48 |
| 208309_s_at | 354.3 | 410.2 | 208.4 | 365.1 | 417.2 | 266.6 | 370.8 | 271.2 | 378.5 | 220.5 | 498.4 | 399.4 | 261.9 |
| 208527_x_at | 248.4 | 332.5 | 236 | 255.9 | 360.1 | 419.5 | 337.9 | 344.9 | 293.9 | 217 | 269 | 206.7 | 243.3 |
| 208579_x_at | 390.9 | 544.8 | 451.9 | 384.2 | 681.8 | 649.9 | 512.9 | 584 | 472.6 | 378.7 | 512.2 | 402.3 | 408.9 |
| 208635_x_at | 15617 | 16530 | 13673 | 16726 | 16157 | 12749 | 16195 | 13773 | 15808 | 14459 | 17974 | 17565 | 16391 |
| 208659_at | 5781 | 6296 | 6429 | 6879 | 6429 | 7955 | 7224 | 6955 | 6151 | 6704 | 5516 | 6293 | 6427 |
| 208680_at | 658.7 | 700.5 | 521.3 | 820.6 | 775.9 | 424.7 | 801.6 | 468.4 | 673.2 | 684.1 | 804 | 988.9 | 706.3 |
| 208749_x_at | 2303 | 1955 | 2017 | 1679 | 1620 | 2689 | 1894 | 2448 | 1586 | 2600 | 1637 | 1501 | 2143 |
| 208771_s_at | 2479 | 6048 | 3609 | 3913 | 4767 | 3830 | 5710 | 4652 | 3427 | 3573 | 4882 | 6047 | 3759 |
| 208780_x_at | 2456 | 2033 | 1961 | 2214 | 1934 | 3626 | 2724 | 3076 | 1857 | 2276 | 2026 | 1958 | 2024 |
| 208798_x_at | 2325 | 1244 | 1699 | 1629 | 2624 | 950.6 | 1043 | 1833 | 1776 | 2072 | 2714 | 1765 | 1586 |
| 208805_at | 1767 | 1807 | 1658 | 2396 | 2214 | 1651 | 2076 | 1494 | 1840 | 1823 | 1845 | 2380 | 1938 |
| 208868_s_at | 780 | 637 | 982.7 | 875.2 | 788.6 | 897.4 | 868.6 | 927.7 | 699.9 | 665.7 | 533.7 | 657.7 | 607.6 |
| 208903_at | 82.8 | 54.44 | 58.41 | 73.27 | 51.25 | 74.64 | 50.02 | 62.25 | 57.75 | 78.4 | 70.07 | 77.24 | 53.66 |
| 208921_s_at | 1128 | 1168 | 971.9 | 1269 | 1304 | 1170 | 1272 | 1051 | 1112 | 1183 | 1241 | 1339 | 1099 |
| 208923_at | 498.2 | 528.1 | 500.1 | 531.6 | 503.3 | 388.4 | 589.4 | 327.9 | 359.4 | 433.4 | 367 | 422.9 | 429.1 |
| 208946_s_at | 1383 | 1529 | 1629 | 1408 | 1538 | 1553 | 1454 | 1591 | 1537 | 1347 | 1515 | 1487 | 1518 |
| 208962_s_at | 52.67 | 61.95 | 73.04 | 63.2 | 57.93 | 40.13 | 86.35 | 40 | 35.74 | 65.26 | 55.35 | 86.18 | 72.31 |
| 209040_s_at | 1713 | 1612 | 1504 | 1932 | 1907 | 1414 | 1706 | 1437 | 1715 | 1710 | 1665 | 1820 | 1622 |
| 209067_s_at | 3121 | 2816 | 2647 | 3343 | 3451 | 2142 | 3100 | 2170 | 3788 | 2039 | 4123 | 3644 | 2898 |
| 209072_at | 65.23 | 62.14 | 41.96 | 56.32 | 50.59 | 56.86 | 63.45 | 79.22 | 57.83 | 48.21 | 25.15 | 32.52 | 69.59 |
| 209099_x_at | 112.2 | 70.88 | 97.89 | 87.44 | 68.19 | 106.2 | 112.9 | 92.73 | 82.32 | 92.48 | 75.33 | 93.06 | 120 |
| 209124_at | 4576 | 4777 | 4905 | 4537 | 4736 | 5779 | 5367 | 5312 | 4318 | 4305 | 3953 | 4387 | 5215 |
| 209180_at | 378.1 | 344.7 | 329.2 | 363.7 | 387.4 | 258.3 | 356.9 | 283 | 344.4 | 304.6 | 367.5 | 407.3 | 357.4 |
| 209191_at | 140.9 | 121.5 | 125.5 | 90.13 | 120.4 | 80.65 | 173.3 | 92.12 | 121.2 | 93.43 | 103 | 234.9 | 102.6 |
| 209212_s_at | 28.95 | 28.6 | 30.42 | 28.73 | 24.64 | 33.58 | 27.42 | 29.66 | 29.57 | 29.65 | 25.83 | 22.43 | 29.41 |
| 209218_at | 93.19 | 95.27 | 82.33 | 125.3 | 167.3 | 73.85 | 97.69 | 122.7 | 105.3 | 128.7 | 178.2 | 242.3 | 148.1 |
| 209236_at | 187.8 | 183.2 | 204.8 | 231.8 | 242.1 | 258.6 | 218.8 | 199.7 | 208 | 139.1 | 164.8 | 179.3 | 223.1 |
| 209251_x_at | 3928 | 5073 | 4228 | 5375 | 4756 | 5171 | 4857 | 5593 | 4869 | 4918 | 4579 | 3672 | 5199 |
| 209259_s_at | 535 | 517.6 | 691.3 | 563.6 | 694 | 450.9 | 576.3 | 647.1 | 658.5 | 491.1 | 710.6 | 674.6 | 619.6 |
| 209269_s_at | 513.6 | 567.7 | 794.5 | 583.9 | 627.9 | 695.8 | 579.3 | 772.1 | 628.9 | 421.4 | 374.1 | 432.9 | 570.1 |
| 209330_s_at | 2513 | 2169 | 2647 | 2496 | 2660 | 1515 | 2442 | 2191 | 3611 | 1726 | 3510 | 3457 | 2269 |
| 209339_at | 406.5 | 305.9 | 338.7 | 442.9 | 405.5 | 305 | 464.6 | 338.7 | 405.4 | 266.2 | 337.9 | 362.7 | 375.2 |
| 209430_at | 903.6 | 918.8 | 963.6 | 908.7 | 994 | 658.5 | 869.2 | 826.1 | 975.4 | 794.2 | 1094 | 976.4 | 907 |
| 209675_s_at | 1003 | 963.8 | 1303 | 1029 | 1316 | 1087 | 1250 | 1025 | 1454 | 970.2 | 1265 | 1058 | 1041 |
| 209684_at | 254.3 | 304 | 293.5 | 223.3 | 253.7 | 221.7 | 459.4 | 171.1 | 333.7 | 242.6 | 195.1 | 443.1 | 309.2 |
| 209806_at | 1460 | 1899 | 1453 | 1232 | 1886 | 1874 | 1627 | 1767 | 1673 | 1445 | 1475 | 1146 | 1262 |
| 209840_s_at | 1073 | 59.2 | 29.63 | 44.55 | 40.12 | 166.9 | 108 | 101.4 | 67.39 | 519.2 | 359.1 | 73.4 | 31.11 |
| 209870_s_at | 240.9 | 193.4 | 179 | 219.5 | 218 | 128.2 | 194.4 | 223.5 | 341.7 | 341.9 | 401.5 | 280.6 | 205.3 |
| 209892_at | 71.76 | 85.05 | 62.46 | 64.46 | 89.97 | 87.53 | 75.29 | 67.76 | 95.4 | 88.62 | 77.8 | 81.37 | 69.27 |
| 209906_at | 646 | 469.6 | 476.3 | 434.1 | 766 | 302.5 | 689.5 | 354.3 | 365 | 337.7 | 207.9 | 581.1 | 577.4 |
| 210022_at | 184.9 | 196.1 | 176.4 | 159.8 | 174.8 | 177.2 | 188.1 | 168 | 176.3 | 134.9 | 171.3 | 166.2 | 148.1 |
| 210061_at | 149.7 | 113.3 | 97.43 | 125.9 | 157.2 | 74.07 | 172 | 158.2 | 160.4 | 88.51 | 149.9 | 122.4 | 111.7 |
| 210145_at | 40.98 | 39.01 | 42.12 | 73.82 | 62.14 | 76.53 | 68.43 | 76.47 | 45.08 | 64.41 | 43.34 | 48.92 | 56.43 |
| 210156_s_at | 950.8 | 902.3 | 963.2 | 1168 | 1104 | 1108 | 1225 | 871.1 | 885.3 | 858.7 | 943.3 | 1242 | 879.6 |
| 210166_at | 577.6 | 380.7 | 283.9 | 354.4 | 352 | 898.3 | 425.4 | 694.2 | 244.6 | 444 | 265.8 | 294.8 | 232.9 |
| 210434_x_at | 2455 | 2507 | 2389 | 2632 | 2448 | 2501 | 2454 | 2338 | 2348 | 2650 | 2435 | 2427 | 2927 |
| 210644_s_at | 421.9 | 419.1 | 369.1 | 350.7 | 589.7 | 277 | 351.6 | 377.9 | 333.5 | 431.5 | 517 | 567.5 | 682 |
| 210648_x_at | 3053 | 3628 | 2988 | 3686 | 3520 | 4125 | 3118 | 3868 | 3021 | 3487 | 2762 | 3587 | 3647 |
| 210875_s_at | 230.5 | 164.2 | 258 | 219.3 | 247.2 | 277.8 | 190.5 | 321.7 | 203.8 | 104.4 | 223.7 | 107.5 | 189.6 |
| 211047_x_at | 993 | 1076 | 1081 | 1142 | 1273 | 845.8 | 1330 | 939.4 | 1080 | 1312 | 1032 | 1306 | 1212 |
| 211058_x_at | 4227 | 5421 | 4713 | 4862 | 4735 | 4751 | 4878 | 5290 | 4893 | 4505 | 4592 | 4161 | 5053 |
| 211185_s_at | 7643 | 8963 | 8849 | 8346 | 8014 | 7986 | 7333 | 8930 | 8951 | 8248 | 8412 | 8415 | 8884 |
| 211272_s_at | 1112 | 645.1 | 596.3 | 511.2 | 728.1 | 520.8 | 433.5 | 555.2 | 726.8 | 375.1 | 1563 | 760 | 608.5 |
| 211323_s_at | 178.7 | 161 | 142.3 | 181.2 | 226.7 | 128.9 | 153.8 | 139.1 | 180.8 | 91.5 | 197.2 | 188.8 | 159.1 |
| 211383_s_at | 388.7 | 513.3 | 486.5 | 504.8 | 553 | 444.6 | 541.7 | 421.8 | 429.1 | 560.2 | 535.9 | 553.1 | 632.4 |
| 211429_s_at | 14326 | 13476 | 16192 | 14011 | 16362 | 18162 | 16838 | 17597 | 15896 | 11404 | 14717 | 13679 | 17112 |
| 211506_s_at | 426.1 | 1383 | 445.2 | 907 | 254.7 | 833.4 | 210.9 | 1073 | 589.6 | 97.91 | 180.3 | 175.1 | 179.7 |
| 211546_x_at | 182.5 | 167.9 | 159.8 | 175.5 | 177 | 185.7 | 221.7 | 169.8 | 149 | 164.6 | 206.9 | 157.2 | 149.4 |
| 211684_s_at | 478.8 | 555.8 | 444.4 | 704.3 | 592.4 | 426.9 | 585.7 | 456.9 | 554.4 | 509.3 | 576.7 | 621.5 | 634.6 |
| 211729_x_at | 314.4 | 444.9 | 391.4 | 402.9 | 360.2 | 288.2 | 468.5 | 283 | 380.9 | 336.4 | 308.4 | 469.1 | 372.3 |
| 211856_x_at | 132.5 | 88.32 | 86.28 | 69.21 | 97.79 | 59.68 | 74.7 | 53.01 | 108.3 | 34.7 | 199.8 | 91.3 | 70.02 |
| 211946_s_at | 5096 | 4449 | 5239 | 4784 | 4818 | 4254 | 4496 | 5266 | 5227 | 5467 | 5466 | 5411 | 5403 |
| 211965_at | 1743 | 2922 | 2730 | 2419 | 3086 | 4933 | 2368 | 3004 | 2604 | 1964 | 1344 | 1520 | 1188 |
| 212030_at | 1150 | 1219 | 1114 | 1415 | 1241 | 1025 | 1076 | 1063 | 1484 | 882.2 | 1329 | 1167 | 1290 |
| 212042_x_at | 27713 | 21983 | 26823 | 26048 | 25809 | 19209 | 26508 | 23328 | 26971 | 24503 | 28268 | 27024 | 25743 |
| 212132_at | 2768 | 2954 | 2921 | 2946 | 2979 | 2506 | 3251 | 2730 | 3175 | 2263 | 3325 | 3065 | 2799 |
| 212213_x_at | 180.7 | 195.9 | 157 | 245.5 | 242.2 | 190.5 | 198.3 | 212.5 | 159.9 | 219.1 | 208.3 | 208.8 | 193.8 |
| 212299_at | 349.4 | 369.8 | 285.3 | 365.5 | 439.3 | 316.7 | 365.7 | 355.9 | 370.6 | 368.9 | 416.6 | 383.6 | 421.7 |
| 212331_at | 3454 | 3293 | 3170 | 4084 | 3610 | 2789 | 3052 | 3346 | 3705 | 3415 | 3447 | 3186 | 2752 |
| 212334_at | 1955 | 2227 | 1958 | 1992 | 2233 | 2438 | 2016 | 1950 | 2263 | 2059 | 1638 | 2349 | 1931 |
| 212406_s_at | 1524 | 1231 | 1412 | 1456 | 1233 | 884.9 | 1196 | 1340 | 1232 | 1059 | 1491 | 1488 | 1407 |
| 212455_at | 3809 | 3465 | 3903 | 3539 | 3275 | 2928 | 3268 | 3494 | 3559 | 2853 | 3864 | 3202 | 3295 |
| 212543_at | 1119 | 1183 | 1197 | 1288 | 1378 | 1568 | 1127 | 1393 | 1247 | 1564 | 1303 | 1089 | 1493 |
| 212658_at | 73.32 | 80.59 | 81.27 | 73.88 | 78.66 | 50.21 | 87.66 | 52.19 | 84.03 | 62.36 | 77.12 | 58.67 | 75.82 |
| 212663_at | 890.7 | 1115 | 1252 | 1080 | 1225 | 1023 | 1356 | 1086 | 954.3 | 1222 | 1010 | 1203 | 1268 |
| 212769_at | 514.8 | 377.1 | 488.9 | 326.5 | 345.1 | 565 | 473.7 | 690.5 | 392.6 | 326.2 | 246.1 | 250.3 | 261.9 |
| 212820_at | 1855 | 1943 | 1708 | 2355 | 1865 | 1473 | 2171 | 1835 | 2331 | 1988 | 1493 | 1639 | 2311 |
| 212932_at | 186.6 | 151.4 | 141.9 | 162.1 | 150 | 160 | 140.2 | 133.9 | 192.1 | 114.5 | 239.7 | 126.9 | 130 |
| 212989_at | 332.9 | 314.7 | 441.9 | 441.2 | 346.7 | 382.1 | 336.4 | 349.8 | 434.6 | 332.9 | 309.7 | 248.8 | 374.2 |
| 212997_s_at | 689.5 | 634.4 | 743.7 | 639.5 | 598.4 | 574.8 | 645.2 | 630.5 | 661.1 | 587.9 | 620.1 | 611.5 | 585.6 |
| 213021_at | 259.8 | 264.7 | 239.6 | 254.3 | 248.9 | 209 | 258.1 | 232 | 233.6 | 153.8 | 266.9 | 285.5 | 222.9 |
| 213152_s_at | 591.1 | 562.3 | 525.9 | 566.7 | 680.2 | 311.9 | 509.1 | 435.4 | 555.2 | 395 | 838.9 | 816.2 | 514.9 |
| 213205_s_at | 147.5 | 133.7 | 142.2 | 149.5 | 176.4 | 117.9 | 136.8 | 105.8 | 175.5 | 169 | 175 | 161.2 | 140.6 |
| 213218_at | 129 | 113.3 | 90.04 | 92.68 | 81.45 | 74.52 | 78.79 | 120 | 98.31 | 97.16 | 120.5 | 103.5 | 88.37 |
| 213266_at | 105.1 | 75.69 | 115.6 | 86.82 | 70.98 | 79.22 | 82.9 | 108.5 | 109.6 | 103.2 | 118.5 | 104.7 | 100.6 |
| 213302_at | 43.38 | 37.62 | 37.06 | 33.78 | 56.46 | 27.19 | 30.74 | 40.04 | 33.72 | 31.43 | 42.73 | 47.67 | 42.67 |
| 213335_s_at | 22.71 | 34.12 | 33.16 | 29.68 | 30.25 | 36.21 | 24.99 | 33.4 | 29.64 | 31.91 | 29.73 | 26.64 | 31.89 |
| 213397_x_at | 85.75 | 86.38 | 77.88 | 75.66 | 83.39 | 78.89 | 150.3 | 54.49 | 107.8 | 85.8 | 38.5 | 60.5 | 78.59 |
| 213459_at | 107.2 | 130.2 | 103.2 | 95.94 | 105.9 | 73 | 69.48 | 78.06 | 105.2 | 91.39 | 113.5 | 152.5 | 82.97 |
| 213494_s_at | 40.72 | 58.5 | 62.58 | 59.51 | 38.49 | 42.8 | 43.2 | 39.07 | 31.62 | 49.13 | 36.4 | 63.78 | 49.04 |
| 213540_at | 80.95 | 64.81 | 63.19 | 55.25 | 71.21 | 54.4 | 68.33 | 80.78 | 63.74 | 80.81 | 82.82 | 70.98 | 56.48 |
| 213693_s_at | 33.66 | 36.75 | 37.18 | 35.63 | 36.39 | 36.62 | 35.94 | 38.29 | 35.1 | 37.3 | 34.26 | 36.46 | 35.97 |
| 213827_at | 83.41 | 74.22 | 90.62 | 71.28 | 61.03 | 54.96 | 65.68 | 58.7 | 86.38 | 64.23 | 87.06 | 83.02 | 63.76 |
| 213877_x_at | 105 | 93.71 | 93.82 | 97.62 | 84.78 | 111.1 | 97.6 | 103.2 | 89.76 | 104 | 90.79 | 90.32 | 77.48 |
| 214045_at | 94.37 | 74.77 | 68.52 | 82.41 | 85.23 | 45.02 | 63.98 | 54.06 | 43.86 | 65.26 | 86.57 | 92.19 | 55.11 |
| 214057_at | 281.1 | 226.5 | 357 | 209.8 | 212.9 | 263.8 | 249.5 | 303 | 205.3 | 238.5 | 164.6 | 282.5 | 237.4 |
| 214330_at | 64.93 | 44.49 | 60.35 | 40.37 | 43.37 | 41.84 | 56.36 | 36.45 | 37.1 | 34.22 | 74.6 | 67.54 | 53.7 |
| 214364_at | 141.9 | 80.29 | 116.5 | 96.21 | 94.41 | 66.87 | 128.2 | 74.77 | 149.6 | 93.03 | 195.5 | 110.1 | 53.02 |
| 214430_at | 340.8 | 378.5 | 390.8 | 364.2 | 400.7 | 508.1 | 443.7 | 310.9 | 329.2 | 411.5 | 332.9 | 401.1 | 434.1 |
| 214511_x_at | 1572 | 573.5 | 448 | 648.5 | 777.2 | 1887 | 1126 | 888.9 | 810.5 | 579.7 | 1369 | 496 | 822.2 |
| 214629_x_at | 5104 | 5315 | 5751 | 6352 | 5680 | 6255 | 6311 | 5467 | 6443 | 5897 | 5539 | 5972 | 6834 |
| 214683_s_at | 4123 | 3433 | 3984 | 4372 | 3466 | 3632 | 3461 | 3886 | 4204 | 3602 | 4061 | 3416 | 3865 |
| 214820_at | 90.39 | 93.71 | 97.02 | 138.1 | 109.1 | 84.63 | 84.5 | 107.7 | 116 | 63.9 | 105.8 | 108.4 | 99.44 |
| 214853_s_at | 393.8 | 380.9 | 421.2 | 468.5 | 441.5 | 389.9 | 441.5 | 402.2 | 476.2 | 485.4 | 429.7 | 518.7 | 509.5 |
| 214931_s_at | 345 | 389.1 | 378.2 | 475.7 | 359.9 | 454.5 | 405.9 | 417.2 | 405.8 | 163.4 | 315.2 | 299.5 | 307.9 |
| 214953_s_at | 123.8 | 164.4 | 129.4 | 205.1 | 187.8 | 171.8 | 218.4 | 140.6 | 247.4 | 114.2 | 283.1 | 154.8 | 133.2 |
| 215009_s_at | 585.5 | 405.7 | 626.6 | 632.9 | 614.6 | 344.1 | 599.9 | 563.8 | 626.1 | 608.1 | 608.4 | 570.4 | 497.8 |
| 215049_x_at | 264.7 | 390.7 | 318.1 | 309.3 | 371 | 434.1 | 569.1 | 271.3 | 433.8 | 312.9 | 191.3 | 284.1 | 763.5 |
| 215273_s_at | 510.6 | 531.6 | 556 | 530.7 | 539.5 | 509.8 | 521 | 474.7 | 526.8 | 601.6 | 514.1 | 628.4 | 533.6 |
| 215293_s_at | 80.56 | 86.35 | 76.06 | 65 | 64.15 | 75.78 | 67.16 | 88.42 | 68.06 | 69.02 | 92.41 | 60.69 | 61.67 |
| 215567_at | 145.8 | 114.9 | 150.5 | 125.2 | 123.4 | 160 | 85.74 | 133 | 174 | 163.2 | 149 | 161.7 | 96.8 |
| 215997_s_at | 372.2 | 317.5 | 341.8 | 371.2 | 370.3 | 474.8 | 365.2 | 347.4 | 355.9 | 139.7 | 318.7 | 237.6 | 313.2 |
| 216484_x_at | 350.2 | 352.3 | 414.4 | 396.6 | 430.5 | 376.7 | 372.3 | 389 | 409.8 | 440.9 | 369.9 | 396.4 | 468.7 |
| 216950_s_at | 950.8 | 216.8 | 233.6 | 293 | 314.1 | 728.3 | 576.7 | 322.4 | 406.1 | 315.5 | 757.5 | 243.5 | 360.5 |
| 217383_at | 23.54 | 33.77 | 32.19 | 30.48 | 26.72 | 20.77 | 24.84 | 32.48 | 14.09 | 28.04 | 25.31 | 38.66 | 24.21 |
| 217403_s_at | 128.2 | 93.56 | 94.99 | 120 | 135.8 | 74.17 | 127.9 | 98.83 | 100 | 93.83 | 150.3 | 106.8 | 82.29 |
| 217466_x_at | 3676 | 2795 | 3119 | 2791 | 3346 | 2497 | 3186 | 2750 | 3216 | 2863 | 4607 | 3801 | 2943 |
| 217769_s_at | 1157 | 1136 | 1189 | 1367 | 1386 | 1314 | 1352 | 1319 | 1216 | 1203 | 1198 | 1557 | 1351 |
| 217778_at | 169.6 | 168.9 | 218.9 | 180.6 | 178.3 | 251.4 | 163 | 204.5 | 172.3 | 214.6 | 182.1 | 200.9 | 228.2 |
| 217824_at | 273.9 | 203.4 | 235.8 | 234.2 | 209.6 | 319.7 | 293 | 293.4 | 263.3 | 253 | 255.6 | 283.1 | 371.6 |
| 217987_at | 943.7 | 789.9 | 551.1 | 726 | 805.2 | 733.4 | 477 | 926.2 | 675.6 | 459.4 | 369.9 | 400.8 | 584.1 |
| 217995_at | 1415 | 1488 | 1324 | 1830 | 1395 | 1635 | 1817 | 1500 | 1279 | 1475 | 1200 | 960.7 | 1365 |
| 218012_at | 310.9 | 190.7 | 287.6 | 212.2 | 267.1 | 211.9 | 227.1 | 260.1 | 291.9 | 268.9 | 356.4 | 261.1 | 226.5 |
| 218040_at | 395.4 | 300.9 | 323.6 | 387.5 | 377.6 | 356.9 | 360.1 | 395.7 | 342.8 | 310.5 | 354.6 | 275.8 | 376.3 |
| 218065_s_at | 908 | 1130 | 941.3 | 1015 | 1138 | 825.9 | 932.1 | 911.1 | 1016 | 1086 | 1057 | 1253 | 1151 |
| 218091_at | 421.1 | 439.6 | 443.4 | 460.1 | 423.4 | 595.1 | 439.9 | 420.2 | 429.2 | 487.1 | 377.6 | 418.3 | 487.2 |
| 218125_s_at | 71.19 | 60.72 | 52.59 | 59.68 | 85.1 | 57.23 | 59.72 | 68.39 | 73.26 | 59.07 | 96.49 | 81.34 | 61.14 |
| 218127_at | 247.8 | 250.7 | 256 | 261.1 | 246.2 | 211.3 | 232.6 | 245.9 | 258.9 | 234.9 | 296.2 | 256.5 | 211.3 |
| 218143_s_at | 514.4 | 537.7 | 632.9 | 593.9 | 582 | 557.9 | 673.7 | 525.9 | 507.6 | 482.9 | 621.8 | 667.8 | 693.9 |
| 218206_x_at | 349.4 | 316.9 | 384.5 | 356 | 377.9 | 288.6 | 393.2 | 352.5 | 366.8 | 432.3 | 361.6 | 450 | 394.5 |
| 218289_s_at | 106.3 | 109.1 | 97.71 | 126.5 | 120.9 | 66.78 | 108.3 | 94.15 | 105.6 | 74.22 | 112.3 | 110 | 97.18 |
| 218325_s_at | 346 | 412 | 378.7 | 397 | 407.7 | 311.8 | 357.7 | 384.7 | 345.9 | 393.5 | 451.5 | 470.9 | 369.8 |
| 218351_at | 979.4 | 957.3 | 1081 | 1101 | 1069 | 850 | 939.4 | 945.4 | 995.5 | 996.3 | 956.2 | 1139 | 930.3 |
| 218499_at | 2144 | 2062 | 2842 | 2398 | 2448 | 2374 | 1996 | 2520 | 2433 | 1898 | 2661 | 3040 | 2767 |
| 218627_at | 293.1 | 230.1 | 266.4 | 306.4 | 261.4 | 373.6 | 331.2 | 370.3 | 334.7 | 275.3 | 234.7 | 251.7 | 346.3 |
| 218718_at | 120.9 | 94.26 | 147.7 | 128.4 | 130 | 47.97 | 57.85 | 101 | 79.24 | 56.43 | 109 | 151 | 170.8 |
| 218732_at | 171.5 | 180 | 172.3 | 205.4 | 228.7 | 162 | 240 | 187.7 | 263.6 | 234.7 | 195.4 | 271.6 | 219.9 |
| 218845_at | 972.3 | 952.3 | 975.2 | 845.5 | 789.9 | 762.9 | 1064 | 865.5 | 905.7 | 1079 | 1098 | 854.7 | 1254 |
| 218962_s_at | 538.3 | 522.2 | 572 | 508.2 | 568 | 359.5 | 461.2 | 431.7 | 479.6 | 469 | 606.8 | 570.3 | 447.7 |
| 219130_at | 386.5 | 339.6 | 316.9 | 338.3 | 371.4 | 251.1 | 276.5 | 343.7 | 333.3 | 314 | 443.4 | 393.7 | 335 |
| 219316_s_at | 65.78 | 40.34 | 64.04 | 60.73 | 85.77 | 70.32 | 135.3 | 44.63 | 75.87 | 74.42 | 59.88 | 69.92 | 59.96 |
| 219343_at | 176.8 | 152.4 | 162.5 | 218 | 220.4 | 137.9 | 169.5 | 201.7 | 196.5 | 177.3 | 214 | 197.3 | 172.6 |
| 219358_s_at | 151.5 | 143.1 | 137.2 | 152.3 | 191.4 | 135.1 | 228.4 | 109.5 | 140.3 | 180.2 | 126.9 | 215 | 171.5 |
| 219418_at | 109.6 | 99.36 | 74.1 | 95.3 | 91.59 | 89.53 | 88.29 | 101 | 89.19 | 111.6 | 105.6 | 108.5 | 89.62 |
| 219507_at | 100.8 | 84.53 | 89.69 | 181.4 | 75.9 | 61.26 | 108.7 | 60.9 | 87.84 | 131.8 | 113.5 | 162.1 | 105.9 |
| 219765_at | 98.41 | 64.58 | 76.59 | 60.99 | 74.16 | 51.02 | 42.33 | 61.51 | 121.1 | 71.93 | 84.97 | 94.72 | 61.89 |
| 219787_s_at | 50.26 | 51.95 | 43.84 | 48.66 | 47.68 | 63.64 | 71.34 | 50.6 | 56.47 | 82.38 | 46.01 | 44.11 | 77.63 |
| 219822_at | 218.4 | 184.5 | 130.2 | 159.2 | 181.5 | 140.5 | 150.3 | 166.5 | 172.9 | 177.9 | 193.7 | 217.4 | 142.5 |
| 219826_at | 61.64 | 53.08 | 53.52 | 52.75 | 47.42 | 33.66 | 33.48 | 43.35 | 44.31 | 51.75 | 70.78 | 55.86 | 46.36 |
| 219952_s_at | 173.4 | 138 | 173.3 | 136.6 | 127.6 | 226.4 | 153.6 | 120.2 | 141 | 159.3 | 102.7 | 181.3 | 244.6 |
| 220044_x_at | 5423 | 5267 | 5421 | 4788 | 5374 | 2863 | 4697 | 4589 | 5815 | 4550 | 6757 | 5698 | 5126 |
| 220146_at | 90.95 | 122.9 | 111.9 | 96.23 | 135.3 | 81.45 | 139.8 | 70.16 | 100.8 | 57.12 | 88.46 | 118.1 | 133.8 |
| 220160_s_at | 61.57 | 51.18 | 59.37 | 68.82 | 61.32 | 62.99 | 62.71 | 57.35 | 48.78 | 62.51 | 57.54 | 55.47 | 58.93 |
| 220386_s_at | 626.6 | 540 | 545.1 | 683.3 | 841.3 | 499.4 | 476 | 412 | 601.3 | 193 | 802.2 | 544.6 | 552.5 |
| 220578_at | 71.21 | 82.24 | 82.04 | 69.51 | 67.64 | 83.69 | 79.19 | 67.8 | 65.18 | 80.15 | 57.26 | 72.87 | 69.39 |
| 220605_s_at | 110.1 | 137.7 | 182.1 | 174 | 145.4 | 138.8 | 166.8 | 171.4 | 165.9 | 205.5 | 147.1 | 164.5 | 187.4 |
| 220610_s_at | 105.1 | 109 | 112.9 | 120.3 | 123.8 | 127.1 | 140.4 | 129.5 | 123.9 | 157 | 87.39 | 79.64 | 123.8 |
| 220690_s_at | 92.52 | 87.4 | 120.1 | 111.5 | 103.5 | 127.9 | 126.9 | 120.1 | 116.5 | 113.2 | 84.88 | 100.6 | 103.3 |
| 220750_s_at | 81.85 | 83.9 | 87.75 | 84.78 | 96.99 | 73.19 | 87.59 | 74.23 | 75.54 | 107.7 | 96.36 | 114 | 119.2 |
| 220865_s_at | 74.93 | 67.96 | 53.1 | 86.31 | 61.66 | 78.12 | 80.73 | 75.36 | 65.03 | 74.71 | 95.74 | 105.9 | 70.23 |
| 220974_x_at | 148.9 | 165 | 227.3 | 206.4 | 184.2 | 111.5 | 219.8 | 180.2 | 245.2 | 303.7 | 219.2 | 212.8 | 205 |
| 221011_s_at | 953 | 892.3 | 860.9 | 1185 | 1051 | 483.8 | 683.9 | 960.9 | 987.2 | 976.2 | 1988 | 1728 | 886 |
| 221206_at | 185.5 | 191.5 | 201.5 | 206.4 | 225.8 | 129.5 | 186 | 146.8 | 188.7 | 237.9 | 204.6 | 188.1 | 192.7 |
| 221264_s_at | 579.1 | 621.8 | 560.6 | 631.6 | 523.8 | 285.4 | 422.1 | 469.8 | 614.1 | 494.1 | 626.2 | 602.9 | 575.9 |
| 221428_s_at | 961.7 | 907 | 832.9 | 956.2 | 987.7 | 814.6 | 826.9 | 989.5 | 956.8 | 563.8 | 1043 | 956.2 | 978.3 |
| 221449_s_at | 314.7 | 323 | 282.3 | 381.5 | 316 | 348.3 | 355.7 | 292.8 | 275.3 | 250.4 | 297.8 | 347.3 | 336.6 |
| 221580_s_at | 1276 | 1212 | 1137 | 1251 | 1348 | 948.3 | 927.5 | 1179 | 1289 | 964.1 | 1360 | 1184 | 1151 |
| 221601_s_at | 2501 | 2556 | 2476 | 2477 | 3038 | 1202 | 1753 | 2829 | 2487 | 1954 | 4213 | 3203 | 2518 |
| 221647_s_at | 396.1 | 424 | 430.7 | 417.2 | 477 | 401.6 | 506.3 | 451.4 | 434.5 | 489.5 | 474.8 | 505.8 | 595 |
| 221731_x_at | 6857 | 6840 | 5857 | 6230 | 5647 | 7306 | 9812 | 3844 | 5584 | 7900 | 5389 | 5070 | 6264 |
| 221757_at | 840.7 | 508 | 520 | 472.7 | 573.5 | 299 | 468.6 | 476.8 | 629.2 | 420.6 | 737.2 | 723.8 | 459.2 |
| 221841_s_at | 736.6 | 1276 | 558.7 | 728.7 | 1074 | 727.4 | 979.2 | 637.9 | 1189 | 867.7 | 973.1 | 1776 | 1286 |
| 221868_at | 54.83 | 38.78 | 46.85 | 39.68 | 34.7 | 31.62 | 32.01 | 44.2 | 43.75 | 39.5 | 83.39 | 56.67 | 31.17 |
| 221960_s_at | 36.85 | 62.73 | 46.72 | 59.03 | 37.76 | 67.29 | 69.72 | 61.02 | 29.4 | 48.59 | 36.54 | 86.79 | 52.59 |
| 222217_s_at | 230.6 | 244.3 | 348.5 | 231.7 | 290.9 | 191.8 | 316.9 | 155 | 333.4 | 311.5 | 195.4 | 412.3 | 377.9 |
| 222231_s_at | 230.9 | 250.3 | 267.5 | 296.2 | 289.7 | 251.7 | 337.8 | 234.1 | 276 | 240.3 | 212.5 | 305.8 | 297.5 |
| 222574_s_at | 500.6 | 499.5 | 467.4 | 619.6 | 545.8 | 563.7 | 519.9 | 565.1 | 567.6 | 374.1 | 460.2 | 431.5 | 445.7 |
| 222605_at | 765.6 | 678.1 | 784.8 | 738.2 | 734.2 | 647.5 | 728.1 | 871.6 | 777.1 | 804.8 | 715.4 | 728 | 828 |
| 222651_s_at | 290.8 | 195.2 | 254.5 | 285.7 | 242.9 | 219.4 | 269.1 | 236.1 | 299.6 | 408.2 | 213.2 | 259.8 | 305.3 |
| 222670_s_at | 383.2 | 726.4 | 395.9 | 451.6 | 438 | 380 | 648 | 225.1 | 615.8 | 421 | 375.1 | 809.8 | 762.3 |
| 222688_at | 320.7 | 233 | 271.5 | 200.7 | 253.5 | 262.2 | 268.2 | 150.7 | 295.5 | 307.8 | 183 | 234.8 | 229.2 |
| 222700_at | 601.5 | 596.6 | 621.8 | 716.9 | 560.5 | 466 | 551.5 | 550.3 | 684.3 | 529.1 | 635.7 | 561.7 | 603.5 |
| 222753_s_at | 161.9 | 179.8 | 159.6 | 211.9 | 160.6 | 240.9 | 222 | 139.2 | 162 | 152.2 | 145.5 | 191.7 | 199.9 |
| 222757_s_at | 101.1 | 119.5 | 76.96 | 83.28 | 50.75 | 154.8 | 135.3 | 99.75 | 80.7 | 116.1 | 58.49 | 84.48 | 76.86 |
| 222774_s_at | 27.99 | 38.13 | 45.65 | 40.7 | 39.46 | 36.3 | 65.84 | 26.96 | 54.58 | 34.32 | 27.68 | 34.33 | 28.42 |
| 222884_at | 98.5 | 118.1 | 90.25 | 105.3 | 101.8 | 111.8 | 91.75 | 136.2 | 98.76 | 116.1 | 131.4 | 122.7 | 127.9 |
| 222980_at | 2092 | 2211 | 2070 | 2403 | 2300 | 2575 | 2092 | 2355 | 2267 | 2275 | 2130 | 2294 | 2603 |
| 222982_x_at | 4289 | 4015 | 4214 | 3717 | 3431 | 4116 | 3995 | 3506 | 4261 | 3325 | 4383 | 4529 | 4521 |
| 223023_at | 285.4 | 273 | 346.8 | 229 | 305.6 | 221.3 | 330.1 | 340.9 | 268.6 | 311.7 | 319.8 | 307.3 | 289.4 |
| 223064_at | 1143 | 1131 | 1283 | 1406 | 1258 | 1233 | 1548 | 1145 | 1185 | 1232 | 1185 | 1437 | 1214 |
| 223158_s_at | 91.3 | 86.96 | 96.7 | 121.4 | 106.3 | 111.1 | 146 | 129 | 96.74 | 97.25 | 97.12 | 81.32 | 171.3 |
| 223380_s_at | 220.7 | 284.4 | 351.1 | 446.6 | 207.9 | 295.7 | 356.2 | 201 | 356.6 | 319.5 | 136.8 | 263 | 307.7 |
| 223444_at | 857.9 | 810.6 | 788.2 | 1056 | 825.8 | 788.8 | 736.8 | 959 | 929.9 | 814.3 | 796.6 | 700.9 | 831.6 |
| 223465_at | 283.9 | 411.9 | 320.5 | 519.3 | 347.9 | 513.6 | 453.4 | 468.8 | 441.5 | 312.8 | 308.7 | 389.6 | 391.9 |
| 223590_at | 463.7 | 317 | 582 | 486.2 | 450.9 | 371.4 | 400.8 | 464.3 | 435.9 | 569.7 | 472.9 | 503.1 | 503.9 |
| 223686_at | 240.6 | 268 | 178.5 | 222.1 | 244.1 | 213.3 | 300.4 | 260.2 | 242.2 | 187 | 189.6 | 188 | 194.3 |
| 223801_s_at | 29.83 | 32.26 | 31.32 | 27.59 | 32.3 | 31.28 | 30.17 | 32.13 | 20.26 | 30.73 | 20.84 | 30.96 | 35.55 |
| 223922_x_at | 1897 | 2384 | 1725 | 1843 | 2529 | 2007 | 3603 | 1248 | 1640 | 1689 | 1295 | 1492 | 1574 |
| 223982_s_at | 1153 | 1042 | 1163 | 1214 | 1089 | 1168 | 1119 | 1063 | 1111 | 802.9 | 1036 | 1143 | 988.3 |
| 224046_s_at | 542.3 | 363.9 | 356.9 | 480.2 | 469.7 | 515.2 | 363.1 | 449.8 | 399.9 | 256.2 | 715.9 | 444.3 | 401.5 |
| 224374_s_at | 516.7 | 349.8 | 418.9 | 345.3 | 442.1 | 413.1 | 827.7 | 324.1 | 329.5 | 511.6 | 296.3 | 371.5 | 379.7 |
| 224387_at | 60.72 | 75.73 | 63.99 | 82.14 | 63.9 | 73.6 | 88.83 | 61.95 | 68.21 | 88.01 | 68.9 | 99.44 | 83.07 |
| 224439_x_at | 370.7 | 376.7 | 307.8 | 500.7 | 456 | 413.6 | 501.4 | 351 | 391.1 | 461.3 | 451.6 | 597.5 | 488.9 |
| 224518_s_at | 401.3 | 320.5 | 320.3 | 275.9 | 363.7 | 222.8 | 273.8 | 309.7 | 312.3 | 300.7 | 452.4 | 393.8 | 295.6 |
| 224582_s_at | 331.5 | 308.5 | 302.8 | 405.3 | 473.3 | 201.5 | 366 | 290 | 402.8 | 230.5 | 537.6 | 401 | 383.6 |
| 224591_at | 3005 | 2326 | 3052 | 3289 | 2718 | 2427 | 3079 | 2689 | 3319 | 3428 | 3946 | 4036 | 3222 |
| 224726_at | 183.8 | 197.5 | 114.2 | 233.2 | 141.3 | 174.5 | 214.2 | 145.2 | 243.3 | 215.7 | 175.6 | 297.5 | 249.8 |
| 224818_at | 546.2 | 612.2 | 557.2 | 598.4 | 596.2 | 613.3 | 711.8 | 648 | 454.5 | 487 | 402.4 | 429 | 593.5 |
| 224917_at | 2022 | 2663 | 2365 | 2325 | 1987 | 1715 | 2599 | 1719 | 2148 | 1698 | 1848 | 1699 | 2216 |
| 224918_x_at | 338.9 | 364.8 | 356.8 | 355 | 228.3 | 416.5 | 708.1 | 275.6 | 333 | 343.7 | 265.6 | 170.3 | 415.4 |
| 224928_at | 191.9 | 260.5 | 245.9 | 253.8 | 242.5 | 165.3 | 277.8 | 210.2 | 255.3 | 263.7 | 187.5 | 270 | 289.2 |
| 225059_at | 1189 | 1173 | 1393 | 1278 | 1227 | 1528 | 1651 | 1473 | 1452 | 1286 | 1054 | 1128 | 1065 |
| 225064_at | 462 | 357.3 | 456.7 | 428.7 | 454 | 344.7 | 550.1 | 426 | 498.6 | 280.3 | 516 | 535.7 | 468.6 |
| 225107_at | 3134 | 2898 | 2993 | 2706 | 2934 | 1991 | 3150 | 2823 | 3087 | 2632 | 3489 | 3147 | 3542 |
| 225188_at | 18.31 | 33.82 | 34.53 | 38.34 | 39.12 | 17.09 | 53.82 | 22.06 | 53.42 | 46.43 | 65.29 | 91 | 150.6 |
| 225341_at | 51.48 | 49.32 | 118 | 133.9 | 53.77 | 37.34 | 74.49 | 82.92 | 59.95 | 52.28 | 63.85 | 63.14 | 54.33 |
| 225358_at | 102.7 | 112.4 | 102.5 | 104.4 | 111.3 | 86.13 | 94.32 | 100.6 | 109.4 | 89.33 | 119.3 | 126.6 | 95.42 |
| 225365_at | 2444 | 2084 | 2396 | 2405 | 2189 | 1921 | 2505 | 1993 | 2592 | 2266 | 2692 | 2677 | 2286 |
| 225388_at | 40.66 | 43.66 | 51.07 | 74.11 | 40.1 | 36.98 | 50.72 | 48.82 | 59.98 | 56.35 | 54.61 | 56.47 | 41.84 |
| 225456_at | 345.3 | 309.3 | 401.5 | 375.6 | 401.5 | 336.8 | 329.5 | 381.5 | 350.7 | 382 | 434.4 | 350.2 | 344.3 |
| 225763_at | 2556 | 2949 | 3106 | 2804 | 3195 | 2875 | 3185 | 2860 | 3084 | 2293 | 2411 | 2788 | 3832 |
| 225844_at | 211.2 | 164.8 | 184.8 | 190.9 | 193.6 | 159.1 | 249.3 | 156.9 | 214.5 | 226 | 200.3 | 262 | 198.7 |
| 225866_at | 110.9 | 146.5 | 98.08 | 118.3 | 117.6 | 97.5 | 117.2 | 120.3 | 111.9 | 98.83 | 151 | 147.1 | 120.8 |
| 225870_s_at | 596 | 574.1 | 850.6 | 641.8 | 676.9 | 562.5 | 813.5 | 595.8 | 605.9 | 930.6 | 643.7 | 475.2 | 1020 |
| 226000_at | 26.03 | 27.57 | 24.82 | 26.73 | 26.22 | 27.4 | 27.51 | 25.08 | 23.08 | 22.13 | 22.73 | 25.79 | 25.21 |
| 226030_at | 141.1 | 128.6 | 121.3 | 145.6 | 111.1 | 102 | 103.8 | 133.9 | 147.7 | 157.4 | 161.7 | 146.3 | 117.8 |
| 226042_at | 98.39 | 93.08 | 100.2 | 100.5 | 92.01 | 92.9 | 104.7 | 92.39 | 100.1 | 90.11 | 103.7 | 103.9 | 100.7 |
| 226059_at | 38.82 | 32.5 | 42.83 | 41.66 | 59.91 | 48.95 | 40.56 | 31.22 | 38.56 | 51.22 | 47.87 | 60.62 | 40.48 |
| 226115_at | 312.4 | 229.6 | 394.9 | 279.2 | 219.1 | 296.2 | 289.8 | 482.2 | 313.1 | 294.3 | 229.1 | 224.5 | 279.6 |
| 226127_at | 84.22 | 88.22 | 86.33 | 92.35 | 101.7 | 73.69 | 86.21 | 81.5 | 85.82 | 105.1 | 86.6 | 114.9 | 85.43 |
| 226218_at | 6820 | 4905 | 6362 | 7213 | 6897 | 2921 | 4674 | 7557 | 6918 | 6683 | 9983 | 7461 | 6288 |
| 226220_at | 82.3 | 91.04 | 113.7 | 99.85 | 76.02 | 98.1 | 92.37 | 102.8 | 53.78 | 75.85 | 53.07 | 119.2 | 87.44 |
| 226323_at | 621.4 | 520.1 | 649.6 | 588.9 | 556.6 | 460.2 | 572.6 | 615.5 | 608.5 | 438.4 | 676.5 | 665 | 574.6 |
| 226353_at | 909.6 | 954.3 | 1017 | 1260 | 963.2 | 1200 | 1254 | 960.7 | 988.3 | 963.6 | 848.3 | 1133 | 1112 |
| 226428_at | 217.7 | 221.7 | 241.4 | 208.1 | 237.7 | 182 | 232.1 | 211.4 | 209.2 | 182.4 | 150.8 | 222.2 | 157.9 |
| 226459_at | 2035 | 2088 | 1575 | 2050 | 2197 | 2461 | 1918 | 2118 | 1803 | 1535 | 1813 | 2375 | 2242 |
| 226503_at | 284.6 | 191.4 | 218.3 | 263 | 309.1 | 280.5 | 199 | 271.5 | 238.8 | 220.8 | 253.8 | 248 | 277.6 |
| 226683_at | 2955 | 2377 | 3078 | 2897 | 2310 | 6724 | 2183 | 3621 | 2372 | 1781 | 1465 | 2766 | 2446 |
| 226718_at | 109.5 | 93.72 | 87.1 | 110.6 | 127.3 | 88.81 | 59.16 | 92.48 | 102.4 | 115.4 | 130.4 | 93.59 | 88.18 |
| 226763_at | 132.2 | 196.3 | 157.1 | 177.8 | 121.6 | 104.4 | 181.3 | 114.8 | 185.6 | 156.4 | 130.9 | 223.8 | 190.4 |
| 226836_at | 29.29 | 37.28 | 37.05 | 30.95 | 33.29 | 35.33 | 34.7 | 36.43 | 32.37 | 33.58 | 27.02 | 35.32 | 31.42 |
| 227020_at | 706.4 | 625.6 | 726.3 | 767.1 | 739.7 | 564 | 697.3 | 711.6 | 650.9 | 870.4 | 729.1 | 820.9 | 900.7 |
| 227114_at | 103.1 | 124.7 | 94.11 | 125.4 | 115.8 | 82.41 | 100.4 | 111.9 | 144 | 99.16 | 154.9 | 119.8 | 108.5 |
| 227149_at | 99.36 | 76.51 | 78.2 | 87.22 | 108.9 | 74.17 | 79.66 | 72.03 | 107.6 | 58.91 | 119.4 | 81.21 | 72.93 |
| 227173_s_at | 200.4 | 138 | 139.2 | 146.2 | 144.6 | 80.52 | 78.11 | 253.9 | 124.6 | 126.4 | 227.5 | 221.4 | 132.3 |
| 227213_at | 91.25 | 59.02 | 65.75 | 89.6 | 111.4 | 59.24 | 63.36 | 74.57 | 76.89 | 102.2 | 154.8 | 91.11 | 82.54 |
| 227374_at | 48.19 | 69.73 | 59.21 | 57.83 | 53.55 | 38.45 | 61.86 | 43.97 | 59.98 | 61.35 | 69.77 | 84.81 | 50.35 |
| 227517_s_at | 637.8 | 445.2 | 490.9 | 529.7 | 734.3 | 397 | 499.6 | 566.1 | 542.7 | 556.2 | 846.8 | 773.9 | 644.4 |
| 227558_at | 1304 | 1045 | 1533 | 1227 | 1338 | 1253 | 1084 | 1335 | 1432 | 1172 | 1235 | 1340 | 1314 |
| 227560_at | 133.5 | 99.79 | 113.3 | 110.2 | 102.6 | 103.1 | 106.6 | 126.1 | 99.28 | 96.36 | 132.8 | 92.59 | 100.6 |
| 227722_at | 365.2 | 155.6 | 253.3 | 369.8 | 210 | 120.2 | 242.1 | 154.6 | 196.8 | 172.8 | 429.5 | 211.2 | 182.7 |
| 227990_at | 969.1 | 910.3 | 1001 | 1023 | 1016 | 1215 | 1029 | 1221 | 1066 | 836.1 | 844.6 | 1030 | 930.8 |
| 228012_at | 34.98 | 24.18 | 30.33 | 36.38 | 30.59 | 23.05 | 26.78 | 34.3 | 29.06 | 45.13 | 34.32 | 36.01 | 24.46 |
| 228170_at | 475.4 | 600.3 | 397.2 | 337.7 | 525.6 | 196.4 | 254 | 348.9 | 600.3 | 145.8 | 290.7 | 333.5 | 556.2 |
| 228176_at | 108.5 | 206.8 | 110.9 | 141.3 | 94.63 | 156.5 | 232.3 | 69.38 | 167.6 | 179.8 | 72.68 | 117.6 | 163.8 |
| 228234_at | 296.4 | 325.6 | 284.9 | 322.1 | 347.1 | 347.2 | 364.5 | 240.6 | 318.3 | 244.3 | 191.1 | 282.3 | 288 |
| 228370_at | 235.7 | 209.3 | 208.3 | 246.3 | 208.8 | 146.4 | 108.3 | 234.7 | 241 | 242.3 | 340.8 | 228.6 | 205.1 |
| 228549_at | 754.7 | 566.9 | 583.4 | 527.7 | 671.3 | 400.9 | 421.8 | 564.5 | 648.8 | 574.1 | 926.6 | 706.1 | 613.5 |
| 228630_at | 134.8 | 107.4 | 81.19 | 117.8 | 103.4 | 68.24 | 84.98 | 117.7 | 99.42 | 116.6 | 147.7 | 94.33 | 119.3 |
| 228831_s_at | 231.1 | 212.3 | 267.4 | 157 | 213.6 | 179.9 | 139.3 | 263.6 | 122 | 195.4 | 194.3 | 235 | 227 |
| 229307_at | 32.28 | 44.56 | 35.83 | 47.25 | 39.3 | 22.62 | 19.44 | 24.75 | 44.14 | 31.9 | 36.24 | 30.63 | 102.5 |
| 229421_s_at | 23.24 | 36.52 | 35.54 | 23.49 | 31.68 | 41.41 | 34.11 | 22.85 | 24.95 | 24.03 | 26.47 | 18.33 | 38.41 |
| 229509_at | 269.8 | 222.5 | 228.9 | 284.1 | 291.4 | 201.9 | 275.1 | 205.3 | 219.6 | 235.1 | 292.4 | 247.2 | 282.5 |
| 229854_at | 32.03 | 40.92 | 36.27 | 24.49 | 25.16 | 25.45 | 28.44 | 25.59 | 25.21 | 26.2 | 34.72 | 25.24 | 24.15 |
| 229982_at | 62.42 | 103 | 69.25 | 116.7 | 66.96 | 59.36 | 84.76 | 71.92 | 77.25 | 81.38 | 73.91 | 125.5 | 105.1 |
| 230265_at | 141.8 | 175.6 | 158.8 | 251.9 | 121.5 | 173.8 | 219.4 | 171.5 | 137.7 | 88.53 | 141.4 | 186.8 | 206.5 |
| 230320_at | 163.3 | 140.3 | 178 | 172.9 | 161.9 | 100.9 | 145.9 | 152.7 | 118.2 | 152 | 167 | 155.7 | 132.5 |
| 230408_at | 104.1 | 110.6 | 113.8 | 97.96 | 112.2 | 81.75 | 85.89 | 147.1 | 98.68 | 108.3 | 122.4 | 118.5 | 97.1 |
| 230480_at | 56.19 | 40.59 | 65.89 | 56.52 | 48.46 | 46.61 | 58.25 | 52 | 35.69 | 40.54 | 48.12 | 59.55 | 50.6 |
| 230837_at | 80.46 | 78.32 | 94.24 | 77.86 | 82.66 | 74.48 | 92.32 | 79.88 | 83.82 | 70.21 | 104 | 69.39 | 64.23 |
| 230852_at | 45.82 | 49.8 | 45.17 | 37.8 | 33.31 | 36.33 | 54.86 | 32.63 | 36.27 | 45.66 | 40.86 | 41.9 | 41.78 |
| 230922_x_at | 46.9 | 40.68 | 50.87 | 60.32 | 43.47 | 48.02 | 43.68 | 47.11 | 44.6 | 37.17 | 48.3 | 52.08 | 43.06 |
| 231283_at | 285 | 197.9 | 245.3 | 325.7 | 257.8 | 197.3 | 229.6 | 241.6 | 251 | 156.8 | 380.9 | 239.4 | 202.4 |
| 231697_s_at | 37.18 | 124.7 | 83 | 66.03 | 54.76 | 56.98 | 51.83 | 54.31 | 50.12 | 43.8 | 46.77 | 67.62 | 57.13 |
| 231836_at | 84.68 | 77.43 | 61.81 | 77.59 | 74.39 | 52.43 | 63.46 | 66.6 | 68.29 | 78.86 | 106.6 | 85.62 | 73.79 |
| 231843_at | 194.3 | 206.4 | 242 | 222.3 | 205.5 | 169 | 206 | 190.3 | 219.6 | 210.9 | 214 | 170.6 | 190.1 |
| 231845_at | 152 | 112.3 | 173.2 | 123.6 | 104.6 | 79.08 | 132 | 91.68 | 156.3 | 128.3 | 158.4 | 151.9 | 133.4 |
| 231904_at | 514.1 | 416.4 | 545.1 | 407.9 | 370.7 | 534.1 | 550.1 | 423.9 | 393.3 | 379.1 | 485.6 | 431.8 | 342.4 |
| 231914_at | 45.95 | 48.66 | 43.5 | 41.73 | 48.03 | 48.73 | 48.24 | 44.03 | 36.91 | 85.15 | 46.12 | 48.69 | 48.47 |
| 232636_at | 35.14 | 53.64 | 48.53 | 49.56 | 36.51 | 46.89 | 76.33 | 29.23 | 51.73 | 34.87 | 42.09 | 50.99 | 64 |
| 232851_at | 45.04 | 38.71 | 90 | 43.18 | 39.57 | 55.62 | 51.98 | 48.29 | 65.14 | 55.13 | 72.41 | 42.29 | 43.34 |
| 233019_at | 393.9 | 309.1 | 349.1 | 274.7 | 308.6 | 268.8 | 291.4 | 327.2 | 387 | 356.6 | 434.1 | 441 | 355.3 |
| 233169_at | 157.3 | 99.22 | 155.4 | 103.5 | 99.83 | 118.2 | 128.5 | 100.4 | 112.4 | 115 | 146.1 | 95.79 | 90.07 |
| 234013_at | 95.85 | 79.42 | 89.18 | 123.9 | 191 | 85.2 | 141.6 | 81.11 | 186 | 81.9 | 392.7 | 138.7 | 124.4 |
| 234311_s_at | 157.5 | 133 | 138.7 | 131.9 | 211.5 | 128.7 | 188 | 119.5 | 135.3 | 105.5 | 182 | 207.8 | 167.2 |
| 234339_s_at | 2525 | 2125 | 2332 | 2012 | 2077 | 990.1 | 2081 | 2091 | 2126 | 2357 | 3474 | 2508 | 1910 |
| 234464_s_at | 18.22 | 37.57 | 33.24 | 31.87 | 30.11 | 21.93 | 25.7 | 33.31 | 32.47 | 36.81 | 23.57 | 40.13 | 32.28 |
| 234733_s_at | 32.15 | 29.6 | 42.75 | 39.84 | 48.9 | 27.35 | 28.11 | 29.37 | 38.2 | 27.5 | 33.29 | 39.93 | 26.35 |
| 235024_at | 120.6 | 110.5 | 95.36 | 111.6 | 118.7 | 78.86 | 94.43 | 123.8 | 98.72 | 105.5 | 103.4 | 110.4 | 104.3 |
| 235067_at | 1013 | 919.7 | 1095 | 809.4 | 1138 | 1181 | 913.6 | 962.1 | 1005 | 996.9 | 1002 | 443.5 | 978.3 |
| 235200_at | 111.9 | 149.5 | 116.1 | 144 | 137.6 | 127.5 | 140 | 140 | 132.8 | 143.1 | 117.8 | 142.5 | 127.2 |
| 235359_at | 232.6 | 252.1 | 296.9 | 331 | 308.3 | 244.7 | 257.8 | 196.5 | 281.2 | 259.1 | 278.4 | 312.3 | 290.2 |
| 235593_at | 408.5 | 509.6 | 503.6 | 774.3 | 418.2 | 409.6 | 666.7 | 424.3 | 616.5 | 534.8 | 473.3 | 655.8 | 803.7 |
| 235610_at | 61.43 | 52.38 | 48.03 | 61.93 | 64.1 | 49.08 | 55.21 | 74.16 | 80 | 71.47 | 72 | 93.43 | 64.3 |
| 235623_at | 32.87 | 28.7 | 28.18 | 29.55 | 27 | 25.76 | 28.79 | 29.01 | 29.79 | 27.01 | 37.41 | 33.23 | 27.25 |
| 235690_at | 22.7 | 26.04 | 25.25 | 32.16 | 28.63 | 23.74 | 25.31 | 36.62 | 34.95 | 24.39 | 32.37 | 29.6 | 21.66 |
| 237504_at | 108 | 77.68 | 105.1 | 80.24 | 100.1 | 95.58 | 75.45 | 88.55 | 79.67 | 88.03 | 104.6 | 92.37 | 101 |
| 238429_at | 4552 | 4148 | 4403 | 5057 | 3248 | 5150 | 4406 | 5615 | 3807 | 4038 | 3909 | 2757 | 3988 |
| 238513_at | 521.3 | 940 | 451.5 | 933.5 | 662.5 | 908.7 | 776.8 | 837.2 | 904.6 | 897.4 | 356.4 | 637 | 705 |
| 238736_at | 251.3 | 219.4 | 305.3 | 282.7 | 300.8 | 262.2 | 217.8 | 301 | 319 | 407.8 | 242.3 | 262.3 | 294.6 |
| 238823_at | 69.54 | 50.42 | 50.53 | 83.77 | 67.69 | 36.17 | 50.64 | 69.5 | 58.35 | 42 | 69.23 | 75.27 | 54.34 |
| 238909_at | 136.1 | 125.7 | 121.4 | 182.1 | 170 | 98.87 | 205 | 112.7 | 181.2 | 239.3 | 167.2 | 207.4 | 207.1 |
| 239108_at | 225.2 | 160.4 | 246.1 | 289.7 | 176.9 | 115.9 | 273.8 | 298.7 | 304.1 | 275.3 | 127.3 | 131 | 462.5 |
| 239897_at | 266.8 | 222 | 243.4 | 228.1 | 236.6 | 219.2 | 214 | 282.6 | 258.7 | 192.4 | 235 | 184.2 | 280.3 |
| 241368_at | 416.2 | 275 | 326.2 | 279.9 | 287.1 | 615.2 | 313.7 | 522.5 | 303.7 | 418.3 | 256.5 | 221 | 423.7 |
| 241704_x_at | 59.05 | 53.74 | 59.58 | 53.25 | 64.08 | 40.21 | 45.22 | 59.82 | 64.76 | 71.86 | 79.72 | 69.03 | 62.09 |
| 241706_at | 89.21 | 120.9 | 95.34 | 114.5 | 94.04 | 88.77 | 128.7 | 71.58 | 108.2 | 116.5 | 81.06 | 131.8 | 125.3 |
| 241731_x_at | 64.71 | 71.89 | 55.27 | 67.4 | 62.45 | 57.68 | 54.33 | 52.24 | 75.05 | 45.35 | 65.06 | 53.97 | 50.53 |
| 242197_x_at | 21.36 | 51.57 | 13.98 | 20.29 | 19.48 | 41.23 | 33.7 | 12.44 | 63.79 | 66.6 | 19.45 | 36.3 | 45.78 |
| 242561_at | 37.87 | 26.55 | 25.48 | 22.45 | 31.55 | 22.7 | 24.61 | 24.85 | 33.63 | 21.26 | 28.48 | 24.59 | 20.23 |
| 242569_at | 266.8 | 224.5 | 273.6 | 297.2 | 274.2 | 243.6 | 244.1 | 306.2 | 284.1 | 153.7 | 198.7 | 206.2 | 261.8 |
| 242669_at | 230.9 | 278.9 | 293.6 | 249.4 | 257.7 | 166.9 | 269.1 | 265.6 | 273.1 | 356.6 | 255.7 | 313.7 | 259.4 |
| 243982_at | 132 | 108 | 141.9 | 119.8 | 128.9 | 93.41 | 112.3 | 147.5 | 116.3 | 139.6 | 128.5 | 130.2 | 116 |
| 244038_at | 82.46 | 56.84 | 59.55 | 54.05 | 71.21 | 39.33 | 47.52 | 56.62 | 49.67 | 46.14 | 67.5 | 55.26 | 54.69 |
| 244654_at | 1491 | 2272 | 1874 | 1922 | 2074 | 1409 | 2223 | 1204 | 1701 | 2822 | 1851 | 2910 | 2671 |
| 244698_at | 38.42 | 39.76 | 35.51 | 32.75 | 33.35 | 33.77 | 33.68 | 33.95 | 39.89 | 33.55 | 33.08 | 35.25 | 32.96 |
| 36566_at | 106.4 | 87.19 | 111.8 | 136.8 | 112.1 | 94.56 | 120.5 | 114.6 | 129.3 | 165.1 | 108.6 | 113.9 | 155.1 |
| 37549_g_at | 36.55 | 44.57 | 42.99 | 39.24 | 44.91 | 37.3 | 43.85 | 45.66 | 45 | 41.98 | 40.86 | 50.64 | 49 |
| 48659_at | 200.2 | 161.1 | 188.7 | 191.3 | 180.7 | 203.6 | 212.1 | 209.5 | 191.9 | 207.2 | 190.7 | 185.4 | 232 |
| 56829_at | 141.8 | 154.3 | 134.9 | 131.8 | 144.5 | 139.8 | 174.2 | 141.3 | 138.1 | 189.4 | 144.7 | 143.3 | 162.7 |
| 64486_at | 189.7 | 182.1 | 178.3 | 184.6 | 200.8 | 199.8 | 234.2 | 179.4 | 218.1 | 212.9 | 232.6 | 213.5 | 261.6 |
| 65493_at | 32.34 | 33.16 | 40.71 | 37.42 | 48.96 | 33.51 | 45.32 | 29.69 | 41.47 | 51.37 | 55.68 | 97.23 | 53.92 |
| AFFX- | 8098 | 8664 | 8857 | 9299 | 8899 | 9928 | 9905 | 7691 | 7972 | 10269 | 7603 | 7829 | 8659 |
| HUMGAPDH/M33197_3_at | | | | | | | | | | | | | |
| | NYHA | NYHA | NYHA | NYHA | NYHA | NYHA | NYHA | NYHA | NYHA | NYHA | NYHA | NYHA | NYHA |
| | I-II | I-II | I-II | I-II | I-II | I-II | I-II | I-II | I-II | I-II | I-II | I-II | I-II |
| Affymetrix Probe | Sample | Sample | Sample | Sample | Sample | Sample | Sample | Sample | Sample | Sample | Sample | Sample | Sample |
| set ID | no. 40 | no. 41 | no. 44 | no. 49 | no. 51 | no. 52 | no. 54 | no. 56 | no. 58 | no. 65 | no. 68 | no. 79 | no. 92 |
| 1552318_at | 2127 | 1579 | 1485 | 1642 | 1178 | 1428 | 1700 | 1257 | 2137 | 1993 | 1945 | 1447 | 1660 |
| 1552630_a_at | 73.26 | 113 | 68.66 | 97.25 | 96.13 | 93.96 | 64.57 | 66.62 | 64.39 | 95.3 | 109.7 | 83.26 | 80.81 |
| 1554149_at | 944.1 | 698.1 | 501.2 | 562.5 | 485.9 | 701.7 | 545.5 | 616.1 | 643.3 | 629.2 | 775.1 | 726.3 | 771.3 |
| 1554539_a_at | 67.02 | 88.6 | 58.62 | 66.77 | 67.78 | 82.19 | 102.1 | 67.41 | 90.2 | 88.91 | 125.8 | 67.81 | 60.48 |
| 1554606_at | 122 | 140.8 | 129.9 | 140.9 | 113.9 | 153.6 | 126.8 | 126.4 | 151.5 | 144.2 | 138.9 | 144.5 | 182.9 |
| 1555630_a_at | 182.2 | 135.7 | 150 | 99.91 | 189.8 | 111.7 | 151.6 | 135.5 | 111.8 | 174.6 | 147.9 | 168.3 | 146.3 |
| 1555963_x_at | 44.56 | 39.47 | 46.19 | 45.03 | 46.67 | 58.95 | 53.69 | 48.6 | 56.52 | 37.98 | 42.73 | 30.41 | 47.28 |
| 1555996_s_at | 762.3 | 750.8 | 830.5 | 781.4 | 847.8 | 1174 | 879.6 | 871.5 | 1323 | 1169 | 1204 | 1028 | 1207 |
| 1556113_at | 36.34 | 38.49 | 45.56 | 39.6 | 56.22 | 30.76 | 34.73 | 35.08 | 52.2 | 43.9 | 47.92 | 49.48 | 41.24 |
| 1556283_s_at | 85.3 | 122 | 129.2 | 88.42 | 168.2 | 100.8 | 128.6 | 172.7 | 113.5 | 126.1 | 131.9 | 128.6 | 139.4 |
| 1556864_at | 46.65 | 38.09 | 49.48 | 46.87 | 50.97 | 46.57 | 47.15 | 51.73 | 36.96 | 54.1 | 46.94 | 47.96 | 48.17 |
| 1557066_at | 166.8 | 165.7 | 127.4 | 184.3 | 119.6 | 267 | 180.6 | 152.4 | 192.9 | 204 | 156.3 | 188.5 | 164 |
| 1558277_at | 31.63 | 37.57 | 32.29 | 32.77 | 47.59 | 53.77 | 46.34 | 31.93 | 27.48 | 65.17 | 43.42 | 38.52 | 35.84 |
| 1558755_x_at | 151.2 | 219.7 | 118.1 | 200.1 | 155.3 | 111.6 | 148.7 | 193.2 | 105.7 | 158.8 | 153 | 165.8 | 126.6 |
| 1561146_at | 61 | 70.32 | 51.14 | 95.6 | 55.67 | 95.23 | 61.49 | 50.47 | 65.09 | 80.24 | 71.7 | 65.81 | 70.6 |
| 1564962_at | 25.56 | 29.41 | 30.16 | 27.05 | 32.69 | 29.35 | 27.09 | 36.66 | 33.9 | 43.44 | 45.16 | 32.7 | 42.93 |
| 1567013_at | 91.77 | 91.13 | 108.9 | 105.3 | 107 | 105.9 | 104.4 | 94.8 | 95.12 | 79.66 | 106.8 | 97.23 | 120.9 |
| 1568815_a_at | 149.2 | 162.2 | 130.8 | 135.1 | 116.1 | 165.8 | 144.5 | 106.3 | 195.3 | 159.1 | 128.4 | 132.4 | 144.9 |
| 200007_at | 8575 | 7733 | 7749 | 7669 | 7829 | 7888 | 7214 | 8264 | 8965 | 8540 | 6559 | 7860 | 8109 |
| 200010_at | 16240 | 12812 | 12582 | 13195 | 10255 | 13182 | 12466 | 11922 | 16046 | 13167 | 14613 | 12699 | 13789 |
| 200059_s_at | 9971 | 10233 | 11771 | 10700 | 11866 | 10052 | 10428 | 11799 | 10494 | 10286 | 11099 | 10304 | 10498 |
| 200091_s_at | 24862 | 20469 | 19411 | 20380 | 15196 | 23063 | 22332 | 18747 | 24474 | 20501 | 18088 | 20300 | 25222 |
| 200633_at | 9777 | 9346 | 7961 | 9073 | 8483 | 9036 | 7780 | 8689 | 9468 | 9871 | 8940 | 9297 | 8478 |
| 200650_s_at | 6579 | 5491 | 5356 | 4980 | 5351 | 5750 | 4912 | 5383 | 6141 | 6468 | 4766 | 5549 | 6261 |
| 200672_x_at | 203.3 | 157.6 | 111 | 129.3 | 134.7 | 190.2 | 132.4 | 141.2 | 175.9 | 151.4 | 207.2 | 105 | 184.6 |
| 200677_at | 2081 | 2509 | 2689 | 2832 | 2462 | 2693 | 2795 | 2658 | 2461 | 2000 | 2958 | 2569 | 2796 |
| 200713_s_at | 1533 | 1576 | 1592 | 1624 | 1967 | 1283 | 1628 | 1749 | 1678 | 1616 | 1491 | 1294 | 1464 |
| 200822_x_at | 1461 | 1505 | 1371 | 1222 | 1534 | 1114 | 1304 | 1331 | 1327 | 1283 | 1134 | 1183 | 1315 |
| 200829_x_at | 655.9 | 598.4 | 574.3 | 537.4 | 632.1 | 538.2 | 547.2 | 549.4 | 675.6 | 668.4 | 542.3 | 651.2 | 582.5 |
| 200839_s_at | 2924 | 2889 | 4078 | 2271 | 3055 | 1745 | 3365 | 2285 | 2697 | 3022 | 2960 | 3212 | 2507 |
| 200932_s_at | 477.7 | 459.9 | 450.2 | 475.2 | 481.3 | 443.4 | 451.1 | 481.2 | 478.7 | 452.9 | 468.7 | 504.5 | 475.6 |
| 200950_at | 403.5 | 528.2 | 659.2 | 552.5 | 641.7 | 567.7 | 597.1 | 578.8 | 536.8 | 507.2 | 513.3 | 574.8 | 548.3 |
| 201031_s_at | 11025 | 9346 | 7389 | 8157 | 7439 | 8744 | 8526 | 6720 | 10513 | 10789 | 8553 | 8207 | 9607 |
| 201075_s_at | 316 | 366.7 | 296.3 | 324.2 | 271.3 | 321.5 | 274.9 | 283.6 | 323.2 | 356.8 | 324.8 | 309.8 | 325.7 |
| 201098_at | 780.6 | 747.7 | 811.3 | 786.8 | 952.1 | 820.1 | 894.6 | 827.4 | 770.7 | 766 | 850.1 | 777.5 | 883.2 |
| 201105_at | 4656 | 3661 | 3074 | 2968 | 3693 | 3907 | 3590 | 3239 | 2807 | 6818 | 3502 | 3764 | 3780 |
| 201172_x_at | 3201 | 3633 | 3665 | 3818 | 4243 | 3135 | 3398 | 4106 | 3365 | 2906 | 3840 | 3590 | 3230 |
| 201186_at | 454.5 | 585.7 | 529.7 | 493 | 594.1 | 411.6 | 467.4 | 415 | 391.7 | 468.6 | 484.5 | 420.4 | 514.5 |
| 201193_at | 507.8 | 539.6 | 720.6 | 551.3 | 803.7 | 422.6 | 687.9 | 652.1 | 552.9 | 633.9 | 549.6 | 677.2 | 548.8 |
| 201198_s_at | 183.7 | 167.5 | 195.8 | 169.6 | 170.6 | 161.8 | 151.6 | 176.8 | 203.4 | 186.5 | 176.1 | 167.4 | 179.4 |
| 201220_x_at | 1444 | 1984 | 1882 | 1743 | 2119 | 1450 | 1547 | 1674 | 1556 | 1427 | 1724 | 1572 | 1605 |
| 201234_at | 1337 | 1256 | 1109 | 1234 | 1381 | 1131 | 1125 | 1270 | 1050 | 1110 | 1241 | 1060 | 1088 |
| 201357_s_at | 274.7 | 387.3 | 365.4 | 296.5 | 413.9 | 393.2 | 333.7 | 365.8 | 314.6 | 328.6 | 354.5 | 321.6 | 340.6 |
| 201363_s_at | 1255 | 1540 | 1455 | 1832 | 1249 | 1588 | 1221 | 1523 | 1572 | 969.1 | 1839 | 1669 | 1460 |
| 201400_at | 1335 | 1930 | 2066 | 1904 | 2015 | 1634 | 1537 | 1833 | 1501 | 1516 | 1597 | 1802 | 1900 |
| 201421_s_at | 190.5 | 157.2 | 145.8 | 183.6 | 149.2 | 196 | 171.7 | 150 | 219.5 | 204.4 | 151 | 164.7 | 192.8 |
| 201422_at | 9184 | 8156 | 9255 | 7124 | 10008 | 7771 | 8180 | 6540 | 6190 | 10747 | 7190 | 7186 | 7508 |
| 201426_s_at | 15032 | 15902 | 18109 | 16116 | 15787 | 18113 | 13757 | 18123 | 17466 | 14283 | 16278 | 14965 | 17445 |
| 201453_x_at | 1527 | 1332 | 1225 | 1359 | 1434 | 1226 | 1342 | 1189 | 1411 | 1337 | 1207 | 1289 | 1402 |
| 201470_at | 1492 | 1226 | 1273 | 1159 | 1318 | 996.5 | 1141 | 1407 | 1234 | 1766 | 1040 | 1116 | 1534 |
| 201478_s_at | 301 | 283 | 261.4 | 306.4 | 253 | 246.5 | 264.5 | 245.1 | 329.6 | 299.6 | 311.6 | 289.7 | 315.7 |
| 201527_at | 1169 | 902.3 | 929 | 829.8 | 1077 | 847 | 937.6 | 918.1 | 751.1 | 1003 | 825.9 | 867.2 | 890.5 |
| 201536_at | 441.4 | 390.4 | 489 | 324.5 | 358.5 | 260.5 | 330.8 | 283.5 | 278 | 382.4 | 336.4 | 455.9 | 468.2 |
| 201554_x_at | 644.1 | 829.8 | 1062 | 870.8 | 955.6 | 526.9 | 616.4 | 774.5 | 606.8 | 667.5 | 731.7 | 864.1 | 957 |
| 201556_s_at | 449.5 | 621.3 | 497.5 | 557.1 | 528.4 | 891.7 | 410 | 478.8 | 684.4 | 561.6 | 633.1 | 827.4 | 639.5 |
| 201576_s_at | 694.2 | 723.4 | 734.7 | 636.4 | 694.6 | 606.8 | 680.1 | 631.3 | 630.3 | 633.4 | 734.4 | 693.9 | 662.9 |
| 201590_x_at | 4563 | 2865 | 3665 | 2668 | 3905 | 3227 | 3178 | 3150 | 2926 | 4777 | 3102 | 3680 | 3718 |
| 201628_s_at | 649.5 | 640.5 | 668.4 | 656.5 | 670.7 | 684.4 | 618.6 | 671.6 | 724.7 | 540.2 | 535 | 597.8 | 684.1 |
| 201788_at | 682.4 | 609 | 612 | 703.2 | 529.8 | 505.7 | 501.5 | 455.7 | 750.9 | 519.1 | 698.8 | 636.5 | 595.7 |
| 201900_s_at | 584.4 | 459.8 | 435 | 422.2 | 514.8 | 401.9 | 434.9 | 376.4 | 403 | 538.1 | 447 | 448.9 | 514.7 |
| 201945_at | 277.4 | 588.2 | 590.2 | 503.4 | 574.9 | 464.2 | 440.3 | 531 | 334.1 | 287.5 | 441.5 | 475.7 | 405.7 |
| 202068_s_at | 84.17 | 94.33 | 71.62 | 82.35 | 174.7 | 151.3 | 101.3 | 75.21 | 91.77 | 108 | 166.8 | 87.51 | 102.8 |
| 202104_s_at | 505.6 | 485.7 | 338.8 | 442.1 | 353 | 508.2 | 393 | 364.2 | 434.9 | 436.3 | 463.9 | 371 | 327.5 |
| 202138_x_at | 338.1 | 299 | 311.5 | 305.3 | 298.3 | 237.6 | 327.9 | 247.8 | 263.2 | 336.4 | 242.4 | 274.7 | 265 |
| 202185_at | 269.4 | 254.7 | 228.7 | 208.8 | 225.3 | 231.9 | 217.8 | 204.8 | 177.9 | 265.3 | 202.5 | 215.2 | 224.9 |
| 202192_s_at | 630.3 | 790.8 | 939.4 | 602.4 | 699.2 | 778.3 | 688.2 | 676.1 | 586.9 | 458.8 | 503.1 | 564.7 | 700.2 |
| 202201_at | 661.5 | 574.6 | 677.3 | 424.4 | 719.2 | 411.7 | 641.9 | 544.4 | 496.4 | 725 | 782.8 | 736.8 | 722.8 |
| 202249_s_at | 220.7 | 227 | 180.4 | 257.7 | 216.1 | 289.6 | 193 | 232.7 | 291.9 | 202 | 224.8 | 186 | 254.3 |
| 202252_at | 98.85 | 76.66 | 138.2 | 85.05 | 158.5 | 88.65 | 143 | 112.9 | 96.66 | 55.66 | 72.13 | 85.42 | 87.51 |
| 202262_x_at | 82.3 | 95.38 | 98.79 | 99.69 | 119.1 | 72.53 | 72.34 | 96.76 | 59.92 | 95.66 | 72.4 | 74.13 | 98.87 |
| 202380_s_at | 958.8 | 729.4 | 595.7 | 790 | 525.3 | 675.6 | 569.8 | 627.4 | 829 | 589.9 | 757.5 | 632.3 | 640.3 |
| 202381_at | 383.3 | 354.7 | 461.1 | 329.1 | 438.8 | 302.2 | 509.9 | 380.1 | 339.2 | 442.2 | 288.6 | 584.3 | 353.6 |
| 202428_x_at | 2418 | 2436 | 2248 | 2283 | 2451 | 2038 | 2061 | 2101 | 2512 | 2850 | 1891 | 2206 | 2134 |
| 202445_s_at | 136.1 | 119.1 | 152.7 | 166.3 | 179.9 | 143.4 | 99.48 | 144.1 | 141.1 | 137.5 | 161 | 114.9 | 146.2 |
| 202461_at | 202.2 | 174.6 | 191.3 | 206.1 | 190.6 | 210.9 | 183.5 | 184.5 | 189.1 | 177.9 | 174.7 | 179.5 | 155.5 |
| 202522_at | 826.2 | 704.9 | 711.1 | 827.5 | 633 | 694 | 743.5 | 725.1 | 822.4 | 667 | 662.3 | 645.3 | 683.6 |
| 202523_s_at | 219.3 | 271 | 125.8 | 249.1 | 120.7 | 414.9 | 167.9 | 136.4 | 117.8 | 145.8 | 313.4 | 111.4 | 141.1 |
| 202594_at | 1268 | 1214 | 1044 | 1135 | 912.1 | 905.2 | 1047 | 826.9 | 1524 | 904.5 | 1271 | 910.3 | 1027 |
| 202623_at | 1179 | 1166 | 1254 | 1321 | 1073 | 1182 | 1072 | 1069 | 1200 | 971.8 | 1049 | 1298 | 1230 |
| 202652_at | 50.87 | 33.63 | 38.31 | 41.06 | 21.04 | 33.58 | 30.79 | 28.4 | 47.36 | 28.32 | 36.44 | 31.5 | 39.47 |
| 202724_s_at | 563.6 | 497.9 | 498.1 | 463.2 | 319.1 | 623.5 | 493.4 | 531.8 | 744 | 397.3 | 534.8 | 411 | 584.4 |
| 202750_s_at | 209.9 | 184.1 | 219.3 | 174.1 | 201.3 | 248.3 | 214.9 | 150.4 | 160 | 182.8 | 269.4 | 164 | 173.5 |
| 202778_s_at | 643.5 | 528.9 | 479.3 | 548.6 | 482.2 | 544.7 | 533.8 | 577.8 | 649.9 | 440.2 | 505.2 | 554.3 | 456 |
| 202910_s_at | 2803 | 3387 | 3318 | 3824 | 3268 | 5337 | 3407 | 4866 | 2387 | 2641 | 3012 | 1912 | 2494 |
| 202928_s_at | 153.2 | 148.7 | 135.1 | 156.8 | 155.9 | 148 | 152.1 | 160.6 | 175.9 | 126.9 | 156.8 | 122.1 | 131.2 |
| 202944_at | 634.9 | 425.4 | 564.1 | 397.6 | 610.2 | 304.7 | 455.9 | 372.7 | 380.8 | 605.5 | 414.7 | 450 | 491.7 |
| 202979_s_at | 951 | 692.9 | 626.7 | 734.4 | 529.5 | 772.7 | 728.7 | 689.5 | 1051 | 759.4 | 594.1 | 696.1 | 849.5 |
| 203003_at | 80.37 | 112.4 | 96.42 | 111.5 | 97.41 | 106.8 | 87.01 | 107.2 | 75.82 | 93.76 | 96.62 | 98.21 | 93.37 |
| 203127_s_at | 295.7 | 283.9 | 392.6 | 336.7 | 362.2 | 299.5 | 339.9 | 382 | 338 | 392.8 | 314.6 | 322.5 | 359.7 |
| 203137_at | 1933 | 1573 | 1464 | 2004 | 1535 | 1887 | 1796 | 1632 | 1635 | 1846 | 1850 | 1922 | 1688 |
| 203184_at | 81.75 | 63.88 | 250 | 36.34 | 96.19 | 71.05 | 102.7 | 48.55 | 115.5 | 70.84 | 76.06 | 61.7 | 86.09 |
| 203234_at | 523.3 | 493.5 | 581.5 | 442.4 | 458.5 | 380.4 | 391.6 | 424.4 | 487.2 | 400.6 | 476.5 | 441.3 | 505.9 |
| 203278_s_at | 613 | 961.1 | 1275 | 972.9 | 1155 | 879 | 898.4 | 1409 | 890.3 | 724.8 | 912.1 | 798.1 | 1127 |
| 203305_at | 1848 | 796.9 | 933.4 | 871 | 976 | 1119 | 1629 | 983.1 | 1039 | 753.5 | 528.6 | 1277 | 913 |
| 203371_s_at | 966 | 1236 | 1530 | 1166 | 1415 | 1124 | 998.5 | 1756 | 1065 | 942.6 | 1096 | 1054 | 1287 |
| 203413_at | 1046 | 435.4 | 377.7 | 500.1 | 231.8 | 520.2 | 586.1 | 211.7 | 793.1 | 364.8 | 718.2 | 250.7 | 798 |
| 203416_at | 9687 | 10819 | 11290 | 11571 | 12040 | 10137 | 9756 | 11114 | 11084 | 10189 | 10831 | 10010 | 10434 |
| 203492_x_at | 269.7 | 232.6 | 211.9 | 253.6 | 221.1 | 242.3 | 219 | 213.2 | 305 | 241.3 | 292.8 | 238.9 | 301.1 |
| 203534_at | 893.7 | 820.3 | 734.4 | 844.1 | 929.9 | 759.1 | 817.4 | 773.4 | 852.7 | 814.6 | 751.7 | 823.3 | 827.2 |
| 203535_at | 35336 | 45645 | 46919 | 44319 | 46845 | 35692 | 40407 | 45708 | 36833 | 40043 | 42052 | 38145 | 40806 |
| 203578_s_at | 105.1 | 70.92 | 97.16 | 54.9 | 66.86 | 131.5 | 131.2 | 116.6 | 158.7 | 131.1 | 168.1 | 70.77 | 140.2 |
| 203748_x_at | 1397 | 1537 | 1958 | 1681 | 1838 | 1608 | 1586 | 1727 | 1493 | 1259 | 1592 | 1578 | 1644 |
| 203759_at | 55.11 | 98.16 | 121.1 | 89.83 | 119.6 | 89.93 | 98.89 | 88.83 | 51.4 | 74.55 | 107.8 | 78.15 | 121.2 |
| 203844_at | 24.3 | 25.77 | 27.34 | 27.23 | 29.88 | 26.42 | 26.98 | 29.1 | 32.5 | 29.47 | 27.68 | 30.02 | 27.47 |
| 203880_at | 312.8 | 319.3 | 308.8 | 287.5 | 317.3 | 282.5 | 249.4 | 272.2 | 308.4 | 357.8 | 278 | 273.8 | 269.3 |
| 203912_s_at | 255.6 | 211.2 | 232.7 | 207 | 280.3 | 238.5 | 226 | 205.3 | 236.9 | 276.3 | 173.8 | 139.1 | 252.3 |
| 203939_at | 50.81 | 63.73 | 33.18 | 56.42 | 53.46 | 41.42 | 57.57 | 145.8 | 148.9 | 99.05 | 113.4 | 64.76 | 104.2 |
| 203971_at | 84.9 | 108.4 | 108.6 | 73.49 | 130.5 | 152.7 | 111.3 | 165.9 | 97.1 | 118.4 | 94.04 | 105.4 | 107.7 |
| 204050_s_at | 1534 | 1318 | 1517 | 1189 | 1443 | 1144 | 1235 | 1221 | 1435 | 1496 | 1198 | 1419 | 1384 |
| 204068_at | 84.08 | 62.28 | 104.6 | 64.94 | 64.32 | 72.04 | 88.49 | 87.85 | 60.13 | 64.07 | 61.79 | 75.02 | 94.71 |
| 204099_at | 156.4 | 202.5 | 339 | 127.9 | 259.1 | 94.71 | 171.4 | 115.9 | 126.6 | 137.4 | 159.1 | 206.6 | 187.9 |
| 204143_s_at | 312.8 | 245.7 | 187.8 | 304 | 85.55 | 236 | 278.8 | 94.58 | 208.4 | 170.2 | 200.2 | 196.7 | 182 |
| 204204_at | 1155 | 1850 | 3524 | 1758 | 2438 | 3210 | 1999 | 3360 | 2122 | 1374 | 1514 | 1508 | 1878 |
| 204214_s_at | 490.7 | 456.5 | 726.6 | 549.2 | 700 | 398 | 471.7 | 577 | 498.7 | 584.1 | 672.1 | 582.4 | 610.9 |
| 204232_at | 3562 | 5799 | 3520 | 2855 | 5469 | 2604 | 4403 | 3547 | 2867 | 4777 | 4314 | 3402 | 6169 |
| 204243_at | 240.5 | 324.4 | 351.8 | 281.6 | 285.2 | 289.1 | 319.5 | 307.3 | 316.9 | 205.3 | 293.1 | 243.6 | 278.9 |
| 204249_s_at | 2823 | 2429 | 3060 | 2882 | 3643 | 1646 | 3081 | 3200 | 2047 | 4018 | 2898 | 3357 | 2740 |
| 204291_at | 471.2 | 371.7 | 467.6 | 427.4 | 335.2 | 450.1 | 349.3 | 420.9 | 452.4 | 472 | 490.5 | 547.2 | 545.3 |
| 204342_at | 938.1 | 699.1 | 1069 | 576.9 | 633 | 832.6 | 707.9 | 791.3 | 964.9 | 1171 | 760.2 | 912.9 | 1068 |
| 204352_at | 529.1 | 526.6 | 259.8 | 453.4 | 193.7 | 517.2 | 370.1 | 532.5 | 656.2 | 453.1 | 412.3 | 282.4 | 565.8 |
| 204401_at | 289.8 | 158.1 | 82.54 | 114.2 | 126.4 | 96.68 | 152.1 | 135.3 | 116.4 | 117.5 | 170.5 | 108.9 | 117.8 |
| 204504_s_at | 95.08 | 102.1 | 77.54 | 95.38 | 82.14 | 108.9 | 88.86 | 89.56 | 103.6 | 97.71 | 108.1 | 81.3 | 95.98 |
| 204617_s_at | 297.9 | 350.4 | 270.1 | 339.3 | 264.3 | 350.3 | 240.6 | 288.5 | 283.5 | 341.1 | 341.1 | 281.7 | 300.2 |
| 204645_at | 852.3 | 773.1 | 888.1 | 837.2 | 730.7 | 959.4 | 867.7 | 841.8 | 993 | 1005 | 889.3 | 955.1 | 1037 |
| 204675_at | 198.5 | 79.5 | 132.9 | 122 | 122.9 | 85.37 | 140.8 | 91.3 | 138.5 | 128.3 | 86.06 | 105.2 | 97.94 |
| 204689_at | 451.3 | 445.9 | 488.6 | 529.2 | 719.9 | 398.1 | 457.4 | 556.6 | 435.4 | 558.3 | 455.2 | 560.4 | 501.2 |
| 204801_s_at | 28.1 | 64.62 | 39.2 | 27.72 | 22.59 | 28.09 | 28.42 | 67.45 | 20.39 | 23.47 | 31.5 | 21.02 | 30.76 |
| 205235_s_at | 94.74 | 71.52 | 80.76 | 95 | 88.95 | 78.05 | 81.14 | 95.38 | 90.8 | 89.93 | 86.74 | 86.45 | 103.9 |
| 205254_x_at | 476.2 | 306.7 | 293.7 | 228.4 | 130.9 | 375.1 | 326.1 | 209.9 | 649.8 | 199.3 | 462.2 | 108.9 | 352.5 |
| 205256_at | 86.14 | 66.94 | 53.29 | 83.44 | 65.79 | 72.23 | 62.92 | 68.2 | 85.86 | 65.62 | 63.85 | 66.32 | 62.06 |
| 205322_s_at | 472.3 | 500.1 | 687.5 | 540.1 | 780 | 452.7 | 470.6 | 571 | 463.2 | 464.2 | 522.6 | 517.3 | 466.8 |
| 205340_at | 183.2 | 132.4 | 122.1 | 161.3 | 124.8 | 149.1 | 119.9 | 125.8 | 161.3 | 174.4 | 185.7 | 139.6 | 161.9 |
| 205349_at | 175.9 | 159.5 | 172.7 | 139.8 | 177.3 | 137.5 | 190.8 | 164.3 | 93.3 | 223.7 | 164.1 | 175.6 | 223.9 |
| 205550_s_at | 313.9 | 274.8 | 269.9 | 284.8 | 282.7 | 260 | 265.9 | 276.7 | 274.5 | 232.2 | 225.7 | 256.6 | 262.8 |
| 205811_at | 246.3 | 185.3 | 138.7 | 194.3 | 135.6 | 178.9 | 198.3 | 190 | 191.3 | 222 | 211.8 | 148.3 | 176 |
| 205835_s_at | 95.45 | 103.9 | 70.82 | 114.8 | 114.9 | 115.9 | 99.11 | 69.76 | 119.3 | 154.7 | 73.81 | 109.1 | 131.4 |
| 205895_s_at | 170.8 | 150.4 | 121.7 | 139.6 | 172.6 | 134.8 | 128.9 | 125.2 | 146.4 | 160.9 | 186.8 | 119.7 | 172.1 |
| 205965_at | 218.2 | 241.9 | 203.3 | 291.9 | 166.2 | 256.1 | 200 | 194.4 | 184.1 | 333.8 | 161.2 | 179.9 | 192.1 |
| 205976_at | 78.23 | 51.43 | 40.64 | 46.09 | 33.02 | 40.64 | 61.34 | 36.98 | 58.31 | 60.73 | 47.71 | 43.83 | 52.43 |
| 206015_s_at | 761.4 | 679.7 | 782.9 | 812.7 | 735.5 | 657.9 | 681.2 | 742.9 | 853.3 | 591 | 731.3 | 636.2 | 765.3 |
| 206037_at | 48.26 | 47.25 | 29.68 | 46.29 | 31.07 | 33.73 | 34.52 | 34.61 | 35.03 | 40.82 | 41.02 | 40.22 | 38.26 |
| 206170_at | 323.3 | 316.5 | 263.6 | 504.7 | 380.5 | 284.1 | 341.3 | 378.8 | 220.5 | 358.3 | 188.1 | 294.7 | 242.9 |
| 206182_at | 116.4 | 95.13 | 106.6 | 83.92 | 91.34 | 88.16 | 109.2 | 92.57 | 114.2 | 92.95 | 127.8 | 99.24 | 116.6 |
| 206343_s_at | 18.9 | 18.95 | 56.88 | 3.681 | 23.83 | 8.747 | 59.13 | 43.02 | 24.45 | 27 | 27.73 | 20.33 | 16.85 |
| 206542_s_at | 1503 | 1258 | 1092 | 1360 | 1124 | 1213 | 1182 | 1243 | 1644 | 1247 | 1216 | 1422 | 1521 |
| 206580_s_at | 56.87 | 62.06 | 66.1 | 47.93 | 60.92 | 46.69 | 59.22 | 50.24 | 64.28 | 57.05 | 61.27 | 60.93 | 53.74 |
| 206715_at | 281.4 | 228.9 | 372.6 | 222.1 | 371.6 | 177.4 | 337.3 | 251.4 | 204 | 343.9 | 267.8 | 465.2 | 262 |
| 206834_at | 72.06 | 48.27 | 48.34 | 52.29 | 127.4 | 57.14 | 57.68 | 164.9 | 39.82 | 71.37 | 70.53 | 19.92 | 70.67 |
| 206968_s_at | 116.1 | 90.32 | 83.69 | 94.72 | 118.9 | 116.9 | 88.2 | 107.4 | 111.2 | 109.3 | 120.7 | 66.79 | 107.5 |
| 207075_at | 139.3 | 143.5 | 158.8 | 139.9 | 141.7 | 132.8 | 166.5 | 276.1 | 149.9 | 86.21 | 115.1 | 153.4 | 145.3 |
| 207078_at | 210.5 | 224.3 | 113 | 234.4 | 114.6 | 202 | 181.9 | 147.8 | 154.3 | 211.4 | 210.4 | 131.2 | 151.5 |
| 207113_s_at | 95.7 | 86.82 | 96.8 | 135 | 207 | 89.83 | 123 | 187 | 96.61 | 155.1 | 104.1 | 90.95 | 142.6 |
| 207164_s_at | 346.7 | 505.3 | 602.1 | 553.2 | 870.3 | 861.1 | 631.5 | 684.1 | 683.5 | 427.5 | 773.1 | 558 | 803.2 |
| 207233_s_at | 133.3 | 80 | 105.6 | 82.12 | 107.4 | 70.49 | 119.6 | 129.5 | 96.42 | 97.89 | 79.94 | 116.9 | 105.7 |
| 207416_s_at | 299 | 316.8 | 161.6 | 273.1 | 228.2 | 313.6 | 214.9 | 202 | 260 | 304.5 | 215.7 | 251.4 | 237.1 |
| 207513_s_at | 232 | 222.5 | 196.8 | 239 | 207.7 | 223 | 249.3 | 201.9 | 236.4 | 294.4 | 240.4 | 270 | 268.8 |
| 207543_s_at | 341.8 | 321.5 | 336.6 | 272.7 | 323.9 | 319.3 | 298.3 | 359.7 | 370.5 | 305.8 | 266.4 | 312 | 334.5 |
| 207564_x_at | 4144 | 3492 | 3222 | 3210 | 2972 | 3340 | 2913 | 3102 | 4441 | 3677 | 3672 | 3069 | 3886 |
| 207971_s_at | 119.3 | 79.72 | 83.25 | 95.79 | 42.25 | 106.3 | 82.29 | 58.54 | 114.5 | 73.94 | 94.56 | 47.56 | 72.66 |
| 208104_s_at | 446.3 | 500.4 | 547.8 | 458 | 457.7 | 435.9 | 455.8 | 502.3 | 455.1 | 399.5 | 472.3 | 541.7 | 457.3 |
| 208121_s_at | 142.6 | 71.06 | 135.4 | 77.5 | 134.8 | 42.46 | 123 | 132.4 | 118.3 | 176.7 | 60.45 | 80.27 | 127.5 |
| 208161_s_at | 56.73 | 44.78 | 90.02 | 44.93 | 58.98 | 64.03 | 66.06 | 36.26 | 39.47 | 48.6 | 42.79 | 79.91 | 64.98 |
| 208269_s_at | 88.18 | 97.89 | 92.37 | 102.2 | 103.1 | 101.3 | 119.5 | 103.4 | 98.5 | 121.9 | 110.1 | 79.71 | 122.1 |
| 208309_s_at | 331.6 | 282.5 | 283.6 | 260.4 | 300.9 | 387 | 308.5 | 319.6 | 475.8 | 348.5 | 435.6 | 325.6 | 401.9 |
| 208527_x_at | 227.9 | 312.1 | 339.9 | 396.5 | 288.6 | 321 | 239.9 | 339.4 | 434.2 | 197.5 | 335.8 | 272.2 | 285.5 |
| 208579_x_at | 386.4 | 617.3 | 567 | 747.9 | 568.3 | 539.2 | 393.6 | 580.4 | 942.6 | 363.2 | 556.5 | 433.6 | 468.3 |
| 208635_x_at | 17052 | 15009 | 15163 | 15443 | 14185 | 14935 | 15030 | 14091 | 18421 | 16634 | 15691 | 15777 | 17285 |
| 208659_at | 5933 | 6929 | 6845 | 7054 | 7584 | 6188 | 6416 | 7109 | 5835 | 6879 | 6564 | 6463 | 7078 |
| 208680_at | 952.8 | 730 | 717.6 | 609.7 | 896.5 | 680.2 | 599.7 | 658.7 | 738.8 | 1019 | 711.4 | 702.8 | 865 |
| 208749_x_at | 1613 | 2276 | 2167 | 2638 | 2148 | 1792 | 1681 | 2070 | 1305 | 1216 | 1944 | 1680 | 1965 |
| 208771_s_at | 6298 | 4544 | 6356 | 3813 | 6366 | 3859 | 6051 | 4436 | 5461 | 6156 | 5143 | 5660 | 7363 |
| 208780_x_at | 2065 | 2663 | 3166 | 2265 | 2513 | 1809 | 3061 | 2832 | 2315 | 2191 | 2217 | 1926 | 2215 |
| 208798_x_at | 2431 | 2347 | 1499 | 1742 | 517.2 | 1204 | 1258 | 1659 | 2439 | 1133 | 1413 | 1018 | 1094 |
| 208805_at | 2335 | 2205 | 2056 | 2169 | 2315 | 1681 | 1985 | 1977 | 1913 | 2995 | 1888 | 2298 | 1879 |
| 208868_s_at | 380 | 927 | 846 | 853.2 | 781.2 | 944.8 | 736.9 | 802.2 | 728.6 | 424.2 | 776.6 | 769.6 | 657.1 |
| 208903_at | 60.42 | 56.75 | 48.91 | 67.92 | 45.71 | 53.63 | 53.87 | 44.57 | 63.1 | 57.59 | 62.33 | 34.02 | 71.02 |
| 208921_s_at | 1174 | 1210 | 1222 | 1251 | 1165 | 1163 | 1124 | 1205 | 1355 | 1271 | 1057 | 1190 | 1287 |
| 208923_at | 852.5 | 508.2 | 715.4 | 481.9 | 640.6 | 413.4 | 716.8 | 575.3 | 486.9 | 585.4 | 585.5 | 706.4 | 722.1 |
| 208946_s_at | 1429 | 1276 | 1375 | 1554 | 1566 | 1515 | 1470 | 1404 | 1407 | 1322 | 1259 | 1499 | 1483 |
| 208962_s_at | 112 | 89.14 | 19.96 | 38.85 | 162.4 | 43.42 | 83.56 | 42.39 | 49.7 | 114.8 | 84.68 | 68.8 | 85.7 |
| 209040_s_at | 1770 | 1792 | 2045 | 1918 | 2071 | 1618 | 1676 | 1884 | 1617 | 2141 | 1616 | 1798 | 1540 |
| 209067_s_at | 3336 | 2364 | 2244 | 2845 | 2222 | 3447 | 2598 | 2067 | 3946 | 3349 | 2827 | 2966 | 3538 |
| 209072_at | 46.06 | 62.82 | 99.48 | 63.71 | 47.67 | 86.26 | 82.71 | 63.59 | 70.71 | 11.85 | 43.27 | 66.37 | 63.89 |
| 209099_x_at | 73.39 | 89.86 | 121.4 | 80.97 | 115.2 | 82.95 | 143.6 | 92.33 | 81.16 | 59.85 | 81.74 | 121.8 | 113.2 |
| 209124_at | 5112 | 4902 | 5276 | 5507 | 5983 | 4665 | 4713 | 5629 | 4782 | 5841 | 5176 | 4362 | 5697 |
| 209180_at | 430 | 293.3 | 336.8 | 391.8 | 306.6 | 312.3 | 292.6 | 242.2 | 394 | 400.4 | 368.1 | 317.6 | 360.7 |
| 209191_at | 80.6 | 97.08 | 104.2 | 70.25 | 98.83 | 211.5 | 182.4 | 290.3 | 165.8 | 232.2 | 96.13 | 98.06 | 202.3 |
| 209212_s_at | 16.34 | 17.59 | 35.61 | 29.66 | 36.49 | 33.18 | 29.79 | 29.67 | 29.05 | 17.88 | 29.62 | 23.81 | 19.21 |
| 209218_at | 152 | 104.3 | 83.77 | 119.5 | 280.6 | 117.8 | 146.9 | 121.8 | 150.6 | 174.2 | 188.9 | 102.3 | 196.5 |
| 209236_at | 248.3 | 231.8 | 205.2 | 254 | 205.3 | 189.2 | 256.2 | 206.2 | 219.9 | 203.9 | 196.1 | 196.1 | 170.9 |
| 209251_x_at | 4526 | 5075 | 5711 | 5955 | 6416 | 5336 | 4579 | 6301 | 4976 | 4068 | 4745 | 4140 | 5212 |
| 209259_s_at | 645.8 | 531.1 | 546.9 | 592.7 | 513.7 | 591.1 | 579.6 | 521 | 721.3 | 609.9 | 557.2 | 600.2 | 628.2 |
| 209269_s_at | 432.5 | 644.8 | 743 | 574.8 | 582.8 | 534.1 | 576 | 522.7 | 481.6 | 488.5 | 542.7 | 704.3 | 524.2 |
| 209330_s_at | 2903 | 2053 | 1945 | 2409 | 2013 | 2697 | 2560 | 1743 | 2690 | 3058 | 2739 | 2451 | 2670 |
| 209339_at | 361.4 | 354 | 447.4 | 405.7 | 445.9 | 397.1 | 339.2 | 402.7 | 395.3 | 409 | 401.8 | 426 | 399 |
| 209430_at | 996.9 | 757.3 | 692.9 | 826.6 | 692 | 890.5 | 747.6 | 727.7 | 974.6 | 881.8 | 750.1 | 920.6 | 859.6 |
| 209675_s_at | 928.4 | 1150 | 1099 | 1064 | 1084 | 1210 | 939.6 | 975 | 1041 | 971.6 | 1142 | 1149 | 1072 |
| 209684_at | 439.3 | 266.1 | 525.8 | 252.3 | 525.4 | 267.4 | 355.2 | 282.7 | 306.5 | 615.3 | 316.8 | 541.9 | 467.7 |
| 209806_at | 1411 | 2107 | 1856 | 2627 | 1750 | 1349 | 1391 | 1766 | 3299 | 1393 | 1712 | 1475 | 1559 |
| 209840_s_at | 187.8 | 9.314 | 182.6 | 15.28 | 13.03 | 55.5 | 54.82 | 11.22 | 327.9 | 168.4 | 205.6 | 10.99 | 392.3 |
| 209870_s_at | 227.8 | 229.2 | 161.5 | 174.5 | 133.8 | 193.2 | 185.8 | 146 | 257 | 193.7 | 292.4 | 136.4 | 161.4 |
| 209892_at | 106.1 | 102.1 | 109.5 | 93.1 | 128.6 | 91.74 | 87.66 | 83.8 | 78.96 | 82.37 | 84.27 | 86.6 | 110.7 |
| 209906_at | 851.3 | 754.2 | 1214 | 273.6 | 1255 | 480.8 | 914.8 | 481.8 | 342.2 | 628.2 | 369.4 | 512.2 | 778.5 |
| 210022_at | 176.9 | 160.5 | 177.9 | 167 | 186.9 | 159.7 | 169.2 | 170.3 | 156.1 | 177 | 174.3 | 194.1 | 180.2 |
| 210061_at | 152.4 | 121.9 | 106.5 | 90.87 | 163.8 | 97.62 | 136.6 | 123.6 | 135 | 116.6 | 111 | 78.76 | 121.1 |
| 210145_at | 83.16 | 55.42 | 84.37 | 53.22 | 84.05 | 57.01 | 92.35 | 69.61 | 66.29 | 84.78 | 80.78 | 110.3 | 79 |
| 210156_s_at | 962.6 | 955.3 | 1152 | 1249 | 1437 | 1012 | 1076 | 1078 | 1110 | 1196 | 1198 | 1345 | 1223 |
| 210166_at | 495.3 | 616.3 | 967.4 | 388 | 603 | 220.3 | 436.6 | 338.5 | 322.2 | 386.1 | 396.4 | 444.4 | 956 |
| 210434_x_at | 2479 | 2809 | 2760 | 2697 | 2826 | 2444 | 2431 | 2652 | 2578 | 2446 | 2479 | 2185 | 2392 |
| 210644_s_at | 629 | 598.5 | 434.6 | 409.1 | 781.1 | 426.1 | 679.6 | 407.2 | 350 | 558.9 | 546.8 | 296.5 | 442.9 |
| 210648_x_at | 3958 | 3649 | 4228 | 3676 | 4384 | 3085 | 3620 | 3963 | 3804 | 3453 | 3378 | 3494 | 3407 |
| 210875_s_at | 129 | 210.7 | 221.2 | 262.6 | 202.6 | 162 | 197.8 | 219.8 | 247.2 | 133.2 | 273.3 | 244.4 | 244 |
| 211047_x_at | 1408 | 1269 | 1248 | 1089 | 1303 | 1073 | 1233 | 1165 | 1101 | 1330 | 1366 | 1149 | 1193 |
| 211058_x_at | 4431 | 4653 | 5215 | 5227 | 5796 | 5080 | 4410 | 5942 | 4880 | 4856 | 5170 | 4818 | 5416 |
| 211185_s_at | 7986 | 7877 | 7724 | 8081 | 7227 | 8141 | 8238 | 7789 | 8364 | 7446 | 8280 | 8035 | 8842 |
| 211272_s_at | 866.9 | 536.3 | 508.5 | 610.4 | 379 | 687.4 | 549.7 | 499.5 | 780.8 | 490.1 | 848.3 | 305 | 604.2 |
| 211323_s_at | 126.3 | 133.5 | 164.4 | 159.1 | 129.9 | 163.7 | 148.5 | 167.2 | 197.8 | 174.1 | 188 | 191.1 | 188.1 |
| 211383_s_at | 599.3 | 586.4 | 487.3 | 592.2 | 515.8 | 490.1 | 480.8 | 465.6 | 500 | 483.9 | 479.9 | 487.5 | 481.1 |
| 211429_s_at | 12340 | 15495 | 20098 | 17065 | 17200 | 15793 | 13923 | 14731 | 14746 | 16825 | 15774 | 15861 | 19901 |
| 211506_s_at | 542.9 | 346.4 | 633.6 | 410.2 | 604.7 | 190 | 1398 | 691.2 | 79.24 | 47.51 | 769.8 | 289.3 | 97.25 |
| 211546_x_at | 203.1 | 181.7 | 157.9 | 175.3 | 188.5 | 133.2 | 156.6 | 189.2 | 152.5 | 157.9 | 196.8 | 207.2 | 147.5 |
| 211684_s_at | 778.8 | 608.4 | 643.7 | 550 | 607.2 | 538 | 644.7 | 568.9 | 698.5 | 661 | 454.5 | 641.1 | 721.6 |
| 211729_x_at | 650.3 | 385.6 | 381.6 | 393.2 | 694.4 | 389.3 | 425.9 | 409.9 | 355.2 | 763 | 453.1 | 380.3 | 422.9 |
| 211856_x_at | 59.11 | 55.28 | 40.75 | 49.92 | 21.12 | 70.09 | 82.17 | 62.12 | 91.9 | 37.17 | 118.2 | 38.85 | 97.27 |
| 211946_s_at | 5202 | 4648 | 4285 | 4395 | 3937 | 5033 | 4372 | 4393 | 5381 | 4678 | 4259 | 5354 | 5173 |
| 211965_at | 1623 | 2158 | 2768 | 2424 | 2638 | 2623 | 1584 | 2423 | 2504 | 1610 | 1872 | 2872 | 3380 |
| 212030_at | 1088 | 1105 | 1127 | 1084 | 1099 | 1269 | 1046 | 1074 | 1331 | 940.7 | 1279 | 1392 | 1325 |
| 212042_x_at | 26539 | 21542 | 22579 | 23600 | 17659 | 23726 | 24164 | 22481 | 27642 | 23679 | 27093 | 24518 | 26524 |
| 212132_at | 2654 | 2609 | 2697 | 2732 | 2730 | 3147 | 2541 | 2316 | 3263 | 2909 | 2597 | 3006 | 3303 |
| 212213_x_at | 259.7 | 208.8 | 232 | 264.9 | 212.5 | 208.6 | 268.7 | 205.3 | 239.7 | 202.3 | 216.7 | 201.7 | 235.4 |
| 212299_at | 495.4 | 412.7 | 377.7 | 381.3 | 371.1 | 306.2 | 350 | 356.9 | 484.9 | 352.6 | 449.6 | 297.5 | 351.3 |
| 212331_at | 4329 | 3035 | 2927 | 3783 | 2858 | 3127 | 3856 | 3091 | 3850 | 3328 | 3083 | 2836 | 2994 |
| 212334_at | 2767 | 2040 | 2548 | 2167 | 3084 | 1789 | 2597 | 2273 | 1827 | 3654 | 2296 | 2402 | 2067 |
| 212406_s_at | 1494 | 1419 | 1223 | 1486 | 1075 | 1395 | 1138 | 1328 | 1523 | 1064 | 1422 | 1372 | 1214 |
| 212455_at | 3282 | 3175 | 3055 | 3205 | 3043 | 3139 | 2996 | 3154 | 3668 | 3031 | 3756 | 3765 | 3444 |
| 212543_at | 1662 | 1369 | 1336 | 1468 | 1420 | 1266 | 1432 | 1420 | 1483 | 1266 | 1207 | 1293 | 1314 |
| 212658_at | 83.59 | 75.97 | 115.6 | 83.84 | 107.3 | 68.23 | 94.17 | 95.49 | 73.11 | 92.77 | 66.32 | 128.1 | 66.83 |
| 212663_at | 1462 | 1306 | 1367 | 1177 | 1398 | 1343 | 1361 | 1429 | 1096 | 1413 | 1295 | 1271 | 1352 |
| 212769_at | 239.7 | 471 | 441.2 | 327.9 | 270 | 475.4 | 483.2 | 604.4 | 299.6 | 186.9 | 372.9 | 258.3 | 357.6 |
| 212820_at | 2196 | 1811 | 2599 | 1607 | 2604 | 2678 | 2496 | 2431 | 1955 | 2622 | 1831 | 2338 | 2188 |
| 212932_at | 171.9 | 144.2 | 170.6 | 136.7 | 155.7 | 119 | 134.3 | 140.7 | 208.3 | 155.8 | 180.7 | 124 | 159.7 |
| 212989_at | 347.6 | 282.9 | 464.3 | 306 | 325.1 | 308.6 | 390.1 | 393.6 | 334 | 347 | 352.3 | 357.5 | 368 |
| 212997_s_at | 543.4 | 564.8 | 607.3 | 607.6 | 633 | 591.5 | 593.1 | 710.7 | 649.1 | 616.5 | 735.8 | 659.9 | 665.7 |
| 213021_at | 228.1 | 249 | 246.7 | 237.5 | 210.9 | 215.3 | 234.4 | 210.7 | 261.2 | 274.9 | 296.5 | 237.9 | 248 |
| 213152_s_at | 643.2 | 479 | 357.9 | 480.2 | 292.5 | 538 | 428.1 | 481.4 | 654.1 | 501.3 | 611.2 | 401.1 | 634.1 |
| 213205_s_at | 196.6 | 178.7 | 120.1 | 143.7 | 114.1 | 139.1 | 124.4 | 120.4 | 136.6 | 148.3 | 146.4 | 121.6 | 139.5 |
| 213218_at | 84.95 | 136.3 | 81.62 | 111.7 | 73.42 | 67.56 | 75.99 | 88.16 | 100 | 87.35 | 122.7 | 88.77 | 100.2 |
| 213266_at | 103.8 | 72.83 | 80.16 | 120.9 | 83.52 | 92.44 | 73.65 | 72.58 | 110.4 | 85.64 | 98.83 | 94.87 | 110.8 |
| 213302_at | 58.93 | 36.62 | 28.29 | 35.82 | 29.27 | 36.04 | 31.81 | 26.62 | 36.36 | 36.7 | 44.96 | 29.59 | 34.96 |
| 213335_s_at | 27.05 | 30.31 | 36.83 | 41.82 | 40.97 | 31.72 | 47.31 | 39.5 | 31.8 | 30.98 | 32.18 | 33.41 | 33.81 |
| 213397_x_at | 85.64 | 125.9 | 81.77 | 73.59 | 92.59 | 43.49 | 128.7 | 85.64 | 70.99 | 88.29 | 70.13 | 94.37 | 133.3 |
| 213459_at | 140.9 | 83.49 | 101.4 | 79.49 | 63.29 | 49.41 | 101 | 60.45 | 87.01 | 67.89 | 114.7 | 80.57 | 96.76 |
| 213494_s_at | 43.58 | 28.92 | 74.95 | 54.41 | 49.86 | 59.64 | 44.36 | 54.21 | 66.86 | 53.89 | 45.95 | 56.27 | 55.75 |
| 213540_at | 97.08 | 58.1 | 53.42 | 78.55 | 54.12 | 60.17 | 64.61 | 50.14 | 87.53 | 49.61 | 76.26 | 55.53 | 76.21 |
| 213693_s_at | 36.27 | 37.49 | 35.98 | 36.25 | 37.16 | 34.55 | 35.18 | 38.01 | 35.04 | 36.6 | 36.39 | 36.96 | 35.99 |
| 213827_at | 59.62 | 72.44 | 54.91 | 63.59 | 55.22 | 67.09 | 60.93 | 45.41 | 58.66 | 65.48 | 67.12 | 91.16 | 86.33 |
| 213877_x_at | 87.44 | 73.53 | 76.95 | 83.87 | 75.3 | 94.58 | 85.82 | 81.48 | 93.45 | 90.93 | 101.2 | 100.5 | 102.8 |
| 214045_at | 49.03 | 61.39 | 55.02 | 93.17 | 58.73 | 79.85 | 67.72 | 63.44 | 62.45 | 82.56 | 74.43 | 65.36 | 76.87 |
| 214057_at | 176.1 | 150.6 | 255.6 | 273.5 | 257.6 | 245.5 | 252 | 241.9 | 211.8 | 227.3 | 217.2 | 249.4 | 295.5 |
| 214330_at | 46 | 45.08 | 41.51 | 41.06 | 49.89 | 45.2 | 38.17 | 37.04 | 46.17 | 53.05 | 58.74 | 53.71 | 48.12 |
| 214364_at | 131 | 106.3 | 78 | 102.6 | 89.32 | 105.9 | 102.6 | 72.93 | 84.02 | 59.24 | 186 | 101.5 | 82.06 |
| 214430_at | 400.6 | 429.3 | 415.4 | 428.6 | 433.3 | 364.4 | 406.3 | 414.3 | 352.9 | 411.8 | 379.6 | 402.3 | 410.6 |
| 214511_x_at | 706.5 | 880.6 | 1841 | 900.9 | 976 | 769.3 | 1571 | 1334 | 477.1 | 2083 | 350.4 | 1028 | 2072 |
| 214629_x_at | 5758 | 5587 | 6459 | 6226 | 6314 | 6387 | 6130 | 6855 | 6956 | 5955 | 5602 | 6335 | 6789 |
| 214683_s_at | 3335 | 3603 | 3157 | 3373 | 2947 | 3705 | 3162 | 3742 | 3964 | 2698 | 3279 | 3383 | 3498 |
| 214820_at | 118.6 | 85.92 | 100.3 | 98.79 | 72.94 | 91.34 | 101.8 | 81.35 | 156.3 | 96.02 | 130.4 | 108 | 107.8 |
| 214853_s_at | 470 | 483.3 | 406.3 | 468.4 | 466 | 470.1 | 413.5 | 444.9 | 448.3 | 417.5 | 450 | 394.4 | 465.2 |
| 214931_s_at | 214.6 | 331.6 | 510.4 | 336.9 | 453.2 | 354.7 | 393.3 | 409.8 | 457.3 | 213.1 | 448.9 | 486.7 | 405.3 |
| 214953_s_at | 109.4 | 99.2 | 282.2 | 133.8 | 172.5 | 177.4 | 177.1 | 187.7 | 401.5 | 249.8 | 140.9 | 265.4 | 214.5 |
| 215009_s_at | 594.9 | 488.9 | 425.2 | 501.8 | 448.4 | 591.6 | 501.4 | 478.5 | 527.4 | 563.2 | 525.1 | 624.8 | 570.5 |
| 215049_x_at | 429.6 | 549 | 781.2 | 415.4 | 465.7 | 180.2 | 688.9 | 582.9 | 339.9 | 418.6 | 506.4 | 384.9 | 362.3 |
| 215273_s_at | 498.8 | 529.8 | 502.8 | 481.2 | 534.1 | 576.9 | 467.1 | 502.5 | 575.3 | 550.7 | 571.4 | 540 | 506.1 |
| 215293_s_at | 57.31 | 56.46 | 64.36 | 60.28 | 52.37 | 56.95 | 62.08 | 64.09 | 61.55 | 84.08 | 67.54 | 72.57 | 97.96 |
| 215567_at | 121.1 | 112.8 | 107.6 | 94.26 | 98.18 | 124.1 | 109.8 | 102 | 159 | 134.2 | 120.7 | 120.3 | 146 |
| 215997_s_at | 232.9 | 298.3 | 380.3 | 314 | 344 | 357.8 | 365.5 | 332.1 | 400.8 | 311.6 | 386.8 | 404.7 | 435.4 |
| 216484_x_at | 434.3 | 393 | 405.2 | 432.9 | 503.7 | 370.2 | 402.6 | 439.4 | 410.8 | 397.5 | 340.2 | 404.3 | 402.7 |
| 216950_s_at | 296.8 | 377.3 | 853.2 | 387.8 | 403.7 | 345.7 | 751.2 | 537.6 | 178.7 | 1232 | 168.1 | 579.9 | 1210 |
| 217383_at | 27.13 | 16.23 | 32.86 | 31.27 | 36.73 | 34.83 | 30.88 | 29.48 | 35.12 | 31.55 | 31.76 | 33.81 | 39.81 |
| 217403_s_at | 97.94 | 122.2 | 94.8 | 115 | 92.64 | 105.9 | 84.76 | 99.11 | 144.9 | 98.74 | 111 | 110.6 | 97.94 |
| 217466_x_at | 3203 | 2713 | 2680 | 2536 | 2240 | 2809 | 2860 | 2534 | 2795 | 3807 | 3542 | 2770 | 3098 |
| 217769_s_at | 1435 | 1408 | 1272 | 1275 | 1492 | 1139 | 1206 | 1431 | 1297 | 1671 | 1199 | 1478 | 1352 |
| 217778_at | 200 | 186.1 | 210.8 | 214.6 | 218.8 | 182.7 | 210.4 | 236.4 | 186 | 208.8 | 208.1 | 227.7 | 215.3 |
| 217824_at | 268.5 | 187.2 | 296.7 | 408.7 | 272.6 | 211.3 | 316 | 417.6 | 278.1 | 357.8 | 231.2 | 239.1 | 361 |
| 217987_at | 722.3 | 652.7 | 654.9 | 682.9 | 556.6 | 292.7 | 354.5 | 541.8 | 708.2 | 334 | 834.1 | 761.8 | 454 |
| 217995_at | 1123 | 1481 | 1926 | 1763 | 2068 | 1294 | 1527 | 1819 | 1277 | 1559 | 1526 | 1640 | 1569 |
| 218012_at | 246.2 | 241.3 | 167.1 | 265 | 139.2 | 207.4 | 190.4 | 179.6 | 237.4 | 221 | 318.5 | 146.6 | 232.7 |
| 218040_at | 359.5 | 388.9 | 301.9 | 363.7 | 338.1 | 222.9 | 346.1 | 332.6 | 355.9 | 357.3 | 394.2 | 441.3 | 376.8 |
| 218065_s_at | 1214 | 1200 | 1123 | 1207 | 1126 | 1007 | 1037 | 894.2 | 1196 | 1203 | 1095 | 1044 | 952.6 |
| 218091_at | 489.6 | 453.4 | 698.9 | 552.9 | 510.3 | 412.9 | 469.8 | 542 | 517.4 | 494.4 | 479.7 | 555 | 601.8 |
| 218125_s_at | 79.08 | 58.08 | 56.39 | 73.36 | 41.15 | 59.45 | 62.69 | 57.65 | 74.11 | 67.07 | 69.74 | 60.18 | 87.01 |
| 218127_at | 248.9 | 204.7 | 174 | 226.9 | 217.4 | 240.6 | 188.7 | 206.6 | 274.9 | 242.9 | 305.9 | 311.3 | 291.1 |
| 218143_s_at | 718.5 | 520.4 | 488.6 | 615.3 | 726.8 | 680.9 | 659 | 639.6 | 761.7 | 816.7 | 639.4 | 449.7 | 580.1 |
| 218206_x_at | 355.9 | 426.3 | 366.1 | 388.5 | 408.4 | 354.2 | 359.5 | 357.9 | 364.3 | 437.2 | 414.3 | 373.1 | 366.1 |
| 218289_s_at | 132.4 | 91.9 | 74.61 | 117.4 | 82.17 | 124.5 | 94.78 | 58.2 | 145.2 | 114.7 | 87.8 | 95.25 | 120.3 |
| 218325_s_at | 459.8 | 350.5 | 424.4 | 390.6 | 448.4 | 447.3 | 402.1 | 349.4 | 443.7 | 359.7 | 390.7 | 362.6 | 357.3 |
| 218351_at | 1216 | 972.1 | 1118 | 1076 | 1001 | 905.5 | 1289 | 1105 | 1053 | 1272 | 887.4 | 1132 | 1180 |
| 218499_at | 2501 | 2149 | 1722 | 1982 | 1722 | 2263 | 2134 | 2298 | 2713 | 2443 | 2055 | 2265 | 2201 |
| 218627_at | 344.2 | 292.9 | 468.3 | 352.4 | 422.4 | 273.3 | 330 | 399.5 | 265.8 | 312.3 | 306.8 | 351.2 | 272.6 |
| 218718_at | 197.1 | 97.04 | 159.1 | 119.5 | 246.8 | 69.58 | 191.8 | 182.7 | 74.38 | 114.6 | 122.6 | 174.9 | 134.7 |
| 218732_at | 243.4 | 204.5 | 233.3 | 222 | 218 | 230.8 | 239.5 | 266.2 | 245.1 | 249.7 | 267.3 | 223.1 | 247.2 |
| 218845_at | 1078 | 827.7 | 951.1 | 1111 | 1102 | 872 | 994 | 1202 | 1107 | 851.8 | 1090 | 887.5 | 1087 |
| 218962_s_at | 622.8 | 497 | 459.1 | 444 | 393.8 | 420.9 | 593.6 | 449.8 | 534.5 | 447.5 | 394.9 | 509 | 566.9 |
| 219130_at | 379.7 | 330.3 | 215.8 | 308.7 | 241.1 | 288.2 | 303.3 | 271.7 | 363.9 | 336.2 | 406.1 | 262.6 | 341.6 |
| 219316_s_at | 119.8 | 75.81 | 130.7 | 65.18 | 59.75 | 83.44 | 85.45 | 68.53 | 76.05 | 106.3 | 72.93 | 91.95 | 137.1 |
| 219343_at | 195 | 164.9 | 190.5 | 173.4 | 155 | 248.4 | 169.4 | 167.5 | 219 | 159.7 | 168.6 | 163.9 | 210.9 |
| 219358_s_at | 238.4 | 159.6 | 220 | 169.2 | 269.5 | 127.4 | 226.5 | 172.7 | 129.5 | 414.8 | 170.6 | 224.1 | 177.9 |
| 219418_at | 130.7 | 113.3 | 100.3 | 111.4 | 88.34 | 107.6 | 110.3 | 98.41 | 124.7 | 124.2 | 104.7 | 99.09 | 116.9 |
| 219507_at | 159.5 | 98.39 | 161.8 | 108.8 | 72.7 | 122.3 | 102.3 | 82.43 | 136.3 | 141.2 | 77.63 | 124.4 | 109.3 |
| 219765_at | 73.53 | 85.86 | 42.34 | 66.9 | 43.2 | 72.99 | 62.03 | 50.74 | 69.29 | 47.06 | 59.45 | 56.6 | 59.05 |
| 219787_s_at | 48.74 | 48.75 | 106.4 | 40.77 | 36.07 | 85.67 | 46.54 | 104.3 | 60.36 | 50.54 | 37.18 | 49.6 | 66.09 |
| 219822_at | 143.2 | 188.4 | 138.2 | 197.6 | 169.6 | 142.2 | 153.4 | 146.6 | 210.4 | 179 | 186 | 131.6 | 195 |
| 219826_at | 50.7 | 47.83 | 34.05 | 40.38 | 33.82 | 40.46 | 37.79 | 45.55 | 63.3 | 39.07 | 47.54 | 36.23 | 53.33 |
| 219952_s_at | 157 | 213.2 | 217.4 | 157.3 | 248.3 | 164.5 | 158.7 | 198.8 | 152 | 245.1 | 171.1 | 166.9 | 130.7 |
| 220044_x_at | 5510 | 4566 | 4233 | 4421 | 4199 | 4743 | 4195 | 4468 | 6036 | 5308 | 5029 | 4851 | 5326 |
| 220146_at | 174.3 | 115 | 170.8 | 106.4 | 180.6 | 100.3 | 144.7 | 143.7 | 168.8 | 266.5 | 107.4 | 156.1 | 156 |
| 220160_s_at | 62.33 | 62.11 | 62.82 | 60.54 | 63.4 | 62.01 | 61.04 | 62.4 | 61.87 | 63.38 | 41.08 | 54.82 | 54.86 |
| 220386_s_at | 534.2 | 533.3 | 489.3 | 427.3 | 596.6 | 557.5 | 615.1 | 610.4 | 829 | 551.1 | 710.9 | 543.6 | 661.2 |
| 220578_at | 95.94 | 74.76 | 106.1 | 75.85 | 92.26 | 74.87 | 74.9 | 89.18 | 53.63 | 171.3 | 69.53 | 75.44 | 70.77 |
| 220605_s_at | 156 | 162.9 | 153.7 | 186.2 | 167.3 | 165.2 | 139 | 197.5 | 151.6 | 139.7 | 162.8 | 145.3 | 158.9 |
| 220610_s_at | 109.7 | 138 | 145.4 | 146.7 | 156.1 | 129.2 | 114.5 | 134.1 | 112.3 | 89.65 | 91.34 | 103.5 | 120.7 |
| 220690_s_at | 118.8 | 115.5 | 125.3 | 117.7 | 166.5 | 99.85 | 136.4 | 117 | 86.72 | 118.7 | 141.9 | 123.3 | 98.99 |
| 220750_s_at | 120.4 | 109.8 | 84.95 | 104.2 | 112.2 | 92.41 | 93.61 | 87.99 | 95.7 | 78.57 | 88.39 | 74.29 | 91.32 |
| 220865_s_at | 78.37 | 86.48 | 151.8 | 68.29 | 88.84 | 63.86 | 129.2 | 71.47 | 107.8 | 79.47 | 86.01 | 97.18 | 84.22 |
| 220974_x_at | 225.7 | 256.1 | 202.9 | 229.1 | 213.6 | 189.1 | 209.1 | 191.9 | 171.8 | 239.6 | 185.9 | 190.2 | 205.9 |
| 221011_s_at | 1112 | 874.9 | 647.4 | 880.1 | 350.6 | 1050 | 654.8 | 677.6 | 1399 | 1125 | 1080 | 802.1 | 1158 |
| 221206_at | 209.9 | 201.9 | 172 | 166.5 | 131.5 | 183 | 173.4 | 162.3 | 197.8 | 185.1 | 187.8 | 178 | 162.2 |
| 221264_s_at | 667.1 | 514.3 | 555.1 | 525.3 | 424.5 | 609 | 455.7 | 470.6 | 685.5 | 403.4 | 478.9 | 525.2 | 472.7 |
| 221428_s_at | 866 | 724.8 | 923.3 | 783.5 | 715.1 | 832.1 | 786.5 | 838.7 | 1102 | 833.3 | 1002 | 960.9 | 1172 |
| 221449_s_at | 351.8 | 345.5 | 418.2 | 351.9 | 405.4 | 322 | 365.5 | 324.6 | 397 | 346.8 | 345.5 | 368.9 | 363.7 |
| 221580_s_at | 1157 | 967 | 1047 | 1135 | 892.6 | 1143 | 1089 | 1090 | 1302 | 1121 | 1057 | 1183 | 1252 |
| 221601_s_at | 2752 | 1916 | 1245 | 1856 | 920.8 | 2431 | 1409 | 2338 | 3660 | 2305 | 2599 | 1282 | 2803 |
| 221647_s_at | 457.6 | 533.4 | 424.7 | 541.4 | 516.6 | 492.4 | 476.5 | 479.3 | 459.8 | 378.5 | 451.1 | 380.7 | 414.8 |
| 221731_x_at | 8055 | 7452 | 8412 | 6113 | 8230 | 4427 | 8794 | 6449 | 6557 | 6916 | 7423 | 8170 | 6385 |
| 221757_at | 684.8 | 464.2 | 499.3 | 374.5 | 251.7 | 647.7 | 525.3 | 356.6 | 710 | 477.8 | 714.4 | 254 | 472.7 |
| 221841_s_at | 1424 | 739.5 | 1452 | 843.8 | 1519 | 1049 | 1147 | 1209 | 1069 | 2649 | 1170 | 1336 | 1357 |
| 221868_at | 44.61 | 30.56 | 29.79 | 31.43 | 23.8 | 34.92 | 30.24 | 27.98 | 42.38 | 32.75 | 36.02 | 36.81 | 41.77 |
| 221960_s_at | 45.87 | 36.01 | 96.09 | 60.19 | 73.6 | 93.93 | 84.55 | 73.1 | 75.88 | 53.16 | 70.71 | 84.02 | 104.8 |
| 222217_s_at | 412.3 | 457.3 | 210.9 | 349.1 | 478.8 | 248.1 | 355.9 | 303.5 | 169.4 | 413.2 | 298.9 | 282.1 | 245.7 |
| 222231_s_at | 327.4 | 340.8 | 315.2 | 287.8 | 331.2 | 277.6 | 324 | 275.6 | 279.2 | 291.8 | 317.5 | 338.3 | 304.9 |
| 222574_s_at | 449 | 413.5 | 505.6 | 559.1 | 465.4 | 528.8 | 526.3 | 528.7 | 549 | 406.5 | 518.8 | 517.1 | 553.8 |
| 222605_at | 793.5 | 742.1 | 672.9 | 843.8 | 706.3 | 728.8 | 595.1 | 727.8 | 818.8 | 645.7 | 828.9 | 880.1 | 712.5 |
| 222651_s_at | 414.4 | 312.5 | 302.1 | 281.3 | 289.8 | 237 | 272.6 | 222 | 269.3 | 370.4 | 295.7 | 411.5 | 289.5 |
| 222670_s_at | 735 | 466.1 | 940.7 | 577.2 | 786.3 | 502.5 | 788.8 | 587.2 | 585.8 | 1637 | 652.6 | 641.1 | 833.6 |
| 222688_at | 343 | 257.4 | 317.2 | 266.9 | 349.6 | 272.8 | 302 | 275.8 | 259.4 | 271 | 261.3 | 341.2 | 282.4 |
| 222700_at | 465.6 | 491.3 | 512.7 | 526.9 | 509.2 | 781.1 | 465.9 | 528.8 | 659.6 | 522.6 | 575.4 | 543.2 | 645.2 |
| 222753_s_at | 162.9 | 191.9 | 194.6 | 188.4 | 238.2 | 198.2 | 235.5 | 191.6 | 199.2 | 192.1 | 155 | 204 | 240.4 |
| 222757_s_at | 92.68 | 91.83 | 108.5 | 65.75 | 110.5 | 62.15 | 110.5 | 61.57 | 71.07 | 107.1 | 78.22 | 107.7 | 179.3 |
| 222774_s_at | 40.14 | 57.43 | 49.01 | 40.62 | 73.23 | 46.27 | 36.63 | 46.99 | 50.99 | 59.24 | 58.57 | 66.45 | 37.97 |
| 222884_at | 105.2 | 145 | 99.73 | 131.6 | 107.6 | 106.3 | 96.38 | 108 | 126.3 | 102.6 | 99.77 | 94.19 | 107.6 |
| 222980_at | 2559 | 2196 | 2397 | 2139 | 2675 | 2196 | 2450 | 2367 | 2380 | 2945 | 2235 | 2357 | 2592 |
| 222982_x_at | 3592 | 3482 | 4331 | 3226 | 3283 | 3350 | 3704 | 4312 | 3965 | 3963 | 3614 | 3960 | 3508 |
| 223023_at | 345.4 | 345.7 | 271.7 | 308.2 | 255.3 | 300.8 | 248.5 | 291.4 | 268 | 273.8 | 442.4 | 240.1 | 314.2 |
| 223064_at | 1388 | 1485 | 1388 | 1433 | 1573 | 1159 | 1399 | 1364 | 1199 | 1557 | 1621 | 1373 | 1299 |
| 223158_s_at | 93.95 | 135.5 | 146.4 | 111.3 | 123 | 146.1 | 155.7 | 150.4 | 144 | 98.21 | 128.1 | 97.35 | 140 |
| 223380_s_at | 259.9 | 287.2 | 338.9 | 288.8 | 267 | 400.4 | 282.4 | 400.3 | 292.6 | 227.6 | 296.9 | 328.7 | 296.9 |
| 223444_at | 920.4 | 791 | 758.4 | 753.8 | 511 | 697.3 | 847.8 | 818.2 | 1072 | 607 | 554.5 | 819 | 819.9 |
| 223465_at | 323.1 | 347.6 | 600.4 | 303.8 | 347 | 439.4 | 482.5 | 593 | 605.4 | 433.1 | 382.8 | 609.1 | 493.5 |
| 223590_at | 447.9 | 521.1 | 361 | 450.2 | 361.4 | 395.1 | 382.8 | 419.5 | 513.5 | 424.9 | 369.5 | 527.1 | 410.5 |
| 223686_at | 204.9 | 201.9 | 197.2 | 201.5 | 234.9 | 213.4 | 184.1 | 212.8 | 201.6 | 266.3 | 237.5 | 214.5 | 241.3 |
| 223801_s_at | 30.55 | 31.4 | 30.95 | 30.73 | 31.37 | 29.41 | 30.65 | 36.33 | 30.24 | 29.91 | 30.36 | 31.46 | 30.3 |
| 223922_x_at | 2386 | 1982 | 2871 | 1884 | 2492 | 1845 | 1943 | 2007 | 1903 | 2267 | 2028 | 2713 | 2275 |
| 223982_s_at | 927.1 | 1021 | 1064 | 1025 | 944.8 | 1099 | 1116 | 1044 | 1115 | 1149 | 932.4 | 1240 | 1191 |
| 224046_s_at | 342 | 346.1 | 433.3 | 375.9 | 385.6 | 401 | 371.3 | 368.8 | 665.4 | 370.7 | 529.1 | 447.5 | 455.8 |
| 224374_s_at | 568 | 507.6 | 523.2 | 361.8 | 527.2 | 361.9 | 472.5 | 421.4 | 469.5 | 613.8 | 500.5 | 414 | 458.6 |
| 224387_at | 60.41 | 81.77 | 78.25 | 81.74 | 74.33 | 59.85 | 72.27 | 62.52 | 62.29 | 74.99 | 64.14 | 95.9 | 73.1 |
| 224439_x_at | 511.6 | 522.9 | 472.8 | 443.3 | 464.4 | 378.3 | 443.8 | 457.2 | 479.3 | 535.6 | 376.7 | 451.3 | 483.1 |
| 224518_s_at | 344.7 | 304.9 | 207.7 | 304.9 | 137.6 | 298.7 | 234.8 | 254.8 | 329.6 | 295.9 | 355 | 287.6 | 274.8 |
| 224582_s_at | 492.9 | 346.1 | 246.8 | 392.7 | 246.3 | 310.5 | 274.6 | 236.2 | 372 | 405.5 | 349.7 | 304.6 | 350 |
| 224591_at | 3326 | 3083 | 2321 | 2835 | 2385 | 3166 | 2683 | 2742 | 3776 | 3096 | 2904 | 3188 | 3238 |
| 224726_at | 223.9 | 121.5 | 254.1 | 152.2 | 126.4 | 199.6 | 180.8 | 199.1 | 268.9 | 187.6 | 185 | 245.2 | 226.1 |
| 224818_at | 773.4 | 630 | 756.9 | 682.1 | 985.4 | 485.1 | 733.7 | 656.7 | 475 | 789.4 | 687.1 | 731.4 | 631.9 |
| 224917_at | 2485 | 2543 | 3197 | 2030 | 3607 | 1837 | 2512 | 2763 | 2061 | 2081 | 2070 | 3115 | 2501 |
| 224918_x_at | 582.8 | 413.8 | 620.7 | 396.8 | 711.3 | 222.4 | 623.2 | 511.2 | 441 | 362.5 | 519.8 | 539.5 | 581 |
| 224928_at | 344.6 | 230.9 | 333.5 | 222.4 | 272.2 | 222.1 | 290.7 | 347.4 | 300.1 | 263.5 | 235.5 | 272.2 | 290.2 |
| 225059_at | 1196 | 1561 | 1668 | 1403 | 1814 | 976.7 | 1301 | 1275 | 1053 | 1412 | 1606 | 1527 | 1168 |
| 225064_at | 397.1 | 403.9 | 327.3 | 465.3 | 360.5 | 404.1 | 267.1 | 420.3 | 526.5 | 588.1 | 434.2 | 383.6 | 453.8 |
| 225107_at | 3034 | 2784 | 2301 | 3067 | 2444 | 2852 | 2519 | 2819 | 3172 | 2651 | 2774 | 2579 | 2635 |
| 225188_at | 67.6 | 63.36 | 79.93 | 21.16 | 92.52 | 23.42 | 74.7 | 53.61 | 101.6 | 97.35 | 61.05 | 39.91 | 73.17 |
| 225341_at | 56.97 | 64.84 | 45.89 | 104.6 | 47.46 | 69.28 | 45.7 | 54.92 | 73.75 | 21.46 | 40.22 | 50.76 | 63.66 |
| 225358_at | 112.7 | 83.26 | 89.95 | 122.4 | 91.48 | 103.7 | 101.6 | 74.35 | 126.7 | 102.4 | 101.2 | 95.04 | 113 |
| 225365_at | 2915 | 2050 | 2399 | 1784 | 1714 | 2310 | 2536 | 2288 | 2645 | 2745 | 2121 | 2876 | 2654 |
| 225388_at | 44.12 | 47.8 | 42 | 40.54 | 28.95 | 43 | 32.84 | 45.36 | 43.71 | 45.67 | 34.47 | 45.13 | 51.72 |
| 225456_at | 405.3 | 376.8 | 314.8 | 336.9 | 319 | 325.2 | 288.7 | 292.5 | 408.1 | 352.8 | 330.1 | 355.6 | 396.9 |
| 225763_at | 2739 | 3106 | 3270 | 2855 | 3992 | 2805 | 3041 | 3090 | 3081 | 2947 | 3614 | 3248 | 2683 |
| 225844_at | 250.8 | 233.4 | 265.3 | 209.7 | 252.9 | 178.1 | 208.9 | 193.2 | 234.3 | 296.2 | 211.6 | 200.8 | 224 |
| 225866_at | 160.9 | 73.72 | 97.08 | 104.3 | 96.49 | 102 | 98.64 | 90.34 | 139.1 | 118.8 | 111.7 | 102.3 | 180.4 |
| 225870_s_at | 565.1 | 671.3 | 790.8 | 597.9 | 763.5 | 579.5 | 836.1 | 864.6 | 489.3 | 685.7 | 845 | 596.3 | 579.1 |
| 226000_at | 30.33 | 24.24 | 27.75 | 27.25 | 28.23 | 19.01 | 33.68 | 27.17 | 37.42 | 29.57 | 24.97 | 36.63 | 29.98 |
| 226030_at | 138.1 | 121.1 | 130 | 159.9 | 99.34 | 134.9 | 106.5 | 79.22 | 137.1 | 139.1 | 109.8 | 114.9 | 122.7 |
| 226042_at | 100.6 | 87.2 | 72.63 | 107.3 | 74.62 | 98.21 | 99.57 | 85.74 | 106.8 | 96.72 | 92.75 | 91.59 | 101.6 |
| 226059_at | 59.82 | 45.76 | 62.82 | 79.21 | 55.18 | 43.95 | 57.25 | 44.56 | 34.47 | 45.9 | 39.15 | 45.83 | 70.68 |
| 226115_at | 228.1 | 226.1 | 361.7 | 339 | 262.7 | 275.6 | 223.9 | 294.8 | 280.9 | 159.1 | 359.7 | 349.1 | 293.2 |
| 226127_at | 100 | 102.9 | 82.25 | 98.25 | 88.11 | 83.64 | 82.74 | 85.32 | 85.05 | 88.88 | 87.18 | 92.68 | 93.76 |
| 226218_at | 6905 | 4758 | 4163 | 5273 | 1711 | 8111 | 4626 | 3854 | 10346 | 2201 | 6905 | 5181 | 7243 |
| 226220_at | 83.84 | 86.53 | 182.1 | 104 | 123.7 | 119.2 | 101.4 | 97.85 | 132.7 | 86.16 | 98.56 | 117.4 | 129 |
| 226323_at | 536.1 | 539 | 565.7 | 579.5 | 529.4 | 553 | 497.6 | 538.4 | 593.1 | 469.7 | 574.3 | 608.7 | 674.1 |
| 226353_at | 879.7 | 978.3 | 1117 | 1015 | 1049 | 1147 | 1108 | 1277 | 1044 | 1134 | 979.4 | 1066 | 1109 |
| 226428_at | 214.5 | 217.9 | 166.8 | 195.8 | 194 | 151.6 | 201.8 | 178.1 | 110.9 | 192.2 | 222.3 | 167 | 179.1 |
| 226459_at | 1989 | 2034 | 2659 | 2143 | 3001 | 1448 | 2294 | 2360 | 1860 | 3375 | 2176 | 2188 | 2529 |
| 226503_at | 272.1 | 225.7 | 226.5 | 204.7 | 229.8 | 251.7 | 225.9 | 264 | 287.7 | 214.3 | 243.7 | 239.3 | 203.9 |
| 226683_at | 2306 | 2372 | 2888 | 2825 | 2453 | 2095 | 2868 | 2403 | 2239 | 2299 | 2441 | 2546 | 2629 |
| 226718_at | 114.4 | 76.78 | 69.09 | 100 | 62.52 | 86.65 | 85.23 | 66.03 | 156.1 | 67.48 | 85.05 | 59.61 | 96.49 |
| 226763_at | 175.2 | 129.4 | 207.1 | 180.5 | 186 | 170.9 | 146.4 | 200.6 | 236.7 | 349.4 | 114 | 245 | 232.3 |
| 226836_at | 30.37 | 32.26 | 34.41 | 33.94 | 38.16 | 33.79 | 34.62 | 34.05 | 32.07 | 31.21 | 30.51 | 36.07 | 34.85 |
| 227020_at | 1018 | 868.2 | 954 | 815.3 | 766.3 | 750.8 | 862.1 | 774.2 | 833.1 | 923.3 | 676.6 | 904.3 | 818.2 |
| 227114_at | 103.5 | 127.4 | 100.6 | 100.6 | 101.4 | 90.29 | 96.34 | 102.7 | 119.5 | 87.85 | 121.8 | 102 | 129.3 |
| 227149_at | 78.63 | 99.73 | 70.84 | 87.8 | 58.81 | 101.3 | 69.81 | 51.69 | 90.55 | 73.42 | 77.45 | 73.36 | 79.75 |
| 227173_s_at | 151.1 | 98.72 | 106.8 | 88.22 | 51.72 | 115.3 | 84.33 | 136.6 | 277 | 197.5 | 141.2 | 71.07 | 149.6 |
| 227213_at | 107.1 | 62.77 | 52.59 | 91.34 | 52.34 | 62.23 | 57.75 | 49.44 | 73.26 | 96.57 | 72.51 | 55.7 | 73.89 |
| 227374_at | 79.55 | 49.57 | 47.43 | 60.79 | 41.85 | 58.22 | 51.59 | 47.62 | 62.28 | 56.55 | 66.39 | 50.47 | 71.12 |
| 227517_s_at | 675 | 499.2 | 327.9 | 506.2 | 311.2 | 564.3 | 436.5 | 461.8 | 601.7 | 494.3 | 494.2 | 348.8 | 547.9 |
| 227558_at | 1199 | 1193 | 1192 | 1344 | 1157 | 1355 | 1169 | 972.1 | 1362 | 1178 | 1191 | 1359 | 1142 |
| 227560_at | 83.29 | 89.69 | 88.08 | 76.86 | 96.4 | 110.4 | 108.2 | 71.51 | 113.2 | 102.8 | 130.7 | 91.77 | 89.6 |
| 227722_at | 334.2 | 158.3 | 70.36 | 305.7 | 44.82 | 36.29 | 290 | 157.2 | 48.19 | 83.11 | 219.4 | 5624 | 132.2 |
| 227990_at | 776.5 | 847.1 | 930.1 | 1117 | 900.4 | 1118 | 1080 | 966 | 993.2 | 1081 | 788.5 | 938.7 | 1069 |
| 228012_at | 30.71 | 27.52 | 25.17 | 42.58 | 20.39 | 33.77 | 33.3 | 24.25 | 34.03 | 31.58 | 44.27 | 31.24 | 33.03 |
| 228170_at | 1148 | 577.7 | 600.3 | 392 | 1345 | 354.6 | 881.5 | 448.1 | 609.8 | 375.5 | 345.5 | 638.4 | 465.9 |
| 228176_at | 249.6 | 197.7 | 446.4 | 334.5 | 461.6 | 109.8 | 248.3 | 353.6 | 291 | 235.5 | 351 | 500.6 | 267 |
| 228234_at | 400.8 | 318.6 | 439.2 | 327.7 | 521.9 | 242.8 | 391.7 | 342.2 | 278.9 | 403.4 | 291.7 | 398.3 | 396.6 |
| 228370_at | 309.3 | 183.9 | 125.1 | 211.7 | 85.72 | 230 | 134.2 | 166.9 | 379.2 | 137.9 | 142.2 | 138.5 | 199.2 |
| 228549_at | 717 | 449.3 | 477.1 | 529.7 | 401.3 | 407.7 | 467.4 | 422.7 | 802.6 | 325.2 | 451.6 | 404.4 | 523.3 |
| 228630_at | 137.7 | 116.5 | 95.15 | 102.3 | 77.36 | 138.3 | 84.48 | 79.67 | 176.1 | 83.02 | 134.8 | 83.47 | 162.9 |
| 228831_s_at | 151.8 | 166.1 | 195.8 | 116.3 | 133.4 | 220.1 | 176.9 | 253.5 | 142.9 | 182.8 | 218.2 | 77.34 | 176.9 |
| 229307_at | 67.69 | 32.52 | 75.26 | 23.63 | 24.06 | 82.29 | 59.45 | 42.86 | 35.22 | 32.01 | 37.4 | 56.25 | 52.06 |
| 229421_s_at | 24.64 | 40.34 | 81.75 | 35.71 | 42.64 | 47.62 | 44.17 | 60.16 | 51.55 | 27.42 | 36.01 | 43.55 | 48.32 |
| 229509_at | 227.3 | 226.5 | 213.2 | 270.9 | 226 | 301.9 | 268 | 218.6 | 219.7 | 278 | 263.9 | 236.8 | 233.5 |
| 229854_at | 25.03 | 24.63 | 31.66 | 24.94 | 25.41 | 22.87 | 24.89 | 24.77 | 31.19 | 26.26 | 25.45 | 24.88 | 29.13 |
| 229982_at | 124.9 | 58.79 | 111.5 | 81.77 | 67.52 | 100 | 89.76 | 118.3 | 188.4 | 141 | 94.65 | 149.4 | 137.8 |
| 230265_at | 138.5 | 113.9 | 246.1 | 140.2 | 177.8 | 165.2 | 191.3 | 266 | 250.1 | 156.8 | 173.6 | 192.3 | 252.4 |
| 230320_at | 187.3 | 140.9 | 142.7 | 141.9 | 121.9 | 104.2 | 130.3 | 121.4 | 163.7 | 130.3 | 158.3 | 144.4 | 153.2 |
| 230408_at | 121.2 | 99.95 | 76.3 | 128.7 | 86.86 | 105.7 | 90.3 | 84.61 | 105.7 | 93.76 | 99.57 | 78.29 | 110.4 |
| 230480_at | 63.61 | 49.3 | 67.21 | 58.3 | 59.5 | 56.99 | 48.26 | 40.73 | 49.65 | 89.18 | 60.49 | 49.21 | 71.99 |
| 230837_at | 61.24 | 71.92 | 80.18 | 74.67 | 71.73 | 72.46 | 67.6 | 69.57 | 72.14 | 84.66 | 85.52 | 95.45 | 80.48 |
| 230852_at | 52.97 | 46.1 | 46.43 | 46.28 | 65.25 | 46.06 | 46.24 | 46.24 | 40.97 | 53.37 | 44.1 | 52.41 | 38.32 |
| 230922_x_at | 35.25 | 43.23 | 38.84 | 43.48 | 48.78 | 43.12 | 55.04 | 42 | 40.19 | 62.14 | 54.65 | 49.96 | 44.55 |
| 231283_at | 201.6 | 202.5 | 213.7 | 232.6 | 180.7 | 261.7 | 204.8 | 196.9 | 328.9 | 165.6 | 300.9 | 229.8 | 282.4 |
| 231697_s_at | 58.92 | 49.64 | 123.1 | 67.66 | 65.53 | 59.02 | 65.04 | 69.24 | 53.71 | 69.46 | 52.09 | 84.1 | 64.13 |
| 231836_at | 87.89 | 62.45 | 55.44 | 63.3 | 65.04 | 56.12 | 63.45 | 63 | 83.87 | 65.48 | 61.81 | 73.17 | 72.2 |
| 231843_at | 189.8 | 212.9 | 185.9 | 189.5 | 174.5 | 208.3 | 189.1 | 169 | 205.3 | 162.3 | 180.9 | 155.2 | 180.7 |
| 231845_at | 178.5 | 106.2 | 83.89 | 118.2 | 96.34 | 112.9 | 112.1 | 81.42 | 120.4 | 106 | 144.8 | 150.3 | 134.7 |
| 231904_at | 380.9 | 374 | 379.7 | 390.9 | 326.1 | 368.7 | 389.2 | 456.6 | 337.9 | 329.8 | 468.6 | 383.1 | 392.6 |
| 231914_at | 47.8 | 47.58 | 44.12 | 43.55 | 59.3 | 45.04 | 55.34 | 47.96 | 47.32 | 49.11 | 46.17 | 34.58 | 53.57 |
| 232636_at | 90.64 | 53.32 | 108.4 | 66.01 | 107.7 | 58.87 | 86.67 | 68.89 | 79.63 | 71.75 | 47.78 | 78.71 | 107.8 |
| 232851_at | 38.41 | 37.91 | 37.69 | 41.95 | 41.48 | 42.19 | 35.67 | 42.8 | 40.74 | 48.4 | 57.67 | 49.01 | 44.78 |
| 233019_at | 330.6 | 307 | 283.9 | 320.8 | 254.1 | 365.7 | 338.7 | 272.5 | 355.2 | 312.4 | 313.7 | 272.8 | 378.3 |
| 233169_at | 72.23 | 50.03 | 103.5 | 86.65 | 85.86 | 101.5 | 89.93 | 97.33 | 80.73 | 149.6 | 129.5 | 103 | 94.13 |
| 234013_at | 135.7 | 107.6 | 78.97 | 784.8 | 39 | 106.5 | 89.07 | 90.29 | 260.5 | 98.45 | 155.1 | 169.3 | 59.76 |
| 234311_s_at | 192.1 | 132.8 | 94.43 | 176.8 | 148.8 | 163.5 | 139.8 | 101.5 | 154.7 | 185.5 | 262.1 | 151.6 | 163.6 |
| 234339_s_at | 2430 | 1989 | 1600 | 2058 | 1175 | 2002 | 1669 | 1682 | 2320 | 2157 | 2416 | 1348 | 2156 |
| 234464_s_at | 36.61 | 30.91 | 36.84 | 37.2 | 35.21 | 51.06 | 25.61 | 34.75 | 37.95 | 30.9 | 30.18 | 54.16 | 27.03 |
| 234733_s_at | 23.31 | 33.02 | 27.97 | 27.81 | 25.39 | 27.66 | 21.42 | 25.34 | 28.05 | 27.81 | 37.5 | 40.28 | 28.1 |
| 235024_at | 98.02 | 93.72 | 84.22 | 104.4 | 95.17 | 125 | 98.74 | 93.59 | 106.9 | 91.41 | 115.8 | 93.59 | 109.1 |
| 235067_at | 890.9 | 1298 | 821.4 | 966.8 | 991 | 876.3 | 986.8 | 1048 | 911.4 | 788 | 840 | 801.8 | 709.5 |
| 235200_at | 126 | 162.9 | 113.6 | 109.6 | 111.9 | 145.7 | 113.9 | 108.1 | 128.1 | 110.9 | 131.8 | 115.8 | 116.3 |
| 235359_at | 393.6 | 259.6 | 254.9 | 283.2 | 336 | 262 | 371.4 | 289.4 | 316.7 | 397.6 | 206.3 | 277 | 316.5 |
| 235593_at | 653.4 | 449 | 879.7 | 598 | 591.1 | 926.4 | 634.3 | 727.1 | 716.5 | 872 | 498.4 | 871.3 | 707.9 |
| 235610_at | 82.33 | 42.63 | 40.06 | 72.8 | 53.17 | 67.2 | 65.41 | 42.27 | 65.59 | 60.67 | 55.08 | 68.64 | 133.1 |
| 235623_at | 29.08 | 27.42 | 23.19 | 27.28 | 19.05 | 29.43 | 25.57 | 27 | 26.42 | 29.05 | 32.72 | 28.64 | 27.35 |
| 235690_at | 33.99 | 25.35 | 21.19 | 22.96 | 24.56 | 22.03 | 22.67 | 22.42 | 29.52 | 26.17 | 35.3 | 22.04 | 48.85 |
| 237504_at | 80.68 | 90.45 | 59.5 | 76.05 | 74.83 | 74.77 | 63.48 | 80.1 | 92.21 | 78.51 | 80.11 | 61.28 | 92.64 |
| 238429_at | 3498 | 4192 | 4252 | 4258 | 4374 | 4191 | 2517 | 4609 | 3745 | 2461 | 4742 | 4400 | 4209 |
| 238513_at | 462.5 | 1124 | 2109 | 898.1 | 1430 | 779.5 | 1075 | 2442 | 1237 | 648.8 | 454.6 | 1336 | 514.8 |
| 238736_at | 275.8 | 344 | 269.7 | 235.3 | 177.1 | 315.8 | 252.7 | 178 | 279.4 | 198.2 | 203.2 | 214.5 | 306.2 |
| 238823_at | 55.76 | 47.66 | 47.29 | 50.26 | 54.7 | 45.77 | 58.67 | 62.68 | 63.3 | 34.68 | 44.35 | 51.75 | 48.65 |
| 238909_at | 190.1 | 122.4 | 177.4 | 131.5 | 108.6 | 286.7 | 163.5 | 223.6 | 247.1 | 158.3 | 122.4 | 165.4 | 152.1 |
| 239108_at | 156.8 | 193.2 | 348.4 | 225.1 | 201.4 | 449.3 | 220.6 | 369.9 | 222.8 | 158 | 191.5 | 211 | 250.1 |
| 239897_at | 211.8 | 207.8 | 223.1 | 207.9 | 157.6 | 256.6 | 242.2 | 260.6 | 216.7 | 154.6 | 214.5 | 203.5 | 226.5 |
| 241368_at | 198.5 | 341.3 | 356.6 | 344.4 | 337.3 | 259.9 | 324.2 | 401 | 238.1 | 202.5 | 250.8 | 263.2 | 303.4 |
| 241704_x_at | 64.19 | 60.26 | 44.64 | 44.93 | 36.12 | 53.18 | 66.23 | 52.55 | 75.29 | 41.3 | 53.76 | 58.54 | 66.91 |
| 241706_at | 127.8 | 93.82 | 148 | 100.6 | 122.1 | 128.9 | 118.2 | 123.8 | 116.9 | 192 | 113.7 | 166.2 | 118.2 |
| 241731_x_at | 50.02 | 63.38 | 47.14 | 50.54 | 54.63 | 52.05 | 51.9 | 47.49 | 62.56 | 79.75 | 52.2 | 55.15 | 65.98 |
| 242197_x_at | 88.79 | 10.48 | 151.8 | 35.76 | 12.17 | 37.94 | 59.02 | 44.99 | 56.95 | 100.2 | 48.55 | 233.7 | 115 |
| 242561_at | 19.73 | 24.31 | 22.53 | 24.86 | 24.7 | 25.75 | 31.44 | 33.1 | 24.62 | 24.75 | 31.34 | 27.74 | 23.3 |
| 242569_at | 183.5 | 288.5 | 252.1 | 294.3 | 261.2 | 297.5 | 261.2 | 228.7 | 186 | 195.3 | 225.5 | 263.8 | 251.4 |
| 242669_at | 251.8 | 201.6 | 222.2 | 198.1 | 181.2 | 229.8 | 162.5 | 228.2 | 311.9 | 231.7 | 212.9 | 234 | 335.9 |
| 243982_at | 131.5 | 140 | 75.32 | 113.8 | 69.21 | 131.2 | 111.3 | 89.37 | 102.4 | 85.18 | 98.93 | 127 | 111.9 |
| 244038_at | 77.07 | 44.74 | 42.3 | 50.34 | 46.43 | 51.1 | 48.8 | 42.64 | 92.32 | 62.74 | 61.17 | 46.01 | 46.01 |
| 244654_at | 2283 | 2890 | 1321 | 2386 | 1897 | 2363 | 1870 | 2039 | 1664 | 2606 | 1542 | 1346 | 1514 |
| 244698_at | 33.22 | 33.33 | 32.66 | 34.45 | 43.18 | 32.42 | 33.44 | 32.34 | 33.02 | 33.79 | 37.73 | 38.03 | 32.36 |
| 36566_at | 134.6 | 102.1 | 139 | 116.2 | 124.8 | 148.5 | 119.8 | 111.3 | 113.1 | 108.4 | 113.1 | 107.8 | 120.7 |
| 37549_g_at | 49.63 | 41.19 | 43.26 | 47.54 | 45.16 | 45.16 | 41.26 | 39.22 | 43.41 | 50.1 | 43.55 | 47.11 | 50.42 |
| 48659_at | 232.6 | 234.6 | 231.1 | 205.9 | 241 | 188.5 | 188.6 | 232.9 | 167.7 | 225.3 | 208.8 | 193.4 | 232.7 |
| 56829_at | 178.3 | 172.1 | 152.2 | 155.8 | 187.3 | 152.4 | 163.8 | 142.4 | 128.7 | 154.6 | 202.8 | 131.8 | 155.2 |
| 64486_at | 220.5 | 231.5 | 256.3 | 211.9 | 290.8 | 182.2 | 245.2 | 237.8 | 196.9 | 281.9 | 264.9 | 185.7 | 234.8 |
| 65493_at | 42.82 | 45.19 | 43.43 | 38.57 | 41.02 | 39.66 | 43.25 | 36.28 | 41.86 | 62.57 | 37.86 | 51.59 | 98.61 |
| AFFX- | 10205 | 10412 | 10280 | 8100 | 10083 | 8336 | 9675 | 9374 | 8642 | 8814 | 9104 | 9579 | 9275 |
| HUMGAPDH/M33197_3_at | | | | | | | | | | | | | |
| | NYHA I-II | NYHA I-II | NYHA I-II | NYHA I-II | NYHA I-II | NYHA I-II | NYHA I-II | NYHA I-II | NYHA I-II | NYHA I-II | NYHA I-II | NYHA I-II | NYHA I-II |
| Affymetrix Probe | Sample | Sample | Sample | Sample | Sample | Sample | Sample | Sample | Sample | Sample | Sample | Sample | Sample |
| set ID | no. 93 | no. 17 | no. 18 | no. 20 | no. 24 | no. 28 | no. 36 | no. 37 | no. 39 | no. 48 | no. 50 | no. 53 | no. 55 |
| 1552318_at | 1128 | 1519 | 1819 | 2180 | 1491 | 1219 | 1614 | 1546 | 1631 | 1312 | 1665 | 1644 | 1288 |
| 1552630_a_at | 118.1 | 64.04 | 40.61 | 80.79 | 88.2 | 71.96 | 74.82 | 88.22 | 88.25 | 55.25 | 89.67 | 81.34 | 75.7 |
| 1554149_at | 679.4 | 708.6 | 516.8 | 713.2 | 550.3 | 629.9 | 649.9 | 606.9 | 758.8 | 617.2 | 693.9 | 588 | 505.4 |
| 1554539_a_at | 61.51 | 74.48 | 63.19 | 97.92 | 86.06 | 62.58 | 82.56 | 112.3 | 112 | 46.87 | 69.72 | 170.9 | 78.02 |
| 1554606_at | 81.58 | 98.62 | 79.99 | 102.3 | 107.9 | 119 | 111.9 | 143.9 | 175.3 | 81.72 | 136.9 | 157.4 | 98.41 |
| 1555630_a_at | 164.1 | 130.9 | 138 | 126.6 | 175 | 118.4 | 160.4 | 156.8 | 118.1 | 102.9 | 251.1 | 111.1 | 210.3 |
| 1555963_x_at | 46.14 | 45.96 | 49.56 | 45.31 | 33.64 | 59.02 | 35.47 | 36.26 | 45.86 | 80.24 | 39.01 | 39.53 | 61.43 |
| 1555996_s_at | 789.9 | 830.3 | 605.9 | 1031 | 692.4 | 664.1 | 699.5 | 1265 | 1204 | 625 | 1073 | 964.7 | 889.8 |
| 1556113_at | 40.96 | 54.42 | 41.53 | 40.95 | 39.12 | 45.75 | 39.99 | 38.99 | 39.16 | 46.8 | 42.82 | 42.47 | 33.01 |
| 1556283_s_at | 123.3 | 137.4 | 115.3 | 111.9 | 121.2 | 101.1 | 100.1 | 109.4 | 160.5 | 104.7 | 165.8 | 104.2 | 116.7 |
| 1556864_at | 47.44 | 46.94 | 54.39 | 46.4 | 47.2 | 42.43 | 46.71 | 56.33 | 62.42 | 39.82 | 48.02 | 47.37 | 46.94 |
| 1557066_at | 138.9 | 149.1 | 139.1 | 158.1 | 87.01 | 118.7 | 155.1 | 169 | 168.1 | 110.2 | 155.5 | 199.4 | 143 |
| 1558277_at | 71.05 | 40.3 | 51.7 | 54.39 | 40.99 | 59.92 | 32.16 | 37.74 | 22.76 | 30.7 | 28.75 | 58.1 | 28.93 |
| 1558755_x_at | 91.14 | 129.7 | 158.6 | 187.6 | 282 | 75.66 | 165 | 199.3 | 125.3 | 81.96 | 121.2 | 205.7 | 202.2 |
| 1561146_at | 65.3 | 44.66 | 64.13 | 65.11 | 62.39 | 65.76 | 62.01 | 71.65 | 80.41 | 29.26 | 63.7 | 54.13 | 87.73 |
| 1564962_at | 29.08 | 28.34 | 30.88 | 33.16 | 30.68 | 29.31 | 27.82 | 35.01 | 36.15 | 27 | 26.56 | 43.42 | 29.24 |
| 1567013_at | 101.7 | 94.56 | 104.4 | 88.39 | 89.72 | 103.1 | 86.19 | 127.6 | 163.2 | 112.1 | 105.9 | 96.45 | 130.7 |
| 1568815_a_at | 102.1 | 130.6 | 114.1 | 164.9 | 130 | 123 | 119.6 | 127 | 136.8 | 71.96 | 129.2 | 153.1 | 142.1 |
| 200007_at | 8194 | 8337 | 7009 | 7642 | 7698 | 7440 | 8068 | 6951 | 7388 | 8691 | 7983 | 8130 | 6570 |
| 200010_at | 11003 | 12197 | 13901 | 14737 | 12212 | 10467 | 12272 | 13292 | 14041 | 12335 | 12926 | 12257 | 10797 |
| 200059_s_at | 10812 | 9889 | 10363 | 10081 | 9543 | 10318 | 9712 | 10870 | 11189 | 12147 | 10988 | 9934 | 11118 |
| 200091_s_at | 16931 | 20708 | 19100 | 24760 | 19722 | 19270 | 19556 | 19078 | 19925 | 13489 | 19633 | 20249 | 17628 |
| 200633_at | 8658 | 9632 | 7366 | 9172 | 8067 | 7366 | 9404 | 8841 | 9658 | 8754 | 9381 | 9119 | 6902 |
| 200650_s_at | 5959 | 6513 | 5159 | 5810 | 5045 | 5387 | 5476 | 4973 | 5900 | 5224 | 4743 | 4865 | 4460 |
| 200672_x_at | 111 | 95.94 | 125.7 | 193.2 | 118.7 | 106.4 | 174.7 | 143.9 | 155.8 | 136.6 | 205.1 | 141.1 | 127.1 |
| 200677_at | 2936 | 2202 | 2439 | 2339 | 2888 | 2956 | 3079 | 3074 | 3205 | 3110 | 2764 | 2269 | 2508 |
| 200713_s_at | 1498 | 1475 | 1183 | 1407 | 1403 | 1511 | 1473 | 1464 | 1696 | 1804 | 1593 | 1118 | 1444 |
| 200822_x_at | 1249 | 1185 | 1474 | 1300 | 1157 | 1417 | 1236 | 1125 | 1389 | 1580 | 1364 | 1102 | 1301 |
| 200829_x_at | 569.8 | 713.8 | 545.3 | 660.7 | 494.2 | 525.5 | 631.3 | 532.3 | 620.3 | 531 | 626.1 | 534.8 | 460.7 |
| 200839_s_at | 3469 | 3375 | 2637 | 2912 | 3261 | 3511 | 3508 | 2648 | 3539 | 2676 | 3755 | 2540 | 3487 |
| 200932_s_at | 486.1 | 461.2 | 460.6 | 473.2 | 545 | 463.7 | 481.6 | 510.5 | 509.1 | 415.6 | 514.3 | 470 | 414.5 |
| 200950_at | 577.6 | 427.8 | 438.3 | 510.4 | 542 | 549.9 | 525.5 | 569.2 | 647.4 | 575.2 | 547.9 | 501.7 | 631.8 |
| 201031_s_at | 8783 | 10823 | 6909 | 8792 | 7696 | 7639 | 8344 | 8685 | 9846 | 6642 | 9179 | 9679 | 6674 |
| 201075_s_at | 283.5 | 258 | 256.1 | 258.3 | 283.8 | 276.7 | 289.2 | 347 | 389.3 | 249.1 | 272.5 | 307.1 | 306.2 |
| 201098_at | 868.6 | 916.5 | 833.8 | 840 | 707.2 | 721.3 | 722.4 | 804.9 | 881.8 | 894.4 | 787.9 | 628.4 | 729.3 |
| 201105_at | 3475 | 4629 | 3463 | 3838 | 3027 | 4340 | 5811 | 3756 | 4769 | 3704 | 4096 | 2787 | 2001 |
| 201172_x_at | 3581 | 3459 | 3685 | 3447 | 3691 | 3608 | 3590 | 3864 | 3270 | 4248 | 3329 | 3112 | 3541 |
| 201186_at | 754.5 | 398.3 | 509.4 | 491.3 | 502.6 | 567.3 | 462.5 | 633.3 | 482.5 | 600.9 | 623.2 | 444.7 | 499 |
| 201193_at | 557.3 | 670.9 | 475 | 797.8 | 582.6 | 567.8 | 670.9 | 545.4 | 571.9 | 563.2 | 663.1 | 508.1 | 480.8 |
| 201198_s_at | 161.1 | 178.1 | 169.8 | 181.8 | 131.4 | 168.5 | 172 | 139.6 | 182.5 | 156.3 | 178.1 | 136 | 134.8 |
| 201220_x_at | 1474 | 1517 | 1658 | 1698 | 1674 | 2286 | 1581 | 1622 | 1963 | 2200 | 1431 | 1788 | 1570 |
| 201234_at | 1617 | 1245 | 1199 | 1403 | 1112 | 1345 | 1354 | 1356 | 1376 | 1496 | 1299 | 1246 | 1217 |
| 201357_s_at | 342.2 | 229.6 | 316.8 | 288.2 | 267.8 | 342.6 | 284.3 | 400.4 | 370.4 | 358.3 | 242.1 | 353.5 | 421.5 |
| 201363_s_at | 1555 | 1193 | 1529 | 1360 | 1480 | 1591 | 1133 | 1827 | 1664 | 1645 | 1973 | 1509 | 1665 |
| 201400_at | 1832 | 1914 | 1650 | 1733 | 1961 | 1743 | 1927 | 1894 | 1952 | 1917 | 1709 | 1621 | 1691 |
| 201421_s_at | 137.7 | 148.8 | 162.2 | 189.7 | 146.8 | 162.4 | 159.5 | 182.3 | 207 | 146.1 | 177.4 | 153 | 158.2 |
| 201422_at | 10000 | 9959 | 7455 | 7961 | 8468 | 8180 | 9199 | 7896 | 9044 | 8172 | 7791 | 5681 | 7824 |
| 201426_s_at | 16056 | 15280 | 16514 | 15476 | 14714 | 19025 | 16059 | 19683 | 17169 | 18567 | 15765 | 13684 | 14331 |
| 201453_x_at | 1343 | 1324 | 1320 | 1276 | 1028 | 1122 | 1228 | 1256 | 1603 | 1146 | 1473 | 1189 | 1148 |
| 201470_at | 1466 | 1531 | 1194 | 1372 | 1085 | 1232 | 1463 | 1213 | 1659 | 1110 | 1447 | 959.8 | 1075 |
| 201478_s_at | 245.4 | 216.4 | 228.9 | 266.9 | 232 | 238.6 | 272.5 | 290 | 344.7 | 220 | 320.9 | 258.8 | 250.3 |
| 201527_at | 657.5 | 913.8 | 912.3 | 963.8 | 951.1 | 834.4 | 965.8 | 804 | 858.4 | 850 | 822.4 | 762 | 865.8 |
| 201536_at | 433.5 | 367.3 | 349.8 | 367.3 | 576.3 | 386.1 | 466.6 | 391.6 | 412.3 | 338.6 | 322.4 | 253.9 | 367.3 |
| 201554_x_at | 830.6 | 680.4 | 606.4 | 781.1 | 915.6 | 1142 | 675.3 | 685.6 | 716.1 | 977.7 | 779.5 | 811.4 | 937.6 |
| 201556_s_at | 797.2 | 365.5 | 445.8 | 533.9 | 508.6 | 570.7 | 484.6 | 350.9 | 712 | 524 | 802.4 | 693.2 | 683.6 |
| 201576_s_at | 723.4 | 612.8 | 547.3 | 684 | 768.4 | 707 | 749.9 | 770.4 | 813.2 | 585.5 | 634 | 552.7 | 592.2 |
| 201590_x_at | 3572 | 4296 | 2880 | 3703 | 2921 | 3800 | 3808 | 3365 | 4378 | 3168 | 3473 | 3125 | 2124 |
| 201628_s_at | 560.5 | 630.3 | 568.9 | 633.4 | 506.6 | 573.3 | 584.9 | 589.3 | 596 | 567.3 | 605.1 | 571.1 | 559.5 |
| 201788_at | 448.5 | 437.1 | 477.6 | 568.5 | 520 | 490.4 | 599.1 | 588.4 | 569.2 | 533.2 | 685.6 | 508.1 | 508.4 |
| 201900_s_at | 402.6 | 444.3 | 386.4 | 565.6 | 467.2 | 458.9 | 489.8 | 396.7 | 523.9 | 341.3 | 383.4 | 386.6 | 393.4 |
| 201945_at | 598 | 325.9 | 506.5 | 377.1 | 441.7 | 536.5 | 467.9 | 430.4 | 431.6 | 608.1 | 372.3 | 363.9 | 545.1 |
| 202068_s_at | 102.8 | 272 | 69.27 | 137.5 | 58.09 | 148.6 | 147 | 83.59 | 137.1 | 55.55 | 83.85 | 138 | 54.27 |
| 202104_s_at | 450.3 | 354.2 | 375.7 | 415 | 366 | 163.3 | 388.6 | 485.9 | 257.8 | 257 | 399.6 | 419.6 | 324.2 |
| 202138_x_at | 233.8 | 331.5 | 243.7 | 310.9 | 231.2 | 258.6 | 286.6 | 258.7 | 295.7 | 272.1 | 286.8 | 252.9 | 226.2 |
| 202185_at | 237.9 | 244 | 179.7 | 232.5 | 190 | 214.2 | 221.8 | 200.7 | 251.1 | 201.9 | 189.6 | 221.1 | 156.8 |
| 202192_s_at | 765.7 | 609 | 788.6 | 464.6 | 644.7 | 741.7 | 670.4 | 727 | 824.3 | 1048 | 582.1 | 428.5 | 509.3 |
| 202201_at | 679.3 | 450.2 | 529.9 | 604.2 | 822 | 547.1 | 752.4 | 601.9 | 893.7 | 519.9 | 756.7 | 409.9 | 558.4 |
| 202249_s_at | 182.7 | 182 | 201.6 | 211.3 | 187 | 182.1 | 192.5 | 215.7 | 265.1 | 198 | 242.4 | 232.1 | 226.1 |
| 202252_at | 103.2 | 85.75 | 107.2 | 78.8 | 102.8 | 92.95 | 112.1 | 100.6 | 90.86 | 107.8 | 114.2 | 78.38 | 110.9 |
| 202262_x_at | 104.7 | 79.82 | 90.95 | 64.49 | 126.5 | 102.9 | 132.8 | 132.1 | 82.4 | 131.7 | 73.68 | 72 | 101.7 |
| 202380_s_at | 622.5 | 569.8 | 761.7 | 729.4 | 546.1 | 521.2 | 690.1 | 759.3 | 733.2 | 602.3 | 686.6 | 625.2 | 539.9 |
| 202381_at | 559.8 | 407.8 | 250.1 | 335.8 | 414 | 568.3 | 411 | 287.5 | 427.9 | 438.5 | 608.8 | 250.3 | 462.9 |
| 202428_x_at | 2061 | 2854 | 1939 | 2311 | 2018 | 2306 | 2644 | 2102 | 2412 | 2153 | 2320 | 1984 | 1663 |
| 202445_s_at | 178.8 | 144.6 | 172.4 | 125.7 | 206.9 | 184.9 | 154.1 | 178.4 | 167.3 | 128.2 | 135.8 | 118.4 | 177.5 |
| 202461_at | 210 | 202 | 171.8 | 204.1 | 193.6 | 203.8 | 174.1 | 165.4 | 214.1 | 195.7 | 171.6 | 184.8 | 129.6 |
| 202522_at | 687.6 | 711.6 | 691.7 | 733.7 | 620.8 | 643.2 | 740.1 | 685.6 | 743.6 | 705.4 | 628 | 655.4 | 679.7 |
| 202523_s_at | 149.2 | 156.1 | 188.9 | 303.5 | 156.5 | 146.7 | 171.7 | 265.4 | 86.09 | 96.78 | 100.8 | 303.9 | 177.2 |
| 202594_at | 1063 | 813.7 | 994.6 | 1075 | 983.9 | 723.8 | 960.9 | 896.7 | 880.8 | 982.5 | 1090 | 879.6 | 975 |
| 202623_at | 1154 | 1163 | 998.3 | 1141 | 1291 | 1101 | 1154 | 1118 | 1259 | 1069 | 1143 | 1056 | 1197 |
| 202652_at | 34.49 | 31.13 | 43.11 | 37.95 | 44.85 | 30.04 | 34.48 | 34.16 | 34.28 | 23.59 | 26.51 | 35.3 | 33.74 |
| 202724_s_at | 500.8 | 433.2 | 544.4 | 532.6 | 515.1 | 474.3 | 406.8 | 531.4 | 469.3 | 444.9 | 432.9 | 390.5 | 493.4 |
| 202750_s_at | 257.3 | 186.1 | 136 | 230.9 | 229 | 214 | 164.2 | 110.1 | 201.5 | 230.2 | 166.6 | 202.7 | 172.3 |
| 202778_s_at | 625.2 | 536.1 | 544 | 547.1 | 550.1 | 623.5 | 512.2 | 530.2 | 569 | 517.2 | 578 | 504.7 | 576.8 |
| 202910_s_at | 5046 | 4562 | 4820 | 2620 | 3474 | 5313 | 3936 | 5339 | 2865 | 4793 | 1921 | 3486 | 3572 |
| 202928_s_at | 140.9 | 78.34 | 133.1 | 134.9 | 115.4 | 122.2 | 149.9 | 164.8 | 136.6 | 119.7 | 163.7 | 130.3 | 158.1 |
| 202944_at | 478.8 | 468.4 | 230.3 | 503 | 503.5 | 323.4 | 460.8 | 412.7 | 436.1 | 322 | 329 | 357.1 | 350.2 |
| 202979_s_at | 538.3 | 743.6 | 509.6 | 789.4 | 502.2 | 706.8 | 626 | 693.5 | 728.6 | 424.4 | 797.4 | 871.1 | 610.5 |
| 203003_at | 135.7 | 87.39 | 95.53 | 86.28 | 103.1 | 97.04 | 89.39 | 90.75 | 92.86 | 95.15 | 104.2 | 97.52 | 110.1 |
| 203127_s_at | 408.8 | 441.6 | 264.6 | 294 | 349.8 | 426.9 | 290.9 | 385.8 | 370.9 | 375.2 | 394.7 | 238.8 | 425.1 |
| 203137_at | 1571 | 1995 | 1390 | 1767 | 1426 | 1551 | 1847 | 1761 | 1703 | 1515 | 1573 | 1892 | 1665 |
| 203184_at | 105.4 | 40.77 | 40.38 | 98.85 | 83.1 | 98.18 | 57.43 | 87.97 | 88.04 | 88.44 | 120 | 34.66 | 73.55 |
| 203234_at | 705.6 | 454 | 436.9 | 421.2 | 506 | 735 | 595.2 | 487.7 | 470.7 | 496.8 | 483.7 | 350.3 | 440.2 |
| 203278_s_at | 1023 | 821.1 | 958.1 | 871.5 | 1119 | 1102 | 1015 | 1018 | 782.1 | 1166 | 855.8 | 1019 | 1028 |
| 203305_at | 3377 | 628 | 992.6 | 1004 | 1312 | 848.6 | 1343 | 875.4 | 1337 | 1255 | 2385 | 726.7 | 1164 |
| 203371_s_at | 1259 | 1224 | 975.2 | 998.1 | 1412 | 1426 | 1423 | 1458 | 1130 | 1535 | 1117 | 912.3 | 1238 |
| 203413_at | 438.3 | 340.4 | 365.7 | 638.3 | 248.6 | 215.4 | 497 | 426.4 | 272.6 | 296.1 | 397.1 | 250.2 | 186.2 |
| 203416_at | 11908 | 10954 | 10324 | 10265 | 9483 | 10546 | 10819 | 10461 | 11112 | 13002 | 10673 | 10857 | 10683 |
| 203492_x_at | 211.1 | 243 | 207.8 | 200.9 | 220.3 | 183.3 | 241.8 | 276.6 | 339.7 | 211.7 | 239.9 | 228.1 | 210 |
| 203534_at | 931.5 | 971.6 | 698.9 | 805.4 | 820.9 | 721.4 | 854.8 | 714.4 | 997.7 | 790.5 | 764.4 | 808.9 | 685.9 |
| 203535_at | 41266 | 34546 | 43439 | 39800 | 41584 | 43756 | 43234 | 43447 | 36408 | 47178 | 43808 | 38070 | 44537 |
| 203578_s_at | 93.93 | 67.66 | 86.99 | 124.3 | 90.54 | 79.46 | 119.6 | 139.8 | 181.3 | 91.25 | 131.1 | 78.06 | 127.2 |
| 203748_x_at | 1517 | 1323 | 1523 | 1516 | 1406 | 1687 | 1514 | 1488 | 1760 | 1870 | 1616 | 1368 | 1586 |
| 203759_at | 104.5 | 61.49 | 84.47 | 86.69 | 101.4 | 95.3 | 84.93 | 92.5 | 100.3 | 166.8 | 78.86 | 88.62 | 105.7 |
| 203844_at | 27.82 | 27.51 | 28.57 | 24.62 | 27.3 | 27.56 | 26.46 | 27.55 | 28.12 | 32.73 | 30 | 26.5 | 30.21 |
| 203880_at | 314.7 | 375.6 | 233.7 | 298.9 | 215.8 | 273.1 | 256.3 | 268.1 | 432.1 | 278.8 | 283 | 235.6 | 225 |
| 203912_s_at | 230.3 | 238 | 186.6 | 243.1 | 265.1 | 311.2 | 208.8 | 218.6 | 253.2 | 201.2 | 218.9 | 153.5 | 206.4 |
| 203939_at | 103.6 | 50.2 | 65.39 | 52.86 | 46.14 | 33.97 | 77.74 | 71.35 | 98.12 | 54.86 | 79.03 | 41.41 | 56.63 |
| 203971_at | 108.3 | 156.6 | 120.9 | 90.66 | 106.8 | 110.8 | 98.48 | 132.4 | 112.8 | 89.56 | 88.16 | 81.46 | 112.3 |
| 204050_s_at | 1140 | 1284 | 1309 | 1320 | 1258 | 1115 | 1274 | 1165 | 1606 | 1306 | 1347 | 1142 | 1077 |
| 204068_at | 120.3 | 96.4 | 84.23 | 65.58 | 100.7 | 106.4 | 85.13 | 63.1 | 85.96 | 65.16 | 71.47 | 85.64 | 69.27 |
| 204099_at | 211.3 | 124.2 | 145.5 | 171.4 | 314.2 | 184.1 | 212.2 | 192.9 | 142.7 | 239.9 | 176.7 | 108.1 | 188.7 |
| 204143_s_at | 128.4 | 216.4 | 129.2 | 183.6 | 221.3 | 131.2 | 164.2 | 295.7 | 232.1 | 74.93 | 150.5 | 207 | 111.3 |
| 204204_at | 2293 | 2506 | 3051 | 1043 | 1516 | 2953 | 2399 | 3079 | 1935 | 2051 | 1771 | 1434 | 2082 |
| 204214_s_at | 796.6 | 444.3 | 561.8 | 497 | 777.2 | 660.6 | 669.9 | 546.6 | 545.9 | 565.3 | 715.9 | 460.7 | 637.5 |
| 204232_at | 5003 | 2740 | 4415 | 4073 | 4560 | 5842 | 4144 | 3413 | 4456 | 5850 | 4106 | 2709 | 4243 |
| 204243_at | 269.8 | 307.9 | 310.9 | 249.3 | 270.5 | 318.6 | 275.4 | 296.2 | 272.7 | 249.9 | 332.2 | 258.5 | 392.3 |
| 204249_s_at | 2967 | 3226 | 3557 | 3095 | 3706 | 2769 | 3527 | 2857 | 3188 | 3029 | 3134 | 2902 | 2846 |
| 204291_at | 552.2 | 514.3 | 313.5 | 520.4 | 670.5 | 503.9 | 548.7 | 367.8 | 463.4 | 173.3 | 494.9 | 530.1 | 433.5 |
| 204342_at | 637.3 | 1418 | 504.5 | 854.2 | 550.4 | 1257 | 1048 | 672.5 | 792.2 | 637 | 796.1 | 871.5 | 628.4 |
| 204352_at | 244.4 | 401.7 | 410.4 | 552.8 | 295.2 | 289.5 | 453.9 | 500.9 | 444.9 | 313.1 | 402.1 | 450.4 | 250.9 |
| 204401_at | 84.4 | 138.1 | 89.67 | 190 | 102.1 | 115.5 | 149.4 | 102.6 | 171 | 168.3 | 106.2 | 94.13 | 89.26 |
| 204504_s_at | 97.73 | 85.7 | 101.5 | 87.47 | 95.72 | 81.98 | 111.6 | 101.2 | 96.62 | 101.8 | 106.5 | 95.04 | 85.74 |
| 204617_s_at | 308.8 | 230.3 | 261.6 | 264.5 | 306.4 | 301.3 | 334.2 | 332.4 | 347.2 | 260.9 | 271.1 | 304.7 | 240.6 |
| 204645_at | 859.9 | 847.3 | 629.2 | 935 | 836.2 | 921.3 | 1004 | 796.1 | 983.5 | 543.4 | 971.2 | 1001 | 812.6 |
| 204675_at | 115.4 | 164.5 | 84.58 | 126.5 | 132.9 | 143.7 | 140.4 | 103.3 | 145.8 | 74.93 | 116.9 | 89.44 | 92.44 |
| 204689_at | 457.9 | 590.2 | 452.1 | 531.8 | 598.7 | 612 | 615.8 | 453.8 | 503.4 | 585.9 | 548.9 | 430.7 | 596.9 |
| 204801_s_at | 39.61 | 25.5 | 20.89 | 39.77 | 49.62 | 50.9 | 35.93 | 71.23 | 29.58 | 23.04 | 27.3 | 21.24 | 46.63 |
| 205235_s_at | 89.95 | 92.22 | 93.15 | 75.36 | 80.67 | 79.96 | 85.67 | 87.34 | 86.41 | 96.32 | 100.3 | 88.03 | 84.98 |
| 205254_x_at | 139.9 | 187.2 | 439.4 | 430.8 | 261.3 | 137.8 | 209.8 | 325.4 | 196.3 | 259.2 | 232 | 217.7 | 271.2 |
| 205256_at | 53.01 | 74.26 | 65.87 | 64.71 | 65.04 | 65.29 | 64.94 | 63.98 | 58.62 | 68.56 | 63.26 | 61.15 | 69.8 |
| 205322_s_at | 498.2 | 461.5 | 512.8 | 604.9 | 587.1 | 544.2 | 533.8 | 471.9 | 533.5 | 755.7 | 513.4 | 495.9 | 616.4 |
| 205340_at | 114.2 | 137.1 | 128.3 | 158.6 | 129.1 | 109.4 | 161.8 | 154.6 | 136.1 | 81.35 | 134.8 | 136.1 | 100.1 |
| 205349_at | 222.4 | 164.3 | 180.1 | 161.6 | 210.4 | 173.5 | 217.4 | 152 | 166 | 171.8 | 153.7 | 130.2 | 164.3 |
| 205550_s_at | 237.6 | 257.9 | 242 | 295.2 | 309.3 | 258.1 | 282 | 257.7 | 310.9 | 267.9 | 255.1 | 257.4 | 245.9 |
| 205811_at | 141.5 | 211.9 | 178.7 | 199.8 | 158.3 | 145.9 | 187.4 | 186.2 | 157.1 | 145.2 | 134.3 | 179.8 | 157.1 |
| 205835_s_at | 87.84 | 105.9 | 54.62 | 91.39 | 68.05 | 86.69 | 86.6 | 134.9 | 136.1 | 58.43 | 105.8 | 96.7 | 98.12 |
| 205895_s_at | 127.1 | 126.6 | 88.13 | 140.1 | 134.7 | 98.81 | 156.8 | 164.7 | 164.2 | 99.44 | 125 | 160 | 109.4 |
| 205965_at | 176.5 | 275.3 | 160.5 | 157.7 | 158.8 | 213 | 220.3 | 171.3 | 199.1 | 214.9 | 201.5 | 230.1 | 139.1 |
| 205976_at | 43.77 | 60.92 | 46.72 | 59.99 | 27.65 | 43.78 | 48.35 | 53.37 | 49.63 | 11.55 | 44.91 | 41.11 | 43.24 |
| 206015_s_at | 601.3 | 692.1 | 652.3 | 783.2 | 679.2 | 672.8 | 677.6 | 704.5 | 620.7 | 688.2 | 690.7 | 673.3 | 605.4 |
| 206037_at | 35.89 | 30.25 | 40.29 | 33.83 | 38.42 | 34.59 | 35.41 | 37.37 | 39.77 | 28.21 | 42.53 | 34.56 | 31.89 |
| 206170_at | 177.5 | 447.4 | 174.2 | 391 | 158.6 | 315.7 | 279.7 | 324.9 | 430.2 | 217.6 | 253.9 | 568.2 | 141.3 |
| 206182_at | 77.68 | 99.79 | 79.49 | 113.3 | 101.7 | 90.04 | 97.79 | 123.1 | 114.8 | 101.1 | 99.71 | 128.9 | 118.9 |
| 206343_s_at | 24.9 | 18.68 | 77.88 | 9.17 | 108.5 | 22.6 | 94.37 | 26.12 | 17.36 | 18.32 | 69.59 | 8.799 | 13.82 |
| 206542_s_at | 1219 | 1261 | 1054 | 1281 | 1165 | 1359 | 1193 | 1103 | 1379 | 992.4 | 1290 | 1277 | 1127 |
| 206580_s_at | 59.71 | 57.54 | 46.72 | 49.36 | 63.49 | 71.42 | 58.79 | 43.25 | 34.5 | 63.51 | 54.95 | 49.01 | 56.82 |
| 206715_at | 378.5 | 410.2 | 164.6 | 410.7 | 445.5 | 276.5 | 354.8 | 276.1 | 288.5 | 238 | 393.9 | 257.1 | 297.2 |
| 206834_at | 90.3 | 105.1 | 71.93 | 54.85 | 23.4 | 71.62 | 91.43 | 118 | 174.1 | 62.87 | 461.8 | 44.82 | 104.1 |
| 206968_s_at | 86.98 | 64.55 | 105.3 | 102.7 | 78.55 | 103.5 | 88.93 | 113.1 | 127.7 | 87.35 | 109.2 | 114 | 118.8 |
| 207075_at | 159 | 117.4 | 196.8 | 158.7 | 173.5 | 148.2 | 217 | 140.2 | 121.8 | 116 | 132.2 | 103.6 | 168 |
| 207078_at | 164.2 | 161.1 | 152 | 163.8 | 170.7 | 159.7 | 181.6 | 199.8 | 176.6 | 84.28 | 185.4 | 254.5 | 123.8 |
| 207113_s_at | 126.3 | 129.3 | 92.81 | 184.3 | 82.98 | 139.7 | 131.4 | 136.4 | 165.2 | 131.6 | 117.3 | 127 | 119.5 |
| 207164_s_at | 759.9 | 329 | 453.3 | 517 | 481.3 | 618.9 | 493.6 | 859.6 | 840.8 | 629 | 752 | 610.2 | 1037 |
| 207233_s_at | 132.4 | 75.32 | 78.18 | 86.36 | 117.8 | 115 | 80.15 | 86.93 | 87.41 | 157.5 | 150.2 | 78.17 | 108.2 |
| 207416_s_at | 185.4 | 270.7 | 235.8 | 241.5 | 248.4 | 191.9 | 283.5 | 241.1 | 304.9 | 163.6 | 252.2 | 284.9 | 227.1 |
| 207513_s_at | 249 | 229.4 | 149.6 | 204.9 | 249.9 | 195.4 | 254.1 | 236.4 | 304.6 | 140.7 | 268.5 | 232.6 | 223 |
| 207543_s_at | 288.1 | 294.7 | 278.6 | 282.3 | 252.6 | 367.8 | 299.3 | 214.7 | 479.3 | 335.8 | 379.8 | 251 | 329.7 |
| 207564_x_at | 2765 | 2747 | 2278 | 3485 | 2564 | 3085 | 3203 | 3836 | 3978 | 2890 | 3978 | 3580 | 2997 |
| 207971_s_at | 52.93 | 56.58 | 72.78 | 92.42 | 72.41 | 56.58 | 70.13 | 98.08 | 102 | 71.38 | 76.3 | 97.81 | 71.61 |
| 208104_s_at | 441 | 365.5 | 451.7 | 502.9 | 293.9 | 583.1 | 460.5 | 516.2 | 316 | 402.6 | 307.6 | 466.7 | 595.3 |
| 208121_s_at | 85.75 | 142.5 | 67.84 | 146.6 | 100.8 | 102 | 133.5 | 118.1 | 160.6 | 49.59 | 116.3 | 92.83 | 81.96 |
| 208161_s_at | 178.4 | 46.66 | 30.22 | 62.51 | 50.24 | 47.14 | 59.18 | 47.71 | 56.97 | 37.73 | 78 | 42.42 | 39.25 |
| 208269_s_at | 88.48 | 89.84 | 132 | 97.48 | 102.3 | 109.3 | 93.63 | 134.6 | 103.1 | 100.2 | 135.1 | 103.5 | 130.2 |
| 208309_s_at | 226.2 | 323.5 | 298.7 | 360.2 | 217 | 261.1 | 278.8 | 375.7 | 477.7 | 258.3 | 305.5 | 335.6 | 284.7 |
| 208527_x_at | 582 | 259 | 282.6 | 326.6 | 320.7 | 318.5 | 297.3 | 400.4 | 421.9 | 390.2 | 346.7 | 261.9 | 442.7 |
| 208579_x_at | 1072 | 445.6 | 469.4 | 628.4 | 492.1 | 584.8 | 412.8 | 687.8 | 620.4 | 807.5 | 624.8 | 438 | 763.9 |
| 208635_x_at | 13058 | 14219 | 13923 | 16481 | 15292 | 12099 | 13978 | 14518 | 16065 | 15205 | 15485 | 14439 | 12106 |
| 208659_at | 6932 | 6772 | 6899 | 6385 | 7149 | 7666 | 7561 | 7448 | 7151 | 8222 | 6792 | 6394 | 6622 |
| 208680_at | 641.8 | 930.8 | 570.4 | 840.3 | 640.1 | 680.2 | 896.5 | 603.1 | 876.1 | 567.2 | 734.4 | 678.1 | 475.3 |
| 208749_x_at | 1896 | 1083 | 2351 | 2078 | 1821 | 1794 | 2111 | 2046 | 1961 | 3140 | 1708 | 1266 | 2698 |
| 208771_s_at | 4689 | 3479 | 3346 | 6951 | 5273 | 6173 | 5014 | 6553 | 7564 | 2532 | 4956 | 6068 | 4276 |
| 208780_x_at | 2499 | 2392 | 2370 | 2290 | 2488 | 2664 | 1926 | 2504 | 2513 | 3059 | 2872 | 2388 | 3331 |
| 208798_x_at | 772.2 | 1764 | 1621 | 1821 | 1003 | 1066 | 1002 | 1421 | 1944 | 831.6 | 1377 | 1547 | 1150 |
| 208805_at | 1772 | 2761 | 1679 | 2266 | 1721 | 2053 | 2356 | 1834 | 2287 | 1923 | 2077 | 1815 | 1790 |
| 208868_s_at | 965.8 | 515.7 | 762 | 569.6 | 970.4 | 695.5 | 591.4 | 925.7 | 694.8 | 778 | 632.1 | 772.4 | 1183 |
| 208903_at | 33.69 | 49.67 | 49.41 | 76.48 | 53.98 | 46.73 | 68.12 | 53.82 | 51.68 | 43.25 | 62.04 | 53.34 | 53.94 |
| 208921_s_at | 1206 | 1336 | 959 | 1278 | 1046 | 1460 | 1320 | 1135 | 1226 | 969.3 | 1098 | 1162 | 1089 |
| 208923_at | 660.3 | 659 | 510.4 | 687.1 | 645.3 | 549 | 732.6 | 604.3 | 577.4 | 441.6 | 583.9 | 407.3 | 476.6 |
| 208946_s_at | 1602 | 1505 | 1393 | 1412 | 1584 | 1428 | 1472 | 1512 | 1596 | 1246 | 1331 | 1416 | 1408 |
| 208962_s_at | 46.24 | 114.3 | 73.17 | 100.3 | 52.19 | 83.54 | 71.86 | 38.13 | 84.47 | 72.29 | 49.92 | 78.09 | 49.65 |
| 209040_s_at | 1954 | 2059 | 1792 | 1821 | 2191 | 1712 | 2307 | 1685 | 1769 | 1827 | 1774 | 1917 | 1764 |
| 209067_s_at | 2326 | 2510 | 2147 | 2707 | 1637 | 2253 | 2130 | 2897 | 3595 | 2336 | 3408 | 2459 | 2316 |
| 209072_at | 98.08 | 63.84 | 82.25 | 56.08 | 80.7 | 102.6 | 36.51 | 91.77 | 52.33 | 68.58 | 41.22 | 71.23 | 63.59 |
| 209099_x_at | 162.1 | 91.36 | 113.3 | 105.2 | 139.2 | 148.7 | 107.9 | 101.2 | 108.6 | 88.53 | 140.9 | 75.94 | 110 |
| 209124_at | 5494 | 5255 | 5579 | 5431 | 5456 | 5997 | 5698 | 5240 | 5698 | 6966 | 5286 | 4278 | 5282 |
| 209180_at | 317.8 | 306.1 | 257.1 | 402.3 | 304.8 | 258.1 | 380.4 | 324.5 | 389.6 | 216.7 | 354.3 | 348.1 | 256.9 |
| 209191_at | 141.8 | 147.7 | 113.8 | 76.2 | 202.4 | 264.4 | 139.3 | 296 | 164.7 | 121.6 | 235.1 | 122.5 | 109.9 |
| 209212_s_at | 39.13 | 15.98 | 30.5 | 28.91 | 29.91 | 52.67 | 14.03 | 29.92 | 20.66 | 41.63 | 29.17 | 25.86 | 28.85 |
| 209218_at | 90.61 | 318.6 | 82.38 | 199.8 | 64.6 | 131.4 | 153.1 | 83.41 | 305.8 | 98.64 | 91.38 | 169.1 | 94.91 |
| 209236_at | 197.7 | 154.3 | 175.9 | 179.7 | 243.6 | 151.8 | 224.7 | 226.6 | 194.5 | 132.7 | 271.5 | 141.2 | 249.6 |
| 209251_x_at | 4389 | 4731 | 5634 | 4632 | 3707 | 5484 | 5136 | 5354 | 5498 | 6076 | 4529 | 4375 | 4926 |
| 209259_s_at | 581 | 655.6 | 483.5 | 603.4 | 546.4 | 542.7 | 605.5 | 507.7 | 700.3 | 349.7 | 605.9 | 606.4 | 487.1 |
| 209269_s_at | 573.3 | 318.4 | 465.7 | 531.4 | 716.6 | 675.2 | 657.7 | 546.3 | 593.6 | 531.3 | 633.5 | 588.6 | 771.9 |
| 209330_s_at | 1993 | 2074 | 1961 | 2290 | 2292 | 1968 | 2328 | 2388 | 2623 | 1904 | 2639 | 2301 | 1971 |
| 209339_at | 505.1 | 407.6 | 368.2 | 446 | 356.6 | 412.8 | 401.4 | 421.7 | 441.7 | 438.8 | 444.9 | 352.4 | 453.5 |
| 209430_at | 613.9 | 848.6 | 767.5 | 750.4 | 765.3 | 722.7 | 796.9 | 732.3 | 864.6 | 507.8 | 821.7 | 740.2 | 741.9 |
| 209675_s_at | 1058 | 722.1 | 1031 | 1070 | 954 | 1061 | 848.1 | 1045 | 993 | 1030 | 1153 | 1017 | 1100 |
| 209684_at | 502.1 | 729.6 | 202.7 | 335.8 | 551.4 | 362.6 | 399.3 | 301 | 535.9 | 314.9 | 375.4 | 229 | 272.6 |
| 209806_at | 3602 | 1612 | 1470 | 2329 | 1548 | 2135 | 1293 | 1539 | 1687 | 2531 | 1605 | 1398 | 2351 |
| 209840_s_at | 44.49 | 33.68 | 59.42 | 173.4 | 30.4 | 6.874 | 4.203 | 8.277 | 33.48 | 7.017 | 162.9 | 5.192 | 62.73 |
| 209870_s_at | 163.2 | 212.9 | 165.1 | 157.4 | 170.3 | 162.1 | 147.9 | 188.8 | 162.3 | 194.5 | 186.2 | 156.2 | 127 |
| 209892_at | 124.5 | 124.3 | 76.63 | 103 | 61.15 | 87.89 | 107.4 | 75.81 | 96.17 | 73.84 | 93.54 | 74.13 | 85.92 |
| 209906_at | 432.4 | 1093 | 259.3 | 788 | 1051 | 380.1 | 694.2 | 628.2 | 609.7 | 486.7 | 356.2 | 435.2 | 755.8 |
| 210022_at | 179.2 | 166.5 | 153 | 166.6 | 176 | 176.3 | 181.6 | 158.7 | 182.3 | 146.1 | 186.8 | 162.4 | 176.3 |
| 210061_at | 104.8 | 78.89 | 137.5 | 129 | 163.5 | 105.3 | 126.1 | 111.6 | 148 | 115.5 | 72.94 | 99.44 | 125.1 |
| 210145_at | 94.15 | 88.91 | 58.36 | 92.35 | 119.5 | 87.01 | 73.82 | 54.34 | 84.07 | 37.51 | 91.81 | 73.89 | 69.42 |
| 210156_s_at | 1245 | 1085 | 887.9 | 1186 | 1204 | 1226 | 1254 | 1134 | 1160 | 814 | 1205 | 1089 | 1153 |
| 210166_at | 506.1 | 407.6 | 373.4 | 434.6 | 646.1 | 778.8 | 491.2 | 338.7 | 389.3 | 6762 | 352.3 | 364.6 | 358.5 |
| 210434_x_at | 2300 | 2565 | 2475 | 2601 | 2273 | 2427 | 2547 | 2441 | 2508 | 2843 | 2382 | 2340 | 2397 |
| 210644_s_at | 471.2 | 603.6 | 479.2 | 532.9 | 439.9 | 487.4 | 551 | 456.6 | 550.9 | 348.2 | 331.4 | 430.7 | 452.3 |
| 210648_x_at | 3509 | 4102 | 3517 | 3486 | 3327 | 3861 | 3696 | 3247 | 3627 | 4612 | 3612 | 2892 | 3672 |
| 210875_s_at | 183.9 | 99.07 | 124.8 | 155.3 | 197.9 | 247.4 | 192.4 | 194.6 | 251.3 | 172 | 194.3 | 234.2 | 249.8 |
| 211047_x_at | 1210 | 1238 | 1224 | 1245 | 1181 | 1125 | 1225 | 1066 | 1395 | 1326 | 1126 | 1041 | 996.9 |
| 211058_x_at | 4724 | 4353 | 5084 | 4491 | 3996 | 5377 | 5141 | 5177 | 5766 | 5507 | 4740 | 4311 | 4746 |
| 211185_s_at | 7274 | 7736 | 7213 | 8481 | 7843 | 8094 | 8589 | 7997 | 7783 | 6629 | 8735 | 8232 | 7835 |
| 211272_s_at | 427.6 | 392.4 | 570.9 | 845.6 | 535 | 327.7 | 486.1 | 637.3 | 508.6 | 427.4 | 632 | 442.2 | 594.6 |
| 211323_s_at | 135.2 | 110.6 | 103.2 | 133.5 | 116.3 | 132.7 | 162.3 | 147.4 | 243.8 | 94.54 | 182.5 | 146.5 | 161 |
| 211383_s_at | 409.8 | 448.3 | 484 | 537.1 | 412.9 | 511.8 | 478.7 | 513.2 | 595.1 | 534.3 | 429.5 | 479.1 | 421.8 |
| 211429_s_at | 19376 | 14314 | 16417 | 13185 | 16720 | 18721 | 17370 | 15166 | 15902 | 20425 | 16514 | 12774 | 16631 |
| 211506_s_at | 81.58 | 120.9 | 411.1 | 419.7 | 360.5 | 113.5 | 472.3 | 781.4 | 195.7 | 115.5 | 357.7 | 354.2 | 1298 |
| 211546_x_at | 281.6 | 170.1 | 190 | 183.4 | 157.6 | 174.7 | 155.1 | 182.9 | 167.5 | 206.5 | 235.9 | 155.6 | 182.1 |
| 211684_s_at | 472.3 | 896.5 | 419 | 686.8 | 474.5 | 540.3 | 604.4 | 552.8 | 698.8 | 499 | 611.5 | 512.6 | 497.9 |
| 211729_x_at | 558.4 | 679 | 530.8 | 542.4 | 509.2 | 493.8 | 524.7 | 372.2 | 495.3 | 520.6 | 427.2 | 293.4 | 378.2 |
| 211856_x_at | 68.1 | 54.93 | 60.51 | 80.99 | 53.01 | 45.54 | 54.09 | 101.5 | 89.95 | 46.7 | 61.15 | 83.46 | 50.16 |
| 211946_s_at | 4463 | 5374 | 3940 | 5214 | 4527 | 4842 | 5081 | 4326 | 4331 | 3675 | 4767 | 5015 | 3989 |
| 211965_at | 1528 | 1305 | 3667 | 2246 | 1788 | 3274 | 1469 | 1895 | 2853 | 2054 | 2897 | 2010 | 3107 |
| 212030_at | 1055 | 1126 | 979 | 1143 | 1018 | 876.3 | 1121 | 1112 | 1393 | 860.2 | 1448 | 960.9 | 1099 |
| 212042_x_at | 23323 | 23698 | 23300 | 24311 | 25799 | 21850 | 23104 | 22883 | 25069 | 19788 | 25371 | 23702 | 20344 |
| 212132_at | 2795 | 2650 | 2074 | 2917 | 2622 | 2716 | 2588 | 2513 | 3303 | 2786 | 3081 | 3163 | 2743 |
| 212213_x_at | 227.9 | 259.9 | 194.1 | 233.3 | 210 | 198.5 | 193.1 | 199.4 | 218.5 | 165.6 | 217.9 | 191.6 | 209 |
| 212299_at | 297.3 | 323.8 | 361.2 | 397.5 | 295.2 | 294 | 393.8 | 349.2 | 319.9 | 364.7 | 341.8 | 364 | 342.6 |
| 212331_at | 2949 | 3208 | 3095 | 3537 | 2377 | 3259 | 2754 | 3124 | 3371 | 2736 | 3017 | 4789 | 3089 |
| 212334_at | 2523 | 2474 | 2021 | 2435 | 2379 | 2409 | 2769 | 2250 | 2289 | 1852 | 2261 | 2288 | 2589 |
| 212406_s_at | 991.6 | 1211 | 1259 | 1415 | 1003 | 1247 | 1281 | 1212 | 1222 | 1175 | 1456 | 1335 | 1226 |
| 212455_at | 3323 | 2832 | 3028 | 3007 | 3292 | 2817 | 3146 | 3105 | 3514 | 2707 | 3360 | 3015 | 3113 |
| 212543_at | 1012 | 1325 | 1203 | 1524 | 1339 | 1537 | 1364 | 1339 | 1255 | 1441 | 1431 | 1436 | 1306 |
| 212658_at | 166.5 | 118.2 | 65.83 | 79.36 | 144.1 | 124.3 | 179.5 | 98.93 | 105.7 | 71.62 | 115.2 | 84.57 | 102.9 |
| 212663_at | 1427 | 1384 | 1228 | 1170 | 1492 | 1236 | 1467 | 1250 | 1266 | 1456 | 1155 | 1175 | 1197 |
| 212769_at | 425.5 | 277.1 | 472.7 | 289 | 424.4 | 383.6 | 460.6 | 576.8 | 257.4 | 343.6 | 261.6 | 382.8 | 506.2 |
| 212820_at | 2905 | 2767 | 2711 | 2218 | 2474 | 3234 | 2845 | 2600 | 1738 | 2219 | 2262 | 1837 | 2163 |
| 212932_at | 145.4 | 135 | 128.5 | 150.7 | 148.2 | 106.2 | 188 | 159.1 | 187 | 110.9 | 146.1 | 119.9 | 157.1 |
| 212989_at | 383.2 | 477.7 | 274.3 | 468.4 | 484.7 | 455.7 | 431.5 | 360.6 | 280.8 | 362.6 | 363.4 | 341.9 | 436.4 |
| 212997_s_at | 581.6 | 562.6 | 553.9 | 573.8 | 653 | 495.2 | 658 | 764.8 | 616.4 | 458.4 | 574.8 | 701.1 | 664.1 |
| 213021_at | 214.8 | 229.9 | 183.3 | 242.7 | 279.8 | 184.7 | 251.5 | 241.1 | 292 | 157 | 230.5 | 244.1 | 241.4 |
| 213152_s_at | 354.9 | 479.9 | 343 | 561.8 | 319.3 | 301.9 | 482.9 | 548.5 | 477.4 | 336.9 | 494.5 | 550.1 | 344.1 |
| 213205_s_at | 131.6 | 106.5 | 124.7 | 122.4 | 123.2 | 118.4 | 136.4 | 153.3 | 167.8 | 99.38 | 143.1 | 144 | 127.3 |
| 213218_at | 69.79 | 62 | 74.83 | 79.8 | 96.17 | 60.08 | 88.29 | 91.65 | 117.1 | 69.54 | 94.74 | 76.59 | 67.13 |
| 213266_at | 109.8 | 85.55 | 74.96 | 87.77 | 73.14 | 70.24 | 107.4 | 118 | 120.2 | 78.29 | 83.23 | 83.15 | 68.39 |
| 213302_at | 30.85 | 24.85 | 23.31 | 42.81 | 28.79 | 18.21 | 34.94 | 38.67 | 42.37 | 19.8 | 31.72 | 24.41 | 24.22 |
| 213335_s_at | 47.07 | 30.4 | 33.29 | 36.73 | 41.39 | 32.95 | 34.66 | 29.71 | 33.79 | 34.19 | 38.58 | 32.92 | 37.89 |
| 213397_x_at | 99.63 | 69.57 | 99.57 | 63.54 | 240.4 | 104.4 | 103.7 | 214.2 | 86.79 | 32.35 | 86.36 | 69.39 | 99.87 |
| 213459_at | 71.63 | 101.9 | 69.36 | 91.18 | 91.61 | 63.91 | 70.34 | 74.38 | 61.14 | 47.62 | 46.19 | 73.88 | 72.02 |
| 213494_s_at | 67.98 | 91.74 | 39.55 | 71.79 | 60.88 | 42.56 | 43.01 | 41.01 | 47.69 | 33.64 | 43.73 | 57.36 | 47.41 |
| 213540_at | 51.64 | 44.85 | 51.59 | 65.68 | 54.19 | 50.26 | 51.15 | 56.55 | 59.85 | 47.16 | 58.1 | 55.23 | 55.54 |
| 213693_s_at | 38.01 | 36.3 | 45.7 | 40.49 | 36.37 | 36.61 | 36.33 | 37.18 | 37.29 | 47.6 | 37.4 | 36.96 | 36.27 |
| 213827_at | 84.2 | 53.09 | 48.15 | 63.65 | 65.41 | 56.87 | 79.47 | 104.2 | 82.51 | 71.45 | 78.37 | 87.75 | 64 |
| 213877_x_at | 91.09 | 93.41 | 91.97 | 74.54 | 90.45 | 94 | 106.2 | 91.38 | 86.94 | 102.6 | 91.81 | 90.84 | 98.6 |
| 214045_at | 36.53 | 67.5 | 78.57 | 79.47 | 84.25 | 52.66 | 58.51 | 73.55 | 90.95 | 19.72 | 60.72 | 77.5 | 68.64 |
| 214057_at | 289.3 | 383.6 | 291.7 | 226.5 | 356.9 | 233.2 | 245.6 | 314.6 | 193.9 | 222.5 | 198 | 283.9 | 238.2 |
| 214330_at | 28.08 | 31.8 | 30.52 | 40.88 | 38.64 | 33.97 | 42.92 | 47.64 | 42.52 | 40.69 | 27.52 | 84.88 | 41.27 |
| 214364_at | 92.79 | 65.47 | 85.7 | 129.8 | 112.8 | 70.32 | 143.3 | 149.1 | 123.1 | 71.07 | 69.99 | 93.32 | 93.03 |
| 214430_at | 550 | 382.2 | 415.4 | 414.3 | 491.3 | 451.9 | 418.6 | 390.3 | 348.5 | 417.1 | 459.3 | 348.1 | 389.3 |
| 214511_x_at | 1993 | 1559 | 852 | 743.8 | 1422 | 1255 | 1951 | 934.1 | 1120 | 1778 | 1248 | 1341 | 1308 |
| 214629_x_at | 7160 | 6825 | 5460 | 6601 | 5580 | 7945 | 6440 | 6602 | 6557 | 6619 | 6768 | 6129 | 6152 |
| 214683_s_at | 3323 | 3329 | 3387 | 3797 | 3074 | 3549 | 3741 | 3711 | 3793 | 2802 | 3331 | 3324 | 3481 |
| 214820_at | 85.45 | 103 | 90.22 | 90.93 | 73.52 | 90.3 | 91.77 | 111.3 | 100.1 | 67.56 | 95.04 | 93.3 | 79.63 |
| 214853_s_at | 447.2 | 448.7 | 415 | 481.3 | 440.3 | 468.6 | 417.2 | 439 | 421.3 | 489.6 | 437.6 | 451.4 | 380.8 |
| 214931_s_at | 329.8 | 245.8 | 250.8 | 278.8 | 358.9 | 358.2 | 327.7 | 472.4 | 616.4 | 268.7 | 479.7 | 332.1 | 444.7 |
| 214953_s_at | 301.6 | 186.4 | 256.1 | 276.9 | 222 | 202.1 | 160.7 | 180.7 | 173.4 | 95.7 | 233.7 | 168.8 | 180.2 |
| 215009_s_at | 562.7 | 436.2 | 466.1 | 485.5 | 464 | 447.9 | 517.1 | 550.6 | 620.6 | 254.1 | 427.5 | 518.3 | 408.6 |
| 215049_x_at | 454.1 | 377.8 | 291.8 | 464.6 | 543.9 | 407.3 | 524.9 | 666.7 | 542.8 | 493 | 606.4 | 285.9 | 551.1 |
| 215273_s_at | 670.9 | 503.4 | 498 | 495.8 | 586.4 | 632.9 | 599.8 | 524.1 | 557.9 | 677.6 | 543 | 460.3 | 453.3 |
| 215293_s_at | 64.57 | 53.06 | 63.14 | 47.27 | 71.3 | 53.98 | 88.84 | 86.55 | 74.98 | 54 | 89.42 | 68.64 | 62.74 |
| 215567_at | 103 | 121.4 | 126 | 125.7 | 129 | 128.3 | 129.4 | 98.72 | 145.9 | 51.21 | 119 | 118.2 | 110.6 |
| 215997_s_at | 302.1 | 320.4 | 251.2 | 288.8 | 334 | 351.6 | 266 | 418.8 | 527.4 | 303.1 | 350.3 | 326.8 | 428.9 |
| 216484_x_at | 465.8 | 399.7 | 428 | 480.9 | 342.3 | 405.7 | 393 | 339.3 | 355.8 | 441.5 | 418.4 | 379.9 | 353.8 |
| 216950_s_at | 1091 | 773 | 268.5 | 376.4 | 709.9 | 600.8 | 1036 | 493 | 768.1 | 847.3 | 691 | 751.7 | 654.9 |
| 217383_at | 31.8 | 39.67 | 26.78 | 40 | 49.22 | 29.22 | 30.84 | 27.14 | 31.44 | 29.87 | 32.83 | 31.94 | 26.58 |
| 217403_s_at | 78.45 | 96.38 | 70.24 | 107.7 | 81.96 | 68.47 | 104 | 104.5 | 126.1 | 48.81 | 108.4 | 95.92 | 98.39 |
| 217466_x_at | 2808 | 2787 | 2627 | 3505 | 2795 | 2372 | 2795 | 3209 | 2796 | 1985 | 2766 | 2975 | 2445 |
| 217769_s_at | 1280 | 1844 | 1257 | 1486 | 1382 | 1480 | 1459 | 1140 | 1527 | 1805 | 1397 | 1242 | 1241 |
| 217778_at | 279.8 | 180.8 | 238.1 | 205.9 | 247 | 227 | 187.9 | 183.8 | 216.4 | 208.3 | 198.5 | 196.9 | 185.6 |
| 217824_at | 281.9 | 377.9 | 324.8 | 268.4 | 254.7 | 509.3 | 316.3 | 289.7 | 298.7 | 161.1 | 255.2 | 283.9 | 183.2 |
| 217987_at | 518.7 | 395.6 | 673.6 | 773.4 | 844.1 | 376.7 | 851.8 | 708.5 | 617.2 | 174.8 | 361.3 | 796.4 | 781.2 |
| 217995_at | 1917 | 1825 | 1310 | 1729 | 1761 | 1882 | 1866 | 1528 | 1291 | 1808 | 1613 | 1487 | 1756 |
| 218012_at | 288.7 | 171.5 | 223 | 229.5 | 299.9 | 147.2 | 264.8 | 255.2 | 220.4 | 189.7 | 206.8 | 230.3 | 220.4 |
| 218040_at | 251.7 | 344 | 305.4 | 382.5 | 333.9 | 372.6 | 380.2 | 356.9 | 353.2 | 286.6 | 389.9 | 360.2 | 357.8 |
| 218065_s_at | 907.3 | 1151 | 955.3 | 1110 | 1051 | 980 | 1025 | 950.8 | 967.2 | 927.9 | 1157 | 848.5 | 950 |
| 218091_at | 457.5 | 642.9 | 407.8 | 528.1 | 468.3 | 508.9 | 458.5 | 433.4 | 518.1 | 556.3 | 654.7 | 398.9 | 599 |
| 218125_s_at | 49.23 | 62.97 | 52.46 | 58.27 | 66.98 | 57.24 | 58.87 | 63.16 | 70.82 | 57.17 | 63.11 | 60.16 | 52.58 |
| 218127_at | 237.4 | 238.1 | 205.2 | 227.3 | 217 | 209.2 | 268.1 | 224.3 | 281.8 | 214 | 231.5 | 274.5 | 228.5 |
| 218143_s_at | 619.7 | 550.9 | 540.8 | 686 | 597.1 | 575.2 | 549.2 | 483.5 | 575.7 | 795 | 616.1 | 645.3 | 661.4 |
| 218206_x_at | 383.4 | 401.5 | 341.5 | 364 | 456.2 | 371.2 | 395.7 | 362.2 | 405.7 | 386.1 | 358 | 353 | 298.3 |
| 218289_s_at | 94.46 | 101.8 | 67.37 | 108.8 | 92.92 | 86.41 | 97.35 | 78.94 | 96.07 | 50.14 | 86.87 | 84.86 | 64.86 |
| 218325_s_at | 308.5 | 335.6 | 306.1 | 406.9 | 312.3 | 301 | 414.1 | 357.5 | 448.8 | 350.2 | 363.7 | 389.9 | 364.3 |
| 218351_at | 1127 | 1486 | 885.8 | 1160 | 855.3 | 1066 | 1124 | 975.2 | 1136 | 814.2 | 1144 | 1116 | 919.2 |
| 218499_at | 2404 | 2734 | 1827 | 2336 | 1788 | 2080 | 2692 | 1872 | 2238 | 1732 | 2725 | 2459 | 2030 |
| 218627_at | 481.4 | 244.1 | 239.1 | 280.5 | 416.1 | 350.5 | 306.4 | 358.3 | 376.7 | 373 | 961.5 | 301.6 | 389.5 |
| 218718_at | 221.7 | 103.5 | 107.7 | 172.9 | 124.2 | 120.9 | 101.6 | 158.8 | 208.5 | 167.9 | 155.8 | 106.3 | 75.07 |
| 218732_at | 288.1 | 284.8 | 211.4 | 255.9 | 208.8 | 267.6 | 218.8 | 254 | 270.8 | 184.3 | 255.6 | 189.7 | 203.3 |
| 218845_at | 1156 | 1008 | 997.3 | 878.9 | 931.5 | 881.1 | 1072 | 959.4 | 1129 | 985 | 1114 | 834.9 | 819.5 |
| 218962_s_at | 350.4 | 517.9 | 434.1 | 501.1 | 422.4 | 438.9 | 488.6 | 456.8 | 544.1 | 313.9 | 439.5 | 429.2 | 415 |
| 219130_at | 191.6 | 398 | 254.3 | 348.5 | 245.8 | 241.2 | 282.6 | 290.4 | 339.7 | 145.3 | 248.8 | 339.1 | 229.6 |
| 219316_s_at | 188 | 104 | 71.31 | 83.84 | 151.6 | 143.1 | 141.7 | 114.4 | 98.76 | 79.41 | 106 | 65.45 | 109.7 |
| 219343_at | 183.8 | 160.1 | 155.9 | 180.9 | 173.9 | 133.7 | 148 | 162.4 | 206.6 | 138 | 175.6 | 212.2 | 179.1 |
| 219358_s_at | 219.1 | 268.2 | 188.5 | 218 | 246.8 | 252.8 | 250.7 | 174.7 | 191.8 | 150.3 | 183.6 | 165.1 | 186.3 |
| 219418_at | 113.9 | 98.25 | 79.13 | 126.5 | 87.89 | 91.94 | 90.96 | 98.45 | 125.4 | 90.59 | 94.13 | 94.85 | 94.45 |
| 219507_at | 155.5 | 139 | 91.09 | 125.3 | 90.87 | 106.1 | 105.7 | 79.72 | 132.7 | 107.8 | 130.3 | 104.6 | 78.05 |
| 219765_at | 48.4 | 58.94 | 57.78 | 57.09 | 38.81 | 53.46 | 66.67 | 54.5 | 64.94 | 48.43 | 72.63 | 90.32 | 66.4 |
| 219787_s_at | 67.32 | 100.8 | 49.79 | 45.36 | 34.05 | 70.42 | 67.16 | 92.62 | 72.97 | 38.76 | 52.67 | 41.81 | 28.73 |
| 219822_at | 86.5 | 144.8 | 120 | 183.4 | 167.5 | 129.9 | 121 | 158.7 | 173.3 | 69.61 | 155 | 197 | 127.7 |
| 219826_at | 28.64 | 48.61 | 33.72 | 56.52 | 41.11 | 24.98 | 48.4 | 39.67 | 49.31 | 29.89 | 38.3 | 39.44 | 34.36 |
| 219952_s_at | 227.4 | 165.6 | 192.9 | 242.2 | 272.6 | 193.4 | 187.7 | 159.3 | 227.4 | 193.7 | 126.3 | 149.8 | 211.3 |
| 220044_x_at | 4441 | 5561 | 3943 | 5212 | 3980 | 4262 | 4554 | 4666 | 5407 | 4133 | 5234 | 5020 | 3639 |
| 220146_at | 153.2 | 244.7 | 183 | 166.2 | 163.2 | 91.25 | 215.9 | 147.5 | 188.7 | 57.37 | 148.2 | 132.7 | 88.86 |
| 220160_s_at | 88.84 | 87.99 | 63.3 | 61.8 | 79.93 | 62.79 | 98.27 | 62.76 | 62.94 | 75.64 | 83.51 | 63.18 | 63.31 |
| 220386_s_at | 394.1 | 477.5 | 410.1 | 538.5 | 276.9 | 476.1 | 526.8 | 657.1 | 615.5 | 512.1 | 658.8 | 747.7 | 537.1 |
| 220578_at | 96.87 | 104 | 96.76 | 82.59 | 70.16 | 85.07 | 113.3 | 79.31 | 125.1 | 61.74 | 89.09 | 71.24 | 84.1 |
| 220605_s_at | 216.7 | 164.4 | 147.6 | 141.7 | 148.7 | 150.5 | 162.2 | 148.2 | 168.9 | 160.3 | 127 | 140.9 | 147.5 |
| 220610_s_at | 131.7 | 111.8 | 144 | 90.8 | 96.4 | 194.5 | 144.7 | 113.8 | 137.8 | 132.9 | 140.1 | 75.32 | 120 |
| 220690_s_at | 119.9 | 110.4 | 86.98 | 114 | 124.3 | 161.2 | 98.93 | 123 | 142.2 | 96.85 | 120.7 | 109.5 | 117.3 |
| 220750_s_at | 82.12 | 102.8 | 103.3 | 107.6 | 86.89 | 105.4 | 91.92 | 86.53 | 82.64 | 141.3 | 73.17 | 91.65 | 82.06 |
| 220865_s_at | 77.24 | 94.59 | 48.99 | 79.99 | 94.67 | 68.21 | 78.91 | 58.26 | 120.7 | 55.86 | 90.82 | 50.47 | 69.69 |
| 220974_x_at | 208.1 | 219.6 | 199.8 | 184.4 | 192 | 247.1 | 227.5 | 207.6 | 214.7 | 226.8 | 177.6 | 199.8 | 147.6 |
| 221011_s_at | 545.3 | 837.2 | 533.4 | 827.4 | 718.5 | 514.4 | 791 | 827.5 | 803.8 | 457.2 | 824.1 | 1185 | 523.8 |
| 221206_at | 122.3 | 154.1 | 175.4 | 196.6 | 180.2 | 167.3 | 195.7 | 182.4 | 197.2 | 140.5 | 186.6 | 202.9 | 162.9 |
| 221264_s_at | 386.6 | 617.6 | 481 | 706.3 | 577.9 | 327.9 | 574.4 | 536.6 | 609.8 | 325.1 | 538.5 | 545.3 | 384.2 |
| 221428_s_at | 608.2 | 728.3 | 677 | 884.4 | 811.1 | 652.5 | 786.2 | 937.8 | 1167 | 622.8 | 945.9 | 1095 | 878.7 |
| 221449_s_at | 395.4 | 338.5 | 288.9 | 322.6 | 383.5 | 292.7 | 329.3 | 348.8 | 367.2 | 289 | 374.2 | 261 | 332.5 |
| 221580_s_at | 976.7 | 1105 | 944.3 | 1168 | 1035 | 1024 | 1069 | 1126 | 1324 | 790.5 | 1133 | 1107 | 950 |
| 221601_s_at | 1049 | 1560 | 2238 | 2092 | 1555 | 933.5 | 1777 | 1996 | 2357 | 1512 | 1864 | 1555 | 1484 |
| 221647_s_at | 462.9 | 483.2 | 518.1 | 497.6 | 416.8 | 476.7 | 436.8 | 494.8 | 464.9 | 546.1 | 460.5 | 410.9 | 423.4 |
| 221731_x_at | 8490 | 7006 | 7728 | 7235 | 10239 | 7646 | 8177 | 6539 | 5230 | 5949 | 8668 | 5347 | 7384 |
| 221757_at | 272.8 | 408.3 | 517.2 | 578.7 | 382.1 | 311.5 | 444.4 | 452.3 | 355 | 440.2 | 465.1 | 408.1 | 399.3 |
| 221841_s_at | 1601 | 1647 | 889.3 | 1476 | 1128 | 1498 | 1186 | 1253 | 2125 | 903.7 | 1274 | 1041 | 946.7 |
| 221868_at | 31.57 | 29.95 | 27.86 | 31.09 | 31.17 | 31.68 | 29 | 31.49 | 31.29 | 28.59 | 35.42 | 43.95 | 30.95 |
| 221960_s_at | 71.93 | 99.81 | 52 | 97.23 | 97.92 | 74.19 | 47.12 | 60.12 | 61.63 | 64.34 | 87.63 | 73.33 | 58.78 |
| 222217_s_at | 321 | 400.4 | 283.4 | 424.6 | 325.9 | 361.8 | 407.2 | 329.5 | 338.5 | 352.1 | 227.1 | 373.1 | 262 |
| 222231_s_at | 312.9 | 303.9 | 308.1 | 308.5 | 297.5 | 283.2 | 297.5 | 287.5 | 369.4 | 285.4 | 320.3 | 251.7 | 274.3 |
| 222574_s_at | 522.9 | 404.3 | 495.1 | 400.9 | 477.7 | 434.1 | 479.6 | 595.7 | 606.9 | 326.8 | 519.6 | 477.7 | 583.5 |
| 222605_at | 780.1 | 682.1 | 650.4 | 740.8 | 721.7 | 721.6 | 788.2 | 709.5 | 780.5 | 618.1 | 726.8 | 646.6 | 752 |
| 222651_s_at | 355.7 | 434.3 | 284.1 | 303.1 | 365.2 | 345.7 | 344.9 | 288 | 326.8 | 253.4 | 363.1 | 228.8 | 278.4 |
| 222670_s_at | 1172 | 1011 | 689.3 | 677 | 884.2 | 672.9 | 702.8 | 456.2 | 1074 | 517.5 | 679.2 | 449.1 | 655 |
| 222688_at | 364.7 | 320 | 287.6 | 336.9 | 346.4 | 407.8 | 312.5 | 205.6 | 335.2 | 185.8 | 218.6 | 303.3 | 218 |
| 222700_at | 535.1 | 432.9 | 543.4 | 506.5 | 474.4 | 521.7 | 506 | 525.5 | 584.7 | 325.2 | 519.2 | 457.4 | 453.5 |
| 222753_s_at | 198.8 | 256 | 167.4 | 209.3 | 189.6 | 199.1 | 185.7 | 176.6 | 276.4 | 186.6 | 208.6 | 176.2 | 184.9 |
| 222757_s_at | 131.1 | 77.92 | 88.91 | 83.79 | 121.4 | 115 | 95.87 | 104.1 | 115.1 | 107.2 | 120.4 | 77.09 | 100.2 |
| 222774_s_at | 63.04 | 48.73 | 34.65 | 43.97 | 65.31 | 38.54 | 46.52 | 58.04 | 79.27 | 55.14 | 63.61 | 39.96 | 39.37 |
| 222884_at | 75.78 | 91.75 | 116.6 | 102.6 | 99.38 | 107.7 | 100.5 | 109.2 | 110.8 | 92.42 | 89.93 | 101.8 | 105.1 |
| 222980_at | 2762 | 3003 | 2272 | 2810 | 2193 | 2722 | 2587 | 1786 | 2538 | 2736 | 2172 | 2145 | 2281 |
| 222982_x_at | 4228 | 4895 | 3701 | 4149 | 3652 | 4341 | 3952 | 4199 | 3613 | 3141 | 3764 | 4057 | 3463 |
| 223023_at | 280 | 275.9 | 296.1 | 292.5 | 277.5 | 251.5 | 312.5 | 315.7 | 304.6 | 298.3 | 225.1 | 284 | 295.1 |
| 223064_at | 1397 | 1282 | 1354 | 1358 | 1481 | 1292 | 1527 | 1455 | 1433 | 1305 | 1474 | 1341 | 1364 |
| 223158_s_at | 165.8 | 109.1 | 161.5 | 109.8 | 128.5 | 173.5 | 202.7 | 149.9 | 176.1 | 111.7 | 128.2 | 77.15 | 169.2 |
| 223380_s_at | 438.8 | 319 | 340.7 | 322.9 | 367.4 | 423.2 | 382 | 350.3 | 406 | 289.7 | 270.4 | 265.5 | 345.1 |
| 223444_at | 810.2 | 959.2 | 674.1 | 959.6 | 810.3 | 722.4 | 816.2 | 605.7 | 632.1 | 637 | 837.9 | 840.5 | 777.4 |
| 223465_at | 505.8 | 618.5 | 458 | 447.7 | 430.7 | 594.5 | 421.6 | 414.9 | 598.3 | 357.2 | 469.6 | 432.6 | 506.4 |
| 223590_at | 360.2 | 443.1 | 414.2 | 442.4 | 494.4 | 414.7 | 403.4 | 518.8 | 475 | 337.1 | 424.1 | 479 | 360.2 |
| 223686_at | 195.3 | 236.3 | 202.5 | 206.5 | 213.1 | 247 | 220.4 | 235 | 296.7 | 175.3 | 194.8 | 176.8 | 179.7 |
| 223801_s_at | 31.09 | 30.63 | 35.18 | 28.31 | 29.98 | 30.63 | 29.01 | 30.91 | 30.57 | 40.75 | 31.67 | 31.13 | 32.45 |
| 223922_x_at | 2083 | 2159 | 2528 | 2120 | 2225 | 2294 | 2055 | 2947 | 1673 | 2191 | 2124 | 1220 | 1888 |
| 223982_s_at | 1166 | 1369 | 795.3 | 1007 | 988.5 | 1115 | 1012 | 935.4 | 1183 | 721 | 1083 | 1024 | 1106 |
| 224046_s_at | 239.7 | 240.5 | 320 | 360.7 | 332.3 | 296.4 | 295.6 | 402.9 | 494.5 | 308.8 | 556.5 | 351.4 | 429.3 |
| 224374_s_at | 713.2 | 449 | 499.8 | 532.2 | 704.5 | 578.6 | 526.8 | 373 | 509.9 | 479.3 | 405.2 | 328.9 | 443.9 |
| 224387_at | 88.42 | 67.5 | 53.57 | 91.75 | 82.27 | 74.26 | 73.5 | 48.18 | 99.42 | 64.28 | 83.02 | 42.53 | 64.04 |
| 224439_x_at | 362 | 500.2 | 443.9 | 476 | 436.4 | 561.6 | 469.8 | 372.6 | 476.1 | 433.9 | 475 | 420.2 | 380.9 |
| 224518_s_at | 197.3 | 316.7 | 145.7 | 194.5 | 230.4 | 275.8 | 356.7 | 198.2 | 329.9 | 127.9 | 253.1 | 295.4 | 251.4 |
| 224582_s_at | 199.9 | 278.3 | 212.2 | 279.4 | 220.5 | 249.7 | 301.3 | 370.6 | 359.3 | 210.6 | 288.4 | 284.4 | 222.1 |
| 224591_at | 2790 | 2835 | 2309 | 3411 | 2988 | 2924 | 3011 | 2860 | 3193 | 2410 | 3124 | 3268 | 2512 |
| 224726_at | 207.3 | 297.9 | 223.5 | 282 | 206.3 | 231.4 | 181.3 | 136.4 | 200.8 | 198.7 | 200.2 | 188.5 | 233.1 |
| 224818_at | 712.1 | 681.7 | 610.9 | 659.7 | 682.9 | 753 | 706.7 | 679.4 | 817 | 762.1 | 655.4 | 544 | 733.7 |
| 224917_at | 2886 | 2898 | 2801 | 3091 | 2744 | 2693 | 2753 | 2022 | 1890 | 2993 | 2722 | 1825 | 2538 |
| 224918_x_at | 310.7 | 354.5 | 356.5 | 605.4 | 481.5 | 549.7 | 413 | 376.8 | 403.9 | 439.1 | 613 | 376.2 | 434.1 |
| 224928_at | 318.3 | 335.4 | 257.1 | 317.1 | 274.7 | 323.3 | 292.9 | 273.5 | 298 | 316.3 | 315.4 | 230.1 | 195.9 |
| 225059_at | 1214 | 1040 | 1208 | 1288 | 1855 | 1469 | 1530 | 1444 | 1667 | 1721 | 1447 | 1110 | 1624 |
| 225064_at | 281.9 | 447.5 | 370.6 | 404.6 | 320.6 | 304.7 | 428.2 | 447.6 | 595 | 325.9 | 404 | 423.5 | 354.2 |
| 225107_at | 2503 | 2552 | 2508 | 3022 | 2690 | 2778 | 3071 | 2755 | 3330 | 2444 | 3011 | 2726 | 2244 |
| 225188_at | 55.98 | 91.47 | 34.57 | 107.8 | 53.79 | 101.6 | 47.72 | 53.84 | 185.1 | 41.23 | 94.11 | 35.93 | 33.91 |
| 225341_at | 34.67 | 56.2 | 58.65 | 34.26 | 51 | 56.03 | 46.53 | 41.5 | 49.78 | 34.39 | 36.08 | 62.07 | 51.78 |
| 225358_at | 77.36 | 97.08 | 82.87 | 88.11 | 84.05 | 64.85 | 81.87 | 106.8 | 125.4 | 90.04 | 103.4 | 97.69 | 81.77 |
| 225365_at | 2471 | 3773 | 1729 | 2369 | 2722 | 2642 | 2718 | 2076 | 2650 | 1845 | 2756 | 2543 | 1968 |
| 225388_at | 41.04 | 42.81 | 24.4 | 41.42 | 27.07 | 40.27 | 52.74 | 45.99 | 60.62 | 39.18 | 44.02 | 43.95 | 33.51 |
| 225456_at | 350 | 367.4 | 274.6 | 333.8 | 321.6 | 311 | 312.9 | 286.9 | 385.1 | 230.6 | 352.2 | 359.3 | 291.8 |
| 225763_at | 2830 | 3140 | 3035 | 3097 | 2814 | 2612 | 3044 | 2872 | 2830 | 3752 | 3321 | 2935 | 3314 |
| 225844_at | 242.4 | 260.1 | 170.9 | 267.9 | 312.8 | 240.2 | 249.5 | 201.7 | 216.3 | 172.3 | 248.2 | 185.5 | 176.4 |
| 225866_at | 70.52 | 110.6 | 116.6 | 124.6 | 116.7 | 103.7 | 106.2 | 89.14 | 139.7 | 56.18 | 150.9 | 89.51 | 89.14 |
| 225870_s_at | 821.7 | 686.7 | 589.3 | 691.4 | 660.9 | 687 | 732 | 887.7 | 851.5 | 705.2 | 747.4 | 568.6 | 547.2 |
| 226000_at | 30.78 | 31.24 | 30.09 | 24.36 | 23.93 | 31.17 | 31.77 | 27.56 | 40.15 | 38.45 | 29.8 | 24.58 | 25.76 |
| 226030_at | 81.75 | 125 | 85.08 | 122.5 | 108.6 | 89.46 | 99.75 | 120.9 | 106.7 | 55.58 | 154.5 | 113.6 | 79.24 |
| 226042_at | 84.02 | 56.62 | 70.99 | 100.3 | 69.83 | 77.43 | 103.3 | 78.02 | 92.01 | 87.06 | 82.85 | 82.06 | 86.91 |
| 226059_at | 56.19 | 86.75 | 46.42 | 46.69 | 40.04 | 41.08 | 57.84 | 57.37 | 50.91 | 38.98 | 51.22 | 54.9 | 47.74 |
| 226115_at | 341.1 | 245.7 | 294.7 | 271.5 | 294.5 | 311 | 289.3 | 303.3 | 184.2 | 390.4 | 263.2 | 274.6 | 303.6 |
| 226127_at | 87.39 | 86.48 | 87.7 | 98.74 | 78.89 | 87.44 | 93.48 | 86.7 | 97.87 | 79.44 | 88.58 | 87.47 | 81.29 |
| 226218_at | 4572 | 4038 | 4435 | 5476 | 3907 | 4081 | 5650 | 4597 | 4454 | 3964 | 4303 | 6976 | 2379 |
| 226220_at | 97.56 | 124.6 | 54.49 | 148.8 | 214 | 109.9 | 88.18 | 88.83 | 82.58 | 94.28 | 107.2 | 185.9 | 83.92 |
| 226323_at | 524 | 536.6 | 456 | 571.9 | 546.6 | 427.4 | 559.8 | 586.1 | 559.4 | 455.1 | 552.9 | 580.7 | 461.8 |
| 226353_at | 1226 | 1356 | 960.9 | 1048 | 1289 | 1318 | 1143 | 1111 | 1171 | 1369 | 1048 | 937.2 | 936.7 |
| 226428_at | 206.4 | 194.6 | 162.2 | 199.4 | 201.1 | 157.4 | 176.2 | 218.3 | 184.3 | 143.1 | 172.8 | 173 | 187.1 |
| 226459_at | 3185 | 3409 | 1920 | 1942 | 2283 | 2204 | 3268 | 1884 | 2502 | 2705 | 2297 | 2184 | 2331 |
| 226503_at | 290.2 | 342 | 224.8 | 279.4 | 266.4 | 184.2 | 317.5 | 212.5 | 243.8 | 150.2 | 206.3 | 259.3 | 235.7 |
| 226683_at | 2201 | 2587 | 2332 | 2298 | 2997 | 2114 | 2052 | 2404 | 2845 | 3109 | 3091 | 2068 | 2867 |
| 226718_at | 57.85 | 73.92 | 83.75 | 102.3 | 70.27 | 67.68 | 57.78 | 86.55 | 76.33 | 72.36 | 73.52 | 77.16 | 72.36 |
| 226763_at | 250 | 242 | 180.8 | 201.3 | 215.9 | 264.5 | 235.3 | 133.4 | 213.7 | 177 | 202.5 | 216.1 | 174.9 |
| 226836_at | 36.65 | 39.49 | 35.68 | 31.82 | 34.76 | 34.49 | 38.61 | 35.32 | 35.37 | 39.7 | 38.09 | 36.06 | 33.66 |
| 227020_at | 855 | 901.1 | 816.7 | 803.8 | 909.6 | 817.4 | 705.4 | 681 | 769 | 645.4 | 800.7 | 632.4 | 745.1 |
| 227114_at | 88.72 | 82.59 | 85.37 | 139.6 | 100.9 | 81.5 | 111.5 | 129.9 | 133.5 | 105.4 | 107.6 | 108.7 | 72.87 |
| 227149_at | 58.84 | 49.67 | 49.5 | 85.94 | 55.6 | 76.12 | 59.28 | 97.27 | 72.64 | 49.98 | 64.85 | 82.64 | 81.18 |
| 227173_s_at | 59.55 | 87.2 | 144.5 | 90.36 | 111.1 | 57.19 | 119.7 | 128.9 | 101.4 | 71.34 | 148.6 | 73.79 | 107.6 |
| 227213_at | 63.48 | 68.63 | 50.88 | 81.46 | 64.51 | 43.08 | 53.39 | 63.4 | 89.84 | 50.67 | 64.33 | 55.32 | 48.98 |
| 227374_at | 32.59 | 58.5 | 39.16 | 74.73 | 41.19 | 46.81 | 49.27 | 50.75 | 80.19 | 52.86 | 59.7 | 57.62 | 42.64 |
| 227517_s_at | 281.1 | 397.6 | 481.7 | 601.3 | 391.7 | 389.6 | 436.1 | 523.4 | 597.9 | 316 | 497.6 | 325.5 | 366.5 |
| 227558_at | 1131 | 1017 | 1105 | 1401 | 1370 | 1218 | 1096 | 1090 | 1201 | 1192 | 1259 | 1334 | 1343 |
| 227560_at | 68.8 | 105.2 | 88.7 | 97.67 | 79.46 | 79.64 | 86.35 | 93.47 | 102.3 | 76.92 | 99.87 | 86.67 | 71.73 |
| 227722_at | 17.99 | 73.47 | 238.9 | 331.2 | 43.74 | 42.95 | 232.7 | 165.6 | 77.21 | 80.57 | 51.38 | 54 | 201.6 |
| 227990_at | 1115 | 1195 | 849 | 963.8 | 1074 | 1018 | 1235 | 848.8 | 908.2 | 645.7 | 877.3 | 1151 | 996.5 |
| 228012_at | 22.9 | 26.51 | 19.72 | 28.52 | 22.42 | 26.94 | 29.39 | 25.82 | 28.72 | 18.98 | 30.96 | 25.65 | 23.78 |
| 228170_at | 503.1 | 540.9 | 535.7 | 789.9 | 426.2 | 947.6 | 1046 | 566 | 1335 | 200.6 | 671.3 | 674.8 | 510.6 |
| 228176_at | 236.1 | 288.8 | 222.6 | 365.6 | 347.6 | 216.4 | 233.2 | 251 | 119 | 339.5 | 307.1 | 206.7 | 180.9 |
| 228234_at | 438.8 | 452.2 | 283.6 | 431.2 | 486.5 | 356.4 | 388 | 303.5 | 360.4 | 377.9 | 398.6 | 305.4 | 383.1 |
| 228370_at | 102.9 | 196.5 | 157.4 | 251 | 142.1 | 157.7 | 162.2 | 169.2 | 157.8 | 75.17 | 135.3 | 227 | 106.8 |
| 228549_at | 256 | 267.4 | 527.2 | 518.6 | 404.1 | 378.5 | 442.7 | 493 | 320.8 | 318 | 593.7 | 360 | 433.1 |
| 228630_at | 68.68 | 90.87 | 80.08 | 140.3 | 84.7 | 86.5 | 89.83 | 95.08 | 115.4 | 52.05 | 93.93 | 90.59 | 71.87 |
| 228831_s_at | 86.75 | 140.6 | 198.4 | 132.6 | 194.7 | 123.9 | 175.2 | 283 | 189.4 | 170.4 | 220.4 | 163.5 | 127.9 |
| 229307_at | 76.65 | 89.86 | 31.74 | 32.44 | 33.25 | 66.53 | 73.39 | 113.7 | 48.94 | 21.77 | 43.77 | 41.91 | 19 |
| 229421_s_at | 51.84 | 38.55 | 32.83 | 31.15 | 35.77 | 42.78 | 37.18 | 62.57 | 36.19 | 37.76 | 43.28 | 39.28 | 47.82 |
| 229509_at | 208.3 | 274.7 | 233 | 226.5 | 193.3 | 208.3 | 210.3 | 288.2 | 241.9 | 191.7 | 225.6 | 244.7 | 204.3 |
| 229854_at | 25.35 | 22.54 | 25.45 | 24.46 | 28.18 | 25.3 | 27.82 | 25.23 | 22.93 | 30.96 | 29.07 | 35.89 | 25.2 |
| 229982_at | 79.71 | 134.2 | 141.5 | 119.2 | 84.81 | 98.74 | 106.8 | 69.62 | 70.21 | 78.17 | 111.1 | 81.5 | 73.55 |
| 230265_at | 170.5 | 333.6 | 127.6 | 169.4 | 148 | 175.9 | 192.7 | 154.8 | 131.1 | 133.3 | 141.8 | 149.5 | 186.3 |
| 230320_at | 127 | 128.5 | 126.4 | 150.7 | 155.2 | 130.5 | 149.7 | 162.5 | 153.5 | 108.9 | 142.2 | 168.1 | 113.8 |
| 230408_at | 76.68 | 80.83 | 97.04 | 114.3 | 80.02 | 76.83 | 110.1 | 108.6 | 125 | 77.89 | 104.1 | 90.25 | 85.22 |
| 230480_at | 70.53 | 66.52 | 51.16 | 49.76 | 79.08 | 74.77 | 68.44 | 58.24 | 63.73 | 37.66 | 64.91 | 59.34 | 45.56 |
| 230837_at | 94.52 | 56.91 | 63.19 | 66.75 | 98.18 | 64 | 75.5 | 94.63 | 87.2 | 79.93 | 95.75 | 88.22 | 90.96 |
| 230852_at | 63.94 | 50.55 | 37.18 | 63.88 | 65.34 | 55.17 | 57.74 | 47.71 | 41.09 | 50.49 | 36.62 | 36.32 | 45.84 |
| 230922_x_at | 44.12 | 43.5 | 40.3 | 37.98 | 58.77 | 46 | 43.37 | 44.49 | 44.63 | 36.61 | 52.86 | 62.89 | 42.58 |
| 231283_at | 145.7 | 168.5 | 188.9 | 198.1 | 180.5 | 138.2 | 226.7 | 245.9 | 236.7 | 137.7 | 186 | 253.6 | 165.7 |
| 231697_s_at | 114.9 | 107 | 69.68 | 101.2 | 141.3 | 70.47 | 62.41 | 37.54 | 64.15 | 58.71 | 71.05 | 59.11 | 55.12 |
| 231836_at | 53.57 | 53.77 | 78.17 | 76.84 | 61.98 | 69.09 | 62.98 | 63.75 | 55.61 | 60.93 | 65.75 | 63.3 | 63.88 |
| 231843_at | 131.6 | 183.9 | 171.1 | 194.3 | 167.5 | 173.3 | 221.8 | 151.3 | 175.7 | 79.53 | 167.9 | 229.9 | 140 |
| 231845_at | 94.5 | 89.46 | 116.5 | 119 | 125.6 | 103.4 | 122.3 | 122.5 | 129.8 | 84.2 | 116.2 | 118.9 | 87.01 |
| 231904_at | 269.8 | 312 | 519 | 381.8 | 385.4 | 496.9 | 448.1 | 505.5 | 412.3 | 315.9 | 386.8 | 388.3 | 416.9 |
| 231914_at | 48.72 | 48.24 | 49.05 | 53.4 | 47.88 | 65.72 | 47.81 | 48.38 | 48.66 | 53.25 | 44.61 | 45.47 | 46.63 |
| 232636_at | 71.14 | 71.7 | 57.31 | 88.97 | 112.5 | 125.8 | 62.93 | 73.04 | 76.27 | 32.47 | 91.3 | 28.53 | 54.91 |
| 232851_at | 78.62 | 37.81 | 43.21 | 39.15 | 64.2 | 41.7 | 66.35 | 44.05 | 51.31 | 48.42 | 48.56 | 51.64 | 42.61 |
| 233019_at | 316.7 | 332.5 | 308.9 | 338.7 | 317.7 | 266.2 | 285.5 | 313.7 | 365.3 | 195.7 | 262.1 | 335.7 | 270.7 |
| 233169_at | 131.7 | 78.65 | 143.5 | 120.9 | 89.92 | 97.54 | 108.4 | 125.3 | 100.6 | 122.9 | 112.2 | 145 | 121.8 |
| 234013_at | 60.3 | 344.9 | 69.84 | 82.3 | 94.35 | 55.43 | 70.7 | 129.8 | 75.29 | 99.61 | 74.65 | 364.2 | 99.3 |
| 234311_s_at | 105.9 | 161.1 | 145.2 | 131.2 | 145.8 | 122.4 | 152.2 | 186.4 | 149.1 | 106 | 183.5 | 169.7 | 135.2 |
| 234339_s_at | 1313 | 1256 | 1891 | 2109 | 1751 | 1086 | 2060 | 2188 | 2069 | 1244 | 1820 | 1692 | 1140 |
| 234464_s_at | 53.74 | 59.77 | 29.99 | 49.53 | 56.21 | 31.89 | 30.16 | 29.06 | 33.18 | 33.9 | 33.37 | 33.22 | 30.56 |
| 234733_s_at | 36.09 | 27.74 | 28.95 | 25.41 | 24.58 | 26.84 | 27.06 | 54.07 | 31.84 | 18.97 | 55.76 | 32.21 | 25.88 |
| 235024_at | 94.93 | 73.5 | 89.32 | 87.27 | 90.48 | 93.71 | 93.56 | 76.68 | 103.4 | 86.58 | 85.6 | 76.92 | 99.59 |
| 235067_at | 803.7 | 922.4 | 1141 | 995.7 | 961.5 | 594.1 | 931.3 | 1054 | 725.6 | 663.2 | 742.1 | 1053 | 949.1 |
| 235200_at | 94.26 | 125.2 | 124.1 | 148.6 | 151.1 | 81.11 | 127.2 | 110.1 | 140.2 | 86.64 | 112.9 | 125.2 | 117.4 |
| 235359_at | 322.9 | 352.7 | 231.5 | 436.2 | 263.8 | 296 | 369.5 | 248.8 | 370.4 | 341.6 | 306.1 | 278.4 | 253.3 |
| 235593_at | 867.2 | 869.8 | 835.4 | 696.3 | 637 | 956 | 852.8 | 768.7 | 764.5 | 632.1 | 849.3 | 817.4 | 558.3 |
| 235610_at | 38.29 | 61.96 | 41.98 | 69.58 | 40.44 | 52.77 | 67.48 | 49.11 | 71.34 | 38.23 | 48.99 | 72.02 | 41.02 |
| 235623_at | 23.8 | 34.24 | 28.3 | 30.31 | 27.72 | 26.39 | 35.99 | 27.93 | 28.24 | 19.21 | 24.82 | 29.72 | 23.15 |
| 235690_at | 24.7 | 36.18 | 18.01 | 25.27 | 29.81 | 23.74 | 25.7 | 24.45 | 24.2 | 24.77 | 26.03 | 24.39 | 23.43 |
| 237504_at | 60.85 | 70.71 | 68.68 | 75.08 | 69.18 | 83.05 | 80.94 | 63.33 | 73.03 | 32.45 | 68.76 | 79.74 | 60.62 |
| 238429_at | 4916 | 3142 | 3329 | 3440 | 4963 | 4290 | 4026 | 4438 | 4433 | 3358 | 3978 | 3264 | 4557 |
| 238513_at | 1395 | 1191 | 1006 | 707.8 | 1547 | 2775 | 1037 | 1038 | 994.2 | 1269 | 1118 | 973.1 | 1127 |
| 238736_at | 256.5 | 275.5 | 256.6 | 293.3 | 241.2 | 309 | 254.3 | 276.3 | 269.9 | 203.5 | 275.3 | 281 | 221.3 |
| 238823_at | 40.29 | 33.64 | 41.83 | 48.75 | 49.24 | 40.86 | 67.21 | 43.66 | 44.48 | 34.38 | 30.58 | 48.18 | 36.29 |
| 238909_at | 195.5 | 342.4 | 191.8 | 149.2 | 102.9 | 355.6 | 192.3 | 212.5 | 226.5 | 135 | 202.5 | 162.4 | 103.2 |
| 239108_at | 424.5 | 339.3 | 266.5 | 166.5 | 212.8 | 399 | 298.6 | 394 | 276.8 | 293.9 | 213 | 177.2 | 198.9 |
| 239897_at | 186.4 | 258.4 | 208.1 | 210.5 | 148.4 | 226.5 | 197.5 | 213.6 | 223.1 | 200.2 | 219.8 | 206.4 | 255 |
| 241368_at | 290 | 248.8 | 521.9 | 273.7 | 345.4 | 317.9 | 243.5 | 315.1 | 244.3 | 294.2 | 239.1 | 225 | 349.2 |
| 241704_x_at | 45.02 | 67.46 | 51.59 | 58.53 | 44.08 | 49.76 | 62.49 | 59.23 | 59.08 | 46.17 | 59.14 | 65.17 | 46.32 |
| 241706_at | 119.7 | 156.8 | 128.6 | 126.3 | 117 | 121 | 114.6 | 115.3 | 151.6 | 134.7 | 142.7 | 141.6 | 74.22 |
| 241731_x_at | 45.3 | 57.92 | 50.3 | 71.52 | 64.86 | 43.84 | 59.45 | 56.11 | 57.67 | 37.5 | 50.51 | 63.49 | 60.68 |
| 242197_x_at | 72.02 | 92.48 | 62.82 | 131 | 80.4 | 57.05 | 69.4 | 20.75 | 67.6 | 56.56 | 72.21 | 36.66 | 41.66 |
| 242561_at | 26.35 | 24.54 | 25 | 22.43 | 24.64 | 27.12 | 25.98 | 35.16 | 24.64 | 23.99 | 33.11 | 43.87 | 24.53 |
| 242569_at | 278.1 | 269.6 | 237.2 | 252.5 | 305.8 | 241.2 | 316.2 | 251.3 | 258.2 | 168.9 | 310.9 | 276.8 | 414 |
| 242669_at | 182.3 | 302.8 | 226.5 | 199.7 | 216.1 | 227.3 | 254.2 | 190 | 293.9 | 161.2 | 244.7 | 262.3 | 174 |
| 243982_at | 112.6 | 118.8 | 108.8 | 106.8 | 122 | 128.2 | 95.34 | 122.1 | 89.86 | 52.74 | 111.5 | 129 | 94.06 |
| 244038_at | 41.32 | 57.24 | 46.24 | 55.48 | 36.88 | 41.54 | 50.26 | 52.19 | 47.95 | 36.84 | 45.34 | 45.88 | 44.09 |
| 244654_at | 1456 | 2923 | 1950 | 2208 | 1527 | 2269 | 2217 | 1973 | 1843 | 1723 | 1582 | 2845 | 1515 |
| 244698_at | 31.83 | 35.78 | 36.88 | 28.18 | 32.65 | 32.98 | 32.15 | 35.59 | 32.72 | 39.66 | 34.25 | 33.81 | 36.88 |
| 36566_at | 208.1 | 111.7 | 115 | 120.4 | 117.9 | 110 | 136.6 | 125.2 | 207.2 | 81.32 | 115.1 | 102.9 | 121.7 |
| 37549_g_at | 45.47 | 42.21 | 42.53 | 45.44 | 45.56 | 45.49 | 42.39 | 50.74 | 53.88 | 47.97 | 43.29 | 50.59 | 39.84 |
| 48659_at | 223.6 | 220.9 | 207.7 | 237.4 | 234.5 | 277.9 | 208.9 | 206.2 | 192.2 | 240.3 | 197.4 | 196.7 | 253 |
| 56829_at | 184 | 169.3 | 196.8 | 164.2 | 156.5 | 144 | 171.6 | 172.2 | 138.8 | 159.6 | 140.4 | 149.2 | 191.8 |
| 64486_at | 277.6 | 180.8 | 230.5 | 295.9 | 318.7 | 211.1 | 202 | 200.6 | 235.8 | 278 | 228.6 | 182.7 | 200.2 |
| 65493_at | 42.6 | 49.49 | 35.65 | 39.75 | 39.12 | 58.71 | 35.75 | 39.51 | 87.52 | 43.06 | 44.08 | 42.55 | 39.23 |
| AFFX- | 8437 | 9063 | 10125 | 9752 | 9276 | 10110 | 9064 | 8917 | 8992 | 11821 | 9821 | 8333 | 8845 |
| HUMGAPDH/M33197_3_at | | | | | | | | | | | | | |
| | NYHA | NYHA | NYHA | NYHA | NYHA | NYHA | NYHA | NYHA | NYHA | NYHA | NYHA III- | NYHA III- | NYHA III- |
| | I-II | I-II | I-II | I-II | I-II | I-II | I-II | I-II | I-II | I-II | IV | IV | IV |
| Affymetrix Probe | Sample | Sample | Sample | Sample | Sample | Sample | Sample | Sample | Sample | Sample | Sample | Sample | Sample |
| set ID | no. 66 | no. 74 | no. 76 | no. 83 | no. 85 | no. 86 | no. 87 | no. 89 | no. 91 | no. 94 | no. 22 | no. 25 | no. 26 |
| 1552318_at | 1732 | 2576 | 1546 | 1209 | 2337 | 1507 | 2104 | 1567 | 1454 | 1055 | 1462 | 1525 | 2204 |
| 1552630_a_at | 57.95 | 79.02 | 83.95 | 98 | 50.97 | 59.01 | 117.5 | 62.9 | 84.38 | 56.57 | 90.68 | 92.52 | 70.21 |
| 1554149_at | 984.4 | 1276 | 734 | 537.9 | 610 | 533.3 | 839.7 | 683.5 | 439.8 | 668.6 | 690.5 | 652.3 | 747.7 |
| 1554539_a_at | 87.01 | 145.9 | 104.2 | 79.77 | 107.6 | 78.57 | 131.2 | 109.4 | 72.8 | 72.26 | 60.84 | 85.69 | 64.46 |
| 1554606_at | 119.1 | 159.8 | 145.2 | 113.8 | 145.6 | 88.25 | 165.8 | 145.8 | 113.9 | 88.49 | 79.05 | 84.22 | 92.66 |
| 1555630_a_at | 110.8 | 123 | 169.4 | 129.3 | 116.7 | 209.9 | 217 | 176.5 | 120.2 | 147.7 | 134.4 | 168 | 122.3 |
| 1555963_x_at | 59.97 | 62.17 | 47.02 | 59.51 | 36.69 | 64.99 | 49.26 | 61.11 | 59.29 | 45.86 | 29.64 | 42.85 | 47.06 |
| 1555996_s_at | 851.3 | 1185 | 1036 | 830.8 | 1109 | 783.1 | 1140 | 865 | 998.7 | 749 | 707.2 | 483.6 | 984.8 |
| 1556113_at | 40.34 | 32.39 | 53.77 | 45 | 35.95 | 33.34 | 34.24 | 33.2 | 41.1 | 37.43 | 38.36 | 38.42 | 43.81 |
| 1556283_s_at | 88.93 | 131.6 | 158.6 | 108.6 | 163.9 | 140.7 | 113 | 135.7 | 154.2 | 127.3 | 108.9 | 109.6 | 131.8 |
| 1556864_at | 44.63 | 41.71 | 47.51 | 41.32 | 47.51 | 46.75 | 35.47 | 30.76 | 47.54 | 36.58 | 47.29 | 45.51 | 47.24 |
| 1557066_at | 158.7 | 157.3 | 121.1 | 159.6 | 149.6 | 121.4 | 161.5 | 132.4 | 169.4 | 145.9 | 140.4 | 156.1 | 173.6 |
| 1558277_at | 48.98 | 57.24 | 22.42 | 48.46 | 41.52 | 84.18 | 90.77 | 28.69 | 59.93 | 46.19 | 37.09 | 45.59 | 56.98 |
| 1558755_x_at | 81.77 | 166.3 | 102.9 | 156.2 | 146.4 | 79.41 | 155.9 | 110 | 91.45 | 82.29 | 170.7 | 128 | 126.7 |
| 1561146_at | 61.51 | 65.3 | 35.81 | 53.06 | 52.11 | 38.93 | 62.6 | 41.15 | 72.68 | 63.11 | 93.26 | 81.58 | 70.28 |
| 1564962_at | 25.25 | 31.73 | 38.91 | 26.97 | 30.49 | 21.36 | 30.71 | 37.98 | 30.38 | 24.22 | 22.64 | 20.41 | 30.84 |
| 1567013_at | 83.08 | 94.09 | 143.9 | 132.6 | 101.4 | 113.1 | 103.7 | 141.1 | 105.2 | 131 | 103 | 97.89 | 102.9 |
| 1568815_a_at | 154.3 | 130.7 | 130.2 | 93.82 | 94.45 | 89.65 | 120.7 | 78.26 | 88.13 | 105 | 141.7 | 154.3 | 134.9 |
| 200007_at | 8293 | 8130 | 8105 | 7284 | 8926 | 8921 | 8575 | 9365 | 7561 | 7267 | 7690 | 7144 | 7913 |
| 200010_at | 15685 | 14379 | 10571 | 9282 | 14613 | 11413 | 15012 | 13378 | 11676 | 11512 | 12330 | 12671 | 12604 |
| 200059_s_at | 9983 | 9920 | 11292 | 11775 | 10696 | 11745 | 10589 | 11983 | 10627 | 10271 | 10747 | 10482 | 10637 |
| 200091_s_at | 23466 | 27366 | 16148 | 15638 | 22950 | 18472 | 26059 | 20457 | 17844 | 21458 | 19835 | 21742 | 21094 |
| 200633_at | 10654 | 9348 | 10428 | 7489 | 8937 | 9590 | 9530 | 10221 | 8680 | 8535 | 8086 | 8587 | 10960 |
| 200650_s_at | 5095 | 6730 | 7125 | 4389 | 5608 | 7846 | 8084 | 5918 | 5536 | 6534 | 5244 | 5215 | 5539 |
| 200672_x_at | 209 | 184.3 | 133.9 | 131.8 | 170.2 | 146.7 | 184 | 123.1 | 129.7 | 133.9 | 117.8 | 109.4 | 135.2 |
| 200677_at | 2725 | 2274 | 3531 | 2992 | 2234 | 3336 | 2107 | 3120 | 2861 | 3161 | 2675 | 2558 | 2711 |
| 200713_s_at | 1663 | 1387 | 1781 | 1610 | 1345 | 1760 | 1593 | 1838 | 1598 | 1441 | 1385 | 1264 | 1630 |
| 200822_x_at | 1349 | 1272 | 1569 | 1369 | 1300 | 1613 | 1569 | 1670 | 1432 | 1333 | 1405 | 1317 | 1345 |
| 200829_x_at | 698.7 | 617.6 | 742.7 | 496.9 | 642.3 | 674.2 | 650.2 | 644.4 | 616.2 | 583.4 | 517.5 | 542.2 | 662 |
| 200839_s_at | 2614 | 2585 | 3481 | 3308 | 3030 | 4908 | 4456 | 3140 | 3124 | 3254 | 3405 | 4019 | 3387 |
| 200932_s_at | 439.3 | 449.7 | 535.5 | 446.3 | 433.1 | 456.8 | 676.6 | 526.1 | 467.7 | 474 | 444.6 | 521.7 | 486.9 |
| 200950_at | 455.1 | 480.3 | 577.1 | 645.1 | 473.9 | 579.9 | 494.1 | 607.3 | 584.9 | 597.6 | 459.5 | 473.4 | 534.4 |
| 201031_s_at | 10296 | 9061 | 7083 | 6355 | 8552 | 7545 | 10827 | 6774 | 7560 | 7402 | 8451 | 9607 | 9273 |
| 201075_s_at | 304.7 | 293 | 312.4 | 319.8 | 259.4 | 261 | 343.8 | 334.7 | 291.8 | 269.2 | 324 | 276.3 | 313.1 |
| 201098_at | 823.2 | 732.4 | 945.7 | 873.9 | 769.3 | 1020 | 902.5 | 855.7 | 800.3 | 831.8 | 744.3 | 765.4 | 899.7 |
| 201105_at | 4335 | 4600 | 4779 | 2480 | 3009 | 5583 | 4661 | 3657 | 4276 | 3068 | 2286 | 4382 | 5012 |
| 201172_x_at | 3426 | 3390 | 4234 | 3763 | 3452 | 3769 | 3074 | 4020 | 3595 | 3792 | 3659 | 3313 | 3678 |
| 201186_at | 654.7 | 377.9 | 664.1 | 653.5 | 446.9 | 630.1 | 477.7 | 592.7 | 451.4 | 738.8 | 537.8 | 482.9 | 473.8 |
| 201193_at | 433.5 | 389.8 | 628 | 518.6 | 554.2 | 768.7 | 799.9 | 612.3 | 577.8 | 679.3 | 533.3 | 616.4 | 771.3 |
| 201198_s_at | 177.6 | 157.2 | 213.5 | 161.7 | 169.4 | 178.7 | 134.6 | 186.1 | 158.1 | 154.5 | 163 | 163.5 | 173.3 |
| 201220_x_at | 1219 | 1462 | 1666 | 1715 | 1279 | 1636 | 1251 | 1638 | 1888 | 2019 | 1843 | 1852 | 1555 |
| 201234_at | 1188 | 1143 | 1931 | 1366 | 1194 | 1558 | 1523 | 1461 | 1408 | 1471 | 1310 | 1276 | 1343 |
| 201357_s_at | 334.1 | 351.2 | 311.8 | 471.8 | 322.6 | 299.5 | 331.2 | 375.5 | 370.4 | 259.6 | 367.3 | 305.7 | 340.4 |
| 201363_s_at | 1336 | 1191 | 1772 | 1562 | 1556 | 1075 | 954.7 | 1399 | 1206 | 1619 | 1818 | 1533 | 1218 |
| 201400_at | 1717 | 1358 | 2525 | 2026 | 1683 | 2206 | 1945 | 2228 | 2065 | 2268 | 1965 | 1659 | 1873 |
| 201421_s_at | 175.6 | 148.4 | 178.4 | 144.6 | 189.7 | 165.1 | 221.2 | 186.3 | 140.1 | 135.9 | 147.6 | 170.4 | 136.2 |
| 201422_at | 6861 | 5904 | 11424 | 8455 | 7067 | 10926 | 7900 | 7919 | 7701 | 6969 | 7977 | 8089 | 9716 |
| 201426_s_at | 12875 | 16563 | 17521 | 15537 | 17666 | 16164 | 20241 | 17907 | 16978 | 13362 | 14682 | 16173 | 16059 |
| 201453_x_at | 1382 | 1188 | 1523 | 1351 | 1318 | 1619 | 1432 | 1363 | 1325 | 1297 | 1233 | 1163 | 1501 |
| 201470_at | 1241 | 1258 | 2335 | 1040 | 1081 | 1765 | 1593 | 1252 | 1378 | 1140 | 1056 | 1236 | 1798 |
| 201478_s_at | 264.4 | 286.3 | 289.9 | 240.4 | 251.6 | 226.9 | 300.9 | 261.5 | 220.1 | 230.6 | 246.8 | 245.9 | 299.7 |
| 201527_at | 933.4 | 684.5 | 1000 | 915.9 | 885.5 | 1101 | 1058 | 1055 | 1002 | 893.2 | 912.5 | 885.6 | 1072 |
| 201536_at | 252.7 | 299.3 | 733.7 | 342 | 267.1 | 516 | 306.7 | 524.5 | 346.6 | 517.5 | 410.2 | 379.5 | 416.2 |
| 201554_x_at | 544.7 | 655.8 | 1226 | 864.6 | 767.1 | 1140 | 1444 | 864 | 900.7 | 1307 | 686 | 689 | 694.6 |
| 201556_s_at | 496.5 | 414.3 | 592.2 | 586.1 | 624.5 | 392.6 | 674.5 | 448.1 | 611.8 | 526.4 | 533.2 | 710.4 | 490 |
| 201576_s_at | 615.2 | 556.2 | 757.2 | 688.6 | 609 | 824 | 831.3 | 798.5 | 677.7 | 676.8 | 653.7 | 692.8 | 649.9 |
| 201590_x_at | 3421 | 2975 | 4771 | 2731 | 3361 | 4991 | 4348 | 3919 | 3436 | 2928 | 3427 | 3408 | 4307 |
| 201628_s_at | 625.1 | 754.4 | 616.1 | 597 | 650 | 645.1 | 704.3 | 755.1 | 635 | 596.7 | 642.5 | 589.1 | 658.4 |
| 201788_at | 653.2 | 464 | 570.8 | 495 | 473.7 | 460.8 | 628.3 | 582.5 | 447.6 | 534.4 | 557.7 | 583.5 | 525.5 |
| 201900_s_at | 479.5 | 377.7 | 581.6 | 364.6 | 430.1 | 606.6 | 707.8 | 534.2 | 492.7 | 383.6 | 426.9 | 521.9 | 495.5 |
| 201945_at | 405.2 | 332.9 | 506.4 | 642.9 | 336.4 | 346.3 | 403.4 | 481.7 | 458.7 | 479 | 579.5 | 523.4 | 406.5 |
| 202068_s_at | 69.84 | 44.36 | 148.6 | 40.98 | 47.62 | 100.7 | 143.2 | 113.7 | 103.3 | 85.43 | 44.63 | 139.9 | 176.3 |
| 202104_s_at | 485.5 | 366.3 | 295 | 374.7 | 356.5 | 294.2 | 454.2 | 356.2 | 374.2 | 318.5 | 398.1 | 413.9 | 380.6 |
| 202138_x_at | 273 | 264.3 | 305 | 248 | 255.9 | 352.5 | 378.7 | 340.4 | 304.1 | 258.4 | 270 | 252.7 | 347.2 |
| 202185_at | 232 | 260.5 | 245.2 | 215 | 198.7 | 252.9 | 256.9 | 216.9 | 227.3 | 223.6 | 215 | 273.7 | 255.7 |
| 202192_s_at | 398.6 | 584 | 686.6 | 687 | 558.8 | 830.6 | 775.4 | 708.6 | 693.3 | 591.5 | 634.3 | 857 | 695.2 |
| 202201_at | 412.5 | 351.5 | 780.9 | 560.7 | 493.2 | 863.6 | 1101 | 605.9 | 687.1 | 631.8 | 658.1 | 736.8 | 803.2 |
| 202249_s_at | 238.7 | 201.6 | 257 | 224.2 | 190.8 | 227.7 | 255.3 | 228.2 | 244.7 | 205.3 | 245.3 | 205.1 | 198.7 |
| 202252_at | 76.86 | 97.73 | 107.1 | 116.8 | 101.8 | 282.6 | 598 | 99.52 | 125 | 187.5 | 104.4 | 116.6 | 132.4 |
| 202262_x_at | 104.1 | 71.19 | 117.7 | 111.7 | 57.44 | 95.02 | 104.3 | 106.3 | 87.92 | 122.6 | 102.7 | 101.4 | 75.33 |
| 202380_s_at | 958.3 | 718.6 | 623.9 | 543.2 | 619.2 | 525.2 | 756 | 598 | 524.9 | 510.9 | 651.4 | 639.6 | 627.6 |
| 202381_at | 294 | 370.6 | 454.7 | 383 | 263.3 | 627.1 | 584 | 440.2 | 390.7 | 486.4 | 465.2 | 454.6 | 458.4 |
| 202428_x_at | 2249 | 2083 | 2519 | 1703 | 2276 | 2512 | 3041 | 2905 | 2206 | 2092 | 1943 | 2468 | 2706 |
| 202445_s_at | 89.62 | 94.59 | 149.9 | 170.9 | 111.8 | 137.4 | 144.6 | 128 | 134.8 | 129.5 | 150.4 | 179.9 | 142.9 |
| 202461_at | 225.1 | 201.6 | 229.4 | 151.9 | 193.3 | 217.6 | 288.3 | 245.1 | 183.9 | 192.2 | 156.5 | 178.7 | 204 |
| 202522_at | 840 | 791.3 | 740.2 | 635.5 | 632.8 | 747.3 | 717.2 | 740.1 | 700.3 | 746.5 | 697.4 | 717.5 | 749 |
| 202523_s_at | 314.5 | 394.6 | 85.43 | 104 | 351.3 | 94.69 | 317.3 | 242.7 | 153.4 | 221.3 | 138.6 | 220.6 | 148.8 |
| 202594_at | 1428 | 1351 | 873 | 722.6 | 1250 | 740.5 | 854.3 | 1067 | 1045 | 1142 | 938 | 899.7 | 984.1 |
| 202623_at | 1219 | 938.3 | 1037 | 1168 | 989.7 | 1046 | 1074 | 1390 | 1025 | 1055 | 1313 | 1076 | 982.9 |
| 202652_at | 56.81 | 48.95 | 18.22 | 16.93 | 42.61 | 18.97 | 30.95 | 43.46 | 33.63 | 34.28 | 39.53 | 35.21 | 35.69 |
| 202724_s_at | 557.7 | 557 | 318.1 | 312.4 | 503.1 | 357.1 | 397.8 | 455.5 | 352.5 | 571.7 | 440.3 | 529.5 | 473.5 |
| 202750_s_at | 226.4 | 173.3 | 219.8 | 227.7 | 121.5 | 162.7 | 178.6 | 175.4 | 169.7 | 210.4 | 216.2 | 222.2 | 212.5 |
| 202778_s_at | 664.8 | 704.5 | 387.8 | 494.8 | 487 | 448.1 | 573.1 | 587.4 | 497.2 | 532.4 | 638.3 | 678.9 | 477.8 |
| 202910_s_at | 3323 | 3115 | 3494 | 4653 | 3498 | 4710 | 3243 | 4642 | 4340 | 3809 | 3981 | 4470 | 4395 |
| 202928_s_at | 165.6 | 170.4 | 121.4 | 170.3 | 126.9 | 103.9 | 138.2 | 177.6 | 145.6 | 134.2 | 145.1 | 145.8 | 125.9 |
| 202944_at | 325.6 | 334.3 | 569.1 | 403.6 | 465 | 556.1 | 551.5 | 477.2 | 403.4 | 401.4 | 463.7 | 355.5 | 415.8 |
| 202979_s_at | 864 | 1039 | 536.3 | 603.6 | 832.6 | 606.1 | 1005 | 756.4 | 680.5 | 666.2 | 632.8 | 564.8 | 661.8 |
| 203003_at | 75.88 | 78.08 | 96.06 | 133.6 | 86.23 | 69.58 | 69.06 | 100.3 | 104.4 | 97.12 | 116.7 | 126.5 | 95.53 |
| 203127_s_at | 232.9 | 270 | 499.3 | 391.7 | 330.1 | 533.8 | 402.9 | 431 | 449.2 | 321.4 | 375.4 | 293.3 | 373.8 |
| 203137_at | 1766 | 1935 | 1801 | 1674 | 1853 | 1804 | 1591 | 1726 | 1880 | 1657 | 1459 | 1618 | 1752 |
| 203184_at | 36.94 | 36.21 | 53.02 | 42.59 | 28.5 | 75.53 | 226.5 | 102.4 | 109.6 | 84.03 | 105.4 | 118.1 | 150.7 |
| 203234_at | 472.6 | 273.7 | 774.6 | 458.4 | 375.9 | 403 | 563.6 | 544.1 | 479.4 | 351.2 | 514.4 | 489.3 | 626.9 |
| 203278_s_at | 752.1 | 788 | 1313 | 1101 | 930.6 | 755.2 | 777.1 | 879.7 | 917.4 | 1553 | 1011 | 1098 | 716.5 |
| 203305_at | 1893 | 1453 | 2640 | 490 | 827.9 | 1915 | 1113 | 1066 | 384.1 | 1779 | 1106 | 1171 | 928.4 |
| 203371_s_at | 797 | 768 | 1455 | 1146 | 1101 | 901.4 | 964.5 | 1246 | 1041 | 1515 | 1202 | 1331 | 1066 |
| 203413_at | 508.6 | 498.6 | 295.8 | 189.7 | 1059 | 176.5 | 428.8 | 410.6 | 289.9 | 373.5 | 366.5 | 260.2 | 335.6 |
| 203416_at | 10949 | 9823 | 12814 | 12701 | 10859 | 10964 | 9813 | 11523 | 11366 | 11197 | 10616 | 9302 | 11084 |
| 203492_x_at | 262.1 | 303.8 | 254.4 | 218.1 | 217.3 | 202.4 | 367.9 | 236.7 | 243.3 | 190.3 | 223.1 | 181.6 | 275.4 |
| 203534_at | 860.4 | 745.9 | 1063 | 831.6 | 774.5 | 926.1 | 965.5 | 1011 | 763.8 | 839.2 | 782.1 | 814.3 | 970.8 |
| 203535_at | 37853 | 31170 | 49653 | 45057 | 39745 | 42643 | 38145 | 40019 | 41371 | 44563 | 41970 | 39894 | 37861 |
| 203578_s_at | 108 | 173.4 | 88.83 | 110.5 | 162.7 | 43.16 | 116.5 | 62.13 | 103.7 | 78.05 | 68.1 | 70.17 | 91.47 |
| 203748_x_at | 1404 | 1532 | 1592 | 1570 | 1521 | 1436 | 1501 | 1936 | 1602 | 1888 | 1599 | 1448 | 1516 |
| 203759_at | 84.13 | 82.76 | 102.8 | 105.5 | 71.58 | 83.46 | 88.39 | 96.99 | 69.87 | 204.5 | 119.3 | 87.51 | 73.27 |
| 203844_at | 30.14 | 29.02 | 29.65 | 38.77 | 33.71 | 30.16 | 26.14 | 26.62 | 29.05 | 28.26 | 27.56 | 25.51 | 28.77 |
| 203880_at | 307.6 | 268.3 | 432.6 | 236.7 | 253.1 | 355.5 | 384.2 | 322.7 | 267.9 | 276.2 | 266.2 | 269.6 | 350.9 |
| 203912_s_at | 195.8 | 180.2 | 260.5 | 244.9 | 194.8 | 261.2 | 260.6 | 211.9 | 254.7 | 243.5 | 260.5 | 204.5 | 203.8 |
| 203939_at | 131.5 | 44.71 | 87.84 | 47.41 | 130.4 | 55.72 | 39.79 | 78.42 | 41.17 | 74.26 | 56.06 | 46.98 | 54.88 |
| 203971_at | 39.98 | 91.81 | 123.7 | 133.4 | 109.8 | 196.1 | 188.8 | 104.6 | 160.4 | 93.32 | 101.1 | 115.3 | 134.6 |
| 204050_s_at | 1191 | 1153 | 1637 | 1186 | 1315 | 1490 | 1459 | 1296 | 1387 | 1051 | 1306 | 1289 | 1494 |
| 204068_at | 52.18 | 72.38 | 132.2 | 116.2 | 76.47 | 72.93 | 115.1 | 93.37 | 67.65 | 160 | 89.9 | 81.98 | 108 |
| 204099_at | 134 | 151.2 | 174.1 | 248.9 | 104.7 | 228.9 | 291.3 | 169.1 | 159.8 | 229.1 | 171.4 | 213.9 | 166.8 |
| 204143_s_at | 343.4 | 245.1 | 123.4 | 71.14 | 158.3 | 139.1 | 246.3 | 179.8 | 113.9 | 108.5 | 224.9 | 188.1 | 176.5 |
| 204204_at | 1567 | 1313 | 2903 | 2825 | 2260 | 2664 | 1682 | 2557 | 2569 | 1966 | 2599 | 2330 | 2817 |
| 204214_s_at | 362.7 | 430.3 | 768.1 | 623.6 | 414.3 | 659.9 | 643.7 | 568.1 | 592.5 | 608.1 | 688.7 | 584.2 | 610.5 |
| 204232_at | 3218 | 2801 | 7213 | 3954 | 3331 | 5221 | 3906 | 4851 | 5032 | 4293 | 3147 | 3270 | 4215 |
| 204243_at | 307.6 | 220.8 | 336.7 | 281.8 | 288.6 | 282.1 | 280.4 | 330.3 | 258.1 | 270.1 | 344.2 | 327 | 379.7 |
| 204249_s_at | 1870 | 2630 | 3763 | 3035 | 2261 | 4786 | 2785 | 3259 | 3200 | 2842 | 2501 | 2796 | 3206 |
| 204291_at | 307.3 | 388.5 | 410.3 | 352.5 | 402.7 | 407.4 | 420.8 | 368.5 | 432.4 | 483.9 | 423.1 | 498.9 | 448.6 |
| 204342_at | 659.8 | 1020 | 1202 | 739.5 | 671.5 | 1202 | 1251 | 1007 | 769.3 | 874.7 | 883.2 | 1061 | 833.9 |
| 204352_at | 788 | 637.4 | 353 | 175.1 | 495.8 | 305.5 | 495.4 | 393.3 | 311.6 | 302.6 | 283.6 | 406.6 | 472.8 |
| 204401_at | 207 | 163.5 | 86.02 | 44.85 | 183.5 | 57.35 | 217.2 | 140.6 | 88.27 | 99.77 | 123 | 186.9 | 161.2 |
| 204504_s_at | 116.3 | 107.8 | 84.57 | 97.94 | 90.73 | 93.93 | 148.2 | 102.6 | 97.1 | 82.04 | 89.05 | 93.17 | 86.38 |
| 204617_s_at | 308 | 332.7 | 288.2 | 268.4 | 252.4 | 231.2 | 354.5 | 268 | 253 | 248.3 | 306.2 | 321.5 | 328.3 |
| 204645_at | 816.1 | 865 | 851.8 | 918.3 | 777.7 | 731 | 840.3 | 773.7 | 860.1 | 869.8 | 871.5 | 831.1 | 915.4 |
| 204675_at | 77.36 | 99.65 | 120.4 | 100.6 | 97.79 | 176.2 | 174.4 | 90.75 | 103.2 | 92.3 | 98.27 | 121 | 147.5 |
| 204689_at | 362 | 355.4 | 550.3 | 503.4 | 399 | 588.8 | 494.5 | 588.4 | 504.1 | 527.1 | 484.9 | 448.4 | 507.1 |
| 204801_s_at | 17.6 | 18.09 | 34.55 | 29.2 | 21.36 | 22.85 | 20.17 | 49.16 | 28.36 | 27.85 | 30.5 | 32.53 | 14.52 |
| 205235_s_at | 81.37 | 87.77 | 77.09 | 86.72 | 88.39 | 85.37 | 75.51 | 93.17 | 85.32 | 82.45 | 98.74 | 76.96 | 89.44 |
| 205254_x_at | 596.7 | 643.3 | 94.11 | 129.2 | 613.8 | 60.68 | 294.4 | 299.9 | 256.4 | 231.4 | 234.9 | 197.9 | 288.5 |
| 205256_at | 64.56 | 65.79 | 65.48 | 70.3 | 68.48 | 77.25 | 69.16 | 71.45 | 70.48 | 67.76 | 65.38 | 64.48 | 67.93 |
| 205322_s_at | 383.3 | 366 | 620.3 | 646.1 | 457.3 | 533.1 | 439.8 | 531.2 | 565.8 | 604.1 | 517.3 | 636.5 | 495.8 |
| 205340_at | 172.4 | 166.5 | 160.9 | 90.96 | 153.8 | 115.3 | 139.5 | 134.8 | 101.3 | 115.1 | 116.6 | 114.5 | 150.1 |
| 205349_at | 103.4 | 150.4 | 214.5 | 160.8 | 136.4 | 215 | 294.1 | 160.6 | 132.9 | 180.9 | 188.5 | 186.6 | 204.5 |
| 205550_s_at | 257.4 | 227.8 | 282.9 | 270.4 | 260.1 | 300.9 | 303.5 | 292.2 | 259.2 | 277.5 | 294.6 | 261.1 | 263.1 |
| 205811_at | 190.1 | 188.8 | 140.9 | 99.09 | 214.4 | 133 | 163.1 | 143.1 | 137.1 | 132.3 | 140.9 | 166.3 | 159.2 |
| 205835_s_at | 80.29 | 126.9 | 206.8 | 114.5 | 92.84 | 130.1 | 110 | 92.22 | 103.4 | 92.77 | 53.54 | 60.87 | 112.2 |
| 205895_s_at | 152.5 | 182.4 | 179.1 | 138.6 | 121.3 | 137.9 | 163.5 | 147.6 | 153 | 101 | 131.6 | 118.2 | 122.6 |
| 205965_at | 236.3 | 246.1 | 350.2 | 134.7 | 163.8 | 189.7 | 210 | 239.7 | 194.6 | 231.7 | 190.9 | 208.2 | 244 |
| 205976_at | 62.23 | 76.21 | 41.67 | 22.34 | 40.85 | 43.75 | 75.11 | 51.41 | 45.88 | 30.03 | 20.54 | 51.61 | 49.94 |
| 206015_s_at | 807.1 | 780.3 | 665.2 | 633.5 | 675.2 | 641.5 | 654.3 | 712.3 | 628 | 610.2 | 697.3 | 647.5 | 681.3 |
| 206037_at | 34.55 | 38.12 | 25.74 | 35.72 | 36.07 | 26.57 | 34.33 | 41.26 | 32.1 | 46.03 | 32.26 | 35.27 | 34.01 |
| 206170_at | 301.5 | 231.8 | 280.9 | 234.4 | 211.3 | 398.3 | 331.5 | 460.1 | 359.9 | 339.4 | 173.2 | 369.4 | 266.6 |
| 206182_at | 104.1 | 121 | 83.21 | 104.1 | 144.4 | 106.9 | 129 | 112 | 105.8 | 95.64 | 98.79 | 78 | 91.61 |
| 206343_s_at | 18.82 | 30.11 | 47.04 | 27.48 | 24.3 | 10.26 | 518 | 18.66 | 7.902 | 35.76 | 37.52 | 43.36 | 6.511 |
| 206542_s_at | 1470 | 1428 | 1104 | 1008 | 1145 | 1121 | 1438 | 1401 | 1038 | 1327 | 1308 | 1150 | 1368 |
| 206580_s_at | 55.76 | 61.62 | 60.23 | 55.12 | 58.67 | 59.88 | 58.08 | 67.94 | 56.3 | 59.15 | 51.67 | 59.11 | 55.4 |
| 206715_at | 128.5 | 150 | 504.1 | 269.6 | 261.7 | 586.3 | 611.8 | 348.1 | 352.4 | 279.3 | 285.8 | 280 | 410.6 |
| 206834_at | 44 | 71.68 | 217.7 | 45.42 | 58.94 | 55.53 | 310.6 | 44.3 | 53.65 | 133.6 | 48.03 | 53.96 | 1045 |
| 206968_s_at | 111.1 | 108.6 | 71.31 | 122.9 | 112.1 | 84.83 | 127.1 | 115.2 | 110.6 | 89.07 | 84.78 | 88.36 | 97.14 |
| 207075_at | 112.1 | 82.67 | 117 | 137 | 96.8 | 199.5 | 245.1 | 314.4 | 116.7 | 144 | 123.7 | 157.5 | 181.2 |
| 207078_at | 168.2 | 160.3 | 139.1 | 137.1 | 136.9 | 105.3 | 168.7 | 104.9 | 134.3 | 134.8 | 196.3 | 227.4 | 167.7 |
| 207113_s_at | 123.8 | 147.3 | 199.7 | 161.4 | 97 | 157.1 | 91.61 | 125.5 | 137.4 | 187.8 | 101.2 | 151.1 | 127.8 |
| 207164_s_at | 379 | 515.5 | 736.8 | 1180 | 590.8 | 589.1 | 647.7 | 593 | 729.6 | 679.4 | 679.7 | 341.6 | 563.6 |
| 207233_s_at | 87.2 | 69.58 | 95.53 | 82.37 | 84.76 | 107.8 | 115.2 | 85.94 | 101.7 | 112 | 112.2 | 110.3 | 95.51 |
| 207416_s_at | 347 | 217.3 | 241.6 | 234.3 | 203.1 | 173.5 | 269.6 | 218.6 | 230.8 | 208.7 | 227.8 | 300.7 | 271.1 |
| 207513_s_at | 222.4 | 234.3 | 319.6 | 234.6 | 216.1 | 194.1 | 233.1 | 220.7 | 199.3 | 225.1 | 252.2 | 249.3 | 247.8 |
| 207543_s_at | 358.8 | 271.7 | 425.8 | 284.3 | 306.9 | 354.5 | 338.1 | 466.4 | 331.6 | 338.8 | 396.1 | 318.7 | 462.8 |
| 207564_x_at | 4021 | 4348 | 3181 | 2922 | 3718 | 2240 | 3099 | 3107 | 2842 | 3336 | 2628 | 2763 | 3273 |
| 207971_s_at | 113.5 | 138.5 | 66.67 | 58.51 | 106.6 | 62.26 | 59.11 | 72.66 | 62.85 | 57.12 | 73.46 | 68.99 | 62.06 |
| 208104_s_at | 366.7 | 445.4 | 452.6 | 540.6 | 357.5 | 373.5 | 418.1 | 473.9 | 602.9 | 477.5 | 460.9 | 548.5 | 447.6 |
| 208121_s_at | 107.3 | 105.9 | 154.3 | 85.82 | 118.2 | 290.5 | 130.8 | 116 | 122.7 | 107.7 | 57.94 | 114.9 | 147.6 |
| 208161_s_at | 97.46 | 81.43 | 114.4 | 46.31 | 33.66 | 57.57 | 37.8 | 42.59 | 30.33 | 51.14 | 47.66 | 53.46 | 113.3 |
| 208269_s_at | 86.93 | 90.46 | 103.7 | 92.13 | 134.5 | 89.05 | 100 | 132.8 | 87.71 | 69.47 | 90.8 | 95.58 | 105.7 |
| 208309_s_at | 342.4 | 511.7 | 358.1 | 274.2 | 398.3 | 322.4 | 321.7 | 307.1 | 346.7 | 250.6 | 226.6 | 228.9 | 311 |
| 208527_x_at | 277.8 | 360.7 | 378.3 | 345.3 | 185.4 | 269.1 | 429 | 348.7 | 258.4 | 403.7 | 346.7 | 351.9 | 324.5 |
| 208579_x_at | 605.4 | 739.7 | 669.1 | 612.9 | 369.6 | 455.7 | 1111 | 629.3 | 426.6 | 835.1 | 613 | 583.5 | 586.6 |
| 208635_x_at | 16819 | 15765 | 14314 | 12255 | 16677 | 15289 | 16733 | 15196 | 14830 | 13486 | 14328 | 14127 | 15086 |
| 208659_at | 6394 | 5834 | 8720 | 7070 | 5979 | 7399 | 6879 | 7536 | 7028 | 7323 | 6813 | 6944 | 6433 |
| 208680_at | 854.2 | 888.6 | 1118 | 452.9 | 657 | 1087 | 890 | 812.4 | 686.1 | 661 | 606.8 | 731.7 | 936.7 |
| 208749_x_at | 2104 | 1823 | 1743 | 2740 | 1628 | 1627 | 1512 | 2454 | 2026 | 3166 | 2508 | 1809 | 1627 |
| 208771_s_at | 3631 | 3276 | 7909 | 7925 | 3476 | 8747 | 8450 | 5456 | 4552 | 7392 | 4409 | 6024 | 8397 |
| 208780_x_at | 2295 | 2322 | 2509 | 2220 | 2696 | 2231 | 2737 | 2468 | 2898 | 3429 | 3005 | 2207 | 2341 |
| 208798_x_at | 2410 | 2835 | 646.6 | 604.2 | 1608 | 481.7 | 998.3 | 918.3 | 813.2 | 1276 | 861.8 | 2004 | 1337 |
| 208805_at | 2067 | 1948 | 3445 | 1616 | 1949 | 2790 | 2602 | 2459 | 2158 | 1712 | 1857 | 2074 | 2448 |
| 208868_s_at | 531.5 | 424 | 664.4 | 943.3 | 711.4 | 483.8 | 761.8 | 581.3 | 641.3 | 726.8 | 1042 | 852 | 526.5 |
| 208903_at | 76.5 | 59.21 | 40.3 | 35.5 | 84.93 | 43.7 | 56.96 | 49.75 | 46.28 | 54.6 | 53.98 | 59.72 | 55.39 |
| 208921_s_at | 1238 | 1236 | 1440 | 948.5 | 1017 | 1320 | 1437 | 1155 | 1222 | 1146 | 1066 | 1250 | 1288 |
| 208923_at | 331.2 | 367.8 | 907 | 604.5 | 492.6 | 1042 | 829 | 715.6 | 599.3 | 666.5 | 684.9 | 615.7 | 728.3 |
| 208946_s_at | 1283 | 1333 | 1410 | 1238 | 1281 | 1523 | 1459 | 1531 | 1517 | 1446 | 1477 | 1508 | 1487 |
| 208962_s_at | 47.54 | 50.07 | 74.68 | 56.6 | 50.31 | 115 | 124.8 | 91.21 | 63.26 | 70.59 | 78.43 | 92.04 | 140.6 |
| 209040_s_at | 1621 | 1501 | 3300 | 2083 | 1838 | 2437 | 1910 | 2053 | 1910 | 1724 | 1512 | 1761 | 1987 |
| 209067_s_at | 3302 | 2793 | 2876 | 1793 | 2718 | 2433 | 3197 | 2693 | 2484 | 1610 | 1959 | 2155 | 2837 |
| 209072_at | 57.1 | 69.24 | 56.21 | 125.3 | 66.09 | 43.77 | 58.34 | 63 | 64.55 | 110.3 | 61.68 | 60.16 | 65.89 |
| 209099_x_at | 43.9 | 72.16 | 155.8 | 118.6 | 94.74 | 149 | 283.9 | 92.7 | 136.2 | 119.6 | 164.8 | 86.35 | 114.3 |
| 209124_at | 4279 | 4215 | 6505 | 6146 | 4678 | 6654 | 5356 | 5959 | 5264 | 6255 | 5085 | 4830 | 5295 |
| 209180_at | 359.3 | 316.7 | 402.8 | 253.6 | 359.3 | 270.9 | 355 | 335.6 | 272.4 | 260.4 | 318.6 | 285 | 361.1 |
| 209191_at | 81.93 | 73.6 | 230.8 | 83.39 | 96.53 | 219.5 | 254.3 | 151.3 | 98.95 | 88.51 | 99.28 | 139.6 | 194.3 |
| 209212_s_at | 21.99 | 26.98 | 67.39 | 42.12 | 23.68 | 35.94 | 32.42 | 34.54 | 30.26 | 35.86 | 30.24 | 31.06 | 45.12 |
| 209218_at | 125.2 | 127 | 223.5 | 73.94 | 109.2 | 222.7 | 201.7 | 184.9 | 139.6 | 187.5 | 89.9 | 123.8 | 177.3 |
| 209236_at | 223.6 | 189.5 | 169.9 | 182.3 | 164.2 | 192.9 | 258.1 | 194.4 | 149.9 | 132.2 | 232.4 | 173.1 | 185.9 |
| 209251_x_at | 5584 | 4954 | 5728 | 5254 | 4943 | 5271 | 4810 | 5593 | 5690 | 5711 | 4621 | 4640 | 5344 |
| 209259_s_at | 509.2 | 624.8 | 537.9 | 446.5 | 502.4 | 568.1 | 782.8 | 660.9 | 494.2 | 547.8 | 538 | 523 | 563.1 |
| 209269_s_at | 359.5 | 409.3 | 626.9 | 766.6 | 415.4 | 661.6 | 749.8 | 552.3 | 556.7 | 508.9 | 703.6 | 526.7 | 502.4 |
| 209330_s_at | 2544 | 2514 | 2069 | 1930 | 2198 | 2362 | 3417 | 2362 | 2252 | 1645 | 2174 | 2251 | 2579 |
| 209339_at | 391.9 | 406.9 | 598.4 | 448.2 | 417.3 | 553 | 523.7 | 487 | 473.6 | 329 | 411.6 | 378.8 | 580.5 |
| 209430_at | 1049 | 895.8 | 781.8 | 645.8 | 930.1 | 748.9 | 952.8 | 839 | 659 | 690.2 | 810.5 | 848 | 917.9 |
| 209675_s_at | 1037 | 1041 | 999.3 | 1179 | 997.9 | 981.5 | 1256 | 1185 | 1104 | 916.8 | 1150 | 1051 | 1039 |
| 209684_at | 241.9 | 293.6 | 426.2 | 299.2 | 253.9 | 699.6 | 406.3 | 388 | 434.2 | 363.2 | 363.7 | 429.3 | 513.4 |
| 209806_at | 1983 | 2212 | 2124 | 1907 | 1303 | 1636 | 4452 | 2191 | 1399 | 2990 | 1831 | 2144 | 2145 |
| 209840_s_at | 318.8 | 249.5 | 10.43 | 12.75 | 179.5 | 4.016 | 12.61 | 146.5 | 37.15 | 84.28 | 50.76 | 27.71 | 18.45 |
| 209870_s_at | 241.2 | 199.8 | 164.5 | 137.8 | 234 | 135.9 | 250.3 | 232.5 | 200.9 | 164.1 | 150.3 | 157.8 | 173.7 |
| 209892_at | 66.84 | 74.26 | 106.8 | 98.45 | 58.69 | 192.3 | 312.4 | 108.1 | 102.5 | 116.9 | 70.06 | 89.28 | 119.1 |
| 209906_at | 520.9 | 403.3 | 1350 | 728.6 | 267.3 | 1805 | 693.2 | 1200 | 713.9 | 777.8 | 483 | 859.7 | 793 |
| 210022_at | 143.8 | 148.6 | 195 | 193.6 | 161.2 | 158.1 | 187.3 | 160.4 | 189 | 157.3 | 177.3 | 171.8 | 172.4 |
| 210061_at | 110.2 | 111.7 | 86.55 | 113.7 | 132.9 | 83.59 | 187.3 | 120 | 114.2 | 104.2 | 95.51 | 109.9 | 73.52 |
| 210145_at | 35.77 | 39.28 | 103.1 | 97.83 | 53.3 | 115 | 106.7 | 84.7 | 85.7 | 77.37 | 94.43 | 66.18 | 86.09 |
| 210156_s_at | 883.5 | 1076 | 1518 | 1102 | 1083 | 1273 | 1431 | 1091 | 1207 | 1086 | 895.1 | 1083 | 1278 |
| 210166_at | 268.4 | 540.1 | 626.8 | 523.7 | 408.6 | 413.8 | 302.3 | 423.8 | 416.2 | 1174 | 566 | 516.8 | 383.3 |
| 210434_x_at | 2860 | 2441 | 2493 | 2460 | 2504 | 2426 | 2561 | 2792 | 2674 | 2522 | 2506 | 2481 | 2845 |
| 210644_s_at | 554.8 | 330.3 | 545.6 | 618.4 | 544.6 | 1215 | 922.2 | 727.8 | 451.4 | 540.2 | 292.2 | 533.1 | 443.9 |
| 210648_x_at | 3777 | 3512 | 3870 | 3637 | 4189 | 5137 | 4820 | 4755 | 3826 | 4242 | 4014 | 3105 | 3748 |
| 210875_s_at | 141.7 | 289.2 | 175 | 273.5 | 159.1 | 135.8 | 233 | 192.3 | 175.1 | 210.2 | 213.3 | 125.6 | 129.6 |
| 211047_x_at | 1322 | 970.2 | 1419 | 1100 | 1133 | 1469 | 1188 | 1178 | 1196 | 1092 | 1220 | 1386 | 1388 |
| 211058_x_at | 5345 | 4819 | 5622 | 4984 | 4956 | 5108 | 4919 | 5504 | 5261 | 5319 | 4476 | 4717 | 5322 |
| 211185_s_at | 7997 | 7349 | 7410 | 7455 | 8157 | 7056 | 7774 | 7880 | 7423 | 7517 | 8372 | 7757 | 7596 |
| 211272_s_at | 851.6 | 942.4 | 304 | 329.6 | 985.2 | 205.8 | 599 | 665.4 | 429 | 516 | 467.5 | 303 | 530.2 |
| 211323_s_at | 135.8 | 151.5 | 156.8 | 117.7 | 146.5 | 141.4 | 118.5 | 132.1 | 115.7 | 119.1 | 125.5 | 124.8 | 136.7 |
| 211383_s_at | 548.2 | 448 | 496 | 483.3 | 498.3 | 478.7 | 478.1 | 493 | 544.5 | 484.5 | 461.4 | 506.3 | 459.7 |
| 211429_s_at | 12857 | 12759 | 18725 | 19437 | 12061 | 19063 | 14211 | 14487 | 18483 | 19228 | 16845 | 14757 | 16183 |
| 211506_s_at | 172.7 | 1129 | 132.1 | 831.5 | 373.2 | 124.9 | 281.3 | 399.3 | 139.6 | 426.3 | 315 | 727.3 | 213.6 |
| 211546_x_at | 212.1 | 175.5 | 234.2 | 156.9 | 163.9 | 224 | 217.6 | 139.5 | 159.5 | 172.1 | 190.3 | 174.4 | 251.8 |
| 211684_s_at | 673.1 | 643.2 | 669.8 | 481.8 | 628 | 870.3 | 867.9 | 661.8 | 666.9 | 565 | 569.8 | 625 | 793.8 |
| 211729_x_at | 378.7 | 370.8 | 751.8 | 438.8 | 294 | 735.2 | 467.8 | 468.8 | 529.1 | 383.1 | 426.9 | 480 | 573.3 |
| 211856_x_at | 83.36 | 229.2 | 63.63 | 26.73 | 83.66 | 30.91 | 55.11 | 63.2 | 65.47 | 62.62 | 46.76 | 48.78 | 64.34 |
| 211946_s_at | 5007 | 4614 | 4148 | 3685 | 4346 | 3751 | 3643 | 4162 | 4018 | 5127 | 4287 | 4994 | 5045 |
| 211965_at | 1908 | 1621 | 3022 | 3542 | 1367 | 1309 | 1052 | 1808 | 1610 | 2050 | 2415 | 2842 | 1707 |
| 212030_at | 1119 | 860.6 | 1091 | 1104 | 1097 | 857.4 | 1005 | 1031 | 905.2 | 991.4 | 1011 | 989.5 | 1002 |
| 212042_x_at | 26660 | 26854 | 20413 | 17992 | 25627 | 21640 | 26628 | 23100 | 21708 | 22205 | 23104 | 24159 | 23918 |
| 212132_at | 2806 | 3099 | 2519 | 2855 | 2660 | 2593 | 3100 | 2860 | 2325 | 2723 | 2521 | 2447 | 3082 |
| 212213_x_at | 234.7 | 246.8 | 205.1 | 168.7 | 240.6 | 313 | 261.6 | 254.8 | 219.4 | 239.4 | 197.8 | 183 | 213.5 |
| 212299_at | 477.5 | 453 | 343.8 | 311 | 378.5 | 378 | 434.4 | 397.5 | 304.3 | 380.9 | 316.3 | 371.9 | 375.2 |
| 212331_at | 3422 | 3609 | 2550 | 2589 | 4290 | 2897 | 3339 | 3197 | 2928 | 3417 | 3591 | 3405 | 3134 |
| 212334_at | 2009 | 1728 | 3652 | 2347 | 2143 | 3165 | 2540 | 2250 | 2483 | 1992 | 2294 | 2600 | 2784 |
| 212406_s_at | 1446 | 1333 | 980.8 | 945.7 | 1209 | 858.7 | 1256 | 1373 | 858.9 | 1123 | 1409 | 993.2 | 1122 |
| 212455_at | 3348 | 3116 | 3060 | 3180 | 3066 | 2526 | 2986 | 3288 | 2905 | 3053 | 3195 | 2950 | 3134 |
| 212543_at | 1566 | 1582 | 1310 | 1176 | 1388 | 1305 | 1499 | 1397 | 1155 | 1270 | 1267 | 1497 | 1325 |
| 212658_at | 61.96 | 63.07 | 348.5 | 136.3 | 83.79 | 200.7 | 122.5 | 135.7 | 115.6 | 64.71 | 101.6 | 74.95 | 145.1 |
| 212663_at | 827.2 | 855.2 | 1514 | 1316 | 1235 | 1448 | 1566 | 1251 | 1293 | 1549 | 1239 | 1433 | 1418 |
| 212769_at | 378.8 | 396.7 | 281.4 | 519.5 | 335 | 326 | 359.7 | 461.2 | 324.4 | 599.2 | 513.3 | 406.8 | 322.6 |
| 212820_at | 1364 | 1731 | 3444 | 2483 | 2346 | 3274 | 3636 | 2248 | 2484 | 1934 | 2035 | 2484 | 3270 |
| 212932_at | 134.8 | 161.1 | 147.2 | 168.2 | 144.2 | 157 | 145.6 | 170.3 | 160.6 | 162.7 | 135.2 | 159.5 | 117.8 |
| 212989_at | 279.8 | 460.5 | 284.8 | 337.3 | 341.1 | 445.8 | 549.2 | 527 | 397.3 | 410.4 | 440.1 | 430.9 | 424.6 |
| 212997_s_at | 588.9 | 594.1 | 579.2 | 611.4 | 582.6 | 582.1 | 602.2 | 609.4 | 473.4 | 619.7 | 601.3 | 666.7 | 587.7 |
| 213021_at | 246.6 | 248.7 | 295.8 | 223.2 | 208 | 209.9 | 239.5 | 244.8 | 224.3 | 191.6 | 188.2 | 213.2 | 245.7 |
| 213152_s_at | 756.9 | 774.9 | 382.7 | 263.7 | 676.2 | 281.7 | 577.7 | 454.3 | 356.4 | 399.8 | 389.1 | 392.4 | 512.1 |
| 213205_s_at | 140.7 | 149.4 | 144.6 | 108.3 | 80.95 | 112 | 139.6 | 141.5 | 131.9 | 76.21 | 109.3 | 153.8 | 148.7 |
| 213218_at | 57.46 | 84.28 | 77.8 | 95.28 | 60.62 | 68.51 | 86.98 | 75.32 | 76.9 | 75.97 | 71.26 | 117.4 | 102.3 |
| 213266_at | 97.1 | 77.25 | 101.2 | 71.37 | 67.33 | 55.22 | 88.34 | 63.99 | 77.02 | 67.52 | 92.61 | 76.71 | 77.01 |
| 213302_at | 44.53 | 30.61 | 30.72 | 22.85 | 39.13 | 25.51 | 38.02 | 28.36 | 25.98 | 31.58 | 28.28 | 34.66 | 32.22 |
| 213335_s_at | 29.84 | 32.42 | 33.95 | 46.01 | 27.46 | 30.27 | 55.78 | 29.93 | 32.67 | 39.75 | 31.93 | 30.33 | 33.01 |
| 213397_x_at | 75.97 | 43.41 | 63.36 | 122.6 | 84.48 | 142.6 | 116.6 | 78.72 | 127.6 | 223.6 | 116.1 | 122.6 | 124.9 |
| 213459_at | 43.9 | 101 | 82.45 | 58.4 | 105.1 | 50.98 | 152.9 | 113 | 76.66 | 95.81 | 103.6 | 77.25 | 110.4 |
| 213494_s_at | 42.49 | 44.99 | 66.49 | 49.66 | 46.99 | 46.69 | 26.89 | 49.61 | 53.46 | 64.9 | 55.08 | 40.54 | 46.54 |
| 213540_at | 98.99 | 75.1 | 48.35 | 38.06 | 66.99 | 53.26 | 73.74 | 55.59 | 56.59 | 55.02 | 54.25 | 59.83 | 54.83 |
| 213693_s_at | 36.14 | 33.62 | 39.5 | 37.77 | 43.78 | 36.11 | 34.82 | 39.96 | 36.48 | 36.75 | 36.83 | 36.02 | 37.91 |
| 213827_at | 62.45 | 38.11 | 69.47 | 58.86 | 52.28 | 50.69 | 75.82 | 54.72 | 41.79 | 55.4 | 62.52 | 74.76 | 63.11 |
| 213877_x_at | 92.97 | 73.39 | 91.61 | 91.25 | 92.22 | 103.6 | 89.47 | 107.3 | 80.6 | 91.66 | 85.97 | 97.77 | 96.62 |
| 214045_at | 101.3 | 80.32 | 69.88 | 31.15 | 84.25 | 61.18 | 80.4 | 55.47 | 57.88 | 31.02 | 35.9 | 56.46 | 72.14 |
| 214057_at | 253.6 | 232.5 | 308.2 | 257.6 | 266.1 | 221.1 | 238.5 | 201.1 | 265 | 226.2 | 270.6 | 270.1 | 254.9 |
| 214330_at | 41.11 | 34.53 | 29.8 | 44.6 | 31.65 | 31.65 | 44.81 | 34.57 | 52.62 | 30.56 | 34.19 | 54.08 | 43.13 |
| 214364_at | 74.86 | 68.08 | 94.71 | 54.48 | 141.6 | 86.41 | 112.2 | 78.35 | 72.9 | 69.43 | 83.61 | 100.9 | 65 |
| 214430_at | 368.9 | 326.1 | 561.9 | 376.5 | 371.1 | 453.4 | 541.6 | 448.1 | 396.4 | 488 | 439.8 | 414.3 | 448.5 |
| 214511_x_at | 436.5 | 1332 | 6055 | 2443 | 695.7 | 3141 | 1938 | 1299 | 1640 | 2072 | 460.3 | 650.9 | 2781 |
| 214629_x_at | 5259 | 5578 | 7106 | 6716 | 5873 | 6256 | 5840 | 6128 | 7116 | 6282 | 6280 | 6844 | 6442 |
| 214683_s_at | 3560 | 3969 | 2849 | 3098 | 3634 | 2483 | 3848 | 3384 | 2871 | 3803 | 3730 | 3215 | 3669 |
| 214820_at | 91.45 | 131.4 | 85.75 | 87.56 | 94.45 | 91.77 | 94.15 | 93.32 | 106.9 | 82.11 | 71.76 | 79.1 | 81.48 |
| 214853_s_at | 519.3 | 465.3 | 516.7 | 395.8 | 382.4 | 478.1 | 531.3 | 473.4 | 396.6 | 470.7 | 413 | 472.1 | 511.1 |
| 214931_s_at | 235.4 | 333.5 | 421.9 | 498.3 | 269.9 | 263.1 | 311.6 | 327.3 | 426.8 | 273.2 | 342.2 | 282.2 | 268.2 |
| 214953_s_at | 206.3 | 190.1 | 219.1 | 173.9 | 239.8 | 382.7 | 588.6 | 232.8 | 234.2 | 265.5 | 222.2 | 221.1 | 142.3 |
| 215009_s_at | 560 | 437.1 | 385.1 | 363 | 541.1 | 354.9 | 833.3 | 443.5 | 379.1 | 416.7 | 499.2 | 396.1 | 533.7 |
| 215049_x_at | 332.9 | 228 | 499.8 | 451.5 | 329.2 | 848.1 | 996.5 | 676.4 | 537.8 | 435.2 | 843.5 | 414.9 | 490.6 |
| 215273_s_at | 519.5 | 519.7 | 783.5 | 543.5 | 450.5 | 537.3 | 594.4 | 667.9 | 604.5 | 570 | 495.5 | 550.7 | 483.1 |
| 215293_s_at | 51.17 | 63.64 | 91.07 | 54.91 | 46.56 | 45.32 | 74.74 | 54.82 | 54.9 | 62.36 | 57.99 | 56.5 | 61.37 |
| 215567_at | 119.7 | 106.1 | 111.5 | 105.6 | 118.4 | 94.19 | 91.23 | 99.07 | 104.5 | 98.21 | 121.6 | 128 | 114.7 |
| 215997_s_at | 231.8 | 297.9 | 387.2 | 407.3 | 377.2 | 232 | 308.5 | 353.1 | 390.6 | 311.5 | 340.1 | 169.3 | 298.8 |
| 216484_x_at | 392.3 | 421.5 | 415.4 | 406.9 | 381.3 | 536.3 | 609.6 | 413.2 | 405.2 | 495.3 | 408.5 | 388.3 | 466.1 |
| 216950_s_at | 194.5 | 568.2 | 4227 | 1221 | 271.6 | 1635 | 915.2 | 674.4 | 829.5 | 948 | 201 | 308.9 | 1293 |
| 217383_at | 26.92 | 24.4 | 39.62 | 32.72 | 31.82 | 36.32 | 40.65 | 27.8 | 33.22 | 38.93 | 31.85 | 20.53 | 31.57 |
| 217403_s_at | 94.32 | 104.4 | 96.34 | 82.87 | 103.8 | 75.15 | 94.15 | 92.97 | 81.61 | 75.93 | 69.2 | 92.28 | 107.1 |
| 217466_x_at | 3322 | 3511 | 2501 | 2133 | 3106 | 2694 | 3529 | 3046 | 2698 | 2338 | 2647 | 2621 | 3329 |
| 217769_s_at | 1263 | 1133 | 1815 | 1304 | 1287 | 1647 | 1423 | 1672 | 1432 | 1415 | 1303 | 1365 | 1538 |
| 217778_at | 162.4 | 200.8 | 215.6 | 235.2 | 194.6 | 239.9 | 250.4 | 214.2 | 209.3 | 314.7 | 182.1 | 213.2 | 217.3 |
| 217824_at | 242.3 | 300 | 406.9 | 314.7 | 236.9 | 469.1 | 359.5 | 309.7 | 386.8 | 418.6 | 250.2 | 273.1 | 236.8 |
| 217987_at | 513.8 | 436.6 | 569.5 | 643.2 | 689.5 | 279.7 | 682.8 | 849.1 | 255.7 | 797.7 | 778.5 | 773.6 | 387.4 |
| 217995_at | 1188 | 1082 | 2681 | 1941 | 1330 | 1868 | 1541 | 1948 | 1769 | 1639 | 1590 | 1531 | 1777 |
| 218012_at | 309.9 | 242.2 | 163.8 | 133.6 | 212.6 | 124.4 | 216.8 | 188.1 | 165.8 | 202 | 192.2 | 197.4 | 199.7 |
| 218040_at | 304.6 | 379.4 | 295.6 | 308.5 | 341.4 | 270.9 | 409.8 | 332.6 | 327.4 | 379.5 | 353 | 350.1 | 363.9 |
| 218065_s_at | 1147 | 1255 | 1098 | 932.3 | 1010 | 1251 | 1107 | 1181 | 1033 | 1111 | 968.1 | 1054 | 1153 |
| 218091_at | 446.8 | 437.1 | 533.5 | 437.1 | 513.3 | 572.3 | 677.2 | 546.3 | 525.6 | 426 | 552.2 | 514.1 | 489.8 |
| 218125_s_at | 83.03 | 67.46 | 57.46 | 54.91 | 73.24 | 55.77 | 71.48 | 58.85 | 59.45 | 59.32 | 59.85 | 58.35 | 57.44 |
| 218127_at | 287.8 | 253.6 | 236.4 | 180.7 | 206.2 | 188 | 243.7 | 231.4 | 225.9 | 195.2 | 185.9 | 206.4 | 245.3 |
| 218143_s_at | 571.3 | 779.2 | 595.1 | 699.1 | 771 | 819 | 689.1 | 872.2 | 660.7 | 511.5 | 724.7 | 673.3 | 632.6 |
| 218206_x_at | 397.9 | 316.1 | 490.8 | 351.6 | 285.5 | 414.7 | 476.4 | 394 | 365.6 | 353.9 | 410.4 | 441.7 | 410.2 |
| 218289_s_at | 105.5 | 126.5 | 80.78 | 74.13 | 91.7 | 76.78 | 192.3 | 87.25 | 89.84 | 111.4 | 68.9 | 103.5 | 93.08 |
| 218325_s_at | 518.8 | 407.3 | 317.1 | 351.2 | 325.2 | 330 | 400.2 | 400.6 | 377.8 | 335.7 | 378.7 | 331 | 359 |
| 218351_at | 902 | 1037 | 1272 | 795.5 | 1117 | 1459 | 1324 | 1206 | 1047 | 1280 | 1067 | 1027 | 1126 |
| 218499_at | 2229 | 2581 | 2126 | 1954 | 2236 | 1674 | 2897 | 2294 | 2051 | 2075 | 2495 | 2309 | 2191 |
| 218627_at | 467.7 | 235.7 | 593.4 | 223.9 | 254.7 | 506.4 | 432.3 | 400.2 | 373.4 | 334.4 | 325.9 | 324.1 | 358.1 |
| 218718_at | 107.1 | 96.04 | 149.6 | 111.1 | 164 | 198.7 | 231.1 | 235.5 | 140.6 | 153.8 | 95.6 | 207.6 | 164.6 |
| 218732_at | 173.3 | 182.3 | 247.8 | 199.9 | 205.2 | 275.4 | 303.7 | 274.9 | 243.1 | 194.6 | 277.1 | 239.7 | 303.8 |
| 218845_at | 1230 | 765.9 | 1187 | 840.3 | 831.6 | 1118 | 954.7 | 1101 | 1105 | 1074 | 837.4 | 1027 | 945.4 |
| 218962_s_at | 461.2 | 563.7 | 378.5 | 315.7 | 520.9 | 397.5 | 513.7 | 566.3 | 411.6 | 472.8 | 454.1 | 439 | 406.9 |
| 219130_at | 384.3 | 451.2 | 198 | 153 | 362.5 | 209.6 | 306.1 | 242.7 | 224.2 | 257 | 234.9 | 303.7 | 344.7 |
| 219316_s_at | 60.99 | 58.86 | 287.5 | 92.39 | 57.04 | 184.7 | 91.66 | 87.53 | 83.56 | 73.87 | 123.2 | 98.66 | 108.6 |
| 219343_at | 199.4 | 158.8 | 196.2 | 141.5 | 195.8 | 139.4 | 140.8 | 192.6 | 163.7 | 158.7 | 158.8 | 163.8 | 180.7 |
| 219358_s_at | 159.6 | 118.7 | 298 | 204.7 | 125 | 375.3 | 166.1 | 170.9 | 197.3 | 147.3 | 169 | 258.9 | 288.3 |
| 219418_at | 100.9 | 113 | 104.9 | 75.02 | 110 | 104.6 | 143.9 | 120.3 | 154.8 | 108 | 91.34 | 86.46 | 111.9 |
| 219507_at | 102.8 | 85.1 | 137.1 | 103.4 | 85.23 | 113.2 | 64.55 | 90.64 | 89.99 | 120.3 | 88.65 | 146.1 | 92.1 |
| 219765_at | 86.55 | 96.15 | 29.82 | 33.48 | 73.23 | 48.24 | 92.72 | 51.71 | 41.56 | 46.05 | 31.09 | 61.35 | 63.1 |
| 219787_s_at | 25.5 | 68.25 | 61.41 | 34.46 | 46.53 | 62.47 | 149.3 | 53.39 | 49.93 | 72.26 | 47.78 | 75.44 | 71.76 |
| 219822_at | 155 | 156.2 | 169.3 | 147.8 | 182.4 | 132.4 | 182.4 | 150.2 | 120 | 144 | 111.1 | 156.4 | 149.9 |
| 219826_at | 68.33 | 50.63 | 29.86 | 26.06 | 52.43 | 34.68 | 58.11 | 32.79 | 47.9 | 35.09 | 39.19 | 45.82 | 34.57 |
| 219952_s_at | 152.3 | 157.9 | 205.4 | 251.2 | 209.5 | 242.6 | 216.4 | 246.7 | 187.4 | 287.7 | 208.2 | 215.9 | 190.9 |
| 220044_x_at | 4928 | 4996 | 4111 | 3440 | 5237 | 4186 | 5374 | 4832 | 4123 | 4264 | 4469 | 4524 | 4724 |
| 220146_at | 89.99 | 120.9 | 248.5 | 128.2 | 89.07 | 348.5 | 188.3 | 182.6 | 134.3 | 85.52 | 109.8 | 172.8 | 144.9 |
| 220160_s_at | 62.14 | 51.08 | 127.3 | 72.09 | 59.36 | 105.7 | 72.77 | 62.4 | 61.15 | 55.81 | 55.99 | 62.07 | 65.3 |
| 220386_s_at | 680.1 | 908.9 | 670.5 | 580.9 | 692.4 | 477.3 | 420.7 | 552.9 | 511.8 | 411.7 | 407.7 | 327.2 | 540.1 |
| 220578_at | 89.58 | 67.6 | 86.89 | 61.61 | 76.68 | 69.54 | 54.37 | 65.08 | 83.29 | 66.9 | 82.4 | 88.79 | 94.82 |
| 220605_s_at | 178.3 | 136.2 | 214.3 | 159.6 | 164.8 | 199.8 | 172.6 | 207.8 | 170.4 | 194.1 | 159.5 | 160.2 | 158.3 |
| 220610_s_at | 74.93 | 83.75 | 159.1 | 151.5 | 91.75 | 117.6 | 164.5 | 131.8 | 169.9 | 111.6 | 94.97 | 115.1 | 142.3 |
| 220690_s_at | 94.07 | 87.99 | 173.1 | 137.3 | 85.37 | 117.7 | 107.9 | 117.7 | 119 | 103 | 97.31 | 135.2 | 118.8 |
| 220750_s_at | 101.8 | 85.23 | 72.19 | 81.42 | 94.59 | 143.7 | 123.6 | 94.19 | 76.68 | 98.35 | 102.5 | 101.2 | 106.4 |
| 220865_s_at | 46.39 | 77.86 | 123 | 83.51 | 56.12 | 83.77 | 154.5 | 111.8 | 112.4 | 99.16 | 75.29 | 83.07 | 110 |
| 220974_x_at | 235.1 | 221.7 | 206.8 | 118.6 | 171.9 | 254.3 | 329.5 | 248.2 | 260.8 | 197.1 | 195.1 | 216.8 | 207.6 |
| 221011_s_at | 1629 | 1189 | 680.8 | 361.7 | 1055 | 408 | 913.2 | 900.6 | 629.7 | 734.6 | 542 | 696.3 | 801.8 |
| 221206_at | 186.8 | 201.9 | 136 | 147.2 | 152.3 | 137.3 | 172.4 | 170 | 166.7 | 158.8 | 154 | 181 | 186.2 |
| 221264_s_at | 564.6 | 487.6 | 352.4 | 414.2 | 533.4 | 310.1 | 444.2 | 691.4 | 431.3 | 468.5 | 481 | 518.3 | 398.3 |
| 221428_s_at | 640.6 | 1085 | 674 | 913.8 | 888.8 | 784.5 | 881.1 | 757.8 | 665.3 | 868.4 | 725.6 | 737.1 | 720.1 |
| 221449_s_at | 298 | 296.4 | 475.4 | 325.2 | 287.8 | 437.1 | 408.8 | 373.4 | 352.6 | 346.3 | 317.3 | 314.2 | 388.2 |
| 221580_s_at | 1186 | 1145 | 965.8 | 871.3 | 1233 | 907.7 | 1219 | 1078 | 941.7 | 1008 | 1072 | 982.5 | 1027 |
| 221601_s_at | 3467 | 2514 | 1301 | 976.7 | 3252 | 955.5 | 1537 | 1991 | 1370 | 1688 | 1608 | 1651 | 1767 |
| 221647_s_at | 555.6 | 528.3 | 437.1 | 481.9 | 436.6 | 503.3 | 542.6 | 541.2 | 540.2 | 480.5 | 473.6 | 469.6 | 496.1 |
| 221731_x_at | 5279 | 5895 | 7899 | 5867 | 5915 | 9103 | 9821 | 6512 | 7005 | 6259 | 8579 | 9538 | 9700 |
| 221757_at | 836.9 | 750.5 | 292.7 | 367 | 928.4 | 231.8 | 503 | 636.3 | 378.7 | 364.3 | 479.6 | 340.9 | 390.3 |
| 221841_s_at | 900.2 | 1482 | 2150 | 1083 | 964.9 | 2308 | 1767 | 1244 | 1413 | 1150 | 939.1 | 1350 | 1613 |
| 221868_at | 31.22 | 31.29 | 19.98 | 31.87 | 32.09 | 25.5 | 35.27 | 31.34 | 31.43 | 31.6 | 31.55 | 33.88 | 30.45 |
| 221960_s_at | 45.32 | 58.65 | 91.5 | 105.4 | 62.46 | 75.39 | 58.4 | 64.19 | 90.09 | 90.02 | 70.82 | 43.99 | 66.84 |
| 222217_s_at | 295.7 | 222.4 | 344.9 | 405.3 | 265 | 632.4 | 301.4 | 470.9 | 360 | 283.1 | 326.1 | 425.8 | 347.4 |
| 222231_s_at | 257.6 | 275.6 | 336.4 | 350.6 | 253.4 | 431.8 | 460.8 | 383.1 | 330.6 | 317.2 | 269 | 315.5 | 342 |
| 222574_s_at | 519.9 | 421.1 | 488.6 | 572 | 459 | 455 | 536.5 | 572.3 | 472.2 | 445.5 | 520.4 | 442.1 | 455.5 |
| 222605_at | 810.6 | 671.3 | 672.7 | 649.1 | 669 | 531.5 | 635.2 | 775.7 | 630.4 | 743.9 | 821.7 | 704.3 | 633.9 |
| 222651_s_at | 232.5 | 216.4 | 346.2 | 205.8 | 247.7 | 331.6 | 376.4 | 322.9 | 281.9 | 259.1 | 329 | 439.7 | 378.2 |
| 222670_s_at | 542.5 | 680.8 | 1114 | 895.3 | 501.2 | 1452 | 705.6 | 673.6 | 858.9 | 683.7 | 420.4 | 703.6 | 856 |
| 222688_at | 194.5 | 251 | 378.7 | 269.1 | 236.7 | 298.4 | 216 | 263.6 | 264 | 409.8 | 286.9 | 487.1 | 295.9 |
| 222700_at | 607 | 497.6 | 604.2 | 357 | 585 | 348.3 | 676.6 | 491.2 | 584.2 | 452.9 | 559 | 381.8 | 503.4 |
| 222753_s_at | 167.3 | 173.1 | 305.2 | 217.8 | 176 | 249.8 | 286.3 | 237.6 | 253.9 | 241.5 | 189.4 | 188 | 221.7 |
| 222757_s_at | 78.28 | 78.72 | 146.5 | 98.99 | 54.54 | 116.1 | 121.6 | 101.6 | 78.4 | 157 | 123.4 | 94.54 | 74.65 |
| 222774_s_at | 32.22 | 62.88 | 84.53 | 31.09 | 39.83 | 60.04 | 78.45 | 63.23 | 57.04 | 48.15 | 52.81 | 43.47 | 66.52 |
| 222884_at | 108.8 | 108 | 109.6 | 104.5 | 102.1 | 96.17 | 114.6 | 105.6 | 82.66 | 102.6 | 104.1 | 109.8 | 105 |
| 222980_at | 2311 | 2431 | 2281 | 2385 | 2301 | 3139 | 2641 | 2677 | 2486 | 2670 | 2540 | 2285 | 3026 |
| 222982_x_at | 3746 | 4988 | 5052 | 3370 | 4219 | 3583 | 4853 | 4450 | 3785 | 4924 | 4332 | 3624 | 4078 |
| 223023_at | 348.1 | 318.4 | 213.1 | 343 | 300.7 | 229.2 | 310.9 | 270.2 | 239 | 295 | 352.5 | 276.2 | 272.8 |
| 223064_at | 1352 | 1201 | 1644 | 1394 | 1334 | 1507 | 1514 | 1570 | 1352 | 1322 | 1277 | 1285 | 1542 |
| 223158_s_at | 98.62 | 109.9 | 135.1 | 182.6 | 110.4 | 139.9 | 184.1 | 177.6 | 110.1 | 92.66 | 98.91 | 86.53 | 120.1 |
| 223380_s_at | 265.9 | 219.4 | 354.4 | 363.2 | 285 | 328 | 224.1 | 403.4 | 316.7 | 362.2 | 390.4 | 489.2 | 314.5 |
| 223444_at | 661.9 | 883.9 | 509.1 | 617.6 | 828.7 | 589.9 | 939.3 | 662.2 | 587.2 | 769.3 | 776.9 | 777.8 | 774.9 |
| 223465_at | 372.2 | 344.5 | 535.8 | 506.4 | 477.6 | 556 | 364.7 | 511.4 | 711.4 | 637.8 | 536.3 | 416.4 | 419 |
| 223590_at | 554.5 | 394.7 | 414.6 | 340.3 | 334.2 | 365.8 | 417.2 | 352.5 | 378.5 | 449.3 | 400.8 | 440.5 | 394.8 |
| 223686_at | 132.1 | 205.1 | 272.1 | 194.6 | 212.7 | 185.5 | 205 | 278.2 | 203.4 | 210.3 | 217.6 | 197.5 | 251.5 |
| 223801_s_at | 28.57 | 31.29 | 37.03 | 31.55 | 31.57 | 69.53 | 31.34 | 37.44 | 37.91 | 31.13 | 41.44 | 29 | 31.29 |
| 223922_x_at | 1203 | 1435 | 1837 | 1991 | 2011 | 2347 | 3101 | 2605 | 2436 | 2182 | 2441 | 2286 | 2469 |
| 223982_s_at | 1015 | 922.6 | 1070 | 1053 | 1065 | 1145 | 1252 | 1160 | 1063 | 1055 | 1234 | 958.7 | 1173 |
| 224046_s_at | 504.8 | 590.9 | 272.9 | 315.3 | 497.5 | 262.1 | 350 | 385.1 | 369.7 | 309.7 | 302.1 | 217.3 | 339.1 |
| 224374_s_at | 323 | 407.7 | 608.1 | 475.9 | 382.7 | 906.2 | 604.9 | 427.3 | 451.2 | 539.3 | 551.3 | 574.8 | 538.6 |
| 224387_at | 48.74 | 72.73 | 89.9 | 74.14 | 70.91 | 122.8 | 71.12 | 69.25 | 74.76 | 90.79 | 72.02 | 73.2 | 85.27 |
| 224439_x_at | 500.2 | 472.3 | 543 | 433.1 | 477.5 | 554.1 | 537.1 | 488.2 | 590.6 | 446.8 | 428.7 | 446.2 | 577.4 |
| 224518_s_at | 419.1 | 386.4 | 217.9 | 105 | 319.8 | 175 | 233.7 | 149.3 | 239 | 203 | 242.6 | 286.6 | 278.9 |
| 224582_s_at | 446.4 | 380 | 253.6 | 204 | 303.5 | 272 | 488.8 | 383.8 | 305.8 | 226.7 | 270.6 | 249.6 | 315.9 |
| 224591_at | 3006 | 3147 | 2868 | 2743 | 2848 | 2618 | 3387 | 3099 | 2661 | 2618 | 3191 | 2925 | 2898 |
| 224726_at | 198.7 | 248.9 | 174.5 | 162.7 | 240.6 | 143.3 | 104.5 | 176.7 | 300.9 | 190.4 | 161.9 | 242.8 | 138.8 |
| 224818_at | 463.9 | 493.4 | 1079 | 859 | 647.2 | 1341 | 987.9 | 717.2 | 795.5 | 686.3 | 687.4 | 652.6 | 760.6 |
| 224917_at | 1879 | 2139 | 3576 | 2676 | 2152 | 3292 | 2467 | 3158 | 3112 | 2660 | 3132 | 2348 | 3124 |
| 224918_x_at | 248.7 | 181.4 | 591 | 391.6 | 378.8 | 902 | 1243 | 599.2 | 349.1 | 565.6 | 578.7 | 520.8 | 679.4 |
| 224928_at | 237.1 | 274.3 | 332.8 | 217.8 | 214.8 | 434.6 | 406.1 | 314.5 | 288.1 | 281.3 | 243.5 | 345.4 | 321.4 |
| 225059_at | 1248 | 1026 | 1595 | 1623 | 1070 | 1530 | 1683 | 1620 | 1360 | 1429 | 1335 | 1385 | 1699 |
| 225064_at | 440.9 | 458.9 | 410 | 285.3 | 263.7 | 372.9 | 451.2 | 395.3 | 408.8 | 332.6 | 324 | 324.1 | 424.7 |
| 225107_at | 2836 | 2238 | 2482 | 2219 | 2621 | 2132 | 3102 | 2443 | 2414 | 2532 | 2673 | 2541 | 2718 |
| 225188_at | 46.81 | 131.7 | 79.64 | 27.39 | 49.54 | 118.1 | 61.9 | 50.56 | 113.5 | 51.77 | 51.06 | 89.07 | 93.67 |
| 225341_at | 49.5 | 38.41 | 50.88 | 43.38 | 47.51 | 29.02 | 54 | 55.47 | 44.78 | 43.96 | 72.56 | 28.26 | 54.53 |
| 225358_at | 106.5 | 127.9 | 86.4 | 75.2 | 96.09 | 99.36 | 119.7 | 94.67 | 113.5 | 72.38 | 81.8 | 80.6 | 110.5 |
| 225365_at | 2139 | 2502 | 2726 | 1809 | 2419 | 3165 | 3490 | 2640 | 2620 | 2853 | 2545 | 2320 | 3526 |
| 225388_at | 60.02 | 60.32 | 52.08 | 22.58 | 35.13 | 27.18 | 49.2 | 39.43 | 42.47 | 41.22 | 44.21 | 42.81 | 54.22 |
| 225456_at | 373.6 | 356 | 382.5 | 291.8 | 272.2 | 284.3 | 408.6 | 287.1 | 280.5 | 295 | 314.4 | 377.1 | 356.2 |
| 225763_at | 3222 | 2446 | 2622 | 3581 | 2966 | 3510 | 3241 | 3203 | 3447 | 2277 | 2920 | 2829 | 3145 |
| 225844_at | 245.8 | 153.2 | 312.5 | 181.5 | 196.6 | 217.9 | 261 | 235.1 | 199.7 | 207 | 195.8 | 278.8 | 265 |
| 225866_at | 147.9 | 123.2 | 119.8 | 64.93 | 128 | 97.27 | 142.5 | 145.4 | 106.2 | 94.2 | 102 | 109.6 | 97.58 |
| 225870_s_at | 640.4 | 477.5 | 1026 | 700.5 | 570.3 | 897.7 | 704.5 | 825.3 | 766.5 | 650.4 | 674.6 | 806 | 795.3 |
| 226000_at | 24.26 | 20.61 | 38.48 | 31.61 | 29.34 | 40.67 | 45.88 | 34.25 | 27.98 | 26.84 | 35.23 | 24.82 | 33.67 |
| 226030_at | 159.9 | 116.2 | 79.44 | 69.9 | 101.2 | 56.67 | 115.5 | 106 | 91.02 | 101 | 114.8 | 133 | 92.08 |
| 226042_at | 79.89 | 92.01 | 102.6 | 72.96 | 80.89 | 73.36 | 92.84 | 95 | 78.76 | 91.13 | 88.29 | 117.2 | 119.5 |
| 226059_at | 59.63 | 45.2 | 56.85 | 35.05 | 43.14 | 61.69 | 66.29 | 51.99 | 45.32 | 36.51 | 55.42 | 61.44 | 58.88 |
| 226115_at | 261.3 | 166.7 | 172.4 | 290.4 | 230.5 | 190.7 | 168.4 | 273.9 | 226 | 256.7 | 341.6 | 292.6 | 181.5 |
| 226127_at | 136.8 | 90.18 | 91.66 | 81.48 | 88.06 | 95.38 | 102.6 | 108.7 | 86.75 | 87.51 | 75.67 | 80.81 | 84 |
| 226218_at | 9579 | 11149 | 2260 | 2068 | 8287 | 1449 | 4898 | 3216 | 3296 | 3308 | 4585 | 4186 | 5845 |
| 226220_at | 67.74 | 88.69 | 122.8 | 94.74 | 110.5 | 87.49 | 172.9 | 86.69 | 114.4 | 150.8 | 102 | 69.87 | 125.9 |
| 226323_at | 460.5 | 511.3 | 532.9 | 440.2 | 505.4 | 417 | 565.8 | 584.6 | 501.8 | 477.6 | 582.3 | 498.8 | 553.8 |
| 226353_at | 1026 | 914.7 | 1702 | 1377 | 1121 | 1223 | 1239 | 1300 | 1158 | 1286 | 1013 | 1087 | 1356 |
| 226428_at | 235 | 205.1 | 199.5 | 187.2 | 197.9 | 181.7 | 210.2 | 174 | 160.8 | 161.7 | 166.9 | 186.3 | 197.2 |
| 226459_at | 1922 | 1768 | 4243 | 2811 | 2047 | 3469 | 1874 | 2415 | 2521 | 2962 | 1876 | 2089 | 2308 |
| 226503_at | 249.7 | 283 | 231.1 | 143.2 | 259.2 | 339.7 | 305.6 | 227.7 | 224.9 | 250.9 | 257.3 | 205.8 | 246.3 |
| 226683_at | 2343 | 1914 | 1856 | 2817 | 1413 | 2472 | 2207 | 2831 | 2520 | 3286 | 3003 | 2138 | 1832 |
| 226718_at | 126.3 | 126.4 | 44.78 | 70.75 | 126.6 | 73.27 | 99.71 | 82.66 | 69.23 | 86.07 | 62.73 | 71.56 | 64.9 |
| 226763_at | 178 | 112.2 | 412.7 | 145.6 | 173.2 | 256.2 | 224.8 | 153.2 | 246.5 | 161.7 | 212.1 | 217.3 | 190.2 |
| 226836_at | 31.09 | 31.65 | 37.43 | 37.62 | 35.98 | 33.01 | 34.12 | 32.38 | 35.09 | 35.03 | 40.43 | 32.28 | 36.29 |
| 227020_at | 841.5 | 708.6 | 762.1 | 738.1 | 995.2 | 988.3 | 967.2 | 853.3 | 743.3 | 740.1 | 991.8 | 860.1 | 845.8 |
| 227114_at | 120.5 | 144.1 | 93.36 | 84.32 | 101.4 | 88.08 | 120.7 | 94.91 | 99.38 | 96.28 | 71.62 | 88.34 | 95.04 |
| 227149_at | 76.9 | 127.1 | 69.27 | 64.19 | 74.48 | 49.41 | 73.11 | 78.15 | 69.58 | 56.09 | 74.22 | 69.39 | 73.39 |
| 227173_s_at | 129.2 | 58.36 | 101.5 | 53.83 | 151 | 73.91 | 84.97 | 118.4 | 76.09 | 61.68 | 81.79 | 82.14 | 104.9 |
| 227213_at | 90.62 | 70.91 | 68.14 | 34.04 | 77.82 | 50.79 | 73.29 | 67 | 45.93 | 63.03 | 59.18 | 64.81 | 77.07 |
| 227374_at | 64.27 | 53.76 | 53.75 | 43.65 | 54.71 | 43.09 | 49.06 | 49.07 | 44.69 | 43.83 | 46.15 | 59.09 | 35.2 |
| 227517_s_at | 665.7 | 490.9 | 375.9 | 294.7 | 592.7 | 304.1 | 586.3 | 447.9 | 374.8 | 403 | 492.6 | 383.1 | 483.4 |
| 227558_at | 1225 | 1149 | 983.1 | 1182 | 1261 | 1020 | 1311 | 1436 | 1135 | 1474 | 1244 | 1151 | 1010 |
| 227560_at | 123.5 | 103.2 | 96.17 | 93.85 | 122 | 92.92 | 91.11 | 83.36 | 82.01 | 91.75 | 84.95 | 73.91 | 98.43 |
| 227722_at | 247.9 | 10.38 | 116.9 | 80.32 | 179.4 | 133.7 | 246.3 | 29.79 | 7.985 | 129.4 | 133.3 | 236.3 | 77.91 |
| 227990_at | 993.2 | 793 | 1095 | 1060 | 767.2 | 1156 | 900.2 | 932.6 | 719.4 | 742.3 | 1062 | 1113 | 846.5 |
| 228012_at | 30.58 | 31.04 | 24.79 | 23.9 | 27.13 | 21.26 | 37.63 | 31.09 | 22.52 | 23.03 | 30.52 | 28.42 | 25.99 |
| 228170_at | 678.8 | 791.4 | 586.6 | 814.8 | 526.4 | 496.2 | 451.8 | 1101 | 597.1 | 787.7 | 1227 | 410.7 | 614.6 |
| 228176_at | 88.03 | 175.1 | 190.6 | 311.9 | 162.2 | 261 | 379 | 260.2 | 212 | 169.8 | 197.8 | 337.8 | 338.5 |
| 228234_at | 319.1 | 244.4 | 416.5 | 386.3 | 340.5 | 541.2 | 547 | 400.8 | 399.7 | 370.7 | 331.6 | 329.9 | 434.6 |
| 228370_at | 241 | 327.5 | 43.46 | 52.72 | 190.7 | 78.12 | 196.8 | 159.7 | 134.6 | 164.8 | 161.4 | 166.9 | 123.3 |
| 228549_at | 740.1 | 765.1 | 324.7 | 321.9 | 518.5 | 263.4 | 538.8 | 466.8 | 358 | 392.1 | 475.5 | 536.3 | 557.5 |
| 228630_at | 114.7 | 113.7 | 77.3 | 50.5 | 126.2 | 91.5 | 100.1 | 126.5 | 80.97 | 95.81 | 65.65 | 102 | 100.8 |
| 228831_s_at | 214.9 | 110.6 | 126.9 | 203.3 | 185.6 | 195.8 | 103.6 | 188.5 | 69.88 | 161.7 | 141.5 | 170.4 | 101.3 |
| 229307_at | 47.16 | 43.69 | 62.55 | 60.38 | 42.52 | 44.48 | 61.11 | 57.87 | 40.69 | 47.82 | 36.39 | 28.3 | 42.89 |
| 229421_s_at | 23.85 | 36.78 | 65.29 | 62.79 | 39.5 | 41.4 | 31.36 | 34.41 | 39.28 | 54.78 | 54.64 | 19.68 | 16.14 |
| 229509_at | 235.7 | 256.3 | 187.8 | 225.4 | 273.8 | 247.8 | 223.4 | 235 | 236.4 | 191.1 | 220.6 | 199.8 | 221.6 |
| 229854_at | 27.5 | 28.41 | 25.29 | 25.02 | 25.54 | 24.27 | 23.6 | 24.28 | 25.1 | 25.39 | 22.7 | 24.95 | 25.95 |
| 229982_at | 99.16 | 115.6 | 148 | 89.44 | 77.69 | 123.9 | 61.28 | 104.7 | 189 | 77.85 | 108 | 81.51 | 71.3 |
| 230265_at | 173.7 | 163.3 | 193.2 | 169 | 182.4 | 168.9 | 122.1 | 262.9 | 205.9 | 126.7 | 240 | 135.5 | 150.2 |
| 230320_at | 135.5 | 115.1 | 119.9 | 114.7 | 109.3 | 127.7 | 116 | 130.4 | 115.1 | 101.4 | 138.7 | 148.2 | 147.1 |
| 230408_at | 123.7 | 83.46 | 76.93 | 87.63 | 85.33 | 70.45 | 104.2 | 76.56 | 88.62 | 79.58 | 80.49 | 90.45 | 89.67 |
| 230480_at | 46.79 | 49.61 | 104.1 | 55.12 | 39.4 | 167.3 | 196.3 | 61.87 | 48.49 | 88.65 | 58.8 | 48.81 | 61.93 |
| 230837_at | 66.48 | 75.24 | 105.2 | 73.43 | 64.04 | 63.24 | 65.14 | 53.17 | 59.82 | 55.9 | 71.52 | 67.61 | 73.78 |
| 230852_at | 32.84 | 35.42 | 46.43 | 50.54 | 38.6 | 88.03 | 52.02 | 39.82 | 46.49 | 45.49 | 50.78 | 55.64 | 49.07 |
| 230922_x_at | 52.36 | 44.92 | 42.88 | 42.81 | 39.89 | 28.22 | 34.3 | 27.48 | 38.67 | 33.43 | 43.96 | 46.21 | 50.12 |
| 231283_at | 255.7 | 345.8 | 164 | 176.4 | 207.9 | 144.3 | 239.6 | 227.9 | 187.9 | 195.3 | 170.2 | 134.9 | 257.2 |
| 231697_s_at | 57.51 | 49.06 | 109.2 | 70.78 | 60.51 | 74.92 | 81.59 | 90.96 | 101.1 | 74.32 | 98.89 | 53.12 | 53.81 |
| 231836_at | 63.75 | 81.61 | 49.41 | 42.93 | 63.05 | 38.77 | 63.75 | 68.17 | 39.33 | 64.07 | 41.18 | 70.95 | 59.49 |
| 231843_at | 219.6 | 183 | 147.4 | 176.2 | 172.2 | 154.3 | 251.1 | 149.8 | 162.9 | 164.4 | 172.1 | 222.7 | 228.2 |
| 231845_at | 142.5 | 159.1 | 126.5 | 83.79 | 110.7 | 101 | 95.45 | 99.89 | 81.51 | 100.2 | 94.95 | 146.8 | 102.1 |
| 231904_at | 342.8 | 308 | 369.9 | 483.2 | 302.4 | 296.5 | 345.4 | 350.9 | 298.6 | 174.5 | 380.9 | 381.8 | 336.9 |
| 231914_at | 47.37 | 44.6 | 50.01 | 49.53 | 49.35 | 55.62 | 47.31 | 60.99 | 49.28 | 51.87 | 48.93 | 46.35 | 50.77 |
| 232636_at | 38.03 | 63.31 | 69.72 | 70.68 | 41.67 | 143.6 | 171.9 | 64 | 67.05 | 96.32 | 38.36 | 74.07 | 82.79 |
| 232851_at | 33.73 | 40.13 | 30.59 | 36.33 | 37.55 | 37.68 | 46.48 | 35.8 | 41.97 | 24.51 | 45.85 | 39.16 | 45.22 |
| 233019_at | 309.2 | 333.5 | 254 | 278.8 | 333.2 | 250.9 | 272.3 | 294.3 | 245.2 | 222.1 | 328.4 | 346.8 | 290.6 |
| 233169_at | 80.18 | 96.64 | 117.7 | 129.5 | 103.3 | 64.46 | 56.09 | 95.68 | 120 | 71.96 | 121 | 157.1 | 122.6 |
| 234013_at | 279.2 | 198.5 | 38.67 | 60.34 | 166.2 | 37.96 | 111.4 | 183.5 | 60.11 | 85.92 | 63.02 | 74.77 | 101.6 |
| 234311_s_at | 170.2 | 154.3 | 162.7 | 130.5 | 162.7 | 117.7 | 144.8 | 159.7 | 159 | 102.1 | 102.1 | 138.3 | 155.6 |
| 234339_s_at | 3050 | 2546 | 1454 | 994.6 | 2055 | 1286 | 2190 | 1851 | 1412 | 1361 | 1486 | 1714 | 2004 |
| 234464_s_at | 33.39 | 24.58 | 34.01 | 41.76 | 43.61 | 42.23 | 62.47 | 37.76 | 35.21 | 58.67 | 32.94 | 27.56 | 40.37 |
| 234733_s_at | 28.05 | 26.4 | 32.88 | 21.82 | 25.82 | 26.66 | 27.13 | 26.1 | 24.42 | 25.45 | 24.62 | 27.65 | 28.88 |
| 235024_at | 95.81 | 92.55 | 62.17 | 123.2 | 91.5 | 78.8 | 93.65 | 89.02 | 87.13 | 84.81 | 115.2 | 93.01 | 97.89 |
| 235067_at | 829.8 | 1009 | 670.5 | 924.8 | 852 | 731.1 | 1018 | 911.4 | 819.9 | 749.5 | 984.3 | 1248 | 1124 |
| 235200_at | 128.2 | 115 | 75.38 | 91.14 | 111.9 | 120 | 113.9 | 117.8 | 102.3 | 111.4 | 116.1 | 142.9 | 122.6 |
| 235359_at | 321.6 | 299.2 | 423.5 | 300.2 | 269.2 | 554.8 | 410.8 | 442 | 347 | 285.3 | 291.1 | 332.5 | 380.5 |
| 235593_at | 533.7 | 558.9 | 954.7 | 859 | 571.1 | 700 | 397.7 | 673.6 | 838.9 | 717.7 | 704 | 669.8 | 735.9 |
| 235610_at | 56.91 | 53.65 | 55.12 | 49.21 | 59.52 | 55.39 | 74.39 | 54.29 | 46.46 | 49.09 | 42.59 | 69.13 | 62.11 |
| 235623_at | 36.18 | 26.15 | 24.61 | 19.77 | 28.45 | 21.64 | 17.93 | 24.28 | 21.45 | 19.5 | 27.14 | 33.68 | 26.02 |
| 235690_at | 22.55 | 37.09 | 25.77 | 18.72 | 27.81 | 21.91 | 33.6 | 21.8 | 20.88 | 23.62 | 23.88 | 26.99 | 23.51 |
| 237504_at | 77.22 | 74.54 | 92.7 | 68.95 | 100.5 | 71.33 | 57.94 | 69.81 | 61.22 | 82.59 | 67.52 | 74.17 | 83.59 |
| 238429_at | 4067 | 3723 | 3091 | 4433 | 4492 | 3013 | 3163 | 4435 | 3400 | 3861 | 4426 | 3310 | 2677 |
| 238513_at | 196.1 | 695.7 | 1662 | 1570 | 651.3 | 1369 | 1266 | 1187 | 3168 | 1275 | 754.1 | 1372 | 1163 |
| 238736_at | 305.3 | 228.1 | 169.4 | 174 | 188.6 | 201 | 354.6 | 193.4 | 205.8 | 233.1 | 293.2 | 287.9 | 241.8 |
| 238823_at | 33.58 | 61.67 | 49.68 | 57.17 | 39.28 | 52.18 | 43.43 | 37.48 | 58.11 | 45.1 | 53.26 | 50.27 | 74.08 |
| 238909_at | 205.3 | 199.7 | 208.7 | 86.3 | 121.3 | 168.4 | 140.3 | 162.3 | 200.9 | 127.8 | 175.2 | 235.9 | 188.1 |
| 239108_at | 121.1 | 171.9 | 299 | 254 | 256.2 | 379.3 | 437.3 | 313.8 | 308.2 | 247.3 | 204.2 | 237.9 | 270.9 |
| 239897_at | 232 | 217.5 | 174.6 | 226.5 | 238.7 | 218.8 | 189.7 | 238.7 | 208.1 | 213.6 | 231.6 | 195.6 | 195.1 |
| 241368_at | 302.1 | 219.9 | 252.6 | 468.5 | 326 | 285.8 | 236.6 | 261.3 | 247.5 | 490.9 | 397.7 | 294.3 | 226.9 |
| 241704_x_at | 60.66 | 69.05 | 36.96 | 51.34 | 68.48 | 50.01 | 70.82 | 60.85 | 51.66 | 46.9 | 54.39 | 47.97 | 55.65 |
| 241706_at | 65.56 | 108.5 | 138.5 | 97.75 | 124.7 | 176 | 113.3 | 122.6 | 147.5 | 119.9 | 148.1 | 139.6 | 132.8 |
| 241731_x_at | 71.37 | 64.71 | 42.02 | 53.07 | 52.44 | 45.49 | 68.12 | 35.82 | 61.14 | 47.25 | 47.63 | 48.87 | 59.83 |
| 242197_x_at | 17.91 | 25.19 | 89.07 | 57.92 | 65.49 | 72.47 | 29.96 | 48.22 | 95.53 | 81.69 | 22.9 | 113.9 | 57.08 |
| 242561_at | 19.94 | 24.3 | 24.73 | 17.7 | 23.85 | 20.48 | 31.5 | 21.37 | 22.96 | 16.5 | 19.05 | 25.81 | 24.62 |
| 242569_at | 178.3 | 234.3 | 229.3 | 340.9 | 257.1 | 281.6 | 230.7 | 252.6 | 246.1 | 224 | 281 | 268.2 | 252.2 |
| 242669_at | 243.6 | 270.7 | 283.7 | 175.2 | 230 | 211.2 | 368.1 | 234.5 | 230.2 | 233.6 | 249.3 | 244.6 | 342.1 |
| 243982_at | 84.4 | 112.2 | 101.6 | 97.56 | 87.46 | 59.98 | 118.8 | 81 | 96.64 | 89.86 | 119.7 | 114.8 | 91.68 |
| 244038_at | 49.65 | 52.57 | 35.46 | 32.19 | 55.43 | 39.55 | 51.22 | 40.45 | 42.61 | 39.81 | 44.63 | 40.78 | 62.69 |
| 244654_at | 2579 | 2211 | 1515 | 1374 | 1740 | 1897 | 1641 | 1973 | 1637 | 1402 | 1518 | 2772 | 2458 |
| 244698_at | 36.17 | 36.16 | 33.09 | 34.07 | 33.99 | 33.24 | 36 | 29.36 | 33.48 | 32.75 | 33.09 | 33.08 | 33 |
| 36566_at | 112.6 | 92.4 | 145.3 | 93.96 | 121.5 | 149.4 | 143.9 | 134.9 | 91.36 | 115.1 | 117.2 | 116.2 | 163.7 |
| 37549_g_at | 45.26 | 47.91 | 48.32 | 44.91 | 43.99 | 38.33 | 41.42 | 51.24 | 42.04 | 49.43 | 41.89 | 41.81 | 45.13 |
| 48659_at | 229.9 | 200.5 | 235.5 | 255.8 | 219.5 | 288.6 | 246.7 | 258.1 | 238.2 | 266.5 | 227.1 | 245 | 221.1 |
| 56829_at | 187.1 | 157.1 | 169.8 | 143.1 | 151.9 | 179.4 | 191.6 | 164.4 | 148.1 | 141.5 | 137.7 | 180.4 | 144.1 |
| 64486_at | 264.6 | 339 | 265.6 | 205.5 | 206.8 | 396.7 | 275.3 | 328.4 | 248.2 | 239.6 | 239.7 | 243.7 | 227.5 |
| 65493_at | 77.29 | 45.24 | 57.39 | 42.09 | 38.91 | 45.01 | 45.17 | 49.75 | 40.37 | 36.64 | 36.04 | 33.56 | 40 |
| AFFX- | 8927 | 9149 | 10452 | 8604 | 9229 | 10902 | 12541 | 11889 | 9973 | 9622 | 9651 | 9362 | 9948 |
| HUMGAPDH/M33197_3_at | | | | | | | | | | | | | |
| | NYHA III- | NYHA III- | NYHA III- | NYHA III- | NYHA III- | NYHA III- | NYHA III- | NYHA III- | NYHA III- | NYHA III- | NYHA III- | NYHA III- | NYHA III- |
| | IV | IV | IV | IV | IV | IV | IV | IV | IV | IV | IV | IV | IV |
| Affymetrix Probe | Sample | Sample | Sample | Sample | Sample | Sample | Sample | Sample | Sample | Sample | Sample | Sample | Sample |
| set ID | no. 30 | no. 32 | no. 38 | no. 42 | no. 43 | no. 46 | no. 47 | no. 57 | no. 59 | no. 60 | no. 61 | no. 62 | no. 63 |
| 1552318_at | 2242 | 1539 | 1291 | 1058 | 905.3 | 888.9 | 1460 | 1451 | 932.3 | 1445 | 1560 | 1507 | 1391 |
| 1552630_a_at | 79.82 | 81.19 | 81.02 | 93.5 | 80.46 | 89.7 | 92.17 | 63.15 | 73.26 | 75.87 | 56.77 | 79.49 | 128.3 |
| 1554149_at | 596.2 | 674.1 | 690.1 | 561.1 | 529.2 | 615.8 | 674.1 | 691.2 | 489.5 | 643 | 682.5 | 495 | 577.1 |
| 1554539_a_at | 106.6 | 76.89 | 84.88 | 64.36 | 92.86 | 27.59 | 78.72 | 93.91 | 52.61 | 77.04 | 59.96 | 68.37 | 61.16 |
| 1554606_at | 156.8 | 128.8 | 120.3 | 73.14 | 123.4 | 115.4 | 117.5 | 127.4 | 119.3 | 109.4 | 115.6 | 75.61 | 124.7 |
| 1555630_a_at | 101.5 | 142.2 | 130.2 | 103.1 | 197.5 | 108.3 | 153.9 | 158.6 | 283.7 | 100.5 | 119 | 170.4 | 144.4 |
| 1555963_x_at | 43.86 | 29.06 | 34.82 | 45.77 | 61.12 | 81.77 | 47.05 | 48.2 | 57.92 | 33.45 | 50.06 | 61.33 | 104.6 |
| 1555996_s_at | 1352 | 987.2 | 844.5 | 591.5 | 602.6 | 595.2 | 1124 | 806.3 | 431.9 | 959.6 | 1039 | 589.3 | 1111 |
| 1556113_at | 35.23 | 40.01 | 39.06 | 36.75 | 41.35 | 44.5 | 42.54 | 45.87 | 55.66 | 37.54 | 41.49 | 42.48 | 48.66 |
| 1556283_s_at | 129.2 | 100.3 | 109.9 | 134.5 | 119.4 | 159.8 | 74.83 | 174.1 | 143.3 | 99.34 | 96.3 | 98.56 | 93.72 |
| 1556864_at | 58.24 | 46.75 | 47.18 | 47.15 | 46.5 | 47.97 | 47.51 | 30.96 | 41.72 | 38.23 | 42.11 | 40.74 | 55.74 |
| 1557066_at | 253.6 | 151.2 | 162.6 | 138.2 | 93.65 | 84.9 | 198.2 | 140.3 | 60.41 | 151.2 | 138 | 159.6 | 223.8 |
| 1558277_at | 29.38 | 41.31 | 40.09 | 44.57 | 31.5 | 27.29 | 48.67 | 29.46 | 33.35 | 54.45 | 16.61 | 29.93 | 29.39 |
| 1558755_x_at | 160.8 | 180.1 | 198.6 | 136.5 | 127 | 131.1 | 122 | 162.3 | 82.87 | 131 | 113.4 | 157.7 | 132.2 |
| 1561146_at | 65.35 | 67.93 | 69.31 | 57.62 | 57.78 | 76.68 | 74.87 | 61.08 | 37.53 | 68.17 | 65.61 | 65.76 | 96.47 |
| 1564962_at | 29.93 | 27.54 | 30.96 | 27.38 | 26.75 | 30.85 | 36.49 | 42.28 | 32.19 | 30.9 | 29.32 | 29.99 | 40.71 |
| 1567013_at | 85.52 | 82.72 | 93.39 | 112.8 | 186.3 | 156.5 | 133.9 | 150.8 | 204.1 | 92.99 | 154.6 | 105.6 | 110.1 |
| 1568815_a_at | 149.7 | 144.8 | 157.4 | 111.2 | 120 | 92.46 | 168.8 | 199.1 | 142.8 | 130.8 | 163.6 | 93.71 | 168.6 |
| 200007_at | 8094 | 8321 | 7235 | 6658 | 6833 | 6479 | 8016 | 7275 | 7006 | 7751 | 7631 | 7961 | 8081 |
| 200010_at | 14932 | 14036 | 12417 | 9416 | 9651 | 8491 | 12335 | 12609 | 7564 | 13404 | 12371 | 10736 | 13636 |
| 200059_s_at | 9370 | 10340 | 10002 | 9420 | 10282 | 11228 | 10304 | 10606 | 10848 | 10119 | 10883 | 10365 | 10600 |
| 200091_s_at | 26352 | 19722 | 20137 | 16465 | 18633 | 14091 | 18498 | 22499 | 14047 | 19913 | 21148 | 17890 | 18552 |
| 200633_at | 7442 | 10359 | 9005 | 7483 | 9170 | 6257 | 9155 | 8592 | 6875 | 8662 | 8614 | 8383 | 9435 |
| 200650_s_at | 6401 | 5291 | 5958 | 4764 | 5227 | 5070 | 6805 | 5454 | 5512 | 7502 | 6473 | 5549 | 6043 |
| 200672_x_at | 192.4 | 185.1 | 128.1 | 108.9 | 130 | 98.62 | 163.7 | 122.8 | 79.64 | 186.6 | 146.8 | 133.9 | 139.1 |
| 200677_at | 2817 | 2361 | 2488 | 2993 | 3391 | 3942 | 3203 | 3052 | 3848 | 3010 | 3600 | 2765 | 2718 |
| 200713_s_at | 1566 | 1494 | 1398 | 1317 | 1337 | 1437 | 1541 | 1453 | 1273 | 1731 | 1707 | 1465 | 1389 |
| 200822_x_at | 1313 | 1222 | 1339 | 1263 | 1312 | 1267 | 1221 | 1307 | 1606 | 1619 | 1561 | 1444 | 1494 |
| 200829_x_at | 585.1 | 619.8 | 583.4 | 538.1 | 686 | 478 | 580.7 | 681.3 | 596.9 | 601.8 | 614 | 513.3 | 662.4 |
| 200839_s_at | 2559 | 2787 | 3063 | 3165 | 3562 | 3176 | 1985 | 3674 | 4503 | 3126 | 2265 | 3091 | 3030 |
| 200932_s_at | 489.1 | 509.7 | 460.2 | 425.6 | 699.9 | 445.6 | 475 | 530.7 | 692.2 | 518.8 | 455.6 | 467.2 | 436.3 |
| 200950_at | 385.2 | 469.8 | 523.9 | 489.4 | 772.7 | 590.4 | 539.9 | 642.3 | 745.2 | 514.2 | 586.3 | 606.9 | 467.4 |
| 201031_s_at | 10496 | 9493 | 10650 | 7290 | 6886 | 5079 | 8552 | 9114 | 6756 | 7609 | 8258 | 8842 | 8949 |
| 201075_s_at | 340.2 | 292.5 | 315.2 | 274.3 | 312.9 | 385.8 | 340.7 | 231.1 | 286.6 | 364.9 | 314.7 | 244.7 | 342 |
| 201098_at | 828 | 771.6 | 778.6 | 758.8 | 768 | 852 | 838.5 | 911.6 | 791.3 | 863.1 | 831.6 | 761.2 | 708.1 |
| 201105_at | 3918 | 4069 | 4216 | 3179 | 5000 | 2612 | 4533 | 3478 | 5181 | 4167 | 3241 | 3646 | 5847 |
| 201172_x_at | 2924 | 3496 | 3381 | 3481 | 4266 | 3836 | 3754 | 3595 | 4765 | 3516 | 3847 | 3913 | 2994 |
| 201186_at | 499.9 | 467.1 | 588.6 | 485.5 | 454.6 | 516.2 | 476.5 | 391.7 | 473.4 | 579.5 | 551 | 686.4 | 469.8 |
| 201193_at | 540.2 | 541.2 | 576.9 | 517 | 690.5 | 517.8 | 522.2 | 727.3 | 953 | 493.2 | 540.9 | 629.8 | 389.3 |
| 201198_s_at | 165.5 | 170.5 | 143.9 | 117.2 | 200.9 | 159.9 | 175.7 | 186.9 | 190.4 | 191.6 | 184.6 | 156.1 | 172.7 |
| 201220_x_at | 1174 | 1674 | 2053 | 1753 | 2085 | 1865 | 1904 | 1775 | 2146 | 1585 | 1674 | 1928 | 1820 |
| 201234_at | 1014 | 1332 | 1106 | 1236 | 1729 | 1072 | 1214 | 1272 | 2116 | 1262 | 1389 | 1375 | 1256 |
| 201357_s_at | 288.4 | 334 | 353 | 335.2 | 296.5 | 503.6 | 480.1 | 291.7 | 324.1 | 410.5 | 316.5 | 325.4 | 438.9 |
| 201363_s_at | 1358 | 1683 | 1800 | 1143 | 1116 | 1474 | 1667 | 1738 | 1024 | 1555 | 1619 | 1675 | 1424 |
| 201400_at | 1440 | 1683 | 1704 | 1719 | 3455 | 1808 | 1746 | 1919 | 3542 | 2002 | 1789 | 1792 | 1563 |
| 201421_s_at | 154.6 | 206 | 146.4 | 137.8 | 152.7 | 101.3 | 149.7 | 129.9 | 151.4 | 150.6 | 164.2 | 158 | 167.6 |
| 201422_at | 7153 | 8362 | 7384 | 8820 | 9242 | 7783 | 7424 | 8319 | 10654 | 8172 | 8324 | 8614 | 8739 |
| 201426_s_at | 16320 | 16046 | 17319 | 14390 | 17999 | 16975 | 16749 | 15035 | 19680 | 17018 | 16472 | 18618 | 17760 |
| 201453_x_at | 1238 | 1342 | 1258 | 1237 | 1414 | 1512 | 1288 | 1351 | 1308 | 1568 | 1379 | 1286 | 1388 |
| 201470_at | 1254 | 1197 | 1069 | 1053 | 1399 | 1384 | 1109 | 1370 | 1581 | 1579 | 1335 | 1188 | 1228 |
| 201478_s_at | 329.5 | 308.1 | 272.1 | 195 | 214.2 | 243.4 | 305.4 | 252.5 | 153.1 | 267.5 | 291 | 213.8 | 316.8 |
| 201527_at | 924.4 | 887.4 | 875.2 | 780.1 | 797 | 866.7 | 793.6 | 897.2 | 982.7 | 990.5 | 832.6 | 1002 | 910.5 |
| 201536_at | 268.9 | 357 | 345.1 | 344.9 | 405.7 | 454.8 | 297 | 425.9 | 624.2 | 328.1 | 420.3 | 330.3 | 369.7 |
| 201554_x_at | 687.6 | 791.7 | 738.9 | 730.1 | 1446 | 746.2 | 854.7 | 731.3 | 1368 | 975.8 | 935.4 | 885.6 | 631.8 |
| 201556_s_at | 418.8 | 649.3 | 502.7 | 647.2 | 471.3 | 780.8 | 731.4 | 573.7 | 473.7 | 496.6 | 744.3 | 595.9 | 682.5 |
| 201576_s_at | 510.3 | 749 | 634.8 | 516.2 | 977.5 | 719.2 | 589.6 | 788 | 1270 | 625.8 | 726.4 | 711.8 | 724.4 |
| 201590_x_at | 3195 | 4041 | 3708 | 2724 | 3642 | 2278 | 3604 | 3215 | 5044 | 4145 | 3546 | 3635 | 4007 |
| 201628_s_at | 635.2 | 641.4 | 576 | 543.6 | 806.7 | 611.8 | 588.1 | 612.1 | 827.2 | 625 | 637.3 | 608 | 529.5 |
| 201788_at | 601.9 | 538.2 | 542.4 | 499.5 | 406.1 | 468.6 | 545.7 | 542.8 | 390 | 555.3 | 617.3 | 504.5 | 540 |
| 201900_s_at | 445.1 | 556.4 | 448 | 345.5 | 526.3 | 383 | 407.4 | 449 | 547 | 508.1 | 397.9 | 476.2 | 474 |
| 201945_at | 273.1 | 345.5 | 486.1 | 588.7 | 572.4 | 786.9 | 539.2 | 351.4 | 544.8 | 567.7 | 521.2 | 597 | 509.6 |
| 202068_s_at | 140.4 | 107.1 | 113.8 | 102.5 | 196.3 | 132.1 | 93.85 | 91.05 | 94.52 | 98.56 | 183.8 | 139.5 | 89.16 |
| 202104_s_at | 473.3 | 471.6 | 419.4 | 312.2 | 352.7 | 306.4 | 373.8 | 363.1 | 306.2 | 468.4 | 383.2 | 385.5 | 418.6 |
| 202138_x_at | 282 | 318.3 | 263 | 217.2 | 296.5 | 199.7 | 247 | 257.2 | 304.4 | 385.8 | 253.8 | 272.6 | 300.8 |
| 202185_at | 248 | 267.8 | 238.2 | 168.2 | 170.6 | 187.4 | 215 | 172.2 | 210.9 | 229.5 | 199.2 | 241.2 | 222.5 |
| 202192_s_at | 542.8 | 607.6 | 715.2 | 493.8 | 667 | 1120 | 750.9 | 552.3 | 775.1 | 740 | 996.1 | 890.7 | 829.7 |
| 202201_at | 424.7 | 566.5 | 663.5 | 425.4 | 852.2 | 627.1 | 630 | 681.3 | 1056 | 552.8 | 486.7 | 495.1 | 763.3 |
| 202249_s_at | 257.3 | 233.9 | 212.7 | 215.5 | 188.8 | 267.9 | 221.9 | 196.6 | 225 | 248.6 | 250.1 | 219.2 | 250.4 |
| 202252_at | 94.15 | 84.42 | 73.94 | 93.93 | 89.51 | 105.5 | 88.69 | 116.4 | 131 | 96.34 | 103.4 | 111.7 | 65.8 |
| 202262_x_at | 83.29 | 86.94 | 100.9 | 114.2 | 140.9 | 147.6 | 155.2 | 91.04 | 127.1 | 127.8 | 134.9 | 119.8 | 99.93 |
| 202380_s_at | 747.3 | 841.2 | 577 | 505.4 | 567.7 | 524.5 | 601.5 | 598 | 417.6 | 698 | 700.3 | 580 | 615.3 |
| 202381_at | 335.3 | 335.7 | 556.3 | 382.3 | 480.4 | 438.7 | 456.6 | 474.7 | 790.8 | 400.8 | 465.4 | 483.1 | 322.4 |
| 202428_x_at | 2440 | 2367 | 2226 | 1746 | 1884 | 1654 | 2055 | 2081 | 1885 | 2690 | 2301 | 2348 | 2281 |
| 202445_s_at | 127.7 | 152.9 | 149.7 | 199.4 | 275.7 | 278.1 | 154.9 | 187.9 | 248.9 | 127.3 | 199.8 | 135.7 | 148.2 |
| 202461_at | 177.4 | 220.8 | 169.4 | 151 | 190 | 131.7 | 180 | 187.7 | 165.1 | 254.1 | 160.2 | 184.9 | 148.8 |
| 202522_at | 771.8 | 772.2 | 734.2 | 628.5 | 620.7 | 684.5 | 769.6 | 730.1 | 602.5 | 765.1 | 684.8 | 643.9 | 582.7 |
| 202523_s_at | 388 | 194.3 | 193.7 | 167.6 | 87.8 | 59.42 | 226.3 | 105.1 | 58.93 | 215.8 | 102.4 | 163 | 189.8 |
| 202594_at | 1466 | 997.7 | 844.3 | 753.5 | 867.9 | 849.3 | 816.9 | 1147 | 643.3 | 980 | 1070 | 740.4 | 687.2 |
| 202623_at | 1116 | 1088 | 1128 | 1064 | 1154 | 1249 | 1176 | 1161 | 1152 | 1231 | 1133 | 1153 | 1118 |
| 202652_at | 46.75 | 33.52 | 31.35 | 34.66 | 37.54 | 10.2 | 34.87 | 30.18 | 20.19 | 26.6 | 43.26 | 20.45 | 34.67 |
| 202724_s_at | 770.5 | 444.2 | 500.5 | 488.4 | 402.3 | 533.6 | 500.2 | 485.3 | 277.5 | 537 | 595 | 468.9 | 440.6 |
| 202750_s_at | 157.3 | 175.4 | 204.9 | 184.5 | 204 | 273.2 | 232.6 | 195.4 | 213.4 | 197.9 | 202.9 | 198.9 | 190.3 |
| 202778_s_at | 639 | 545.7 | 592.8 | 515.4 | 597.9 | 493.5 | 439.6 | 584.4 | 566.9 | 600 | 591.7 | 471.8 | 458.4 |
| 202910_s_at | 3263 | 3327 | 3728 | 5576 | 3420 | 5809 | 4204 | 3010 | 3174 | 4258 | 3927 | 5264 | 3827 |
| 202928_s_at | 164.1 | 147.2 | 200.4 | 139.4 | 165.8 | 161.4 | 150.7 | 130.9 | 132.1 | 142.4 | 156.1 | 102.9 | 159.1 |
| 202944_at | 344 | 455.3 | 372.8 | 339 | 398.8 | 358.1 | 298 | 484.1 | 583.8 | 435.7 | 394 | 553.6 | 426.8 |
| 202979_s_at | 982.1 | 799.6 | 732.6 | 579.2 | 541.1 | 445.4 | 597.9 | 724.7 | 376.5 | 685.1 | 828 | 514.3 | 695.1 |
| 203003_at | 70.85 | 98.08 | 109.5 | 96.34 | 80.24 | 132.2 | 107.7 | 102.2 | 92.93 | 88.18 | 96.3 | 110 | 114.6 |
| 203127_s_at | 207.5 | 266.3 | 260 | 350.3 | 381.3 | 424.6 | 288.5 | 376.8 | 494.8 | 339.7 | 207.9 | 374 | 310.7 |
| 203137_at | 2017 | 1923 | 1725 | 1624 | 1593 | 1343 | 2020 | 1409 | 1269 | 1781 | 1735 | 1780 | 1888 |
| 203184_at | 77.68 | 61.55 | 99.83 | 38.15 | 155.4 | 108 | 25.71 | 213 | 137.6 | 87.58 | 95.36 | 83.1 | 58.36 |
| 203234_at | 476.4 | 480.5 | 469.8 | 532.3 | 802.2 | 534.3 | 534.6 | 421.1 | 700.2 | 677.4 | 615.7 | 554.3 | 472.9 |
| 203278_s_at | 934.1 | 903.2 | 1038 | 1450 | 1097 | 1363 | 1226 | 1011 | 1181 | 1052 | 1352 | 1167 | 800.3 |
| 203305_at | 1057 | 1081 | 1412 | 781.4 | 1405 | 1219 | 1455 | 1523 | 2234 | 1036 | 1229 | 1417 | 1421 |
| 203371_s_at | 1008 | 1214 | 1300 | 1588 | 2029 | 1581 | 1253 | 1310 | 1748 | 1230 | 1465 | 1397 | 809.8 |
| 203413_at | 1417 | 386.4 | 404.1 | 270.6 | 327.9 | 252.1 | 235.5 | 528.1 | 172.4 | 568.5 | 591.4 | 183.8 | 170.7 |
| 203416_at | 9918 | 10508 | 9211 | 11279 | 12154 | 11943 | 11248 | 10836 | 12928 | 11626 | 11913 | 9875 | 10573 |
| 203492_x_at | 261.7 | 270.4 | 215.2 | 187 | 233.9 | 210.9 | 264.9 | 221 | 143.2 | 262 | 225.9 | 165.7 | 258.7 |
| 203534_at | 793.8 | 872.3 | 798 | 729.1 | 1060 | 761.1 | 759.4 | 916.5 | 996.3 | 962.4 | 816.6 | 730.3 | 689.8 |
| 203535_at | 35336 | 37891 | 39379 | 42102 | 43833 | 44686 | 44450 | 39025 | 44915 | 41970 | 41641 | 43082 | 37824 |
| 203578_s_at | 173.9 | 92.99 | 117.7 | 66.44 | 112.9 | 45.92 | 103.9 | 121.6 | 82.03 | 113.1 | 92.06 | 87.11 | 122.3 |
| 203748_x_at | 1497 | 1571 | 1536 | 1602 | 1865 | 1865 | 1676 | 1561 | 1791 | 1573 | 1656 | 1524 | 1285 |
| 203759_at | 77.13 | 65.49 | 140.1 | 143.1 | 182.2 | 148.2 | 226.4 | 95.1 | 104.9 | 146.1 | 138.1 | 131.8 | 78.25 |
| 203844_at | 27.28 | 26.02 | 27.26 | 28.27 | 25.86 | 41.52 | 28.77 | 29.01 | 29.66 | 32.15 | 27.36 | 28.35 | 29.88 |
| 203880_at | 245.2 | 306 | 245.4 | 254.7 | 288.4 | 294.8 | 310.3 | 292.1 | 259.7 | 304 | 261.8 | 309.9 | 281.1 |
| 203912_s_at | 176.4 | 187.9 | 167.5 | 190 | 248.7 | 234.9 | 208.3 | 244.4 | 259.7 | 247.7 | 207.4 | 212.7 | 253.5 |
| 203939_at | 236.2 | 63.46 | 42.92 | 72.37 | 73.82 | 72.81 | 38.83 | 91.54 | 44.3 | 85.86 | 59.43 | 42.47 | 34.81 |
| 203971_at | 99.42 | 96.24 | 105.2 | 120.2 | 117.4 | 141.1 | 98.79 | 132.4 | 147.6 | 113 | 114.7 | 119.7 | 117.4 |
| 204050_s_at | 1335 | 1469 | 1258 | 910.5 | 1275 | 1123 | 1332 | 1496 | 1513 | 1326 | 1143 | 1328 | 1350 |
| 204068_at | 49.14 | 61.67 | 74.54 | 121.1 | 134.2 | 105.2 | 83.02 | 103.9 | 120.7 | 62.94 | 94.43 | 92.86 | 62.17 |
| 204099_at | 101 | 157.8 | 192.4 | 192.5 | 345 | 153.6 | 192.3 | 162.9 | 423.4 | 111.3 | 174.5 | 205.9 | 149.6 |
| 204143_s_at | 263.7 | 192.1 | 171.9 | 137.2 | 117.2 | 54.75 | 144.6 | 249.7 | 81.46 | 238.2 | 168.7 | 134.9 | 105.2 |
| 204204_at | 1429 | 1818 | 1853 | 3323 | 2702 | 3546 | 1781 | 2584 | 2705 | 2094 | 2275 | 2961 | 1968 |
| 204214_s_at | 410.3 | 495.7 | 562 | 461.7 | 721 | 658.1 | 515.1 | 526 | 1022 | 568.1 | 609.4 | 564.9 | 583.9 |
| 204232_at | 3600 | 4224 | 4319 | 5783 | 4532 | 3492 | 3499 | 3476 | 3993 | 6080 | 4858 | 4486 | 3867 |
| 204243_at | 314.2 | 240.4 | 281.2 | 344.2 | 361.4 | 429.4 | 357.1 | 305 | 419.3 | 353.5 | 434.8 | 266.3 | 219.1 |
| 204249_s_at | 2082 | 2965 | 2843 | 3524 | 2792 | 3427 | 2954 | 3178 | 3156 | 2738 | 2838 | 2898 | 3206 |
| 204291_at | 419.9 | 509.5 | 559.4 | 388.3 | 497.9 | 385.1 | 368 | 519.3 | 439.5 | 326.4 | 403.4 | 452 | 476.8 |
| 204342_at | 951.2 | 998.5 | 998.5 | 700.3 | 907.7 | 633.3 | 646.6 | 848.1 | 1138 | 707.9 | 862.8 | 994.8 | 835.4 |
| 204352_at | 846.1 | 535 | 345.2 | 338.3 | 348.1 | 201.5 | 415.7 | 408.5 | 146 | 479 | 452.5 | 220.7 | 447.2 |
| 204401_at | 157.5 | 115 | 135.2 | 129.5 | 93.14 | 117.2 | 134.1 | 113.5 | 107.5 | 249.3 | 117.5 | 73.71 | 108.1 |
| 204504_s_at | 105.6 | 109.8 | 95.55 | 79.46 | 106.1 | 79.14 | 107 | 78.48 | 77.95 | 99.2 | 81.46 | 96.7 | 106.8 |
| 204617_s_at | 352.1 | 352.3 | 313.2 | 203.1 | 273.5 | 297.6 | 364.8 | 267 | 207.5 | 327.9 | 320.5 | 292.9 | 332.6 |
| 204645_at | 961.5 | 954.7 | 954.5 | 763 | 906.6 | 869.4 | 788 | 899 | 763.8 | 768 | 893 | 837.7 | 816.6 |
| 204675_at | 116.6 | 131.9 | 140.8 | 97.14 | 94.52 | 67.28 | 123.2 | 96.17 | 163.7 | 113 | 182.2 | 134.3 | 81.8 |
| 204689_at | 399.9 | 490.7 | 514.6 | 574.5 | 566.5 | 612.6 | 448.3 | 476.9 | 716.9 | 446.8 | 446.5 | 535.7 | 513.2 |
| 204801_s_at | 27.17 | 23.72 | 32.36 | 30.51 | 43.09 | 38.21 | 28.75 | 21.24 | 28.61 | 30.96 | 37.21 | 29.37 | 20.79 |
| 205235_s_at | 90.45 | 82.38 | 75.57 | 83.87 | 85.8 | 81.83 | 94.99 | 83.77 | 81.48 | 83.85 | 81.72 | 97.75 | 87.34 |
| 205254_x_at | 818.8 | 221.9 | 258.2 | 288.2 | 199.3 | 118.8 | 300.3 | 255.7 | 74.92 | 409.9 | 363.4 | 183.1 | 215.9 |
| 205256_at | 80.37 | 65.09 | 58.19 | 66.1 | 72.93 | 67.27 | 73.59 | 65.63 | 59.56 | 74.77 | 66.32 | 55.35 | 65.67 |
| 205322_s_at | 362.2 | 489.3 | 509.2 | 652.3 | 724.6 | 578.2 | 520 | 600.8 | 836.9 | 502.1 | 529.7 | 624.7 | 426 |
| 205340_at | 163.9 | 142.4 | 145.9 | 120.7 | 110.9 | 88.36 | 133.5 | 108.7 | 97.64 | 131.4 | 138.7 | 107.9 | 155.2 |
| 205349_at | 159.7 | 150.9 | 201.1 | 161 | 198.3 | 193.4 | 149.8 | 196.6 | 215.6 | 170 | 221 | 158.2 | 183.6 |
| 205550_s_at | 274.2 | 267.2 | 251.9 | 225.8 | 298 | 320.3 | 249.9 | 311.5 | 305.8 | 270.9 | 263.4 | 274 | 271.7 |
| 205811_at | 210.1 | 209.3 | 165.7 | 148.5 | 156.7 | 122.1 | 159.9 | 138.1 | 96.19 | 161.1 | 156.9 | 151.9 | 161 |
| 205835_s_at | 122.9 | 96.7 | 101.8 | 76.36 | 81.88 | 98.72 | 96.7 | 94.61 | 76.2 | 95.27 | 121.1 | 62.99 | 119.1 |
| 205895_s_at | 154.8 | 156.1 | 159.2 | 94.91 | 101.5 | 89.69 | 198.6 | 125.6 | 47.55 | 165.7 | 141.8 | 116.5 | 190 |
| 205965_at | 199 | 254.8 | 218.5 | 209.5 | 257.7 | 250 | 316.3 | 193.8 | 223.4 | 237.8 | 245.3 | 165.6 | 178.2 |
| 205976_at | 103.6 | 55.61 | 51.95 | 33.01 | 42.48 | 10.71 | 30.3 | 46.09 | 11.1 | 44.06 | 53.33 | 28.46 | 36.84 |
| 206015_s_at | 874.4 | 791.7 | 643.9 | 638.8 | 636.5 | 666.5 | 721.7 | 770.4 | 507.9 | 577.4 | 771.6 | 649.3 | 591.5 |
| 206037_at | 35.5 | 30.76 | 34.98 | 34.85 | 35.07 | 35.4 | 39.78 | 25.28 | 27.83 | 31.87 | 35.67 | 30.02 | 47.09 |
| 206170_at | 228.4 | 418.7 | 306.6 | 377.7 | 297.6 | 232.9 | 252.3 | 255.2 | 331.2 | 234.1 | 301.2 | 237.3 | 237.9 |
| 206182_at | 117.9 | 110.3 | 89.88 | 84.25 | 93.39 | 92.46 | 107.6 | 114.2 | 62.95 | 74.19 | 97.2 | 97.94 | 102.6 |
| 206343_s_at | 14.79 | 25.4 | 87.08 | 32.17 | 54.1 | 51.26 | 37.54 | 23.22 | 40.25 | 10.7 | 26.48 | 25.65 | 9.248 |
| 206542_s_at | 1441 | 1363 | 1347 | 1177 | 1035 | 1370 | 1340 | 1276 | 984.1 | 1401 | 1484 | 1178 | 1062 |
| 206580_s_at | 66.07 | 43.12 | 60.9 | 79.21 | 66.83 | 92.86 | 77.65 | 54.61 | 54.43 | 77.82 | 95.49 | 65.22 | 44.99 |
| 206715_at | 206.7 | 321.7 | 353.3 | 212.1 | 337.5 | 260.5 | 205.7 | 391.4 | 585 | 230 | 175.1 | 322.6 | 304 |
| 206834_at | 102.6 | 90.13 | 96.17 | 218.2 | 96.06 | 517.1 | 72.7 | 106.3 | 73 | 82.11 | 239.7 | 60.24 | 73.46 |
| 206968_s_at | 132.6 | 100.5 | 91.02 | 89.19 | 104.3 | 92.83 | 119.1 | 85.77 | 84.35 | 154.6 | 72.46 | 109.3 | 120.2 |
| 207075_at | 80.75 | 128.5 | 165.6 | 119.9 | 397.9 | 233.5 | 192.2 | 204.5 | 338.4 | 118.2 | 155.1 | 160.3 | 102 |
| 207078_at | 222.4 | 235 | 209.3 | 174.1 | 121.1 | 133.3 | 164.5 | 130.3 | 87.84 | 149.2 | 131.5 | 150.8 | 207 |
| 207113_s_at | 120.4 | 102.6 | 101.4 | 176.3 | 198.9 | 134.3 | 131.3 | 195.6 | 183.3 | 155.7 | 191.9 | 120.2 | 105.2 |
| 207164_s_at | 415.4 | 443.9 | 509.2 | 812.2 | 497.8 | 1014 | 675.3 | 693.1 | 553.1 | 541.7 | 789.4 | 587 | 645.2 |
| 207233_s_at | 122.7 | 81.1 | 115.4 | 99.16 | 97.44 | 89.53 | 76.38 | 115.5 | 215.2 | 81.16 | 109.8 | 99.67 | 88.27 |
| 207416_s_at | 268.8 | 314.5 | 248.2 | 198.7 | 222.8 | 257.8 | 320.8 | 236.1 | 172.5 | 196.1 | 271.2 | 191.5 | 264 |
| 207513_s_at | 256.7 | 298.2 | 298 | 204.2 | 237.2 | 184 | 243 | 234.2 | 202.6 | 222.6 | 202 | 192.4 | 242.1 |
| 207543_s_at | 308.4 | 361.8 | 282 | 259.5 | 325.4 | 491.7 | 301.5 | 354.8 | 366.4 | 478.1 | 496.2 | 311.7 | 327.4 |
| 207564_x_at | 3978 | 3862 | 3301 | 2516 | 2771 | 2192 | 3073 | 2992 | 2426 | 3897 | 4038 | 2387 | 3993 |
| 207971_s_at | 63.03 | 80.3 | 71.8 | 62.73 | 64.9 | 43.18 | 81.98 | 63.86 | 55 | 72.7 | 72.66 | 55.58 | 76.35 |
| 208104_s_at | 386.1 | 431.9 | 545.5 | 582.5 | 603 | 615.7 | 506.5 | 374.3 | 609.3 | 454 | 488.2 | 461.1 | 407.3 |
| 208121_s_at | 95.58 | 202.5 | 86.36 | 108.8 | 127.5 | 63.31 | 130.8 | 125.7 | 166 | 147.8 | 115.5 | 147 | 107 |
| 208161_s_at | 56.91 | 109.4 | 41.75 | 43.26 | 58.89 | 48.41 | 37.12 | 32.09 | 53.61 | 62.06 | 79.93 | 49.5 | 31.32 |
| 208269_s_at | 135.3 | 133.5 | 97.64 | 102.9 | 101.5 | 102.1 | 81.21 | 105.4 | 105.7 | 97.94 | 90.27 | 99.97 | 132.1 |
| 208309_s_at | 421.6 | 336 | 275.1 | 219.6 | 312.2 | 184.5 | 360.5 | 376 | 194 | 297.8 | 312.6 | 209 | 378.6 |
| 208527_x_at | 282.5 | 320.5 | 317.5 | 379.5 | 482.1 | 456.3 | 478.3 | 490.6 | 426.1 | 290.1 | 334.1 | 287.1 | 324 |
| 208579_x_at | 507.3 | 471.7 | 431.1 | 653.1 | 748.6 | 768.9 | 895.3 | 775.3 | 697.7 | 469.2 | 550.5 | 541.9 | 521.8 |
| 208635_x_at | 18356 | 15868 | 14836 | 10342 | 12286 | 10988 | 15145 | 15238 | 9989 | 15946 | 14653 | 13010 | 16314 |
| 208659_at | 5474 | 6695 | 6305 | 7288 | 9837 | 7111 | 6778 | 7027 | 10926 | 7337 | 7414 | 6902 | 6707 |
| 208680_at | 823.5 | 694.8 | 653.2 | 603 | 885.1 | 559.3 | 767.1 | 787.5 | 926.6 | 919.5 | 768.7 | 626.4 | 741 |
| 208749_x_at | 1616 | 1699 | 2071 | 2657 | 2550 | 2198 | 2285 | 2003 | 2684 | 2801 | 2682 | 2477 | 1721 |
| 208771_s_at | 4877 | 5857 | 6572 | 4714 | 5059 | 10036 | 5309 | 4856 | 7707 | 4644 | 3693 | 4334 | 5032 |
| 208780_x_at | 2225 | 2290 | 2660 | 2032 | 2879 | 2820 | 2182 | 2691 | 2777 | 2846 | 2909 | 2757 | 2220 |
| 208798_x_at | 2026 | 1854 | 1360 | 1130 | 920.2 | 478 | 1078 | 1553 | 404.3 | 1074 | 1307 | 545.3 | 1273 |
| 208805_at | 2085 | 2298 | 2065 | 1762 | 2263 | 1452 | 1932 | 2152 | 2442 | 2351 | 1816 | 1797 | 1985 |
| 208868_s_at | 625.8 | 600.9 | 902.3 | 820.1 | 770.7 | 1187 | 796.1 | 844.8 | 883 | 487.8 | 772.7 | 939.4 | 598.6 |
| 208903_at | 66.63 | 69.81 | 84.07 | 43.22 | 53.59 | 38.64 | 54.06 | 70.98 | 44.09 | 42.74 | 53.98 | 35.4 | 31.22 |
| 208921_s_at | 1365 | 1177 | 1259 | 1149 | 1220 | 1161 | 1216 | 1062 | 1046 | 1225 | 1555 | 1235 | 1105 |
| 208923_at | 510.1 | 626.7 | 599.2 | 414.8 | 619.1 | 538.3 | 457.5 | 760 | 1079 | 656.3 | 525.7 | 581.5 | 533.1 |
| 208946_s_at | 1460 | 1364 | 1412 | 1524 | 1106 | 1396 | 1536 | 1455 | 1186 | 1365 | 1407 | 1577 | 1155 |
| 208962_s_at | 103.7 | 88.97 | 91.39 | 41.95 | 76.36 | 54.05 | 47.27 | 47.94 | 75.58 | 53.81 | 99.22 | 100.3 | 72.31 |
| 209040_s_at | 1477 | 1996 | 1491 | 2340 | 1805 | 2057 | 1972 | 2015 | 1564 | 2027 | 1935 | 1863 | 1742 |
| 209067_s_at | 4002 | 2920 | 3046 | 1731 | 1774 | 1985 | 3472 | 2555 | 1399 | 2793 | 2706 | 2111 | 3325 |
| 209072_at | 43.02 | 34.22 | 80.81 | 85.72 | 94.65 | 191.3 | 56.11 | 54.39 | 138.2 | 33.28 | 95.62 | 65.48 | 39.79 |
| 209099_x_at | 83.72 | 92.04 | 95.15 | 107.4 | 219.7 | 122 | 89.4 | 85.89 | 245.2 | 110.9 | 149 | 145.5 | 111 |
| 209124_at | 4054 | 4999 | 4664 | 5718 | 5615 | 6129 | 6593 | 4652 | 6500 | 5909 | 5880 | 5631 | 4982 |
| 209180_at | 353.4 | 410.6 | 319 | 253.2 | 252.3 | 254.5 | 346.7 | 298.6 | 185.6 | 324.7 | 304 | 278.8 | 349.8 |
| 209191_at | 170.2 | 238.2 | 203.7 | 206.8 | 174.7 | 112.9 | 104.8 | 177.7 | 170.2 | 374.3 | 224.6 | 141.7 | 287.9 |
| 209212_s_at | 23.81 | 24.89 | 29.9 | 36.7 | 38.76 | 52.21 | 30.03 | 29.46 | 33.45 | 30.12 | 48.17 | 30.44 | 30.47 |
| 209218_at | 225.7 | 151.9 | 110.6 | 83.56 | 191.2 | 119.2 | 124.2 | 114.7 | 112.4 | 207.8 | 265 | 120.6 | 176.8 |
| 209236_at | 182.5 | 218.4 | 193.8 | 114.3 | 205.8 | 159 | 190.4 | 216.9 | 217.8 | 164.5 | 186.1 | 162.1 | 176.9 |
| 209251_x_at | 4574 | 4909 | 4693 | 5132 | 6323 | 5528 | 5315 | 5419 | 6820 | 6395 | 6009 | 5598 | 4509 |
| 209259_s_at | 654.7 | 634.6 | 609.2 | 491.2 | 479.3 | 551.6 | 515.3 | 571.3 | 327.9 | 466.3 | 599.1 | 522.1 | 488.7 |
| 209269_s_at | 428.5 | 552.5 | 553.9 | 649.6 | 501.2 | 927 | 525.6 | 573.2 | 632 | 621.9 | 563.6 | 567 | 635.7 |
| 209330_s_at | 2993 | 2715 | 2265 | 1610 | 1230 | 1966 | 2285 | 1965 | 927.1 | 2583 | 2117 | 2060 | 2897 |
| 209339_at | 369 | 469.4 | 353.6 | 427.7 | 452 | 550 | 427 | 400.8 | 483.2 | 415.8 | 433.7 | 421.5 | 345.5 |
| 209430_at | 1038 | 928.8 | 855 | 657.1 | 751.7 | 635 | 747.3 | 826.6 | 614 | 907 | 773.6 | 722.8 | 887.9 |
| 209675_s_at | 968.9 | 900.7 | 1059 | 1021 | 704.7 | 1123 | 1232 | 890.7 | 716.2 | 1011 | 860.7 | 968.1 | 1330 |
| 209684_at | 270.1 | 416.6 | 496.1 | 317.1 | 410.3 | 334.2 | 325.2 | 481.8 | 615.5 | 344 | 442.6 | 377.4 | 444.3 |
| 209806_at | 1671 | 1704 | 1510 | 2294 | 2752 | 2341 | 2770 | 2603 | 2174 | 1668 | 1941 | 1762 | 1674 |
| 209840_s_at | 186.2 | 11.48 | 12.76 | 59.5 | 41.05 | 8.581 | 10.81 | 108.9 | 4.209 | 231.5 | 193.7 | 8.387 | 34.73 |
| 209870_s_at | 302.2 | 209.7 | 186.6 | 162.5 | 153.3 | 109.8 | 176.3 | 124.1 | 91.29 | 339.7 | 211.5 | 164.6 | 133.6 |
| 209892_at | 83.2 | 92.52 | 104.9 | 85.18 | 107.9 | 78.65 | 95.57 | 115.9 | 106.8 | 114.9 | 104.9 | 99.3 | 83.43 |
| 209906_at | 755.2 | 406.2 | 590.8 | 1170 | 724.7 | 588.5 | 793.9 | 316.4 | 1750 | 682.1 | 853.2 | 410.9 | 713.4 |
| 210022_at | 145.5 | 182.6 | 178.9 | 158.7 | 171.8 | 183.2 | 170.1 | 176.3 | 190 | 165.3 | 176 | 181.2 | 255.2 |
| 210061_at | 116.3 | 97.25 | 111.4 | 111.6 | 73.11 | 60.7 | 113.8 | 160.6 | 77.91 | 122 | 103.4 | 129.4 | 134.2 |
| 210145_at | 50.75 | 72.04 | 85.96 | 68.91 | 97.77 | 74.79 | 36.86 | 73.82 | 202.2 | 33.36 | 76.45 | 68.2 | 69.32 |
| 210156_s_at | 1037 | 1001 | 1055 | 918.4 | 1172 | 1138 | 1261 | 1087 | 1291 | 1078 | 1176 | 1085 | 1219 |
| 210166_at | 409.8 | 362.4 | 396.6 | 503.9 | 852.2 | 685.9 | 804.3 | 451.2 | 874 | 724.4 | 850.8 | 504.3 | 289.5 |
| 210434_x_at | 2477 | 2507 | 2215 | 2315 | 3019 | 2470 | 2711 | 2700 | 3052 | 3051 | 2488 | 2324 | 2285 |
| 210644_s_at | 494.5 | 535.6 | 397 | 507.6 | 505.9 | 348.9 | 428.7 | 451.6 | 593.8 | 516.2 | 479.9 | 576.8 | 481.3 |
| 210648_x_at | 3711 | 3569 | 3312 | 3509 | 4493 | 3347 | 3412 | 3858 | 4583 | 4354 | 3520 | 4122 | 3609 |
| 210875_s_at | 234.8 | 176.8 | 193.2 | 190.4 | 204.5 | 263.1 | 184.4 | 219.7 | 196.8 | 145.4 | 238.9 | 127.1 | 176.1 |
| 211047_x_at | 1121 | 1347 | 1163 | 943.5 | 1172 | 997.9 | 1070 | 1217 | 1402 | 1342 | 1157 | 1388 | 1291 |
| 211058_x_at | 4299 | 5037 | 4430 | 4874 | 6627 | 5083 | 5564 | 5141 | 6188 | 6534 | 5813 | 5336 | 4704 |
| 211185_s_at | 8535 | 8172 | 7762 | 6821 | 7267 | 8577 | 8027 | 8303 | 7343 | 7549 | 8548 | 7792 | 6780 |
| 211272_s_at | 1175 | 463.3 | 448.4 | 394 | 428.7 | 255.9 | 562.7 | 543.1 | 227.7 | 762 | 563.5 | 402.9 | 547.9 |
| 211323_s_at | 198.7 | 147.1 | 136.5 | 128.5 | 160.2 | 139.3 | 147.3 | 158 | 93.28 | 152.6 | 132.5 | 107.2 | 199.9 |
| 211383_s_at | 552.9 | 545.1 | 505.7 | 425.1 | 422.6 | 444.2 | 533.9 | 471.1 | 489.3 | 571.3 | 532.2 | 487.7 | 425.9 |
| 211429_s_at | 13724 | 14725 | 14685 | 18954 | 20769 | 21897 | 17397 | 14815 | 23036 | 18148 | 17271 | 16598 | 15012 |
| 211506_s_at | 90.62 | 254.7 | 614.6 | 432.3 | 698.4 | 2014 | 510.4 | 1612 | 711.8 | 44.08 | 352.7 | 238.1 | 257.4 |
| 211546_x_at | 191.4 | 180 | 190.3 | 210.4 | 171.9 | 234.3 | 180.9 | 235.3 | 194.6 | 181 | 188.9 | 197.5 | 172.9 |
| 211684_s_at | 727.1 | 689.3 | 607.3 | 503.4 | 648.1 | 435 | 501.7 | 689.7 | 706.5 | 638.5 | 624.2 | 616.7 | 570.9 |
| 211729_x_at | 373.2 | 541.5 | 372.3 | 407.6 | 350.5 | 461.2 | 473.7 | 469.8 | 536.7 | 465.1 | 371.4 | 524.3 | 515.6 |
| 211856_x_at | 123.2 | 56.94 | 59.95 | 47.61 | 54.59 | 25.83 | 79.17 | 68.72 | 28.68 | 67.78 | 57.46 | 27.71 | 67.98 |
| 211946_s_at | 5377 | 5418 | 5212 | 4260 | 4146 | 4093 | 4562 | 4862 | 3910 | 4543 | 5067 | 4800 | 4674 |
| 211965_at | 931.9 | 1857 | 1819 | 4821 | 3886 | 5127 | 4828 | 3462 | 4104 | 2182 | 4273 | 3211 | 2368 |
| 212030_at | 1070 | 1199 | 1120 | 773.9 | 1084 | 995.7 | 1038 | 1200 | 910 | 1056 | 1204 | 931.7 | 1045 |
| 212042_x_at | 26300 | 25217 | 25069 | 16589 | 20213 | 17805 | 23411 | 24784 | 17418 | 23998 | 23974 | 20122 | 23591 |
| 212132_at | 2764 | 2679 | 2687 | 2475 | 2062 | 2808 | 2841 | 2918 | 1735 | 2517 | 2646 | 2681 | 2656 |
| 212213_x_at | 252.2 | 228.6 | 183.8 | 168.4 | 209.7 | 156.4 | 168.3 | 219.7 | 174.4 | 205.2 | 218.1 | 217.9 | 220.4 |
| 212299_at | 404.1 | 406.3 | 289.4 | 311.2 | 311.5 | 284.1 | 345.2 | 349.3 | 324.1 | 393 | 375.9 | 339 | 241.1 |
| 212331_at | 4234 | 3059 | 3077 | 2779 | 3294 | 2610 | 2346 | 3662 | 3051 | 2982 | 2838 | 2944 | 2184 |
| 212334_at | 2069 | 2289 | 2324 | 2212 | 1963 | 2405 | 1840 | 2548 | 2275 | 2440 | 2261 | 2758 | 1609 |
| 212406_s_at | 1621 | 1483 | 1346 | 872 | 1099 | 1021 | 1164 | 1258 | 1032 | 1132 | 1260 | 1053 | 1065 |
| 212455_at | 3126 | 3387 | 3037 | 2656 | 3200 | 3183 | 2999 | 3318 | 2633 | 3021 | 3310 | 2807 | 3149 |
| 212543_at | 1454 | 1481 | 1194 | 1205 | 1221 | 1317 | 1227 | 1394 | 1466 | 1454 | 1389 | 1103 | 886.5 |
| 212658_at | 76.38 | 91.88 | 98.91 | 122.1 | 97.62 | 146.4 | 82.77 | 104 | 170.7 | 82.32 | 87.77 | 121.6 | 125.4 |
| 212663_at | 1083 | 1309 | 1295 | 1198 | 1464 | 1289 | 1045 | 1392 | 1750 | 1313 | 1192 | 1353 | 1481 |
| 212769_at | 315.4 | 297 | 420.2 | 559.7 | 440.8 | 608.7 | 552 | 418.4 | 355.2 | 416.4 | 402.6 | 416.8 | 310.9 |
| 212820_at | 1536 | 2271 | 2514 | 2752 | 3108 | 2227 | 2139 | 2755 | 3584 | 1522 | 2779 | 3180 | 2084 |
| 212932_at | 120.3 | 151.3 | 138.8 | 134.5 | 119.7 | 97.91 | 118 | 153.8 | 105.5 | 131.7 | 148.4 | 126.8 | 115.9 |
| 212989_at | 365.6 | 426.9 | 468.6 | 419.1 | 597.7 | 342.7 | 363.5 | 392.4 | 656.3 | 267.4 | 347.2 | 375.7 | 322.7 |
| 212997_s_at | 576.3 | 592.9 | 615.8 | 565 | 586.6 | 571 | 633.4 | 612.4 | 527.6 | 549.7 | 533.3 | 533.6 | 627.9 |
| 213021_at | 247.8 | 268.2 | 225.7 | 193.7 | 206.3 | 195.9 | 258.8 | 239.2 | 174.5 | 246.6 | 237.5 | 183.2 | 228.7 |
| 213152_s_at | 752.1 | 534.6 | 515 | 324.3 | 447.8 | 258.4 | 517.3 | 467.8 | 305.8 | 518.3 | 474.2 | 311.4 | 484.6 |
| 213205_s_at | 134.4 | 178.3 | 132.4 | 85.5 | 135.2 | 97.12 | 165.5 | 108.2 | 91.56 | 173.4 | 109.2 | 105 | 179 |
| 213218_at | 91.52 | 107.4 | 101 | 55.35 | 101.6 | 83.89 | 64.46 | 70.1 | 80.79 | 62.11 | 74.96 | 81.05 | 88.63 |
| 213266_at | 89.84 | 90.32 | 77.85 | 60.85 | 90.75 | 101.2 | 85.86 | 64.03 | 66.77 | 98.45 | 76.68 | 69.95 | 90.2 |
| 213302_at | 53.75 | 36.25 | 26.72 | 24.72 | 22.51 | 18.63 | 36.41 | 33.81 | 11.64 | 32.77 | 27.57 | 25.77 | 41.29 |
| 213335_s_at | 27.56 | 33.52 | 36.94 | 31.55 | 39.74 | 32.94 | 33.54 | 30.68 | 62.12 | 24.81 | 32.67 | 33.8 | 31.63 |
| 213397_x_at | 103.5 | 56.94 | 135.7 | 86.23 | 125.5 | 130.9 | 47.97 | 133.9 | 133.4 | 50.84 | 67.73 | 92.37 | 115.8 |
| 213459_at | 144.8 | 94.26 | 93.3 | 69.73 | 104.2 | 68.91 | 83.02 | 97.89 | 56.95 | 60.5 | 112.2 | 67.96 | 87.87 |
| 213494_s_at | 34.78 | 37.24 | 39.83 | 36.27 | 67.52 | 56.18 | 43.49 | 89 | 72.3 | 41.75 | 72.5 | 60.73 | 58.24 |
| 213540_at | 124.7 | 62.33 | 58.1 | 48.27 | 59.89 | 36.15 | 57.79 | 56.39 | 40.6 | 63.71 | 65.5 | 45.47 | 56.98 |
| 213693_s_at | 41.69 | 35.32 | 35.88 | 36.54 | 46.27 | 39.77 | 40.55 | 36.91 | 38.18 | 36.46 | 41.9 | 37.37 | 36.8 |
| 213827_at | 57.44 | 60.75 | 93.82 | 64.01 | 46.39 | 56.17 | 80.7 | 52.54 | 43.34 | 61.58 | 57.6 | 77.4 | 63.16 |
| 213877_x_at | 80.94 | 89.76 | 108.2 | 96.85 | 94.63 | 87.01 | 91.32 | 100.5 | 116.2 | 83.84 | 76.75 | 89.6 | 91.25 |
| 214045_at | 98.64 | 54.9 | 77.57 | 48.81 | 41.12 | 34.11 | 36.78 | 60.05 | 28.21 | 47.4 | 57.5 | 67.35 | 68.49 |
| 214057_at | 175.2 | 208.2 | 264.6 | 284.8 | 405.2 | 297.7 | 271.6 | 331.6 | 393.4 | 202.4 | 247.4 | 264.9 | 307.4 |
| 214330_at | 42.03 | 49.96 | 36.26 | 28.5 | 25.86 | 39.4 | 40.28 | 36.54 | 31.2 | 39.36 | 51.92 | 40.98 | 42.8 |
| 214364_at | 68.66 | 97.04 | 87.49 | 47.13 | 104.8 | 47.18 | 76.9 | 89.09 | 49.63 | 44.57 | 101 | 66.29 | 143.5 |
| 214430_at | 262.9 | 383.3 | 412.6 | 414 | 516.1 | 489.4 | 472.4 | 471.5 | 546.1 | 517.4 | 533.9 | 454.2 | 412.9 |
| 214511_x_at | 785.8 | 920.6 | 658.8 | 2803 | 2185 | 1440 | 2410 | 995.9 | 2475 | 1447 | 2859 | 1935 | 563 |
| 214629_x_at | 5832 | 5697 | 6350 | 6655 | 6849 | 8339 | 5948 | 6618 | 6271 | 6614 | 7656 | 6676 | 5965 |
| 214683_s_at | 3691 | 3453 | 4067 | 3087 | 3483 | 4081 | 3341 | 4060 | 3545 | 3234 | 3352 | 3007 | 2583 |
| 214820_at | 115.9 | 91.81 | 93.32 | 47.37 | 123.3 | 74.74 | 101.5 | 113.4 | 63.95 | 88.93 | 95.15 | 75.81 | 96.49 |
| 214853_s_at | 548.5 | 443.1 | 415.8 | 411 | 401.7 | 452 | 381.8 | 486.3 | 464.3 | 410.8 | 487.4 | 437.8 | 432.6 |
| 214931_s_at | 229.2 | 304.1 | 338.5 | 308.5 | 451 | 459.5 | 490.5 | 446.9 | 428.6 | 298.9 | 420.7 | 319.9 | 420.8 |
| 214953_s_at | 188.2 | 149 | 189.8 | 130.7 | 207.1 | 182.9 | 198.7 | 220.7 | 251.2 | 253.3 | 223.4 | 220.2 | 159.7 |
| 215009_s_at | 657.7 | 610.6 | 588.2 | 361.6 | 434 | 366.9 | 403.1 | 538.6 | 395.3 | 485.5 | 476.9 | 485.5 | 550.1 |
| 215049_x_at | 320.7 | 461.1 | 506.7 | 277.6 | 378.2 | 530.9 | 271.6 | 600.2 | 1031 | 459.2 | 337 | 635.6 | 529.1 |
| 215273_s_at | 415.8 | 540.9 | 566.8 | 522.5 | 682.5 | 482.5 | 649.1 | 562.5 | 694.2 | 557.3 | 608 | 606.2 | 575.2 |
| 215293_s_at | 72.81 | 86.3 | 78.99 | 47.11 | 56.07 | 57.33 | 78.88 | 54.15 | 61.52 | 60.84 | 62.07 | 59.68 | 84.9 |
| 215567_at | 139 | 95.25 | 140 | 107.9 | 121.2 | 73.92 | 78.55 | 127.7 | 103.1 | 78.6 | 144.5 | 120.9 | 116.4 |
| 215997_s_at | 313.1 | 299.5 | 307.2 | 324.5 | 370.3 | 511 | 418.6 | 436.2 | 409 | 282 | 382.1 | 242 | 424.9 |
| 216484_x_at | 377.9 | 388.3 | 344.5 | 413.8 | 358.3 | 488.3 | 352.5 | 384.6 | 411.6 | 424.5 | 452.6 | 464.6 | 395.6 |
| 216950_s_at | 332.3 | 492.7 | 349.9 | 1375 | 1082 | 766 | 1322 | 463.7 | 1407 | 581.8 | 1669 | 1021 | 333.3 |
| 217383_at | 21.28 | 26.55 | 20.83 | 29.36 | 39.79 | 34.73 | 27.01 | 47.59 | 39.98 | 30.62 | 39.43 | 37.73 | 31.69 |
| 217403_s_at | 119.5 | 98.7 | 94.35 | 73.52 | 84.35 | 75.9 | 105.6 | 91.84 | 49.62 | 107.3 | 79.42 | 73.81 | 82.84 |
| 217466_x_at | 3078 | 2914 | 2807 | 1690 | 2621 | 1746 | 2849 | 2976 | 2541 | 3197 | 2748 | 2078 | 4156 |
| 217769_s_at | 1238 | 1509 | 1188 | 1286 | 1593 | 1286 | 1382 | 1436 | 1636 | 1634 | 1354 | 1358 | 1313 |
| 217778_at | 164.8 | 192.3 | 216.4 | 245.4 | 215.2 | 254.8 | 229.4 | 216.8 | 269.6 | 214.8 | 253.9 | 215.6 | 218.8 |
| 217824_at | 340.3 | 301.7 | 275.4 | 401.6 | 432.9 | 480.8 | 265.4 | 313.3 | 437.5 | 431.7 | 538.1 | 285.4 | 326.1 |
| 217987_at | 501.4 | 607.4 | 573.6 | 494 | 674.5 | 225 | 519.2 | 882 | 574.5 | 350.1 | 438.3 | 695.9 | 273.2 |
| 217995_at | 1124 | 1688 | 1434 | 1942 | 2348 | 1876 | 1690 | 1707 | 2673 | 1473 | 1633 | 1614 | 1096 |
| 218012_at | 298.3 | 240.6 | 228.1 | 192.6 | 146.2 | 156.9 | 256.6 | 162.4 | 86.16 | 168 | 208.1 | 206.8 | 212.1 |
| 218040_at | 418.7 | 412.8 | 396.6 | 309 | 278.5 | 352.2 | 350.7 | 387.8 | 230 | 331.7 | 334 | 326 | 266.7 |
| 218065_s_at | 1158 | 969.3 | 1013 | 921.2 | 1002 | 946.1 | 1095 | 1086 | 815.4 | 980.6 | 1112 | 996.9 | 937 |
| 218091_at | 411.5 | 458.1 | 463.8 | 408.3 | 534.7 | 480.1 | 394.2 | 634.4 | 851.3 | 481.9 | 495.6 | 450.8 | 483.7 |
| 218125_s_at | 69.54 | 68.82 | 59.22 | 57.36 | 58.43 | 46.59 | 60.74 | 59.7 | 44.43 | 38.98 | 60.99 | 49.46 | 57.57 |
| 218127_at | 260.8 | 285.8 | 252.7 | 170.4 | 197.9 | 203.9 | 270 | 212.9 | 138.8 | 256.6 | 223 | 203.7 | 267.4 |
| 218143_s_at | 497.8 | 554.2 | 593.2 | 588.1 | 395.7 | 616.1 | 621.9 | 624.4 | 478.3 | 676.4 | 608.2 | 698.8 | 698.9 |
| 218206_x_at | 347.2 | 426.9 | 395 | 318.9 | 548.5 | 376 | 373.8 | 370.6 | 593.2 | 374.3 | 364.4 | 365.7 | 350.3 |
| 218289_s_at | 120.6 | 113.9 | 81.79 | 75.23 | 83.62 | 56.03 | 97.21 | 90.86 | 63.65 | 114.9 | 106 | 77.33 | 88.55 |
| 218325_s_at | 417 | 449.3 | 294.5 | 357.7 | 311.9 | 288.4 | 311.4 | 357.7 | 279.3 | 371.8 | 376 | 359.3 | 361.2 |
| 218351_at | 956.4 | 1200 | 1036 | 834.2 | 1271 | 850.3 | 900.6 | 1350 | 1473 | 815.3 | 1108 | 1118 | 1175 |
| 218499_at | 2447 | 2921 | 2656 | 1844 | 1963 | 1686 | 2291 | 2295 | 1786 | 2022 | 2109 | 1998 | 2026 |
| 218627_at | 217.3 | 355 | 372.5 | 437 | 457 | 541.3 | 389.3 | 400.4 | 388.1 | 312.7 | 345.4 | 397 | 288.8 |
| 218718_at | 78.76 | 158.4 | 159.3 | 120.4 | 164 | 105.8 | 36.83 | 168.9 | 250.6 | 117.3 | 158.3 | 172.3 | 40.47 |
| 218732_at | 241.5 | 231.2 | 248.3 | 203.8 | 313.2 | 279.8 | 182.6 | 284.8 | 348.2 | 237.3 | 232.6 | 187.1 | 240.9 |
| 218845_at | 818 | 1124 | 877.3 | 813.5 | 964.7 | 1116 | 1042 | 912.1 | 929.5 | 1296 | 1252 | 1019 | 934.8 |
| 218962_s_at | 601.5 | 570.5 | 447 | 376.4 | 412.2 | 364.2 | 361.1 | 479.6 | 359.7 | 388.3 | 473.7 | 378.5 | 416.3 |
| 219130_at | 524.9 | 347 | 305.2 | 244.2 | 284.6 | 142.4 | 292.8 | 289 | 143.5 | 239.6 | 262.3 | 200.4 | 242 |
| 219316_s_at | 92.3 | 72.17 | 80.33 | 63.39 | 77.66 | 108.8 | 117.5 | 93.83 | 128.3 | 89.6 | 108.4 | 113.7 | 97.33 |
| 219343_at | 153.5 | 181.9 | 137.5 | 136.5 | 171.6 | 179 | 180.4 | 198.7 | 108.6 | 168 | 212.4 | 131.9 | 160.6 |
| 219358_s_at | 172.4 | 281.9 | 194.4 | 167.2 | 195.8 | 199.9 | 189 | 147.6 | 251.2 | 216.8 | 191.4 | 233.8 | 238.5 |
| 219418_at | 107.7 | 102.8 | 76.59 | 76.42 | 117.1 | 104.4 | 89.39 | 89.33 | 83.29 | 92.73 | 89.35 | 103.5 | 93.58 |
| 219507_at | 115.1 | 97.04 | 82.74 | 98.62 | 100.2 | 103.4 | 74.57 | 136.8 | 82.84 | 95.74 | 151.2 | 62.84 | 89.9 |
| 219765_at | 90.48 | 56.82 | 53.93 | 33.58 | 51.37 | 39.85 | 47.38 | 62.9 | 24.12 | 39.3 | 64.55 | 53.77 | 49.93 |
| 219787_s_at | 53.14 | 56.57 | 76.8 | 92.95 | 111.6 | 71.42 | 53.4 | 81.85 | 59.84 | 79.8 | 78 | 69.8 | 52.77 |
| 219822_at | 205.7 | 177.7 | 159.7 | 124.1 | 134.9 | 142.1 | 122 | 214.8 | 114.4 | 142.2 | 150.4 | 128.8 | 143.5 |
| 219826_at | 66.29 | 48.42 | 43.52 | 30.93 | 33.07 | 21.27 | 44.66 | 48.24 | 22.07 | 33.43 | 44.17 | 33.72 | 32.28 |
| 219952_s_at | 110.3 | 167.3 | 231.3 | 202.5 | 197.5 | 216.8 | 163.6 | 175 | 248.3 | 205.5 | 233.7 | 240 | 169.5 |
| 220044_x_at | 5977 | 5531 | 4686 | 3830 | 3905 | 3555 | 4227 | 4402 | 3190 | 4858 | 4870 | 3486 | 5066 |
| 220146_at | 122.8 | 208.5 | 138.9 | 133.2 | 209.4 | 172.4 | 133.5 | 161.1 | 186 | 156.7 | 121 | 151.5 | 163.7 |
| 220160_s_at | 53.54 | 53.69 | 54.48 | 102.5 | 100.4 | 73.17 | 63.76 | 54.64 | 87.01 | 62.58 | 68.82 | 64.27 | 63.4 |
| 220386_s_at | 640 | 551.7 | 422.3 | 399 | 534.2 | 356.9 | 601.2 | 530.7 | 413.6 | 598 | 702.9 | 298.3 | 555.9 |
| 220578_at | 65.41 | 123.3 | 67.11 | 120.8 | 92.62 | 109.9 | 92.17 | 55.06 | 69.03 | 106.8 | 78.69 | 111.2 | 85.87 |
| 220605_s_at | 143.7 | 173.8 | 170.6 | 156 | 231.4 | 156.9 | 157.8 | 172 | 240.2 | 164.8 | 169.9 | 157.5 | 150.4 |
| 220610_s_at | 96.7 | 106.4 | 116 | 168.5 | 128.7 | 233.4 | 146 | 109.7 | 111.8 | 127.2 | 161.7 | 153.2 | 145 |
| 220690_s_at | 90.41 | 115 | 126 | 118.7 | 163.5 | 145 | 123.4 | 118.8 | 184.4 | 115.9 | 118.6 | 120.9 | 130.9 |
| 220750_s_at | 100.8 | 90.23 | 91.74 | 80.16 | 110 | 68.17 | 80.57 | 90.82 | 136 | 105.4 | 91.09 | 94.65 | 88.06 |
| 220865_s_at | 95.79 | 61.34 | 102.5 | 69.98 | 113.8 | 86.38 | 97.1 | 105.7 | 152.8 | 83.31 | 88.32 | 90.86 | 113 |
| 220974_x_at | 216.4 | 219.5 | 255.4 | 173 | 198.8 | 193.1 | 186.5 | 208 | 252.1 | 177.3 | 275.2 | 208.3 | 172.2 |
| 221011_s_at | 1629 | 1294 | 692.4 | 594.1 | 683.2 | 271.5 | 920.8 | 803.8 | 220 | 963.4 | 826.2 | 453.8 | 713.8 |
| 221206_at | 214.9 | 141.2 | 203.4 | 144.7 | 159.6 | 186.4 | 132.1 | 146.4 | 154.8 | 131.6 | 164.7 | 187 | 166.2 |
| 221264_s_at | 462.7 | 577.2 | 474 | 351.2 | 450 | 367.2 | 332.5 | 572 | 350.7 | 444.4 | 594.9 | 428 | 392 |
| 221428_s_at | 958.8 | 988.5 | 973.3 | 681.8 | 779.4 | 766.5 | 1065 | 946.7 | 728.7 | 714.4 | 881.3 | 598.7 | 853.3 |
| 221449_s_at | 290 | 343.8 | 315.1 | 292.6 | 412.3 | 335.9 | 290.1 | 411.6 | 465.6 | 413.6 | 384.1 | 300.2 | 296.8 |
| 221580_s_at | 1386 | 1146 | 1149 | 851 | 985.8 | 1029 | 833.1 | 1151 | 813 | 1107 | 1023 | 887.5 | 1090 |
| 221601_s_at | 3995 | 2466 | 1540 | 1477 | 1433 | 991.2 | 1991 | 1687 | 645.4 | 2667 | 1936 | 956.4 | 3025 |
| 221647_s_at | 470.1 | 472.9 | 446.2 | 416.8 | 543.9 | 458.7 | 471.9 | 444.8 | 525.4 | 609.1 | 472.7 | 473.8 | 405.9 |
| 221731_x_at | 7176 | 6442 | 8848 | 5716 | 6994 | 6939 | 6555 | 7924 | 11038 | 6749 | 5472 | 8215 | 8233 |
| 221757_at | 768.3 | 459.1 | 356.9 | 273.6 | 397.1 | 246.1 | 439.5 | 373.4 | 247.3 | 710.4 | 442.8 | 332.8 | 499.2 |
| 221841_s_at | 1059 | 1165 | 1263 | 1522 | 1573 | 1153 | 1218 | 1374 | 2044 | 1356 | 1750 | 1639 | 2176 |
| 221868_at | 53.31 | 45.41 | 35.55 | 31.5 | 30.37 | 17.45 | 35.77 | 31.42 | 23.29 | 31.45 | 29.78 | 24.06 | 37.75 |
| 221960_s_at | 43.13 | 44.62 | 35.33 | 56.3 | 80.56 | 128.6 | 61.21 | 113.1 | 124 | 66.88 | 92.22 | 73.13 | 62.25 |
| 222217_s_at | 211 | 389.7 | 360.7 | 416.4 | 366.5 | 274 | 261 | 285.9 | 463.2 | 305.9 | 276.5 | 471.3 | 430.5 |
| 222231_s_at | 242 | 279 | 268.7 | 248.5 | 307 | 313.5 | 299.1 | 355 | 388.9 | 348.4 | 260.2 | 275.1 | 306 |
| 222574_s_at | 476.7 | 450.6 | 473 | 404.2 | 541.9 | 585.9 | 535.4 | 570.4 | 487.9 | 464 | 513.6 | 419.9 | 517.3 |
| 222605_at | 722.6 | 827.7 | 802.9 | 621.7 | 851.6 | 653 | 663.5 | 658.8 | 655.3 | 714.9 | 773.9 | 637.1 | 623 |
| 222651_s_at | 271.5 | 280 | 397.7 | 237.1 | 252.6 | 389 | 212.5 | 353.3 | 317.9 | 317.8 | 310.9 | 317.6 | 358.3 |
| 222670_s_at | 529.2 | 888.8 | 628 | 697.4 | 800.2 | 592.1 | 720.4 | 643.4 | 823.5 | 970.8 | 782.9 | 842.5 | 1161 |
| 222688_at | 236.7 | 313.1 | 269.8 | 266 | 315 | 311.5 | 250.6 | 303 | 332.4 | 228.7 | 288.9 | 340 | 295.1 |
| 222700_at | 637.1 | 557.2 | 524.5 | 396.1 | 638.9 | 516.9 | 461.6 | 582 | 346.2 | 464.2 | 483.4 | 575.1 | 512.1 |
| 222753_s_at | 178.9 | 151.2 | 157.5 | 172.4 | 310.5 | 237.1 | 177.2 | 238 | 285.9 | 291.3 | 222.7 | 218.6 | 211.9 |
| 222757_s_at | 95.96 | 82.64 | 99.05 | 103.8 | 137.9 | 152.4 | 169.3 | 98.91 | 155.1 | 156.6 | 156.2 | 127.2 | 91.32 |
| 222774_s_at | 37.58 | 46.71 | 55.19 | 37.96 | 65.8 | 33.58 | 31.41 | 70.1 | 57.85 | 52.2 | 47.46 | 46.64 | 56.32 |
| 222884_at | 92.97 | 98.56 | 83.67 | 95.75 | 96.34 | 122.6 | 105.8 | 99.73 | 79.35 | 110.4 | 93.17 | 95.74 | 93.21 |
| 222980_at | 2321 | 2286 | 2414 | 2266 | 2430 | 2460 | 2733 | 2469 | 2732 | 2540 | 2688 | 2297 | 2046 |
| 222982_x_at | 4374 | 4186 | 4431 | 4016 | 4629 | 4448 | 3713 | 4982 | 5057 | 3860 | 3639 | 3282 | 3260 |
| 223023_at | 332.5 | 267.1 | 251.7 | 198.6 | 212.5 | 210.8 | 295.4 | 211.7 | 202.9 | 299 | 262.5 | 223.7 | 301.6 |
| 223064_at | 1170 | 1375 | 1291 | 1153 | 1689 | 1238 | 1426 | 1414 | 1983 | 1361 | 1276 | 1345 | 1406 |
| 223158_s_at | 80.05 | 101.2 | 116.2 | 121.9 | 184.9 | 156.1 | 118.7 | 163.8 | 156.1 | 109.2 | 171.3 | 125.9 | 139.2 |
| 223380_s_at | 285.5 | 310.2 | 382.7 | 342.4 | 486 | 577.5 | 342.4 | 425.7 | 506.1 | 190.8 | 368.2 | 337.2 | 315.5 |
| 223444_at | 835.4 | 683.1 | 804 | 665.2 | 788.2 | 903.7 | 624.5 | 939.4 | 844 | 614.6 | 830.5 | 778.2 | 810.5 |
| 223465_at | 411.5 | 383.3 | 406.5 | 537.7 | 751.5 | 516 | 422.1 | 614.6 | 632.3 | 439.1 | 624.8 | 476.5 | 405.4 |
| 223590_at | 424.6 | 485.8 | 424.4 | 395.4 | 386.7 | 440.2 | 319.5 | 442.6 | 301.1 | 327.2 | 478.8 | 380.9 | 389 |
| 223686_at | 270.6 | 206.8 | 178.3 | 250.8 | 302.9 | 310.4 | 203.5 | 250.1 | 224.6 | 254.9 | 313.1 | 269.1 | 259.4 |
| 223801_s_at | 30.59 | 29.94 | 28.85 | 31.88 | 33.97 | 38.09 | 34.7 | 31.01 | 34.21 | 30.07 | 36.59 | 33.43 | 31.22 |
| 223922_x_at | 1942 | 2148 | 2362 | 1961 | 2237 | 2129 | 2190 | 2261 | 3255 | 1937 | 1892 | 2525 | 2314 |
| 223982_s_at | 1025 | 1045 | 1134 | 943.9 | 1223 | 1133 | 924.2 | 1207 | 1191 | 925.1 | 1099 | 1052 | 1146 |
| 224046_s_at | 651.2 | 352.7 | 343.7 | 332.9 | 434.1 | 349.6 | 549.8 | 389.8 | 272.6 | 426.4 | 426.7 | 237.2 | 490.1 |
| 224374_s_at | 571.6 | 509.6 | 498 | 446.8 | 432.4 | 703.5 | 461.2 | 441.2 | 605.5 | 577.2 | 443.8 | 565.1 | 568 |
| 224387_at | 57.12 | 76.32 | 63.05 | 47.68 | 112.7 | 73.95 | 84.22 | 85.52 | 89.47 | 70.68 | 67.03 | 88.3 | 75.94 |
| 224439_x_at | 579.4 | 503.4 | 447.5 | 404.3 | 516.6 | 473.1 | 380.8 | 484.4 | 474.3 | 493.7 | 479.2 | 461.4 | 420.2 |
| 224518_s_at | 392.8 | 367.5 | 321.5 | 216.7 | 285.2 | 224.6 | 347.4 | 273.3 | 129.8 | 252.6 | 264.9 | 142.6 | 314.2 |
| 224582_s_at | 540.3 | 388.4 | 284.8 | 208.6 | 226.5 | 205.7 | 427.2 | 237.9 | 119.6 | 372.4 | 375.9 | 211.3 | 393.6 |
| 224591_at | 3180 | 3586 | 3404 | 2367 | 2565 | 2549 | 2578 | 3002 | 2153 | 2505 | 2830 | 2533 | 2956 |
| 224726_at | 229.9 | 186.7 | 224.6 | 203 | 236.4 | 197 | 131.9 | 265 | 263.8 | 165.7 | 271 | 156.9 | 179.4 |
| 224818_at | 545.4 | 681.7 | 475.9 | 739.5 | 712.8 | 776.9 | 492.6 | 645.7 | 931.9 | 730.1 | 740 | 889.6 | 567.5 |
| 224917_at | 2238 | 1944 | 2561 | 2228 | 2536 | 2618 | 2397 | 2652 | 2940 | 2793 | 2711 | 2506 | 2344 |
| 224918_x_at | 367 | 486.4 | 640.5 | 253.9 | 598.9 | 416.7 | 365.5 | 621 | 902 | 360.3 | 367.1 | 403.4 | 545.7 |
| 224928_at | 246.4 | 352.7 | 348.7 | 244.2 | 321.4 | 300.6 | 254.1 | 355.8 | 428.7 | 342.7 | 266.9 | 326.4 | 251.8 |
| 225059_at | 998.3 | 1442 | 1379 | 1355 | 1888 | 1705 | 1471 | 1244 | 2607 | 1480 | 1421 | 1481 | 1549 |
| 225064_at | 508.6 | 506.2 | 373.9 | 314.2 | 394.6 | 393.7 | 452.3 | 363.4 | 262.1 | 451.8 | 397.9 | 307.9 | 458 |
| 225107_at | 2910 | 3048 | 3018 | 2262 | 2035 | 2332 | 2172 | 2539 | 1704 | 2843 | 2914 | 2601 | 2450 |
| 225188_at | 56.71 | 101 | 67.74 | 114.1 | 70.53 | 42.72 | 66.23 | 85.91 | 111.7 | 90.15 | 96.28 | 55.55 | 73.17 |
| 225341_at | 67.41 | 89.39 | 52.59 | 44.54 | 52.21 | 63.13 | 56.5 | 54.01 | 56.84 | 45.86 | 49.67 | 29.21 | 34.81 |
| 225358_at | 113.2 | 98.04 | 89.95 | 86.48 | 95.79 | 61.34 | 101.3 | 98.76 | 47.99 | 107.2 | 100 | 83.51 | 93.95 |
| 225365_at | 2362 | 2566 | 2713 | 2250 | 2686 | 1998 | 1831 | 2259 | 3005 | 3670 | 2446 | 2763 | 3442 |
| 225388_at | 35.97 | 45.08 | 42.85 | 32 | 34.27 | 35.17 | 42.47 | 31.98 | 22.64 | 53.03 | 39.24 | 34.9 | 54.27 |
| 225456_at | 369.6 | 366.7 | 348.9 | 241.9 | 310.1 | 320.4 | 421.5 | 332.9 | 276.2 | 351.5 | 267.8 | 254 | 269.8 |
| 225763_at | 2667 | 2803 | 2801 | 2790 | 2398 | 2860 | 2425 | 2987 | 2397 | 3270 | 2346 | 2933 | 3726 |
| 225844_at | 237.5 | 233.1 | 208.8 | 165.5 | 287.5 | 204.8 | 196.6 | 229.8 | 354.3 | 217.3 | 244.1 | 218.4 | 233.5 |
| 225866_at | 137.1 | 96.3 | 85.67 | 89.53 | 101.9 | 69.42 | 112.1 | 106.6 | 73.87 | 77.01 | 105.4 | 97.81 | 97.96 |
| 225870_s_at | 584.9 | 633.5 | 739.8 | 811.1 | 961.3 | 799.9 | 660.9 | 827.5 | 1021 | 742.9 | 660.3 | 628.3 | 688.7 |
| 226000_at | 23.31 | 40.68 | 34.93 | 27.22 | 27.17 | 35.81 | 23.63 | 35.12 | 47.91 | 28.62 | 28.86 | 36.39 | 30.48 |
| 226030_at | 175.3 | 136.5 | 126.8 | 99.85 | 98.95 | 56.79 | 120.7 | 110.5 | 75.76 | 95.47 | 116.3 | 76.59 | 85.82 |
| 226042_at | 105.3 | 121.8 | 94.11 | 69.27 | 119.8 | 85.53 | 89.62 | 91.83 | 126.6 | 91.23 | 84.91 | 93.36 | 84.47 |
| 226059_at | 52.35 | 45.95 | 44 | 44.93 | 76.77 | 67.39 | 49.22 | 66.37 | 76.45 | 65.87 | 68.95 | 48.64 | 29.9 |
| 226115_at | 198 | 222.2 | 281.6 | 229.6 | 360.1 | 408.2 | 296.3 | 319.5 | 300.9 | 213.5 | 409.2 | 297.4 | 204.8 |
| 226127_at | 91.25 | 86.26 | 86.53 | 85.91 | 85.05 | 75.79 | 88.34 | 87.01 | 66.57 | 95.49 | 86.82 | 85.6 | 87.68 |
| 226218_at | 9177 | 6984 | 4523 | 2321 | 3968 | 1659 | 5640 | 5261 | 1960 | 4271 | 5744 | 2220 | 3102 |
| 226220_at | 72.86 | 58.7 | 89.95 | 109.5 | 117.8 | 95.23 | 57.7 | 151.8 | 226.6 | 79.16 | 99.71 | 165.5 | 106 |
| 226323_at | 497.5 | 595.5 | 567.2 | 461.9 | 538.2 | 484.9 | 571.3 | 539.1 | 389.9 | 517.8 | 557.4 | 534.7 | 451.8 |
| 226353_at | 898.8 | 942.6 | 1075 | 1266 | 1309 | 1303 | 1219 | 1001 | 927.9 | 1118 | 1250 | 1161 | 1131 |
| 226428_at | 231.5 | 194.1 | 202.7 | 165.2 | 174.9 | 168.4 | 176.1 | 146.3 | 192 | 211.1 | 180.5 | 197.1 | 235.2 |
| 226459_at | 1945 | 2407 | 1979 | 3955 | 3219 | 2714 | 2753 | 2580 | 3234 | 2294 | 2649 | 2266 | 2189 |
| 226503_at | 237 | 236.9 | 237 | 238.1 | 256.2 | 149.2 | 212.4 | 258.7 | 188.7 | 194.5 | 227 | 194.8 | 160.2 |
| 226683_at | 2105 | 2418 | 3434 | 2460 | 2810 | 3617 | 2707 | 2639 | 2625 | 2692 | 2977 | 2154 | 2155 |
| 226718_at | 172.6 | 75.58 | 69.27 | 63.19 | 64.48 | 66.32 | 80.73 | 81.34 | 56.85 | 78.77 | 86.46 | 69.76 | 54.37 |
| 226763_at | 149.9 | 169 | 174.3 | 220.4 | 354.6 | 195.8 | 95.98 | 287 | 222.5 | 252.5 | 252.6 | 206 | 314.8 |
| 226836_at | 28.8 | 34.16 | 34.32 | 34.1 | 37.79 | 38.62 | 38.61 | 41.57 | 41.12 | 34.2 | 34.85 | 42.32 | 37.65 |
| 227020_at | 781.8 | 726.4 | 749.9 | 579.7 | 788 | 784.8 | 626.8 | 986.4 | 1168 | 848.8 | 929 | 787.1 | 689.7 |
| 227114_at | 100.4 | 119.3 | 100.6 | 100.6 | 99.71 | 75.23 | 109 | 101.3 | 89.99 | 89.3 | 79.85 | 102.2 | 99.63 |
| 227149_at | 116.6 | 83.67 | 82.08 | 79.1 | 56.97 | 55.69 | 84.97 | 60.74 | 38.42 | 73.87 | 77.39 | 71.12 | 85.79 |
| 227173_s_at | 323.4 | 167.8 | 82.58 | 127.9 | 112.6 | 59.05 | 95.32 | 105.8 | 48.99 | 125.9 | 134.3 | 68.27 | 193.9 |
| 227213_at | 134 | 62.72 | 60.98 | 50.42 | 40.25 | 45.48 | 70.93 | 63.08 | 26.69 | 73.72 | 64.77 | 63.43 | 52.86 |
| 227374_at | 57.07 | 60.85 | 41.35 | 42.4 | 45.78 | 36.01 | 37.01 | 35.85 | 34.75 | 58.17 | 47.62 | 45.6 | 60.02 |
| 227517_s_at | 872.2 | 529.6 | 431.3 | 364.2 | 299.6 | 302.1 | 495.2 | 493.4 | 220.5 | 615.5 | 456.6 | 316.5 | 433.5 |
| 227558_at | 1062 | 1175 | 1197 | 1128 | 1137 | 1184 | 1178 | 1171 | 1070 | 1133 | 1321 | 1330 | 1219 |
| 227560_at | 139.7 | 111.7 | 98.08 | 83.7 | 89.49 | 83.23 | 91.09 | 97.48 | 95.28 | 120.1 | 95.36 | 75.48 | 111.2 |
| 227722_at | 227.4 | 269.2 | 153 | 170.8 | 183.3 | 42.26 | 75.53 | 190.3 | 86.98 | 187.7 | 82.04 | 54.01 | 140.4 |
| 227990_at | 1004 | 833.4 | 1076 | 830.8 | 1071 | 1062 | 983.9 | 1006 | 1305 | 879 | 1065 | 995.1 | 1031 |
| 228012_at | 29.07 | 29.38 | 25.72 | 22.46 | 26.9 | 22.7 | 23.68 | 28.51 | 20.15 | 22.19 | 23.5 | 19.66 | 19.47 |
| 228170_at | 212.3 | 424.5 | 518.6 | 569.5 | 1099 | 766.2 | 231.5 | 829.8 | 2076 | 473 | 1179 | 1381 | 562.6 |
| 228176_at | 182.7 | 161.5 | 324.5 | 105.7 | 261.4 | 264.2 | 59.56 | 339.7 | 603.1 | 204.8 | 209.9 | 151.3 | 288.8 |
| 228234_at | 260.2 | 432.4 | 323.2 | 350.6 | 419.8 | 351.1 | 265.2 | 406.8 | 456.9 | 392.9 | 317.9 | 350.8 | 306.7 |
| 228370_at | 327.9 | 190.5 | 137.6 | 122.2 | 166.7 | 58.69 | 142 | 175.3 | 60.85 | 174.5 | 169.5 | 86.93 | 105 |
| 228549_at | 947.4 | 412.2 | 382.7 | 357.4 | 414.8 | 295.8 | 354.5 | 508.4 | 300.1 | 492.8 | 601.5 | 356.4 | 466.4 |
| 228630_at | 135.6 | 126.7 | 87.49 | 86.64 | 73.84 | 51.82 | 87.82 | 87.32 | 40.59 | 92.04 | 111.7 | 85.74 | 77.07 |
| 228831_s_at | 214.3 | 197 | 162 | 166.2 | 117.6 | 163.3 | 148.8 | 171.2 | 141.3 | 189.1 | 153.8 | 135.9 | 215.5 |
| 229307_at | 43.12 | 39.89 | 60.34 | 58.43 | 96 | 27.54 | 40 | 45.51 | 87.9 | 42.83 | 144.2 | 50.16 | 22.75 |
| 229421_s_at | 32.85 | 25.64 | 29.01 | 50.67 | 42.68 | 54.47 | 49.11 | 40.18 | 45.9 | 34.12 | 43.47 | 43.6 | 37.91 |
| 229509_at | 247.8 | 247.8 | 196.2 | 204 | 214.8 | 202.2 | 275.8 | 196.3 | 170.5 | 219 | 219.8 | 180.9 | 247 |
| 229854_at | 25 | 26.87 | 27.93 | 25.05 | 24.56 | 25.08 | 25.97 | 24.91 | 24.87 | 24.92 | 25.21 | 25.3 | 25.46 |
| 229982_at | 80 | 129.5 | 84.23 | 93.43 | 110.4 | 98.04 | 75.07 | 160.8 | 112.5 | 104.5 | 122.9 | 78.85 | 81.1 |
| 230265_at | 180.1 | 196 | 154.7 | 186.2 | 300.2 | 147.5 | 158.8 | 294.4 | 252.1 | 226.5 | 237.4 | 151.7 | 126 |
| 230320_at | 141.6 | 175.7 | 164.6 | 97.87 | 126.2 | 98.95 | 143.2 | 118.4 | 108.1 | 112.9 | 164.7 | 140.7 | 145 |
| 230408_at | 111.8 | 102 | 86.43 | 84.81 | 78.55 | 89.44 | 91.27 | 113.9 | 62.44 | 85.85 | 89.72 | 78.94 | 111.7 |
| 230480_at | 35.98 | 59.44 | 66.33 | 58.79 | 84.38 | 58.33 | 40.46 | 45.5 | 93.52 | 43.89 | 58.24 | 54.23 | 45.07 |
| 230837_at | 79.27 | 87.7 | 83.11 | 68.28 | 72.86 | 61.76 | 92.75 | 72.99 | 70.02 | 74.83 | 65.44 | 64.55 | 111.7 |
| 230852_at | 46.06 | 52.02 | 56.36 | 43.24 | 45.89 | 32.63 | 46.32 | 57 | 68.98 | 42.71 | 46.28 | 51.23 | 53.13 |
| 230922_x_at | 43.61 | 48.07 | 54.45 | 40.38 | 42.5 | 37.12 | 70.46 | 39.41 | 40.59 | 39.55 | 38.18 | 44.12 | 53.76 |
| 231283_at | 328.6 | 270.5 | 220.9 | 186.5 | 194.2 | 140.7 | 259.3 | 232.7 | 110.1 | 195.7 | 254 | 138.4 | 155.5 |
| 231697_s_at | 64.83 | 64.77 | 73.58 | 76.5 | 131 | 96.51 | 35.71 | 111.6 | 205.8 | 69.69 | 69.58 | 85.2 | 63.02 |
| 231836_at | 122 | 62.98 | 73.2 | 53.61 | 74.99 | 53.02 | 64.84 | 72.47 | 23.55 | 63.46 | 63.71 | 57.54 | 64.2 |
| 231843_at | 272.8 | 192 | 219.4 | 175.3 | 156.8 | 156.7 | 210 | 186.6 | 109.9 | 153.2 | 150.9 | 184.3 | 229.2 |
| 231845_at | 139.6 | 131.7 | 107.9 | 88.81 | 124.7 | 70.01 | 119 | 94.54 | 75.85 | 104.5 | 102.1 | 84.38 | 127.1 |
| 231904_at | 483.6 | 348.7 | 430.7 | 421.8 | 359.2 | 513.2 | 387.6 | 406.1 | 347.8 | 314.4 | 378.4 | 472.8 | 409.8 |
| 231914_at | 47.31 | 47.86 | 54.46 | 50.11 | 50.51 | 52.1 | 47.91 | 48.45 | 73.07 | 48.05 | 47.41 | 49.64 | 44.72 |
| 232636_at | 70.07 | 62.49 | 79.61 | 72.02 | 96.85 | 26.41 | 45.07 | 89.91 | 106.1 | 53.94 | 76.24 | 68.1 | 64.27 |
| 232851_at | 38.94 | 47.11 | 55.77 | 45.49 | 40.49 | 47.97 | 62.31 | 42.71 | 39.52 | 34.8 | 36.5 | 49.32 | 49.62 |
| 233019_at | 413 | 330.9 | 297 | 253.7 | 297.3 | 292.7 | 257.1 | 292.5 | 224.2 | 282.5 | 283.6 | 266.3 | 336.2 |
| 233169_at | 89.35 | 102.4 | 88.16 | 87.15 | 101.2 | 110.3 | 105.8 | 93.25 | 78.89 | 101.8 | 102.9 | 107.4 | 116.3 |
| 234013_at | 184.3 | 37.71 | 88.13 | 74.52 | 84.02 | 39.56 | 97.6 | 112 | 40.33 | 86.89 | 107.2 | 56.17 | 65.84 |
| 234311_s_at | 162.9 | 142.6 | 144.3 | 111.1 | 101.3 | 129.4 | 157.6 | 149.4 | 97.67 | 140.4 | 119.8 | 99.13 | 172.4 |
| 234339_s_at | 3371 | 2086 | 1512 | 1265 | 1053 | 1116 | 2157 | 1741 | 599.6 | 2083 | 1562 | 1016 | 2272 |
| 234464_s_at | 26.43 | 30.85 | 33.85 | 28.92 | 47.24 | 31.23 | 21.53 | 49.35 | 66.63 | 39.33 | 40.68 | 45.2 | 30.12 |
| 234733_s_at | 30.22 | 34.31 | 36.68 | 27.47 | 26.79 | 22.68 | 32.42 | 27.71 | 20.35 | 27.74 | 27.71 | 28.75 | 31.92 |
| 235024_at | 94.07 | 106.8 | 82.58 | 88.48 | 93.01 | 98.47 | 95.64 | 85.22 | 64.98 | 110.2 | 105.9 | 94.46 | 95.02 |
| 235067_at | 1241 | 841.5 | 1266 | 1104 | 786.8 | 1118 | 1026 | 947 | 778 | 830.8 | 755.7 | 864.6 | 714.2 |
| 235200_at | 167.9 | 109.3 | 143.3 | 91.74 | 145.3 | 92.5 | 88.46 | 118.5 | 104.9 | 88.27 | 118.1 | 109.1 | 88.37 |
| 235359_at | 262.3 | 357.2 | 358.8 | 340 | 258.6 | 318.5 | 305.3 | 276.3 | 313.9 | 350.3 | 412.2 | 455.7 | 399.2 |
| 235593_at | 516.2 | 672.5 | 622.1 | 993 | 823 | 1071 | 853.5 | 734.7 | 897.6 | 673.2 | 948 | 627.9 | 1056 |
| 235610_at | 74.58 | 55.15 | 78.8 | 38.45 | 64.27 | 45.13 | 51.4 | 55.64 | 36.46 | 41.44 | 56.87 | 39.47 | 57.8 |
| 235623_at | 25.39 | 36.93 | 28.6 | 25.93 | 28 | 20.56 | 25.71 | 26.73 | 17.84 | 28.57 | 31.14 | 21.62 | 34.94 |
| 235690_at | 39.99 | 24.91 | 23.77 | 23.21 | 22.48 | 16.67 | 22.99 | 30.43 | 24.07 | 22.98 | 23.26 | 21.69 | 25.43 |
| 237504_at | 77.3 | 80.11 | 109.9 | 75.08 | 66.99 | 64.19 | 88.63 | 62.02 | 51.3 | 68.93 | 81.79 | 80.51 | 77.15 |
| 238429_at | 2812 | 3585 | 3362 | 4290 | 4972 | 4844 | 3888 | 4793 | 6011 | 4313 | 5348 | 4644 | 3103 |
| 238513_at | 567 | 627.1 | 1256 | 3403 | 1511 | 1836 | 873.9 | 943.3 | 1675 | 555.9 | 1189 | 1768 | 584.4 |
| 238736_at | 262.7 | 251.3 | 292 | 268 | 281.6 | 289.5 | 257.2 | 278.1 | 279.4 | 219.5 | 263.8 | 287.3 | 226.4 |
| 238823_at | 93.03 | 64.84 | 59.41 | 58.11 | 40.8 | 39.45 | 62.95 | 40.41 | 24.65 | 56.41 | 51.86 | 49.24 | 60.41 |
| 238909_at | 218.8 | 227.7 | 204.3 | 175 | 260.5 | 135.4 | 178.3 | 185.9 | 275.6 | 205.5 | 208.3 | 204.8 | 175.8 |
| 239108_at | 134.4 | 205.5 | 294.6 | 349.3 | 470.6 | 453.8 | 178.2 | 351.8 | 390.5 | 156.1 | 348.2 | 351.1 | 234.5 |
| 239897_at | 265.3 | 238.1 | 191 | 195.9 | 226.9 | 275 | 196.8 | 210.4 | 201.2 | 220.8 | 267.7 | 187.1 | 219.3 |
| 241368_at | 313.1 | 194.5 | 310.7 | 427.2 | 382.8 | 658.7 | 539.5 | 377.9 | 356.9 | 532.7 | 533.3 | 435.8 | 248.8 |
| 241704_x_at | 59.62 | 54.24 | 51.15 | 44.54 | 43.92 | 39.49 | 56.45 | 48.76 | 38.71 | 53.39 | 48.06 | 49.06 | 48.27 |
| 241706_at | 116.4 | 119.2 | 149.5 | 118.6 | 121 | 161.4 | 84.33 | 160 | 157.6 | 118.3 | 118.7 | 135 | 130.2 |
| 241731_x_at | 70.67 | 57.37 | 76.47 | 45.79 | 43.62 | 40.56 | 49.11 | 49.87 | 37.18 | 45.93 | 48.37 | 39.2 | 55.9 |
| 242197_x_at | 59.58 | 46.71 | 57.31 | 58.22 | 69.27 | 39.16 | 14.72 | 108.9 | 201.7 | 36.22 | 88.81 | 50.7 | 95.98 |
| 242561_at | 25.77 | 24.48 | 23.78 | 21.52 | 18.42 | 27.14 | 28.91 | 20.41 | 24.96 | 22.81 | 19.93 | 30.9 | 22.91 |
| 242569_at | 190.2 | 287.7 | 251.9 | 275.1 | 261.2 | 325.6 | 222.7 | 265.7 | 265.1 | 197.5 | 247.2 | 315 | 264.2 |
| 242669_at | 282.7 | 245.4 | 248 | 129.9 | 221.9 | 205.3 | 153.4 | 241.5 | 140.9 | 172.3 | 217.5 | 221.8 | 220 |
| 243982_at | 110.1 | 117.6 | 124.1 | 104.4 | 114.7 | 93.71 | 86.14 | 100.3 | 91.43 | 97.08 | 108.7 | 109.9 | 95.55 |
| 244038_at | 60.62 | 63.02 | 53.79 | 38.14 | 52.77 | 29.19 | 47.6 | 46.53 | 25.42 | 52.72 | 50.53 | 30 | 41.55 |
| 244654_at | 2193 | 2193 | 2401 | 2258 | 1644 | 1391 | 2296 | 1470 | 1192 | 2109 | 1930 | 2449 | 2045 |
| 244698_at | 31.67 | 36.05 | 36.37 | 31.17 | 31.95 | 33.99 | 33.96 | 32.6 | 34.22 | 32.55 | 33.54 | 34.11 | 33.92 |
| 36566_at | 96.78 | 101.8 | 135.2 | 94.19 | 128.5 | 121.5 | 118.6 | 120.9 | 138.1 | 127.2 | 123.8 | 146.9 | 118.1 |
| 37549_g_at | 41.83 | 47.46 | 47.67 | 40.47 | 38.64 | 48.66 | 49.82 | 42.26 | 47.05 | 40.63 | 42.35 | 41.86 | 39.72 |
| 48659_at | 171.4 | 196.6 | 184.5 | 203.7 | 213 | 224 | 196.8 | 200 | 267.4 | 149.7 | 259.5 | 218.5 | 223 |
| 56829_at | 146.2 | 146 | 162.4 | 160.7 | 126.6 | 152.4 | 177.4 | 125 | 168.3 | 141 | 140.8 | 186.4 | 169.3 |
| 64486_at | 182 | 242.7 | 236.7 | 168.2 | 270.1 | 243.2 | 186.3 | 267.3 | 291.6 | 247.4 | 202.1 | 235.4 | 219.8 |
| 65493_at | 47.99 | 72.5 | 34.72 | 26.56 | 41.2 | 42.12 | 66.2 | 40.42 | 42.72 | 42.8 | 38.95 | 40.58 | 55.58 |
| AFFX- | 8508 | 8564 | 9605 | 8541 | 10641 | 8642 | 9153 | 9443 | 12450 | 10662 | 9468 | 10064 | 9626 |
| HUMGAPDH/M33197_3_at | | | | | | | | | | | | | |
| | NYHA III- | NYHA III- | NYHA III- | NYHA III- | NYHA III- | NYHA III- | NYHA III- | NYHA III- | NYHA III- | NYHA III- | NYHA III- | NYHA III- | NYHA III- |
| | IV | IV | IV | IV | IV | IV | IV | IV | IV | IV | IV | IV | IV |
| Affymetrix Probe | Sample | Sample | Sample | Sample | Sample | Sample | Sample | Sample | Sample | Sample | Sample | Sample | Sample |
| set ID | no. 64 | no. 70 | no. 72 | no. 73 | no. 75 | no. 77 | no. 78 | no. 80 | no. 81 | no. 84 | no. 88 | no. 90 | no. 95 |
| 1552318_at | 1695 | 1560 | 1627 | 1231 | 1657 | 1604 | 1058 | 1095 | 1545 | 1358 | 1024 | 1444 | 1467 |
| 1552630_a_at | 60.18 | 81.18 | 73.58 | 71.78 | 92.92 | 68.39 | 85.47 | 65.14 | 76.87 | 64.04 | 73.69 | 60.37 | 121.7 |
| 1554149_at | 785.1 | 688.6 | 526.6 | 418.1 | 708.4 | 679.7 | 456.8 | 732.4 | 547.3 | 736 | 678.4 | 664.8 | 879 |
| 1554539_a_at | 76.92 | 77.47 | 69.29 | 63.55 | 72.16 | 90.07 | 59.23 | 62.97 | 102 | 67.84 | 104.3 | 85.72 | 81.06 |
| 1554606_at | 173.3 | 112.3 | 115.4 | 80.71 | 83.82 | 158.6 | 98.95 | 81.62 | 112.9 | 120 | 102.1 | 112.6 | 131.6 |
| 1555630_a_at | 102.1 | 186.8 | 155.4 | 132.7 | 155.2 | 125.7 | 121.3 | 91.41 | 134.2 | 91.94 | 198.5 | 178.3 | 221.4 |
| 1555963_x_at | 74.96 | 45.63 | 45.16 | 46.64 | 46.27 | 51.36 | 47.23 | 52 | 51.33 | 45.19 | 46.28 | 45.88 | 209.9 |
| 1555996_s_at | 1339 | 840.5 | 986.4 | 819.8 | 536.8 | 762.9 | 619.5 | 663.5 | 898.6 | 1000 | 747.4 | 1034 | 860.7 |
| 1556113_at | 31.26 | 38.26 | 39.19 | 52.65 | 46.09 | 37.61 | 40.72 | 41.48 | 40.11 | 45.24 | 39.82 | 38.15 | 42.44 |
| 1556283_s_at | 113.6 | 135.2 | 180.2 | 107 | 95.94 | 106.2 | 181.7 | 172.5 | 131.1 | 105.4 | 138.7 | 114.2 | 141.7 |
| 1556864_at | 57.4 | 51.75 | 56.29 | 61.2 | 47.65 | 46.71 | 53.42 | 26.84 | 48.48 | 46.87 | 48 | 36.8 | 39.28 |
| 1557066_at | 237.6 | 161 | 150 | 137.6 | 104.5 | 166.8 | 106.1 | 88.22 | 137 | 174.1 | 130.9 | 134.5 | 156.1 |
| 1558277_at | 49.81 | 38.41 | 34.1 | 50.7 | 39.56 | 28.71 | 60.8 | 46.51 | 55.05 | 25.53 | 67.89 | 43.27 | 40.09 |
| 1558755_x_at | 103.8 | 133 | 149.3 | 116 | 80.18 | 158.1 | 153.2 | 86.41 | 184 | 131.8 | 194.6 | 120.6 | 109.2 |
| 1561146_at | 64.95 | 62.2 | 65.4 | 66.46 | 51.62 | 51.16 | 52.13 | 53.44 | 53.25 | 64.01 | 35.6 | 65.61 | 39.64 |
| 1564962_at | 29.52 | 26.12 | 30.38 | 32.29 | 22.08 | 24.3 | 31.57 | 37.89 | 32.09 | 35.25 | 33.1 | 29.52 | 30.68 |
| 1567013_at | 85.65 | 106.8 | 146.1 | 119.5 | 103.1 | 100 | 155.9 | 133.3 | 126.5 | 123.1 | 132.1 | 153.9 | 120.2 |
| 1568815_a_at | 130.4 | 95 | 129.6 | 82.9 | 111.6 | 111.4 | 75.36 | 74.96 | 89.79 | 156.4 | 91.11 | 98.23 | 113.5 |
| 200007_at | 8022 | 7474 | 7689 | 7454 | 7083 | 8125 | 6517 | 7144 | 7352 | 7340 | 8161 | 7902 | 8481 |
| 200010_at | 14354 | 11551 | 12609 | 8991 | 11138 | 12118 | 7762 | 8206 | 11308 | 13470 | 9670 | 11861 | 10587 |
| 200059_s_at | 9744 | 10312 | 10502 | 11156 | 10121 | 10304 | 11373 | 10525 | 10296 | 10189 | 11025 | 11764 | 10564 |
| 200091_s_at | 21602 | 19430 | 18962 | 13373 | 16802 | 19293 | 14085 | 15470 | 19100 | 20217 | 18869 | 18421 | 17058 |
| 200633_at | 8533 | 8354 | 8990 | 8041 | 8694 | 8535 | 5878 | 6926 | 8059 | 8679 | 8040 | 7970 | 11178 |
| 200650_s_at | 6026 | 4801 | 5097 | 5362 | 6148 | 6148 | 6311 | 7255 | 4959 | 5709 | 6310 | 5342 | 7585 |
| 200672_x_at | 152.9 | 174.1 | 127.1 | 116.6 | 133.7 | 132.4 | 116.3 | 133.2 | 131.9 | 141.4 | 127.5 | 146 | 143.1 |
| 200677_at | 2811 | 2659 | 2658 | 2811 | 2997 | 3240 | 2511 | 3451 | 3190 | 2362 | 2665 | 2381 | 2805 |
| 200713_s_at | 1335 | 1422 | 1407 | 1464 | 1672 | 1386 | 1326 | 1574 | 1507 | 1437 | 1651 | 1633 | 2104 |
| 200822_x_at | 1206 | 1190 | 1353 | 1216 | 1523 | 1454 | 1559 | 1012 | 1166 | 1279 | 1296 | 1507 | 1583 |
| 200829_x_at | 612.4 | 603.8 | 593.7 | 511.1 | 595 | 634.6 | 461 | 523 | 535.6 | 617.8 | 603.8 | 597.1 | 845.8 |
| 200839_s_at | 2311 | 2837 | 2812 | 3917 | 2723 | 3009 | 3899 | 3367 | 2647 | 3152 | 4225 | 3686 | 5812 |
| 200932_s_at | 437.3 | 410.6 | 470.2 | 435.2 | 512.8 | 447 | 404.8 | 449.1 | 500 | 505.2 | 494.1 | 441 | 513.2 |
| 200950_at | 414.1 | 569.7 | 556 | 536.8 | 522 | 489.4 | 616.4 | 642.2 | 598.2 | 497.1 | 598.2 | 611 | 672.9 |
| 201031_s_at | 9573 | 7203 | 7264 | 6369 | 7247 | 8612 | 4943 | 5118 | 6354 | 8342 | 7196 | 6890 | 8138 |
| 201075_s_at | 324.7 | 289.6 | 301.7 | 322.1 | 287.3 | 369.9 | 244.2 | 302.7 | 275.1 | 271.3 | 274.3 | 310.8 | 261 |
| 201098_at | 754.7 | 852 | 846.3 | 805.2 | 782.1 | 833.3 | 730.8 | 878.2 | 848.6 | 807.5 | 890 | 860.4 | 1021 |
| 201105_at | 3539 | 2254 | 2855 | 4312 | 3684 | 3197 | 1979 | 2553 | 3305 | 3198 | 3452 | 3141 | 6730 |
| 201172_x_at | 3039 | 3424 | 3481 | 3669 | 3773 | 3624 | 3970 | 4106 | 3363 | 3724 | 3507 | 4294 | 4090 |
| 201186_at | 394.4 | 420.7 | 500.5 | 572.2 | 620.3 | 497.8 | 615.9 | 889.6 | 635.9 | 448.1 | 487.7 | 570.1 | 687.6 |
| 201193_at | 516.3 | 606.3 | 547 | 643.2 | 594.9 | 644.1 | 663.2 | 458.1 | 605 | 643.2 | 807.6 | 678.2 | 1078 |
| 201198_s_at | 155.1 | 166.4 | 170.3 | 163.1 | 177.6 | 172.8 | 121.3 | 160.8 | 160.2 | 137.2 | 109.7 | 171.9 | 207.8 |
| 201220_x_at | 1324 | 1744 | 1530 | 1873 | 1570 | 1756 | 1961 | 1787 | 1720 | 1906 | 1565 | 1877 | 1734 |
| 201234_at | 1107 | 1399 | 1642 | 1240 | 1489 | 1404 | 1242 | 1071 | 1369 | 1058 | 1792 | 1406 | 1952 |
| 201357_s_at | 286.8 | 330.1 | 287.3 | 431.7 | 424.1 | 394.7 | 528.6 | 401.5 | 358.7 | 280.8 | 341.6 | 431 | 255.2 |
| 201363_s_at | 1318 | 1564 | 1524 | 1536 | 1245 | 1285 | 1855 | 1434 | 1786 | 1474 | 1816 | 1220 | 1530 |
| 201400_at | 1465 | 1836 | 1962 | 1635 | 1962 | 1543 | 1948 | 2243 | 2105 | 1597 | 1972 | 2234 | 1837 |
| 201421_s_at | 179.6 | 159.8 | 151.3 | 162 | 191.6 | 149 | 127.2 | 116.8 | 140.1 | 151.7 | 150.6 | 142.1 | 186 |
| 201422_at | 6939 | 8111 | 7477 | 9827 | 9202 | 7424 | 7153 | 8070 | 6865 | 6843 | 8328 | 7970 | 13572 |
| 201426_s_at | 17268 | 15271 | 15274 | 18673 | 15154 | 16259 | 15657 | 15410 | 16173 | 13876 | 17607 | 16563 | 15406 |
| 201453_x_at | 1266 | 1406 | 1292 | 1111 | 1345 | 1561 | 1035 | 1070 | 1403 | 1330 | 1380 | 1269 | 1732 |
| 201470_at | 1239 | 1143 | 1519 | 1124 | 1666 | 1188 | 968.5 | 994.2 | 1021 | 1076 | 1533 | 1242 | 2655 |
| 201478_s_at | 263.8 | 265.7 | 266.9 | 201.2 | 247.3 | 266.1 | 193.8 | 173.1 | 240.8 | 301.9 | 240 | 262.4 | 245.7 |
| 201527_at | 866.9 | 941.8 | 926.8 | 775.3 | 925.1 | 931.5 | 831.8 | 698.4 | 817.2 | 802.7 | 869.8 | 903.4 | 1333 |
| 201536_at | 299.1 | 432.5 | 380.5 | 471 | 537.6 | 343 | 329 | 502 | 389.3 | 392.8 | 375.9 | 364.3 | 815.1 |
| 201554_x_at | 721.7 | 701.3 | 644.8 | 998.1 | 710.6 | 752.3 | 1442 | 2793 | 875.2 | 957 | 1091 | 807.3 | 1113 |
| 201556_s_at | 460.4 | 648.4 | 568.7 | 539.1 | 562.7 | 474.8 | 421.2 | 572.9 | 554.1 | 644.7 | 515.6 | 559 | 613.2 |
| 201576_s_at | 610.6 | 713.9 | 714.8 | 672.8 | 728 | 741.1 | 708.5 | 561.1 | 652.2 | 589.3 | 672.9 | 753 | 936.3 |
| 201590_x_at | 3367 | 3337 | 2983 | 3823 | 3657 | 3108 | 2074 | 2513 | 2848 | 2724 | 3489 | 3507 | 5559 |
| 201628_s_at | 608.8 | 633.5 | 609.2 | 500.2 | 634.3 | 621.2 | 613.3 | 666.5 | 581.1 | 587.3 | 596.5 | 639.4 | 759.6 |
| 201788_at | 450.1 | 528 | 479.3 | 434.1 | 561.2 | 510.7 | 491.1 | 403.6 | 555.1 | 626.2 | 426.9 | 515.4 | 468.3 |
| 201900_s_at | 390.8 | 474.8 | 375.5 | 342.2 | 463.5 | 443.4 | 327.2 | 275.6 | 389.6 | 407.8 | 413.2 | 469.5 | 847.8 |
| 201945_at | 325.7 | 514.9 | 511.7 | 662 | 744.5 | 477 | 853 | 810.2 | 574.2 | 549 | 478.9 | 564.3 | 508.5 |
| 202068_s_at | 156.2 | 92.39 | 92.95 | 89.81 | 136.4 | 110.6 | 32.04 | 105.3 | 127.2 | 154.2 | 120.5 | 132.1 | 329.2 |
| 202104_s_at | 419.5 | 361.9 | 360.8 | 261.8 | 392.9 | 396 | 316.5 | 216.8 | 360.9 | 355.6 | 299.9 | 354.1 | 372.9 |
| 202138_x_at | 245.1 | 276.9 | 274.7 | 251.2 | 286.6 | 271.8 | 205 | 208 | 235.2 | 242 | 156.3 | 255.3 | 372.3 |
| 202185_at | 213.7 | 200.5 | 192 | 178.2 | 235 | 208.7 | 173.1 | 179.3 | 195.6 | 190.3 | 197.1 | 224.3 | 272.5 |
| 202192_s_at | 699.1 | 626.2 | 531.7 | 692.4 | 746.1 | 901.8 | 706.8 | 1113 | 582 | 824.3 | 768.7 | 994 | 583.8 |
| 202201_at | 512.7 | 469.5 | 641.5 | 921.3 | 743.2 | 607.9 | 686 | 458.8 | 721.7 | 625.1 | 752.3 | 667.4 | 753.3 |
| 202249_s_at | 202.5 | 236.7 | 225.9 | 165.1 | 213.2 | 223 | 205.3 | 224.6 | 151.2 | 196 | 200.3 | 207.7 | 243.9 |
| 202252_at | 72.19 | 86.62 | 107.2 | 104.3 | 105.9 | 100 | 138.7 | 84.07 | 105.2 | 89.35 | 321.7 | 155.7 | 226.4 |
| 202262_x_at | 75.72 | 79.94 | 77.53 | 163.7 | 128.7 | 99.46 | 100 | 161.6 | 122.5 | 97.79 | 101.3 | 122 | 133.6 |
| 202380_s_at | 636.4 | 697.3 | 578.8 | 466.1 | 492.1 | 623.9 | 299 | 336.2 | 426.9 | 548.7 | 400.2 | 526.2 | 562.1 |
| 202381_at | 309.8 | 348.1 | 380.9 | 531.2 | 577.1 | 413.2 | 607.5 | 604.5 | 502.9 | 440.5 | 905 | 543.2 | 610.5 |
| 202428_x_at | 2083 | 2124 | 1823 | 1806 | 1994 | 2169 | 1758 | 1655 | 2035 | 2204 | 2049 | 2196 | 3903 |
| 202445_s_at | 119.6 | 184.7 | 133.8 | 159.1 | 148.2 | 147 | 147.6 | 163.1 | 113.9 | 144.6 | 172.8 | 138.8 | 134.7 |
| 202461_at | 166.3 | 177 | 190 | 160.4 | 199.5 | 215.2 | 153.7 | 93.71 | 168.2 | 184.7 | 189.4 | 196.5 | 281.5 |
| 202522_at | 729.4 | 795.6 | 677.4 | 518.4 | 661.9 | 705 | 632.8 | 639.9 | 659.9 | 682.8 | 649.6 | 805.9 | 726.6 |
| 202523_s_at | 251.9 | 279.2 | 222.9 | 130.4 | 177.6 | 193.1 | 98.18 | 164.3 | 235.5 | 117 | 162.2 | 213.2 | 77.63 |
| 202594_at | 913.6 | 973.9 | 878.3 | 706.3 | 880.1 | 891.2 | 1232 | 1012 | 915 | 1093 | 840.2 | 917.9 | 1200 |
| 202623_at | 1004 | 1261 | 1082 | 880.6 | 1183 | 1105 | 1160 | 951.7 | 1013 | 1154 | 1110 | 1072 | 1034 |
| 202652_at | 29.8 | 36.45 | 36.27 | 35.64 | 34.6 | 28.8 | 20.83 | 27.8 | 39.45 | 38.99 | 35.32 | 28.88 | 24.83 |
| 202724_s_at | 505.8 | 418.4 | 447.8 | 360 | 483.5 | 528.6 | 356.9 | 573.4 | 454.9 | 577.1 | 466.3 | 396.3 | 260.7 |
| 202750_s_at | 188.9 | 242.7 | 195 | 208.4 | 237.4 | 240.1 | 222.9 | 205.8 | 236.3 | 178.6 | 207.9 | 246.9 | 198 |
| 202778_s_at | 589.2 | 589.4 | 526.9 | 399.9 | 541 | 567.3 | 527.4 | 443.8 | 474.5 | 509.7 | 616.7 | 524.8 | 477.1 |
| 202910_s_at | 3670 | 3891 | 4289 | 4329 | 5058 | 4698 | 3997 | 5993 | 3871 | 3010 | 3812 | 4388 | 4253 |
| 202928_s_at | 125.1 | 163.8 | 148.9 | 115.7 | 113 | 151 | 171.9 | 122 | 124.3 | 142.7 | 131.7 | 151.4 | 127.6 |
| 202944_at | 366.5 | 456.6 | 359.2 | 442.5 | 426.9 | 404.8 | 434.5 | 319.4 | 392 | 308.8 | 384.3 | 422.7 | 578.4 |
| 202979_s_at | 1092 | 635.7 | 654 | 405.9 | 547.3 | 680.4 | 437.1 | 416.7 | 538.3 | 821.9 | 579.6 | 681.6 | 714.6 |
| 203003_at | 79.19 | 103.1 | 103.8 | 123.7 | 135.7 | 86.14 | 114.2 | 102.6 | 115.2 | 97.94 | 112.6 | 106.5 | 81.66 |
| 203127_s_at | 287.2 | 375.2 | 339 | 343.4 | 301 | 308.1 | 452.4 | 493.1 | 312.4 | 299.3 | 368.1 | 398.2 | 725.1 |
| 203137_at | 2449 | 1645 | 1727 | 1901 | 1535 | 2085 | 1533 | 1583 | 1683 | 1405 | 1488 | 1489 | 1766 |
| 203184_at | 99.77 | 75.72 | 51.91 | 186.6 | 97.83 | 65.66 | 87.99 | 67 | 131.2 | 178.1 | 190 | 155 | 126.7 |
| 203234_at | 333.2 | 451.8 | 428.5 | 496.6 | 631 | 470.9 | 605.7 | 1189 | 449.3 | 547.8 | 486.2 | 334.8 | 529 |
| 203278_s_at | 784.1 | 780.9 | 840 | 1247 | 1141 | 910.2 | 1371 | 2527 | 1221 | 1289 | 1287 | 1136 | 758.7 |
| 203305_at | 787.9 | 1174 | 2461 | 2009 | 1470 | 1471 | 894 | 721 | 1003 | 957.7 | 3084 | 946.3 | 2816 |
| 203371_s_at | 807.3 | 911.8 | 1056 | 1264 | 1270 | 1256 | 1390 | 2261 | 1353 | 1228 | 1476 | 1224 | 1357 |
| 203413_at | 518.3 | 408.8 | 443.4 | 48.31 | 353.9 | 322.2 | 140.1 | 315.6 | 325.9 | 512 | 348.4 | 252.7 | 206.2 |
| 203416_at | 10093 | 10616 | 10840 | 11708 | 10889 | 11211 | 11861 | 12974 | 10596 | 10844 | 10535 | 11708 | 12840 |
| 203492_x_at | 273.8 | 218.6 | 226.9 | 194 | 202.7 | 232.6 | 149.8 | 160.7 | 195.1 | 226.1 | 258.4 | 204.4 | 242 |
| 203534_at | 785.8 | 797.5 | 869.4 | 672.4 | 830.6 | 788.9 | 683.9 | 723.7 | 725 | 798.8 | 992.2 | 759 | 1225 |
| 203535_at | 34915 | 38895 | 40854 | 45816 | 44041 | 40185 | 47048 | 51441 | 43567 | 39980 | 43014 | 45234 | 44598 |
| 203578_s_at | 156.1 | 129.6 | 129.4 | 86.3 | 74.52 | 83.28 | 75.94 | 70.25 | 97.48 | 120.6 | 85.79 | 97.66 | 67.65 |
| 203748_x_at | 1419 | 1741 | 1595 | 1756 | 1758 | 1640 | 2021 | 2332 | 1864 | 1797 | 1587 | 1911 | 1769 |
| 203759_at | 87.65 | 77.4 | 86.16 | 144.9 | 156.1 | 94.59 | 154.1 | 369.4 | 113.2 | 137.8 | 129.8 | 83.13 | 56.16 |
| 203844_at | 37.77 | 28.03 | 27.57 | 29.79 | 30.58 | 29.27 | 30.49 | 31.78 | 29.5 | 27.21 | 30.21 | 27.69 | 31.08 |
| 203880_at | 253.2 | 307.6 | 276.3 | 215.3 | 315.7 | 257.5 | 200 | 243.5 | 279.3 | 280.8 | 273.3 | 282.5 | 482.4 |
| 203912_s_at | 230.1 | 192.8 | 198.4 | 219.7 | 243.6 | 194.8 | 266 | 160.1 | 195.1 | 231 | 197 | 250.3 | 294.5 |
| 203939_at | 64.99 | 55.35 | 117.1 | 72.99 | 69.17 | 94.2 | 33.5 | 63.03 | 63.25 | 81.45 | 67.98 | 35.57 | 50.36 |
| 203971_at | 97.48 | 98.02 | 120.8 | 130.7 | 130.3 | 120.6 | 125.4 | 144.2 | 104.8 | 93.72 | 134.1 | 157.9 | 137.7 |
| 204050_s_at | 1282 | 1248 | 1356 | 1214 | 1194 | 1200 | 1172 | 1025 | 1174 | 1118 | 1305 | 1264 | 1727 |
| 204068_at | 64.89 | 84.57 | 74.9 | 99.99 | 102.8 | 90.87 | 75.73 | 217 | 87.85 | 108 | 127.5 | 105 | 114.1 |
| 204099_at | 114.4 | 141.4 | 160.8 | 201.5 | 171.4 | 179.4 | 370.4 | 227.9 | 195.1 | 202.3 | 223 | 210.2 | 298.4 |
| 204143_s_at | 215.4 | 164 | 130 | 92.81 | 71.24 | 200.4 | 71.21 | 91.75 | 118.2 | 157.2 | 114.2 | 87.4 | 102.6 |
| 204204_at | 1794 | 1875 | 2200 | 2842 | 2191 | 2821 | 2288 | 3354 | 2191 | 2112 | 2531 | 2399 | 3088 |
| 204214_s_at | 432.3 | 470.9 | 643.9 | 807.9 | 607 | 517.7 | 580.9 | 964.9 | 722 | 611.6 | 815.8 | 614.4 | 586.9 |
| 204232_at | 3310 | 3025 | 3785 | 3485 | 5504 | 4102 | 4390 | 5650 | 4338 | 5257 | 6162 | 3992 | 6213 |
| 204243_at | 250.3 | 278.6 | 250.3 | 276.5 | 290.9 | 294.4 | 383.4 | 289.6 | 250.9 | 315.2 | 341.8 | 289.6 | 218.8 |
| 204249_s_at | 2315 | 3259 | 2751 | 3311 | 3723 | 2645 | 3600 | 2661 | 3348 | 3342 | 3808 | 3675 | 4164 |
| 204291_at | 539.8 | 460.2 | 369.6 | 380.1 | 408.3 | 402 | 299.9 | 401 | 441.8 | 386 | 409.4 | 328.2 | 374 |
| 204342_at | 1062 | 887.7 | 630.5 | 824.1 | 843.3 | 785.5 | 701 | 737.8 | 886.3 | 812.2 | 860.4 | 923.3 | 1280 |
| 204352_at | 661.2 | 384.9 | 370.8 | 178 | 356.6 | 420.5 | 99.26 | 228.6 | 251.8 | 451.8 | 215.8 | 294.5 | 382.9 |
| 204401_at | 188.1 | 144.9 | 176.5 | 105.6 | 99.69 | 121.2 | 70.52 | 87.15 | 92.48 | 106 | 170.7 | 103.4 | 85.82 |
| 204504_s_at | 102.7 | 98.39 | 93.87 | 80.05 | 109.7 | 96.49 | 68.17 | 79.85 | 91.84 | 82.98 | 101.6 | 95.4 | 102.5 |
| 204617_s_at | 288.8 | 298 | 332.4 | 255.2 | 321.8 | 346.7 | 207.4 | 213 | 258 | 347.3 | 257.2 | 266.3 | 221.1 |
| 204645_at | 1001 | 876.3 | 813.5 | 812.4 | 794.4 | 782.5 | 757.8 | 772.4 | 934.3 | 778.9 | 808.4 | 629.8 | 924.4 |
| 204675_at | 116.8 | 193.7 | 123.2 | 112.3 | 97.67 | 102.5 | 55.08 | 34.15 | 85.97 | 103.8 | 113.4 | 106.4 | 170.3 |
| 204689_at | 448.5 | 468.5 | 557.8 | 514.2 | 601.1 | 517.9 | 645.6 | 647.7 | 526 | 643.7 | 712.4 | 594.4 | 538.2 |
| 204801_s_at | 23.91 | 32.72 | 33.55 | 27.02 | 26.19 | 21.23 | 30.13 | 38.83 | 67.36 | 19.89 | 23.83 | 28.49 | 19.25 |
| 205235_s_at | 91.07 | 81.75 | 88.1 | 92.21 | 87.42 | 78.99 | 75.33 | 79.38 | 88.91 | 89.76 | 87.92 | 84.68 | 87.34 |
| 205254_x_at | 400.9 | 306.7 | 254.2 | 43.01 | 179.1 | 250.9 | 97.2 | 206.6 | 238 | 319 | 198.6 | 244.1 | 123.7 |
| 205256_at | 65.56 | 75.54 | 67.2 | 55.86 | 65.39 | 63.49 | 64.86 | 50.49 | 48.49 | 64.79 | 67.06 | 68.62 | 85.52 |
| 205322_s_at | 419 | 570.6 | 528.7 | 629.4 | 541.6 | 543 | 761.5 | 714.8 | 650.8 | 565.3 | 575.9 | 586.6 | 629.9 |
| 205340_at | 153.3 | 130.7 | 118.6 | 87.32 | 135.8 | 124.9 | 74.96 | 84.81 | 123.9 | 156.6 | 89.72 | 104.9 | 120.4 |
| 205349_at | 159.6 | 188.1 | 188.2 | 194.3 | 193.8 | 128.4 | 156.8 | 154.4 | 183.6 | 164.7 | 260.6 | 199.3 | 247.3 |
| 205550_s_at | 256.4 | 261.4 | 289.6 | 261.4 | 305.3 | 284.4 | 266.3 | 311.8 | 261.4 | 258.9 | 261.3 | 259.4 | 299 |
| 205811_at | 177.8 | 174.2 | 163.5 | 145 | 136.1 | 170.3 | 106.7 | 117.3 | 143.1 | 182.4 | 110.9 | 125.7 | 138.2 |
| 205835_s_at | 117.1 | 78.2 | 77.3 | 94.15 | 76.03 | 77.68 | 58.99 | 51.83 | 88.56 | 100.8 | 61.81 | 74.52 | 98.85 |
| 205895_s_at | 168.4 | 150.3 | 139 | 101 | 117.4 | 145.4 | 98.78 | 97.83 | 134.5 | 93.37 | 113.2 | 150.8 | 147.5 |
| 205965_at | 206.8 | 189.1 | 187.9 | 175.3 | 232.7 | 274.2 | 192.7 | 331.2 | 171.1 | 253.5 | 215.3 | 248.2 | 261.8 |
| 205976_at | 78.62 | 51.12 | 54.91 | 15.98 | 26.05 | 53 | 17.9 | 14.29 | 41.52 | 45.34 | 30.49 | 42.67 | 40.16 |
| 206015_s_at | 717.9 | 736.5 | 689.3 | 581.2 | 641 | 678.4 | 552.9 | 548 | 593.8 | 678.4 | 620.4 | 646 | 623.1 |
| 206037_at | 28.75 | 35.62 | 33.72 | 36.91 | 40.94 | 30.35 | 33.91 | 32.97 | 37.47 | 35.72 | 27.81 | 39.51 | 28.67 |
| 206170_at | 285.3 | 310.5 | 169.1 | 230 | 270.6 | 427.4 | 144 | 271.8 | 251.3 | 203.2 | 344.6 | 327.6 | 396.1 |
| 206182_at | 122.5 | 119.1 | 114.5 | 77.8 | 105.7 | 108.4 | 92.57 | 94.07 | 101.3 | 96.42 | 115.1 | 122.6 | 81.5 |
| 206343_s_at | 4.57 | 32.83 | 24.71 | 93.76 | 78.59 | 21.92 | 53.97 | 8.237 | 15.1 | 81.42 | 91.95 | 26.62 | 9.013 |
| 206542_s_at | 1414 | 1233 | 1077 | 975.6 | 1222 | 1376 | 1083 | 922.6 | 970.2 | 1446 | 1182 | 1161 | 1188 |
| 206580_s_at | 59.15 | 59.15 | 80.38 | 62.84 | 79.58 | 65.78 | 68.8 | 58.04 | 59.1 | 74.57 | 72.1 | 63.14 | 73.91 |
| 206715_at | 355.8 | 252.1 | 248.4 | 312.9 | 334.5 | 191 | 354.1 | 260.4 | 290.8 | 272.8 | 424.6 | 375.2 | 1024 |
| 206834_at | 44 | 44.55 | 208.5 | 444.3 | 299.3 | 141.7 | 45.58 | 46.03 | 54.83 | 44.37 | 643.7 | 54.62 | 57.68 |
| 206968_s_at | 100.3 | 93.39 | 111.3 | 127.2 | 87.22 | 101.1 | 78.79 | 74.38 | 73.72 | 94.63 | 100 | 103.5 | 81.88 |
| 207075_at | 154.6 | 169.5 | 127.6 | 175 | 201.7 | 126.4 | 353.7 | 122.6 | 147.4 | 228.8 | 194.4 | 191.9 | 155.1 |
| 207078_at | 224 | 168.9 | 149.2 | 124.1 | 140.8 | 135.3 | 76.15 | 110.8 | 167.5 | 117.4 | 111.7 | 124.6 | 137.6 |
| 207113_s_at | 106.7 | 125.3 | 144.2 | 76.38 | 156 | 171.3 | 70.82 | 124.9 | 133.5 | 100.9 | 154.1 | 136.5 | 159.3 |
| 207164_s_at | 546.8 | 719.6 | 694.4 | 919 | 521.1 | 553.1 | 1006 | 652 | 696.8 | 764.2 | 919.5 | 895.3 | 334.5 |
| 207233_s_at | 116.9 | 110.3 | 139.9 | 101.7 | 103.1 | 99.61 | 93.17 | 91.36 | 77.43 | 95.28 | 150.6 | 101.5 | 145.7 |
| 207416_s_at | 265.2 | 245.6 | 207.7 | 210.2 | 266.2 | 250.3 | 216.9 | 111.6 | 240.2 | 174.4 | 184.8 | 241.7 | 235.4 |
| 207513_s_at | 224.9 | 235.8 | 211.7 | 234.8 | 314.4 | 208.6 | 205.8 | 202.8 | 260.4 | 238.2 | 243.2 | 161.9 | 276.8 |
| 207543_s_at | 256.8 | 267.1 | 269.6 | 280 | 418.4 | 330.8 | 493 | 314.6 | 221.4 | 417.1 | 394.1 | 351.6 | 372.4 |
| 207564_x_at | 4098 | 3407 | 2885 | 2983 | 2398 | 2898 | 2301 | 2449 | 2144 | 3614 | 2420 | 3036 | 3071 |
| 207971_s_at | 85.32 | 72.57 | 61.73 | 67.8 | 70.96 | 70.17 | 50.31 | 67.98 | 80.07 | 56.08 | 55.08 | 73.3 | 51.74 |
| 208104_s_at | 413.2 | 491.1 | 563.9 | 544.1 | 670.7 | 615.3 | 669.2 | 492.6 | 520.2 | 531.3 | 633.8 | 625.2 | 470.6 |
| 208121_s_at | 145.3 | 121.5 | 64.63 | 102.6 | 163.8 | 89.74 | 63.43 | 65.79 | 65.56 | 77.24 | 150.4 | 135.5 | 226.8 |
| 208161_s_at | 27.75 | 55.04 | 124.6 | 42.08 | 104.8 | 35.97 | 34.26 | 21.4 | 65.97 | 63.9 | 147.5 | 45.55 | 163 |
| 208269_s_at | 109.8 | 104.4 | 130.2 | 113.1 | 91.34 | 88.6 | 95.81 | 104.4 | 107.3 | 94.84 | 111.8 | 103.5 | 98.14 |
| 208309_s_at | 424.5 | 323.3 | 335.6 | 251.6 | 271.7 | 283.3 | 187.4 | 199.8 | 241.7 | 264.2 | 264.2 | 295.5 | 281.3 |
| 208527_x_at | 202.7 | 409 | 361.2 | 447.1 | 422.4 | 301 | 533.6 | 624.4 | 568.3 | 407.4 | 542.5 | 524.6 | 630.3 |
| 208579_x_at | 337.5 | 826.7 | 713 | 757.3 | 831.6 | 437.5 | 860.2 | 1161 | 972.5 | 617.6 | 1124 | 875.6 | 1200 |
| 208635_x_at | 16253 | 14944 | 14365 | 12269 | 12964 | 12777 | 10610 | 9186 | 14121 | 14691 | 12166 | 13779 | 14085 |
| 208659_at | 6243 | 6330 | 6861 | 7075 | 7612 | 6793 | 7182 | 8290 | 7854 | 6879 | 7838 | 7496 | 7490 |
| 208680_at | 783.2 | 692 | 678.4 | 642.3 | 692.8 | 695.2 | 476 | 564.5 | 603.2 | 643 | 691.3 | 664.9 | 1331 |
| 208749_x_at | 1667 | 2062 | 2065 | 2989 | 3543 | 1973 | 2549 | 4574 | 2543 | 2460 | 2188 | 2573 | 1638 |
| 208771_s_at | 4712 | 6033 | 5192 | 7278 | 4463 | 4706 | 4823 | 6313 | 4603 | 6725 | 6023 | 5657 | 6168 |
| 208780_x_at | 2276 | 2267 | 2482 | 2814 | 2277 | 2434 | 3343 | 4219 | 2763 | 2544 | 3104 | 2788 | 2454 |
| 208798_x_at | 1843 | 1191 | 1181 | 623.5 | 917.5 | 1883 | 342 | 646.8 | 490.1 | 1482 | 788 | 840.3 | 1127 |
| 208805_at | 2022 | 1921 | 1990 | 1621 | 1901 | 1992 | 1661 | 1942 | 1933 | 1765 | 2091 | 1831 | 3964 |
| 208868_s_at | 470.8 | 831.6 | 771.3 | 934.1 | 583.1 | 884.4 | 1568 | 1039 | 928.6 | 862.8 | 852.5 | 887.4 | 404.9 |
| 208903_at | 51.35 | 46.15 | 44.31 | 43.9 | 62.06 | 42.57 | 42.5 | 17.08 | 49.9 | 67.98 | 53.17 | 48.46 | 37.51 |
| 208921_s_at | 1089 | 974.4 | 999.9 | 1030 | 1181 | 1214 | 1015 | 1259 | 1039 | 1337 | 1083 | 1241 | 1555 |
| 208923_at | 514.1 | 672.1 | 551 | 788.8 | 598 | 496.8 | 577.4 | 447 | 594.1 | 571.7 | 703.4 | 617.4 | 798.1 |
| 208946_s_at | 1447 | 1254 | 1327 | 1243 | 1538 | 1445 | 1628 | 1483 | 1454 | 1506 | 1587 | 1478 | 1606 |
| 208962_s_at | 74.87 | 65.84 | 95.51 | 83 | 115.9 | 64.66 | 105.4 | 49.13 | 86.18 | 88.77 | 90.45 | 135.3 | 119.4 |
| 209040_s_at | 1564 | 2169 | 1673 | 1549 | 1980 | 1608 | 1467 | 2086 | 1477 | 1793 | 2086 | 1803 | 2771 |
| 209067_s_at | 3390 | 2728 | 2348 | 1779 | 2210 | 2424 | 1475 | 1455 | 2013 | 2824 | 1894 | 2086 | 3094 |
| 209072_at | 40.86 | 77.18 | 90.87 | 128.5 | 121.8 | 113.9 | 139.5 | 90.06 | 49.82 | 77.42 | 99.97 | 260.7 | 41.35 |
| 209099_x_at | 101 | 123.5 | 134.8 | 153.1 | 96.23 | 79.56 | 139.2 | 102.3 | 103.9 | 135.1 | 162.7 | 136.8 | 153.3 |
| 209124_at | 4348 | 5720 | 4713 | 6157 | 5497 | 4440 | 5752 | 6477 | 5228 | 5428 | 5234 | 5606 | 5989 |
| 209180_at | 350.1 | 279.3 | 284.5 | 235.2 | 257.3 | 255 | 157.6 | 163.3 | 281 | 303.9 | 211.9 | 303 | 364.1 |
| 209191_at | 173.8 | 155.4 | 107.7 | 172.4 | 140.2 | 129 | 81.79 | 98.99 | 96.4 | 97.37 | 261.8 | 81.66 | 84.32 |
| 209212_s_at | 25.59 | 31.36 | 29.81 | 32.14 | 31.28 | 40.76 | 57.3 | 31.6 | 43.97 | 37.88 | 31.47 | 34.61 | 33.31 |
| 209218_at | 218.2 | 142.8 | 153.2 | 57.61 | 171.8 | 127.5 | 43.9 | 129.7 | 132.7 | 123.5 | 184 | 177 | 397.5 |
| 209236_at | 191.8 | 225.5 | 173.4 | 158.2 | 173.6 | 178 | 228 | 99.46 | 168.8 | 177.3 | 195.4 | 198.7 | 202.2 |
| 209251_x_at | 4661 | 5181 | 5618 | 4826 | 5976 | 5892 | 4784 | 6784 | 4841 | 5180 | 5179 | 5711 | 4389 |
| 209259_s_at | 603.7 | 551.5 | 497.7 | 382.5 | 470.9 | 516.8 | 490.5 | 405.6 | 446.8 | 605.7 | 593.6 | 564.3 | 555.2 |
| 209269_s_at | 444.5 | 616.5 | 619.7 | 767.1 | 612.3 | 574.3 | 846 | 469.1 | 556.7 | 691.7 | 801 | 647 | 407.4 |
| 209330_s_at | 2995 | 2432 | 2099 | 1602 | 2199 | 2042 | 1422 | 1253 | 2672 | 1871 | 2473 | 1816 | 2350 |
| 209339_at | 357.1 | 531.1 | 470.5 | 489.9 | 505.4 | 384.3 | 427.9 | 461.6 | 371.8 | 466.1 | 554.3 | 503.1 | 659.6 |
| 209430_at | 998.7 | 845.5 | 739.7 | 594.6 | 829.8 | 819.1 | 639.3 | 544.5 | 712 | 673.6 | 686.4 | 669.5 | 765.6 |
| 209675_s_at | 1028 | 1052 | 1113 | 965.1 | 1096 | 941.8 | 1089 | 857 | 1021 | 984.4 | 1074 | 1174 | 1034 |
| 209684_at | 318.1 | 396.8 | 268.3 | 368.7 | 427.8 | 318.1 | 315 | 338.7 | 334.2 | 302 | 535.8 | 322.7 | 807.9 |
| 209806_at | 1267 | 2634 | 2344 | 2312 | 2475 | 1322 | 2845 | 3552 | 2765 | 2213 | 3961 | 2710 | 3889 |
| 209840_s_at | 12.56 | 18.81 | 70.95 | 4.273 | 15.42 | 12.56 | 6.198 | 16.18 | 48.59 | 180.7 | 30.78 | 27.13 | 7.486 |
| 209870_s_at | 150.5 | 162.4 | 163.9 | 136.9 | 160.7 | 137.4 | 153.9 | 138.5 | 178.4 | 214.3 | 137.2 | 147.5 | 163.7 |
| 209892_at | 78.55 | 83.25 | 79.05 | 93.12 | 95.57 | 119.9 | 73.92 | 66.18 | 74.64 | 98.23 | 149.2 | 105.3 | 146.8 |
| 209906_at | 381.3 | 667.6 | 718.6 | 865 | 886.3 | 470.2 | 636 | 700 | 502.9 | 425.4 | 1459 | 1093 | 1721 |
| 210022_at | 160.4 | 180.7 | 179.6 | 200.1 | 197.7 | 170.6 | 182.8 | 199.2 | 211.6 | 162.1 | 181.9 | 176.3 | 176.3 |
| 210061_at | 118.5 | 78.25 | 142.6 | 100.8 | 59.18 | 78.18 | 100.5 | 79.28 | 87.68 | 100.4 | 108.3 | 118.3 | 96.3 |
| 210145_at | 58.27 | 95.64 | 61.83 | 65.94 | 69.8 | 61.28 | 112.6 | 74.32 | 83.94 | 68.08 | 134.9 | 73.87 | 139.7 |
| 210156_s_at | 967.4 | 1021 | 1075 | 1261 | 1028 | 967 | 1178 | 1114 | 1385 | 1180 | 1211 | 1269 | 1356 |
| 210166_at | 320.5 | 367.4 | 378.2 | 650.4 | 424.3 | 489.8 | 698.3 | 1596 | 550.1 | 791.1 | 484.3 | 543.4 | 375.6 |
| 210434_x_at | 2310 | 2707 | 2705 | 2326 | 2530 | 2674 | 2502 | 2372 | 2425 | 2551 | 2169 | 2910 | 2514 |
| 210644_s_at | 606.1 | 535.5 | 509.1 | 489.7 | 635.4 | 513.6 | 443.8 | 445.7 | 465.8 | 430.1 | 531 | 561.6 | 999.1 |
| 210648_x_at | 3579 | 3288 | 3985 | 3308 | 3300 | 3938 | 3977 | 5192 | 3428 | 3439 | 4510 | 4190 | 4572 |
| 210875_s_at | 149.3 | 175.7 | 247 | 208.6 | 173.9 | 195.4 | 235.9 | 210.2 | 232.3 | 229 | 406.9 | 275.2 | 107.4 |
| 211047_x_at | 1087 | 1157 | 1253 | 1058 | 1307 | 1231 | 957.9 | 897.9 | 1173 | 1010 | 1422 | 1209 | 1519 |
| 211058_x_at | 4559 | 5119 | 5226 | 4918 | 5717 | 5424 | 4548 | 6781 | 4615 | 5247 | 4408 | 5180 | 4506 |
| 211185_s_at | 8657 | 8264 | 7808 | 7011 | 7843 | 8135 | 7446 | 6981 | 7213 | 8002 | 7461 | 7477 | 7079 |
| 211272_s_at | 691.2 | 691.7 | 662.5 | 279.7 | 432.9 | 540.1 | 328.1 | 380.8 | 480.1 | 556.2 | 433.6 | 588.9 | 308.8 |
| 211323_s_at | 137.1 | 134.2 | 174.8 | 110.1 | 120.5 | 121.2 | 181.2 | 124.2 | 110.9 | 152 | 75.15 | 102.5 | 153.8 |
| 211383_s_at | 587.8 | 511.1 | 436.8 | 433.9 | 465.9 | 476.1 | 430.7 | 469.8 | 445.7 | 422.8 | 424.4 | 533 | 511.2 |
| 211429_s_at | 13733 | 15605 | 18045 | 19108 | 18850 | 18166 | 17479 | 20618 | 18245 | 15605 | 21374 | 17237 | 18328 |
| 211506_s_at | 193.9 | 727.7 | 668.4 | 527.1 | 578 | 551.8 | 664.2 | 106.4 | 1227 | 176.7 | 981.5 | 1452 | 413.7 |
| 211546_x_at | 226.2 | 158 | 305.6 | 310.9 | 226.9 | 184.3 | 193 | 193.2 | 229.7 | 187.3 | 364.6 | 185.5 | 270.5 |
| 211684_s_at | 647 | 555.9 | 560.1 | 443.1 | 558.5 | 597.6 | 418 | 484.7 | 473.1 | 551.2 | 597.6 | 613.5 | 1086 |
| 211729_x_at | 286.2 | 517.2 | 459.3 | 501.3 | 576.1 | 400.9 | 390 | 404.2 | 299.8 | 375.7 | 495.7 | 432.2 | 1028 |
| 211856_x_at | 132.4 | 69.35 | 52.26 | 18.88 | 51.57 | 69.55 | 43.84 | 60.06 | 69.29 | 55.54 | 55.51 | 64.42 | 17.7 |
| 211946_s_at | 5536 | 5047 | 3988 | 3707 | 4731 | 4590 | 3698 | 4418 | 4185 | 5207 | 3320 | 3539 | 5089 |
| 211965_at | 1525 | 1828 | 2610 | 2121 | 3146 | 2255 | 2118 | 3651 | 2058 | 2441 | 2487 | 2702 | 867.9 |
| 212030_at | 1084 | 1396 | 1092 | 911.1 | 861.1 | 1026 | 829.5 | 910.7 | 996.3 | 1181 | 898.6 | 898.1 | 1097 |
| 212042_x_at | 25758 | 22695 | 20521 | 19059 | 22459 | 22279 | 15211 | 16116 | 23531 | 25546 | 20974 | 21905 | 20626 |
| 212132_at | 3057 | 3038 | 2860 | 2322 | 2858 | 2472 | 2411 | 2554 | 2869 | 2912 | 2795 | 2662 | 2726 |
| 212213_x_at | 221.6 | 208.3 | 184.7 | 133.9 | 242.3 | 215.6 | 168.3 | 138.7 | 135.4 | 200.8 | 239.8 | 204.7 | 283.2 |
| 212299_at | 334.2 | 367 | 283.2 | 265.2 | 322.8 | 349.5 | 294.1 | 362.1 | 260.3 | 293.7 | 274.4 | 417 | 379.4 |
| 212331_at | 3491 | 3411 | 2905 | 2746 | 2492 | 3168 | 2969 | 2527 | 2752 | 2686 | 3217 | 2792 | 2929 |
| 212334_at | 1637 | 2134 | 2096 | 3026 | 2917 | 2000 | 2914 | 2684 | 2728 | 2249 | 2819 | 2363 | 3084 |
| 212406_s_at | 1390 | 1024 | 1015 | 676.5 | 1129 | 1256 | 1031 | 825.3 | 1162 | 1219 | 950.6 | 1031 | 878.3 |
| 212455_at | 3349 | 3649 | 3176 | 3139 | 3159 | 3160 | 2703 | 2958 | 3149 | 3416 | 2896 | 3004 | 2834 |
| 212543_at | 1399 | 1505 | 1130 | 1264 | 1217 | 1504 | 1090 | 1194 | 1240 | 1450 | 1331 | 1347 | 1270 |
| 212658_at | 53.73 | 151.4 | 110.8 | 125.5 | 134.9 | 82.45 | 90.82 | 142.6 | 95.64 | 100.8 | 165.7 | 99.07 | 478.6 |
| 212663_at | 1196 | 1175 | 1215 | 1394 | 1391 | 1184 | 1110 | 1369 | 1275 | 1345 | 1211 | 1352 | 1590 |
| 212769_at | 251.7 | 392.1 | 423.4 | 516.4 | 748.7 | 516.6 | 545.3 | 913.4 | 528.5 | 407.7 | 580.9 | 458.2 | 107.9 |
| 212820_at | 2325 | 2826 | 2477 | 2679 | 1784 | 2341 | 2219 | 1660 | 2001 | 1947 | 3119 | 2005 | 4134 |
| 212932_at | 124 | 149.6 | 154.3 | 120.4 | 140.8 | 116.5 | 124.2 | 126.8 | 171 | 139.3 | 152.6 | 161.6 | 118.5 |
| 212989_at | 391.5 | 407 | 304.1 | 461.2 | 410.3 | 372.1 | 590.3 | 411.9 | 450.4 | 421.2 | 792.5 | 498.3 | 501.6 |
| 212997_s_at | 551.4 | 656.5 | 566.2 | 738.5 | 704.3 | 576.8 | 637.6 | 661.9 | 750.4 | 640.9 | 586.6 | 678.5 | 521.2 |
| 213021_at | 236.5 | 230.6 | 239 | 241.8 | 230.7 | 205.2 | 227.3 | 207.5 | 253.2 | 230.6 | 206.8 | 217.2 | 233.5 |
| 213152_s_at | 674.6 | 416 | 448.5 | 270.1 | 415.5 | 512.8 | 193.1 | 299.6 | 352.8 | 574.9 | 372.9 | 288.8 | 468.5 |
| 213205_s_at | 146.6 | 114.7 | 109.7 | 120.4 | 151 | 122.9 | 97.54 | 75.15 | 108.1 | 111.1 | 94.11 | 112.1 | 124.6 |
| 213218_at | 78.42 | 97 | 88.44 | 75.79 | 71.02 | 66.88 | 60.3 | 44.75 | 104.4 | 80.78 | 101.2 | 67.52 | 79 |
| 213266_at | 75.76 | 83.23 | 81.62 | 62.33 | 72.2 | 97.33 | 73.76 | 59.05 | 71.17 | 107.4 | 73.4 | 66.95 | 66.75 |
| 213302_at | 32.2 | 30.71 | 29.76 | 20.21 | 24.97 | 23.87 | 19.37 | 23.2 | 23.76 | 34.43 | 27.01 | 31.72 | 22.33 |
| 213335_s_at | 28.81 | 40.23 | 34.3 | 42.52 | 26 | 22.56 | 51.29 | 32.87 | 44.02 | 38.06 | 42.94 | 43.22 | 36.68 |
| 213397_x_at | 96.38 | 89.54 | 118.3 | 160.5 | 90.61 | 50.4 | 195 | 66.54 | 99.09 | 102.5 | 186.4 | 195.1 | 111.4 |
| 213459_at | 109.7 | 111.4 | 86.18 | 47.16 | 45.34 | 80.95 | 66.46 | 43.32 | 78 | 104.7 | 74.6 | 80.52 | 78.55 |
| 213494_s_at | 52.95 | 81.64 | 57.32 | 50.83 | 50.4 | 65.21 | 41.45 | 69.39 | 60.61 | 76.35 | 43.26 | 56.07 | 48.89 |
| 213540_at | 61.49 | 53.95 | 53.57 | 46.1 | 56.92 | 55.75 | 47.23 | 54.07 | 55.05 | 61.52 | 46.48 | 53.2 | 48.33 |
| 213693_s_at | 44.9 | 36.75 | 36.28 | 39.59 | 45.22 | 35.31 | 38.71 | 39.66 | 37.44 | 36.42 | 47.62 | 43.99 | 50.73 |
| 213827_at | 38.03 | 50.91 | 51.09 | 54.52 | 66.9 | 45.75 | 53.81 | 53.4 | 71.7 | 80.33 | 64.28 | 58.47 | 66.92 |
| 213877_x_at | 95.79 | 81.99 | 76.9 | 93.26 | 118.7 | 90.55 | 92.08 | 95.74 | 92.99 | 84.53 | 108 | 91.61 | 88.25 |
| 214045_at | 91.92 | 42.05 | 70.32 | 42.32 | 32.37 | 75.82 | 62.56 | 43.93 | 44.76 | 40.41 | 32.04 | 43.05 | 46.81 |
| 214057_at | 196.8 | 277.8 | 245.6 | 309.8 | 278.4 | 299.9 | 244.5 | 346.6 | 316.7 | 305.8 | 260.5 | 289.6 | 230.6 |
| 214330_at | 37.03 | 56.8 | 41.56 | 46.11 | 34.57 | 38.27 | 33.4 | 26.43 | 36.99 | 30.03 | 34.12 | 25.93 | 27.1 |
| 214364_at | 94.15 | 110 | 85.53 | 75.45 | 108.3 | 80.97 | 74.33 | 76.75 | 119.9 | 61.11 | 83.56 | 72.51 | 54.17 |
| 214430_at | 330.7 | 386.4 | 455.5 | 417.1 | 391.6 | 410.2 | 420.5 | 293.7 | 424.1 | 436.7 | 487.7 | 473.6 | 605.6 |
| 214511_x_at | 506.4 | 1583 | 1288 | 936.9 | 1683 | 912.7 | 649.9 | 4153 | 807.8 | 1549 | 1429 | 1007 | 4578 |
| 214629_x_at | 5751 | 5992 | 6094 | 5907 | 6335 | 6370 | 6800 | 7184 | 5834 | 7238 | 6198 | 6737 | 7238 |
| 214683_s_at | 3451 | 3735 | 3413 | 3142 | 3296 | 3964 | 3353 | 3638 | 3146 | 4036 | 3839 | 3532 | 2930 |
| 214820_at | 136 | 92.59 | 102.8 | 67.62 | 81.42 | 91.45 | 90.45 | 65.94 | 95.81 | 93.32 | 95.04 | 83.47 | 93.69 |
| 214853_s_at | 407.4 | 441.1 | 405.4 | 375.2 | 585.5 | 489.1 | 382.4 | 425.2 | 455 | 354.6 | 469.5 | 495.1 | 539.3 |
| 214931_s_at | 271.1 | 345.5 | 371.7 | 524 | 334.9 | 369.6 | 548.7 | 303.1 | 432.1 | 506.6 | 533.7 | 436.8 | 163.6 |
| 214953_s_at | 210.6 | 145.8 | 299.7 | 158.3 | 117.4 | 140.2 | 207 | 225.6 | 200.2 | 317.3 | 362.2 | 214.3 | 270.8 |
| 215009_s_at | 578.5 | 484.3 | 489.7 | 290.7 | 429.8 | 490.6 | 232.2 | 267.9 | 393.5 | 465.3 | 403.1 | 382.7 | 422.4 |
| 215049_x_at | 358.6 | 446.8 | 375.2 | 831.8 | 569.2 | 340.7 | 955.5 | 767.2 | 506.1 | 422.4 | 635.6 | 580.8 | 630.9 |
| 215273_s_at | 523.7 | 547.4 | 535.6 | 532.9 | 617.4 | 492.5 | 523.9 | 702 | 696.5 | 575.9 | 588.5 | 594.9 | 710 |
| 215293_s_at | 50.91 | 42.41 | 64.36 | 74.67 | 109.1 | 77.86 | 59.16 | 50.35 | 75.07 | 92.01 | 69.51 | 62.45 | 64.36 |
| 215567_at | 151.9 | 116 | 113.7 | 57.79 | 85.77 | 87.8 | 79.42 | 68.6 | 125.7 | 123.4 | 67.65 | 85.48 | 96.81 |
| 215997_s_at | 402.3 | 311 | 335.6 | 385.1 | 285.9 | 349.6 | 558.5 | 385.8 | 410 | 401.2 | 402.7 | 409.4 | 195.9 |
| 216484_x_at | 386.5 | 356.9 | 413.6 | 354.2 | 424.9 | 403.3 | 403.4 | 341.8 | 359.4 | 476.5 | 504 | 455 | 522.7 |
| 216950_s_at | 215.9 | 716.1 | 546 | 521.2 | 967 | 393.9 | 310.9 | 2240 | 509.5 | 997.9 | 676 | 418.2 | 2789 |
| 217383_at | 21.5 | 42.09 | 29.54 | 32.45 | 32.04 | 30.9 | 22.98 | 53.29 | 32.7 | 43.07 | 43.08 | 37.69 | 34.18 |
| 217403_s_at | 97.87 | 104.5 | 87.68 | 67.81 | 98.33 | 97.14 | 63.53 | 82.43 | 94.87 | 94.02 | 83.89 | 92.72 | 89.37 |
| 217466_x_at | 3152 | 2782 | 2786 | 2383 | 3099 | 2638 | 1558 | 1919 | 2940 | 2779 | 2543 | 2408 | 1965 |
| 217769_s_at | 1243 | 1358 | 1239 | 1096 | 1336 | 1278 | 1244 | 1446 | 1117 | 1268 | 1429 | 1373 | 2609 |
| 217778_at | 206.8 | 203.1 | 207.6 | 258.1 | 238.1 | 213.7 | 219.4 | 304.2 | 276.8 | 306.4 | 317.6 | 229.6 | 177.2 |
| 217824_at | 276.2 | 303.4 | 267.8 | 249.3 | 455.1 | 301.3 | 287 | 511.4 | 245.3 | 338.6 | 342.1 | 348.3 | 231.7 |
| 217987_at | 527 | 738.8 | 568.1 | 337.9 | 599.2 | 552.6 | 818 | 202.5 | 944.6 | 634.6 | 309.7 | 545.3 | 370.4 |
| 217995_at | 1178 | 1775 | 1461 | 1780 | 1695 | 1488 | 1839 | 2094 | 1825 | 1826 | 1828 | 1709 | 2728 |
| 218012_at | 220 | 200 | 219.3 | 122.5 | 260.2 | 191.2 | 163.3 | 164.2 | 220.2 | 251.8 | 137.3 | 187.9 | 233.8 |
| 218040_at | 375.8 | 343.6 | 330.6 | 280.8 | 334.8 | 344.7 | 328.9 | 324.4 | 302.5 | 296.2 | 336.7 | 297.2 | 344 |
| 218065_s_at | 1079 | 967.9 | 1054 | 908.6 | 880.4 | 977.3 | 859.9 | 887 | 984.6 | 927.7 | 1019 | 1199 | 1169 |
| 218091_at | 495.5 | 505.8 | 398.2 | 453.4 | 596.9 | 517.3 | 832 | 797.4 | 608.5 | 507.6 | 524.6 | 561.6 | 508.4 |
| 218125_s_at | 66.49 | 59.45 | 51.26 | 38.37 | 60.16 | 66.39 | 56.09 | 50.08 | 49 | 59.39 | 57.57 | 60.94 | 60.05 |
| 218127_at | 233.2 | 212.9 | 215 | 217.3 | 281.3 | 209.8 | 166.4 | 226.3 | 246.7 | 233.8 | 225.1 | 227.6 | 203.1 |
| 218143_s_at | 637.8 | 692 | 730.4 | 500.9 | 771.5 | 673.7 | 467.7 | 562.5 | 606.8 | 588.9 | 506.4 | 631.4 | 731.6 |
| 218206_x_at | 330.2 | 348.7 | 360.2 | 354.3 | 444 | 391.9 | 346.4 | 331.6 | 377.7 | 321.4 | 419 | 365 | 541.7 |
| 218289_s_at | 103.1 | 85.55 | 89.53 | 68.25 | 81.48 | 92.83 | 33.25 | 57.95 | 48.69 | 106.4 | 86.14 | 77.22 | 119.5 |
| 218325_s_at | 357.8 | 393.8 | 325.4 | 270.4 | 343.6 | 400.6 | 223.6 | 271.3 | 291.9 | 334.4 | 314.4 | 359 | 336.4 |
| 218351_at | 1101 | 1024 | 1110 | 1020 | 890.7 | 1151 | 903.7 | 984.4 | 1037 | 1096 | 1192 | 1131 | 1267 |
| 218499_at | 2219 | 2226 | 2142 | 1794 | 2566 | 2167 | 1762 | 1837 | 2325 | 1925 | 2382 | 1881 | 2548 |
| 218627_at | 584.1 | 194 | 350.4 | 463.4 | 377.5 | 316.8 | 591.3 | 336.7 | 336.2 | 353.1 | 589.5 | 613 | 512.8 |
| 218718_at | 27.12 | 204 | 179.7 | 132 | 176.9 | 136.5 | 111.9 | 64.84 | 173.1 | 84.38 | 311.5 | 105.9 | 113.8 |
| 218732_at | 193.6 | 252.4 | 219.8 | 198.8 | 252 | 209.5 | 264.7 | 196.6 | 229.3 | 199.8 | 220.9 | 254 | 231.1 |
| 218845_at | 945 | 969.8 | 972.1 | 1032 | 1153 | 936.9 | 954.9 | 881.5 | 1027 | 1026 | 1025 | 1094 | 962.4 |
| 218962_s_at | 584.4 | 435.3 | 460 | 362.3 | 439.8 | 447.1 | 328.3 | 367.2 | 367.9 | 391.6 | 364.9 | 367.6 | 386.3 |
| 219130_at | 463.8 | 277.1 | 233 | 180.2 | 236 | 343.9 | 161.4 | 197.1 | 192.1 | 252.3 | 195.6 | 183.7 | 266.3 |
| 219316_s_at | 66.84 | 113.5 | 62.02 | 113.9 | 149.2 | 55.6 | 92.33 | 105 | 64.66 | 97.1 | 85.1 | 76.81 | 250.1 |
| 219343_at | 162.9 | 164.4 | 135.5 | 107.4 | 139.1 | 169.5 | 119 | 120.9 | 168.9 | 167.4 | 134 | 172.2 | 180.9 |
| 219358_s_at | 198.1 | 159.7 | 137.5 | 221.9 | 236.3 | 156.8 | 204.2 | 158 | 197.3 | 152.8 | 209.7 | 173.5 | 374.2 |
| 219418_at | 106.4 | 88.44 | 106.3 | 77.56 | 91.34 | 110.7 | 71.96 | 73.84 | 74.41 | 118.4 | 79.21 | 105.3 | 108 |
| 219507_at | 110.4 | 110.9 | 99.69 | 71.52 | 83.25 | 71.75 | 81.62 | 83.15 | 59.16 | 142 | 57.03 | 77.82 | 103.8 |
| 219765_at | 63.08 | 58.85 | 51.81 | 50.54 | 66.03 | 50.29 | 29.5 | 49.34 | 47.07 | 64.38 | 47.36 | 46.98 | 35.89 |
| 219787_s_at | 54 | 55.18 | 62.67 | 36.23 | 50.29 | 109.3 | 47.63 | 118.8 | 48.77 | 62.84 | 65.93 | 58.83 | 52.28 |
| 219822_at | 188.7 | 150.9 | 147 | 122.3 | 116.4 | 135.7 | 122.7 | 95.81 | 155.3 | 161.6 | 141.6 | 133.9 | 160.7 |
| 219826_at | 24.59 | 38.49 | 33.43 | 26.79 | 49 | 44.09 | 20.44 | 25.91 | 41.09 | 41.11 | 34.38 | 44.1 | 35.17 |
| 219952_s_at | 134 | 206.6 | 205.9 | 267.8 | 252.2 | 184.7 | 303 | 260.4 | 193.4 | 120.4 | 272.9 | 208.7 | 268 |
| 220044_x_at | 5315 | 4691 | 4553 | 3646 | 4176 | 4566 | 3026 | 3145 | 3858 | 4889 | 3868 | 4201 | 4170 |
| 220146_at | 146.5 | 123.3 | 109 | 115.8 | 160.8 | 99.83 | 110.5 | 78.02 | 120.4 | 147.9 | 168 | 171.6 | 348.7 |
| 220160_s_at | 75.72 | 66.32 | 62.97 | 49.52 | 63.51 | 62.13 | 64.18 | 95.55 | 61.35 | 62.58 | 92.06 | 62.87 | 126.6 |
| 220386_s_at | 570.9 | 591.5 | 620.6 | 356.8 | 434 | 460 | 335.5 | 508.4 | 440.3 | 492.8 | 431.5 | 571.1 | 520.3 |
| 220578_at | 76.57 | 81.85 | 76.89 | 130.7 | 150 | 99.36 | 73.13 | 85.69 | 74.16 | 68.41 | 59.24 | 55.13 | 146.8 |
| 220605_s_at | 149.8 | 172.8 | 158.7 | 158.6 | 193.1 | 184.3 | 152.7 | 147.7 | 168.2 | 173.7 | 180.8 | 173.3 | 211.3 |
| 220610_s_at | 91 | 98.41 | 114.4 | 118.2 | 122.2 | 112.6 | 153.4 | 167.5 | 119 | 108.3 | 145 | 125 | 161.4 |
| 220690_s_at | 91.7 | 110.6 | 118 | 144.6 | 138.3 | 97.69 | 173.4 | 141.7 | 135.7 | 111.5 | 139.2 | 124.1 | 119.1 |
| 220750_s_at | 83.11 | 98.76 | 94.84 | 61.72 | 93.98 | 107.8 | 92.53 | 80.92 | 85.37 | 73.4 | 81.62 | 82.74 | 110 |
| 220865_s_at | 64.6 | 85.91 | 92.88 | 94.13 | 89.11 | 70.75 | 88.29 | 225 | 89.25 | 137.4 | 105.4 | 101.6 | 99.56 |
| 220974_x_at | 208.6 | 170.4 | 225.2 | 214.1 | 210.3 | 256.9 | 154.3 | 116.6 | 199.3 | 185.1 | 242.2 | 264.6 | 258.4 |
| 221011_s_at | 1077 | 695.8 | 643.2 | 449.3 | 656.3 | 883.2 | 269.4 | 455.2 | 645.4 | 1111 | 452.4 | 586.1 | 600.9 |
| 221206_at | 194.7 | 183.2 | 179.1 | 137.3 | 142.3 | 176.9 | 149.6 | 117.5 | 128.4 | 170.9 | 135.7 | 145.6 | 144.6 |
| 221264_s_at | 437 | 564.8 | 482.9 | 330.3 | 363.3 | 466.1 | 309.1 | 296.4 | 333.3 | 426 | 337 | 375.7 | 372.6 |
| 221428_s_at | 948.5 | 788.2 | 792.7 | 764.2 | 845.6 | 693.3 | 702.4 | 696.3 | 823.3 | 1008 | 994.2 | 921.7 | 619 |
| 221449_s_at | 300.3 | 335.6 | 394.5 | 304.3 | 348.1 | 359.4 | 328.1 | 311.5 | 384.5 | 364.4 | 462.2 | 367.1 | 609.3 |
| 221580_s_at | 1300 | 1178 | 1051 | 861.2 | 936.1 | 1135 | 906.1 | 820.6 | 952.5 | 968.9 | 964.7 | 976.9 | 957.3 |
| 221601_s_at | 2877 | 1724 | 2044 | 739.8 | 1731 | 2004 | 578.8 | 952.1 | 1416 | 2166 | 1144 | 1362 | 1554 |
| 221647_s_at | 487.1 | 544.5 | 461.5 | 372.9 | 501.4 | 510.4 | 519.7 | 456.8 | 440.4 | 411 | 462.7 | 574.8 | 518.6 |
| 221731_x_at | 7388 | 7843 | 6711 | 10241 | 7812 | 7007 | 9219 | 7781 | 7370 | 6336 | 6773 | 7832 | 9111 |
| 221757_at | 545.6 | 470.9 | 481.4 | 196.5 | 387.6 | 473.1 | 274.6 | 375.6 | 499.3 | 412.7 | 266.1 | 386.3 | 248.4 |
| 221841_s_at | 1022 | 1464 | 1127 | 1037 | 1339 | 1016 | 936.7 | 1029 | 1088 | 1152 | 1347 | 1416 | 2100 |
| 221868_at | 31.15 | 31.37 | 42.09 | 33.05 | 32.03 | 30.64 | 25.07 | 32.36 | 34.12 | 31.42 | 25.46 | 31.52 | 31.6 |
| 221960_s_at | 54.87 | 70.39 | 81.98 | 80.29 | 87.54 | 62.07 | 51.71 | 113.3 | 97.08 | 94.35 | 86.06 | 85.1 | 59.88 |
| 222217_s_at | 298.6 | 334.7 | 283.4 | 300.9 | 437.2 | 384.5 | 290.4 | 232.8 | 319.3 | 177.8 | 388 | 386.2 | 727.7 |
| 222231_s_at | 281.9 | 332.1 | 286.8 | 250.2 | 351.2 | 260.6 | 280.9 | 246 | 296.5 | 240.7 | 421.3 | 395 | 455.3 |
| 222574_s_at | 476.5 | 541.4 | 566.7 | 556.4 | 458.7 | 476.8 | 497.6 | 420.9 | 573.6 | 508.7 | 433.3 | 527.4 | 347.2 |
| 222605_at | 667.5 | 750.8 | 713.8 | 654.1 | 756.4 | 686.8 | 587.8 | 534.6 | 679.2 | 584.7 | 661.5 | 735.2 | 684.7 |
| 222651_s_at | 289.4 | 299.5 | 209.4 | 279.3 | 368.4 | 303.7 | 263.6 | 299.5 | 308.9 | 357.2 | 274.3 | 286.7 | 300.5 |
| 222670_s_at | 570.7 | 656.3 | 604.3 | 815.3 | 1076 | 418.1 | 544.2 | 887.4 | 576.2 | 447.3 | 588.6 | 664.8 | 1489 |
| 222688_at | 284.4 | 278.8 | 339.8 | 320.2 | 316.5 | 204.5 | 307.9 | 329.2 | 372.4 | 233.6 | 280.3 | 223.5 | 390.9 |
| 222700_at | 548.6 | 555.1 | 547.9 | 453 | 420.1 | 502 | 421.8 | 409.2 | 490.5 | 511.5 | 444.4 | 511.3 | 441.2 |
| 222753_s_at | 171.5 | 204.8 | 217.4 | 174.5 | 200.2 | 174 | 261.3 | 251.1 | 205.3 | 247.1 | 274.2 | 210.4 | 224.8 |
| 222757_s_at | 95.34 | 76.72 | 86.23 | 118.6 | 99.03 | 126.4 | 102 | 171.4 | 78.76 | 147.4 | 105.6 | 120.6 | 89.67 |
| 222774_s_at | 44.32 | 47.66 | 43.72 | 50.19 | 50.77 | 39.99 | 98.64 | 29.4 | 52.79 | 40.84 | 61.74 | 63.91 | 55.23 |
| 222884_at | 96.57 | 90.27 | 84.05 | 76.87 | 124.1 | 102.4 | 90.71 | 106.1 | 77.39 | 100.6 | 108.2 | 100.1 | 113.9 |
| 222980_at | 2268 | 2203 | 2224 | 2211 | 2395 | 2406 | 2252 | 2394 | 2132 | 2109 | 3291 | 2588 | 3035 |
| 222982_x_at | 3888 | 4322 | 3687 | 4045 | 4733 | 4044 | 4846 | 4966 | 3819 | 5201 | 4387 | 4854 | 4642 |
| 223023_at | 339.5 | 320 | 283.6 | 275.6 | 320.3 | 287.1 | 247.8 | 217.9 | 244.4 | 215.8 | 202.2 | 322 | 282.4 |
| 223064_at | 1262 | 1283 | 1398 | 1309 | 1452 | 1360 | 1464 | 1316 | 1404 | 1213 | 1430 | 1505 | 1677 |
| 223158_s_at | 115.7 | 111.2 | 110.5 | 167.8 | 163 | 136.8 | 174.6 | 111.1 | 115.1 | 148.3 | 149.9 | 176.8 | 112.8 |
| 223380_s_at | 237 | 368.6 | 372.9 | 352.3 | 325.7 | 298.4 | 494.4 | 399.3 | 371.4 | 372 | 244.4 | 299.6 | 592.2 |
| 223444_at | 718.7 | 756.1 | 773.3 | 637.1 | 755.2 | 779.7 | 834.4 | 788.2 | 534.6 | 618.2 | 772.8 | 782.8 | 605.9 |
| 223465_at | 451.3 | 449.3 | 458 | 471.2 | 439.3 | 555 | 626.6 | 590.6 | 510.4 | 578 | 548.6 | 431.9 | 395.2 |
| 223590_at | 521.5 | 363.8 | 348.7 | 338.8 | 352.1 | 403 | 294.6 | 286.8 | 377.9 | 408.3 | 334.8 | 347.7 | 350.9 |
| 223686_at | 193.9 | 239.2 | 201.9 | 244 | 280.1 | 215 | 190.9 | 249.7 | 279.6 | 290.4 | 271.1 | 213.2 | 165.4 |
| 223801_s_at | 39.58 | 46.37 | 31.66 | 37.68 | 32.56 | 31.51 | 36.05 | 34.93 | 36.87 | 30.13 | 33.05 | 30.76 | 53.45 |
| 223922_x_at | 1571 | 1844 | 2143 | 2436 | 2121 | 2071 | 2552 | 2078 | 1924 | 1840 | 2569 | 2613 | 3317 |
| 223982_s_at | 1082 | 1016 | 1059 | 945.6 | 960.9 | 1022 | 1171 | 1125 | 1076 | 903.4 | 1133 | 929.7 | 1124 |
| 224046_s_at | 502 | 378.3 | 438.7 | 350.3 | 254.1 | 315 | 243.2 | 313.6 | 273.1 | 401.1 | 341.5 | 414.9 | 281.8 |
| 224374_s_at | 456.2 | 447.8 | 424.9 | 711.1 | 657.5 | 479.1 | 511.1 | 734.2 | 559.3 | 392.2 | 582.4 | 512.9 | 679.7 |
| 224387_at | 69.29 | 63.69 | 73.45 | 80.49 | 86.96 | 76.21 | 77.5 | 77.83 | 98.79 | 70.74 | 95.02 | 71.82 | 118.7 |
| 224439_x_at | 393.1 | 481.2 | 490 | 379.6 | 382.1 | 438.4 | 401.5 | 427.5 | 442 | 363.5 | 487.3 | 439 | 588 |
| 224518_s_at | 364.9 | 296.8 | 235.1 | 236.6 | 277.5 | 313.9 | 188 | 200.9 | 236.4 | 260.6 | 152.5 | 180.3 | 190.7 |
| 224582_s_at | 405.1 | 265.5 | 272.9 | 229.5 | 314.1 | 297.8 | 139.8 | 155.1 | 230 | 244 | 237 | 252.6 | 326.9 |
| 224591_at | 2937 | 2858 | 2581 | 2460 | 2952 | 2705 | 1989 | 1867 | 2747 | 2943 | 2552 | 2809 | 2417 |
| 224726_at | 250.4 | 241.9 | 209.2 | 182.2 | 145 | 183.6 | 223.1 | 205.6 | 169.4 | 262.9 | 99.05 | 148.3 | 148.7 |
| 224818_at | 506.9 | 858.7 | 680.5 | 826.1 | 865.7 | 652 | 654.1 | 971.2 | 748 | 476.5 | 959.8 | 820.7 | 1324 |
| 224917_at | 2219 | 2486 | 2294 | 2925 | 2495 | 2396 | 3203 | 3052 | 2464 | 2616 | 2782 | 2729 | 4405 |
| 224918_x_at | 321.7 | 451 | 544.8 | 614.4 | 471.5 | 396.4 | 650.8 | 327.2 | 565.8 | 483.3 | 737.2 | 678 | 711.7 |
| 224928_at | 251.9 | 265.7 | 256.2 | 268.7 | 275.1 | 274.2 | 335.6 | 205.9 | 297.6 | 250.3 | 331 | 307.5 | 304.9 |
| 225059_at | 872.7 | 1295 | 1421 | 1624 | 1720 | 1354 | 2003 | 1227 | 1670 | 1857 | 1516 | 1672 | 1448 |
| 225064_at | 559 | 303.2 | 403.4 | 313.6 | 337.5 | 285.1 | 290.8 | 341.2 | 333.3 | 374.3 | 339.5 | 450.3 | 401.1 |
| 225107_at | 2764 | 3027 | 2443 | 1852 | 2068 | 2317 | 1619 | 1682 | 1850 | 2380 | 1978 | 2204 | 2826 |
| 225188_at | 58.24 | 71.7 | 37.5 | 40.18 | 99.69 | 20.07 | 43.02 | 58.93 | 73.01 | 49.63 | 39.13 | 54.08 | 30.78 |
| 225341_at | 75.61 | 38.51 | 62.72 | 40.91 | 34.59 | 58.46 | 31.91 | 20.7 | 49.64 | 56.41 | 35.3 | 49.72 | 29.73 |
| 225358_at | 110.8 | 98.04 | 96.53 | 76.68 | 89.47 | 93.1 | 59.96 | 69.18 | 90.79 | 75.54 | 77.72 | 76.29 | 110.6 |
| 225365_at | 2806 | 1988 | 2146 | 2497 | 2940 | 2300 | 2310 | 2534 | 2631 | 2739 | 2476 | 2425 | 4405 |
| 225388_at | 45.99 | 33.24 | 38.88 | 57.52 | 51.55 | 51.28 | 28.85 | 38.79 | 39.75 | 42.55 | 38.66 | 32.68 | 36.03 |
| 225456_at | 293.2 | 303.1 | 267.1 | 259.4 | 386.4 | 332.5 | 285.5 | 278.8 | 309 | 323.4 | 284.4 | 268.3 | 342.3 |
| 225763_at | 2934 | 2518 | 2706 | 3142 | 2973 | 2788 | 3297 | 2433 | 2745 | 2385 | 3354 | 3205 | 3140 |
| 225844_at | 200.7 | 161.3 | 194.2 | 211.2 | 219.9 | 208.1 | 215.8 | 196.8 | 209 | 221.1 | 214.8 | 211.8 | 279.9 |
| 225866_at | 126.9 | 97.75 | 96.62 | 60.19 | 97.89 | 79.03 | 62.62 | 76.5 | 100 | 119.2 | 91.99 | 88.48 | 102.5 |
| 225870_s_at | 620.6 | 711.6 | 887.2 | 653.1 | 737.5 | 677.4 | 834.4 | 811 | 870.3 | 524.9 | 865 | 695.2 | 689.1 |
| 226000_at | 25.59 | 39.93 | 26.53 | 34.97 | 24.86 | 33.01 | 28.55 | 21.45 | 22.49 | 22.26 | 40.79 | 32.24 | 28.62 |
| 226030_at | 128.4 | 102.4 | 101.9 | 87.46 | 92.24 | 99.75 | 72.1 | 73.82 | 85.62 | 124.9 | 69.38 | 85.02 | 99.03 |
| 226042_at | 77.77 | 85.2 | 81.66 | 103.4 | 101.8 | 85.57 | 77.06 | 81.5 | 87.94 | 102.5 | 82.53 | 85.6 | 86.28 |
| 226059_at | 37.45 | 37.99 | 35.11 | 53.4 | 47.92 | 53.92 | 45.84 | 54.44 | 51.52 | 66.26 | 65.75 | 63.36 | 112.3 |
| 226115_at | 243.5 | 322.9 | 284.1 | 260.9 | 350.8 | 292.2 | 242.8 | 309.4 | 390.5 | 221.5 | 353.8 | 259.4 | 145.4 |
| 226127_at | 86.35 | 83 | 86.18 | 64.08 | 87.54 | 87.54 | 77.62 | 78.97 | 78.43 | 85.96 | 73.45 | 86.58 | 103.7 |
| 226218_at | 7018 | 4435 | 4026 | 2269 | 4427 | 4684 | 1664 | 3628 | 3477 | 6510 | 1889 | 3472 | 1940 |
| 226220_at | 85.38 | 132.5 | 88.34 | 96.3 | 106.8 | 110.1 | 68.31 | 242.7 | 181.7 | 159.7 | 126 | 175.7 | 101 |
| 226323_at | 472.9 | 520.6 | 592.8 | 521.8 | 543 | 489.6 | 469.4 | 441.2 | 664.9 | 566.3 | 492.6 | 518.3 | 525.8 |
| 226353_at | 1112 | 1030 | 1045 | 1081 | 1049 | 1038 | 1049 | 994.4 | 1216 | 1101 | 1242 | 1199 | 1571 |
| 226428_at | 173.1 | 211.4 | 204.5 | 199.3 | 213.8 | 193.9 | 162.9 | 175.2 | 207 | 150.2 | 191.4 | 185 | 186.1 |
| 226459_at | 1670 | 2357 | 2056 | 2156 | 2597 | 2315 | 2314 | 3566 | 2333 | 2332 | 2304 | 2436 | 3595 |
| 226503_at | 299.1 | 222.2 | 195.3 | 167.5 | 235.7 | 243.2 | 141.1 | 250.3 | 216.3 | 180.5 | 211.7 | 174.6 | 225.1 |
| 226683_at | 2858 | 2368 | 2065 | 2007 | 3364 | 2587 | 2444 | 2930 | 3300 | 3108 | 3397 | 2410 | 1655 |
| 226718_at | 73.62 | 89.11 | 62.47 | 60.09 | 58.63 | 67.58 | 61.91 | 81.35 | 67.17 | 82.06 | 71.21 | 73.2 | 69.53 |
| 226763_at | 174.5 | 254.8 | 217.6 | 158 | 201 | 172.6 | 166.5 | 154.4 | 133.8 | 336.9 | 151.7 | 111.3 | 473.1 |
| 226836_at | 32.28 | 35.05 | 34.79 | 37.35 | 40.62 | 32.82 | 36.68 | 40.46 | 40.02 | 38.25 | 37.48 | 35.08 | 49.45 |
| 227020_at | 667.5 | 839 | 793.1 | 778.9 | 802.4 | 743 | 808.9 | 592.9 | 682.5 | 668.6 | 784.8 | 837.7 | 861.9 |
| 227114_at | 99.71 | 112 | 101.7 | 64.09 | 101.6 | 83.64 | 82.46 | 75.78 | 92.37 | 107.6 | 102.2 | 92.03 | 100.9 |
| 227149_at | 94.95 | 86.31 | 68.51 | 68.68 | 51.14 | 77.28 | 60.84 | 75.32 | 73.5 | 64.22 | 51 | 79.25 | 59.09 |
| 227173_s_at | 139.2 | 69.28 | 145.9 | 61.12 | 74.98 | 108.3 | 25.62 | 37.02 | 112.9 | 168.7 | 63.09 | 67.97 | 81.35 |
| 227213_at | 74.89 | 63.04 | 70.52 | 64.48 | 63.48 | 68.17 | 28.37 | 51.34 | 61.63 | 86.16 | 40.01 | 47.82 | 55.65 |
| 227374_at | 59.98 | 48.62 | 50.43 | 52.66 | 48.94 | 50.84 | 24.91 | 33.76 | 39.56 | 58.46 | 26.9 | 31.87 | 40.66 |
| 227517_s_at | 655.3 | 506.8 | 440.4 | 261.9 | 340.9 | 452.6 | 207.1 | 323.8 | 369.4 | 523.8 | 331 | 385.7 | 344.4 |
| 227558_at | 1186 | 1324 | 1187 | 1039 | 1217 | 1147 | 1651 | 981.7 | 1242 | 1281 | 1446 | 1300 | 1077 |
| 227560_at | 91.11 | 123.7 | 84.18 | 82.98 | 72.94 | 88.63 | 69.54 | 89.05 | 75.1 | 99.85 | 93.65 | 85.5 | 78.93 |
| 227722_at | 214.5 | 150.2 | 50.8 | 132.5 | 10.07 | 236.9 | 166.2 | 37.25 | 238.6 | 372.4 | 54.91 | 153.9 | 78.02 |
| 227990_at | 972.3 | 789.4 | 888.1 | 733.6 | 912.7 | 1004 | 1150 | 968.1 | 1054 | 978.8 | 1052 | 908.4 | 1089 |
| 228012_at | 28.55 | 27.88 | 23.89 | 22.86 | 28.77 | 27.04 | 24.88 | 16.61 | 26.06 | 26.78 | 27.39 | 23.87 | 24.03 |
| 228170_at | 350.8 | 834.2 | 896.8 | 599.7 | 780.8 | 330.6 | 566.1 | 239.7 | 506.2 | 590.8 | 644.1 | 799.4 | 798 |
| 228176_at | 128.4 | 252.6 | 281.6 | 225.9 | 292.6 | 343.4 | 392.5 | 159.1 | 288.6 | 133.2 | 409.7 | 463 | 313.9 |
| 228234_at | 300.2 | 445.1 | 433.8 | 343.8 | 361.7 | 333.7 | 420.6 | 259.1 | 301.1 | 299.9 | 444.8 | 440.4 | 549.2 |
| 228370_at | 231.3 | 160.5 | 118 | 77.07 | 153.1 | 204.3 | 33.27 | 94.93 | 118.4 | 223.1 | 93.17 | 116.3 | 91.18 |
| 228549_at | 496.3 | 514.3 | 481.3 | 251.5 | 405.3 | 411.9 | 369.4 | 291.7 | 417.6 | 549.2 | 489.4 | 385.1 | 297.4 |
| 228630_at | 100.4 | 114.7 | 84.17 | 56.73 | 95.4 | 79.13 | 46.65 | 39.8 | 79.82 | 120.5 | 76.65 | 83.52 | 82.09 |
| 228831_s_at | 185.8 | 138.9 | 205.3 | 115 | 223.8 | 170.4 | 78.59 | 90.11 | 274.3 | 152.9 | 196.8 | 172.9 | 95.04 |
| 229307_at | 30.84 | 66.74 | 65.06 | 19.96 | 35.7 | 104.2 | 19.83 | 79.21 | 51.35 | 37.67 | 42.51 | 27.23 | 73.56 |
| 229421_s_at | 32.27 | 30.88 | 49.57 | 66.98 | 36.78 | 44.65 | 55.08 | 80.54 | 71.27 | 50.41 | 44.98 | 59.71 | 34.62 |
| 229509_at | 288.1 | 277.9 | 230.4 | 164.8 | 190.7 | 238.8 | 169.9 | 152.1 | 228.6 | 189.5 | 171.4 | 197 | 221.6 |
| 229854_at | 24.58 | 25.24 | 25.21 | 31.08 | 25.53 | 24.58 | 26.09 | 26.24 | 27.62 | 25.21 | 22.68 | 24.53 | 24.6 |
| 229982_at | 117.7 | 121.4 | 118.5 | 92.83 | 118 | 104.7 | 65.17 | 68.66 | 71.55 | 107 | 44.51 | 68.86 | 112.6 |
| 230265_at | 158.2 | 146.1 | 155.9 | 162.8 | 190.6 | 249.2 | 247.4 | 221 | 207.3 | 218.9 | 126.7 | 192.3 | 145.4 |
| 230320_at | 134.8 | 136.8 | 138.6 | 117.9 | 120.1 | 117.1 | 97.62 | 109.2 | 151.7 | 123.3 | 100.8 | 110.8 | 109.4 |
| 230408_at | 108.2 | 80.43 | 74.57 | 77.27 | 79.44 | 84.78 | 76.36 | 73.34 | 89.93 | 108.9 | 61.85 | 76.39 | 77.19 |
| 230480_at | 57.26 | 56.04 | 43.83 | 60.96 | 58.82 | 57.26 | 52.34 | 50.92 | 80.7 | 72.16 | 113.8 | 60.48 | 68.48 |
| 230837_at | 78.68 | 71.93 | 68.52 | 74.89 | 82.04 | 66.53 | 75.51 | 93.89 | 82.37 | 94.11 | 80.46 | 68.6 | 62.4 |
| 230852_at | 38.58 | 46.24 | 42.09 | 59.18 | 45.17 | 46.28 | 49.98 | 47.03 | 45.61 | 50.31 | 56.32 | 41.93 | 78.31 |
| 230922_x_at | 43.2 | 43.66 | 41.59 | 57.14 | 43.31 | 36.96 | 41.32 | 38.67 | 51.45 | 42.89 | 40.55 | 43.45 | 41.98 |
| 231283_at | 295.4 | 186.5 | 195.7 | 152.6 | 156.7 | 239.1 | 209.5 | 194.4 | 203.3 | 246.5 | 196.4 | 234.6 | 140.8 |
| 231697_s_at | 73.34 | 85.59 | 65.03 | 81.19 | 69.51 | 87.44 | 113.8 | 113.3 | 96.95 | 104.8 | 91.56 | 59.34 | 112.4 |
| 231836_at | 62.61 | 63.83 | 63.75 | 49.97 | 59.44 | 62.61 | 46.88 | 56.21 | 31.23 | 63.16 | 54.65 | 57.69 | 46.18 |
| 231843_at | 170.9 | 176.4 | 202.1 | 145.1 | 164.8 | 178.4 | 185.6 | 127.1 | 137.5 | 173.5 | 155.7 | 149.1 | 167.2 |
| 231845_at | 118.1 | 93.54 | 95.94 | 81.61 | 100.9 | 105.4 | 70.2 | 86.79 | 95.79 | 104.1 | 63.05 | 100.6 | 83.31 |
| 231904_at | 348.1 | 378.2 | 374.9 | 449.9 | 417.2 | 399.6 | 426.9 | 371.5 | 357.4 | 303.5 | 292.9 | 320.7 | 163.7 |
| 231914_at | 47.06 | 43.53 | 48.12 | 50.44 | 49.51 | 47.66 | 49.77 | 50.63 | 44.82 | 47.54 | 49.94 | 51.15 | 59.08 |
| 232636_at | 68.98 | 76.15 | 28.17 | 48.64 | 70.52 | 50.8 | 101.4 | 73.74 | 76.06 | 58.84 | 107.4 | 90.43 | 144.9 |
| 232851_at | 33.74 | 38.45 | 40.15 | 49.55 | 54.07 | 38.27 | 41.13 | 43.07 | 48.44 | 54.37 | 45.66 | 26.45 | 43.83 |
| 233019_at | 338.6 | 368.8 | 290.8 | 243.9 | 277.6 | 249 | 244.4 | 163.6 | 299.7 | 244.1 | 214 | 223.3 | 228.7 |
| 233169_at | 104.1 | 103.8 | 119 | 160.3 | 97.81 | 94.48 | 126.9 | 111 | 152.1 | 98.52 | 68.43 | 92.22 | 53.37 |
| 234013_at | 117.4 | 91.86 | 91.59 | 36.73 | 85.5 | 111.1 | 39.75 | 91.59 | 76.15 | 92.72 | 53.55 | 83.21 | 49.83 |
| 234311_s_at | 173.5 | 155.4 | 143.9 | 88.97 | 125.3 | 143.3 | 114.9 | 104.4 | 139.7 | 137.9 | 89.97 | 142.6 | 145.5 |
| 234339_s_at | 1968 | 1456 | 1460 | 1171 | 1805 | 1811 | 591.3 | 1002 | 1867 | 1900 | 1031 | 1249 | 837.7 |
| 234464_s_at | 29.64 | 44.69 | 38.47 | 32 | 33.03 | 32.76 | 17.26 | 38.96 | 46.16 | 45.32 | 43.83 | 39.08 | 59.68 |
| 234733_s_at | 29.63 | 28.19 | 25.84 | 25.09 | 28.81 | 21.66 | 25.25 | 29.9 | 30.85 | 27.67 | 25.79 | 19.58 | 28.48 |
| 235024_at | 79.85 | 94.35 | 94.15 | 97.23 | 93.76 | 93.48 | 84.1 | 79.39 | 86.31 | 99.65 | 93.74 | 64.1 | 84.5 |
| 235067_at | 967.9 | 1055 | 956.4 | 1017 | 841.2 | 914.8 | 990.9 | 887.2 | 862.6 | 367.1 | 1051 | 894.7 | 779.7 |
| 235200_at | 126.9 | 97.35 | 116.2 | 82.84 | 110.3 | 109 | 111.4 | 92.62 | 117.9 | 109.6 | 98.74 | 110.5 | 110.9 |
| 235359_at | 304.6 | 451.8 | 314.8 | 210.1 | 349.1 | 256.2 | 269.4 | 209.3 | 207.3 | 182.5 | 315.6 | 287.7 | 503.6 |
| 235593_at | 860.1 | 854.2 | 594.8 | 644.3 | 888.4 | 729.6 | 771.5 | 660.3 | 677.4 | 915.2 | 665.9 | 849.8 | 943.9 |
| 235610_at | 84.02 | 47.75 | 27.36 | 46.17 | 61.61 | 49.8 | 41.13 | 28.48 | 49.12 | 52.63 | 49.91 | 48.19 | 52.57 |
| 235623_at | 35.77 | 27.66 | 27.42 | 25.81 | 30.35 | 29.3 | 28.8 | 17.9 | 26.13 | 28.35 | 18.69 | 19.77 | 18.27 |
| 235690_at | 27.06 | 23.91 | 24.21 | 24.48 | 27.18 | 21.94 | 16.34 | 24.39 | 24.36 | 25.94 | 21.02 | 23.27 | 25.53 |
| 237504_at | 73.66 | 60.79 | 74.86 | 65.11 | 73.71 | 74.77 | 60.66 | 92.64 | 87.82 | 67.64 | 53.91 | 63.84 | 56.14 |
| 238429_at | 3872 | 4119 | 3577 | 5418 | 4571 | 4631 | 4782 | 5074 | 4701 | 5024 | 4631 | 4474 | 2955 |
| 238513_at | 535.8 | 898.6 | 890.2 | 1194 | 1256 | 1000 | 2139 | 1225 | 851 | 1695 | 1345 | 2687 | 2577 |
| 238736_at | 263.8 | 254.7 | 234.5 | 234.8 | 195.2 | 238 | 180.9 | 159.8 | 178.7 | 253.5 | 197.4 | 187.9 | 198.5 |
| 238823_at | 52.51 | 54.23 | 62.87 | 61.33 | 53.13 | 38.91 | 28.34 | 28.44 | 31.26 | 53.8 | 46.68 | 45.64 | 62.33 |
| 238909_at | 221.4 | 180.2 | 138.6 | 144.8 | 153.3 | 171.7 | 103.5 | 158.6 | 114 | 146.2 | 95.4 | 106.9 | 157.6 |
| 239108_at | 185.1 | 279.8 | 276.2 | 263 | 259.1 | 368.6 | 292 | 206.6 | 257.4 | 269.8 | 506.3 | 293 | 297.2 |
| 239897_at | 255.5 | 243.6 | 205.4 | 186.3 | 212.9 | 251.3 | 194.1 | 186.3 | 156 | 210.8 | 224.6 | 216.1 | 141.2 |
| 241368_at | 298.1 | 278.6 | 317.2 | 366.7 | 365.4 | 373.7 | 394 | 729.1 | 391.3 | 448.7 | 359.1 | 372.9 | 176.3 |
| 241704_x_at | 75.17 | 49.97 | 45.78 | 27.95 | 46.3 | 54.59 | 39.9 | 39.86 | 50.72 | 48.99 | 47.34 | 48.32 | 50.35 |
| 241706_at | 128.7 | 124.2 | 134.7 | 135.5 | 113.4 | 116.9 | 126.4 | 124.2 | 98.7 | 125.1 | 85.18 | 121 | 155.6 |
| 241731_x_at | 73.2 | 63.4 | 56.04 | 37.83 | 48.87 | 52.88 | 50.82 | 32.4 | 60.28 | 51.56 | 53.19 | 42.81 | 50.62 |
| 242197_x_at | 72.53 | 57.25 | 66.88 | 59.06 | 74.87 | 38.94 | 46.64 | 71.38 | 58.89 | 91.57 | 20.66 | 44.82 | 110.3 |
| 242561_at | 40 | 22.45 | 19.24 | 21.74 | 25.99 | 22.5 | 19.87 | 25.2 | 30.9 | 24.92 | 24.59 | 24.23 | 16.73 |
| 242569_at | 167 | 306.2 | 284.1 | 226.8 | 222.8 | 217 | 304.1 | 316.1 | 261.2 | 222.4 | 356.9 | 235.7 | 315.8 |
| 242669_at | 262 | 215.2 | 255.9 | 171.1 | 223.6 | 195.2 | 123.2 | 162.5 | 233 | 184.2 | 203.2 | 164.9 | 273.8 |
| 243982_at | 118.1 | 116.5 | 101 | 89.9 | 75.75 | 100.8 | 86.5 | 78.51 | 96.11 | 98.23 | 73.55 | 87.08 | 89.51 |
| 244038_at | 67.96 | 47.14 | 40.38 | 35.49 | 43.7 | 44.58 | 30.59 | 35.38 | 45.41 | 50.54 | 37.42 | 31.76 | 44.9 |
| 244654_at | 2753 | 2017 | 1471 | 1397 | 1671 | 2406 | 1556 | 1421 | 1394 | 1404 | 1212 | 1589 | 1830 |
| 244698_at | 33.08 | 32.72 | 32.63 | 34.28 | 33.03 | 28.67 | 33.7 | 35.37 | 34.16 | 32.44 | 31.49 | 32.33 | 34.65 |
| 36566_at | 98.26 | 142 | 141.8 | 118.6 | 115 | 96.17 | 99.81 | 99.67 | 101.9 | 109.4 | 128.1 | 103.5 | 144.8 |
| 37549_g_at | 49.12 | 43.05 | 42.67 | 50.3 | 47.76 | 42.54 | 41.28 | 48.28 | 45.69 | 45.22 | 46.77 | 42.33 | 47.81 |
| 48659_at | 196.9 | 191.9 | 198.9 | 195.6 | 231.8 | 182.8 | 263.6 | 294 | 210.9 | 193.7 | 215.3 | 228.7 | 248.6 |
| 56829_at | 138.1 | 151.4 | 158.1 | 189.1 | 185 | 165.3 | 177.5 | 165.2 | 166.1 | 148.3 | 151.5 | 152.4 | 176.2 |
| 64486_at | 231.6 | 198.7 | 251.5 | 214.8 | 268.1 | 188.9 | 221.4 | 153.7 | 252 | 217.4 | 312.8 | 266.2 | 304.2 |
| 65493_at | 72.95 | 40.73 | 47.48 | 42.62 | 42.14 | 35.48 | 33.7 | 27.55 | 25.8 | 40.92 | 32.73 | 49.25 | 50.73 |
| AFFX- | 9316 | 8398 | 9380 | 8971 | 9249 | 9380 | 11949 | 9555 | 9903 | 8071 | 9914 | 10557 | 10889 |
| HUMGAPDH/M33197_3_at | | | | | | | | | | | | | |

| | | | | | NYHA III- | | NYHA III- | |
|---|---|---|---|---|---|---|---|---|
| | | | | | IV | | IV | |
| Affymetrix Probe | NYHA III-IV | | NYHA III-IV | | Sample | | Sample | |
| set ID | Sample no. 96 | NYHA III-IV Sample no. 23 | Sample no. 27 | NYHA III-IV Sample no. 45 | no. 67 | NYHA III- IV Sample no. 69 | no. 71 | NYHA III-IV Sample no. 82 |
| 1552318_at | 1228 | 1669 | 1206 | 1162 | 1500 | 1091 | 1709 | 1047 |
| 1552630_a_at | 83.75 | 75.58 | 86.38 | 80.76 | 107.4 | 80.94 | 67.48 | 42.17 |
| 1554149_at | 703.4 | 755.4 | 496.6 | 575.9 | 591.5 | 546.6 | 880.2 | 642.2 |
| 1554539_a_at | 62.88 | 54.99 | 58.72 | 77.3 | 71.19 | 63.65 | 52.22 | 49.91 |
| 1554606_at | 92.75 | 58.44 | 100.4 | 99.65 | 184.1 | 111.6 | 109.6 | 140.5 |
| 1555630_a_at | 182.2 | 151.4 | 138.3 | 168 | 162.8 | 203.5 | 271.3 | 143 |
| 1555963_x_at | 58.03 | 106.6 | 60.48 | 43.3 | 63.28 | 45.84 | 46.61 | 59.95 |
| 1555996_s_at | 899 | 331.3 | 612.3 | 781.8 | 1259 | 606.9 | 669.8 | 722.8 |
| 1556113_at | 39.43 | 47.27 | 44.08 | 40.62 | 41.45 | 39.2 | 31.86 | 56.5 |
| 1556283_s_at | 132.9 | 103.2 | 149.4 | 163.1 | 168.2 | 139 | 179.8 | 107 |
| 1556864_at | 41.32 | 47.26 | 46.99 | 43.9 | 46.87 | 47.43 | 32 | 47.15 |
| 1557066_at | 135.6 | 150.1 | 131.5 | 89.95 | 154 | 85.37 | 110.4 | 102.3 |
| 1558277_at | 32.12 | 36 | 28.71 | 29.05 | 28.92 | 56.19 | 27.2 | 36.2 |
| 1558755_x_at | 72.02 | 126.2 | 128.8 | 119.4 | 114.1 | 108.1 | 98.21 | 107.4 |
| 1561146_at | 54.49 | 51.65 | 76.74 | 65.4 | 78.66 | 72.24 | 65.4 | 52.41 |
| 1564962_at | 26.03 | 22.29 | 22.01 | 25.45 | 39.89 | 33.1 | 21.69 | 31.45 |
| 1567013_at | 130.3 | 96.02 | 121.7 | 118.2 | 126.8 | 156.8 | 145.1 | 177.2 |
| 1568815_a_at | 105.1 | 140.4 | 111.9 | 106.2 | 164 | 55.32 | 129.7 | 70.24 |
| 200007_at | 7306 | 7637 | 7585 | 7857 | 8008 | 6972 | 8917 | 6955 |
| 200010_at | 11211 | 14088 | 12284 | 11456 | 11932 | 9313 | 12313 | 9651 |
| 200059_s_at | 10002 | 10062 | 11038 | 10127 | 10700 | 11328 | 11310 | 11981 |
| 200091_s_at | 20582 | 20217 | 17428 | 20586 | 20708 | 13604 | 20047 | 16031 |
| 200633_at | 8308 | 9478 | 8119 | 8942 | 8219 | 7702 | 10969 | 6611 |
| 200650_s_at | 5780 | 5610 | 6690 | 6110 | 6509 | 5667 | 6400 | 5977 |
| 200672_x_at | 120.3 | 132.8 | 111.8 | 160.9 | 131.2 | 106.7 | 100.6 | 55.42 |
| 200677_at | 3337 | 2362 | 2870 | 2356 | 3230 | 3168 | 3077 | 3395 |
| 200713_s_at | 1380 | 1482 | 1554 | 1521 | 1553 | 1454 | 1648 | 1282 |
| 200822_x_at | 1417 | 1751 | 1682 | 1424 | 1205 | 1658 | 1961 | 1287 |
| 200829_x_at | 567.6 | 659.9 | 553.7 | 669.9 | 608.1 | 515.6 | 620.7 | 530.6 |
| 200839_s_at | 2892 | 2918 | 4254 | 3522 | 3326 | 3942 | 4853 | 3593 |
| 200932_s_at | 500.1 | 479.9 | 514.6 | 471.7 | 480.7 | 491.1 | 591.1 | 481 |
| 200950_at | 564.3 | 421.2 | 636.6 | 585.2 | 572.4 | 621.3 | 713.5 | 627.8 |
| 201031_s_at | 7860 | 9695 | 8016 | 7455 | 7555 | 5837 | 6285 | 5138 |
| 201075_s_at | 274.1 | 268.4 | 323.5 | 281.9 | 336.6 | 322.2 | 255.4 | 256.1 |
| 201098_at | 836.5 | 737.2 | 857.4 | 876.6 | 942.8 | 873.5 | 1037 | 726.1 |
| 201105_at | 4353 | 3468 | 4549 | 3442 | 4419 | 3858 | 7914 | 2989 |
| 201172_x_at | 3619 | 3478 | 3557 | 3290 | 3646 | 4218 | 3933 | 4021 |
| 201186_at | 729.1 | 703.5 | 718.7 | 580.2 | 594.5 | 618.6 | 702.7 | 620.2 |
| 201193_at | 643.4 | 747.9 | 588.8 | 676.6 | 802.2 | 822.7 | 894.4 | 618.2 |
| 201198_s_at | 173.8 | 168.1 | 168.1 | 171.9 | 216.2 | 162.4 | 163.4 | 147.1 |
| 201220_x_at | 1680 | 1799 | 1739 | 1602 | 1970 | 2084 | 1564 | 2018 |
| 201234_at | 1341 | 1314 | 1562 | 1578 | 1126 | 1431 | 1414 | 1093 |
| 201357_s_at | 331.5 | 351.2 | 345 | 241.2 | 356.4 | 418.4 | 275.5 | 333.5 |
| 201363_s_at | 1647 | 1074 | 1451 | 1435 | 1756 | 1435 | 1159 | 1580 |
| 201400_at | 1845 | 1887 | 2271 | 1871 | 1845 | 2170 | 2708 | 2445 |
| 201421_s_at | 143.3 | 179.5 | 136 | 153.1 | 168.2 | 116.7 | 178.9 | 151.1 |
| 201422_at | 8633 | 8331 | 10490 | 9029 | 8352 | 9837 | 10893 | 7702 |
| 201426_s_at | 20814 | 13614 | 19843 | 14682 | 18299 | 18494 | 17298 | 16129 |
| 201453_x_at | 1390 | 1328 | 1297 | 1263 | 1405 | 1326 | 1463 | 1385 |
| 201470_at | 1485 | 1461 | 1757 | 1352 | 1163 | 1393 | 2243 | 1283 |
| 201478_s_at | 223.1 | 213.5 | 235.5 | 250 | 287.7 | 164.3 | 237.9 | 197.4 |
| 201527_at | 933.9 | 1170 | 1000 | 1003 | 784.5 | 1054 | 1162 | 807.8 |
| 201536_at | 535.8 | 378.5 | 392.3 | 424.1 | 444.2 | 605.7 | 544.4 | 515.2 |
| 201554_x_at | 1187 | 678.9 | 897 | 823.8 | 820.9 | 842.3 | 1030 | 1370 |
| 201556_s_at | 592.5 | 522.3 | 496.6 | 557.5 | 783.5 | 497.7 | 447.6 | 536.7 |
| 201576_s_at | 647.7 | 683.2 | 799.2 | 759.1 | 805.7 | 834.9 | 955.8 | 710.9 |
| 201590_x_at | 3688 | 3455 | 3865 | 3583 | 3698 | 3581 | 4903 | 3255 |
| 201628_s_at | 614.7 | 631.3 | 713.4 | 613.4 | 629.8 | 667.6 | 695.2 | 657.5 |
| 201788_at | 501.3 | 563.9 | 501.3 | 520.2 | 577.6 | 416.2 | 482.5 | 499.6 |
| 201900_s_at | 460.9 | 551.5 | 476.9 | 518.7 | 369 | 485.4 | 741.4 | 388.9 |
| 201945_at | 549.2 | 598.5 | 563.2 | 484.2 | 661.6 | 613.8 | 428.5 | 618.1 |
| 202068_s_at | 201.3 | 160.9 | 159.7 | 105.3 | 130.8 | 233.1 | 164.7 | 78.83 |
| 202104_s_at | 179.3 | 373.7 | 459.3 | 310.1 | 338.3 | 258.6 | 327.9 | 242.2 |
| 202138_x_at | 252.6 | 320.2 | 276.9 | 272 | 253.1 | 261.8 | 340.1 | 280.1 |
| 202185_at | 248.2 | 308.9 | 211.1 | 247 | 217 | 224.8 | 240.2 | 169.5 |
| 202192_s_at | 918.6 | 844.3 | 946.5 | 640.3 | 1091 | 1105 | 1067 | 788.3 |
| 202201_at | 670.1 | 709.7 | 780.1 | 713.1 | 762.4 | 889.5 | 1467 | 631.8 |
| 202249_s_at | 204.2 | 212.3 | 195.1 | 207.3 | 232 | 175.5 | 190.8 | 198.3 |
| 202252_at | 127.5 | 118.7 | 125.8 | 128.7 | 117.1 | 176.4 | 201 | 109.3 |
| 202262_x_at | 170.7 | 98.97 | 137.4 | 94.84 | 106.9 | 116.6 | 119.5 | 130.3 |
| 202380_s_at | 635.8 | 539.7 | 666.5 | 523.9 | 727 | 392.6 | 473.8 | 497.2 |
| 202381_at | 589.3 | 278.4 | 596 | 563.3 | 728.8 | 580.1 | 620.7 | 733.7 |
| 202428_x_at | 2090 | 2365 | 2282 | 2166 | 2022 | 1688 | 2764 | 1878 |
| 202445_s_at | 208.2 | 123.7 | 211.1 | 156.4 | 284.1 | 172.8 | 165 | 189 |
| 202461_at | 202.7 | 215.3 | 163.1 | 212.5 | 187.9 | 156.6 | 218.8 | 197.7 |
| 202522_at | 732 | 747.4 | 686.7 | 718.7 | 699.1 | 650 | 738.6 | 581.8 |
| 202523_s_at | 181.5 | 190 | 143.3 | 168.5 | 101.1 | 137.9 | 173.1 | 60.42 |
| 202594_at | 840.3 | 1001 | 748.7 | 951.7 | 906.4 | 704.2 | 936.1 | 664.9 |
| 202623_at | 1152 | 1035 | 1098 | 1126 | 1119 | 952.3 | 1183 | 1208 |
| 202652_at | 25.66 | 48.52 | 33.12 | 33.05 | 33.06 | 26.14 | 19.86 | 16.96 |
| 202724_s_at | 496.6 | 498.5 | 465.5 | 437.4 | 513.5 | 442 | 479.8 | 413.8 |
| 202750_s_at | 222.5 | 237.7 | 215.6 | 195.1 | 215.8 | 224 | 187.5 | 191.2 |
| 202778_s_at | 519 | 548.3 | 654.8 | 457.9 | 571.1 | 493.9 | 602.3 | 642.3 |
| 202910_s_at | 5258 | 4635 | 5178 | 3219 | 2851 | 5896 | 4449 | 3363 |
| 202928_s_at | 159 | 134.8 | 126.8 | 128.3 | 135.3 | 119.9 | 97.83 | 88.98 |
| 202944_at | 439.8 | 523.1 | 463.2 | 420.5 | 438 | 437.6 | 555.2 | 518 |
| 202979_s_at | 661.9 | 536.4 | 588.5 | 554 | 799.7 | 453.1 | 607.9 | 527 |
| 203003_at | 96.7 | 108.8 | 94.46 | 83.66 | 123.3 | 110.6 | 100.6 | 83.13 |
| 203127_s_at | 364 | 240.6 | 388.8 | 336.8 | 408.4 | 449.1 | 411.7 | 479.4 |
| 203137_at | 1377 | 1369 | 1632 | 1554 | 1727 | 1502 | 1811 | 1270 |
| 203184_at | 104.4 | 81.27 | 125.9 | 145.6 | 190.6 | 108 | 281.2 | 97.87 |
| 203234_at | 652.9 | 531.1 | 770.1 | 631.8 | 565.6 | 481.5 | 838 | 444.7 |
| 203278_s_at | 1350 | 988.5 | 1228 | 988.9 | 1333 | 1639 | 1107 | 1499 |
| 203305_at | 1061 | 886.5 | 1602 | 1844 | 1619 | 2163 | 1565 | 1305 |
| 203371_s_at | 1750 | 1457 | 1387 | 1235 | 1422 | 1774 | 1781 | 1474 |
| 203413_at | 445.1 | 259.7 | 326.9 | 172.4 | 345.1 | 251.3 | 195.8 | 192.1 |
| 203416_at | 11286 | 9983 | 11132 | 10111 | 10817 | 12142 | 10591 | 11741 |
| 203492_x_at | 224.2 | 212.4 | 196.3 | 213.4 | 294.2 | 174.2 | 197 | 217.4 |
| 203534_at | 782.1 | 920.8 | 884.2 | 924.6 | 879.4 | 751.8 | 944.4 | 718.9 |
| 203535_at | 44023 | 43558 | 44450 | 43756 | 41485 | 48457 | 44537 | 47392 |
| 203578_s_at | 82.82 | 51.49 | 87.27 | 117.3 | 111.3 | 50.4 | 73.49 | 62.84 |
| 203748_x_at | 1726 | 1443 | 1652 | 1519 | 1748 | 2100 | 1679 | 1796 |
| 203759_at | 147.1 | 94.84 | 134 | 89.95 | 106.1 | 205.2 | 131.6 | 174.1 |
| 203844_at | 27.61 | 29 | 27.63 | 26.97 | 26.88 | 28 | 39.26 | 29.65 |
| 203880_at | 341.2 | 319.8 | 313.2 | 338.7 | 301.9 | 243.5 | 322.3 | 213.2 |
| 203912_s_at | 310.2 | 192.9 | 298.7 | 224.1 | 219.1 | 267.8 | 334.7 | 240.5 |
| 203939_at | 60.18 | 92.28 | 71.28 | 36.91 | 42.18 | 59.55 | 53.91 | 60.48 |
| 203971_at | 125.5 | 114.8 | 135.7 | 119 | 142.2 | 135.2 | 165.3 | 115.7 |
| 204050_s_at | 1191 | 1429 | 1380 | 1241 | 1281 | 1437 | 1661 | 1165 |
| 204068_at | 166.6 | 110.7 | 114.7 | 89.04 | 154.3 | 195.4 | 161.9 | 183.7 |
| 204099_at | 175.1 | 164.2 | 229.8 | 316.7 | 186 | 271.6 | 348.9 | 247.3 |
| 204143_s_at | 142.6 | 112 | 114.3 | 149.3 | 197.5 | 103.6 | 148.4 | 81.67 |
| 204204_at | 2896 | 2413 | 2482 | 1534 | 2547 | 2894 | 3292 | 2122 |
| 204214_s_at | 620.1 | 509.5 | 717 | 626 | 683.5 | 825.4 | 1232 | 698 |
| 204232_at | 5887 | 4971 | 6309 | 4864 | 5392 | 5761 | 6009 | 7379 |
| 204243_at | 373.3 | 289.1 | 373.1 | 264.9 | 318.1 | 387.3 | 285.7 | 366.1 |
| 204249_s_at | 2424 | 2738 | 2778 | 2984 | 3308 | 2948 | 3447 | 3378 |
| 204291_at | 363.7 | 367.5 | 420 | 449.1 | 442.9 | 355.5 | 405.7 | 391.1 |
| 204342_at | 942.8 | 1086 | 1075 | 1005 | 1056 | 822.8 | 1372 | 975 |
| 204352_at | 379.1 | 557.4 | 417.2 | 282.7 | 375.4 | 173 | 345.4 | 204.6 |
| 204401_at | 172.7 | 158.8 | 217 | 139.3 | 94.33 | 65.34 | 144.2 | 92.53 |
| 204504_s_at | 95.4 | 99.24 | 84.4 | 93.06 | 94.17 | 79.5 | 107.6 | 70.85 |
| 204617_s_at | 303.3 | 380.7 | 315.5 | 247.1 | 262.1 | 353.7 | 303.8 | 118.5 |
| 204645_at | 781.5 | 637.8 | 802.4 | 951.3 | 1118 | 780.9 | 863.8 | 808.3 |
| 204675_at | 126.7 | 105.5 | 100.4 | 122.5 | 163.3 | 130.9 | 163.4 | 161.6 |
| 204689_at | 539 | 457.7 | 548.4 | 495.5 | 495.8 | 526.5 | 518 | 705 |
| 204801_s_at | 27.47 | 36.52 | 72.34 | 46.13 | 33.64 | 84.38 | 33.72 | 53.55 |
| 205235_s_at | 93.69 | 112.8 | 77.86 | 79.75 | 87.34 | 81.96 | 81 | 75.99 |
| 205254_x_at | 253.7 | 265.9 | 256 | 231.1 | 230.4 | 185.8 | 142.4 | 106.4 |
| 205256_at | 64.98 | 65.67 | 53.83 | 63.55 | 63.76 | 59.42 | 63.75 | 66.32 |
| 205322_s_at | 546 | 559.4 | 619.6 | 671.3 | 506.9 | 611.7 | 545.9 | 581.1 |
| 205340_at | 112.9 | 146 | 121.7 | 124.2 | 147.5 | 105.6 | 126.8 | 86.21 |
| 205349_at | 237.8 | 195 | 256.2 | 230.8 | 174.2 | 269.1 | 239.7 | 171.8 |
| 205550_s_at | 307.9 | 284.5 | 318.1 | 279.3 | 283.6 | 305.8 | 324.9 | 285.9 |
| 205811_at | 145.6 | 178.2 | 163.1 | 168.2 | 122.3 | 109.9 | 153.4 | 116.7 |
| 205835_s_at | 94.04 | 45.17 | 78.51 | 90.87 | 148.6 | 58.95 | 78.38 | 80.43 |
| 205895_s_at | 115.7 | 101.5 | 98.81 | 134.1 | 163.2 | 89.4 | 138.7 | 71.06 |
| 205965_at | 328.3 | 237.7 | 300.2 | 209.7 | 214.1 | 282.1 | 310.7 | 161.3 |
| 205976_at | 50.6 | 41.41 | 46.03 | 42.94 | 33.7 | 17.04 | 32.31 | 12.32 |
| 206015_s_at | 593 | 640.4 | 629.3 | 605.9 | 697.2 | 546.6 | 589.6 | 619 |
| 206037_at | 35.8 | 35.98 | 28.76 | 35.9 | 35.91 | 34.04 | 34.08 | 30.71 |
| 206170_at | 326.3 | 304.5 | 275.6 | 315 | 253 | 235.5 | 269.4 | 222.1 |
| 206182_at | 79.69 | 79.8 | 89.95 | 131.2 | 103.3 | 75.32 | 88.13 | 92.17 |
| 206343_s_at | 66.46 | 62.58 | 57.09 | 36.75 | 52.3 | 82.69 | 124.9 | 95.49 |
| 206542_s_at | 1213 | 1434 | 1237 | 1109 | 1509 | 1080 | 1056 | 1265 |
| 206580_s_at | 77.15 | 64.33 | 59.15 | 77.1 | 79.13 | 63.48 | 61 | 62.61 |
| 206715_at | 301.8 | 256.6 | 300.3 | 390.7 | 317.5 | 409.8 | 526.4 | 411.4 |
| 206834_at | 90.34 | 98.31 | 44.23 | 655.7 | 82.24 | 71.33 | 281 | 59.93 |
| 206968_s_at | 82.3 | 49.85 | 101.8 | 107.1 | 100.9 | 86.26 | 99.91 | 59.03 |
| 207075_at | 289.6 | 167.3 | 150.1 | 171.9 | 173.9 | 275.2 | 213.8 | 326.9 |
| 207078_at | 142 | 165.4 | 171.2 | 164 | 153.3 | 99.57 | 132.4 | 96.51 |
| 207113_s_at | 169.5 | 151.1 | 135.8 | 92.52 | 133.8 | 87.01 | 158.7 | 150.7 |
| 207164_s_at | 577.7 | 197.3 | 546.2 | 684.5 | 1056 | 657.5 | 513.2 | 710.6 |
| 207233_s_at | 103.9 | 105.6 | 136.7 | 113.7 | 110.2 | 159.7 | 175.1 | 169.1 |
| 207416_s_at | 283.4 | 275 | 213.5 | 216.9 | 237.6 | 152.7 | 223.7 | 149.8 |
| 207513_s_at | 200.1 | 242.3 | 225 | 228.2 | 251.2 | 206.7 | 235.5 | 231.3 |
| 207543_s_at | 436.5 | 427.5 | 498.3 | 268.8 | 350.3 | 505.5 | 399.9 | 405.7 |
| 207564_x_at | 2970 | 1924 | 3046 | 3247 | 3540 | 2103 | 2322 | 2627 |
| 207971_s_at | 67.89 | 39.16 | 83.08 | 68.19 | 69.84 | 60.18 | 54.85 | 40.43 |
| 208104_s_at | 637.4 | 442.4 | 556.6 | 526.8 | 409.8 | 626.8 | 422.9 | 493.4 |
| 208121_s_at | 107.9 | 132.6 | 120.7 | 114.7 | 136.6 | 106.3 | 228.2 | 137.4 |
| 208161_s_at | 63.24 | 33.48 | 87.49 | 76.93 | 115.7 | 80.79 | 90.8 | 34.81 |
| 208269_s_at | 80.79 | 105.8 | 101.9 | 93.12 | 132.7 | 84.45 | 63.71 | 108.4 |
| 208309_s_at | 282.6 | 189.6 | 260.6 | 249.3 | 348.4 | 209 | 292.9 | 225.6 |
| 208527_x_at | 379.4 | 194 | 379.5 | 431.2 | 391.8 | 444.1 | 465.3 | 355.4 |
| 208579_x_at | 680.8 | 287.9 | 714.4 | 769.9 | 713.1 | 746.2 | 735.9 | 668.7 |
| 208635_x_at | 13846 | 14558 | 13792 | 12751 | 15331 | 11605 | 13975 | 12145 |
| 208659_at | 7731 | 6762 | 8266 | 6918 | 6635 | 7467 | 9596 | 8044 |
| 208680_at | 864.1 | 813.8 | 853.3 | 767.4 | 738.1 | 711.4 | 1179 | 718 |
| 208749_x_at | 2957 | 1883 | 2393 | 2441 | 1773 | 3532 | 2409 | 2739 |
| 208771_s_at | 7123 | 5627 | 6048 | 7627 | 6068 | 6170 | 5897 | 5038 |
| 208780_x_at | 3012 | 2715 | 2803 | 2503 | 2907 | 3156 | 2823 | 3667 |
| 208798_x_at | 1380 | 1340 | 1075 | 1090 | 1047 | 636.8 | 836.2 | 550.6 |
| 208805_at | 2048 | 2199 | 2282 | 2149 | 1744 | 1901 | 3109 | 1849 |
| 208868_s_at | 708.1 | 438.6 | 759 | 712.7 | 658.7 | 872.7 | 731 | 957.3 |
| 208903_at | 52.05 | 54.37 | 43.21 | 49.3 | 51.41 | 49.39 | 51.84 | 35.72 |
| 208921_s_at | 1314 | 1278 | 1384 | 1249 | 1276 | 1140 | 1434 | 1262 |
| 208923_at | 564.6 | 637 | 695.7 | 640.5 | 626.9 | 700.2 | 911.6 | 736.3 |
| 208946_s_at | 1390 | 1386 | 1440 | 1457 | 1477 | 1241 | 1565 | 1492 |
| 208962_s_at | 47.97 | 130.2 | 103.7 | 72.73 | 59.78 | 93.56 | 167.8 | 91.2 |
| 209040_s_at | 1725 | 1778 | 1761 | 2040 | 1724 | 1929 | 2265 | 1608 |
| 209067_s_at | 2397 | 1816 | 2413 | 2182 | 3411 | 1522 | 2254 | 1935 |
| 209072_at | 89.83 | 59.8 | 68.19 | 66.65 | 124 | 184.1 | 115.2 | 62.34 |
| 209099_x_at | 229.4 | 116.3 | 146.9 | 131.8 | 139.2 | 166.7 | 143.4 | 152.3 |
| 209124_at | 6097 | 4698 | 6468 | 4942 | 5359 | 6372 | 5477 | 5924 |
| 209180_at | 261.8 | 274.5 | 275.8 | 252.3 | 320.4 | 175.8 | 316.8 | 228.5 |
| 209191_at | 199.9 | 207.2 | 152.4 | 185.7 | 232 | 125.7 | 130 | 137.1 |
| 209212_s_at | 31.74 | 30.73 | 37.11 | 39.1 | 36.99 | 49.77 | 34.15 | 43.13 |
| 209218_at | 160.6 | 144.4 | 227.8 | 152 | 130.4 | 137.2 | 172.5 | 133.6 |
| 209236_at | 157.3 | 182.4 | 166.1 | 136.8 | 178.4 | 143.8 | 170.8 | 205.7 |
| 209251_x_at | 5852 | 5263 | 5341 | 5292 | 4007 | 6284 | 5561 | 5593 |
| 209259_s_at | 484.2 | 583.6 | 546.8 | 537.4 | 604.1 | 438.2 | 488.3 | 434.2 |
| 209269_s_at | 463.7 | 427 | 632.9 | 712.7 | 687.8 | 677.6 | 616.3 | 710.9 |
| 209330_s_at | 1798 | 2022 | 2074 | 2162 | 2791 | 1426 | 2506 | 1618 |
| 209339_at | 415.8 | 372.1 | 489.7 | 548 | 456 | 403.3 | 483.9 | 374.6 |
| 209430_at | 701.8 | 789.6 | 770.2 | 679.3 | 792.8 | 519.5 | 762.7 | 659.3 |
| 209675_s_at | 983.9 | 1122 | 1085 | 1015 | 1127 | 864.3 | 1026 | 874.6 |
| 209684_at | 496.3 | 400.8 | 507.9 | 378 | 590.3 | 532.4 | 810.3 | 340.1 |
| 209806_at | 2468 | 1314 | 2296 | 2703 | 2238 | 2288 | 2290 | 2491 |
| 209840_s_at | 15.34 | 25.94 | 12.6 | 19.51 | 45.7 | 12.86 | 21.89 | 9.549 |
| 209870_s_at | 166.9 | 276.5 | 157.4 | 147.5 | 209.9 | 122.6 | 95.74 | 97.56 |
| 209892_at | 92.79 | 78 | 103.2 | 106.3 | 78.69 | 101.4 | 108.3 | 105.5 |
| 209906_at | 397.1 | 816.1 | 1363 | 1175 | 719.9 | 548.3 | 1040 | 1021 |
| 210022_at | 175.4 | 160.2 | 176.9 | 206 | 173.9 | 187.1 | 189.7 | 169.6 |
| 210061_at | 105.1 | 112.8 | 113.8 | 96.42 | 97.91 | 105.6 | 111.2 | 84.45 |
| 210145_at | 96.15 | 101.6 | 82.06 | 149.9 | 86.98 | 75.73 | 162.2 | 97.44 |
| 210156_s_at | 993.4 | 884.8 | 1214 | 1188 | 1317 | 1044 | 1423 | 1148 |
| 210166_at | 954 | 615.2 | 719.2 | 617.3 | 765.9 | 883.2 | 639.1 | 1045 |
| 210434_x_at | 2501 | 2408 | 2670 | 2531 | 2200 | 2862 | 3024 | 2311 |
| 210644_s_at | 479.2 | 422 | 736.5 | 553.7 | 468.3 | 417.7 | 634.6 | 361.2 |
| 210648_x_at | 3569 | 3806 | 3936 | 3664 | 3515 | 3933 | 4831 | 4819 |
| 210875_s_at | 182.6 | 97.14 | 193.1 | 210.4 | 266.4 | 172.5 | 134.3 | 278.1 |
| 211047_x_at | 1129 | 1392 | 1371 | 1281 | 1044 | 1301 | 1693 | 1039 |
| 211058_x_at | 5380 | 5080 | 5241 | 4983 | 4100 | 5115 | 5150 | 5325 |
| 211185_s_at | 8511 | 7439 | 8180 | 7432 | 6789 | 7163 | 6531 | 8111 |
| 211272_s_at | 557.9 | 357.5 | 467.7 | 558 | 465.3 | 361.2 | 343.8 | 201.1 |
| 211323_s_at | 119 | 76.72 | 156.6 | 140.3 | 203.4 | 102.9 | 130.6 | 133.2 |
| 211383_s_at | 482.9 | 491.8 | 496 | 440.7 | 541.9 | 414.5 | 443.1 | 459.2 |
| 211429_s_at | 21378 | 14430 | 18443 | 16176 | 16958 | 18713 | 20830 | 19738 |
| 211506_s_at | 140.1 | 40.09 | 101.6 | 351.1 | 236.1 | 934.7 | 459.7 | 1376 |
| 211546_x_at | 152 | 192.7 | 195.3 | 270.3 | 163.7 | 184.3 | 235.8 | 177.8 |
| 211684_s_at | 706.3 | 713.7 | 632.4 | 656.7 | 586.6 | 604.5 | 850.1 | 584 |
| 211729_x_at | 436.4 | 582.3 | 540.2 | 310.9 | 458.6 | 434.7 | 658.3 | 271.4 |
| 211856_x_at | 62.67 | 25.44 | 48.66 | 58.78 | 55.92 | 36.75 | 58.03 | 9.702 |
| 211946_s_at | 4539 | 4985 | 4672 | 4357 | 4689 | 3788 | 3589 | 3907 |
| 211965_at | 3092 | 3115 | 2323 | 958.7 | 3996 | 2774 | 984.1 | 5320 |
| 212030_at | 944.8 | 825.8 | 854.5 | 970.4 | 1189 | 793.5 | 852.2 | 959.2 |
| 212042_x_at | 22117 | 24750 | 21759 | 21454 | 24397 | 19175 | 21202 | 20469 |
| 212132_at | 2722 | 2467 | 2531 | 2795 | 3327 | 2282 | 2337 | 2659 |
| 212213_x_at | 265.6 | 185.1 | 181.9 | 254 | 223.8 | 194.4 | 275.6 | 223.6 |
| 212299_at | 311 | 376.7 | 328.1 | 368.1 | 307.6 | 329.7 | 372 | 276.6 |
| 212331_at | 3254 | 3168 | 2689 | 3253 | 2869 | 2732 | 2529 | 3184 |
| 212334_at | 2135 | 2619 | 2251 | 2526 | 2501 | 2830 | 2893 | 2817 |
| 212406_s_at | 1005 | 1114 | 988.1 | 880.2 | 1460 | 857.5 | 998.9 | 1286 |
| 212455_at | 2602 | 2697 | 2776 | 2923 | 3371 | 2808 | 2561 | 2882 |
| 212543_at | 1305 | 1462 | 1391 | 1440 | 1403 | 1247 | 1259 | 1322 |
| 212658_at | 105.8 | 75.11 | 124.1 | 165.3 | 131.6 | 127.5 | 157.3 | 88.23 |
| 212663_at | 1398 | 1152 | 1344 | 1275 | 1407 | 1577 | 1537 | 1288 |
| 212769_at | 496.7 | 347.3 | 418.6 | 296.1 | 325.6 | 721.3 | 458.5 | 603.4 |
| 212820_at | 2840 | 2047 | 2753 | 2572 | 3016 | 3596 | 2675 | 2765 |
| 212932_at | 140 | 105.2 | 163.4 | 141.1 | 147.3 | 137.5 | 134.2 | 125.2 |
| 212989_at | 395.9 | 380.1 | 395 | 552.2 | 669.8 | 436.4 | 568.9 | 490.8 |
| 212997_s_at | 535.7 | 559.3 | 558.2 | 564.8 | 668 | 647.4 | 607.3 | 579.6 |
| 213021_at | 188.8 | 179.6 | 194.7 | 201.9 | 273.5 | 203.2 | 206.5 | 178.4 |
| 213152_s_at | 479.6 | 451.5 | 397.7 | 424.4 | 390.2 | 276.1 | 357.6 | 315.4 |
| 213205_s_at | 97.62 | 162.2 | 117.1 | 116.8 | 137.4 | 96.09 | 122.5 | 91.41 |
| 213218_at | 77.63 | 68.55 | 85.96 | 69.94 | 108.4 | 86.26 | 84.65 | 72.6 |
| 213266_at | 85.69 | 78.22 | 65.97 | 52 | 96.87 | 73.71 | 63.66 | 78.62 |
| 213302_at | 31.47 | 40.29 | 28.43 | 30.25 | 27.66 | 25.11 | 31.62 | 19.58 |
| 213335_s_at | 26.77 | 40.83 | 43.85 | 42.54 | 44.54 | 48.17 | 42.82 | 46.08 |
| 213397_x_at | 196.1 | 110.4 | 121.8 | 155.9 | 136.8 | 88.83 | 249.6 | 112.8 |
| 213459_at | 27.45 | 98.54 | 82.4 | 83.26 | 93.03 | 56.4 | 68.24 | 83.33 |
| 213494_s_at | 64.75 | 49.04 | 45.24 | 50.68 | 67.19 | 49.04 | 40.7 | 67.25 |
| 213540_at | 63.36 | 55.55 | 54.59 | 36.97 | 51.88 | 42.53 | 70.5 | 44.72 |
| 213693_s_at | 40.71 | 40.8 | 41.63 | 34.5 | 35.48 | 36.92 | 36.36 | 37.29 |
| 213827_at | 85.42 | 81.37 | 42.37 | 48.78 | 64.76 | 38.36 | 56.19 | 38.13 |
| 213877_x_at | 86.72 | 93.67 | 90.07 | 89.76 | 89.35 | 90.61 | 99.95 | 85.47 |
| 214045_at | 29.61 | 38.24 | 69.51 | 54.52 | 66.39 | 33.82 | 59.86 | 41.75 |
| 214057_at | 349.6 | 446.8 | 244.8 | 338.9 | 289.5 | 278.3 | 292.7 | 281.6 |
| 214330_at | 40.95 | 41.11 | 31.18 | 48.95 | 56.11 | 35.56 | 43.75 | 33.6 |
| 214364_at | 59.84 | 73.79 | 110.9 | 95.17 | 109 | 55.88 | 80.59 | 46.53 |
| 214430_at | 497.5 | 459.3 | 483.7 | 420.2 | 317.9 | 485.6 | 576.3 | 598.4 |
| 214511_x_at | 3739 | 1387 | 2079 | 1356 | 1771 | 1916 | 1829 | 3076 |
| 214629_x_at | 7540 | 6267 | 7610 | 6282 | 7506 | 7576 | 5933 | 7922 |
| 214683_s_at | 3718 | 3326 | 3341 | 3478 | 3401 | 3656 | 3295 | 3545 |
| 214820_at | 75.39 | 68.23 | 68.79 | 90.89 | 127.9 | 82.71 | 86.55 | 81.03 |
| 214853_s_at | 518.3 | 481.5 | 501.1 | 441.5 | 406.5 | 420.2 | 570.6 | 324 |
| 214931_s_at | 314.7 | 176.6 | 289.8 | 355.6 | 524.1 | 288.8 | 286.6 | 427.4 |
| 214953_s_at | 207.2 | 138.2 | 195 | 131.4 | 302.4 | 284.5 | 202.5 | 270.7 |
| 215009_s_at | 404.6 | 485.5 | 453.9 | 452 | 516.9 | 295 | 425.3 | 357.8 |
| 215049_x_at | 466.9 | 571.8 | 453.9 | 510.5 | 503.5 | 515.2 | 1296 | 809.2 |
| 215273_s_at | 538.8 | 586.4 | 629.5 | 601.1 | 632.6 | 606.4 | 650.5 | 565.1 |
| 215293_s_at | 56.96 | 57.95 | 47.12 | 68.08 | 46.4 | 49.87 | 53.73 | 64.33 |
| 215567_at | 97.71 | 102.3 | 109.8 | 104.1 | 116 | 70.84 | 97.02 | 71.85 |
| 215997_s_at | 324.9 | 149.7 | 351.6 | 317.4 | 452.1 | 365.7 | 293.2 | 505 |
| 216484_x_at | 490.8 | 544.9 | 410.7 | 501.2 | 371.2 | 504.4 | 485.7 | 423.9 |
| 216950_s_at | 2162 | 589.2 | 1083 | 665.7 | 1077 | 872.3 | 890.3 | 1452 |
| 217383_at | 56.85 | 32.17 | 32.94 | 32.16 | 50.46 | 31.82 | 38.73 | 52.83 |
| 217403_s_at | 74.99 | 100.5 | 84.66 | 101.8 | 111 | 63.09 | 79.25 | 90.18 |
| 217466_x_at | 2683 | 2725 | 2448 | 2409 | 2667 | 2050 | 2652 | 1887 |
| 217769_s_at | 1482 | 1652 | 1551 | 1671 | 1256 | 1416 | 1602 | 1427 |
| 217778_at | 240.3 | 275.9 | 258.4 | 214.5 | 221.3 | 238.8 | 307.6 | 301.8 |
| 217824_at | 333.5 | 275.6 | 447.7 | 368.2 | 444.6 | 298.3 | 294.6 | 524.8 |
| 217987_at | 343.2 | 363.8 | 361.7 | 851.8 | 866.9 | 522.6 | 574.8 | 522.2 |
| 217995_at | 1630 | 1356 | 1813 | 1864 | 1650 | 1986 | 1806 | 2124 |
| 218012_at | 217.3 | 245 | 173 | 168.8 | 210.4 | 162.7 | 188.5 | 129.6 |
| 218040_at | 326.1 | 353.6 | 314.7 | 346.6 | 307.4 | 301.5 | 237.2 | 287.3 |
| 218065_s_at | 919 | 1072 | 975.6 | 1083 | 1099 | 881.5 | 1393 | 800.5 |
| 218091_at | 494.1 | 597.8 | 562.9 | 538.8 | 622.5 | 522 | 583.1 | 748.7 |
| 218125_s_at | 56.56 | 61.4 | 55.51 | 56.24 | 68.75 | 41.24 | 55.66 | 45.56 |
| 218127_at | 222.8 | 176.9 | 194.9 | 201.4 | 271.4 | 180.2 | 214 | 159.6 |
| 218143_s_at | 562.5 | 668.8 | 601.3 | 538.4 | 621.5 | 678.4 | 724.1 | 575.9 |
| 218206_x_at | 380.7 | 391.3 | 440.6 | 388.3 | 400.9 | 468.5 | 691.8 | 268.3 |
| 218289_s_at | 96.99 | 75.82 | 69.5 | 86.26 | 93.12 | 52.96 | 86.89 | 69.5 |
| 218325_s_at | 346.1 | 331 | 356.2 | 324.7 | 340.7 | 339.4 | 332.5 | 362.4 |
| 218351_at | 1151 | 1142 | 994.6 | 1062 | 1213 | 1410 | 1281 | 1309 |
| 218499_at | 1911 | 2262 | 1785 | 2121 | 2093 | 1686 | 1725 | 1701 |
| 218627_at | 408.2 | 292.6 | 391.4 | 359.6 | 474.7 | 668.6 | 487.3 | 515.9 |
| 218718_at | 101.7 | 118 | 180.6 | 208.7 | 240.6 | 213.2 | 127.4 | 153.9 |
| 218732_at | 295 | 260.8 | 278.6 | 269.6 | 273.5 | 226.4 | 342.4 | 209 |
| 218845_at | 947.6 | 1038 | 1176 | 835.7 | 1272 | 1280 | 1229 | 951 |
| 218962_s_at | 407.5 | 445.2 | 468.1 | 452.9 | 529 | 359.5 | 392.6 | 483.4 |
| 219130_at | 284 | 249.8 | 266.4 | 210 | 210.8 | 186.6 | 231 | 158.9 |
| 219316_s_at | 103.7 | 90.61 | 138.4 | 98.16 | 174.4 | 149.1 | 109.3 | 145.6 |
| 219343_at | 168.4 | 171.7 | 146.5 | 154.3 | 216.5 | 165.1 | 178.1 | 139.9 |
| 219358_s_at | 172.3 | 247 | 225.5 | 200 | 222.9 | 224.2 | 356.4 | 191.1 |
| 219418_at | 88.23 | 95.98 | 61 | 98.19 | 88.9 | 102.8 | 111.4 | 75.33 |
| 219507_at | 121.1 | 157.2 | 129.6 | 124.4 | 118.1 | 111.2 | 85.2 | 119.7 |
| 219765_at | 39.12 | 79.53 | 39.43 | 57.78 | 47.91 | 57.67 | 50.87 | 31.69 |
| 219787_s_at | 139.3 | 80.13 | 54.33 | 65.4 | 91.56 | 174.4 | 102.9 | 59.78 |
| 219822_at | 128.5 | 139.9 | 139.6 | 159.9 | 151.4 | 106.3 | 127.9 | 108 |
| 219826_at | 30.85 | 42.49 | 35.2 | 35.55 | 35.25 | 38.73 | 36.94 | 25.04 |
| 219952_s_at | 259.8 | 212.6 | 191.7 | 276.2 | 200.2 | 220.6 | 207.1 | 176.2 |
| 220044_x_at | 3854 | 4691 | 4328 | 4033 | 5100 | 3301 | 3610 | 3606 |
| 220146_at | 122.1 | 138.5 | 138.1 | 126.6 | 200.9 | 135.4 | 202.8 | 137.3 |
| 220160_s_at | 62.94 | 85.52 | 63.86 | 86.67 | 62.56 | 63.02 | 62.51 | 63.88 |
| 220386_s_at | 459.7 | 254.1 | 367.5 | 517.5 | 606.1 | 439.9 | 355.4 | 521.1 |
| 220578_at | 88.51 | 151.2 | 113.7 | 88.01 | 67.08 | 100.4 | 70.48 | 108 |
| 220605_s_at | 184.5 | 194.7 | 168 | 185.1 | 174.1 | 211.2 | 193.5 | 148 |
| 220610_s_at | 157.4 | 132.7 | 176.4 | 114.6 | 144.6 | 145.6 | 138.9 | 150.8 |
| 220690_s_at | 122 | 98.02 | 153 | 128.2 | 168 | 153 | 162.4 | 127 |
| 220750_s_at | 119.5 | 110.7 | 107.7 | 102.7 | 72.46 | 101.4 | 108.2 | 76.33 |
| 220865_s_at | 103.5 | 94.06 | 105.9 | 91.2 | 112.4 | 94.43 | 116.3 | 99.91 |
| 220974_x_at | 242.2 | 278.4 | 223 | 220.1 | 239.7 | 266.4 | 254.8 | 254.5 |
| 221011_s_at | 742.9 | 774.5 | 569.6 | 525.2 | 781.4 | 337.9 | 663.3 | 309.3 |
| 221206_at | 147.5 | 200.9 | 118.2 | 160.8 | 164.7 | 176.7 | 162.6 | 128.9 |
| 221264_s_at | 446 | 511.6 | 467.3 | 489.9 | 387.5 | 371.6 | 405.1 | 429.7 |
| 221428_s_at | 801.6 | 544.3 | 692.1 | 757.6 | 1161 | 773.4 | 610.8 | 987.4 |
| 221449_s_at | 359 | 267.3 | 375.1 | 418.7 | 452.7 | 430 | 456.5 | 367 |
| 221580_s_at | 959.4 | 922.1 | 893.9 | 1019 | 1115 | 893.7 | 844.8 | 877.5 |
| 221601_s_at | 1242 | 2272 | 1479 | 1102 | 1512 | 907.5 | 999.9 | 868.9 |
| 221647_s_at | 524.6 | 462.2 | 595.6 | 479.8 | 430.1 | 530.7 | 526.6 | 373.1 |
| 221731_x_at | 7505 | 8854 | 9341 | 8051 | 8485 | 8995 | 8691 | 8346 |
| 221757_at | 433.5 | 444.2 | 356.6 | 385 | 303.1 | 336.4 | 373.5 | 281.9 |
| 221841_s_at | 1725 | 1586 | 1487 | 1208 | 1880 | 1551 | 1796 | 1359 |
| 221868_at | 30.64 | 31.7 | 29.3 | 28.78 | 39.09 | 24.48 | 29.82 | 27.58 |
| 221960_s_at | 101.9 | 57.46 | 71.58 | 80.08 | 87.85 | 59.11 | 70.41 | 129.1 |
| 222217_s_at | 322.9 | 474.7 | 350.9 | 382.3 | 259.5 | 308.2 | 448 | 230.5 |
| 222231_s_at | 323.3 | 323.9 | 326.3 | 401.7 | 315.7 | 315.3 | 423.5 | 238.2 |
| 222574_s_at | 447.8 | 270.1 | 480.9 | 473.2 | 575.5 | 535.3 | 525.3 | 575.2 |
| 222605_at | 588.1 | 545.6 | 707.2 | 656.8 | 739.2 | 635.7 | 607.8 | 578.4 |
| 222651_s_at | 364.5 | 402.9 | 397.7 | 327.3 | 399.6 | 403.8 | 471.2 | 335.7 |
| 222670_s_at | 735.5 | 763.9 | 957.5 | 656.6 | 1073 | 679.3 | 1208 | 642 |
| 222688_at | 273.9 | 398.8 | 431.2 | 384.3 | 296.1 | 323.1 | 401.4 | 348.7 |
| 222700_at | 445.6 | 598.4 | 577.9 | 501.1 | 505.6 | 373.8 | 418.1 | 526.9 |
| 222753_s_at | 242.3 | 208.6 | 231.5 | 270.2 | 225.3 | 234 | 305.3 | 188.2 |
| 222757_s_at | 234.2 | 131.8 | 158.3 | 116.7 | 193.3 | 193.7 | 148.4 | 179.5 |
| 222774_s_at | 64.65 | 51.63 | 62.06 | 69.77 | 49.5 | 47.51 | 87.39 | 40.2 |
| 222884_at | 79.99 | 100.1 | 91.47 | 84.05 | 106 | 83.25 | 98.21 | 118.7 |
| 222980_at | 2589 | 2605 | 3055 | 2629 | 2631 | 2388 | 2546 | 2934 |
| 222982_x_at | 5148 | 4119 | 3792 | 4468 | 4383 | 4492 | 3872 | 4914 |
| 223023_at | 265.8 | 251.2 | 239.9 | 241.5 | 246.9 | 285.3 | 277 | 182.3 |
| 223064_at | 1241 | 1483 | 1517 | 1580 | 1418 | 1491 | 2048 | 1229 |
| 223158_s_at | 128.7 | 99.75 | 147.1 | 130.9 | 131.7 | 173.1 | 138.1 | 131.8 |
| 223380_s_at | 407 | 320.8 | 356.9 | 331.4 | 407.3 | 333.9 | 420 | 392 |
| 223444_at | 838 | 810.6 | 711 | 772.7 | 892.1 | 859.9 | 720.6 | 917.2 |
| 223465_at | 618 | 263.7 | 541.6 | 404 | 710.6 | 626.3 | 451.3 | 666.9 |
| 223590_at | 296.9 | 344.6 | 485.4 | 354.3 | 481.3 | 304.7 | 341.9 | 409.4 |
| 223686_at | 298.7 | 222.8 | 204.9 | 207 | 303 | 265.8 | 255.4 | 349.8 |
| 223801_s_at | 37.42 | 34.72 | 41.68 | 28.68 | 29.72 | 44.64 | 30.64 | 33.08 |
| 223922_x_at | 2679 | 2491 | 2269 | 2502 | 2191 | 2937 | 3570 | 2983 |
| 223982_s_at | 1040 | 859.9 | 1103 | 988.9 | 1300 | 1110 | 1166 | 1154 |
| 224046_s_at | 361.5 | 146.4 | 283.4 | 349.1 | 477.7 | 298.3 | 279.8 | 238.7 |
| 224374_s_at | 838.2 | 567.3 | 724.7 | 478 | 572.6 | 617.3 | 781.2 | 464.5 |
| 224387_at | 88.62 | 79.17 | 74.07 | 79.53 | 80.45 | 91.04 | 153.6 | 54.75 |
| 224439_x_at | 459.5 | 427.5 | 566.7 | 472.3 | 497.3 | 468.7 | 840.7 | 400.7 |
| 224518_s_at | 207.4 | 172.2 | 274.5 | 223.1 | 270.2 | 198.5 | 217 | 91.29 |
| 224582_s_at | 248.5 | 220.7 | 219.5 | 240.2 | 414.9 | 181.4 | 271.7 | 224.5 |
| 224591_at | 2452 | 3192 | 2725 | 2851 | 3059 | 1996 | 2349 | 2174 |
| 224726_at | 201.2 | 189.3 | 214.4 | 194.5 | 313.1 | 194.5 | 229.4 | 232 |
| 224818_at | 682.1 | 765.6 | 804.1 | 714.6 | 679.7 | 684.5 | 904.1 | 888.9 |
| 224917_at | 3213 | 2249 | 2599 | 2412 | 2176 | 2922 | 4075 | 2953 |
| 224918_x_at | 635.2 | 406.5 | 650.7 | 621 | 396.8 | 801.8 | 1038 | 463.3 |
| 224928_at | 359.6 | 328.1 | 369.7 | 280 | 314.2 | 345.6 | 413.1 | 280.1 |
| 225059_at | 1632 | 1449 | 1943 | 1448 | 1548 | 1943 | 2103 | 1527 |
| 225064_at | 337.1 | 312.6 | 395.7 | 247.4 | 414 | 347.4 | 371 | 279 |
| 225107_at | 2472 | 2594 | 2388 | 2550 | 2423 | 1756 | 1778 | 2148 |
| 225188_at | 71.28 | 79 | 99.81 | 38 | 103.3 | 53.61 | 215.6 | 92.44 |
| 225341_at | 40.15 | 34.84 | 33.73 | 35.34 | 40 | 31.96 | 67.17 | 58.36 |
| 225358_at | 97.69 | 65.65 | 86.38 | 82.04 | 98.25 | 68.27 | 108.7 | 63 |
| 225365_at | 3092 | 3109 | 2678 | 2999 | 4573 | 2314 | 2758 | 2542 |
| 225388_at | 37.23 | 43.11 | 25.53 | 42.81 | 43.03 | 27.7 | 40 | 36.05 |
| 225456_at | 295 | 398.8 | 312.6 | 282.7 | 414.2 | 291.4 | 315.5 | 245.9 |
| 225763_at | 1833 | 3284 | 2587 | 3120 | 2428 | 2596 | 2214 | 2181 |
| 225844_at | 204.5 | 254.2 | 276.8 | 213.1 | 236.6 | 260.5 | 446.2 | 192.2 |
| 225866_at | 82.84 | 97.96 | 96.42 | 99.71 | 134.5 | 93.52 | 90.45 | 97.06 |
| 225870_s_at | 820.6 | 876.4 | 941.8 | 690.7 | 705.3 | 1011 | 1536 | 632.4 |
| 226000_at | 38.13 | 26.1 | 25.65 | 27.9 | 31.24 | 30.87 | 31.6 | 53.38 |
| 226030_at | 91.29 | 102.3 | 101.1 | 88.56 | 111.1 | 80.11 | 90.55 | 83.47 |
| 226042_at | 90.61 | 98.1 | 79.28 | 86.3 | 89.7 | 68.79 | 97.35 | 84.25 |
| 226059_at | 94.43 | 82.53 | 63.16 | 56.37 | 74.2 | 41.43 | 57.33 | 37.45 |
| 226115_at | 218.2 | 189.8 | 240.5 | 214.9 | 319.6 | 344.7 | 266.8 | 395.7 |
| 226127_at | 87.01 | 87.63 | 85.62 | 71.63 | 85.82 | 82.92 | 93.25 | 82.61 |
| 226218_at | 5885 | 4549 | 4259 | 3124 | 5620 | 2417 | 3238 | 1748 |
| 226220_at | 158.5 | 120.5 | 98.62 | 120.4 | 135.5 | 93.37 | 113.4 | 169.1 |
| 226323_at | 501.3 | 585.2 | 435.8 | 478.6 | 537.6 | 381.2 | 512.3 | 529.4 |
| 226353_at | 1322 | 1001 | 1329 | 1159 | 1410 | 1238 | 1090 | 1101 |
| 226428_at | 181.2 | 204.5 | 102.6 | 179.2 | 171.7 | 180.3 | 183.6 | 166.6 |
| 226459_at | 2774 | 2142 | 2662 | 2140 | 2657 | 2662 | 2705 | 3023 |
| 226503_at | 173.7 | 230.7 | 203.3 | 230.6 | 222.2 | 229 | 227.7 | 217.8 |
| 226683_at | 2588 | 2546 | 2552 | 1941 | 3331 | 2699 | 2257 | 3785 |
| 226718_at | 76.53 | 72.87 | 69.42 | 52.77 | 69.84 | 58.12 | 63.07 | 69.87 |
| 226763_at | 225 | 204.9 | 260.5 | 143.4 | 252.9 | 189.7 | 249.4 | 226.3 |
| 226836_at | 34.68 | 44.21 | 34.14 | 34.12 | 34.23 | 35.12 | 34.27 | 43.51 |
| 227020_at | 765.3 | 878.3 | 746.8 | 795.5 | 895.3 | 777.2 | 964.7 | 949.8 |
| 227114_at | 108.6 | 101 | 87.42 | 100.3 | 89.76 | 81.67 | 109.3 | 94.02 |
| 227149_at | 73.98 | 52.82 | 73.3 | 59.92 | 73.53 | 48.25 | 59.08 | 67.2 |
| 227173_s_at | 69.74 | 152.6 | 127.7 | 62.28 | 115.6 | 42.21 | 51.18 | 62.72 |
| 227213_at | 54.67 | 65.79 | 53.55 | 75.97 | 62.79 | 31.43 | 50.33 | 38.77 |
| 227374_at | 41.02 | 49.75 | 49.13 | 46.48 | 43.8 | 48.35 | 41.54 | 32.07 |
| 227517_s_at | 382.4 | 495.9 | 381.8 | 400.3 | 424.7 | 267.3 | 315.5 | 244.5 |
| 227558_at | 1169 | 1019 | 1247 | 1274 | 1375 | 1018 | 1170 | 1228 |
| 227560_at | 79.71 | 85.84 | 92.04 | 76.38 | 77.83 | 86.21 | 81.59 | 77.5 |
| 227722_at | 39.07 | 215.9 | 81.54 | 59.97 | 70.18 | 123.4 | 62.19 | 169.9 |
| 227990_at | 898.6 | 827.2 | 993.2 | 888.8 | 1033 | 1041 | 1081 | 1144 |
| 228012_at | 23.21 | 24.09 | 30.34 | 24.26 | 23.75 | 22.7 | 24.79 | 20.43 |
| 228170_at | 826.7 | 814.5 | 482.8 | 1380 | 737.3 | 374.8 | 343.8 | 1017 |
| 228176_at | 151.2 | 280.6 | 267.2 | 285.9 | 325 | 249.8 | 494.8 | 245.5 |
| 228234_at | 363.8 | 319.6 | 388 | 412.5 | 383.3 | 410.6 | 508.4 | 396.1 |
| 228370_at | 175.4 | 203.5 | 125.4 | 94.97 | 172.2 | 59.9 | 89.81 | 97.52 |
| 228549_at | 393.7 | 493.8 | 484.2 | 359.7 | 440 | 334.9 | 390.5 | 294.4 |
| 228630_at | 111.3 | 98.54 | 71.13 | 82.12 | 109.9 | 40.19 | 72.6 | 67.41 |
| 228831_s_at | 76.18 | 163.4 | 138.1 | 141.2 | 182.1 | 147.1 | 78.18 | 129.1 |
| 229307_at | 144.5 | 53.17 | 122.1 | 48.33 | 86.89 | 88.36 | 30.81 | 45.07 |
| 229421_s_at | 63.84 | 33.5 | 34.92 | 41.39 | 48.57 | 57.7 | 44.52 | 69.42 |
| 229509_at | 220 | 176 | 221.1 | 211.4 | 228.2 | 181 | 201 | 225.3 |
| 229854_at | 23.01 | 25.66 | 25.16 | 22.46 | 25.24 | 24.8 | 24.32 | 25.71 |
| 229982_at | 131.9 | 152.5 | 113.1 | 85.15 | 134.8 | 92.66 | 110.6 | 97.69 |
| 230265_at | 250.1 | 144.4 | 172.4 | 126.7 | 249 | 299.9 | 180.1 | 301 |
| 230320_at | 102 | 136.1 | 125.6 | 119 | 122.4 | 113.9 | 126.5 | 92.83 |
| 230408_at | 79.05 | 102.9 | 88.83 | 88.67 | 83.7 | 79.85 | 93.17 | 77.97 |
| 230480_at | 73.89 | 73.2 | 74.35 | 58.36 | 67.04 | 58.25 | 66.48 | 59.78 |
| 230837_at | 59.38 | 62.6 | 72.9 | 65.66 | 81.91 | 64.09 | 58.46 | 69.66 |
| 230852_at | 48.85 | 47.9 | 46.24 | 46.28 | 41.68 | 52.01 | 46.24 | 50.42 |
| 230922_x_at | 43.79 | 39.91 | 34.58 | 48.67 | 42.8 | 44.91 | 41.58 | 38.7 |
| 231283_at | 173.9 | 143.8 | 140.2 | 194 | 254.5 | 188.8 | 145.2 | 122.2 |
| 231697_s_at | 115.4 | 90.57 | 88.37 | 75.7 | 98.91 | 67.16 | 136.8 | 96.89 |
| 231836_at | 50.38 | 72.41 | 62.82 | 49.21 | 54.65 | 44.4 | 50.75 | 38.98 |
| 231843_at | 152.9 | 197.8 | 168.6 | 164 | 171.6 | 117.2 | 134.2 | 119.9 |
| 231845_at | 84.15 | 156.8 | 87.16 | 85.64 | 95.25 | 72.56 | 89.09 | 82.37 |
| 231904_at | 248.8 | 381.3 | 376.9 | 298.7 | 346.7 | 361.7 | 284.8 | 383.9 |
| 231914_at | 50.22 | 59.14 | 49.9 | 47.38 | 42.32 | 48.65 | 72.57 | 59.32 |
| 232636_at | 105.9 | 68.64 | 93.72 | 83.66 | 115.9 | 69.18 | 111.3 | 64.25 |
| 232851_at | 42.05 | 39.62 | 37.81 | 37.2 | 52.68 | 45.35 | 29.08 | 45.9 |
| 233019_at | 209 | 275.8 | 296.1 | 286.9 | 299 | 178.5 | 257.1 | 182.4 |
| 233169_at | 72.93 | 87.16 | 87.44 | 76.06 | 87.85 | 87.61 | 96.7 | 110.3 |
| 234013_at | 123 | 81.02 | 56.57 | 106.2 | 62.31 | 66.35 | 119.7 | 61.44 |
| 234311_s_at | 97.92 | 135.3 | 109.7 | 111.1 | 151.4 | 144 | 109.5 | 153 |
| 234339_s_at | 1379 | 2451 | 1009 | 1131 | 1627 | 1209 | 1925 | 875.9 |
| 234464_s_at | 49.51 | 52.24 | 36.24 | 52.35 | 47.78 | 26.37 | 33.89 | 38.03 |
| 234733_s_at | 21.67 | 23.31 | 27.12 | 27.16 | 41.12 | 21.89 | 31.66 | 29.26 |
| 235024_at | 94.65 | 90.02 | 88.97 | 79.49 | 94.07 | 94.46 | 101 | 83.25 |
| 235067_at | 770.7 | 886 | 1043 | 1025 | 806.5 | 929.2 | 791.6 | 955.5 |
| 235200_at | 78.26 | 156.4 | 119.7 | 105.7 | 95.74 | 105.1 | 118.6 | 89.77 |
| 235359_at | 280.1 | 417.6 | 361 | 384.8 | 339.1 | 287.7 | 432.1 | 334.3 |
| 235593_at | 1198 | 651.4 | 913 | 654.9 | 1161 | 911.6 | 683.5 | 1015 |
| 235610_at | 50.59 | 55.12 | 41.23 | 58.57 | 64.9 | 39.29 | 56.86 | 46.59 |
| 235623_at | 26.12 | 28.6 | 26.79 | 25.21 | 24.53 | 20.77 | 22.07 | 18.78 |
| 235690_at | 25.46 | 24.71 | 25.92 | 22.28 | 21.76 | 22.9 | 19.01 | 16.87 |
| 237504_at | 55.55 | 84.3 | 61.51 | 55.96 | 66.37 | 76.06 | 74.67 | 76.21 |
| 238429_at | 2653 | 2933 | 3541 | 3913 | 3214 | 4244 | 4476 | 5591 |
| 238513_at | 1606 | 873.2 | 928.8 | 1326 | 1558 | 1900 | 1081 | 1048 |
| 238736_at | 297.6 | 272.2 | 262.6 | 210.8 | 228.1 | 205.5 | 244.9 | 216 |
| 238823_at | 45.69 | 53.25 | 40.79 | 37.02 | 33.74 | 32.49 | 24.83 | 34.4 |
| 238909_at | 389.9 | 170.7 | 261.4 | 213.2 | 225.3 | 167.8 | 325.7 | 148.8 |
| 239108_at | 346 | 274.4 | 316.8 | 281.6 | 365.5 | 521.1 | 332.9 | 283.5 |
| 239897_at | 223.8 | 169.2 | 210 | 184.6 | 229.7 | 264.1 | 193.9 | 263.9 |
| 241368_at | 430.8 | 319.1 | 436.6 | 335.2 | 300 | 447 | 295.1 | 568.2 |
| 241704_x_at | 45.76 | 69.14 | 50 | 52.36 | 32.26 | 43.66 | 38.3 | 44.75 |
| 241706_at | 128 | 123.7 | 131.8 | 117.3 | 151 | 159.3 | 197.5 | 130.2 |
| 241731_x_at | 46.56 | 47.55 | 56.84 | 44.62 | 56.51 | 50.21 | 46.91 | 47.59 |
| 242197_x_at | 56.68 | 112.7 | 128.9 | 66.44 | 145.5 | 88.9 | 79.35 | 81.35 |
| 242561_at | 24.62 | 24 | 15.43 | 23.47 | 26.56 | 23.23 | 22.78 | 25.29 |
| 242569_at | 194.8 | 190 | 254.7 | 283.4 | 269.1 | 273.4 | 259.7 | 338.8 |
| 242669_at | 206.4 | 290.1 | 232.3 | 241.3 | 327.7 | 182.2 | 234 | 179.2 |
| 243982_at | 95.87 | 76.44 | 99.57 | 97.14 | 114.7 | 97 | 80.27 | 77.12 |
| 244038_at | 41.11 | 44.97 | 35.9 | 38.62 | 48.81 | 40.07 | 39.69 | 27.91 |
| 244654_at | 1532 | 2423 | 2975 | 2086 | 1421 | 1916 | 1808 | 1378 |
| 244698_at | 33.16 | 34.56 | 33.28 | 30.61 | 29.97 | 30.63 | 33.55 | 34.85 |
| 36566_at | 118.6 | 127.3 | 130.1 | 157.1 | 124 | 135.4 | 152.4 | 98.89 |
| 37549_g_at | 42.75 | 44.25 | 40.07 | 46.18 | 42.52 | 43.78 | 42.79 | 46.12 |
| 48659_at | 256.1 | 271.2 | 249 | 207.9 | 181.3 | 242.7 | 234.3 | 185.7 |
| 56829_at | 140.2 | 171.7 | 166.2 | 149.9 | 133.2 | 216 | 163.5 | 160.8 |
| 64486_at | 259.5 | 306.1 | 249.3 | 243.2 | 253.2 | 316.2 | 380.4 | 172.1 |
| 65493_at | 55.4 | 39.22 | 46.3 | 40.81 | 45.25 | 37.45 | 49.23 | 40.56 |
| AFFX- | 11426 | 10898 | 11477 | 11311 | 8295 | 11212 | 11537 | 9700 |
| HUMGAPDH/M33197_3_at | | | | | | | | |

TABLE 2

| Affymetrix | | GenBank | |
|---|---|---|---|
| Probe set ID | Gene symbol | Accession No. | Gene Title |
| 1552318_at | GIMAP1 | AK091818 | GTPase, IMAP family member 1 |
| 1552630_a_at | SRCAP | NM_006662 | Snf2-related CBP activator protein |
| 1554149_at | CLDND1 | BC013610 | claudin domain containing 1 |
| 1554539_a_at | RHOF | BC018208 | ras homolog gene family, member F (in |
| | | | filopodia) |
| 1554606_at | CCDC100 | BC040527 | coiled-coil domain containing 100 |
| 1555630_a_at | RAB34 | AF327350 | RAB34, member RAS oncoqene family |
| 1555963_x_at | B3GNT7 | CA503291 | UDP-GlcNAc:betaGal beta-1,3-N- |
| | | | acetylglucosaminyltransferase 7 |
| 1555996_s_at | EIF4A2 | A1332397 | eukaryotic translation initiation factor 4A, |
| | | | isoform 2 |
| 1556113_at | DKFZp451A211 | BC036906 | DKFZp451A211 protein |
| 1556283_s_at | FGFR1OP2 | W74643 | FGFR1 oncoqene partner 2 |
| 1556864_at | TECT1 | BC030993 | tectonic 1 |
| 1557066_at | LUC7L | AI744735 | LUC7-like (S. cerevisiae) |
| 1558277_at | ZNF740 | BM786513 | zinc finger protein 740 |
| 1558755_x_at | ZNF763 | AA484731 | zinc finger protein 763 |
| 1561146_at | VPS35 | N51700 | vacuolar protein sorting 35 homolog (S. |
| | | | cerevisiae) |
| 1564962_at | ZNF92 | M61872 | zinc finger protein 92 |
| 1567013_at | NFE2L2 | AF323119 | nuclear factor (erythroid-derived 2)-like 2 |
| 1568815_a_at | DDX50 | AA903184 | DEAD (Asp-Glu-Ala-Asp) box polypeptide 50 |
| 200007_at | SRP14 | NM_003134 | signal recognition particle 14 kDa (homologous |
| | | | Alu RNA binding protein) |
| 200010_at | RPL11 | NM_000975 | ribosomal protein L11 |
| 200059_s_at | RHOA | BC001360 | ras homoloq gene family, member A |
| 200091_s_at | RPS25 | AA888388 | ribosomal protein S25 |
| 200633_at | UBB | NM_018955 | ubiquitin B |
| 200650_s_at | LDHA | NM_005566 | lactate dehydroqenase A |
| 200672_x_at | SPTBN1 | NM_003128 | spectrin, beta, non-erythrocytic 1 |
| 200677_at | PTTG1IP | NM_004339 | pituitary tum or-transforming 1 interacting protein |
| 200713_s_at | MAPRE1 | NM_012325 | microtubule-associated protein, RP/EB family, |
| | | | member 1 |
| 200822_x_at | TPI1 | NM_000365 | triosephosphate isomerase 1 |
| 200829_x_at | ZNF207 | NM_003457 | zinc finger protein 207 |
| 200839_s_at | CTSB | NM_001908 | cathepsin B |
| 200932_s_at | DCTN2 | NM_006400 | dynactin 2 (p50) |
| 200950_at | ARPC1A | NM_006409 | actin related protein 2/3 complex, subunit 1A, |
| | | | 41 kDa |
| 201031_s_at | HNRPH1 | NM_005520 | heterogeneous nuclear ribonucleoprotein H1 (H) |
| 201075_s_at | SMARCC1 | NM_ 003074 | SWI/SNF related, matrix associated, actin |
| | | | dependent regulator of chromatin, subfamily c, |
| | | | member 1 |
| 201098_at | COPB2 | NM_004766 | coatomer protein complex, subunit beta 2 (beta |
| | | | prime) |
| 201105_at | LGALS1 | NM_002305 | lectin, galactoside-binding, soluble, 1 (galectin |
| | | | 1) |
| 201172_x_at | ATP6V0EI | NM_003945 | ATPase, H+ transporting, lysosomal 9 kDa, V0 |
| | | | subunit e1 |
| 20 186_at | LRPAP1 | NM_002337 | low density lipoprotein receptor-related protein |
| | | | associated protein 1 |
| 201193_at | IDH1 | NM_005896 | isocitrate dehydrogenase 1 (NADP+), soluble |
| 201198_s_at | PSMD1 | AI860431 | proteasome (prosome, macropain) 26S subunit, |
| | | | non-ATPase, 1 |
| 201220_x_at | CTBP2 | NM_001329 | C-terminal binding protein 2 |
| 201234_at | ILK | NM_004517 | integrin-linked kinase |
| 201357_s_at | SF3A1 | NM_005877 | splicing factor 3a, subunit 1, 120 kDa |
| 201363_s_at | IVNS1ABP | AB020657 | influenza virus NS1A binding protein |
| 201400_at | PSMB3 | NM_002795 | proteasome (prosome, macropain) subunit, beta |
| | | | type, 3 |
| 201421_s_at | WDR77 | NM_024102 | WD repeat domain 77 |
| 201422_at | IFI30 | NM_006332 | interferon, gamma-inducible protein 30 |
| 201426_s_at | VIM | AI922599 | vimentin |
| 201453_x_at | RHEB | NM_005614 | Ras homolog enriched in brain |
| 201470_at | GSTO1 | NM_004832 | glutathione S-transferase omega 1 |
| 201478_s_at | DKC1 | U59151 | dyskeratosis congenita 1, dyskerin |
| 201527_at | ATP6V1F | NM_004231 | ATPase, H+ transporting, lysosomal 14 kDa, V1 |
| | | | subunit F |
| 201536_at | DUSP3 | AL048503 | dual specificity phosphatase 3 (vaccinia virus |
| | | | phosphatase VH1-related) |
| 201554_x_at | GYG1 | NM_004130 | glycogenin 1 |
| 201556_s_at | VAMP2 | BC002737 | vesicle-associated membrane protein 2 |
| | | | (synaptobrevin 2) |
| 201576_s_at | GLB1 | NM_000404 | galactosidase, beta 1 |
| 201590_x_at | ANXA2 | NM_004039 | annexin A2 |
| 201628_s_at | RRAGA | NM_006570 | Ras-related GTP binding A |
| 201788_at | DDX42 | NM_007372 | DEAD (Asp-Glu-Ala-Asp) box polypeptide 42 |
| 201900_s_at | AKR1A1 | NM_006066 | aldo-keto reductase family 1, member A1 |
| | | | (aldehyde reductase) |
| 201945_at | FURIN | NM_002569 | furin (paired basic amino acid cleaving enzyme) |
| 202068_s_at | LDLR | NM_000527 | low density lipoprotein receptor (familial |
| | | | hypercholesterolemia) |
| 202104_s_at | SPG7 | NM_003119 | spastic paraplegia 7 (pure and complicated |
| | | | autosomal recessive) |
| 202138_x_at | JTV1 | NM_006303 | JTV1 gene |
| 202185_at | PLOD3 | NM_001084 | procollagen-lysine, 2-oxoglutarate 5- |
| | | | dioxygenase 3 |
| 202192_s_at | GAS7 | NM_005890 | growth arrest-specific 7 |
| 202201_at | BLVRB | NM_000713 | biliverdin reductase B (flavin reductase |
| | | | (NADPH)) |
| 202249_s_at | WDR42A | AU146233 | WD repeat domain 42A |
| 202252_at | RAB13 | NM_002870 | RAB13, member RAS oncogene family |
| 202262_x_at | DDAH2 | NM_013974 | dimethylarginine dimethylaminohydrolase 2 |
| 202380_s_at | NKTR | NM_005385 | natural killer-tumor recognition sequence |
| 202381_at | ADAM9 | NM_003816 | ADAM metallopeptidase domain 9 (meltrin |
| | | | gamma) |
| 202428_x_at | DBI | NM_020548 | diazepam binding inhibitor (GABA receptor |
| | | | modulator, acyl-Coenzyme A binding protein) |
| 202445_s_at | NOTCH2 | NM_024408 | Notch homolog 2 (Drosophila) |
| 202461_at | E F2B2 | NM_ 014239 | eukaryotic translation initiation factor 2B, subunit |
| | | | 2 beta, 39 kDa |
| 202522_at | PITPNB | AL031591 | phosphatidylinositol transfer protein, beta |
| 202523_s_at | SPOCK2 | AI952009 | sparc/osteonectin, cwcv and kazal-like domains |
| | | | proteoglycan (testican) 2 |
| 202594_at | LEPROTL1 | NM_015344 | leptin receptor overlapping transcript-like 1 |
| 202623_at | EAPP | NM_018453 | E2F-associated phosphoprotein |
| 202652_at | APBBI | NM_001164 | amyloid beta (A4) precursor protein-binding, |
| | | | family B, member 1 (Fe65) |
| 202724_s_at | FOXO1 | NM_002015 | forkhead box O1 |
| 202750_s_at | TFIP11 | AL080147 | tuftelin interacting protein 11 |
| 202778_s_at | ZMYM2 | NM_003453 | zinc finger, MYM-type 2 |
| 202910_s_at | CD97 | NM_001784 | CD97 molecule |
| 202928_s_at | PHF1 | NM_024165 | PHD finger protein 1 |
| 202944_at | NAGA | NM_000262 | N-acetylgalactosaminidase, alpha- |
| 202979_s_at | CREBZF | NM_021212 | CREB/ATF bZIP transcription factor |
| 203003_at | MEF2D | AL530331 | myocyte enhancer factor 2D |
| 203127_s_at | SPTLC2 | BC005123 | serine palmitoyltransferase, long chain base |
| | | | subunit 2 |
| 203137_at | WTAP | NM_004906 | Wilms tumor 1 associated protein |
| 203184_at | FBN2 | NM_001999 | fibrillin 2 (congenital contractural |
| | | | arachnodactyly) |
| 203234_at | UPP1 | NM_003364 | uridine phosphorylase 1 |
| 203278_s_at | PHF21A | NM_016621 | PHD finger protein 21A |
| 203305_at | F13A1 | NM_000129 | coagulation factor XIII, A1 polypeptide |
| 203371_s_at | NDUFB3 | NM_002491 | NADH dehydrogenase (ubiquinone) 1 beta |
| | | | subcomplex, 3, 12 kDa |
| 203413_at | NELL2 | NM_006159 | NEL-like 2 (chicken) |
| 203416_at | CD53 | NM_000560 | CD53 molecule |
| 203492_x_at | CEP57 | AA918224 | centrosomal protein 57 kDa |
| 203534_at | LSM1 | NM_014462 | LSM1 homolog, U6 small nuclear RNA |
| | | | associated (S. cerevisiae) |
| 203535_at | S100A9 | NM_002965 | S100 calcium binding protein A9 |
| 203578_s_at | SLC7A6 | BG230586 | solute carrier family 7 (cationic amino acid |
| | | | transporter, y+ system), member 6 |
| 203748_x_at | RBMS1 | NM_016839 | RNA binding motif, single stranded interacting |
| | | | protein 1 |
| 203759_at | ST3GAL4 | NM_006278 | ST3 beta-galactoside alpha-2,3-sialyltransferase |
| | | | 4 |
| 203844_at | VHL | NM_000551 | von Hippel-Lindau tumor suppressor |
| 203880_at | COX17 | NM_005694 | COX17 cytochrome c oxidase assembly |
| | | | homoloq (S. cerevisiae) |
| 203912_s_at | DNASE1L1 | NM_006730 | deoxyribonuclease I-like 1 |
| 203939_at | NT5E | NM_002526 | 5′-nucleotidase, ecto (CD73) |
| 203971_at | SLC31A1 | NM_001859 | solute carrier family 31 (copper transporters), |
| | | | member 1 |
| 204050_s_at | CLTA | NM_001833 | clathrin, light chain (Lca) |
| 204068_at | STK3 | NM_006281 | serine/threonine kinase 3 (STE20 homolog, |
| | | | Yeast) |
| 204099_at | SMARCD3 | NM_003078 | SWI/SNF related, matrix associated, actin |
| | | | dependent regulator of chromatin, subfamily d, |
| | | | member 3 |
| 204143_s_at | ENOSF1 | NM_017512 | enolase superfamily member 1 |
| 204204_at | SLC31A2 | NM_001860 | solute carrier family 31 (copper transporters), |
| | | | member 2 |
| 204214_s_at | RAB32 | NM_006834 | RAB32, member RAS oncogene family |
| 204232_at | FCER1G | NM_004106 | Fc fragment of IgE, high affinity I, receptor for; |
| | | | gamma polypeptide |
| 204243_at | RLF | NM_012421 | rearranged L-myc fusion |
| 204249_s_at | LMO2 | NM_005574 | LIM domain only 2 (rhombotin-like 1) |
| 204291_at | ZNF518 | NM_014803 | zinc finger protein 518 |
| 204342_at | SLC25A24 | NM_013386 | solute carrier family 25 (mitochondrial carrier; |
| | | | phosphate carrier), member 24 |
| 204352_at | TRAF5 | NM_004619 | TNF receptor-associated factor 5 |
| 204401_at | KCNN4 | NM_002250 | potassium intermediate/small conductance |
| | | | calcium-activated channel, subfamily N, |
| | | | member 4 |
| 204504_s_at | HIRIP3 | NM_003609 | HIRA interacting protein 3 |
| 204617_s_at | ACD | NM_022914 | adrenocortical dysplasia hornolog (mouse) |
| 204645_at | CCNT2 | NM_001241 | cyclin T2 |
| 204675_at | SRD5A1 | NM_001047 | steroid-5-alpha-reductase, alpha polypeptide 1 |
| | | | (3-oxo-5 alpha-steroid delta 4-dehydrogenase |
| | | | alpha 1) |
| 204689_at | HHEX | NM_001529 | hematopoietically expressed homeobox |
| 204801_s_at | DHRS12 | NM_024705 | dehydrogenase/reductase (SDR family) member |
| | | | 12 |
| 205235_s_at | MPHOSPH1 | NM_016195 | M-phase phosphoprotein 1 |
| 205254_x_at | TCF7 | AW027359 | transcription factor 7 (T-cell specific, HMG-box) |
| 205256_at | ZBTB39 | NM_014830 | zinc finger and BTB domain containing 39 |
| 205322_s_at | MTF1 | AW182367 | metal-regulatory transcription factor 1 |
| 205340_at | ZBTB24 | NM_014797 | zinc finger and BTB domain containing 24 |
| 205349_at | GNA15 | NM_002068 | guanine nucleotide binding protein (G protein), |
| | | | alpha 15 (Gq class) |
| 205550_s_at | BRE | NM_004899 | brain and reproductive organ-expressed |
| | | | (TNFRSF1A modulator) |
| 205811_at | POLG2 | NM_007215 | polymerase (DNA directed), gamma 2, |
| | | | accessory subunit |
| 205835_s_at | YTHDC2 | AW975818 | YTH domain containing 2 |
| 205895_s_at | NOLC1 | NM_004741 | nucleolar and coiled-body phosphoprotein 1 |
| 205965_at | BATF | NM_006399 | basic leucine zipper transcription factor, ATF-like |
| 205976_at | FASTKD2 | NM_014929 | FAST kinase domains 2 |
| 206015_s_at | FOXJ3 | NM_014947 | forkhead box J3 |
| 206037_at | CCBL1 | NM_004059 | cysteine conjugate-beta lyase; cytoplasmic |
| | | | (glutamine transaminase K, kyneurenine |
| | | | aminotransferase) |
| 206170_at | ADRB2 | NM_000024 | adrenergic, beta-2-, receptor, surface |
| 206182_at | ZNF134 | NM_003435 | zinc finger protein 134 |
| 206343_s_at | NRG1 | NM_013959 | neuregulin 1 |
| 206542_s_at | SMARCA2 | AV725365 | SWI/SNF related, matrix associated, actin |
| | | | dependent regulator of chromatin, subfamily a, |
| | | | member 2 |
| 206580_s_at | EFEMP2 | NM_016938 | EGF-containing fibulin-like extracellular matrix |
| | | | protein 2 |
| 206715_at | TFEC | NM_012252 | transcription factor EC |
| 206834_at | HBD | NM_000519 | hemoglobin, delta |
| 206968_s_at | NFRKB | NM_006165 | nuclear factor related to kappaB binding protein |
| 207075_at | NLRP3 | NM_004895 | NLR family, pyrin domain containing 3 |
| 207078_at | MED6 | NM_005466 | mediator complex subunit 6 |
| 207113_s_at | TNF | NM_000594 | tumor necrosis factor (TNF superfamily, member |
| | | | 2) |
| 207164_s_at | ZNF238 | NM_006352 | zinc finger protein 238 |
| 207233_s_at | MITF | NM_000248 | microphthalmia-associated transcription factor |
| 207416_s_at | NFATC3 | NM_004555 | nuclear factor of activated T-cells, cytoplasmic, |
| | | | calcineurin-dependent 3 |
| 207513_s_at | ZNF189 | NM_003452 | zinc finger protein 189 |
| 207543_s_at | P4HA1 | NM_000917 | procollagen-proline, 2-oxoglutarate 4- |
| | | | dioxygenase (proline 4-hydroxylase), alpha |
| | | | polypeptide I |
| 207564_x_at | OGT | NM_003605 | O-linked N-acetylglucosamine (GlcNAc) |
| | | | transferase (UDP-N- |
| | | | acetylglucosamine:polypeptide-N- |
| | | | acetylglucosaminyl transferase) |
| 207971_s_at | CEP68 | NM_015147 | centroso al protein 68 kDa |
| 208104_s_at | TSC22D4 | NM_030935 | TSC22 domain family, member 4. |
| 208121_s_at | PTPRO | NM_002848 | protein tyrosine phosphatase, receptor type, O |
| 208161_s_at | ABCC3 | NM_020037 | ATP-binding cassette, sub-family C |
| | | | (CFTR/MRP), member 3 |
| 208269_s_at | ADAM28 | NM_021777 | ADAM metallopeptidase domain 28 |
| 208309_s_at | MALT1 | NM_006785 | mucosa associated lymphoid tissue lymphoma |
| | | | translocation gene 1 |
| 208527_x_at | HIST1H2BE | NM_003523 | hitone cluster 1, H2be |
| 208579_x_at | H2BFS | NM_017445 | H2B histone family, member S |
| 208635_x_at | NACA | BF976260 | nascent polypeptide-associated complex alpha |
| | | | subunit |
| 208659_at | CLIC1 | AF034607 | chloride intracellular channel 1 |
| 208680_at | PRDX1 | L19184 | peroxiredoxin 1 |
| 208749_x_at | FLOT1 | AF085357 | flotillin 1 |
| 208771_s_at | LTA4H | J02959 | leukotriene A4 hydrolase |
| 208780_x_at | VAPA | AF154847 | VAMP (vesicle-associated membrane protein)- |
| | | | associated protein A, 33 kDa |
| 208798_x_at | GOLGA8A | AF204231 | golgi autoantigen, golgin subfamily a, 8A |
| 208805_at | PSMA6 | BC002979 | proteasome (prosome, macropain) subunit, |
| | | | alpha type, 6 |
| 208868_s_at | GABARAPL1 | BF125756 | GABA(A) receptor-associated protein like 1 |
| 208903_at | RPS28 | BF431363 | ribosomal protein S28 |
| 208921_s_at | SRI | L12387 | sorcin |
| 208923_at | CYFIP1 | BC005097 | cytoplasmic FMR1 interacting protein 1 |
| 208946_s_at | BECN1 | AF139131 | beclin 1 (coiled-coil, myosin-like BCL2 |
| | | | interacting protein) |
| 208962_s_at | FADS1 | BE540552 | fatty acid desaturase 1 |
| 209040_s_at | PSMB8 | U17496 | proteasome (prosome, macropain) subunit, beta |
| | | | type, 8 (large multifunctional peptidase 7) |
| 209067_s_at | HNRPDL | D89092 | heterogeneous nuclear ribonucleoprotein D-like |
| 209072_at | MBP | M13577 | myelin basic protein |
| 209099_x_at | JAG1 | U73936 | jagged 1 (Alagille syndrome) |
| 209124_at | MYD88 | U70451 | myeloid differentiation primary response gene |
| | | | (88) |
| 209180_at | RABGGTB | U49245 | Rab geranylgeranyltransferase, beta subunit |
| 209191_at | TUBB6 | BC002654 | tubulin, beta 6 |
| 209212_s_at | KLF5 | AB030824 | Kruppel-like factor 5 (intestinal) |
| 209218_at | SQLE | AF098865 | squalene epoxidase |
| 209236_at | SLC23A2 | AL389886 | solute carrier family 23 (nucleobase |
| | | | transporters), member 2 |
| 209251_x_at | TUBA1C | BC004949 | tubulin, alpha 1c |
| 209259_s_at | SMC3 | AF020043 | structural maintenance of chromosomes 3 |
| 209269_s_at | SYK | AW450910 | spleen tyrosine kinase |
| 209330_s_at | HNRPD | D55674 | heterogeneous nuclear ribonucleoprotein D (AU- |
| | | | rich element RNA binding protein 1, 37 kDa) |
| 209339_at | SIAH2 | U76248 | seven in absentia homolog 2 (Drosophila) |
| 209430_at | BTAF1 | AJ001017 | BTAF1 RNA polymerase II, B-TFIID transcription |
| | | | factor-associated, 170kDa (Mott homolog, S. |
| | | | cerevisiae) |
| 209675_s_at | HNRPUL1 | BC004242 | heterogeneous nuclear ribonucleoprotein U-like |
| | | | 1 |
| 209684_at | RIN2 | AL136924 | Ras and Rab interactor 2 |
| 209806_at | HIST1H2BK | BC000893 | histone cluster 1, H2bk |
| 209840_s_at | LRRN3 | AI221950 | leucine rich repeat neuronal 3 |
| 209870_s_at | APBA2 | AW571582 | amyloid beta (A4) precursor protein-binding, |
| | | | family A member 2 (X11-like) |
| 209892_at | FUT4 | AF305083 | fucosyltransferase 4 (alpha (1,3) |
| | | | fucosyltransferase, myeloid-specific) |
| 209906_at | C3AR1 | U62027 | complement component 3a receptor 1 |
| 210022_at | PCGF1 | BC004952 | polycomb group ring finger 1 |
| 210061_at | ZNF589 | AF114817 | zinc finger protein 589 |
| 210145_at | PLA2G4A | M68874 | phospholipase A2, group IVA (cytosolic, calcium- |
| | | | dependent) |
| 210156_s_at | PCMT1 | D25547 | protein-L-isoaspartate (D-aspartate) O- |
| | | | methyltransferase |
| 210166_at | TLR5 | AF051151 | toll-like receptor 5 |
| 210434_x_at | JTB | AF151056 | jumping translocation breakpoint |
| 210644_s_at | LAIR1 | AF109683 | leukocyte-associated immunoglobulin-like |
| | | | receptor 1 |
| 210648_x_at | SNX3 | AB047360 | sorting nexin 3 |
| 210875_s_at | ZEB1 | U12170 | zinc finger E-box binding homeobox 1 |
| 211047_x_at | AP2S1 | BC006337 | adaptor-related protein complex 2, sigma 1 |
| | | | subunit |
| 211058_x_at | TUBA1B | BC006379 | tubulin, alpha 1b |
| 211185_s_at | SF3B1 | AF130099 | splicing factor 3b, subunit 1, 155 kDa |
| 211272_s_at | DGKA | AF064771 | diacylglycerol kinase, alpha 80 kDa |
| 211323_s_at | ITPR1 | L38019 | inositol 1,4,5-triphosphate receptor, type 1 |
| 211383_s_at | WDR37 | AL136827 | WD repeat domain 37 |
| 211429_s_at | SERPINA1 | AF119873 | serpin peptidase inhibitor, clade A (alpha-1 |
| | | | antiproteinase, antitrypsin), member 1 |
| 211506_s_at | IL8 | AF043337 | interleukin 8 |
| 211546_x_at | SNCA | L36674 | synuclein, alpha (non A4 component of amyloid |
| | | | precursor) |
| 211684_s_at | DYNC1I2 | AF250307 | dynein, cytoplasmic 1, intermediate chain 2 |
| 211729_x_at | BLVRA | BC005902 | biliverdin reductase A |
| 211856_x_at | CD28 | AF222341 | CD28 molecule |
| 211946_s_at | BAT2D1 | AL096857 | BAT2 domain containing 1 |
| 211965_at | ZFP36L1 | BE620915 | zinc finger protein 36, C3H type-like 1 |
| 212030_at | RBM25 | BG251218 | RNA binding motif protein 25 |
| 212042_x_at | hCG_31916///RPL7 | BG389744 | ribosomal protein L7///hCG31916 |
| 212132_at | LSM14A | AL117499 | LSM14A, SCD6 homolog A (S. cerevisiae) |
| 212213_x_at | OPA1 | AB011139 | optic atrophy 1 (autosomal dominant) |
| 212299_at | NEK9 | AL117502 | NIMA (never in mitosis gene a)- related kinase 9 |
| 212331_at | RBL2 | X76061 | retinoblastoma-like 2 (p130) |
| 212334_at | GNS | BE880245 | glucosamine (N-acetyl)-6-sulfatase (Sanfilippo |
| | | | disease IIID) |
| 212406_s_at | PCMTD2 | AB028973 | protein-L-isoaspartate (D-aspartate) O- |
| | | | methyltransferase domain containing 2 |
| 212455_at | YTHDC1 | N36997 | YTH domain containing 1 |
| 212543_at | AIM1 | 083115 | absent in melanoma 1 |
| 212658_at | LHFPL2 | N66633 | lipoma HMGIC fusion partner-like 2 |
| 212663_at | FKBP15 | AB014574 | FK506 binding protein 15, 133 kDa |
| 212769_at | TLE3 | AI567426 | transducin-like enhancer of split 3 (E(sp1) |
| | | | homolog, Drosophila) |
| 212820_at | DMXL2 | AB020663 | Dmx-like 2 |
| 212932_at | RAB3GAP1 | AK022494 | RAB3 GTPase activating protein subunit 1 |
| | | | (catalytic) |
| 212989_at | SGMS1 | AI377497 | sphingomyelin synthase 1 |
| 212997_s_at | TLK2 | AU151689 | tousled-like kinase 2 |
| 213021_at | GOSR1 | AI741876 | golgi SNAP receptor complex member 1 |
| 213152_s_at | SFRS2B | AI343248 | splicing factor, arginine/serine-rich 2B |
| 213205_s_at | RAD54L2 | AU159543 | RAD54-like 2 (S. cerevisiae) |
| 213218_at | ZNF187 | AV705032 | zinc finger protein 187 |
| 213266_at | 76P | BF592982 | Gamma tubulin ring complex protein (76p gene) |
| 213302_at | PFAS | AL044326 | phosphoribosylformylglycinamidine synthase |
| | | | (FGAR amidotransferase) |
| 213335_s_at | ST3GAL6 | AK001922 | ST3 beta-galactoside alpha-2,3-sialyltransferase |
| | | | 6 |
| 213397_x_at | RNASE4 | AI761728 | ribonuclease, RNase A family, 4 |
| 213459_at | RPL37A | AU155515 | ribosomal protein L37a |
| 213494_s_at | YY1 | AA748649 | YY1 transcription factor |
| 213540_at | HSD17B8 | AL031228 | hydroxysteroid (17-beta) dehydrogenase 8 |
| 213693_s_at | MUC1 | AI610869 | mucin 1, cell surface associated |
| 213827_at | SNX26 | AL137579 | sorting nexin 26 |
| 213877_x_at | TCEB2 | AI568533 | transcription elongation factor B (SIII), |
| | | | polypeptide 2 (18 kDa, elonqin B) |
| 214045_at | LIAS | BF056778 | lipoic acid synthetase |
| 214057_at | MCL1 | H71805 | Myeloid cell leukemia sequence 1 (BCL2- |
| | | | related) |
| 214330_at | ATPAF2 | AF070584 | ATP synthase mitochondrial F1 complex |
| | | | assembly factor 2 |
| 214364_at | MTERFD2 | W84525 | MTERF domain containing 2 |
| 214430_at | GLA | NM_000169 | galactosidase, alpha |
| 214511_x_at | FCGR1B | L03419 | Fc fragment of IgG, high affinity Ib, receptor |
| | | | (CD64) |
| 214629_x_at | RTN4 | AF320999 | reticulon 4 |
| 214683_s_at | CLK1 | A1251890 | CDC-like kinase 1 |
| 214820_at | BRWD1 | AJ002572 | bromodomain and WD repeat domain |
| | | | containing. 1 |
| 214853_s_at | SHC1 | A1091079 | SHC (Src homology 2 domain containing) |
| | | | transforming protein 1 |
| 214931_s_at | SRPK2 | AC005070 | SFRS protein kinase 2 |
| 214953_s_at | APP | X06989 | amyloid beta (A4) precursor protein (peptidase |
| | | | nexin-11, Alzheimer disease) |
| 215009_s_at | SEC31A | U92014 | SEC31 homolog A (S. cerevisiae) |
| 215049_x_at | CD163 | Z22969 | CD163 molecule |
| 215273_s_at | TADA3L | AK024982 | transcriptional adaptor 3 (NGG1 homolog, |
| | | | yeast)-like |
| 215293_s_at | FRAG1 | AL049261 | FGF receptor activating protein 1 |
| 215567_at | FCF1 | AU144919 | FCF1 small subunit (SSU) processome |
| | | | component homolog (S. cerevisiae) |
| 215997_s_at | CUL4B | AV694732 | cullin 4B |
| 216484_x_at | HDGF | L24521 | Hepatoma-derived growth factor (high-mobility |
| | | | group protein 1-like) |
| 216950_s_at | FCGR1A | X14355 | Fc fragment of IgG, high affinity la, receptor |
| | | | (CD64) |
| 217383_at | PGK1 | S81916 | Phosphoglycerate kinase 1 |
| 217403_s_at | ZNF227 | AC074331 | zinc finger protein 227 |
| 217466_x_at | LOC400963/// | L48784 | ribosomal protein S2///hypothetical gene |
| | LOC440589/// | | supported by AB082925; BC019021; NM |
| | LOC441013/// | | 002952 III similar to ribosomal protein S2/// |
| | LOC645173/// | | hypothetical LOC645173 |
| | LOC646294/// | | |
| | LOC650901/// | | |
| | LOC729274/// | | |
| | RPS2 | | |
| 217769_s_at | POMP | NM_015932 | proteasome maturation protein |
| 217778_at | SLC39A1 | NM_014437 | solute carrier family 39 (zinc transporter), |
| | | | member 1 |
| 217824_at | UBE2J1 | AW500009 | ubiquitin-conjugating enzyme E2, J1 (UBC6 |
| | | | homolog, yeast) |
| 217987_at | ASNSD1 | NM_019048 | asparagine synthetase domain containing 1 |
| 217995_at | SQRDL | NM_021199 | sulfide quinone reductase-like (yeast) |
| 218012_at | TSPYL2 | NM_022117 | TSPY-like 2 |
| 218040_at | PRPF38B | NM_018061 | PRP38 pre-mRNA processing factor 38 (yeast) |
| | | | domain containing B |
| 218065_s_at | TMEM9B | NM_020644 | TMEM9 domain family, member B |
| 218091_at | HRB | AI989512 | HIV-1 Rev binding protein |
| 218125_s_at | CCDC25 | NM_018246 | coiled-coil domain containing 25 |
| 218127_at | NFYB | AI804118 | nuclear transcription factor Y, beta |
| 218143_s_at | SCAMP2 | NM_005697 | secretory carrier membrane protein 2 |
| 218206_x_at | SCAND1 | NM_016558 | SCAN domain containing 1 |
| 218289_s_at | UBE1DC1 | NM_024818 | ubiquitin-activating enzyme E1-domain |
| | | | containing 1 |
| 218325_s_at | DIDO1 | NM_022105 | death inducer-obliterator 1 |
| 218351_at | COMMD8 | NM_017845 | COMM domain containing 8 |
| 218499_at | RP6-213H19.1 | NM_016542 | serine/threonine protein kinase MST4 |
| 218627_at | DRAM | NM_018370 | damage-regulated autophaqy modulator |
| 218718_at | PDGFC | NM_016205 | platelet derived growth factor C |
| 218732_at | PTRH2 | NM_016077 | peptidyl-tRNA hydrolase 2 |
| 218845_at | DUSP22 | NM_020185 | dual specificity phosphatase 22 |
| 218962_s_at | TMEM168 | NM_022484 | transmembrane protein 168 |
| 219130_at | CCDC76 | NM_019083 | coiled-coil domain containing 76 |
| 219316_s_at | F VCR2 | NM_017791 | feline leukemia virus subgroup C cellular |
| | | | receptor family, member 2 |
| 219343_at | CDC37L1 | NM_017913 | cell division cycle 37 homolog (S. cerevisiae)- |
| | | | like 1 |
| 219358_s_at | CENTA2 | NM_018404 | centaurin, alpha 2 |
| 219418_at | NHEJ1 | NM_024782 | nonhomologous end-joining factor 1 |
| 219507_at | RSRC1 | NM_016625 | arginine/serine-rich coiled-coil 1 |
| 219765_at | ZNF329 | NM_024620 | zinc finger protein 329 |
| 219787_s_at | ECT2 | NM_018098 | epithelial cell transforming sequence 2 |
| | | | oncogene |
| 219822_at | MTRF1 | NM_004294 | mitochondrial translational release factor 1 |
| 219826_at | ZNF419 | NM_024691 | zinc finger protein 419 |
| 219952_s_at | MCOLN1 | NM_020533 | mucolipin 1 |
| 220044_x_at | CROP | NM_016424 | cisplatin resistance-associated overexpressed |
| | | | protein |
| 220146_at | TLR7 | NM_016562 | toll-like receptor 7 |
| 220160_s_at | KPTN | NM_007059 | kaptin (actin binding protein) |
| 220386_s_at | EML4 | NM_019063 | echinoderm microtubule associated protein like |
| | | | 4 |
| 220578_at | ADAMTSL4 | NM_025008 | ADAMTS-like 4 |
| 220605_s_at | SIRT2 | NM_012237 | sirtuin (silent mating type information regulation |
| | | | 2 homolog) 2 (S. cerevisiae) |
| 220610_s_at | LRRFIP2 | NM_006309 | leucine rich repeat (in FLII) interacting protein 2 |
| 220690_s_at | DHRS7B | NM_015510 | dehydrogenase/reductase (SDR family) member |
| | | | 7B |
| 220750_s_at | LEPRE1 | NM_022356 | leucine proline-enriched proteoglycan (leprecan) |
| | | | 1 |
| 220865_s_at | PDSS1 | NM_014317 | prenyl (decaprenyl) diphosphate synthase, |
| | | | subunit 1 |
| 220974_x_at | SFXN3 | NM_030971 | sideroflexin 3 |
| 221011_s_at | LBH | NM_030915 | limb bud and heart development homolog |
| | | | (mouse) |
| 22 206_at | PMS2 | NM_024521 | PMS2 postmeiotic segregation increased 2 (S. |
| | | | cerevisiae) |
| 221264_s_at | TARDBP | NM_031214 | TAR DNA binding protein |
| 221428_s_at | TBL1XR1 | NM_030921 | transducin (beta)-like 1X-linked receptor 1 |
| 221449_s_at | ITFG1 | NM_030790 | integrin alpha FG-GAP repeat containing 1 |
| 221580_s_at | JOSD3 | BC001972 | Josephin domain containing 3 |
| 221601_s_at | FAIM3 | A1084226 | Fas apoptotic inhibitory molecule 3 |
| 221647_s_at | RIC8A | AL136935 | resistance to inhibitors of cholinesterase 8 |
| | | | homolog A (C. elegans) |
| 221731_x_at | VCAN | BF218922 | versican |
| 221757_at | PIK3IP1 | BE042976 | phosphoinositide-3-kinase interacting protein 1 |
| 221841_s_at | KLF4 | BF514079 | Kruppel-like factor 4 (gut) |
| 221868_at | PAIP2B | AB032981 | poly(A) binding protein interacting protein 2B |
| 221960_s_at | RAB2A | A1189609 | RAB2A, member RAS oncoqene family |
| 222217_s_at | SLC27A3 | BC003654 | solute carrier family 27 (fatty acid transporter), |
| | | | member 3 |
| 222231_s_at | LRRC59 | AK025328 | leucine rich repeat containing 59 |
| 222574_s_at | DHX40 | BF431360 | DEAH (Asp-Glu-Ala-His) box polypeptide 40 |
| 222605_at | RCOR3 | A1807073 | REST corepressor 3 |
| 222651_s_at | TRPS1 | BF701166 | trichorhinophalangeal syndrome I |
| 222670_s_at | MAFB | AW135013 | v-maf musculoaponeurotic fibrosarcoma |
| | | | oncogene homolog B (avian) |
| 222688_at | PHCA | R12678 | phytoceramidase, alkaline |
| 222700_at | ARL6IP2 | AV700003 | ADP-ribosylation factor-like 6 interacting protein |
| | | | 2 |
| 222753_s_at | SPCS3 | AL136660 | signal peptidase complex subunit 3 homolog (S. |
| | | | cerevisiae) |
| 222757_s_at | ZAK | AB030034 | sterile alpha motif and leucine zipper containing |
| | | | kinase AZK |
| 222774_s_at | NETO2 | AI335263 | neuropilin (NRP) and tolloid (TLL)-like 2 |
| 222884_at | ZNF346 | AI830579 | zinc finger protein 346 |
| 222980_at | RAB10 | AL136650 | RAB10, member RAS oncogene family |
| 222982_x_at | SLC38A2 | AF298897 | solute carrier family 38, member 2 |
| 223023_at | BET1L | BC000688 | blocked early in transport 1 homolog (S. |
| | | | cerevisiae)-like |
| 223064_at | RNF181 | AF151072 | ring finger protein 181 |
| 223158_s_at | NEK6 | BE616825 | NIMA (never in mitosis gene a)-related kinase 6 |
| 223380_s_at | LATS2 | AF207547 | LATS, large tumor suppressor, homolog 2 |
| | | | (Drosophila) |
| 223444_at | SENP7 | AL136599 | SUMO1/sentrin specific peptidase 7 |
| 223465_at | COL4A3BP | BE967275 | collagen, type IV, alpha 3 (Goodpasture antigen) |
| | | | binding protein |
| 223590_at | ZNF700 | AL136732 | zinc finger protein 700 |
| 223686_at | TPK1 | AB028138 | thiamin pyrophosphokinase 1 |
| 223801_s_at | APOL4 | AY014914 | apolipoprotein L, 4 |
| 223922_x_at | MS4A6A | AB013104 | membrane-spanning 4-domains, subfamily A, |
| | | | member 6A |
| 223982_s_at | PNPLA8 | AB041261 | patatin-like phospholipase domain containing 8 |
| 224046_s_at | PDE7A | U67932 | phosphodiesterase 7A |
| 224374_s_at | EMILIN2 | AF270513 | elastin microfibril interfacer 2 |
| 224387_at | COMMD5 | AF290195 | COMM domain containing 5 |
| 224439_x_at | RNF7 | BC005966 | ring finger protein 7 |
| 224518_s_at | ZNF559 | BC006436 | zinc finger protein 559 |
| 224582_s_at | NUCKS1 | H09085 | nuclear casein kinase and cyclin-dependent |
| | | | kinase substrate 1 |
| 224591_at | HP1BP3 | AK023129 | heterochromatin protein 1, binding protein 3 |
| 224726_at | MIB1 | W80418 | mindbomb homolog 1 (Drosophila) |
| 224818_at | SORT1 | BE622952 | sortilin 1 |
| 224917_at | MIRN21 | BF674052 | microRNA 21 |
| 224918_x_at | MGST1 | AI220117 | microsomal glutathione S-transferase 1 |
| 224928_at | SETD7 | AK024846 | SET domain containing (lysine- |
| | | | methyltransferase) 7 |
| 225059_at | AGTRAP | BE875567 | angiotensin II receptor-associated protein |
| 225064_at | RABEP1 | R60018 | rabaptin, RAB GTPase binding effector protein 1 |
| 225107_at | HNRNPA2B1 | A1963008 | heterogeheous nuclear ribonucleoprotein A2/B1 |
| 225188_at | RAPH1 | AA194149 | Ras association (RaIGDS/AF-6) and pleckstrin |
| | | | homology domains 1 |
| 225341_at | MTERFD3 | BF697312 | MTERF domain containing 3 |
| 225358_at | DNAJCI9 | A1003794 | DnaJ (Hsp40) homolog, subfamily C, member |
| | | | 19 |
| 225365_at | ZDHHC20 | BG249221 | zinc finger, DHHC-type containing 20 |
| 225388_at | TSPAN5 | A1928507 | tetraspanin 5 |
| 225456_at | MED1 | A1708776 | mediator complex subunit 1 |
| 225763_at | RCSD1 | A1659418 | RCSD domain containing 1 |
| 225844_at | POLE4 | NM_019896 | polymerase (DNA-directed), epsilon 4 (p12 |
| | | | subunit) |
| 225866_at | BXDC1 | AA976536 | brix domain containing 1 |
| 225870_s_at | TRAPPC5 | BF569208 | trafficking protein particle complex 5 |
| 226000_at | CTTNBP2NL | A1423056 | CTTNBP2 N-terminal like |
| 226030_at | ACADSB | BE897866 | acyl-Coenzyme A dehydrogenase, |
| | | | short/branched chain |
| 226042_at | EDC3 | AL563608 | enhancer of mRNA decapping 3 homolog (S. |
| | | | cerevisiae) |
| 226059_at | TOMM4OL | AK022832 | translocase of outer mitochondrial membrane 40 |
| | | | homolog (yeast)-like |
| 226115_at | AHCTF1 | A1138934 | AT hook containing transcription factor 1 |
| 226127_at | ALKBH3 | BF062547 | alkB, alkylation repair homoloq 3 (E. coli) |
| 226218_at | IL7R | BE217880 | interleukin 7 receptor |
| 226220_at | METTL9 | BE551054 | Methyltransferase like 9 |
| 226323_at | CCDC16 | AA398517 | coiled-coil domain containing 16 |
| 226353_at | SPPL2A | A1674647 | signal peptide peptidase-like 2A |
| 226428_at | TNPO2 | A1885873 | transportin 2 (importin 3, karyopherin beta 2b) |
| 226459_at | PIK3AP1 | AW575754 | phosphoinositide-3-kinase adaptor protein 1 |
| 226503_at | RIF1 | BE504653 | RAP1 interacting factor homolog (yeast) |
| 226683_at | SNAG1 | AU146771 | Sorting nexin associated golgi protein 1 |
| 226718_at | AMIGO1 | AA001423 | adhesion molecule with Ig-like domain 1 |
| 226763_at | SESTD1 | AW409611 | SEC14 and spectrin domains 1 |
| 226836_at | SFT2D1 | AA044813 | SFT2 domain containing 1 |
| 227020_at | YPEL2 | BE502982 | yippee-like 2 (Drosophila) |
| 227114_at | RNF214 | BG435876 | ring finger protein 214 |
| 227149_at | TNRC6C | AB046802 | trinucleotide repeat containing 6C |
| 227173_s_at | BACH2 | AW450901 | BTB and CNC homology 1, basic leucine zipper |
| | | | transcription factor 2 |
| 227213_at | ADAT2 | AA706895 | adenosine deaminase, tRNA-specific 2, TAD2 |
| | | | homolog (S. cerevisiae) |
| 227374_at | EARS2 | AA833716 | glutamyl-tRNA synthetase 2, mitochondrial |
| | | | (putative) |
| 227517_s_at | GAS5 | A1056992 | growth arrest-specific 5 |
| 227558_at | CBX4 | A1570531 | chromobox homolog 4 (Pc class homolog, |
| | | | Drosophila) |
| 227560_at | SFXN2 | AL530504 | sideroflexin 2 |
| 227722_at | RPS23 | AW043594 | ribosomal protein S23 |
| 227990_at | SLU7 | AA843238 | SLU7 splicing factor homolog (S. cerevisiae) |
| 228012_at | MATR3 | N53862 | Matrin 3 |
| 228170_at | 0 G1 | AL355743 | oligodendrocyte transcription factor 1 |
| 228176_at | EDG3 | AA534817 | endothelial differentiation, sphingolipid G-protein- |
| | | | coupled receptor, 3 |
| 228234_at | TICAM2 | A1423165 | toll-like receptor adaptor molecule 2 |
| 228370_at | SNRPN | BF114870 | Small nuclear ribonucleoprotein polypeptide N |
| 228549_at | TMEM63A | A1491983 | Transmembrane protein 63A |
| 228630_at | ZNF84 | W92744 | Zinc finger protein 84 |
| 228831_s_at | GNG7 | AL039870 | guanine nucleotide binding protein (G protein), |
| | | | gamma 7 |
| 229307_at | ANKRD28 | N32051 | ankyrin repeat domain 28 |
| 229421_s_at | FLJ20273 | BF435329 | RNA-binding protein |
| 229509_at | MFSD8 | AA534752 | major facilitator superfamily domain containing 8 |
| 229854_at | OBSCN | AW614056 | obscurin, cytoskeletal calmodulin and titin- |
| | | | interacting RhoGEF |
| 229982_at | QSER1 | AW195525 | glutamine and serine rich 1 |
| 230265_at | SEL1L | BE671138 | Sel-1 suppressor of lin-12-like (C. elegans) |
| 230320_at | TBRG1 | AW291696 | transforming growth factor beta regulator 1 |
| 230408_at | PCGF3 | BG231712 | Polycomb group ring finger 3 |
| 230480_at | PIWIL4 | A1808955 | piwi-like 4 (Drosophila) |
| 230837_at | LOC647500 | N67108 | similar to phosphodiesterase 4D interacting |
| | | | protein isoform 1 |
| 230852_at | STAC3 | AW663959 | SH3 and cysteine rich domain 3 |
| 230922_x_at | FUNDC2 | H09739 | FUN14 domain containing 2 |
| 231283_at | MGAT4A | AW271609 | mannosyl (alpha-1,3-)-glycoprotein beta-1,4-N- |
| | | | acetylglucosaminyltransferase, isozyme A |
| 231697_s_at | TMEM49 | AV660825 | Transmembrane protein 49 |
| 231836_at | HKR1 | BC004513 | GLI-Kruppel family member HKR1 |
| 231843_at | DDX55 | AB046815 | DEAD (Asp-Glu-Ala-Asp) box polypeptide 55 |
| 231845_at | AARS2 | AI721172 | alanyl-tRNA synthetase 2, mitochondrial |
| | | | (putative) |
| 231904_at | U2AF1 | AU122448 | U2 small nuclear RNA auxiliary factor 1 |
| 231914_at | NUDT14 | W24623 | nudix (nucleoside diphosphate linked moiety X)- |
| | | | type motif 14 |
| 232636_at | SLITRK4 | AL080239 | SLIT and NTRK-like family, member 4 |
| 232851_at | FBXO3 | AL162053 | F-box protein 3 |
| 233019_at | CNOT7 | AU145061 | CCR4-NOT transcription complex, subunit 7 |
| 233169_at | ZNF350 | AU145915 | zinc finger protein 350 |
| 234013_at | TRA@ | AE000659 | T cell receptor alpha locus///Clone PSA.S.31 T- |
| | | | cell receptor alpha chain |
| 234311_s_at | GTPBP10 | AC006153 | GTP-bindinq protein 10 (putative) |
| 234339_s_at | GLTSCR2 | AF296124 | glioma tumor suppressor candidate region gene |
| | | | 2 |
| 234464_s_at | EME1 | AK021607 | essential meiotic endonuclease 1 homolog 1 (S. |
| | | | pombe) |
| 234733_s_at | FANCM | AK001672 | Fanconi anemia, complementation group M |
| 235024_at | PHF17 | AI868315 | PHD finger protein 17 |
| 235067_at | MKLN1 | D81987 | muskelin 1, intracellular mediator containing |
| | | | kelch motifs |
| 235200_at | ZNF561 | AL135342 | zinc finger protein 561 |
| 235359_at | LRRC33 | AA534416 | leucine rich repeat containing 33 |
| 235593_at | ZEB2 | AL546529 | zinc finger E-box binding homeobox 2 |
| 235610_at | ALKBH8 | AI590659 | alkB, alkylation repair homolog 8 (E. coli) |
| 235623_at | ELP2 | BF526230 | Elongation protein 2 homoloq (S. cerevisiae) |
| 235690_at | ZNF594 | AA872562 | zinc finger protein 594 |
| 237504_at | INTS10 | AW002398 | integrator complex subunit 10 |
| 238429_at | TMEM71 | AI342543 | transmembrane protein 71 |
| 238513_at | PRRG4 | BF905445 | Proline rich Gla (G-carboxyglutamic acid) 4 |
| | | | (transmembrane) |
| 238736_at | REV3L | AA805939 | REV3-like, catalytic subunit of DNA polymerase |
| | | | zeta (yeast) |
| 238823_at | FMNL3 | AA481044 | formin-like 3 |
| 238909_at | S100A10 | BF126155 | S100 calcium binding protein A10 |
| 239108_at | MLSTD1 | H16791 | Male sterility domain containing 1 |
| 239897_at | BCLAF1 | AW152620 | BCL2-associated transcription factor 1 |
| 241368_at | LSDP5 | AI190693 | lipid storage droplet protein 5 |
| 241704_x_at | ZNF320 | AI025436 | zinc finger protein 320 |
| 241706_at | CPNE8 | AA431782 | copine VIII |
| 241731_x_at | ZNF440 | AA883653 | zinc finger protein 440 |
| 242197_x_at | CD36 | W95035 | CD36 molecule (thrombospondin receptor) |
| 242561_at | IPO9 | AW075415 | importin 9 |
| 242569_at | STAM2 | N57099 | Signal transducing adaptor molecule (SH3 |
| | | | domain and ITAM motif) 2 |
| 242669_at | UFM1 | BF514975 | Ubiquitin-fold modifier 1 |
| 243982_at | KLHL28 | AA455180 | Kelch-like 28 (Drosophila) |
| 244038_at | WDR89 | AW069315 | WD repeat domain 89 |
| 244654_at | MYO1G | BE646398 | myosin IG |
| 244698_at | CDRT4 | AW297656 | CMT1A duplicated region transcript 4 |
| 36566_at | CTNS | AJ222967 | cystinosis, nephropathic |
| 37549 _g_at | BBS9 | U87408 | Bardet-Biedl syndrome 9 |
| 48659_at | RP5-107789.4 | W60802 | invasion inhibitory protein 45 |
| 56829_at | NIBP | H61826 | NIK and IKK{beta} binding protein |
| 64486_at | CORO1B | AI341234 | coronin, actin binding protein, 1B |
| 65493_at | HEATR6 | AA555088 | HEAT repeat containing 6 |
| AFFX- | GAPDH | NM_002046 | glyceraldehyde-3-phosphate dehydrogenase |
| HUMGAPDH/ | | | |
| M331973_at | | | |

TABLE 3

| | | | | | | | | Extreme |
|---|---|---|---|---|---|---|---|---|
| | | | | | | Extreme | | control- |
| | | | | | | NYHA I-II- | | directional |
| | | | | | | directional | | fold- |
| | | Statistical | Maximum | Average | | fold-change | | change |
| | | significance | overall | fold-change | Average fold- | observed | Average | observed |
| | | of | accuracy of | gene | change | (Extreme | fold-change | (Extreme |
| | | differential | classification | expression | expression at | NYHA | expression at | Control/ |
| Affymetrix Probe | | expression | power | (NYHA I-II/ | sensitivity = | I-II/average | specificity = | average |
| set ID | Gene symbol | (p-value) | (ROC AUC) | Control) | 0.6 | Control) | 0.6 | Control) |
| 1552630_a_at | SRCAP | 2.52E−03 | 0.701 | 0.831 | 0.800 | 0.415 | 1.032 | 1.417 |
| 1554149_at | CLDND1 | 2.85E−02 | 0.681 | 0.907 | 0.852 | 0.587 | 1.048 | 1.291 |
| 1554606_at | CCDC100 | 7.47E−03 | 0.710 | 0.860 | 0.811 | 0.423 | 1.100 | 1.175 |
| 1555630_a_at | RAB34 | 2.76E−03 | 0.731 | 1.277 | 1.115 | 2.496 | 1.044 | 0.591 |
| 1555963_x_at | B3GNT7 | 1.34E−03 | 0.705 | 1.206 | 1.119 | 1.950 | 1.105 | 0.719 |
| 1556113_at | DKFZp451A211 | 1.63E−02 | 0.679 | 1.118 | 1.065 | 1.523 | 1.060 | 0.722 |
| 1556283_s_at | FGFR1OP2 | 3.82E−03 | 0.732 | 1.194 | 1.122 | 1.665 | 1.028 | 0.634 |
| 1556864_at | TECT1 | 1.30E−03 | 0.736 | 0.849 | 0.866 | 0.569 | 1.010 | 1.424 |
| 1557066_at | LUC7L | 2.91E−02 | 0.697 | 0.873 | 0.840 | 0.474 | 1.064 | 1.349 |
| 1558277_at | ZNF740 | 1.18E−03 | 0.741 | 1.326 | 1.149 | 2.721 | 1.038 | 0.648 |
| 1558755_x_at | ZNF763 | 3.51E−03 | 0.717 | 0.816 | 0.736 | 0.434 | 1.118 | 1.312 |
| 1561146_at | VPS35 | 9.85E−04 | 0.736 | 0.789 | 0.773 | 0.364 | 1.030 | 1.929 |
| 1564962_at | ZNF92 | 4.83E−04 | 0.791 | 0.799 | 0.740 | 0.535 | 1.019 | 1.521 |
| 1568815_a_at | DDX50 | 1.56E−02 | 0.709 | 0.836 | 0.804 | 0.449 | 1.010 | 2.085 |
| 200007_at | SRP14 | 9.03E−04 | 0.756 | 1.080 | 1.062 | 1.268 | 1.039 | 0.854 |
| 200059_s_at | RHOA | 1.12E−03 | 0.743 | 1.068 | 1.044 | 1.229 | 1.015 | 0.867 |
| 200633_at | UBB | 4.40E−03 | 0.735 | 1.102 | 1.089 | 1.460 | 1.027 | 0.785 |
| 200650_s_at | LDHA | 2.14E−02 | 0.649 | 1.099 | 1.043 | 1.560 | 1.052 | 0.736 |
| 200672_x_at | SPTBN1 | 4.56E−02 | 0.670 | 0.893 | 0.787 | 0.523 | 1.030 | 1.532 |
| 200713_s_at | MAPRE1 | 2.56E−04 | 0.778 | 1.106 | 1.069 | 1.415 | 1.009 | 0.906 |
| 200822_x_at | TPI1 | 3.61E−03 | 0.718 | 1.102 | 1.077 | 1.387 | 1.009 | 0.723 |
| 200829_x_at | ZNF207 | 1.69E−04 | 0.780 | 1.147 | 1.102 | 1.426 | 1.042 | 0.812 |
| 200839_s_at | CTSB | 3.74E−03 | 0.744 | 1.199 | 1.136 | 1.939 | 1.034 | 0.546 |
| 200932_s_at | DCTN2 | 3.28E−03 | 0.723 | 1.069 | 1.039 | 1.506 | 1.024 | 0.881 |
| 200950_at | ARPC1A | 7.18E−04 | 0.759 | 1.102 | 1.080 | 1.342 | 1.009 | 0.880 |
| 201075_s_at | SMARCC1 | 7.66E−05 | 0.801 | 0.874 | 0.839 | 0.717 | 1.024 | 1.246 |
| 201098_at | COPB2 | 1.20E−03 | 0.750 | 1.079 | 1.045 | 1.347 | 1.020 | 0.897 |
| 201105_at | LGALS1 | 1.17E−03 | 0.778 | 1.339 | 1.256 | 2.357 | 1.041 | 0.513 |
| 201172_x_at | ATP6V0E1 | 5.94E−03 | 0.699 | 1.075 | 1.048 | 1.284 | 1.030 | 0.865 |
| 201186_at | LRPAP1 | 2.18E−02 | 0.660 | 1.119 | 1.033 | 1.615 | 1.027 | 0.783 |
| 201193_at | IDH1 | 1.59E−04 | 0.756 | 1.192 | 1.124 | 1.634 | 1.078 | 0.784 |
| 201198_s_at | PSMD1 | 8.47E−04 | 0.769 | 1.138 | 1.120 | 1.517 | 1.051 | 0.736 |
| 201220_x_at | CTBP2 | 4.25E−02 | 0.665 | 1.085 | 1.053 | 1.498 | 1.028 | 0.796 |
| 201234_at | ILK | 8.39E−05 | 0.790 | 1.137 | 1.082 | 1.696 | 1.015 | 0.867 |
| 201357_s_at | SF3A1 | 5.49E−05 | 0.813 | 0.847 | 0.830 | 0.582 | 1.002 | 1.293 |
| 201363_s_at | IVNS1ABP | 2.68E−04 | 0.771 | 0.851 | 0.846 | 0.550 | 1.016 | 1.300 |
| 201400_at | PSMB3 | 4.52E−03 | 0.718 | 1.106 | 1.067 | 1.541 | 1.011 | 0.820 |
| 201422_at | IFI30 | 3.74E−03 | 0.714 | 1.151 | 1.090 | 1.651 | 1.026 | 0.686 |
| 201426_s_at | VIM | 9.14E−03 | 0.748 | 1.092 | 1.055 | 1.367 | 1.004 | 0.847 |
| 201453_x_at | RHEB | 1.65E−03 | 0.738 | 1.084 | 1.064 | 1.331 | 1.025 | 0.810 |
| 201470_at | GSTO1 | 2.91E−03 | 0.736 | 1.171 | 1.080 | 2.090 | 1.005 | 0.770 |
| 201527_at | ATP6V1F | 4.72E−03 | 0.713 | 1.093 | 1.068 | 1.414 | 1.037 | 0.839 |
| 201536_at | DUSP3 | 2.41E−02 | 0.644 | 1.160 | 1.044 | 2.261 | 1.035 | 0.742 |
| 201554_x_at | GYG1 | 4.62E−02 | 0.638 | 1.140 | 1.018 | 2.004 | 1.011 | 0.674 |
| 201556_s_at | VAMP2 | 3.34E−04 | 0.771 | 0.810 | 0.755 | 0.494 | 0.985 | 1.523 |
| 201576_s_at | GLB1 | 8.64E−03 | 0.720 | 1.108 | 1.060 | 1.374 | 1.022 | 0.743 |
| 201590_x_at | ANXA2 | 1.98E−04 | 0.799 | 1.259 | 1.172 | 1.807 | 1.062 | 0.631 |
| 201628_s_at | RRAGA | 2.82E−03 | 0.744 | 1.086 | 1.047 | 1.318 | 1.029 | 0.842 |
| 201900_s_at | AKR1A1 | 2.20E−03 | 0.729 | 1.158 | 1.069 | 1.799 | 1.023 | 0.770 |
| 201945_at | FURIN | 7.29E−03 | 0.685 | 0.846 | 0.808 | 0.464 | 1.023 | 1.482 |
| 202068_s_at | LDLR | 9.51E−03 | 0.708 | 1.352 | 1.149 | 3.500 | 1.029 | 0.406 |
| 202138_x_at | JTV1 | 1.35E−03 | 0.726 | 1.135 | 1.064 | 1.523 | 1.048 | 0.776 |
| 202185_at | PLOD3 | 5.67E−04 | 0.778 | 1.135 | 1.107 | 1.479 | 1.023 | 0.797 |
| 202201_at | BLVRB | 1.21E−02 | 0.731 | 1.196 | 1.081 | 2.124 | 1.001 | 0.675 |
| 202249_s_at | WDR42A | 1.48E−02 | 0.695 | 0.925 | 0.875 | 0.748 | 1.030 | 1.224 |
| 202252_at | RAB13 | 1.20E−02 | 0.703 | 1.374 | 1.125 | 6.988 | 1.083 | 0.711 |
| 202428_x_at | DBI | 3.93E−05 | 0.810 | 1.174 | 1.121 | 1.569 | 1.038 | 0.807 |
| 202445_s_at | NOTCH2 | 1.12E−02 | 0.714 | 0.874 | 0.831 | 0.551 | 1.060 | 1.223 |
| 202461_at | EIF2B2 | 5.63E−04 | 0.803 | 1.195 | 1.151 | 1.755 | 1.059 | 0.653 |
| 202522_at | PITPNB | 1.15E−03 | 0.762 | 1.094 | 1.072 | 1.291 | 1.017 | 0.822 |
| 202523_s_at | SPOCK2 | 1.53E−02 | 0.670 | 0.834 | 0.630 | 0.347 | 1.065 | 1.476 |
| 202623_at | EAPP | 3.76E−04 | 0.763 | 0.917 | 0.896 | 0.756 | 1.012 | 1.174 |
| 202652_at | APBB1 | 1.06E−02 | 0.719 | 0.862 | 0.805 | 0.403 | 1.019 | 1.429 |
| 202724_s_at | FOXO1 | 7.97E−03 | 0.668 | 0.881 | 0.857 | 0.560 | 0.997 | 1.437 |
| 202778_s_at | ZMYM2 | 1.35E−03 | 0.741 | 0.907 | 0.874 | 0.640 | 1.026 | 1.162 |
| 202928_s_at | PHF1 | 3.96E−04 | 0.769 | 0.852 | 0.808 | 0.460 | 1.013 | 1.320 |
| 202944_at | NAGA | 1.96E−03 | 0.740 | 1.226 | 1.152 | 1.815 | 1.008 | 0.676 |
| 203003_at | MEF2D | 3.66E−04 | 0.799 | 0.835 | 0.820 | 0.603 | 0.978 | 1.416 |
| 203127_s_at | SPTLC2 | 2.12E−03 | 0.737 | 1.199 | 1.125 | 1.838 | 1.058 | 0.719 |
| 203137_at | WTAP | 7.00E−03 | 0.697 | 0.929 | 0.903 | 0.744 | 1.030 | 1.177 |
| 203305_at | F13A1 | 3.94E−02 | 0.644 | 1.306 | 1.066 | 3.596 | 1.052 | 0.534 |
| 203413_at | NELL2 | 2.75E−02 | 0.699 | 0.799 | 0.658 | 0.309 | 1.017 | 1.764 |
| 203416_at | CD53 | 4.36E−03 | 0.702 | 1.063 | 1.041 | 1.275 | 1.019 | 0.867 |
| 203534_at | LSM1 | 1.23E−04 | 0.818 | 1.149 | 1.114 | 1.460 | 1.024 | 0.815 |
| 203759_at | ST3GAL4 | 1.17E−02 | 0.710 | 0.768 | 0.713 | 0.417 | 1.066 | 2.047 |
| 203844_at | VHL | 1.12E−02 | 0.674 | 1.066 | 1.028 | 1.448 | 1.029 | 0.794 |
| 203880_at | COX17 | 1.35E−03 | 0.741 | 1.167 | 1.090 | 1.714 | 1.046 | 0.695 |
| 203912_s_at | DNASE1L1 | 1.75E−03 | 0.764 | 1.201 | 1.156 | 1.660 | 1.051 | 0.647 |
| 203939_at | NT5E | 8.38E−03 | 0.710 | 0.802 | 0.642 | 0.370 | 1.004 | 1.778 |
| 204050_s_at | CLTA | 1.90E−03 | 0.748 | 1.107 | 1.058 | 1.398 | 1.010 | 0.865 |
| 204099_at | SMARCD3 | 8.10E−03 | 0.686 | 1.240 | 1.092 | 2.367 | 1.074 | 0.701 |
| 204243_at | RLF | 9.43E−03 | 0.701 | 1.122 | 1.084 | 1.534 | 1.064 | 0.752 |
| 204249_s_at | LMO2 | 8.50E−03 | 0.749 | 1.162 | 1.130 | 1.884 | 1.014 | 0.804 |
| 204291_at | ZNF518 | 4.67E−02 | 0.641 | 0.924 | 0.901 | 0.361 | 1.037 | 1.201 |
| 204401_at | KCNN4 | 5.05E−03 | 0.709 | 0.828 | 0.723 | 0.283 | 1.040 | 1.629 |
| 204617_s_at | ACD | 3.92E−03 | 0.724 | 0.895 | 0.839 | 0.690 | 1.045 | 1.209 |
| 204645_at | CCNT2 | 3.56E−04 | 0.758 | 0.886 | 0.870 | 0.556 | 1.009 | 1.238 |
| 204675_at | SRD5A1 | 3.83E−04 | 0.788 | 1.321 | 1.159 | 2.286 | 1.037 | 0.572 |
| 204801_s_at | DHRS12 | 1.62E−03 | 0.756 | 0.757 | 0.644 | 0.407 | 1.089 | 1.834 |
| 205235_s_at | MPHOSPH1 | 3.01E−03 | 0.742 | 0.905 | 0.885 | 0.735 | 1.033 | 1.309 |
| 205254_x_at | TCF7 | 3.47E−02 | 0.660 | 0.862 | 0.676 | 0.167 | 1.007 | 1.924 |
| 205256_at | ZBTB39 | 4.74E−02 | 0.661 | 0.935 | 0.891 | 0.721 | 1.012 | 1.321 |
| 205550_s_at | BRE | 2.43E−02 | 0.674 | 1.057 | 1.025 | 1.234 | 1.023 | 0.835 |
| 206170_at | ADRB2 | 4.22E−04 | 0.788 | 1.459 | 1.338 | 2.681 | 1.109 | 0.361 |
| 206182_at | ZNF134 | 4.17E−02 | 0.660 | 0.925 | 0.882 | 0.680 | 1.026 | 1.305 |
| 206542_s_at | SMARCA2 | 1.86E−03 | 0.731 | 0.900 | 0.872 | 0.706 | 1.015 | 1.228 |
| 206715_at | TFEC | 1.82E−02 | 0.678 | 1.269 | 1.104 | 2.537 | 1.068 | 0.516 |
| 206968_s_at | NFRKB | 3.47E−02 | 0.632 | 0.919 | 0.928 | 0.573 | 1.028 | 1.276 |
| 207078_at | MED6 | 9.05E−03 | 0.688 | 0.887 | 0.826 | 0.442 | 1.048 | 1.304 |
| 207113_s_at | TNF | 5.32E−03 | 0.706 | 1.219 | 1.145 | 1.942 | 1.123 | 0.644 |
| 207164_s_at | ZNF238 | 2.47E−03 | 0.714 | 0.845 | 0.792 | 0.260 | 1.008 | 1.390 |
| 207513_s_at | ZNF189 | 4.39E−03 | 0.704 | 0.898 | 0.880 | 0.543 | 1.023 | 1.332 |
| 207543_s_at | P4HA1 | 4.39E−02 | 0.669 | 1.099 | 1.054 | 1.625 | 0.985 | 0.746 |
| 208104_s_at | TSC22D4 | 3.93E−04 | 0.748 | 0.869 | 0.860 | 0.565 | 1.027 | 1.257 |
| 208121_s_at | PTPRO | 4.15E−04 | 0.784 | 1.456 | 1.351 | 3.729 | 1.136 | 0.562 |
| 208161_s_at | ABCC3 | 3.53E−04 | 0.778 | 1.465 | 1.187 | 4.485 | 1.068 | 0.473 |
| 208269_s_at | ADAM28 | 2.06E−03 | 0.748 | 0.859 | 0.817 | 0.568 | 1.052 | 1.412 |
| 208659_at | CLIC1 | 3.13E−02 | 0.683 | 1.054 | 1.040 | 1.342 | 0.987 | 0.890 |
| 208680_at | PRDX1 | 1.37E−03 | 0.746 | 1.224 | 1.124 | 1.805 | 1.067 | 0.676 |
| 208771_s_at | LTA4H | 8.95E−03 | 0.690 | 1.244 | 1.116 | 2.001 | 1.055 | 0.567 |
| 208805_at | PSMA6 | 1.50E−03 | 0.728 | 1.145 | 1.055 | 1.862 | 1.028 | 0.808 |
| 208868_s_at | GABARAPL1 | 1.00E−04 | 0.769 | 0.834 | 0.787 | 0.443 | 1.053 | 1.171 |
| 208921_s_at | SRI | 1.71E−03 | 0.744 | 1.106 | 1.081 | 1.347 | 1.028 | 0.806 |
| 208923_at | CYFIP1 | 1.02E−03 | 0.741 | 1.262 | 1.159 | 2.216 | 1.077 | 0.697 |
| 208946_s_at | BECN1 | 1.90E−04 | 0.759 | 0.938 | 0.925 | 0.810 | 1.012 | 1.115 |
| 209040_s_at | PSMB8 | 7.81E−04 | 0.763 | 1.135 | 1.071 | 1.991 | 1.018 | 0.853 |
| 209099_x_at | JAG1 | 2.79E−02 | 0.661 | 1.201 | 1.043 | 3.100 | 1.034 | 0.692 |
| 209124_at | MYD88 | 8.80E−03 | 0.676 | 1.085 | 1.072 | 1.422 | 0.999 | 0.882 |
| 209191_at | TUBB6 | 4.39E−02 | 0.613 | 1.281 | 0.915 | 2.538 | 1.061 | 0.615 |
| 209218_at | SQLE | 2.18E−03 | 0.719 | 1.389 | 1.143 | 2.894 | 1.085 | 0.578 |
| 209236_at | SLC23A2 | 5.80E−03 | 0.682 | 0.901 | 0.863 | 0.604 | 1.040 | 1.181 |
| 209251_x_at | TUBA1C | 1.78E−02 | 0.687 | 1.090 | 1.052 | 1.375 | 1.045 | 0.809 |
| 209269_s_at | SYK | 7.21E−04 | 0.746 | 0.823 | 0.790 | 0.469 | 1.055 | 1.675 |
| 209675_s_at | HNRPUL1 | 1.14E−03 | 0.742 | 0.870 | 0.856 | 0.599 | 1.036 | 1.341 |
| 209684_at | RIN2 | 2.06E−02 | 0.684 | 1.244 | 1.027 | 2.378 | 1.004 | 0.558 |
| 209892_at | FUT4 | 5.23E−04 | 0.754 | 1.303 | 1.131 | 4.088 | 1.052 | 0.714 |
| 210022_at | PCGF1 | 6.75E−03 | 0.692 | 0.936 | 0.915 | 0.745 | 1.001 | 1.265 |
| 210145_at | PLA2G4A | 1.35E−03 | 0.753 | 1.319 | 1.263 | 2.076 | 1.133 | 0.674 |
| 210156_s_at | PCMT1 | 4.98E−03 | 0.698 | 1.111 | 1.077 | 1.489 | 1.060 | 0.835 |
| 210434_x_at | JTB | 1.84E−04 | 0.790 | 1.097 | 1.063 | 1.266 | 1.044 | 0.845 |
| 210644_s_at | LAIR1 | 8.12E−05 | 0.791 | 1.341 | 1.177 | 3.053 | 1.031 | 0.696 |
| 210648_x_at | SNX3 | 2.36E−04 | 0.770 | 1.134 | 1.086 | 1.549 | 1.002 | 0.854 |
| 210875_s_at | ZEB1 | 6.08E−05 | 0.782 | 0.768 | 0.745 | 0.388 | 1.005 | 1.535 |
| 211047_x_at | AP2S1 | 4.36E−04 | 0.780 | 1.136 | 1.112 | 1.383 | 1.023 | 0.779 |
| 211058_x_at | TUBA1B | 1.56E−02 | 0.688 | 1.059 | 1.037 | 1.262 | 1.019 | 0.857 |
| 211185_s_at | SF3B1 | 3.75E−03 | 0.734 | 0.943 | 0.933 | 0.791 | 1.025 | 1.150 |
| 211323_s_at | ITPR1 | 7.88E−03 | 0.680 | 0.873 | 0.818 | 0.535 | 1.063 | 1.345 |
| 211383_s_at | WDR37 | 1.13E−03 | 0.744 | 1.118 | 1.076 | 1.404 | 1.056 | 0.826 |
| 211506_s_at | IL8 | 4.32E−05 | 0.803 | 0.495 | 0.284 | 0.059 | 1.059 | 2.135 |
| 211684_s_at | DYNC1I2 | 1.57E−03 | 0.754 | 1.182 | 1.135 | 1.720 | 1.047 | 0.655 |
| 211729_x_at | BLVRA | 1.88E−03 | 0.722 | 1.250 | 1.075 | 2.037 | 1.038 | 0.607 |
| 211856_x_at | CD28 | 3.85E−02 | 0.697 | 0.839 | 0.687 | 0.250 | 1.099 | 1.625 |
| 211946_s_at | BAT2D1 | 4.44E−03 | 0.669 | 0.933 | 0.889 | 0.736 | 1.038 | 1.095 |
| 211965_at | ZFP36L1 | 1.31E−03 | 0.729 | 0.737 | 0.634 | 0.361 | 0.965 | 1.774 |
| 212030_at | RBM25 | 2.89E−03 | 0.718 | 0.897 | 0.875 | 0.698 | 1.012 | 1.292 |
| 212132_at | LSM14A | 3.39E−03 | 0.713 | 0.925 | 0.897 | 0.688 | 1.017 | 1.224 |
| 212213_x_at | OPA1 | 3.49E−04 | 0.784 | 1.146 | 1.082 | 1.614 | 1.015 | 0.810 |
| 212299_at | NEK9 | 3.00E−02 | 0.665 | 1.097 | 1.052 | 1.461 | 1.042 | 0.691 |
| 212334_at | GNS | 1.58E−02 | 0.708 | 1.118 | 1.065 | 1.732 | 0.993 | 0.819 |
| 212455_at | YTHDC1 | 4.91E−05 | 0.806 | 0.917 | 0.891 | 0.731 | 1.019 | 1.129 |
| 212543_at | AIM1 | 3.20E−04 | 0.799 | 1.130 | 1.098 | 1.378 | 1.009 | 0.803 |
| 212658_at | LHFPL2 | 3.59E−03 | 0.684 | 1.348 | 1.040 | 4.460 | 1.026 | 0.643 |
| 212663_at | FKBP15 | 2.33E−03 | 0.755 | 1.119 | 1.090 | 1.355 | 1.049 | 0.771 |
| 212769_at | TLE3 | 1.25E−03 | 0.737 | 0.811 | 0.719 | 0.406 | 1.080 | 1.501 |
| 212820_at | DMXL2 | 1.05E−02 | 0.685 | 1.151 | 1.095 | 1.787 | 1.032 | 0.724 |
| 212997_s_at | TLK2 | 2.57E−04 | 0.774 | 0.919 | 0.894 | 0.694 | 1.033 | 1.125 |
| 213218_at | ZNF187 | 3.20E−03 | 0.728 | 0.857 | 0.789 | 0.574 | 1.029 | 1.288 |
| 213335_s_at | ST3GAL6 | 7.83E−03 | 0.676 | 1.124 | 1.041 | 1.792 | 1.043 | 0.729 |
| 213459_at | RPL37A | 6.42E−03 | 0.699 | 0.848 | 0.759 | 0.440 | 1.056 | 1.415 |
| 213494_s_at | YY1 | 9.76E−03 | 0.720 | 1.199 | 1.103 | 2.128 | 0.996 | 0.733 |
| 213877_x_at | TCEB2 | 3.33E−04 | 0.761 | 0.912 | 0.913 | 0.738 | 1.045 | 1.135 |
| 214430_at | GLA | 1.89E−02 | 0.684 | 1.096 | 1.067 | 1.481 | 1.039 | 0.758 |
| 214511_x_at | FCGR1B | 7.32E−03 | 0.704 | 1.560 | 1.237 | 6.652 | 1.032 | 0.439 |
| 214629_x_at | RTN4 | 6.28E−03 | 0.708 | 1.071 | 1.051 | 1.347 | 1.034 | 0.866 |
| 214683_s_at | CLK1 | 6.36E−06 | 0.825 | 0.890 | 0.873 | 0.645 | 1.026 | 1.136 |
| 214820_at | BRWD1 | 4.84E−02 | 0.661 | 0.909 | 0.867 | 0.602 | 1.024 | 1.386 |
| 214853_s_at | SHC1 | 2.47E−05 | 0.834 | 1.131 | 1.112 | 1.327 | 1.003 | 0.788 |
| 214931_s_at | SRPK2 | 6.51E−04 | 0.714 | 0.853 | 0.782 | 0.392 | 1.005 | 1.388 |
| 214953_s_at | APP | 1.43E−03 | 0.730 | 1.359 | 1.144 | 3.691 | 1.022 | 0.733 |
| 215049_x_at | CD163 | 1.76E−02 | 0.689 | 1.279 | 1.144 | 2.654 | 1.060 | 0.596 |
| 215273_s_at | TADA3L | 4.12E−02 | 0.625 | 1.061 | 1.013 | 1.504 | 1.022 | 0.818 |
| 215293_s_at | FRAG1 | 4.04E−03 | 0.733 | 0.882 | 0.817 | 0.610 | 1.012 | 1.344 |
| 215567_at | FCF1 | 3.90E−03 | 0.735 | 0.863 | 0.815 | 0.378 | 1.058 | 1.285 |
| 215997_s_at | CUL4B | 3.73E−04 | 0.747 | 0.848 | 0.803 | 0.355 | 0.983 | 1.284 |
| 216484_x_at | HDGF | 3.37E−03 | 0.699 | 1.083 | 1.043 | 1.582 | 1.026 | 0.892 |
| 216950_s_at | FCGR1A | 1.44E−02 | 0.681 | 1.641 | 1.187 | 9.391 | 1.065 | 0.442 |
| 217383_at | PGK1 | 8.49E−03 | 0.729 | 1.184 | 1.137 | 1.810 | 1.062 | 0.518 |
| 217769_s_at | POMP | 3.67E−03 | 0.694 | 1.090 | 1.028 | 1.439 | 1.046 | 0.882 |
| 217987_at | ASNSD1 | 1.15E−03 | 0.700 | 0.810 | 0.739 | 0.247 | 1.051 | 1.331 |
| 218012_at | TSPYL2 | 1.20E−02 | 0.658 | 0.894 | 0.855 | 0.505 | 1.059 | 1.261 |
| 218040_at | PRPF38B | 1.42E−02 | 0.676 | 0.936 | 0.928 | 0.608 | 1.045 | 1.100 |
| 218065_s_at | TMEM9B | 5.39E−04 | 0.760 | 1.114 | 1.085 | 1.302 | 1.036 | 0.823 |
| 218091_at | HRB | 7.79E−04 | 0.741 | 1.128 | 1.073 | 1.553 | 1.013 | 0.827 |
| 218127_at | NFYB | 3.48E−02 | 0.671 | 0.940 | 0.903 | 0.693 | 1.010 | 1.263 |
| 218143_s_at | SCAMP2 | 5.41E−04 | 0.755 | 1.158 | 1.108 | 1.576 | 1.044 | 0.769 |
| 218206_x_at | SCAND1 | 6.34E−03 | 0.704 | 1.077 | 1.025 | 1.378 | 1.019 | 0.811 |
| 218351_at | COMMD8 | 6.25E−03 | 0.694 | 1.103 | 1.067 | 1.509 | 1.013 | 0.854 |
| 218499_at | RP6-213H19.1 | 1.92E−02 | 0.654 | 0.934 | 0.889 | 0.696 | 1.034 | 1.182 |
| 218627_at | DRAM | 2.47E−02 | 0.646 | 1.183 | 1.044 | 3.160 | 1.054 | 0.756 |
| 218718_at | PDGFC | 1.61E−03 | 0.744 | 1.412 | 1.219 | 2.410 | 1.081 | 0.466 |
| 218732_at | PTRH2 | 1.25E−03 | 0.764 | 1.165 | 1.121 | 1.504 | 1.006 | 0.677 |
| 218845_at | DUSP22 | 1.91E−05 | 0.804 | 1.166 | 1.124 | 1.448 | 1.029 | 0.798 |
| 219316_s_at | FLVCR2 | 1.34E−02 | 0.666 | 1.297 | 1.032 | 3.754 | 1.011 | 0.527 |
| 219358_s_at | CENTA2 | 8.09E−03 | 0.701 | 1.234 | 1.074 | 2.542 | 1.023 | 0.671 |
| 219418_at | NHEJ1 | 4.99E−03 | 0.734 | 1.130 | 1.077 | 1.640 | 1.025 | 0.776 |
| 219507_at | RSRC1 | 2.97E−04 | 0.816 | 1.338 | 1.256 | 1.949 | 1.048 | 0.647 |
| 219826_at | ZNF419 | 4.77E−02 | 0.646 | 0.869 | 0.786 | 0.498 | 1.069 | 1.621 |
| 219952_s_at | MCOLN1 | 2.55E−02 | 0.688 | 1.155 | 1.050 | 1.709 | 0.993 | 0.714 |
| 220146_at | TLR7 | 1.74E−03 | 0.734 | 1.404 | 1.258 | 3.269 | 1.066 | 0.524 |
| 220160_s_at | KPTN | 3.99E−03 | 0.713 | 1.151 | 1.064 | 2.178 | 1.044 | 0.806 |
| 220605_s_at | SIRT2 | 3.64E−02 | 0.631 | 1.076 | 1.025 | 1.411 | 1.039 | 0.717 |
| 220750_s_at | LEPRE1 | 3.60E−04 | 0.746 | 1.169 | 1.092 | 1.732 | 1.050 | 0.711 |
| 220865_s_at | PDSS1 | 2.87E−02 | 0.663 | 1.182 | 1.072 | 2.102 | 1.072 | 0.669 |
| 220974_x_at | SFXN3 | 3.54E−03 | 0.739 | 1.190 | 1.146 | 1.835 | 1.027 | 0.621 |
| 221428_s_at | TBL1XR1 | 1.26E−02 | 0.681 | 0.892 | 0.851 | 0.591 | 1.023 | 1.348 |
| 221449_s_at | ITFG1 | 1.23E−02 | 0.695 | 1.092 | 1.062 | 1.497 | 1.023 | 0.831 |
| 221580_s_at | JOSD3 | 3.38E−02 | 0.669 | 0.930 | 0.916 | 0.678 | 1.041 | 1.244 |
| 221601_s_at | FAIM3 | 3.66E−02 | 0.655 | 0.865 | 0.748 | 0.396 | 1.070 | 1.685 |
| 221647_s_at | RIC8A | 1.24E−03 | 0.740 | 1.093 | 1.070 | 1.354 | 0.997 | 0.884 |
| 221731_x_at | VCAN | 3.18E−02 | 0.681 | 1.129 | 1.063 | 1.633 | 1.027 | 0.613 |
| 221841_s_at | KLF4 | 5.09E−04 | 0.784 | 1.403 | 1.237 | 2.790 | 1.017 | 0.456 |
| 221868_at | PAIP2B | 3.25E−03 | 0.789 | 0.823 | 0.752 | 0.480 | 1.030 | 1.665 |
| 221960_s_at | RAB2A | 1.66E−04 | 0.779 | 1.388 | 1.250 | 2.043 | 1.141 | 0.570 |
| 222217_s_at | SLC27A3 | 1.31E−03 | 0.745 | 1.268 | 1.169 | 2.373 | 1.076 | 0.582 |
| 222231_s_at | LRRC59 | 4.48E−04 | 0.775 | 1.135 | 1.083 | 1.692 | 1.027 | 0.848 |
| 222574_s_at | DHX40 | 4.47E−04 | 0.778 | 0.867 | 0.834 | 0.581 | 1.008 | 1.592 |
| 222651_s_at | TRPS1 | 3.06E−03 | 0.700 | 1.159 | 1.089 | 1.658 | 1.065 | 0.745 |
| 222670_s_at | MAFB | 3.79E−03 | 0.728 | 1.344 | 1.209 | 2.949 | 1.003 | 0.406 |
| 222700_at | ARL6IP2 | 4.41E−03 | 0.713 | 0.906 | 0.882 | 0.557 | 1.035 | 1.228 |
| 222753_s_at | SPCS3 | 2.08E−02 | 0.690 | 1.120 | 1.045 | 1.666 | 1.005 | 0.760 |
| 222774_s_at | NETO2 | 8.14E−03 | 0.695 | 1.242 | 1.080 | 2.077 | 1.004 | 0.617 |
| 222980_at | RAB10 | 2.51E−03 | 0.733 | 1.087 | 1.036 | 1.391 | 1.019 | 0.849 |
| 223064_at | RNF181 | 3.87E−04 | 0.778 | 1.090 | 1.066 | 1.290 | 1.013 | 0.887 |
| 223158_s_at | NEK6 | 2.79E−04 | 0.755 | 1.253 | 1.115 | 1.910 | 1.033 | 0.790 |
| 223444_at | SENP7 | 9.71E−05 | 0.740 | 0.871 | 0.853 | 0.587 | 1.031 | 1.217 |
| 223465_at | COL4A3BP | 4.01E−02 | 0.638 | 1.133 | 1.049 | 1.730 | 1.067 | 0.690 |
| 223686_at | TPK1 | 7.03E−03 | 0.724 | 0.898 | 0.859 | 0.561 | 1.031 | 1.277 |
| 223801_s_at | APOL4 | 3.48E−02 | 0.611 | 1.094 | 1.035 | 2.338 | 1.046 | 0.681 |
| 223982_s_at | PNPLA8 | 9.12E−04 | 0.739 | 0.922 | 0.907 | 0.631 | 1.011 | 1.115 |
| 224046_s_at | PDE7A | 9.29E−03 | 0.699 | 0.885 | 0.808 | 0.537 | 1.049 | 1.434 |
| 224387_at | COMMD5 | 2.53E−02 | 0.696 | 1.139 | 1.088 | 1.866 | 1.021 | 0.557 |
| 224439_x_at | RNF7 | 7.23E−05 | 0.808 | 1.175 | 1.145 | 1.488 | 1.035 | 0.766 |
| 224518_s_at | ZNF559 | 1.43E−02 | 0.628 | 0.890 | 0.825 | 0.350 | 1.010 | 1.336 |
| 224726_at | MIB1 | 2.04E−03 | 0.752 | 1.228 | 1.161 | 1.794 | 1.042 | 0.681 |
| 224818_at | SORT1 | 1.43E−02 | 0.703 | 1.165 | 1.117 | 2.232 | 1.045 | 0.682 |
| 224917_at | MIRN21 | 5.61E−03 | 0.697 | 1.158 | 1.078 | 1.651 | 1.046 | 0.727 |
| 224918_x_at | MGST1 | 3.40E−02 | 0.691 | 1.253 | 1.068 | 3.299 | 0.991 | 0.606 |
| 224928_at | SETD7 | 1.02E−03 | 0.766 | 1.195 | 1.148 | 1.825 | 1.059 | 0.666 |
| 225188_at | RAPH1 | 1.64E−04 | 0.799 | 1.812 | 1.390 | 4.673 | 1.009 | 0.289 |
| 225341_at | MTERFD3 | 4.65E−03 | 0.703 | 0.740 | 0.697 | 0.311 | 0.984 | 1.939 |
| 225365_at | ZDHHC20 | 1.03E−02 | 0.699 | 1.118 | 1.091 | 1.694 | 1.045 | 0.821 |
| 225388_at | TSPAN5 | 1.57E−02 | 0.649 | 0.865 | 0.841 | 0.454 | 1.004 | 1.505 |
| 225456_at | MED1 | 3.15E−02 | 0.634 | 0.934 | 0.899 | 0.642 | 1.010 | 1.298 |
| 225844_at | POLE4 | 1.74E−03 | 0.741 | 1.160 | 1.082 | 1.612 | 1.025 | 0.775 |
| 225870_s_at | TRAPPC5 | 3.02E−02 | 0.671 | 1.117 | 1.055 | 1.616 | 1.027 | 0.783 |
| 226000_at | CTTNBP2NL | 1.61E−02 | 0.654 | 1.117 | 1.035 | 1.735 | 1.020 | 0.700 |
| 226042_at | EDC3 | 7.20E−04 | 0.720 | 0.905 | 0.880 | 0.578 | 1.022 | 1.179 |
| 226059_at | TOMM40L | 3.81E−03 | 0.724 | 1.191 | 1.077 | 2.004 | 0.989 | 0.721 |
| 226115_at | AHCTF1 | 4.40E−04 | 0.766 | 0.815 | 0.803 | 0.485 | 1.018 | 1.471 |
| 226127_at | ALKBH3 | 2.12E−02 | 0.705 | 1.070 | 1.018 | 1.594 | 1.006 | 0.846 |
| 226220_at | METTL9 | 6.02E−03 | 0.698 | 1.233 | 1.052 | 2.413 | 1.039 | 0.606 |
| 226323_at | CCDC16 | 2.93E−03 | 0.726 | 0.908 | 0.897 | 0.707 | 1.024 | 1.266 |
| 226353_at | SPPL2A | 1.59E−03 | 0.741 | 1.122 | 1.076 | 1.689 | 0.990 | 0.846 |
| 226428_at | TNPO2 | 1.36E−03 | 0.733 | 0.898 | 0.871 | 0.539 | 1.029 | 1.173 |
| 226459_at | PIK3AP1 | 7.63E−03 | 0.668 | 1.159 | 1.059 | 2.046 | 1.027 | 0.759 |
| 226683_at | SNAG1 | 1.05E−03 | 0.781 | 0.784 | 0.756 | 0.455 | 1.010 | 2.165 |
| 226763_at | SESTD1 | 3.26E−04 | 0.765 | 1.324 | 1.190 | 2.717 | 1.134 | 0.687 |
| 227020_at | YPEL2 | 6.11E−04 | 0.781 | 1.145 | 1.108 | 1.426 | 1.035 | 0.684 |
| 227149_at | TNRC6C | 5.77E−03 | 0.703 | 0.860 | 0.829 | 0.573 | 0.963 | 1.359 |
| 227173_s_at | BACH2 | 1.04E−02 | 0.704 | 0.804 | 0.663 | 0.363 | 1.047 | 1.780 |
| 227558_at | CBX4 | 3.84E−03 | 0.726 | 0.916 | 0.890 | 0.730 | 1.016 | 1.151 |
| 227560_at | SFXN2 | 1.53E−02 | 0.710 | 0.910 | 0.872 | 0.661 | 1.020 | 1.282 |
| 227722_at | RPS23 | 1.35E−03 | 0.696 | 0.655 | 0.412 | 0.037 | 1.013 | 2.284 |
| 227990_at | SLU7 | 3.05E−04 | 0.725 | 0.895 | 0.859 | 0.604 | 1.012 | 1.142 |
| 228170_at | OLIG1 | 1.54E−03 | 0.748 | 1.514 | 1.285 | 3.247 | 1.043 | 0.474 |
| 228176_at | EDG3 | 6.68E−03 | 0.724 | 1.399 | 1.227 | 2.772 | 1.042 | 0.384 |
| 228234_at | TICAM2 | 1.32E−02 | 0.698 | 1.149 | 1.093 | 1.711 | 1.023 | 0.753 |
| 228549_at | TMEM63A | 4.56E−02 | 0.650 | 0.893 | 0.790 | 0.476 | 1.044 | 1.432 |
| 228831_s_at | GNG7 | 2.03E−02 | 0.648 | 0.842 | 0.815 | 0.345 | 1.045 | 1.693 |
| 229307_at | ANKRD28 | 4.84E−03 | 0.689 | 1.410 | 1.147 | 3.169 | 1.165 | 0.460 |
| 229421_s_at | FLJ20273 | 1.42E−02 | 0.703 | 1.213 | 1.097 | 2.394 | 1.057 | 0.669 |
| 229982_at | QSER1 | 3.69E−05 | 0.799 | 1.379 | 1.175 | 2.491 | 1.007 | 0.700 |
| 230265_at | SEL1L | 2.15E−02 | 0.689 | 1.189 | 1.095 | 2.244 | 1.000 | 0.528 |
| 230480_at | PIWIL4 | 8.24E−03 | 0.674 | 1.265 | 1.054 | 3.805 | 1.078 | 0.692 |
| 230837_at | LOC647500 | 3.24E−03 | 0.704 | 0.901 | 0.839 | 0.632 | 1.000 | 1.329 |
| 230852_at | STAC3 | 7.55E−03 | 0.710 | 1.152 | 1.095 | 2.110 | 1.063 | 0.782 |
| 230922_x_at | FUNDC2 | 5.71E−03 | 0.723 | 0.906 | 0.881 | 0.564 | 1.012 | 1.245 |
| 231283_at | MGAT4A | 5.90E−03 | 0.713 | 0.873 | 0.801 | 0.559 | 1.040 | 1.323 |
| 231843_at | DDX55 | 4.46E−04 | 0.768 | 0.874 | 0.842 | 0.389 | 1.038 | 1.203 |
| 231904_at | U2AF1 | 2.03E−03 | 0.736 | 0.861 | 0.839 | 0.397 | 1.027 | 1.252 |
| 231914_at | NUDT14 | 7.81E−03 | 0.681 | 1.085 | 1.038 | 1.845 | 1.039 | 0.800 |
| 232636_at | SLITRK4 | 4.02E−04 | 0.766 | 1.492 | 1.337 | 3.430 | 1.066 | 0.414 |
| 232851_at | FBXO3 | 2.72E−03 | 0.756 | 0.813 | 0.753 | 0.444 | 1.015 | 1.631 |
| 233169_at | ZNF350 | 1.26E−03 | 0.713 | 0.849 | 0.795 | 0.412 | 1.000 | 1.347 |
| 234464_s_at | EME1 | 9.59E−04 | 0.749 | 1.262 | 1.111 | 2.075 | 1.084 | 0.605 |
| 234733_s_at | FANCM | 1.56E−02 | 0.737 | 0.879 | 0.798 | 0.565 | 0.982 | 1.456 |
| 235024_at | PHF17 | 2.63E−03 | 0.748 | 0.893 | 0.874 | 0.587 | 1.075 | 1.169 |
| 235067_at | MKLN1 | 6.87E−04 | 0.741 | 0.872 | 0.848 | 0.437 | 1.030 | 1.170 |
| 235200_at | ZNF561 | 1.60E−02 | 0.659 | 0.904 | 0.870 | 0.573 | 1.057 | 1.338 |
| 235359_at | LRRC33 | 1.18E−03 | 0.754 | 1.232 | 1.124 | 2.131 | 1.061 | 0.544 |
| 235593_at | ZEB2 | 3.53E−04 | 0.780 | 1.282 | 1.221 | 1.720 | 1.078 | 0.690 |
| 235623_at | ELP2 | 6.41E−03 | 0.701 | 0.922 | 0.906 | 0.614 | 1.003 | 1.198 |
| 237504_at | INTS10 | 1.65E−02 | 0.678 | 0.901 | 0.866 | 0.385 | 1.038 | 1.282 |
| 238429_at | TMEM71 | 6.63E−04 | 0.745 | 0.847 | 0.840 | 0.535 | 1.007 | 1.358 |
| 238736_at | REV3L | 6.09E−03 | 0.692 | 0.880 | 0.839 | 0.589 | 1.036 | 1.477 |
| 238823_at | FMNL3 | 7.45E−04 | 0.769 | 0.827 | 0.776 | 0.520 | 1.048 | 1.426 |
| 238909_at | S100A10 | 8.25E−03 | 0.715 | 1.255 | 1.135 | 2.459 | 0.993 | 0.663 |
| 239897_at | BCLAF1 | 1.82E−03 | 0.745 | 0.905 | 0.891 | 0.625 | 1.021 | 1.191 |
| 241368_at | LSDP5 | 3.71E−02 | 0.674 | 0.860 | 0.744 | 0.562 | 0.959 | 1.743 |
| 241706_at | CPNE8 | 2.46E−03 | 0.764 | 1.194 | 1.147 | 1.841 | 1.039 | 0.686 |
| 241731_x_at | ZNF440 | 1.92E−02 | 0.672 | 0.919 | 0.864 | 0.597 | 1.014 | 1.250 |
| 242197_x_at | CD36 | 8.67E−04 | 0.770 | 1.871 | 1.507 | 6.707 | 1.171 | 0.357 |
| 242561_at | IPO9 | 2.50E−02 | 0.679 | 0.889 | 0.852 | 0.577 | 1.038 | 1.433 |
| 242569_at | STAM2 | 4.84E−04 | 0.758 | 0.863 | 0.839 | 0.527 | 1.042 | 1.235 |
| 243982_at | KLHL28 | 5.39E−03 | 0.695 | 0.870 | 0.841 | 0.435 | 1.060 | 1.304 |
| 244038_at | WDR89 | 3.57E−02 | 0.688 | 0.897 | 0.833 | 0.585 | 1.020 | 1.498 |
| 244654_at | MYO1G | 1.31E−03 | 0.734 | 1.227 | 1.102 | 1.794 | 0.999 | 0.739 |
| 36566_at | CTNS | 1.24E−03 | 0.740 | 1.178 | 1.084 | 1.970 | 1.052 | 0.738 |
| 37549_g_at | BBS9 | 2.83E−03 | 0.703 | 1.075 | 1.044 | 1.274 | 1.029 | 0.864 |
| 48659_at | RP5-1077B9.4 | 1.97E−06 | 0.821 | 1.159 | 1.117 | 1.497 | 1.024 | 0.836 |
| 56829_at | NIBP | 1.20E−03 | 0.734 | 1.099 | 1.048 | 1.373 | 1.013 | 0.892 |
| 64486_at | CORO1B | 1.81E−04 | 0.782 | 1.210 | 1.119 | 1.964 | 1.019 | 0.736 |
| 65493_at | HEATR6 | 4.99E−04 | 0.763 | 1.272 | 1.095 | 2.565 | 1.049 | 0.613 |
| AFFX- | GAPDH | 4.88E−04 | 0.761 | 1.103 | 1.059 | 1.456 | 1.027 | 0.868 |
| HUMGAPDH/M33197_3_at | | | | | | | | |

TABLE 4

| | | | | | | Extreme | | |
|---|---|---|---|---|---|---|---|---|
| | | | | | | NYHA | | Extreme |
| | | | | Average | | III-IV- | | Control- |
| | | | | fold- | | directional | | directional |
| | | Statistical | Maximum | change | | fold-change | | fold-change |
| | | significance | overall | gene | Average | observed | Average | observed |
| | | of | accuracy of | expression | fold-change | (Extreme | fold-change | (Extreme |
| | | differential | classification | (NYHA | expression at | NYHA | expression at | Control/ |
| Affymetrix Probe | | expression | power | III-IV/ | sensitivity = | III-IV/average | specificity = | average |
| set ID | Gene symbol | (p-value) | (ROC AUC) | Control) | 0.6 | Control) | 0.6 | Control) |
| 1552318_at | GIMAP1 | 1.63E−02 | 0.527 | 0.855 | 0.945 | 0.543 | 1.053 | 1.534 |
| 1552630_a_at | SRCAP | 9.37E−04 | 0.687 | 0.815 | 0.804 | 0.431 | 1.032 | 1.417 |
| 1554149_at | CLDND1 | 1.04E−03 | 0.672 | 0.856 | 0.841 | 0.558 | 1.048 | 1.291 |
| 1554539_a_at | RHOF | 5.37E−03 | 0.536 | 0.825 | 0.860 | 0.317 | 1.029 | 1.373 |
| 1554606_at | CCDC100 | 1.41E−05 | 0.701 | 0.760 | 0.811 | 0.397 | 1.100 | 1.175 |
| 1555630_a_at | RAB34 | 1.50E−03 | 0.727 | 1.306 | 1.108 | 2.425 | 1.046 | 0.591 |
| 1555963_x_at | B3GNT7 | 6.37E−04 | 0.693 | 1.386 | 1.113 | 5.102 | 1.105 | 0.719 |
| 1555996_s_at | EIF4A2 | 1.18E−03 | 0.584 | 0.794 | 0.822 | 0.322 | 1.100 | 1.421 |
| 1556113_at | DKFZp451A211 | 3.55E−03 | 0.692 | 1.131 | 1.070 | 1.530 | 1.060 | 0.722 |
| 1556283_s_at | FGFR1OP2 | 1.60E−03 | 0.720 | 1.237 | 1.103 | 1.751 | 1.028 | 0.634 |
| 1556864_at | TECT1 | 1.98E−03 | 0.724 | 0.852 | 0.866 | 0.496 | 1.010 | 1.424 |
| 1557066_at | LUC7L | 3.12E−04 | 0.689 | 0.776 | 0.844 | 0.329 | 1.064 | 1.349 |
| 1558277_at | ZNF740 | 4.88E−02 | 0.737 | 1.175 | 1.122 | 2.035 | 1.038 | 0.648 |
| 1558755_x_at | ZNF763 | 1.20E−04 | 0.697 | 0.753 | 0.767 | 0.413 | 1.118 | 1.312 |
| 1561146_at | VPS35 | 1.02E−03 | 0.732 | 0.790 | 0.771 | 0.442 | 1.030 | 1.929 |
| 1564962_at | ZNF92 | 1.90E−05 | 0.793 | 0.748 | 0.734 | 0.511 | 1.027 | 1.521 |
| 1567013_at | NFE2L2 | 8.33E−03 | 0.564 | 1.169 | 0.891 | 1.897 | 0.958 | 0.846 |
| 1568815_a_at | DDX50 | 5.34E−04 | 0.687 | 0.762 | 0.811 | 0.345 | 1.010 | 2.085 |
| 200010_at | RPL11 | 4.31E−03 | 0.569 | 0.902 | 0.993 | 0.594 | 1.022 | 1.220 |
| 200059_s_at | RHOA | 2.79E−04 | 0.730 | 1.068 | 1.036 | 1.212 | 1.015 | 0.867 |
| 200091_s_at | RPS25 | 8.54E−04 | 0.562 | 0.881 | 0.920 | 0.629 | 1.018 | 1.294 |
| 200650_s_at | LDHA | 1.50E−03 | 0.635 | 1.136 | 1.030 | 1.464 | 1.051 | 0.736 |
| 200672_x_at | SPTBN1 | 7.47E−05 | 0.649 | 0.773 | 0.796 | 0.325 | 1.030 | 1.532 |
| 200677_at | PTTG1IP | 9.05E−04 | 0.597 | 1.135 | 1.010 | 1.526 | 1.034 | 0.747 |
| 200713_s_at | MAPRE1 | 5.99E−03 | 0.767 | 1.073 | 1.066 | 1.514 | 1.009 | 0.906 |
| 200822_x_at | TPI1 | 5.74E−05 | 0.701 | 1.162 | 1.063 | 1.629 | 1.009 | 0.723 |
| 200829_x_at | ZNF207 | 1.09E−03 | 0.769 | 1.125 | 1.082 | 1.606 | 1.042 | 0.812 |
| 200839_s_at | CTSB | 2.90E−05 | 0.727 | 1.330 | 1.117 | 2.297 | 1.034 | 0.546 |
| 200932_s_at | DCTN2 | 2.37E−03 | 0.712 | 1.088 | 1.033 | 1.558 | 1.024 | 0.881 |
| 200950_at | ARPC1A | 8.34E−05 | 0.739 | 1.148 | 1.067 | 1.573 | 1.009 | 0.880 |
| 201031_s_at | HNRPH1 | 1.24E−03 | 0.539 | 0.859 | 0.940 | 0.549 | 1.068 | 1.235 |
| 201075_s_at | SMARCC1 | 3.51E−05 | 0.797 | 0.864 | 0.839 | 0.665 | 1.024 | 1.246 |
| 201098_at | COPB2 | 1.31E−04 | 0.739 | 1.095 | 1.039 | 1.369 | 1.020 | 0.897 |
| 201105_at | LGALS1 | 2.12E−03 | 0.778 | 1.345 | 1.255 | 2.736 | 1.039 | 0.513 |
| 201172_x_at | ATP6V0E1 | 1.67E−04 | 0.681 | 1.113 | 1.042 | 1.441 | 1.030 | 0.865 |
| 201186_at | LRPAP1 | 3.57E−04 | 0.649 | 1.200 | 1.026 | 1.904 | 1.027 | 0.783 |
| 201193_at | IDH1 | 6.48E−07 | 0.738 | 1.310 | 1.119 | 2.191 | 1.078 | 0.784 |
| 201198_s_at | PSMD1 | 7.45E−03 | 0.771 | 1.114 | 1.124 | 1.447 | 1.053 | 0.736 |
| 201220_x_at | CTBP2 | 1.14E−04 | 0.646 | 1.160 | 1.036 | 1.406 | 1.028 | 0.796 |
| 201234_at | ILK | 1.18E−05 | 0.773 | 1.194 | 1.071 | 1.858 | 1.015 | 0.867 |
| 201357_s_at | SF3A1 | 7.81E−03 | 0.814 | 0.898 | 0.826 | 0.611 | 1.002 | 1.293 |
| 201363_s_at | IVNS1ABP | 4.11E−04 | 0.762 | 0.856 | 0.852 | 0.590 | 1.016 | 1.300 |
| 201400_at | PSMB3 | 8.05E−05 | 0.695 | 1.205 | 1.044 | 2.162 | 1.011 | 0.820 |
| 201421_s_at | WDR77 | 1.97E−02 | 0.503 | 0.894 | 0.945 | 0.592 | 1.060 | 1.260 |
| 201422_at | IFI30 | 1.41E−05 | 0.712 | 1.234 | 1.086 | 1.962 | 1.029 | 0.686 |
| 201426_s_at | VIM | 7.11E−04 | 0.753 | 1.123 | 1.052 | 1.406 | 1.004 | 0.847 |
| 201453_x_at | RHEB | 4.11E−04 | 0.726 | 1.101 | 1.055 | 1.424 | 1.025 | 0.810 |
| 201470_at | GSTO1 | 8.72E−04 | 0.734 | 1.218 | 1.076 | 2.377 | 1.004 | 0.770 |
| 201478_s_at | DKC1 | 2.09E−04 | 0.605 | 0.861 | 0.903 | 0.534 | 1.039 | 1.208 |
| 201527_at | ATP6V1F | 2.23E−03 | 0.699 | 1.110 | 1.057 | 1.612 | 1.034 | 0.839 |
| 201536_at | DUSP3 | 2.12E−05 | 0.626 | 1.303 | 1.024 | 2.512 | 1.032 | 0.742 |
| 201554_x_at | GYG1 | 8.98E−04 | 0.615 | 1.307 | 0.976 | 3.876 | 1.010 | 0.674 |
| 201556_s_at | VAMP2 | 1.49E−04 | 0.759 | 0.801 | 0.758 | 0.589 | 0.985 | 1.523 |
| 201576_s_at | GLB1 | 1.94E−04 | 0.707 | 1.197 | 1.048 | 2.099 | 1.022 | 0.743 |
| 201590_x_at | ANXA2 | 1.08E−04 | 0.799 | 1.281 | 1.151 | 2.012 | 1.062 | 0.631 |
| 201628_s_at | RRAGA | 6.66E−04 | 0.732 | 1.104 | 1.043 | 1.444 | 1.029 | 0.842 |
| 201788_at | DDX42 | 6.53E−05 | 0.629 | 0.867 | 0.890 | 0.661 | 1.018 | 1.256 |
| 201900_s_at | AKR1A1 | 4.38E−03 | 0.723 | 1.170 | 1.063 | 2.155 | 1.023 | 0.770 |
| 202068_s_at | LDLR | 2.42E−05 | 0.703 | 1.689 | 1.125 | 4.236 | 1.029 | 0.406 |
| 202104_s_at | SPG7 | 2.82E−04 | 0.598 | 0.834 | 0.872 | 0.420 | 1.066 | 1.174 |
| 202185_at | PLOD3 | 1.70E−02 | 0.770 | 1.101 | 1.102 | 1.565 | 1.023 | 0.797 |
| 202192_s_at | GAS7 | 2.75E−03 | 0.601 | 1.243 | 0.974 | 1.773 | 1.000 | 0.641 |
| 202201_at | BLVRB | 1.74E−04 | 0.720 | 1.335 | 1.066 | 2.830 | 1.001 | 0.675 |
| 202249_s_at | WDR42A | 4.50E−04 | 0.697 | 0.890 | 0.871 | 0.627 | 1.034 | 1.224 |
| 202252_at | RAB13 | 7.48E−05 | 0.685 | 1.393 | 1.109 | 3.759 | 1.083 | 0.711 |
| 202262_x_at | DDAH2 | 1.69E−03 | 0.501 | 1.234 | 0.909 | 1.835 | 0.992 | 0.779 |
| 202380_s_at | NKTR | 1.92E−04 | 0.514 | 0.827 | 0.916 | 0.437 | 1.066 | 1.314 |
| 202381_at | ADAM9 | 5.40E−05 | 0.582 | 1.376 | 0.967 | 2.456 | 0.988 | 0.667 |
| 202428_x_at | DBI | 9.95E−03 | 0.806 | 1.118 | 1.121 | 2.014 | 1.038 | 0.807 |
| 202461_at | EIF2B2 | 4.07E−02 | 0.795 | 1.117 | 1.147 | 1.714 | 1.059 | 0.653 |
| 202522_at | PITPNB | 2.98E−02 | 0.752 | 1.063 | 1.066 | 1.239 | 1.017 | 0.822 |
| 202523_s_at | SPOCK2 | 3.70E−05 | 0.672 | 0.674 | 0.614 | 0.239 | 1.076 | 1.476 |
| 202594_at | LEPROTL1 | 8.21E−04 | 0.553 | 0.883 | 0.920 | 0.620 | 1.048 | 1.194 |
| 202623_at | EAPP | 1.38E−05 | 0.770 | 0.896 | 0.900 | 0.709 | 1.012 | 1.174 |
| 202652_at | APBB1 | 4.37E−05 | 0.719 | 0.753 | 0.789 | 0.243 | 1.016 | 1.429 |
| 202724_s_at | FOXO1 | 8.60E−04 | 0.659 | 0.847 | 0.860 | 0.468 | 0.994 | 1.437 |
| 202750_s_at | TFIP11 | 4.59E−03 | 0.609 | 1.158 | 1.002 | 1.504 | 1.094 | 0.532 |
| 202778_s_at | ZMYM2 | 6.31E−04 | 0.733 | 0.899 | 0.873 | 0.660 | 1.026 | 1.162 |
| 202910_s_at | CD97 | 1.12E−03 | 0.526 | 1.208 | 0.955 | 1.720 | 1.038 | 0.619 |
| 202928_s_at | PHF1 | 1.91E−05 | 0.772 | 0.818 | 0.797 | 0.523 | 1.011 | 1.320 |
| 202944_at | NAGA | 7.63E−04 | 0.731 | 1.219 | 1.130 | 1.669 | 1.008 | 0.676 |
| 202979_s_at | CREBZF | 2.80E−03 | 0.559 | 0.834 | 0.905 | 0.499 | 1.061 | 1.414 |
| 203003_at | MEF2D | 2.66E−02 | 0.809 | 0.897 | 0.808 | 0.619 | 0.978 | 1.416 |
| 203127_s_at | SPTLC2 | 6.30E−04 | 0.721 | 1.247 | 1.118 | 2.496 | 1.058 | 0.719 |
| 203137_at | WTAP | 2.24E−04 | 0.695 | 0.889 | 0.895 | 0.679 | 1.030 | 1.177 |
| 203184_at | FBN2 | 1.61E−03 | 0.545 | 1.573 | 0.878 | 3.839 | 1.051 | 0.405 |
| 203234_at | UPP1 | 3.76E−04 | 0.680 | 1.317 | 1.062 | 2.790 | 1.007 | 0.567 |
| 203278_s_at | PHF21A | 4.88E−03 | 0.509 | 1.204 | 0.923 | 2.629 | 1.056 | 0.730 |
| 203305_at | F13A1 | 1.01E−04 | 0.649 | 1.505 | 1.057 | 3.284 | 1.052 | 0.534 |
| 203371_s_at | NDUFB3 | 4.53E−04 | 0.562 | 1.224 | 0.961 | 2.021 | 1.047 | 0.795 |
| 203413_at | NELL2 | 4.76E−05 | 0.688 | 0.608 | 0.659 | 0.085 | 1.017 | 1.764 |
| 203416_at | CD53 | 4.04E−04 | 0.680 | 1.085 | 1.035 | 1.272 | 1.019 | 0.867 |
| 203492_x_at | CEP57 | 1.48E−03 | 0.559 | 0.863 | 0.895 | 0.564 | 1.012 | 1.316 |
| 203534_at | LSM1 | 4.10E−04 | 0.812 | 1.147 | 1.111 | 1.682 | 1.024 | 0.815 |
| 203535_at | S100A9 | 1.10E−03 | 0.631 | 1.089 | 1.018 | 1.318 | 1.024 | 0.830 |
| 203578_s_at | SLC7A6 | 6.44E−04 | 0.564 | 0.776 | 0.822 | 0.380 | 0.984 | 1.600 |
| 203748_x_at | RBMS1 | 1.84E−03 | 0.555 | 1.106 | 0.990 | 1.529 | 0.996 | 0.807 |
| 203844_at | VHL | 8.32E−04 | 0.672 | 1.099 | 1.026 | 1.551 | 1.029 | 0.794 |
| 203880_at | COX17 | 7.60E−03 | 0.739 | 1.136 | 1.089 | 1.912 | 1.045 | 0.695 |
| 203912_s_at | DNASE1L1 | 9.10E−04 | 0.754 | 1.221 | 1.149 | 1.786 | 1.051 | 0.647 |
| 203939_at | NT5E | 7.33E−04 | 0.703 | 0.743 | 0.632 | 0.374 | 1.004 | 1.778 |
| 203971_at | SLC31A1 | 6.87E−04 | 0.597 | 1.200 | 1.035 | 1.622 | 1.076 | 0.644 |
| 204050_s_at | CLTA | 2.98E−03 | 0.753 | 1.108 | 1.049 | 1.475 | 1.010 | 0.865 |
| 204068_at | STK3 | 5.62E−03 | 0.526 | 1.303 | 0.852 | 2.631 | 1.130 | 0.600 |
| 204099_at | SMARCD3 | 7.02E−06 | 0.674 | 1.463 | 1.066 | 2.956 | 1.074 | 0.701 |
| 204143_s_at | ENOSF1 | 1.77E−03 | 0.512 | 0.718 | 0.885 | 0.274 | 0.954 | 1.941 |
| 204204_at | SLC31A2 | 2.07E−03 | 0.559 | 1.255 | 0.942 | 1.817 | 1.081 | 0.501 |
| 204214_s_at | RAB32 | 1.76E−04 | 0.610 | 1.245 | 1.003 | 2.378 | 0.997 | 0.829 |
| 204232_at | FCER1G | 6.03E−04 | 0.601 | 1.262 | 1.003 | 1.996 | 1.111 | 0.642 |
| 204243_at | RLF | 7.04E−05 | 0.703 | 1.243 | 1.087 | 1.700 | 1.065 | 0.752 |
| 204249_s_at | LMO2 | 8.74E−05 | 0.739 | 1.210 | 1.127 | 1.639 | 1.014 | 0.804 |
| 204291_at | ZNF518 | 5.29E−04 | 0.632 | 0.872 | 0.902 | 0.624 | 1.037 | 1.201 |
| 204342_at | SLC25A24 | 4.51E−04 | 0.593 | 1.186 | 0.977 | 1.794 | 0.996 | 0.769 |
| 204352_at | TRAF5 | 1.04E−03 | 0.564 | 0.728 | 0.848 | 0.200 | 1.034 | 1.955 |
| 204401_at | KCNN4 | 2.66E−03 | 0.695 | 0.813 | 0.732 | 0.413 | 1.040 | 1.629 |
| 204504_s_at | HIRIP3 | 1.20E−03 | 0.645 | 0.887 | 0.914 | 0.654 | 1.035 | 1.196 |
| 204617_s_at | ACD | 2.14E−03 | 0.703 | 0.871 | 0.875 | 0.355 | 1.045 | 1.209 |
| 204645_at | CCNT2 | 2.13E−05 | 0.747 | 0.863 | 0.867 | 0.644 | 1.009 | 1.238 |
| 204675_at | SRD5A1 | 6.23E−04 | 0.799 | 1.369 | 1.170 | 2.230 | 1.033 | 0.572 |
| 204689_at | HHEX | 8.76E−04 | 0.600 | 1.147 | 0.986 | 1.531 | 1.045 | 0.767 |
| 204801_s_at | DHRS12 | 4.89E−03 | 0.757 | 0.782 | 0.614 | 0.336 | 1.077 | 1.834 |
| 205235_s_at | MPHOSPH1 | 3.08E−04 | 0.737 | 0.883 | 0.886 | 0.774 | 1.033 | 1.309 |
| 205254_x_at | TCF7 | 9.88E−05 | 0.649 | 0.666 | 0.670 | 0.118 | 1.007 | 1.924 |
| 205256_at | ZBTB39 | 8.23E−04 | 0.672 | 0.887 | 0.890 | 0.659 | 1.012 | 1.321 |
| 205322_s_at | MTF1 | 2.76E−04 | 0.598 | 1.175 | 0.989 | 1.704 | 1.013 | 0.794 |
| 205340_at | ZBTB24 | 1.61E−03 | 0.504 | 0.851 | 0.948 | 0.524 | 1.043 | 1.294 |
| 205349_at | GNA15 | 3.35E−04 | 0.589 | 1.215 | 1.016 | 1.697 | 1.037 | 0.733 |
| 205550_s_at | BRE | 2.80E−04 | 0.662 | 1.101 | 1.023 | 1.277 | 1.023 | 0.835 |
| 205811_at | POLG2 | 2.41E−03 | 0.535 | 0.871 | 0.985 | 0.558 | 1.040 | 1.242 |
| 205835_s_at | YTHDC2 | 3.15E−03 | 0.586 | 0.786 | 0.884 | 0.410 | 1.059 | 1.395 |
| 205895_s_at | NOLC1 | 6.77E−04 | 0.623 | 0.787 | 0.843 | 0.296 | 1.041 | 1.369 |
| 205965_at | BATF | 6.51E−04 | 0.659 | 1.220 | 1.032 | 1.743 | 1.013 | 0.796 |
| 205976_at | FASTKD2 | 9.60E−04 | 0.617 | 0.724 | 0.821 | 0.197 | 1.110 | 1.504 |
| 206015_s_at | FOXJ3 | 5.61E−04 | 0.571 | 0.907 | 0.942 | 0.707 | 1.029 | 1.155 |
| 206037_at | CCBL1 | 2.95E−03 | 0.613 | 0.885 | 0.909 | 0.657 | 1.028 | 1.272 |
| 206170_at | ADRB2 | 2.47E−03 | 0.772 | 1.320 | 1.285 | 2.017 | 1.109 | 0.361 |
| 206182_at | ZNF134 | 2.21E−04 | 0.657 | 0.853 | 0.878 | 0.551 | 1.026 | 1.305 |
| 206343_s_at | NRG1 | 5.42E−04 | 0.630 | 2.271 | 0.960 | 6.376 | 0.930 | 0.314 |
| 206542_s_at | SMARCA2 | 1.70E−04 | 0.732 | 0.873 | 0.867 | 0.656 | 1.017 | 1.228 |
| 206580_s_at | EFEMP2 | 1.51E−03 | 0.533 | 1.175 | 0.984 | 1.684 | 1.008 | 0.754 |
| 206715_at | TFEC | 4.89E−04 | 0.662 | 1.400 | 1.088 | 4.246 | 1.068 | 0.516 |
| 206834_at | HBD | 6.69E−04 | 0.614 | 2.762 | 0.983 | 16.461 | 1.002 | 0.396 |
| 206968_s_at | NFRKB | 3.96E−04 | 0.633 | 0.850 | 0.926 | 0.443 | 1.028 | 1.276 |
| 207075_at | NLRP3 | 4.83E−04 | 0.578 | 1.407 | 0.993 | 2.969 | 1.035 | 0.659 |
| 207078_at | MED6 | 2.91E−05 | 0.662 | 0.797 | 0.847 | 0.400 | 1.048 | 1.304 |
| 207113_s_at | TNF | 8.71E−04 | 0.691 | 1.277 | 1.120 | 1.866 | 1.123 | 0.644 |
| 207164_s_at | ZNF238 | 1.12E−02 | 0.714 | 0.870 | 0.772 | 0.266 | 1.012 | 1.390 |
| 207233_s_at | MITF | 5.10E−04 | 0.569 | 1.252 | 0.934 | 2.368 | 0.975 | 0.802 |
| 207416_s_at | NFATC3 | 7.25E−04 | 0.607 | 0.858 | 0.885 | 0.413 | 1.031 | 1.207 |
| 207513_s_at | ZNF189 | 3.50E−03 | 0.684 | 0.897 | 0.883 | 0.624 | 1.023 | 1.332 |
| 207543_s_at | P4HA1 | 2.41E−04 | 0.653 | 1.239 | 1.041 | 1.714 | 0.985 | 0.746 |
| 207564_x_at | OGT | 1.99E−04 | 0.646 | 0.801 | 0.851 | 0.521 | 1.053 | 1.345 |
| 207971_s_at | CEP68 | 3.91E−04 | 0.541 | 0.784 | 0.869 | 0.470 | 0.998 | 1.927 |
| 208121_s_at | PTPRO | 4.03E−05 | 0.772 | 1.561 | 1.319 | 2.929 | 1.136 | 0.562 |
| 208161_s_at | ABCC3 | 2.38E−04 | 0.793 | 1.654 | 1.190 | 4.098 | 1.067 | 0.473 |
| 208269_s_at | ADAM28 | 5.81E−04 | 0.747 | 0.840 | 0.819 | 0.521 | 1.052 | 1.412 |
| 208309_s_at | MALT1 | 4.29E−02 | 0.504 | 0.853 | 0.942 | 0.564 | 1.108 | 1.460 |
| 208527_x_at | HIST1H2BE | 1.49E−03 | 0.554 | 1.235 | 0.890 | 1.932 | 1.029 | 0.724 |
| 208579_x_at | H2BFS | 4.68E−04 | 0.546 | 1.315 | 0.936 | 2.258 | 1.024 | 0.723 |
| 208635_x_at | NACA | 1.35E−02 | 0.567 | 0.921 | 1.011 | 0.618 | 1.062 | 1.149 |
| 208659_at | CLIC1 | 1.22E−04 | 0.664 | 1.129 | 1.026 | 1.682 | 0.987 | 0.890 |
| 208680_at | PRDX1 | 1.84E−03 | 0.744 | 1.215 | 1.128 | 2.149 | 1.067 | 0.676 |
| 208749_x_at | FLOT1 | 1.60E−02 | 0.564 | 1.170 | 0.878 | 2.242 | 1.032 | 0.693 |
| 208771_s_at | LTA4H | 1.62E−04 | 0.682 | 1.322 | 1.108 | 2.296 | 1.057 | 0.567 |
| 208780_x_at | VAPA | 2.75E−03 | 0.631 | 1.173 | 0.993 | 1.827 | 0.989 | 0.728 |
| 208798_x_at | GOLGA8A | 4.40E−04 | 0.539 | 0.706 | 0.797 | 0.221 | 1.041 | 1.693 |
| 208805_at | PSMA6 | 1.15E−02 | 0.725 | 1.120 | 1.048 | 2.143 | 1.028 | 0.808 |
| 208903_at | RPS28 | 6.94E−04 | 0.604 | 0.830 | 0.889 | 0.283 | 1.009 | 1.373 |
| 208921_s_at | SRI | 1.31E−03 | 0.743 | 1.115 | 1.082 | 1.434 | 1.028 | 0.806 |
| 208923_at | CYFIP1 | 7.20E−06 | 0.724 | 1.343 | 1.112 | 2.294 | 1.077 | 0.697 |
| 208946_s_at | BECN1 | 5.04E−04 | 0.768 | 0.935 | 0.922 | 0.724 | 1.012 | 1.115 |
| 208962_s_at | FADS1 | 1.10E−03 | 0.622 | 1.387 | 0.961 | 2.687 | 1.011 | 0.572 |
| 209040_s_at | PSMB8 | 4.28E−03 | 0.755 | 1.115 | 1.071 | 1.671 | 1.018 | 0.853 |
| 209067_s_at | HNRPDL | 5.68E−04 | 0.586 | 0.810 | 0.848 | 0.474 | 1.060 | 1.358 |
| 209072_at | MBP | 3.35E−04 | 0.635 | 1.610 | 1.082 | 4.703 | 1.071 | 0.564 |
| 209099_x_at | JAG1 | 1.15E−06 | 0.649 | 1.437 | 1.018 | 2.677 | 1.033 | 0.692 |
| 209124_at | MYD88 | 2.46E−04 | 0.657 | 1.117 | 1.066 | 1.346 | 0.999 | 0.882 |
| 209180_at | RABGGTB | 3.48E−03 | 0.520 | 0.857 | 0.958 | 0.478 | 1.063 | 1.322 |
| 209191_at | TUBB6 | 7.44E−04 | 0.625 | 1.407 | 0.932 | 3.209 | 1.061 | 0.615 |
| 209212_s_at | KLF5 | 1.87E−05 | 0.517 | 1.233 | 0.992 | 1.998 | 1.035 | 0.708 |
| 209218_at | SQLE | 1.66E−03 | 0.701 | 1.403 | 1.124 | 3.611 | 1.085 | 0.578 |
| 209236_at | SLC23A2 | 5.20E−06 | 0.661 | 0.826 | 0.867 | 0.454 | 1.040 | 1.181 |
| 209251_x_at | TUBA1C | 2.59E−04 | 0.662 | 1.147 | 1.042 | 1.461 | 1.045 | 0.809 |
| 209259_s_at | SMC3 | 1.80E−03 | 0.558 | 0.883 | 0.939 | 0.554 | 1.064 | 1.172 |
| 209269_s_at | SYK | 3.93E−02 | 0.736 | 0.893 | 0.787 | 0.600 | 1.055 | 1.675 |
| 209330_s_at | HNRPD | 1.01E−03 | 0.638 | 0.811 | 0.857 | 0.355 | 1.012 | 1.467 |
| 209339_at | SIAH2 | 4.35E−04 | 0.617 | 1.163 | 1.037 | 1.704 | 1.056 | 0.788 |
| 209430_at | BTAF1 | 9.75E−04 | 0.636 | 0.870 | 0.871 | 0.595 | 1.032 | 1.263 |
| 209675_s_at | HNRPUL1 | 1.35E−04 | 0.744 | 0.843 | 0.856 | 0.585 | 1.036 | 1.341 |
| 209684_at | RIN2 | 2.80E−04 | 0.676 | 1.382 | 0.998 | 2.641 | 1.004 | 0.558 |
| 209806_at | HIST1H2BK | 5.51E−06 | 0.567 | 1.391 | 0.934 | 2.388 | 1.046 | 0.743 |
| 209840_s_at | LRRN3 | 7.84E−04 | 0.581 | 0.326 | 0.197 | 0.031 | 0.711 | 7.962 |
| 209870_s_at | APBA2 | 2.53E−03 | 0.592 | 0.811 | 0.804 | 0.444 | 1.050 | 1.662 |
| 209892_at | FUT4 | 3.70E−05 | 0.736 | 1.270 | 1.114 | 1.952 | 1.052 | 0.714 |
| 209906_at | C3AR1 | 2.19E−04 | 0.616 | 1.553 | 0.969 | 3.408 | 1.031 | 0.589 |
| 210061_at | ZNF589 | 1.27E−03 | 0.594 | 0.797 | 0.865 | 0.461 | 1.077 | 1.339 |
| 210145_at | PLA2G4A | 4.81E−05 | 0.736 | 1.507 | 1.194 | 3.513 | 1.133 | 0.674 |
| 210156_s_at | PCMT1 | 2.36E−03 | 0.697 | 1.113 | 1.076 | 1.396 | 1.058 | 0.835 |
| 210166_at | TLR5 | 2.85E−03 | 0.503 | 1.372 | 0.855 | 3.509 | 0.945 | 0.538 |
| 210434_x_at | JTB | 2.30E−04 | 0.776 | 1.106 | 1.060 | 1.320 | 1.044 | 0.845 |
| 210644_s_at | LAIR1 | 1.35E−04 | 0.782 | 1.278 | 1.169 | 2.510 | 1.031 | 0.696 |
| 210648_x_at | SNX3 | 1.68E−05 | 0.755 | 1.165 | 1.076 | 1.565 | 1.002 | 0.854 |
| 210875_s_at | ZEB1 | 1.97E−04 | 0.774 | 0.783 | 0.744 | 0.380 | 1.005 | 1.535 |
| 211047_x_at | AP2S1 | 6.86E−04 | 0.782 | 1.149 | 1.113 | 1.594 | 1.022 | 0.779 |
| 211058_x_at | TUBA1B | 1.37E−03 | 0.666 | 1.095 | 1.026 | 1.440 | 1.019 | 0.857 |
| 211185_s_at | SF3B1 | 9.79E−05 | 0.722 | 0.918 | 0.934 | 0.779 | 1.025 | 1.150 |
| 211272_s_at | DGKA | 3.03E−04 | 0.600 | 0.744 | 0.797 | 0.312 | 0.993 | 1.724 |
| 211323_s_at | ITPR1 | 6.83E−05 | 0.657 | 0.798 | 0.823 | 0.439 | 1.063 | 1.345 |
| 211383_s_at | WDR37 | 4.56E−02 | 0.741 | 1.065 | 1.072 | 1.305 | 1.055 | 0.826 |
| 211429_s_at | SERPINA1 | 6.77E−04 | 0.516 | 1.121 | 0.975 | 1.461 | 1.019 | 0.855 |
| 211506_s_at | IL8 | 1.20E−02 | 0.799 | 0.710 | 0.273 | 0.050 | 1.059 | 2.135 |
| 211546_x_at | SNCA | 1.62E−03 | 0.507 | 1.175 | 0.948 | 2.044 | 1.016 | 0.733 |
| 211684_s_at | DYNC1I2 | 1.98E−03 | 0.746 | 1.186 | 1.114 | 2.083 | 1.047 | 0.655 |
| 211729_x_at | BLVRA | 2.80E−03 | 0.717 | 1.241 | 1.067 | 2.744 | 1.041 | 0.607 |
| 211856_x_at | CD28 | 1.53E−04 | 0.693 | 0.654 | 0.666 | 0.115 | 1.099 | 1.625 |
| 211946_s_at | BAT2D1 | 4.37E−04 | 0.659 | 0.910 | 0.891 | 0.670 | 1.039 | 1.095 |
| 212030_at | RBM25 | 8.72E−07 | 0.697 | 0.818 | 0.884 | 0.630 | 1.012 | 1.292 |
| 212042_x_at | hCG_31916///RPL7 | 5.64E−04 | 0.555 | 0.896 | 0.960 | 0.621 | 1.041 | 1.132 |
| 212132_at | LSM14A | 1.98E−05 | 0.699 | 0.881 | 0.896 | 0.576 | 1.017 | 1.224 |
| 212331_at | RBL2 | 8.39E−05 | 0.669 | 0.871 | 0.892 | 0.634 | 1.018 | 1.199 |
| 212334_at | GNS | 1.44E−03 | 0.707 | 1.152 | 1.065 | 1.462 | 0.993 | 0.819 |
| 212406_s_at | PCMTD2 | 6.55E−03 | 0.568 | 0.864 | 0.949 | 0.526 | 1.067 | 1.217 |
| 212455_at | YTHDC1 | 3.94E−08 | 0.799 | 0.878 | 0.893 | 0.741 | 1.019 | 1.129 |
| 212543_at | AIM1 | 9.82E−03 | 0.808 | 1.090 | 1.101 | 1.248 | 1.009 | 0.803 |
| 212658_at | LHFPL2 | 8.19E−06 | 0.681 | 1.569 | 1.033 | 6.125 | 1.026 | 0.643 |
| 212663_at | FKBP15 | 1.17E−04 | 0.749 | 1.147 | 1.087 | 1.514 | 1.049 | 0.771 |
| 212820_at | DMXL2 | 1.16E−04 | 0.686 | 1.249 | 1.092 | 2.031 | 1.032 | 0.724 |
| 212932_at | RAB3GAP1 | 3.29E−03 | 0.553 | 0.877 | 0.930 | 0.639 | 1.035 | 1.268 |
| 212989_at | SGMS1 | 4.86E−03 | 0.551 | 1.173 | 0.904 | 2.079 | 1.010 | 0.824 |
| 212997_s_at | TLK2 | 1.18E−04 | 0.764 | 0.915 | 0.893 | 0.789 | 1.033 | 1.125 |
| 213021_at | GOSR1 | 8.87E−05 | 0.606 | 0.889 | 0.940 | 0.705 | 1.040 | 1.139 |
| 213152_s_at | SFRS2B | 1.12E−03 | 0.581 | 0.797 | 0.857 | 0.365 | 1.038 | 1.494 |
| 213205_s_at | RAD54L2 | 4.99E−04 | 0.634 | 0.839 | 0.890 | 0.515 | 1.035 | 1.227 |
| 213218_at | ZNF187 | 2.35E−04 | 0.714 | 0.816 | 0.805 | 0.447 | 1.029 | 1.288 |
| 213266_at | 76P | 7.22E−03 | 0.507 | 0.864 | 0.922 | 0.574 | 1.066 | 1.295 |
| 213302_at | PFAS | 6.03E−04 | 0.641 | 0.744 | 0.798 | 0.301 | 1.017 | 1.738 |
| 213335_s_at | ST3GAL6 | 1.69E−03 | 0.679 | 1.186 | 1.040 | 1.995 | 1.043 | 0.729 |
| 213397_x_at | RNASE4 | 3.28E−04 | 0.611 | 1.485 | 1.023 | 3.133 | 1.066 | 0.474 |
| 213459_at | RPL37A | 2.70E−03 | 0.711 | 0.822 | 0.732 | 0.275 | 1.056 | 1.415 |
| 213494_s_at | YY1 | 6.88E−04 | 0.711 | 1.279 | 1.077 | 2.064 | 0.996 | 0.733 |
| 213540_at | HSD17B8 | 1.25E−04 | 0.636 | 0.838 | 0.828 | 0.544 | 1.033 | 1.262 |
| 213693_s_at | MUC1 | 2.02E−04 | 0.520 | 1.074 | 0.995 | 1.390 | 1.004 | 0.922 |
| 213827_at | SNX26 | 1.09E−03 | 0.600 | 0.848 | 0.886 | 0.536 | 1.044 | 1.276 |
| 213877_x_at | TCEB2 | 3.61E−03 | 0.770 | 0.930 | 0.912 | 0.772 | 1.045 | 1.135 |
| 214045_at | LIAS | 8.31E−03 | 0.591 | 0.817 | 1.010 | 0.438 | 1.068 | 1.464 |
| 214057_at | MCL1 | 2.95E−04 | 0.638 | 1.229 | 1.019 | 1.921 | 1.016 | 0.734 |
| 214330_at | ATPAF2 | 1.30E−03 | 0.611 | 0.815 | 0.856 | 0.543 | 1.001 | 1.429 |
| 214364_at | MTERFD2 | 1.40E−03 | 0.576 | 0.776 | 0.856 | 0.427 | 1.006 | 1.517 |
| 214430_at | GLA | 7.00E−04 | 0.672 | 1.180 | 1.057 | 1.596 | 1.039 | 0.758 |
| 214511_x_at | FCGR1B | 2.32E−04 | 0.686 | 1.889 | 1.114 | 5.029 | 1.032 | 0.439 |
| 214629_x_at | RTN4 | 3.15E−05 | 0.700 | 1.125 | 1.037 | 1.414 | 1.034 | 0.866 |
| 214683_s_at | CLK1 | 4.57E−05 | 0.822 | 0.905 | 0.872 | 0.671 | 1.026 | 1.136 |
| 214820_at | BRWD1 | 8.03E−04 | 0.655 | 0.837 | 0.862 | 0.447 | 1.024 | 1.386 |
| 214853_s_at | SHC1 | 4.92E−04 | 0.835 | 1.124 | 1.110 | 1.462 | 1.005 | 0.788 |
| 214931_s_at | SRPK2 | 6.41E−03 | 0.709 | 0.882 | 0.782 | 0.392 | 1.005 | 1.388 |
| 214953_s_at | APP | 3.46E−04 | 0.711 | 1.315 | 1.121 | 2.271 | 1.022 | 0.733 |
| 215009_s_at | SEC31A | 2.97E−04 | 0.674 | 0.804 | 0.875 | 0.419 | 1.104 | 1.227 |
| 215049_x_at | CD163 | 1.03E−04 | 0.673 | 1.485 | 1.101 | 3.452 | 1.060 | 0.596 |
| 215273_s_at | TADA3L | 3.62E−04 | 0.600 | 1.113 | 1.005 | 1.363 | 1.022 | 0.818 |
| 215293_s_at | FRAG1 | 1.44E−03 | 0.712 | 0.864 | 0.828 | 0.571 | 1.012 | 1.344 |
| 215567_at | FCF1 | 6.02E−06 | 0.720 | 0.766 | 0.838 | 0.427 | 1.058 | 1.285 |
| 215997_s_at | CUL4B | 2.27E−02 | 0.751 | 0.902 | 0.801 | 0.381 | 0.982 | 1.284 |
| 216484_x_at | HDGF | 1.51E−03 | 0.686 | 1.098 | 1.036 | 1.414 | 1.026 | 0.892 |
| 216950_s_at | FCGR1A | 3.05E−04 | 0.665 | 1.987 | 1.063 | 6.196 | 1.065 | 0.442 |
| 217383_at | PGK1 | 1.19E−03 | 0.724 | 1.286 | 1.134 | 2.091 | 1.066 | 0.518 |
| 217403_s_at | ZNF227 | 1.04E−03 | 0.589 | 0.838 | 0.909 | 0.471 | 1.024 | 1.371 |
| 217466_x_at | LOC400963///LOC440 | 3.06E−04 | 0.593 | 0.857 | 0.915 | 0.512 | 1.054 | 1.225 |
| 217769_s_at | POMP | 3.29E−03 | 0.672 | 1.107 | 1.008 | 2.036 | 1.046 | 0.882 |
| 217778_at | SLC39A1 | 3.19E−03 | 0.573 | 1.148 | 0.992 | 1.544 | 1.038 | 0.792 |
| 217824_at | UBE2J1 | 1.15E−04 | 0.604 | 1.266 | 1.011 | 1.979 | 1.061 | 0.748 |
| 217987_at | ASNSD1 | 2.23E−04 | 0.720 | 0.774 | 0.729 | 0.286 | 1.051 | 1.331 |
| 217995_at | SQRDL | 6.59E−04 | 0.627 | 1.191 | 1.028 | 1.859 | 1.028 | 0.662 |
| 218012_at | TSPYL2 | 9.33E−06 | 0.631 | 0.792 | 0.869 | 0.350 | 1.059 | 1.261 |
| 218040_at | PRPF38B | 2.17E−04 | 0.672 | 0.898 | 0.930 | 0.627 | 1.046 | 1.100 |
| 218091_at | HRB | 2.64E−05 | 0.741 | 1.206 | 1.070 | 1.892 | 1.013 | 0.827 |
| 218125_s_at | CCDC25 | 5.15E−03 | 0.533 | 0.899 | 0.949 | 0.613 | 0.982 | 1.359 |
| 218127_at | NFYB | 9.61E−05 | 0.652 | 0.872 | 0.904 | 0.553 | 1.010 | 1.263 |
| 218143_s_at | SCAMP2 | 8.06E−03 | 0.758 | 1.111 | 1.104 | 1.394 | 1.044 | 0.769 |
| 218206_x_at | SCAND1 | 3.87E−03 | 0.706 | 1.126 | 1.024 | 1.943 | 1.019 | 0.811 |
| 218289_s_at | UBE1DC1 | 1.10E−03 | 0.599 | 0.824 | 0.874 | 0.325 | 1.057 | 1.347 |
| 218325_s_at | DIDO1 | 2.92E−02 | 0.603 | 0.926 | 0.982 | 0.610 | 1.001 | 1.365 |
| 218351_at | COMMD8 | 1.68E−03 | 0.678 | 1.119 | 1.049 | 1.495 | 1.013 | 0.854 |
| 218499_at | RP6-213H19.1 | 4.03E−05 | 0.638 | 0.878 | 0.894 | 0.701 | 1.034 | 1.182 |
| 218627_at | DRAM | 1.60E−05 | 0.627 | 1.344 | 1.000 | 2.197 | 1.054 | 0.756 |
| 218718_at | PDGFC | 1.59E−02 | 0.733 | 1.416 | 1.164 | 3.042 | 1.081 | 0.466 |
| 218732_at | PTRH2 | 1.13E−04 | 0.761 | 1.222 | 1.114 | 1.725 | 1.010 | 0.677 |
| 218845_at | DUSP22 | 1.01E−05 | 0.788 | 1.174 | 1.109 | 1.496 | 1.029 | 0.798 |
| 218962_s_at | TMEM168 | 1.38E−03 | 0.584 | 0.876 | 0.913 | 0.674 | 1.046 | 1.245 |
| 219130_at | CCDC76 | 7.95E−04 | 0.512 | 0.828 | 0.909 | 0.465 | 1.083 | 1.278 |
| 219316_s_at | FLVCR2 | 4.82E−04 | 0.666 | 1.382 | 1.020 | 3.266 | 1.009 | 0.527 |
| 219343_at | CDC37L1 | 1.63E−03 | 0.591 | 0.864 | 0.907 | 0.581 | 1.061 | 1.211 |
| 219358_s_at | CENTA2 | 4.62E−04 | 0.707 | 1.294 | 1.079 | 2.293 | 1.020 | 0.671 |
| 219507_at | RSRC1 | 1.27E−02 | 0.819 | 1.214 | 1.261 | 1.890 | 1.048 | 0.647 |
| 219765_at | ZNF329 | 7.47E−05 | 0.622 | 0.724 | 0.826 | 0.342 | 1.033 | 1.718 |
| 219787_s_at | ECT2 | 3.84E−05 | 0.578 | 1.433 | 0.943 | 3.396 | 0.983 | 0.635 |
| 219822_at | MTRF1 | 1.07E−03 | 0.542 | 0.866 | 0.911 | 0.582 | 1.022 | 1.328 |
| 219826_at | ZNF419 | 7.33E−05 | 0.636 | 0.733 | 0.790 | 0.407 | 1.069 | 1.621 |
| 219952_s_at | MCOLN1 | 8.19E−04 | 0.671 | 1.252 | 1.022 | 1.800 | 0.993 | 0.714 |
| 220044_x_at | CROP | 1.66E−02 | 0.547 | 0.889 | 0.945 | 0.631 | 1.086 | 1.212 |
| 220146_at | TLR7 | 1.45E−04 | 0.739 | 1.417 | 1.258 | 3.271 | 1.066 | 0.524 |
| 220160_s_at | KPTN | 4.43E−04 | 0.726 | 1.194 | 1.065 | 2.166 | 1.043 | 0.806 |
| 220386_s_at | EML4 | 6.48E−04 | 0.533 | 0.828 | 0.930 | 0.439 | 1.048 | 1.453 |
| 220578_at | ADAMTSL4 | 9.20E−04 | 0.664 | 1.247 | 1.013 | 2.047 | 1.000 | 0.792 |
| 220605_s_at | SIRT2 | 6.43E−04 | 0.605 | 1.127 | 1.009 | 1.564 | 1.039 | 0.717 |
| 220610_s_at | LRRFIP2 | 6.71E−04 | 0.591 | 1.174 | 1.001 | 2.047 | 1.035 | 0.853 |
| 220690_s_at | DHRS7B | 1.43E−03 | 0.513 | 1.150 | 0.991 | 1.641 | 1.056 | 0.778 |
| 220750_s_at | LEPRE1 | 3.62E−03 | 0.747 | 1.135 | 1.089 | 1.639 | 1.050 | 0.711 |
| 220865_s_at | PDSS1 | 1.58E−05 | 0.638 | 1.357 | 1.049 | 3.061 | 1.072 | 0.669 |
| 220974_x_at | SFXN3 | 1.87E−03 | 0.726 | 1.210 | 1.143 | 1.550 | 1.027 | 0.621 |
| 221011_s_at | LBH | 1.00E−03 | 0.543 | 0.767 | 0.861 | 0.247 | 1.052 | 1.644 |
| 221206_at | PMS2 | 1.26E−03 | 0.606 | 0.854 | 0.924 | 0.627 | 1.044 | 1.338 |
| 221264_s_at | TARDBP | 1.11E−02 | 0.505 | 0.832 | 0.946 | 0.578 | 1.066 | 1.576 |
| 221428_s_at | TBL1XR1 | 7.90E−04 | 0.667 | 0.851 | 0.854 | 0.571 | 1.023 | 1.348 |
| 221449_s_at | ITFG1 | 7.63E−04 | 0.684 | 1.155 | 1.049 | 1.919 | 1.023 | 0.831 |
| 221580_s_at | JOSD3 | 5.70E−05 | 0.655 | 0.859 | 0.920 | 0.697 | 1.041 | 1.244 |
| 221601_s_at | FAIM3 | 5.94E−05 | 0.639 | 0.703 | 0.753 | 0.249 | 1.070 | 1.685 |
| 221647_s_at | RIC8A | 1.51E−03 | 0.723 | 1.097 | 1.060 | 1.386 | 0.997 | 0.884 |
| 221731_x_at | VCAN | 6.55E−05 | 0.684 | 1.267 | 1.067 | 1.761 | 1.028 | 0.613 |
| 221757_at | PIK3IP1 | 1.49E−04 | 0.625 | 0.761 | 0.818 | 0.377 | 1.004 | 1.612 |
| 221841_s_at | KLF4 | 4.89E−05 | 0.781 | 1.476 | 1.217 | 2.292 | 1.016 | 0.456 |
| 221868_at | PAIP2B | 1.37E−04 | 0.776 | 0.764 | 0.750 | 0.419 | 1.029 | 1.665 |
| 221960_s_at | RAB2A | 2.55E−05 | 0.765 | 1.490 | 1.200 | 2.502 | 1.141 | 0.570 |
| 222217_s_at | SLC27A3 | 3.36E−04 | 0.736 | 1.314 | 1.162 | 2.731 | 1.078 | 0.582 |
| 222231_s_at | LRRC59 | 8.10E−04 | 0.761 | 1.150 | 1.073 | 1.672 | 1.027 | 0.848 |
| 222574_s_at | DHX40 | 9.62E−04 | 0.782 | 0.871 | 0.832 | 0.480 | 1.008 | 1.592 |
| 222605_at | RCOR3 | 6.53E−04 | 0.650 | 0.898 | 0.940 | 0.707 | 1.029 | 1.153 |
| 222651_s_at | TRPS1 | 1.37E−05 | 0.701 | 1.249 | 1.091 | 1.798 | 1.063 | 0.745 |
| 222670_s_at | MAFB | 1.51E−03 | 0.723 | 1.369 | 1.190 | 2.682 | 1.003 | 0.406 |
| 222688_at | PHCA | 1.11E−03 | 0.645 | 1.236 | 1.054 | 1.927 | 1.053 | 0.596 |
| 222700_at | ARL6IP2 | 9.52E−06 | 0.701 | 0.850 | 0.885 | 0.593 | 1.035 | 1.228 |
| 222753_s_at | SPCS3 | 3.94E−04 | 0.670 | 1.206 | 1.039 | 1.695 | 1.005 | 0.760 |
| 222757_s_at | ZAK | 3.06E−04 | 0.555 | 1.363 | 0.948 | 2.518 | 1.016 | 0.546 |
| 222774_s_at | NETO2 | 9.82E−04 | 0.680 | 1.297 | 1.051 | 2.424 | 1.004 | 0.617 |
| 222884_at | ZNF346 | 1.52E−03 | 0.563 | 0.894 | 0.951 | 0.703 | 1.050 | 1.245 |
| 222980_at | RAB10 | 3.81E−04 | 0.716 | 1.107 | 1.029 | 1.458 | 1.019 | 0.849 |
| 222982_x_at | SLC38A2 | 5.48E−04 | 0.526 | 1.108 | 0.956 | 1.345 | 1.039 | 0.884 |
| 223023_at | BET1L | 1.11E−02 | 0.523 | 0.886 | 0.965 | 0.615 | 1.013 | 1.456 |
| 223064_at | RNF181 | 6.20E−04 | 0.773 | 1.109 | 1.066 | 1.607 | 1.013 | 0.887 |
| 223158_s_at | NEK6 | 7.23E−05 | 0.765 | 1.254 | 1.150 | 1.742 | 1.032 | 0.790 |
| 223380_s_at | LATS2 | 2.25E−03 | 0.563 | 1.236 | 0.973 | 1.969 | 1.023 | 0.668 |
| 223444_at | SENP7 | 9.07E−05 | 0.720 | 0.882 | 0.868 | 0.616 | 1.031 | 1.217 |
| 223465_at | COL4A3BP | 4.36E−04 | 0.611 | 1.234 | 1.023 | 1.827 | 1.067 | 0.690 |
| 223590_at | ZNF700 | 2.30E−04 | 0.576 | 0.859 | 0.920 | 0.643 | 1.012 | 1.304 |
| 223801_s_at | APOL4 | 1.56E−04 | 0.591 | 1.164 | 1.032 | 1.797 | 1.046 | 0.681 |
| 223922_x_at | MS4A6A | 1.29E−03 | 0.637 | 1.244 | 1.049 | 1.888 | 1.016 | 0.656 |
| 223982_s_at | PNPLA8 | 4.60E−03 | 0.741 | 0.938 | 0.898 | 0.752 | 1.010 | 1.115 |
| 224046_s_at | PDE7A | 3.79E−05 | 0.684 | 0.791 | 0.805 | 0.328 | 1.049 | 1.434 |
| 224374_s_at | EMILIN2 | 1.07E−04 | 0.669 | 1.301 | 1.040 | 1.950 | 0.986 | 0.721 |
| 224387_at | COMMD5 | 8.34E−04 | 0.686 | 1.226 | 1.084 | 2.334 | 1.017 | 0.557 |
| 224439_x_at | RNF7 | 3.70E−04 | 0.802 | 1.172 | 1.141 | 2.094 | 1.035 | 0.766 |
| 224518_s_at | ZNF559 | 3.49E−04 | 0.599 | 0.821 | 0.868 | 0.304 | 1.010 | 1.336 |
| 224582_s_at | NUCKS1 | 6.18E−04 | 0.643 | 0.788 | 0.797 | 0.341 | 1.091 | 1.351 |
| 224591_at | HP1BP3 | 1.57E−02 | 0.539 | 0.918 | 0.983 | 0.635 | 1.030 | 1.217 |
| 224726_at | MIB1 | 4.26E−03 | 0.747 | 1.207 | 1.168 | 1.867 | 1.039 | 0.681 |
| 224818_at | SORT1 | 2.51E−04 | 0.685 | 1.237 | 1.104 | 2.204 | 1.045 | 0.682 |
| 224917_at | MIRN21 | 1.93E−05 | 0.675 | 1.234 | 1.053 | 2.016 | 1.046 | 0.727 |
| 224918_x_at | MGST1 | 3.31E−05 | 0.685 | 1.440 | 1.062 | 2.755 | 0.991 | 0.606 |
| 224928_at | SETD7 | 1.18E−05 | 0.751 | 1.278 | 1.138 | 1.800 | 1.059 | 0.666 |
| 225059_at | AGTRAP | 6.73E−04 | 0.557 | 1.180 | 0.958 | 1.973 | 1.039 | 0.736 |
| 225064_at | RABEP1 | 6.88E−04 | 0.628 | 0.832 | 0.880 | 0.556 | 1.013 | 1.396 |
| 225107_at | HNRNPA2B1 | 7.11E−06 | 0.635 | 0.826 | 0.915 | 0.563 | 1.042 | 1.215 |
| 225188_at | RAPH1 | 7.03E−05 | 0.796 | 1.838 | 1.406 | 5.443 | 1.009 | 0.289 |
| 225341_at | MTERFD3 | 7.54E−04 | 0.698 | 0.696 | 0.701 | 0.300 | 0.984 | 1.939 |
| 225358_at | DNAJC19 | 1.19E−03 | 0.539 | 0.880 | 0.942 | 0.482 | 1.030 | 1.130 |
| 225365_at | ZDHHC20 | 4.13E−05 | 0.678 | 1.222 | 1.070 | 2.054 | 1.045 | 0.821 |
| 225388_at | TSPAN5 | 4.62E−04 | 0.635 | 0.802 | 0.845 | 0.455 | 1.004 | 1.505 |
| 225456_at | MED1 | 2.31E−04 | 0.604 | 0.877 | 0.910 | 0.673 | 1.010 | 1.298 |
| 225763_at | RCSD1 | 1.97E−03 | 0.533 | 0.903 | 0.943 | 0.594 | 1.002 | 1.290 |
| 225844_at | POLE4 | 5.71E−04 | 0.741 | 1.198 | 1.084 | 2.300 | 1.025 | 0.775 |
| 225866_at | BXDC1 | 5.46E−03 | 0.522 | 0.859 | 0.915 | 0.539 | 1.041 | 1.620 |
| 225870_s_at | TRAPPC5 | 1.13E−04 | 0.660 | 1.227 | 1.045 | 2.419 | 1.028 | 0.783 |
| 226000_at | CTTNBP2NL | 7.93E−04 | 0.643 | 1.186 | 1.019 | 2.019 | 1.021 | 0.700 |
| 226030_at | ACADSB | 8.00E−04 | 0.570 | 0.824 | 0.909 | 0.470 | 1.048 | 1.384 |
| 226042_at | EDC3 | 3.60E−02 | 0.714 | 0.943 | 0.878 | 0.702 | 1.022 | 1.179 |
| 226059_at | TOMM40L | 9.95E−05 | 0.736 | 1.339 | 1.080 | 2.595 | 0.989 | 0.721 |
| 226115_at | AHCTF1 | 8.10E−03 | 0.753 | 0.860 | 0.807 | 0.444 | 1.018 | 1.471 |
| 226218_at | IL7R | 2.49E−04 | 0.575 | 0.722 | 0.794 | 0.292 | 1.095 | 1.569 |
| 226220_at | METTL9 | 6.45E−04 | 0.689 | 1.345 | 1.047 | 2.737 | 1.039 | 0.606 |
| 226323_at | CCDC16 | 9.86E−05 | 0.720 | 0.876 | 0.902 | 0.646 | 1.024 | 1.266 |
| 226353_at | SPPL2A | 2.28E−04 | 0.724 | 1.138 | 1.066 | 1.559 | 0.990 | 0.846 |
| 226428_at | TNPO2 | 1.85E−03 | 0.714 | 0.900 | 0.884 | 0.499 | 1.029 | 1.173 |
| 226459_at | PIK3AP1 | 4.89E−05 | 0.645 | 1.215 | 1.028 | 1.907 | 1.027 | 0.759 |
| 226503_at | RIF1 | 5.07E−04 | 0.543 | 0.852 | 0.923 | 0.556 | 1.073 | 1.256 |
| 226683_at | SNAG1 | 2.92E−02 | 0.801 | 0.852 | 0.746 | 0.533 | 1.010 | 2.165 |
| 226718_at | AMIGO1 | 6.07E−04 | 0.582 | 0.815 | 0.840 | 0.596 | 1.056 | 1.439 |
| 226763_at | SESTD1 | 6.84E−05 | 0.772 | 1.419 | 1.194 | 3.114 | 1.143 | 0.687 |
| 226836_at | SFT2D1 | 6.76E−03 | 0.514 | 1.075 | 0.985 | 1.434 | 1.028 | 0.850 |
| 227020_at | YPEL2 | 4.34E−03 | 0.783 | 1.127 | 1.119 | 1.636 | 1.033 | 0.684 |
| 227114_at | RNF214 | 1.46E−02 | 0.517 | 0.882 | 0.940 | 0.596 | 1.069 | 1.339 |
| 227149_at | TNRC6C | 3.81E−04 | 0.691 | 0.815 | 0.833 | 0.445 | 0.963 | 1.359 |
| 227173_s_at | BACH2 | 3.28E−04 | 0.688 | 0.711 | 0.687 | 0.180 | 1.047 | 1.780 |
| 227213_at | ADAT2 | 2.84E−04 | 0.631 | 0.766 | 0.791 | 0.341 | 0.992 | 1.567 |
| 227374_at | EARS2 | 2.63E−04 | 0.509 | 0.831 | 0.939 | 0.460 | 1.065 | 1.289 |
| 227517_s_at | GAS5 | 2.04E−04 | 0.594 | 0.772 | 0.856 | 0.388 | 0.978 | 1.597 |
| 227558_at | CBX4 | 6.88E−04 | 0.747 | 0.899 | 0.890 | 0.737 | 1.016 | 1.151 |
| 227560_at | SFXN2 | 5.37E−04 | 0.695 | 0.867 | 0.880 | 0.668 | 1.020 | 1.282 |
| 227722_at | RPS23 | 1.53E−03 | 0.676 | 0.622 | 0.424 | 0.046 | 1.013 | 2.284 |
| 227990_at | SLU7 | 4.23E−03 | 0.704 | 0.924 | 0.864 | 0.686 | 1.012 | 1.142 |
| 228012_at | MATR3 | 3.15E−04 | 0.562 | 0.825 | 0.883 | 0.551 | 1.039 | 1.525 |
| 228170_at | OLIG1 | 2.17E−04 | 0.732 | 1.728 | 1.255 | 5.011 | 1.043 | 0.474 |
| 228176_at | EDG3 | 1.95E−03 | 0.726 | 1.499 | 1.234 | 3.339 | 1.054 | 0.384 |
| 228234_at | TICAM2 | 1.04E−03 | 0.678 | 1.171 | 1.052 | 1.718 | 1.023 | 0.753 |
| 228370_at | SNRPN | 3.83E−04 | 0.564 | 0.726 | 0.792 | 0.175 | 1.051 | 1.914 |
| 228549_at | TMEM63A | 7.32E−04 | 0.634 | 0.805 | 0.795 | 0.468 | 1.044 | 1.432 |
| 228630_at | ZNF84 | 1.97E−03 | 0.529 | 0.820 | 0.874 | 0.386 | 1.038 | 1.497 |
| 228831_s_at | GNG7 | 7.41E−04 | 0.638 | 0.766 | 0.817 | 0.376 | 1.045 | 1.693 |
| 229307_at | ANKRD28 | 1.50E−03 | 0.677 | 1.612 | 1.118 | 4.028 | 1.170 | 0.460 |
| 229421_s_at | FLJ20273 | 1.26E−03 | 0.697 | 1.323 | 1.092 | 2.358 | 1.057 | 0.669 |
| 229509_at | MFSD8 | 8.26E−03 | 0.515 | 0.886 | 0.946 | 0.635 | 1.017 | 1.301 |
| 229854_at | OBSCN | 1.14E−02 | 0.643 | 0.899 | 0.896 | 0.799 | 0.945 | 1.456 |
| 229982_at | QSER1 | 1.19E−04 | 0.792 | 1.326 | 1.157 | 2.120 | 1.007 | 0.700 |
| 230265_at | SEL1L | 5.12E−04 | 0.684 | 1.324 | 1.088 | 2.025 | 1.000 | 0.528 |
| 230320_at | TBRG1 | 9.67E−04 | 0.646 | 0.852 | 0.871 | 0.625 | 1.062 | 1.199 |
| 230408_at | PCGF3 | 1.57E−03 | 0.564 | 0.856 | 0.867 | 0.610 | 1.033 | 1.452 |
| 230480_at | PIWIL4 | 3.48E−03 | 0.666 | 1.194 | 1.048 | 2.206 | 1.078 | 0.692 |
| 230837_at | LOC647500 | 4.08E−04 | 0.680 | 0.884 | 0.848 | 0.695 | 1.000 | 1.329 |
| 230852_at | STAC3 | 5.18E−04 | 0.715 | 1.181 | 1.095 | 1.877 | 1.063 | 0.782 |
| 230922_x_at | FUNDC2 | 3.63E−03 | 0.700 | 0.907 | 0.884 | 0.710 | 1.012 | 1.245 |
| 231283_at | MGAT4A | 6.09E−05 | 0.699 | 0.797 | 0.802 | 0.447 | 1.040 | 1.323 |
| 231697_s_at | TMEM49 | 2.66E−04 | 0.642 | 1.392 | 0.967 | 3.233 | 0.903 | 0.584 |
| 231836_at | HKR1 | 9.87E−04 | 0.639 | 0.793 | 0.856 | 0.320 | 1.013 | 1.840 |
| 231843_at | DDX55 | 3.23E−05 | 0.752 | 0.842 | 0.849 | 0.537 | 1.038 | 1.203 |
| 231845_at | AARS2 | 2.34E−03 | 0.512 | 0.821 | 0.936 | 0.522 | 1.017 | 1.435 |
| 231904_at | U2AF1 | 5.78E−04 | 0.719 | 0.841 | 0.853 | 0.373 | 1.027 | 1.252 |
| 231914_at | NUDT14 | 7.59E−04 | 0.658 | 1.099 | 1.035 | 1.583 | 1.039 | 0.800 |
| 232636_at | SLITRK4 | 1.16E−04 | 0.759 | 1.518 | 1.326 | 2.892 | 1.066 | 0.414 |
| 232851_at | FBXO3 | 7.40E−04 | 0.739 | 0.788 | 0.759 | 0.479 | 1.015 | 1.631 |
| 233019_at | CNOT7 | 2.46E−04 | 0.550 | 0.839 | 0.937 | 0.500 | 1.007 | 1.364 |
| 233169_at | ZNF350 | 5.49E−04 | 0.707 | 0.840 | 0.797 | 0.439 | 1.002 | 1.347 |
| 234013_at | TRA@ | 2.57E−03 | 0.504 | 0.722 | 0.778 | 0.326 | 0.951 | 1.844 |
| 234311_s_at | GTPBP10 | 5.02E−03 | 0.520 | 0.864 | 0.971 | 0.587 | 0.998 | 1.396 |
| 234339_s_at | GLTSCR2 | 2.44E−03 | 0.518 | 0.794 | 0.933 | 0.306 | 1.071 | 1.528 |
| 234464_s_at | EME1 | 1.02E−03 | 0.734 | 1.284 | 1.100 | 2.214 | 1.084 | 0.605 |
| 234733_s_at | FANCM | 6.29E−04 | 0.718 | 0.825 | 0.809 | 0.583 | 0.982 | 1.456 |
| 235024_at | PHF17 | 1.85E−04 | 0.733 | 0.866 | 0.881 | 0.605 | 1.075 | 1.169 |
| 235067_at | MKLN1 | 2.85E−02 | 0.726 | 0.917 | 0.855 | 0.362 | 1.030 | 1.170 |
| 235200_at | ZNF561 | 2.15E−04 | 0.645 | 0.844 | 0.873 | 0.595 | 1.057 | 1.338 |
| 235359_at | LRRC33 | 9.30E−04 | 0.744 | 1.257 | 1.106 | 1.934 | 1.061 | 0.544 |
| 235593_at | ZEB2 | 8.32E−07 | 0.770 | 1.451 | 1.201 | 2.156 | 1.078 | 0.690 |
| 235610_at | ALKBH8 | 5.70E−04 | 0.587 | 0.788 | 0.831 | 0.415 | 1.008 | 1.893 |
| 235623_at | ELP2 | 9.66E−04 | 0.676 | 0.894 | 0.922 | 0.611 | 1.003 | 1.198 |
| 235690_at | ZNF594 | 9.02E−04 | 0.647 | 0.824 | 0.835 | 0.563 | 1.011 | 1.635 |
| 237504_at | INTS10 | 4.67E−04 | 0.666 | 0.855 | 0.870 | 0.609 | 1.038 | 1.282 |
| 238429_at | TMEM71 | 4.30E−02 | 0.742 | 0.909 | 0.840 | 0.576 | 1.007 | 1.358 |
| 238513_at | PRRG4 | 9.07E−04 | 0.646 | 1.543 | 1.108 | 3.989 | 1.064 | 0.472 |
| 238736_at | REV3L | 4.11E−04 | 0.670 | 0.845 | 0.863 | 0.555 | 1.036 | 1.477 |
| 238823_at | FMNL3 | 1.75E−03 | 0.766 | 0.828 | 0.778 | 0.419 | 1.048 | 1.426 |
| 238909_at | S100A10 | 1.40E−03 | 0.716 | 1.317 | 1.138 | 2.696 | 0.993 | 0.663 |
| 239108_at | MLSTD1 | 8.51E−04 | 0.592 | 1.338 | 0.964 | 2.322 | 1.113 | 0.516 |
| 239897_at | BCLAF1 | 2.75E−03 | 0.743 | 0.905 | 0.883 | 0.595 | 1.021 | 1.191 |
| 241704_x_at | ZNF320 | 4.39E−03 | 0.534 | 0.865 | 0.964 | 0.498 | 1.053 | 1.306 |
| 241706_at | CPNE8 | 6.88E−05 | 0.754 | 1.254 | 1.136 | 1.893 | 1.039 | 0.686 |
| 241731_x_at | ZNF440 | 6.39E−05 | 0.663 | 0.849 | 0.867 | 0.540 | 1.014 | 1.250 |
| 242197_x_at | CD36 | 1.29E−05 | 0.759 | 2.090 | 1.487 | 5.789 | 1.171 | 0.357 |
| 242561_at | IPO9 | 1.17E−03 | 0.657 | 0.836 | 0.859 | 0.539 | 1.038 | 1.433 |
| 242569_at | STAM2 | 6.61E−03 | 0.749 | 0.896 | 0.838 | 0.573 | 1.042 | 1.235 |
| 242669_at | UFM1 | 8.10E−04 | 0.645 | 0.842 | 0.864 | 0.474 | 1.049 | 1.248 |
| 243982_at | KLHL28 | 3.10E−05 | 0.674 | 0.809 | 0.865 | 0.606 | 1.060 | 1.304 |
| 244038_at | WDR89 | 7.97E−05 | 0.670 | 0.792 | 0.838 | 0.462 | 1.020 | 1.498 |
| 244654_at | MYO1G | 2.56E−02 | 0.746 | 1.161 | 1.119 | 1.826 | 0.999 | 0.739 |
| 244698_at | CDRT4 | 8.84E−03 | 0.595 | 0.930 | 0.933 | 0.806 | 0.994 | 1.240 |
| 36566_at | CTNS | 1.31E−03 | 0.747 | 1.155 | 1.084 | 1.550 | 1.052 | 0.738 |
| 37549_g_at | BBS9 | 3.65E−02 | 0.698 | 1.047 | 1.039 | 1.189 | 1.029 | 0.864 |
| 48659_at | RP5-1077B9.4 | 2.84E−04 | 0.807 | 1.133 | 1.098 | 1.525 | 1.024 | 0.836 |
| 56829_at | NIBP | 1.15E−02 | 0.745 | 1.078 | 1.051 | 1.462 | 1.015 | 0.892 |
| 64486_at | CORO1B | 4.79E−04 | 0.772 | 1.200 | 1.098 | 1.884 | 1.019 | 0.736 |
| AFFX-HUMGAPDH/ [symbol] | GAPDH | 4.93E−06 | 0.746 | 1.148 | 1.049 | 1.446 | 1.027 | 0.868 |

[symbol]

indicates data missing or illegible when filed

TABLE 5

| | | Average fold- | Average fold- |
|---|---|---|---|
| | | change gene | change gene |
| | | expression | expression |
| Affymetrix Probe | | (NYHA I-II/ | (NYHA III-IV/ |
| set ID | Gene symbol | Control) | Control) |
| 1555630_a_at | RAB34 | 1.277 | 1.306 |
| 1555963_x_at | B3GNT7 | 1.206 | 1.386 |
| 1556113_at | DKFZp451A211 | 1.118 | 1.131 |
| 1556283_s_at | FGFR1OP2 | 1.194 | 1.237 |
| 200059_s_at | RHOA | 1.068 | 1.068 |
| 200650_s_at | LDHA | 1.099 | 1.136 |
| 200822_x_at | TPI1 | 1.102 | 1.162 |
| 200839_s_at | CTSB | 1.199 | 1.330 |
| 200932_s_at | DCTN2 | 1.069 | 1.088 |
| 200950_at | ARPC1A | 1.102 | 1.148 |
| 201098_at | COPB2 | 1.079 | 1.095 |
| 201105_at | LGALS1 | 1.339 | 1.345 |
| 201172_x_at | ATP6V0E1 | 1.075 | 1.113 |
| 201186_at | LRPAP1 | 1.119 | 1.200 |
| 201193_at | IDH1 | 1.192 | 1.310 |
| 201220_x_at | CTBP2 | 1.085 | 1.160 |
| 201234_at | ILK | 1.137 | 1.194 |
| 201400_at | PSMB3 | 1.106 | 1.205 |
| 201422_at | IFI30 | 1.151 | 1.234 |
| 201426_s_at | VIM | 1.092 | 1.123 |
| 201453_x_at | RHEB | 1.084 | 1.101 |
| 201470_at | GSTO1 | 1.171 | 1.218 |
| 201527_at | ATP6V1F | 1.093 | 1.110 |
| 201536_at | DUSP3 | 1.160 | 1.303 |
| 201554_x_at | GYG1 | 1.140 | 1.307 |
| 201576_s_at | GLB1 | 1.108 | 1.197 |
| 201590_x_at | ANXA2 | 1.259 | 1.281 |
| 201628_s_at | RRAGA | 1.086 | 1.104 |
| 201900_s_at | AKR1A1 | 1.158 | 1.170 |
| 202068_s_at | LDLR | 1.352 | 1.689 |
| 202201_at | BLVRB | 1.196 | 1.335 |
| 202252_at | RAB13 | 1.374 | 1.393 |
| 203127_s_at | SPTLC2 | 1.199 | 1.247 |
| 203305_at | F13A1 | 1.306 | 1.505 |
| 203416_at | CD53 | 1.063 | 1.085 |
| 203844_at | VHL | 1.066 | 1.099 |
| 203912_s_at | DNASE1L1 | 1.201 | 1.221 |
| 204050_s_at | CLTA | 1.107 | 1.108 |
| 204099_at | SMARCD3 | 1.240 | 1.463 |
| 204243_at | RLF | 1.122 | 1.243 |
| 204249_s_at | LMO2 | 1.162 | 1.210 |
| 204675_at | SRD5A1 | 1.321 | 1.369 |
| 205550_s_at | BRE | 1.057 | 1.101 |
| 206715_at | TFEC | 1.269 | 1.400 |
| 207113_s_at | TNF | 1.219 | 1.277 |
| 207543_s_at | P4HA1 | 1.099 | 1.239 |
| 208121_s_at | PTPRO | 1.456 | 1.561 |
| 208161_s_at | ABCC3 | 1.465 | 1.654 |
| 208659_at | CLIC1 | 1.054 | 1.129 |
| 208771_s_at | LTA4H | 1.244 | 1.322 |
| 208921_s_at | SRI | 1.106 | 1.115 |
| 208923_at | CYFIP1 | 1.262 | 1.343 |
| 209099_x_at | JAG1 | 1.201 | 1.437 |
| 209124_at | MYD88 | 1.085 | 1.117 |
| 209191_at | TUBB6 | 1.281 | 1.407 |
| 209218_at | SQLE | 1.389 | 1.403 |
| 209251_x_at | TUBA1C | 1.090 | 1.147 |
| 209684_at | RIN2 | 1.244 | 1.382 |
| 210145_at | PLA2G4A | 1.319 | 1.507 |
| 210156_s_at | PCMT1 | 1.111 | 1.113 |
| 210434_x_at | JTB | 1.097 | 1.106 |
| 210648_x_at | SNX3 | 1.134 | 1.165 |
| 211047_x_at | AP2S1 | 1.136 | 1.149 |
| 211058_x_at | TUBA1B | 1.059 | 1.095 |
| 211684_s_at | DYNC1I2 | 1.182 | 1.186 |
| 212334_at | GNS | 1.118 | 1.152 |
| 212658_at | LHFPL2 | 1.348 | 1.569 |
| 212663_at | FKBP15 | 1.119 | 1.147 |
| 212820_at | DMXL2 | 1.151 | 1.249 |
| 213335_s_at | ST3GAL6 | 1.124 | 1.186 |
| 213494_s_at | YY1 | 1.199 | 1.279 |
| 214430_at | GLA | 1.096 | 1.180 |
| 214511_x_at | FCGR1B | 1.560 | 1.889 |
| 214629_x_at | RTN4 | 1.071 | 1.125 |
| 215049_x_at | CD163 | 1.279 | 1.485 |
| 215273_s_at | TADA3L | 1.061 | 1.113 |
| 216484_x_at | HDGF | 1.083 | 1.098 |
| 216950_s_at | FCGR1A | 1.641 | 1.987 |
| 217383_at | PGK1 | 1.184 | 1.286 |
| 217769_s_at | POMP | 1.090 | 1.107 |
| 218091_at | HRB | 1.128 | 1.206 |
| 218206_x_at | SCAND1 | 1.077 | 1.126 |
| 218351_at | COMMD8 | 1.103 | 1.119 |
| 218627_at | DRAM | 1.183 | 1.344 |
| 218718_at | PDGFC | 1.412 | 1.416 |
| 218732_at | PTRH2 | 1.165 | 1.222 |
| 218845_at | DUSP22 | 1.166 | 1.174 |
| 219316_s_at | FLVCR2 | 1.297 | 1.382 |
| 219358_s_at | CENTA2 | 1.234 | 1.294 |
| 219952_s_at | MCOLN1 | 1.155 | 1.252 |
| 220146_at | TLR7 | 1.404 | 1.417 |
| 220160_s_at | KPTN | 1.151 | 1.194 |
| 220605_s_at | SIRT2 | 1.076 | 1.127 |
| 220865_s_at | PDSS1 | 1.182 | 1.357 |
| 220974_x_at | SFXN3 | 1.190 | 1.210 |
| 221449_s_at | ITFG1 | 1.092 | 1.155 |
| 221647_s_at | RIC8A | 1.093 | 1.097 |
| 221731_x_at | VCAN | 1.129 | 1.267 |
| 221841_s_at | KLF4 | 1.403 | 1.476 |
| 221960_s_at | RAB2A | 1.388 | 1.490 |
| 222217_s_at | SLC27A3 | 1.268 | 1.314 |
| 222231_s_at | LRRC59 | 1.135 | 1.150 |
| 222651_s_at | TRPS1 | 1.159 | 1.249 |
| 222670_s_at | MAFB | 1.344 | 1.369 |
| 222753_s_at | SPCS3 | 1.120 | 1.206 |
| 222774_s_at | NETO2 | 1.242 | 1.297 |
| 222980_at | RAB10 | 1.087 | 1.107 |
| 223064_at | RNF181 | 1.090 | 1.109 |
| 223158_s_at | NEK6 | 1.253 | 1.254 |
| 223465_at | COL4A3BP | 1.133 | 1.234 |
| 223801_s_at | APOL4 | 1.094 | 1.164 |
| 224387_at | COMMD5 | 1.139 | 1.226 |
| 224818_at | SORT1 | 1.165 | 1.237 |
| 224917_at | MIRN21 | 1.158 | 1.234 |
| 224918_x_at | MGST1 | 1.253 | 1.440 |
| 224928_at | SETD7 | 1.195 | 1.278 |
| 225188_at | RAPH1 | 1.812 | 1.838 |
| 225365_at | ZDHHC20 | 1.118 | 1.222 |
| 225844_at | POLE4 | 1.160 | 1.198 |
| 225870_s_at | TRAPPC5 | 1.117 | 1.227 |
| 226000_at | CTTNBP2NL | 1.117 | 1.186 |
| 226059_at | TOMM40L | 1.191 | 1.339 |
| 226220_at | METTL9 | 1.233 | 1.345 |
| 226353_at | SPPL2A | 1.122 | 1.138 |
| 226459_at | PIK3AP1 | 1.159 | 1.215 |
| 226763_at | SESTD1 | 1.324 | 1.419 |
| 228170_at | OLIG1 | 1.514 | 1.728 |
| 228176_at | EDG3 | 1.399 | 1.499 |
| 228234_at | TICAM2 | 1.149 | 1.171 |
| 229307_at | ANKRD28 | 1.410 | 1.612 |
| 229421_s_at | FLJ20273 | 1.213 | 1.323 |
| 230265_at | SEL1L | 1.189 | 1.324 |
| 230852_at | STAC3 | 1.152 | 1.181 |
| 231914_at | NUDT14 | 1.085 | 1.099 |
| 232636_at | SLITRK4 | 1.492 | 1.518 |
| 234464_s_at | EME1 | 1.262 | 1.284 |
| 235359_at | LRRC33 | 1.232 | 1.257 |
| 235593_at | ZEB2 | 1.282 | 1.451 |
| 238909_at | S100A10 | 1.255 | 1.317 |
| 241706_at | CPNE8 | 1.194 | 1.254 |
| 242197_x_at | CD36 | 1.871 | 2.090 |
| AFFX- | GAPDH | 1.103 | 1.148 |
| HUMGAPDH/ | | | |
| M33197_3_at | | | |

TABLE 6

| | | Average fold- | Average fold- |
|---|---|---|---|
| | | change gene | change gene |
| | | expression | expression |
| Affymetrix Probe | | (NYHA I-II/ | (NYHA III-IV/ |
| set ID | Gene symbol | Control) | Control) |
| 1558277_at | ZNF740 | 1.326 | 1.175 |
| 200713_s_at | MAPRE1 | 1.106 | 1.073 |
| 200829_x_at | ZNF207 | 1.147 | 1.125 |
| 201198_s_at | PSMD1 | 1.138 | 1.114 |
| 202185_at | PLOD3 | 1.135 | 1.101 |
| 202428_x_at | DBI | 1.174 | 1.118 |
| 202461_at | EIF2B2 | 1.195 | 1.117 |
| 202522_at | PITPNB | 1.094 | 1.063 |
| 202944_at | NAGA | 1.226 | 1.219 |
| 203534_at | LSM1 | 1.149 | 1.147 |
| 203880_at | COX17 | 1.167 | 1.136 |
| 206170_at | ADRB2 | 1.459 | 1.320 |
| 208680_at | PRDX1 | 1.224 | 1.215 |
| 208805_at | PSMA6 | 1.145 | 1.120 |
| 209040_s_at | PSMB8 | 1.135 | 1.115 |
| 209892_at | FUT4 | 1.303 | 1.270 |
| 210644_s_at | LAIR1 | 1.341 | 1.278 |
| 211383_s_at | WDR37 | 1.118 | 1.065 |
| 211729_x_at | BLVRA | 1.250 | 1.241 |
| 212543_at | AIM1 | 1.130 | 1.090 |
| 214853_s_at | SHC1 | 1.131 | 1.124 |
| 214953_s_at | APP | 1.359 | 1.315 |
| 218143_s_at | SCAMP2 | 1.158 | 1.111 |
| 219507_at | RSRC1 | 1.338 | 1.214 |
| 220750_s_at | LEPRE1 | 1.169 | 1.135 |
| 224439_x_at | RNF7 | 1.175 | 1.172 |
| 224726_at | MIB1 | 1.228 | 1.207 |
| 227020_at | YPEL2 | 1.145 | 1.127 |
| 229982_at | QSER1 | 1.379 | 1.326 |
| 230480_at | PIWIL4 | 1.265 | 1.194 |
| 244654_at | MYO1G | 1.227 | 1.161 |
| 36566_at | CTNS | 1.178 | 1.155 |
| 37549_g_at | BBS9 | 1.075 | 1.047 |
| 48659_at | RP5-1077B9.4 | 1.159 | 1.133 |
| 56829_at | NIBP | 1.099 | 1.078 |
| 64486_at | CORO1B | 1.210 | 1.200 |

TABLE 7

| | | Average fold- | Average fold- |
|---|---|---|---|
| | | change gene | change gene |
| | | expression | expression |
| Affymetrix Probe | | (NYHA I-II/ | (NYHA III-IV/ |
| set ID | Gene symbol | Control) | Control) |
| 1552630_a_at | SRCAP | 0.831 | 0.815 |
| 1554149_at | CLDND1 | 0.907 | 0.856 |
| 1554606_at | CCDC100 | 0.860 | 0.760 |
| 1557066_at | LUC7L | 0.873 | 0.776 |
| 1558755_x_at | ZNF763 | 0.816 | 0.753 |
| 1564962_at | ZNF92 | 0.799 | 0.748 |
| 1568815_a_at | DDX50 | 0.836 | 0.762 |
| 200672_x_at | SPTBN1 | 0.893 | 0.773 |
| 201075_s_at | SMARCC1 | 0.874 | 0.864 |
| 201556_s_at | VAMP2 | 0.810 | 0.801 |
| 202249_s_at | WDR42A | 0.925 | 0.890 |
| 202523_s_at | SPOCK2 | 0.834 | 0.674 |
| 202623_at | EAPP | 0.917 | 0.896 |
| 202652_at | APBB1 | 0.862 | 0.753 |
| 202724_s_at | FOXO1 | 0.881 | 0.847 |
| 202778_s_at | ZMYM2 | 0.907 | 0.899 |
| 202928_s_at | PHF1 | 0.852 | 0.818 |
| 203137_at | WTAP | 0.929 | 0.889 |
| 203413_at | NELL2 | 0.799 | 0.608 |
| 203939_at | NT5E | 0.802 | 0.743 |
| 204291_at | ZNF518 | 0.924 | 0.872 |
| 204401_at | KCNN4 | 0.828 | 0.813 |
| 204617_s_at | ACD | 0.895 | 0.871 |
| 204645_at | CCNT2 | 0.886 | 0.863 |
| 205235_s_at | MPHOSPH1 | 0.905 | 0.883 |
| 205254_x_at | TCF7 | 0.862 | 0.666 |
| 205256_at | ZBTB39 | 0.935 | 0.887 |
| 206182_at | ZNF134 | 0.925 | 0.853 |
| 206542_s_at | SMARCA2 | 0.900 | 0.873 |
| 206968_s_at | NFRKB | 0.919 | 0.850 |
| 207078_at | MED6 | 0.887 | 0.797 |
| 207513_s_at | ZNF189 | 0.898 | 0.897 |
| 208269_s_at | ADAM28 | 0.859 | 0.840 |
| 208946_s_at | BECN1 | 0.938 | 0.935 |
| 209236_at | SLC23A2 | 0.901 | 0.826 |
| 209675_s_at | HNRPUL1 | 0.870 | 0.843 |
| 211185_s_at | SF3B1 | 0.943 | 0.918 |
| 211323_s_at | ITPR1 | 0.873 | 0.798 |
| 211856_x_at | CD28 | 0.839 | 0.654 |
| 211946_s_at | BAT2D1 | 0.933 | 0.910 |
| 212030_at | RBM25 | 0.897 | 0.818 |
| 212132_at | LSM14A | 0.925 | 0.881 |
| 212455_at | YTHDC1 | 0.917 | 0.878 |
| 212997_s_at | TLK2 | 0.919 | 0.915 |
| 213218_at | ZNF187 | 0.857 | 0.816 |
| 213459_at | RPL37A | 0.848 | 0.822 |
| 214820_at | BRWD1 | 0.909 | 0.837 |
| 215293_s_at | FRAG1 | 0.882 | 0.864 |
| 215567_at | FGF1 | 0.863 | 0.766 |
| 217987_at | ASNSD1 | 0.810 | 0.774 |
| 218012_at | TSPYL2 | 0.894 | 0.792 |
| 218040_at | PRPF38B | 0.936 | 0.898 |
| 218127_at | NFYB | 0.940 | 0.872 |
| 218499_at | RP6-213H19.1 | 0.934 | 0.878 |
| 219826_at | ZNF419 | 0.869 | 0.733 |
| 221428_s_at | TBL1XR1 | 0.892 | 0.851 |
| 221580_s_at | JOSD3 | 0.930 | 0.859 |
| 221601_s_at | FAIM3 | 0.865 | 0.703 |
| 221868_at | PAIP2B | 0.823 | 0.764 |
| 222700_at | ARL6IP2 | 0.906 | 0.850 |
| 224046_s_at | PDE7A | 0.885 | 0.791 |
| 224518_s_at | ZNF559 | 0.890 | 0.821 |
| 225341_at | MTERFD3 | 0.740 | 0.696 |
| 225388_at | TSPAN5 | 0.865 | 0.802 |
| 225456_at | MED1 | 0.934 | 0.877 |
| 226323_at | CCDC16 | 0.908 | 0.876 |
| 227149_at | TNRC6C | 0.860 | 0.815 |
| 227173_s_at | BACH2 | 0.804 | 0.711 |
| 227558_at | CBX4 | 0.916 | 0.899 |
| 227560_at | SFXN2 | 0.910 | 0.867 |
| 227722_at | RPS23 | 0.655 | 0.622 |
| 228549_at | TMEM63A | 0.893 | 0.805 |
| 228831_s_at | GNG7 | 0.842 | 0.766 |
| 230837_at | LOC647500 | 0.901 | 0.884 |
| 231283_at | MGAT4A | 0.873 | 0.797 |
| 231843_at | DDX55 | 0.874 | 0.842 |
| 231904_at | U2AF1 | 0.861 | 0.841 |
| 232851_at | FBXO3 | 0.813 | 0.788 |
| 233169_at | ZNF350 | 0.849 | 0.840 |
| 234733_s_at | FANCM | 0.879 | 0.825 |
| 235024_at | PHF17 | 0.893 | 0.866 |
| 235200_at | ZNF561 | 0.904 | 0.844 |
| 235623_at | ELP2 | 0.922 | 0.894 |
| 237504_at | INTS10 | 0.901 | 0.855 |
| 238736_at | REV3L | 0.880 | 0.845 |
| 239897_at | BCLAF1 | 0.905 | 0.905 |
| 241731_x_at | ZNF440 | 0.919 | 0.849 |
| 242561_at | IPO9 | 0.889 | 0.836 |
| 243982_at | KLHL28 | 0.870 | 0.809 |
| 244038_at | WDR89 | 0.897 | 0.792 |

TABLE 8

| | | Average fold- | Average fold- |
|---|---|---|---|
| | | change gene | change gene |
| | | expression | expression |
| Affymetrix Probe | | (NYHA I-II/ | (NYHA III-IV/ |
| set ID | Gene symbol | Control) | Control) |
| 1556864_at | TECT1 | 0.849 | 0.852 |
| 1561146_at | VPS35 | 0.789 | 0.790 |
| 201357_s_at | SF3A1 | 0.847 | 0.898 |
| 201363_s_at | IVNS1ABP | 0.851 | 0.856 |
| 203003_at | MEF2D | 0.835 | 0.897 |
| 204801_s_at | DHRS12 | 0.757 | 0.782 |
| 207164_s_at | ZNF238 | 0.845 | 0.870 |
| 209269_s_at | SYK | 0.823 | 0.893 |
| 210875_s_at | ZEB1 | 0.768 | 0.783 |
| 211506_s_at | IL8 | 0.495 | 0.710 |
| 213877_x_at | TCEB2 | 0.912 | 0.930 |
| 214683_s_at | CLK1 | 0.890 | 0.905 |
| 214931_s_at | SRPK2 | 0.853 | 0.882 |
| 215997_s_at | CUL4B | 0.848 | 0.902 |
| 222574_s_at | DHX40 | 0.867 | 0.871 |
| 223444_at | SENP7 | 0.871 | 0.882 |
| 223982_s_at | PNPLA8 | 0.922 | 0.938 |
| 226042_at | EDC3 | 0.905 | 0.943 |
| 226115_at | AHCTF1 | 0.815 | 0.860 |
| 226428_at | TNPO2 | 0.898 | 0.900 |
| 226683_at | SNAG1 | 0.784 | 0.852 |
| 227990_at | SLU7 | 0.895 | 0.924 |
| 230922_x_at | FUNDC2 | 0.906 | 0.907 |
| 235067_at | MKLN1 | 0.872 | 0.917 |
| 238429_at | TMEM71 | 0.847 | 0.909 |
| 238823_at | FMNL3 | 0.827 | 0.828 |
| 242569_at | STAM2 | 0.863 | 0.896 |

We claim:

1. A method of determining a severity of heart failure in a human test subject, the method comprising,
for each gene of a set of one or more of the genes listed in Tables 3, 4, 5, 6, 7 and 8:
a) determining a level of RNA encoded by the gene in blood of the test subject, thereby generating a test data;
b) providing a control data representing levels of RNA encoded by the gene in blood of human control subjects having a categorized severity of heart failure; and
c) comparing the levels of steps a) and b) to thereby determine at least one value indicating whether the test data corresponds to the control data;
wherein an indication by the at least one value, for each gene of the set, that the test data corresponds to the control data indicates that the test subject has the categorized severity of heart failure.

2. The method of claim 1, wherein the categorized severity is compensated heart failure, optionally NYHA I/NYHA II heart failure, or decompensated heart failure, optionally NYHA III/NYHA IV heart failure.

3. The method of claim 1, wherein the level of RNA encoded by the gene in blood of the test subject is determined as a ratio to a level of RNA encoded by the gene in blood of subjects not having heart failure.

4. The method of claim 1, further comprising determining levels of RNA encoded by the gene in blood of a population of human subjects having the categorized severity of heart failure, thereby providing the control data.

5. The method of claim 1, wherein step c) is effected by causing a suitably programmed computer to compare the test data to the control data to thereby generate the at least one value indicating whether the test data corresponds to the control data.

6. A method of monitoring the progression of heart failure in a human subject, the method comprising, for each gene of a set of one or more of the genes listed in Table 5:
a) determining a level of RNA encoded by the gene in blood of the subject at a first time point;
b) determining a level of RNA encoded by the gene in blood of the subject at a second time point, wherein the second time point is later than the first time point;
c) comparing the levels of steps a) and b) to thereby determine at least one value indicating whether the level at the second time point is higher than the level at the first time point;
wherein an indication by the at least one value, for each gene of the set, that the level at the second time point is higher than the level at the first time point indicates a progression of heart failure.

7. A method of monitoring the progression of heart failure in a human subject, the method comprising, for each gene of a set of one or more of the genes listed in Table 7:
a) determining a level of RNA encoded by the gene in blood of the subject at a first time point;
b) determining a level of RNA encoded by the gene in blood of the subject at a second time point, wherein the second time point is later than the first time point;
c) comparing the levels of steps a) and b) to thereby determine at least one value indicating whether the level at the second time point is lower than the level at the first time point;
wherein an indication by the at least one value, for each gene of the set, that the level at the second time point is lower than the level at the first time point indicates a progression of heart failure.

8. The method of claim 6 or 7, wherein the level of RNA encoded by the gene in blood of the test subject is determined as a ratio to a level of RNA encoded by the gene in blood of subjects not having heart failure.

9. The method of claim 6, wherein step c) is effected by causing a suitably programmed computer to compare a data representing the level at the first time point to a data representing the level at the second time point to thereby determine the at least one value indicating whether the level at the second time point is higher than the level at the first time point.

10. The method of claim 7, wherein step c) is effected by causing a suitably programmed computer to compare a data representing the level at the first time point to a data representing the level at the second time point to thereby determine the at least one value indicating whether the level at the second time point is lower than the level at the first time point.

11. A kit comprising packaging and containing, for each gene of a set of two or more of the genes listed in Table 1, a primer set capable of generating an amplification product of DNA complementary to RNA encoded, in a human subject, only by the gene.

12. The kit of claim 11, further comprising for a control gene, a primer set capable of generating an amplification product of DNA complementary to RNA, wherein the RNA is encoded, in the human genome, only by the control gene.

13. The kit of claim 11 or 12, further comprising a component selected from the group consisting of a thermostable polymerase, a reverse transcriptase, deoxynucleotide triphosphates, nucleotide triphosphates and enzyme buffer.

14. The kit of claim 11, 12 or 13, further comprising at least one labeled probe capable of selectively hybridizing to either a sense or an antisense strand of the amplification product.

15. The kit of claim 11, 12, 13 or 14, further comprising a computer-readable medium having instructions stored thereon that are operable when executed by a computer for comparing a test data representing a level of RNA encoded by the gene in blood of a human test subject to a control data representing levels of RNA encoded by the gene in blood of human control subjects having a categorized severity of heart failure to thereby determine at least one value indicating whether the test data corresponds to the control data, wherein an indication by the at least one value that the test data corresponds to the control data classifies the test subject as having the categorized severity of heart failure.

16. A method of classifying a human test subject as having decompensated heart failure, optionally NYHA class III-IV heart failure, the method comprising:
a) determining a level of RNA encoded by each gene of a set of one or more of the genes listed in Tables 5 and 6 in blood of the test subject, thereby generating a test data;
b) providing a control data representing a level of RNA encoded by the gene in blood of human control subjects not having heart failure; and
c) comparing the test data to the control data to thereby determine at least one value indicating whether the level of RNA encoded by the gene in blood of the test subject is higher than the level of RNA encoded by the gene in blood of human control subjects not having heart failure,
wherein an indication by the at least one value that the level of RNA encoded by the gene in blood of the test subject is higher than the level of RNA encoded by the gene in blood of human control subjects not having heart failure classifies the test subject as having decompensated heart failure.

17. The method of claim 16 wherein the level of RNA encoded by the gene in blood of the test subject is determined as a ratio to a level of RNA encoded by a gene in blood of a subject not having heart failure.

18. The method of claim 16, further comprising determining levels of RNA encoded by the gene in blood of human subjects not having decompensated heart failure, thereby providing the control data.

19. The method of claim 16, wherein step c) is effected by causing a suitably programmed computer to compare a test data representing the level of RNA encoded by the gene in blood of the test subject to a control data representing the level of RNA encoded by the gene in blood of human control subjects not having heart failure to thereby determine the at least one value indicating whether the level of RNA encoded by the gene in blood of the test subject is higher than the level of RNA encoded by the gene in blood of human control subjects not having heart failure.

20. A method of classifying a human test subject as having decompensated heart failure, optionally NYHA class III-IV heart failure, the method comprising:
a) determining a level of RNA encoded by each gene of a set of one or more of the genes listed in Tables 7 and 8 in blood of the test subject, thereby generating a test data;
b) providing a control data representing a level of RNA encoded by the gene in blood of human control subjects not having heart failure; and
c) comparing the test data to the control data to thereby determine at least one value indicating whether the level of RNA encoded by the gene in blood of the test subject is lower than the level of RNA encoded by the gene in blood of human control subjects not having heart failure,
wherein an indication by the at least one value that the level of RNA encoded by the gene in blood of the test subject is lower than the level of RNA encoded by the gene in blood of human control subjects not having heart failure classifies the test subject as having decompensated heart failure.

21. The method of claim 20 wherein the level of RNA encoded by the gene in blood of the test subject is determined as a ratio to a level of RNA encoded by the gene in blood of subjects not having heart failure.

22. The method of claim 20, further comprising determining levels of RNA encoded by the gene in blood of human subjects not having decompensated heart failure, thereby providing the control data.

23. The method of claim 20, wherein step c) is effected by causing a suitably programmed computer to compare a test data representing the level of RNA encoded by the gene in blood of the test subject to a control data representing a level of RNA encoded by the gene in blood of human control subjects not having heart failure to thereby determine the at least one value indicating whether the level of RNA encoded by the gene in blood of the test subject is lower than the level of RNA encoded by the gene in blood of human control subjects not having heart failure.
